(19) United States
(12) Patent Application Publication
(10) Pub. No.: US 2026/0330465 A1
(43) Pub. Date: Oct. 22, 2026

(54) QR Anonymous Communication and QR Automation Systems and Related Methods

(71) Applicant: QR Automation Technologies, Inc., Temple, TX (US)

(72) Inventor: Gopal Nandakumar, Temple, TX (US)

(21) Appl. No.: 19/306,835

(22) Filed: Aug. 21, 2025

Related U.S. Application Data
(60) Provisional application No. 63/790,502, filed on Apr. 17, 2025.

(51) Int. Cl. G06Q 30/01; G06K 7/14; G06Q 50/50; H04L 9/40

(52) U.S. Cl. CPC G06Q 30/01; G06K 7/1417; H04L 63/0421

(57) ABSTRACT

The present invention relates to a system and method for facilitating communication between two parties via an intermediary agent without either party disclosing to the other party personal contact information such as phone numbers or social media handles. The system further comprises a system and method to grant temporary access to a party's internet connection via the intermediary agent.

The invention further relates to a system and method efficient order processing, order fulfillment, and product management in physical retail environments. The invention incorporates electronic racks equipped with unique QR codes, NFC or RFID tag readers, and sensors capable of communicating with an intermediary agent through an application programming interface (API). These electronic racks are designed to securely stock products in uniquely designated bins, each fitted with a unique product QR code, to prevent shoplifting and enhance inventory management.

### CROSS REFERENCE TO RELATED APPLICATIONS

This application claims benefit to U.S. Provisional Application No. 63/685,335 filed Aug. 21, 2024, entitled QR Anonymous Communication and QR Automation Systems and Related Methods and U.S. Provisional Application No. 63/790,502 filed Apr. 17, 2025 entitled QR Code Door Bell Application, QR Code Communication & Automation (Store Automation), both of which are incorporated by reference.

### STATEMENT REGARDING FEDERALLY SPONSORED RESEARCH OR DEVELOPMENT

Not applicable.

### BACKGROUND OF THE INVENTION

### 1. Field of the Invention

The present invention relates to a communication system for providing anonymous text and/or video communication between two or more persons, entities, devices, or the like without exchanging sensitive information like cell phone number, email, Facebook login, Google login, Apple login, Snapchat code, msl code, Skype, Whatsapp and the like. More particularly, the invention relates to a system and related method whereby the identity of a person, entity, device, or the like attempting to gain communication with a person, entity, device or the like to be securely authenticated or verified without exchanging sensitive information between persons, entities, devices or the like for establishing communication.

The present invention also relates to an automation system for providing audio and video ordering and automated indoor, curbside, drive-thru lane order pickup and parking lot order pickup by authenticated or verified persons in physical locations. The present invention also relates to front and back-end automation of businesses such as restaurants, golf courses, grocery stores and the like. It also relates to automatic uploading of images and texts into social networks such as Facebook, Instagram, Pinterest, Youtube, Tiktok and the like by buyers (consumers) as well as merchants. It also relates to providing wi-fi access for a short period of time for consumers as guests to sign-in and providing wi-fi access for a long period of time for buyers for internet browsing. It also relates to reducing environmental impact by reusing takeout containers.

The present invention also relates to an automation system for providing shopping access for authenticated or verified persons in physical locations replacing all employee managed and self-serving checkout counters with electronic racks, bins, product motion sensors and secured self-checkouts attached with smart lockers.

The present invention also relates to an automation system for providing automated indoor, curbside, and drive-thru package pickups by authenticated or verified persons at physical locations for high volume package pickups using package transporter and intermediary bins.

The present invention also relates to an automation system for providing curbside, drive-thru and parking lot pickups by authenticated or verified persons at physical locations for 24 hours 7 days a week.

The present invention also relates to package transfer automation such as package delivery from driver operated and/or self-autonomous driver-less vehicles and/or robots to stand alone delivery boxes and/or to specific delivery boxes in a hub of delivery boxes. The present invention also relates to package transfer automation such as package pickup into driver operated and/or self-autonomous driver-less vehicles and/or robots from stand alone pick up boxes and/or from specific pick-up box in a hub of pickup boxes.

The present invention also relates to product transfer automation for online orders placed in advance or at physical entry less locations to be fulfilled or be prepared at physical entry less locations and be picked up from physical entry less locations by authenticated or verified persons 24 hours a day and 7 days a week.

The present invention also relates to self-scanning for self-checkout using high definition cameras and smart electronic lockers.

### BACKGROUND OF THE INVENTION

In today's fast faced e-commerce and physical transactions, numerous times consumers are asked to share their sensitive contact identifier such as mobile phone number, email addresses, Whatsapp, Snapchat codes and the like with businesses and merchants. This sensitive information does not stay with business and merchants, but handed over to their employees verbally, in text or digital form. Also, the ownership of businesses and merchants are transforming from single person or single family to multi corporations where customers cannot rely on providing sensitive information to a single person. These employees move from job to job or quit working and nothing prevents them from taking the sensitive information with them. Credit card numbers and sensitive contact identifier are treated differently. When credit card numbers are not protected, merchants and businesses are punished, but when other sensitive information are not protected merchants and businesses are not punished. To protect credit card numbers, card less payments through authentication methods and systems were patented and practiced by issuing mobile wallets for example msl wallet by MySingleLink. Unprotected sensitive information ends up in dark web and falls in the hands of robocall operators and unprotected emails end up with hackers and being used in sending phishing emails to get additional sensitive information like user id and password. For example, ride sharing companies share their riders' contact information with drivers. Delivery companies share customers' contact information with deliverers. Companies like air-conditioning & heating, plumbing, handyman, pest control, pool maintenance, lawn maintenance, pet care, childcare, elderly care, and the like share customers' contact information with their employees.

Merchants demand mobile numbers and/or email addresses verbally from customers for emailing or texting receipts instead of handing over printed receipts. Merchants demand mobile numbers and/or email addresses for loyalty program participation, even to show price lists or visit a public web site. Restaurants demand mobile numbers verbally to add guests into waitlists. Not only does the host get the cell phone numbers, but also the customers waiting in line near the host can get the information. Marketing agencies require email addresses and mobile numbers for customers to participate in video meetings or webinars. It is all done in the name of providing better and faster service.

Also, consumers receive sensitive information like mobile numbers of employees of merchants and businesses, in order for consumers to contact those employees. This sensitive information may not stay with customers or with employees of merchants and businesses. Because of dangers of providing sensitive information like cell number, email address, Snapchat code, msl code, Skype number, Whatsapp number and the like to visitors, home occupants, apartment occupants, office building occupants and the like are opting to meet strangers at the entrance and/or letting strangers enter protected areas without authenticating or verifying the visitors.

Because of dangers of sharing sensitive information like cell number, email address, Snapchat code, msl code, Skype number, Whatsapp number and the like with strangers, consumers may not be exchanging their request for suggestions or recommendations with strangers in a brick-and-mortar store. Instead, consumers resort to blogs set up by merchants and/or third-party service providers such as Instagram, Yelp, Trustpilot and the like. Unfortunately, the bloggers are not positively verified by merchants or by third-party service providers and the blogs are based on experience. For example, professional bloggers who are paid for blogging can blog without making a purchase or visiting the merchant or business location or online store.

For example, consumers in a restaurant may want to request strangers concurrently present at the restaurant, for suggestions or recommendations without exchanging any sensitive information. For example, golf players in a golf course may want to request strangers concurrently present at the golf course, for suggestions or recommendations without exchanging any sensitive information. For example, golf course operators may want to know golf players' location in the golf course for better traffic management in the golf course. For example, homeowners, apartment residents, businesses in multiunit office buildings may want to authenticate or verify visitors before exchanging any sensitive information to establish a communication channel or to meet in person. For example, businesses and merchants may want to know the text exchanged between their employees and customers during an employee visit to a customer location.

Even though merchants provide QR Codes to view menus, many customers may not be able to scan the QR Codes because internet service may not be available from customers' mobile devices. So, merchants provide free wi-fi access by posting wi-fi user name and password. But unfortunately, customers abuse the free wi-fi access without any purchase or use it with a purchase but for a longer period of time.

Even though certain types of service providers use mobile devices and videos to provide service, the vast majority of service providers are not able to use mobile devices and videos to provide service. For example, in restaurants, diners must place orders with waiters personally, cannot get waiters' attention when the diners need, cannot use videos or audios to place orders, cannot communicate with chef, cannot communicate with wine connoisseur (sommelier). Golfers cannot communicate with caddies to get advice.

In today's physical shopping, shoppers are asked to wait in line and exit through self-check-out or employee managed counters. When there are not enough check-out counters free, the wait times increase. Unfortunately, the self-check-out counters rely on the weight of individual item being scanned before placed in the shopping bags rather than the content and value of the individual item being placed inside the shopping bags. This opens the possibility for shop lifting and requires additional manpower to monitor self-checkouts. Even employees managed check-out counters are vulnerable to fraud unless being monitored constantly. For example, customers in a grocery or convenient store may want to skip the check-out lane and grocery and convenient store operators may want to close all the check-out counters to save money and eliminate shop lifting.

In today's physical shopping, latest technology in high-definition cameras and sensors are used to build check-out counter less stores such as Amazon Go stores. But unfortunately, they are expensive and invades into shoppers' privacy.

In today's physical shopping, merchants are unable to keep the stores opened long hours because of high employee cost and because of lack of security, but shoppers demand the convenience of 24/7 shopping especially from convenient stores selling products ready to be picked up.

Because of the introduction of electronic lockers, travelers at airports can pick up mobile orders from electronic lockers placed at departing gates, arriving gates, food courts and baggage pickup areas. Because of the introduction of electronic lockers, online shoppers shopping from single family homes, apartments and offices can pick up mobile orders from electronic lockers placed at online shoppers' chosen locations. But unfortunately, this process still needs manual transfer of packages to and from robots and autonomous vehicles. Robots and autonomous vehicles can only move packages from the order fulfillment area to order pickup area after packages are manually placed on robots or on autonomous vehicles.

In today's physical shopping, shoppers are asked to pick up packages from electronic lockers located inside physical stores or located at curbside or located at drive-thru lanes or parking lots. When the electronic lockers are located inside physical stores or located at curbside, the shoppers are asked to park the vehicles and walk to the electronic lockers. Even though pickup from electronic lockers located at drive-thru lanes are faster than pickup from drive-thru windows, still the number of lockers that can be located at drive-thru lanes are very much limited. Moreover, only a limited number of orders can be left in the curbside and at drive-thru lanes for after hour pickup. For example, customers would like to pick up prescriptions 24/7 from pharmacies where the number of prescriptions to be picked up is large.

Given the fundamentally flawed state of the art with respect to sensitive information protection, it is therefore the overriding object of the present invention to improve over the prior art, in at least some implementations of the present invention, the QR Automation method further comprises the step of utilizing an intermediary agent, by providing a system and related method by which communication between strangers may be more securely conducted.

Given the fundamentally flawed state of the art with respect to employee managed and self-served counters in physical stores, it is therefore the overriding object of the present invention to improve over the prior art, in at least some implementations of the present invention, the QR Automation method further comprises the step of utilizing an intermediary agent, by providing a system and related method by which shoppers can pick up products and exit without going through check-out counters.

Given the fundamentally flawed state of the art with respect to wi-fi access control, it is therefore the overriding object of the present invention to improve over the prior art, in at least some implementations of the present invention, the QR Automation for wi-fi access method further comprises the step of broadcasting user name and password for free wi-fi access for all customers for a short period of time and utilizing an intermediary agent, by providing a system and related method by which only buyers will be provided with free wi-fi access for a long period of time. The free wi-fi access time provided to buyers will depend on the amount of purchase made by the buyers and any excess over and above the free wi-fi access time may be charged at a pre-determined rate.

Given the fundamentally flawed state of the art with respect to lockers not able to store more than one order per locker at a time, it is therefore the overriding object of the present invention to improve over the prior art, in at least some implementations of the present invention, the QR Automation for package transfer method further comprises the step of utilizing an intermediary agent, by providing a system and related method by which packages can be transferred from intermediary bins into lockers just in time for pick up.

Given the fundamentally flawed state of the art with respect to manual package transfer to and from robots and autonomous vehicles, it is therefore the overriding object of the present invention to improve over the prior art, in at least some implementations of the present invention, the QR Automation method further comprises the step of utilizing an intermediary agent, by providing a system and related method by which packages can be transferred without human intervention to and from robots and autonomous vehicles. QR Automation method for package transfer to and from robots and autonomous vehicles can not only be used in locations like airports, malls, and food courts but can also be used in single family homes, apartments, offices, and delivery/pickup centers.

Given the fundamentally flawed state of the art with respect to physical store locations selling products having employee managed check-out counters or having customer self-check-out it is therefore the overriding object of the present invention to improve over the prior art, in at least some implementations of the present invention, the QR Automation method further comprises the step of utilizing an intermediary agent, by providing a system and related method by which customers can scan and pay for the products picked up from bins and skip the counters. QR Automation method for store automation can be used at all locations.

Given the fundamentally flawed state of the art with respect to physical store locations selling products having buyers to pick up products from bins stocked with products it is therefore the overriding object of the present invention to improve over the prior art, in at least some implementations of the present invention, the QR Automation method further comprises the step of utilizing an intermediary agent, by providing a system and related method by which products can be transferred without human intervention from bins stocked with products to buyers having no entrances to enter physical store locations. QR Automation method for product transfer from bins to buyers can be used at all locations with or without drive-thru lane.

Given the fundamentally flawed state of the art with respect to self-check out at physical store locations selling it is therefore the overriding object of the present invention to improve over the prior art, in at least some implementations of the present invention, the QR Automation method further comprises the step of utilizing an intermediary agent, by providing a system and related method by which customers can scan and leave the products in a shopping basket or shopping cart where the shopping cart or shopping basket can be left inside an electronic locker from a secured area and the shopping cart or shopping basket can be retrieved from the electronic locker from unsecured area.

Additionally, it is an object of the present invention to provide such a system and related method that is robust in specific implementation and readily usable by any manner of person, entity, device, or the like. Finally, it is an object of the present invention to provide such a system and method that is economical in implementation and therefore readily accessible to virtually any application.

This invention provides a means for consumers to authenticate or verify visitors, including package delivery persons and home care personnel, to single unit and multiunit residences without exchanging sensitive information. This invention can be a complement or replacement to Video Doorbell and Intercom video systems. In general Video Doorbell systems are used in single-unit buildings and Intercom video systems are used in multiunit buildings.

This invention provides a means for businesses and merchants to automate workflow and to provide better and faster service without demanding sensitive information such as mobile numbers and/or email addresses, Snapchat code, msl code, Skype number, Whatsapp number and the like.

This invention provides a means for brick-and-mortar stores to let shoppers exit without going through check-out counters. This invention also provides a means for physical stores to protect products from shoplifting.

This invention provides a means for brick-and-mortar and online stores to deliver online orders to standalone lockers (Example: placed at single-family homes) and to a specific locker in a locker hub (Example: locker hubs at airports, malls, apartments, office buildings) using robots and autonomous vehicles. This invention provides a means in autonomous vehicles to move packages automatically from an opening provided for incoming packages to any specific intermediary bin and to move packages automatically from any specific intermediary bin to an opening provided for outgoing packages.

This invention provides a means for brick-and-mortar stores to deliver online orders to standalone drive-thru lockers placed in drive-thru lanes and standalone sprint-thru lockers placed at any spot in parking lots using conveyors, robots, drones and autonomous vehicles. This invention provides a means in autonomous vehicles to move packages automatically from an opening provided for incoming packages to any specific intermediary bin and to move packages automatically from any specific intermediary bin to an opening provided for outgoing packages.

This invention provides a means for brick-and-mortar stores to provide free wi-fi access for all customers for a short period of time and free wi-fi access only for buyers for a long period of time.

This invention provides a means for brick-and-mortar stores to reduce environmental impact by providing reusable takeout containers.

This invention provides a means for pick up lockers to receive packages from one or more intermediary bins instead of packages being manually placed inside the lockers. For example, consumers would be able to pick up prescriptions from pharmacies from drive-thru and from curbside lockers even when pharmacies are closed.

This invention provides a means for two or more participants to participate in text and/or video meetings without the participants exchanging their sensitive information.

This invention provides a means for consumers to exchange their product recommendations, blogs, and comments with fellow consumers without exchanging sensitive information like mobile phone number or email address.

For example, customers in a golf course can electronically communicate through texts and video meeting with golf course operators without providing mobile phone numbers or email addresses. Golf players can form a team and create team score cards without exchanging sensitive information like mobile phone numbers or email addresses. Golf players on a golf course can also communicate with fellow golf players and provide or get suggestions and recommendations without exchanging sensitive information like mobile phone numbers and email addresses.

For example, customers in a restaurant can electronically communicate with waiters, without providing mobile phone numbers or email addresses, to place orders using texts and video meeting instead of placing orders face to face or through apps or websites. Diners in a restaurant can also communicate with fellow diners and provide or get suggestions and recommendations without exchanging sensitive information like mobile phone numbers and email addresses. Even customers waiting in parking lots can communicate with fellow customers in parking lots and provide or get suggestions and recommendations without exchanging sensitive information like mobile phone numbers and email addresses.

For example, customers in a grocery or convenient store can electronically communicate with employees, without providing mobile phone numbers or email addresses, to get help using texts and video meeting instead of waiting for face-to-face help. Shoppers in a grocery or convenient stores can also communicate with fellow shoppers and provide or get suggestions and recommendations without exchanging sensitive information like mobile phone numbers and email addresses. Shoppers in a grocery store can also exit with picked up products without going through any type of check-out counters.

For example, customers in a pharmacy can pick up prescriptions 24/7 because pharmacies can handle large volumes of prescriptions with very few lockers using intermediary bins.

For example, customers can shop 24/7 at entry less stores.

This invention also provides a means for customers to use temporary mobile phone numbers wherever providing permanent mobile numbers are not required. This invention provides a means for consumers to receive and use, on demand, temporary mobile numbers. These temporary and on-demand mobile numbers are reusable, can be used by more than one consumer and can be used for single or multiple transactions at a time. These temporary and on-demand mobile numbers are virtual and not tied to any device permanently. For example, customers can use temporary mobile phone numbers instead of giving their permanent mobile phone numbers when signing-in with a host or to receive an electronic receipt. Temporary phone numbers may not be applicable for secured transactions like logins, payments and so on.

This invention is also intended for drivers of vehicles to exchange safety alerts between vehicles through audio systems in the vehicles when QR Code readers and QR Codes are embedded on vehicles.

### SUMMARY OF THE INVENTION

In accordance with the foregoing objects, the present invention in part—an Anonymous Communication system having an intermediary agent and providing a communication gateway between strangers without sharing sensitive information (such as for example a phone number or email address or Skype code or Snapchat code or Whatsapp code or wallet number and the like) —generally comprises a means for receiving from a visitor (such as, for example, a deliverer delivering goods to an occupant in a single or multiunit building, a service provider such as a plumber providing service to an occupant in a single or multiunit building, a diner signing in a restaurant, a golf player signing in a golf course, a buyer signing in any physical location, a buyer placing an order with an entry less physical location) a request, in the form of an alpha-numeric message received from a visitor's device that was captured from a machine readable code such as Bar Code or QR Code, for a communication channel with a stranger who purportedly displayed the machine readable code (such as for example, an occupant of a single unit building, a restaurant operator, a golf course operator, a grocery store operator, a merchant owner and the like) or a communication channel with a stranger on whose behalf the machine readable code was purportedly displayed (such as for example, an occupant of a multiunit building on whose behalf the multiunit building operator displayed the machine readable code); a means for authenticating or verifying the visitor; a means for verifying the said request; a means for receiving a consent for communication from a person or entity purportedly displayed the machine readable code or a means for receiving a consent for communication from a person or entity on whose behalf the machine readable code was displayed; a means for providing a communication channel between the said visitor and the said stranger.

In accordance with the foregoing objects, the present invention in part—a Free Wi-fi Access system providing a free wi-fi access by a merchant in the said merchant location for all customers for a short period of time and having an intermediary agent and providing a free or paid wi-fi access for all buyers of products or services provided by the said merchant for a long period of time.

In accordance with the foregoing objects, the present invention in part—an Automation System having an intermediary agent and providing a vending gateway to protect products from shop lifting and for shoppers, upon completing purchases, to exit without going through check-out counters such as self-check-out counters or employee managed check-out counters and the like—generally comprises a means for pre-payment authentication at physical stores through said Automation system or any third-party pre-payment authentication system; a means for said shoppers being verified at any electronic racks being placed in the said physical store through a manual verification system such as QR Code or fingerprint reader or through an automated verification system such as Near Field Communication (NFC) reader or Radio Frequency Identification (RFID) reader and the like attached to the said electronic racks and the NFC tags or RFID tags attached to shopping cart or shopping basked in possession of said shoppers before letting the said shoppers to pick one or more products from the said electronic racks.

In accordance with the foregoing objects, the present invention in part—an Automation System having an intermediary agent and providing a vending gateway to protect products from shop lifting and for shoppers, upon completing purchases, to exit without going through check-out counters such as self-check-out counters or employee managed check-out counters and the like—generally comprises a means for pre-payment authentication at physical stores through said Automation system or any third-party pre-payment authentication system; a means for said shoppers being verified at any electronic bins being placed in the said physical store through a manual verification system such as QR Code or fingerprint reader or through an automated verification system such as Near Field Communication (NFC) reader or in possession of said shoppers before letting the said shoppers Bluetooth Identification reader and the like attached to the said electronic bins and the NFC tags or Bluetooth attached to mobile devices to pick up products from the said electronic bins.

In accordance with the foregoing objects, the present invention in part—an Automation System having an intermediary agent and providing a package transfer gateway for package transfer machine, having incoming bins, intermediary bins, outgoing bins and a package transporter, to receive incoming packages automatically into any specific intermediary bin through incoming bin and to deliver outgoing packages automatically from any specific intermediary bin through any specific outgoing bin—generally comprises a means for incoming bin to scan a QR Code printed on incoming packages and to direct a package transporter to move incoming packages to a specific intermediary bin, a means to accept pickup ready input from outgoing package recipients and to direct package transporter to move outgoing packages from any specific intermediary bin to any specific outgoing bin and a means for package recipients to scan a QR Code displayed on outgoing bins or to enter an one-time code on a keypad attached to outgoing bins. Some package transfer machines may directly transport packages from incoming bin to outgoing and said package transfer machines may not have intermediary bins and may not have resource to accept ready input from outgoing package recipients.

In accordance with the foregoing objects, the present invention in part—an Automation System having an intermediary agent and providing a product transfer gateway for product transfer machine, having product bins, drive-thru lockers (outgoing bins), curbside lockers (outgoing bins) and a product transporter, to deliver outgoing orders automatically from one or more specific product bins through any specific drive-thru outgoing bins or any specific curbside outgoing bins—generally comprises a means to receive orders, a means for shoppers to scan a QR Code printed on drive-thru or curbside outgoing bins or to communicate through Near Field Communication (NFC) reader or to communicate through Bluetooth reader attached to drive-thru or curbside outgoing bins and a means to direct a product transporter to move outgoing products from specific product bins to specific drive-thru outgoing or curbside outgoing bins.

In at least some implementations of the present invention, further comprises a means for consumers to register with the said intermediary agent and for businesses to register their employees with the said intermediary agent. Consumers registered with the said intermediary agent are referred as visitor clients. Employees registered with the said intermediary agent are referred as employee clients.

In at least some implementations of the present invention, further comprises a means for authenticating the visitor and employee clients.

In at least some implementations of the present invention, further comprises a means for verifying intruders. Any person scanning the QR Code who is not a visitor client and is not an employee client is referred to as an intruder.

In at least some implementations of the present invention, further comprises a means for the visitor clients and employee clients to use an app provided by the said intermediary agent or interfaced with the said intermediary agent. In at least some implementations of the present invention, further comprises a means for the said intermediary agent to restrict access for visitor clients and employee clients only through an app provided by the said intermediary agent or interfaced with the said intermediary agent.

In at least some implementations of the present invention, further comprises a means to provide a free wi-fi access for all consumers for a short period of time and a means to provide a free wi-fi access for buyers only for a long period of time.

In at least some implementations of the present invention, further comprises a means to verify that the visitor clients and employee clients are present in a location where the QR Code is displayed.

In at least some implementations of the present invention, further comprises a means for intruders to use an internet browser instead of using an app provided by the said intermediary agent or an app interfaced with the said intermediary agent.

In at least some implementations of the present invention, further comprises a means to verify device location captured from visitor clients' and employee clients' app interfaced with the said intermediary agent or a means to verify location based on IP address captured from intruder's browser by the said intermediary agent.

In at least some implementations of the present invention, further comprises a means for single unit residential building owners or renters to register with the said intermediary agent. Owners or renters of single unit residential buildings registered with the said intermediary agent are referred as home clients.

In at least some implementations of the present invention, further comprises a means for single unit commercial building owners or renters to register with the said intermediary agent. Owners or renters of single unit commercial buildings registered with the said intermediary agent are referred as merchant clients.

In at least some implementations of the present invention, further comprises a means for single unit commercial building owners or renters engaged in restaurant business to register with the said intermediary agent. Owners or renters of single unit commercial buildings engaged in restaurant business and registered with the said intermediary agent are referred as restaurant clients.

In at least some implementations of the present invention, further comprises a means for single unit commercial building owners or renters to register with the said intermediary agent. Owners or renters of single unit commercial buildings and registered with the said intermediary agent are referred as operator clients.

In at least some implementations of the present invention, further comprises a means for multiunit building (such as apartments, office buildings, gated communities, and the like) administrators to register with the said intermediary agent. Multiunit building operators registered with the said intermediary agent are referred as administrator clients.

In at least some implementations of the present invention, further comprises a means for administrator clients to add/edit/delete information about individual unit occupants of multiunit buildings administrated by said administrator clients. Multiunit building occupants registered with the said intermediary agent are referred as condo clients.

In at least some implementations of the present invention, further comprises a means for visitor clients in selecting a condo client where the said condo client is selected from a list of condo clients maintained by multiunit building administrators.

In at least some implementations of the present invention, further comprises a means for the said visitor client and the said home client to use a text communication channel provided by the said intermediary agent between the said visitor client app and the said home client app.

In at least some implementations of the present invention, further comprises a means for the said visitor client and the said home client to use an internal audio/video communication channel provided by the said intermediary agent between the said visitor client app and the said home client app.

In at least some implementations of the present invention, further comprises a means for the said visitor client or the said home client to use an external audio/video communication channel and share the external communication credentials through the said text communication channel provided by the said intermediary agent between the said visitor client app and the said home client app.

In at least some implementations of the present invention, further comprises a means for the said visitor client and the said condo client to use a text communication channel provided by the said intermediary agent between the said visitor client app and the said condo client app.

In at least some implementations of the present invention, further comprises a means for the said visitor client and the said condo client to use an internal audio/video communication channel provided by the said intermediary agent between the said visitor client app and the said condo client app.

In at least some implementations of the present invention, further comprises a means for the said visitor client or the said condo client to use an external audio/video communication channel and share the external communication credentials through the said text communication channel provided by the said intermediary agent between the said visitor client app and the said condo client app.

In at least some implementations of the present invention, further comprises a means for the said intruder and the said home client to use a text communication channel provided by the said intermediary agent between the said intruder browser and the said home client app.

In at least some implementations of the present invention, further comprises a means for the said intruder and the said home client to use an internal audio/video communication channel provided by the said intermediary agent between the said intruder browser and the said home client app.

In at least some implementations of the present invention, further comprises a means for the said intruder or the said home client to use an external audio/video communication channel and share the external communication credentials through the said text communication channel provided by the said intermediary agent between the said intruder browser and the said home client app.

In at least some implementations of the present invention, further comprises a means for the said intruder and the said condo client to use a text communication channel provided by the said intermediary agent between the said intruder browser and the said condo client app.

In at least some implementations of the present invention, further comprises a means for the said intruder and the said condo client to use an internal audio/video communication channel provided by the said intermediary agent between the said intruder browser and the said condo client app.

In at least some implementations of the present invention, further comprises a means for the said intruder or the said condo client to use an external audio/video communication channel and share the external communication credentials through the said text communication channel provided by the said intermediary agent between the said intruder browser and the said condo client app.

In at least some implementations of the present invention, further comprises a means for the restaurant or merchant clients to maintain a menu or a price list or merchant specific information.

In at least some implementations of the present invention, further comprises a means for the restaurant or merchant clients to maintain a waitlist.

In at least some implementations of the present invention, further comprises a means for the visitor clients to view a menu or a price list or merchant specific information through the communication channel provided by the said intermediary agent between the said visitor client app and the said merchant client app or browser.

In at least some implementations of the present invention, further comprises a means for the said visitor client to make a purchase of one or more items from the said menu or from the said price list of the said merchant client through the communication channel provided by the said intermediary agent between the visitor client app and the merchant client app or browser.

In at least some implementations of the present invention, further comprises a means for the said visitor client to sign-in for service with the said merchant client through the communication channel provided by the said intermediary agent between the visitor client app and the merchant client app or browser.

In at least some implementations of the present invention, further comprises a means for the operator client to maintain golf course cart information, golf bag information of golf players walking instead of riding a cart.

In at least some implementations of the present invention, further comprises a means for the operator client to maintain GPS (latitude and longitude) information of tee off boxes and holes.

In at least some implementations of the present invention, further comprises a means for the operator client to maintain electronic score cards.

In at least some implementations of the present invention, further comprises a means for the visitor client to enter scores in an electronic golf score card received from the operator client.

In at least some implementations of the present invention, further comprises a means for the intruders to view a menu or a price list or merchant specific information through the communication channel provided by the said intermediary agent between the said intruder browser and the said merchant client app or browser.

In at least some implementations of the present invention, further comprises a means for the said intruder to make a purchase of one or more items from the said menu or from the said price list of the said merchant client through the communication channel provided by the said intermediary agent between the intruder browser and the merchant client app or browser.

In at least some implementations of the present invention, further comprises a means for the said intruder to sign-in for service with the said merchant client through the communication channel provided by the said intermediary agent between the intruder browser and the merchant client app or browser.

In at least some implementations of the present invention, further comprises a means for the intruder to enter scores in an electronic golf score card received from the operator client.

In at least some implementations of the present invention, further comprises a means for all visitor clients and intruders to communicate with fellow visitor clients and intruders through a group communication channel where the group communication channel can be for text and/or for audio and/or for video and where the group communication channel can be internal or external provided by an external resource provider during the said fellow visitor clients and intruders have an open communication channel with the same merchant client (for example such as merchant or golf course operator, restaurant operator and the like).

In at least some implementations of the present invention, further comprises a means for the said merchant clients to communicate with the said visitor clients and intruders through multiple channels and through multiple devices simultaneously.

In at least some implementations of the present invention, further comprises a means for physical store clients to maintain a price list and merchant specific information.

In at least some implementations of the present invention, further comprises a means for physical store clients to maintain electronic racks fitted with unique rack QR Code, fitted with unique rack tag reader capable of reading NFC or RFID or similar tags and capable of communicating with an intermediary agent through an API (application programming interface) provided by the said intermediary agent. The electronic racks are also fitted with one or more uniquely designated bin to stock individual product where each uniquely designated bin is also fitted with unique product QR Code and with uniquely identifiable sensors that can communicate with an intermediary agent through an API provided by said intermediary agent to protect the stocked product from being shop lifted.

In at least some implementations of the present invention, further comprises a means for the said visitor client to scan the said unique product QR Code to view the details of the said unique product.

In at least some implementations of the present invention, further comprises a means for the said visitor client to park shopping cart or shopping basket fitted with unique NFC or RFID or any other readable tag to be read by the rack tag reader to get permission from an intermediary agent using an API provided by the said intermediary agent for the visitor client to pick one or more products from bins attached to the rack.

In at least some implementations of the present invention, further comprises a means for intruders to scan the said unique product QR Code to view the details of the said unique product.

In at least some implementations of the present invention, further comprises a means for shoppers to scan the said unique electronic rack QR Code to get permission to pick one or more products from bins attached to the rack.

In at least some implementations of the present invention, further comprises a means for shoppers to scan the said unique electronic bin QR Code to get permission to pick the products from the bin.

In at least some implementations of the present invention, further comprises a means for the package transfer owners and employees to maintain package transfer machine identifier information.

In at least some implementations of the present invention, further comprises a means for the package transfer owners and employees to maintain intermediary bin identifier information in each package transfer machine.

In at least some implementations of the present invention, further comprises an incoming bin for packages to enter package transfer machine where the incoming bin may or may not have a door.

In at least some implementations of the present invention, further comprises a QR Code reader and/or NFC reader and/or RFID reader and the like in the incoming bin in the package transfer machine to identify the incoming packages.

In at least some implementations of the present invention, further comprises a QR Code reader and/or NFC reader and/or RFID reader and the like near the incoming bin in the package transfer machine to identify external outgoing bin identifier such as a box or a locker holding a package to be moved into incoming bin in the package transfer machine.

In at least some implementations of the present invention, further comprises a means for QR Code reader and/or NFC reader and/or RFID reader and the like equipped in the incoming bin in the package transfer machine to communicate with a server to receive the intermediary bin identifier information where the incoming package will be moved.

In at least some implementations of the present invention, further comprises a means for the package transfer machine to move the incoming packages to a designated intermediary bin.

In at least some implementations of the present invention, further comprises a package out going bin for packages to exit from package transfer machine where the package out going bin may or may not have a door to accept packages from package transporter.

In at least some implementations of the present invention, further comprises a QR Code reader and/or NFC reader and/or RFID reader and the like near outgoing bin in the package transfer machine to identify external incoming bin identifier such as a box or a locker waiting to receive a package from package transfer machine.

In at least some implementations of the present invention, further comprises a means for QR Code reader and/or NFC reader and/or RFID reader and the like equipped near the outgoing bin in the package transfer machine to communicate with a server to receive the intermediary bin identifier information where the outgoing package has been stored.

In at least some implementations of the present invention, further comprises a means for the package transfer machine to move the outgoing packages from a designated outgoing bin in the package transfer machine to external incoming bin such as a box or a locker waiting to receive a package from package transfer machine.

In at least some implementations of the present invention, further comprises electronic doors protecting packages stored in outgoing bins in package transfer machine where the said electronic doors can be opened using a one-time code or by scanning a unique QR Code assigned to each electronic door.

In at least some implementations of the present invention, further comprises means for package transfer machine to be mobile where the package transfer machine may be mounted on manually driven trucks or self-driving autonomous trucks or robots and the like.

In at least some implementations of the present invention, further comprises a means for the product transfer owners, administrators, and employees to maintain product transfer machine identifier information.

In at least some implementations of the present invention, further comprises a means for the product transfer owners, administrators, and employees to maintain product bin identifier information in each product transfer machine.

In at least some implementations of the present invention, further comprises a means for the product transfer owners, administrators, and employees to stock products in product bins in each product transfer machine.

In at least some implementations of the present invention, further comprises a means for the product transfer owners, administrators, and employees to maintain identifier of products stocked in product bins in each product transfer machine.

In at least some implementations of the present invention, further comprises a QR Code reader and/or NFC reader and/or RFID reader and the like near curbside pickup bins in the product transfer machine for pickup recipients to convey ready to pick up notification.

In at least some implementations of the present invention, further comprises a QR Code in an iPoster, a poster with a QR Code, in parking lots designated for product transfer machine for pickup recipients to convey ready to pick up notification.

In at least some implementations of the present invention, further comprises a QR Code in an iPoster, a poster with a QR Code, in parking lots designated for product transfer machine for customers to place an order.

In at least some implementations of the present invention, further comprises a QR Code in a pickup controller placed at curbside designated for product transfer machine for pickup recipients to convey ready to pick up notification.

In at least some implementations of the present invention, further comprises a QR Code in a pickup controller placed at curbside designated for product transfer machine for customers to place an order.

In at least some implementations of the present invention, further comprises a means for the product transfer machine to move products from designated product bins in the product transfer machine to designated intermediary bins.

In at least some implementations of the present invention, further comprises a means for the product transfer machine to move products from designated intermediary bins in the product transfer machine to designated pick up bins.

In at least some implementations of the present invention, further comprises electronic doors protecting packages stored in pickup bins in product transfer machine where the said electronic doors can be opened using a one-time code or by scanning a unique QR Code assigned to each electronic door.

In at least some implementations of the present invention, further comprises a means to move products from bin to bin using product transports and intermediary transporter using methods such as rails, robots, and the like.

In at least some implementations of the present invention, further comprises a means for a shopper client to use a temporary communication identifier such as a temporary phone number for communication with a stranger where the said stranger demands a communication identifier such as a cell phone number from the visitor client instead of displaying a machine-readable code with a request message for communication.

One of the most important aspects of the present invention is the content of the QR Code and the method in which the content of the QR Code is processed by the intermediary agent using various databases and applications. Each database will have one or more tables and each table will have one or more fields. For faster retrieval, tables may have one or more Primary Key fields and one or more Indexed fields. Fields denoted with characters ‘PK’ are Primary Key fields. Fields denoted with character ‘I’ are Indexed fields. Each application will have one or more programs and each program will have one or more instructions. The content of the QR Code could be in any pre-defined format, but would generally be in an URL format, so that an app provided by the intermediary agent, or any app interfaced with the intermediary agent, or any generic QR Code Reader app can scan the QR Code. In one of the names and value pairs in the query string of the URL, the value of a specific name could hold the request message. For example, the string in the name would be ‘MSL_Code’ and the string in the value would be a value to identify the request message. For example, the URL could be https://www.mysinglelink.com/web_scripts.asp?MSL_Code=45-John-Home1-Entrance1. The content of the QR Code can also be just a string with delimiters such as ‘,’ or ‘;’ or ‘?’ or ‘_’ or ‘-’ and the like which can identify the request message where the QR Code will be scanned only using an app provided by the intermediary agent or any app interfaced with the intermediary agent. For example, the string could be a delimited text with various segments such as 45-John-Home1-Entrance1. The content of the QR Code can also be just a string without any delimiters such as ‘92018382207’ where the QR Code will be scanned only using an app provided by the intermediary agent or any app interfaced with the intermediary agent and the string can be used by the intermediary agent to expand the string into various segments. The request message can also be stored in multiple names and value pairs in the query string of the URL, For example, the URL could be https://www.mysinglelink.com/web_scripts.cfm?MSL_Code_Segment1=45&MSL_Code_Segment2=John&MSL_Code_Segment3=Home1&MSL_Code_Segment4-Entrance1.

For example the request message in the QR Code could be 1) the person scanning the QR Code likes to communicate with an occupant of a single unit home or office or 2) the person scanning the QR Code likes to communicate with an occupant of one of the units in a multiunit building or 3) the person scanning the QR Code likes to communicate with an employee of a business or merchant in order to buy a product or service and/or to communicate with other shoppers to share recommendations and suggestions or service or 4) the person scanning the QR Code likes to communicate with employees of golf course and/or with fellow golf players in the golf course or 5) the person scanning the QR Code likes to purchase products by picking up goods from bins and leave without going through any check-out counter and/or to communicate with fellow shoppers to share recommendations and suggestions or service or 6) the person scanning the QR Code likes to use an online ordering system to place an order and pick up or to sign-in to pick up products from outgoing bins placed at curbside or at drive-thru lane or at driveway by stores with or without entry or 8) a buyer scanning a QR Code or a single item in a menu or a price list to purchase or add to a shopping cart or 7) a machine scanning the QR Code likes to execute a specific task.

The request message in the QR Code could be in any pre-defined form but generally be in the form of a string delimited with different segments and presented to an intermediary agent. The delimiter can be any character. The value in each segment in the request message will be used by the intermediary agent to process the request. Generally, the first segment will be an application identifier. For example application identifier 45 may be for a communication between the person scanned the QR Code and the occupant of a single unit building, 65 may be for a communication between the person scanned the QR Code and the occupant of a single-unit in a multiunit building, 77 may be for a communication between the person scanned the QR Code and employees and shoppers of a business or merchant in order to sign-in to purchase a product or service or 87 may be to sign-out after purchasing a product or service or 327 may be to buy a selective product or service from a menu of products and services or 97 may be for players in a golf course to place an order or 107 may be to sign-in from an iPoster in a store to pick up a product and leave without going through any check-out counter and for a communication between the person scanned the QR Code and employees and shoppers of a store or 127 may be to get a shopping cart or shopping basket assignment or to sign-in and get a shopping cart or shopping basket assignment in a store or 147 may be to get rack permission to pick up one or more products one or more times from any bin in the said rack in a store or 167 may be to get a product details and/or to get a bin permission to pick up a product stored in a specific bin in a store or 187 may be to sign-out from an iPoster in a store to return goods and leave or 207 may be for a package transfer machine to receive an incoming package identifier, verify the incoming package identifier and insert a row in a incoming queue table or 227 may be for a package transfer machine to receive an outgoing package identifier, verify outgoing package identifier and insert a row in an outgoing queue table or 247 may be in a package transfer machine to identify that the incoming data is from intermediary package controller or 347 may be in a product transfer machine to identify that the incoming data is from pickup controller or 367 may be in a product transfer machine to identify that the incoming data is from parking lot pickup iPoster or 387 may be in a product transfer machine to identify that the incoming data is from curbside pickup controller QR Code or 307 may be in a product transfer machine to identify that the incoming data is from delivery controller.

The number of segments in the request message may vary depending on the application identifier. The segments starting from the 2^{nd} segment will be used by the intermediary agent to access, add or edit data in databases.

For example, the request message 45-John-Home1-Entrance1 would direct the intermediary agent to access the data from Single Unit Building Database as shown in a class diagram in FIG. 7 where the OWNER_ID is John, LOCATION_ID is Home1 and ENTRANCE_ID is Entrance1. For example, the request message 65-ABC Corp-Bldg11-Gate9 would direct the intermediary agent to access the data from Multi Unit Building Database as shown in a class diagram in FIG. 8 where the OWNER_ID is ABC Corp, LOCATION_ID is Bldg11 and ENTRANCE_ID is Gate9. For example, the request message 77-Taco Village-DAL19 would direct the intermediary agent to access the data from Restaurant Database as shown in a class diagram in FIGS. 9 & 9A where the OWNER_ID is Taco Village, RESTAURANT_ID is DAL19 and the person scanning the QR Code wants to sign in. For example, the request message 327-Taco Village-DAL19-Soup-Ministrone would direct the intermediary agent to access the data from Restaurant Database where the OWNER_ID is Taco Village, RESTAURANT_ID is DAL19 and the person scanning the QR Code wants to get more information or to purchase in the group Soup and the item Ministrone. For example, the request message 87-Taco Village-DAL19 would direct the intermediary agent to access the data from Restaurant Database where the OWNER_ID is Taco Village, RESTAURANT_ID is DAL19 and the person scanning the QR Code wants to sign out. For example, the request message 77-ABC Golf-FL23 would direct the intermediary agent to access the data from golf course Database as shown in a class diagram in FIG. 10 where the OWNER_ID is ABC Golf, GOLF_COURSE_ID is FL23 and the person scanning the QR Code wants to sign in. For example when the person scanning the QR Code is ready to drop the incoming package, the request message 207-My Pharmacny-TX42 would direct the intermediary agent to accept incoming order identifier, verify incoming order identifier and insert a row in a queue table in package transfer Database as shown in a class diagram in FIG. 44 where the OWNER_ID is My Pharmacy, MACHINE_ID is TX42 and PACKAGE_TYPE is ‘N’ along with other information. For example when the person scanning the QR Code is ready to pick up the outgoing package, the request message 227-My Pharmacy-TX42 would direct the intermediary agent to accept outgoing package identifier, verify outgoing package identifier and insert a row in outgoing queue table in package transfer Database as shown in a class diagram in FIG. 44 where the OWNER_ID is My Pharmacy, MACHINE_ID is TX42 and PACKAGE_TYPE is ‘O’ along with other information. For example, when the package transfer machine intermediary agent receives a request message 247-PackageOwner1-Machine1 from intermediary package controller, the intermediary agent would access the data from Package Transfer Database as shown in a class diagram in FIG. 44 where the OWNER_ID is PackageOwner1, MACHINE_ID is Machine1 and process the request message. For example, when the product transfer machine intermediary agent receives a request message 347-ProductOwner1-Machine1 from pickup controller, the intermediary agent would access the data from Product Transfer Database as shown in a class diagram in FIG. 54 where the OWNER_ID is ProductOwner1, MACHINE_ID is Machine1 and process the request message. For example, when the product transfer machine intermediary agent receives a request message 367-ProductOwner1-Machine1 from a mobile device scanning the QR Code in a drive-thru iPoster, the intermediary agent would access the data from Product Transfer Database as shown in a class diagram in FIG. 54 where the OWNER_ID is ProductOwner1, MACHINE_ID is Machine1 and process the request message. For example, when the product transfer machine intermediary agent receives a request message 387-ProductOwner1-Machine1 from a mobile device scanning the QR Code in a curbside pickup controller, the intermediary agent would access the data from Product Transfer Database as shown in a class diagram in FIG. 54 where the OWNER_ID is ProductOwner1, MACHINE_ID is Machine1 and process the request message. For example, when the product transfer machine intermediary agent receives a request message 307-ProductOwner1-Machine1-DI from delivery controller, the intermediary agent would access the data from Product Transfer Database as shown in a class diagram in FIG. 54 where 307 is application identifier, the OWNER_ID is ProductOwner1, MACHINE_ID is Machine1, DI is for inquiry and process the request message. For example, when the product transfer machine intermediary agent receives a request message 307-ProductOwner1-Machine1-DU from delivery controller, the intermediary agent would access the data from Product Transfer Database as shown in a class diagram in FIG. 54 where 307 is application identifier, the OWNER_ID is ProductOwner1, MACHINE_ID is Machine1, DU is for update and process the request message. For example, when the product transfer machine intermediary agent receives a request message 307-ProductOwner1-Machine1-DD from delivery controller, the intermediary agent would access the data from Product Transfer Database as shown in a class diagram in FIG. 54 where 307 is application identifier, the OWNER_ID is ProductOwner1, MACHINE_ID is Machine1, DD is for display and process the request message.

### BRIEF SUMMARY OF THE DRAWINGS

Although the scope of the present invention is much broader than any particular embodiment, a detailed description of the preferred embodiments where the preferred embodiments are such as QR Automation for Video Doorbell, QR Automation for Intercom video, QR Automation for Restaurant, QR Automation for golf course, QR Automation for package transfer machine, QR Automation for product transfer machine and the like, follows together with illustrative figures, wherein like reference numerals refer to like components, and wherein:

FIGS. 1A & 1B show, in an overview use case diagram, the various basic functionality implemented for some of the preferred embodiments of the present invention for single-unit (QR Automation for Video Doorbell) and/or for multiunit (QR Automation for Intercom Video) residences and commercial buildings.

FIGS. 2A & 2B show, in an overview use case diagram, the various basic functionality implemented in another preferred embodiment of the present invention for any business or merchant such as a restaurant (QR Automation for Restaurant).

FIGS. 3A & 3B show, in an overview use case diagram, the various basic functionality implemented in one of the preferred embodiments of the present invention for a golf course (QR Automation for Golf Course).

FIGS. 3C & 3D show, in an overview use case diagram, the various additional functionality implemented in one of the preferred embodiments of the present invention for a golf course (QR Automation for Golf Course).

FIG. 4 shows, in a flowchart, an overview of the various steps generally taken in displaying a request message (QR Code) by a home (single unit), condo (multiunit) or merchant or golf course or store client for a communication by a visitor or intruder with the said home or condo or merchant or golf course or store clients and various steps taken by the intermediary agent in accordance with the present invention.

FIG. 5 shows, in an overview sequence diagram, various interactions as generally taken place during the operation of the present invention.

FIG. 6 shows, in a class diagram, a high-level schema for a representative Intermediary Agent Customer database (58-13) as may be implemented in accordance with the present invention.

FIG. 7 shows, in a class diagram, a high-level schema for a representative Single Unit Building database (58-14) as may be implemented in accordance with the present invention.

FIG. 8 shows, in a class diagram, a high-level schema for a representative Multiunit Building database (58-15) as may be implemented in accordance with the present invention.

FIGS. 9 & 9A show, in a class diagram, a high-level schema for a representative Restaurant (58-16) database as may be implemented in accordance with the present invention.

FIGS. 10 and 10A show, in a class diagram, a high-level schema for a representative golf course database (58-17) as may be implemented in accordance with the present invention.

FIG. 11 shows, in a class diagram, a high-level schema for a representative Cell Number Rental database (58-18) as may be implemented in accordance with the present invention.

FIG. 12 shows, in a flowchart, an overview of the various steps generally taken by consumers and employees of businesses registering and maintaining personal information with the intermediary agent in accordance with the present invention.

FIG. 12A shows, in a flowchart, an overview of the various steps generally taken by a customer registering and maintaining payment information with the intermediary agent in accordance with the present invention.

FIG. 13 shows, in a flowchart, an overview of the various steps generally taken by businesses in registering and maintaining their information and their employee's information with the intermediary agent in intermediary agent customer database in accordance with the present invention.

FIG. 14 shows, in a flowchart, an overview of the various steps generally taken by a businesses in maintaining their business and their employee's information with the intermediary agent in accordance with the present invention.

FIG. 15 shows, in a flowchart, an overview of the various steps generally taken by an occupant of a single unit structure in registering and maintaining single unit entrances information with the intermediary agent in accordance with the present invention.

FIG. 15A shows, in a flowchart, an overview of the various steps generally taken by an occupant of a single unit structure in downloading a QR Code for each registered entrance in the said single unit structure from intermediary agent in accordance with the present invention.

FIG. 15B shows, an elevation view of a single unit structure with a QR Code displayed at each entrance of the said single unit structure by the occupant of the said single unit structure where the said QR Code was downloaded from intermediary agent by the said single unit owner or renter in accordance with the present invention.

FIG. 15C shows, in a flowchart, an overview of the various steps generally taken by an occupant of a single unit structure or a visitor client in downloading or viewing a log report for any entrance in a single unit structure for any period in accordance with the present invention.

FIG. 16 shows, in a flowchart, an overview of the various steps generally taken by an administrator of a multiunit structure in registering and maintaining the information of entrances of the said multiunit structure with the intermediary agent in accordance with the present invention.

FIG. 17 shows, in a flowchart, an overview of the various steps generally taken by an administrator of a multiunit structure in registering and maintaining occupants of individual units in the said multiunit structure with the intermediary agent in accordance with the present invention.

FIG. 17A shows, in a flowchart, an overview of the various steps generally taken by an administrator of a multiunit structure in downloading a QR Code for each registered entrance in the multiunit structure from intermediary agent in accordance with the present invention.

FIG. 17B shows, an elevation view of a multiunit structure with a QR Code displayed at each entrance of the said multiunit structure by an administrator of the said multiunit structure where the said QR Code was downloaded from intermediary agent by the said administrator in accordance with the present invention.

FIG. 17C shows, in a flowchart, an overview of the various steps generally taken by an occupant of a multiunit structure in activating a package delivery code and for visitor client or intruder in inactivating said package delivery code in accordance with the present invention.

FIG. 17D shows, in a flowchart, an overview of the various steps generally taken by an occupant or administrator of a multiunit structure or a visitor client in downloading or viewing a log report for any entrance in a multiunit structure for any period in accordance with the present invention.

FIG. 18 shows, in a flowchart, an overview of the various steps generally taken by an operator of a restaurant in registering and maintaining location & table information in the said restaurant with the intermediary agent in accordance with the present invention.

FIG. 18A shows, in a flowchart, an overview of the various steps generally taken by an operator of a restaurant in registering and maintaining employee information in the said restaurant with the intermediary agent in accordance with the present invention.

FIG. 18B shows, in a flowchart, an overview of the various steps generally taken by an operator or employees of a restaurant in setting up area and table information in the said restaurant with the intermediary agent in accordance with the present invention.

FIG. 18C shows, in a flowchart, an overview of the various steps generally taken by an operator or employees of a restaurant in setting up external and internal video channel setup in the said restaurant with the intermediary agent in accordance with the present invention.

FIG. 19 shows, in a flowchart, an overview of the various steps generally taken by an operator of a restaurant in registering and maintaining location & menu information in the said restaurant with the intermediary agent in accordance with the present invention.

FIG. 20 shows, in a flowchart, an overview of the various steps generally taken by the intermediary agent in capturing payment information from customers and order information from restaurant operator in maintaining the point of sales information in accordance with the present invention.

FIG. 21 shows, in a flowchart, an overview of the various steps generally taken by the intermediary agent in capturing sign-in information from customers and seating information from restaurant operators in maintaining the waitlist information in accordance with the present invention.

FIG. 21A shows, in a flowchart, an overview of the various steps generally taken by a restaurant in downloading a QR Code for customers to sign-in from intermediary agent in accordance with the present invention.

FIG. 21B shows, an elevation view of a restaurant location with a QR Code displayed for customers to sign-in where the said QR Code was downloaded from intermediary agent by the said merchant in accordance with the present invention. The figure also includes a wi-fi password for a short period of time for those who need wi-fi.

FIG. 21C shows, a web page view in a consumer mobile device for consumers to select an employee for a text communication.

FIG. 21D shows, a web page view in a consumer mobile device for consumers to enter a meeting identifier for an internal or external video meeting.

FIG. 21E shows, a big display screen with waitlist information.

FIG. 21F shows, an elevation view of seating in a restaurant location with a seating map on a mobile screen, a digital screen displayed with a seating map and a robot waiting to guide a customer to a table in accordance with the present invention.

FIG. 21G shows, a web page view in a consumer mobile device for consumers to view menu and/or place orders.

FIG. 21H shows, a web page view in a consumer mobile device for consumers to view single-item in the menu and make a purchase.

FIG. 21I shows, a web page view in a consumer mobile device for consumers to view wi-fi access details for buyers.

FIG. 22 shows, in a flowchart, an overview of the various steps generally taken by an operator of a golf course in registering and maintaining location & hole information in the said golf course with the intermediary agent in accordance with the present invention.

FIG. 22A shows, in a flowchart, an overview of the various steps generally taken by an operator of a golf course in adding and editing employee information in the said golf course with the intermediary agent in accordance with the present invention.

FIG. 22B shows, in a flowchart, an overview of the various steps generally taken by an operator or employee of a golf course in adding and editing golf course hole information in the said golf course with the intermediary agent in accordance with the present invention.

FIG. 22C shows, in a flowchart, an overview of the various steps generally taken by an operator or employee of a golf course in adding and editing ordering station information in the said golf course with the intermediary agent in accordance with the present invention.

FIG. 23 shows, in a flowchart, an overview of the various steps generally taken by an operator of a golf course in registering and maintaining golf cart and golf bag identifier information in the said golf course with the intermediary agent in accordance with the present invention.

FIG. 24 shows, in a flowchart, an overview of the various steps generally taken by an operator of a golf course in registering and maintaining golf score card information in the said golf course with the intermediary agent in accordance with the present invention.

FIG. 25 shows, in a flowchart, an overview of the various steps generally taken by an operator or employee of a golf course in downloading various QR Codes information in the said golf course with the intermediary agent in accordance with the present invention.

FIG. 25A shows examples of QR Code content generally used in a golf course in accordance with the present invention.

FIG. 25B shows, an elevation view of a golf course location with a QR Code displayed for players to sign-in where the said QR Code was downloaded from intermediary agent by the said golf course in accordance with the present invention.

FIG. 25C shows, a golf cart with a QR Code displayed for players to scan before starting the game where the said QR Code was downloaded from intermediary agent by the said golf course in accordance with the present invention.

FIG. 25D shows, a golf bag with a QR Code displayed for players to scan before starting the game where the said QR Code was downloaded from intermediary agent by the said golf course in accordance with the present invention.

FIG. 25E shows, an elevation view of a golf course order station with a QR Code displayed for players to place an order from an ordering station where the said QR Code was downloaded from intermediary agent by the said golf course in accordance with the present invention.

FIG. 25F shows, an elevation view of a golf course location with a QR Code displayed for players to sign-out where the said QR Code was downloaded from intermediary agent by the said golf course in accordance with the present invention.

FIG. 25G shows a web page view in a consumer mobile device for consumers to view menu and/or place orders.

FIG. 25H shows a big display screen with waitlist information.

FIG. 26 shows, in a flowchart, an overview of the various steps generally taken by a temporary cell number renter in starting the rental, managing the rental and ending the rental information with the intermediary agent in accordance with the present invention.

FIG. 27 shows, in a flowchart, an overview of the various steps generally taken by the intermediary agent to set up a text communication between visitor client and owner client in accordance with the present invention.

FIG. 28 shows, in a flowchart, an overview of the various steps generally taken by the intermediary agent to set up a text communication between intruder and owner client in accordance with the present invention.

FIG. 29 shows, in a flowchart, an overview of the various steps generally taken by the intermediary agent to set up a text & video communication between visitor client and owner client in accordance with the present invention.

FIG. 30 shows, in a flowchart, an overview of the various steps generally taken by the intermediary agent to set up a text & video communication between intruder and owner client in accordance with the present invention.

FIGS. 31A & 31B show, in an overview use case diagram, the various basic functionality implemented for some of the preferred embodiments of the present invention for store automation.

FIG. 32 shows, in a flowchart, an overview of the various steps generally taken in processing a request message (QR Code) and providing access for a visitor or intruder to a store and various steps taken by the intermediary agent in accordance with the present invention.

FIG. 33 shows, in an overview sequence diagram, various interactions as generally taken by a visitor or intruder in gaining access to the store or a rack during the operation of Store Automation in accordance with the present invention.

FIGS. 34, 34A and 34B show, in a class diagram, a high-level schema for a representative Store database (58-19) as may be implemented in accordance with the present invention.

FIG. 35A shows, in a flowchart, an overview of the various steps generally taken by an operator of a store in registering as an owner of one or more stores with the intermediary agent in accordance with the present invention.

FIG. 35B shows, in a flowchart, an overview of the various steps generally taken by an operator of a store in registering and maintaining location information of the said stores with the intermediary agent in accordance with the present invention.

FIG. 35C shows, in a flowchart, an overview of the various steps generally taken by an operator of a store in maintaining employee information in the said store with the intermediary agent in accordance with the present invention.

FIG. 35D shows, in a flowchart, an overview of the various steps generally taken by an operator of a store in maintaining product information in the said store with the intermediary agent in accordance with the present invention.

FIG. 35E shows, in a flowchart, an overview of the various steps generally taken by an operator of a store in registering and maintaining rack information in the said store with the intermediary agent in accordance with the present invention.

FIG. 35F shows, in a flowchart, an overview of the various steps generally taken by an operator of a store in registering and maintaining bin information in the said store with the intermediary agent in accordance with the present invention.

FIG. 35G shows, in a flowchart, an overview of the various steps generally taken by an operator of a store in registering and maintaining shopping cart and shopping basket information in the said store with the intermediary agent in accordance with the present invention.

FIG. 36A shows, in a flowchart, an overview of the various steps generally taken by a store in downloading Shopping Cart or Shopping Basket Assignment QR Codes from intermediary agent that can be attached to shopping carts or shopping baskets in accordance with the present invention.

FIG. 36B shows, in a flowchart, an overview of the various steps generally taken by a store in downloading Sign-in QR Codes from intermediary agent that can be used in iPosters in accordance with the present invention.

FIG. 36C shows, in a flowchart, an overview of the various steps generally taken by a store in downloading Rack QR Codes from intermediary agent that can be displayed on electronic racks in accordance with the present invention.

FIG. 36D shows, in a flowchart, an overview of the various steps generally taken by a store in downloading Bin QR Codes from intermediary agent that can be displayed on bins in accordance with the present invention.

FIG. 36E shows, in a flowchart, an overview of the various steps generally taken by a store in downloading Exit QR Codes from intermediary agent that can be displayed on return stations in accordance with the present invention.

FIG. 37A shows, in a front view of the various parts generally installed in an electronic rack with one or more bins used to display products for pickup by shoppers in accordance with the present invention.

FIG. 37B shows, in a side view of the various parts generally installed in an electronic rack with one or more bins used to display products for pickup by shoppers in accordance with the present invention.

FIG. 37C shows, in a front view of the various parts generally installed in a return station for products to be returned by shoppers in accordance with the present invention.

FIG. 37AP shows a front view of the various parts generally installed in an electronic rack with one or more bins used to display products for pickup by shoppers using product pusher technology instead of product sensor technology in accordance with the present invention.

FIG. 37BP shows a side view of the various parts generally installed in an electronic rack with one or more bins used to display products for pickup by shoppers using product pusher technology instead of product sensor technology in accordance with the present invention.

FIG. 37CP shows, in a front view of the various parts generally installed in a return station for products to be returned by shoppers in accordance with the present invention.

FIG. 38A shows, in a flowchart, an overview of the various steps generally taken by a store in syncing rack and tag reader attached to the said rack in accordance with the present invention.

FIG. 38B shows, in a flowchart, an overview of the various steps generally taken by a store in syncing bin and sensor monitoring said bin in accordance with the present invention.

FIG. 38C shows, in a flowchart, an overview of the various steps generally taken by a store in syncing bin and product placed inside said bin in accordance with the present invention.

FIG. 38D shows, in a flowchart, an overview of the various steps generally taken by a store in syncing shopping cart or shopping basket with identifier of tag attached to the said shopping cart or shopping basket in accordance with the present invention.

FIG. 38E shows, in a flowchart, an overview of the various steps generally taken by a store in maintaining product inventory in each bin in accordance with the present invention.

FIG. 39A shows, a shopping cart with a QR Code, one or more machine-readable tags with identifiers used in a store where the said QR Code was downloaded from intermediary agent by the said store and the machine-readable tag identifiers are synced with the shopping cart number in accordance with the present invention.

FIG. 39B shows, a shopping basket with a QR Code, one or more machine-readable tags with identifiers used in a store where the said QR Code was downloaded from intermediary agent by the said store and the machine-readable tag identifiers are synced with shopping basket number in accordance with the present invention.

FIG. 39C shows, an iPoster with a QR Code displayed in a store where the said QR Code was downloaded from intermediary agent by the said store in accordance with the present invention/

FIG. 40A shows, in a flowchart, an overview of the various steps generally taken by the intermediary agent in maintaining customer order summary information in each store in accordance with the present invention.

FIG. 40B shows, in a flowchart, an overview of the various steps generally taken by the intermediary agent in maintaining customer order detail information in each store in accordance with the present invention.

FIG. 40C shows, in a flowchart, an overview of the various steps generally taken by the intermediary agent in maintaining customer order return information in each store in accordance with the present invention.

FIGS. 41A & 41B show in an overview use case diagram, the various basic functionality implemented for some of the preferred embodiments of the present invention for package transfer automation.

FIG. 42 shows in a flowchart, an overview of the various steps generally taken by the intermediary agent in verifying orders with an order management system before a package being handled by package transfer automation system.

FIG. 43 shows in an overview sequence diagram, various interactions as generally taken place while accessing order management system in the present package transfer automation invention.

FIG. 44 shows, in a class diagram, a high-level schema for a representative Package Transfer Automation (58-20) database as may be implemented in accordance with the present package transfer automation invention;

FIG. 45A shows in a flowchart, an overview of the various steps generally taken by an owner of a package transfer machine in registering as an owner of one or more package transfer automation machines with the intermediary agent in accordance with the present package transfer automation invention.

FIG. 45B shows in a flowchart, an overview of the various steps generally taken by an owner of a package transfer machine in registering employees of package transfer machine owner with the intermediary agent in accordance with the present package transfer automation invention.

FIG. 45C shows in a flowchart, an overview of the various steps generally taken by an owner or employee of a package transfer machine in registering and editing package transfer machine parameters with the intermediary agent in accordance with the present package transfer automation invention.

FIG. 45D shows in a flowchart, an overview of the various steps generally taken by an owner or an employee of a package transfer machine in registering and editing bin in package transfer machine with the intermediary agent in accordance with the present package transfer automation invention.

FIG. 45E shows in a flowchart, an overview of the various steps generally taken by an owner or an employee of a package transfer machine in registering and editing aisle in package transfer machine with the intermediary agent in accordance with the present package transfer automation invention.

FIG. 46 shows in a flowchart, an overview of the various steps generally taken in downloading and displaying a request message (QR Code) by a package transfer machine owner or an employee for an incoming package controller identifier or outgoing package controller identifier and various steps taken by the intermediary agent in accordance with the present package transfer automation invention.

FIG. 47A shows various parts generally used in a package direct transfer machine in accordance with the present package transfer automation invention.

FIG. 47B shows a top view of various parts generally assembled in a package direct transfer machine in accordance with the present package transfer automation invention; Note that parts assembled one above the other are shown in the order in which they are assembled from top to bottom.

FIG. 47C shows a front view of various parts generally assembled in a package direct transfer machine in accordance with the present package transfer automation invention.

FIG. 47D shows a back view of various parts generally assembled in a package direct transfer machine in accordance with the present package transfer automation invention.

FIG. 47E shows right side view of various parts generally assembled in a package direct transfer machine in accordance with the present package transfer automation invention; Note that parts assembled one behind the other are shown in the order in which they are assembled from front to back.

FIG. 47F shows an illustration of package pickup side of a package direct transfer machine in accordance with the present package transfer automation invention.

FIG. 47G shows an illustration of package drop side of a package direct transfer machine in accordance with the present package transfer automation invention.

FIG. 48A shows various parts generally used in a package intermediary transfer machine with the present package transfer automation invention; Note that package intermediary transfer machine uses a package holder bin whereas package direct transfer machine does not use a package holder bin.

FIG. 48B shows a top view of various parts generally assembled in a package intermediary transfer machine that uses package holder bins in accordance with the present package transfer automation invention. Note that parts assembled one above the other are shown in the order in which they are assembled from top to bottom.

FIG. 48C shows a front view of various parts generally assembled in a package intermediary transfer machine that uses package holder bins in accordance with the present package transfer automation invention. Note that parts assembled one behind the other are shown in the order in intermediary mover which they are assembled from near to far.

FIG. 48D shows a back view of various parts generally assembled in a package intermediary transfer machine that uses package holder bins in accordance with the present package transfer automation invention. Note that parts assembled one behind the other are shown in the order in which they are assembled from near to far.

FIG. 48E shows a right side view of various parts generally assembled in a package intermediary transfer machine that uses package holder bins in accordance with the present package transfer automation invention. Note that parts assembled one behind the other are shown in the order in which they are assembled from near to far.

FIG. 48F shows a right side view of various parts generally assembled in a package intermediary transfer machine that uses a robot instead of rails in accordance with the present package transfer automation invention. Note that parts assembled one behind the other are shown in the order in which they are assembled from near to far.

FIG. 48G shows a front view of various parts generally assembled in a package intermediary transfer machine in accordance with the present package transfer automation invention.

FIG. 49 shows a front view of package delivery (driver driven or driver less) truck delivering a package in accordance with the present package transfer automation invention.

FIG. 50 shows a right-side view of manual package load, robot package load and autonomous vehicle package load in accordance with the present package transfer automation invention.

FIGS. 51A & 51B show various parts generally used in a product transfer machine in accordance with the present product transfer automation invention; Note any store with a product transfer machine can be entry less store.

FIG. 52 shows in a flowchart, an overview of the various steps generally taken by the intermediary agent in verifying orders with an order management system before an order being handled by product transfer automation system.

FIG. 53 shows in an overview sequence diagram, various interactions as generally taken place while accessing order management system in the present product transfer automation invention.

FIG. 54 shows, in a class diagram, a high-level schema for a representative Product Transfer Automation (58-21) database as may be implemented in accordance with the present product transfer automation invention.

FIG. 55A shows in a flowchart, an overview of the various steps generally taken by an owner of a product transfer machine in registering as an owner of one or more product transfer automation machines with the intermediary agent in accordance with the present product transfer automation invention.

FIG. 55B shows in a flowchart, an overview of the various steps generally taken by an owner of a product transfer machine in registering employees of product transfer machine owner with the intermediary agent in accordance with the present product transfer automation invention.

FIG. 55C shows in a flowchart, an overview of the various steps generally taken by an owner or employee of a product transfer machine in registering and editing product transfer machine parameters with the intermediary agent in accordance with the present product transfer automation invention.

FIG. 55D shows in a flowchart, an overview of the various steps generally taken by an owner or an employee of a product transfer machine in registering and editing bin in product transfer machine with the intermediary agent in accordance with the present product transfer automation invention.

FIG. 55E shows in a flowchart, an overview of the various steps generally taken by an owner of a product transfer machine in registering vendors of product transfer machine with the intermediary agent in accordance with the present product transfer automation invention.

FIG. 56 shows in a flowchart, an overview of the various steps generally taken in downloading and displaying a request message (QR Code) by a product transfer machine owner or an employee in accordance with the present product transfer automation invention.

FIG. 57A shows various parts generally used in a product transfer machine in accordance with the present product transfer automation invention.

FIG. 57B shows a top view of various parts generally assembled in a product transfer machine that use rails to move transporters carrying products in accordance with the present product transfer automation invention. Note that parts assembled one above the other are shown in the order in which they are assembled from top to bottom.

FIG. 57C shows a top view of various parts generally assembled in a product transfer machine that use robots to move transporters carrying products in accordance with the present product transfer automation invention. Note that parts assembled one above the other are shown in the order in which they are assembled from top to bottom.

FIG. 57D shows a front view of various parts generally assembled in a product transfer machine for buyers to pick up orders from order pickup bins located at the curbside and at drive-thru lane in accordance with the present product transfer automation invention.

FIG. 57E shows a curbside view of various parts generally assembled in a product transfer machine for buyers to pick up orders from order pickup bins located at the curbside and at drive-thru lane in accordance with the present product transfer automation invention.

FIG. 57F shows a back view of various parts generally assembled in a product transfer machine for vendor entrance in accordance with the present product transfer automation invention.

FIG. 57G shows a QR Code for customers to place an order and sign-in to pick up or to sign-in to pick up already placed order generally displayed at the curbside and at the drive-thru in parking lot where a product transfer machine is installed in accordance with the present product transfer automation invention.

FIG. 58 shows, in a deployment diagram, an overview of the various steps generally taken by the intermediary agent in providing services as an intermediary agent in accordance with the present invention.

FIG. 59 shows, in a deployment diagram, various details of at least one implementation of a user interface for use in connection with the exemplary hardware and software implementation of FIG. 58.

### DETAILED DESCRIPTION OF THE INVENTION

Although those of ordinary skill in the art will readily recognize many alternative embodiments, especially in light of the illustrations provided herein, this detailed description is exemplary of the preferred embodiments of the present invention, the scope of which is limited only by the claims appended hereto.

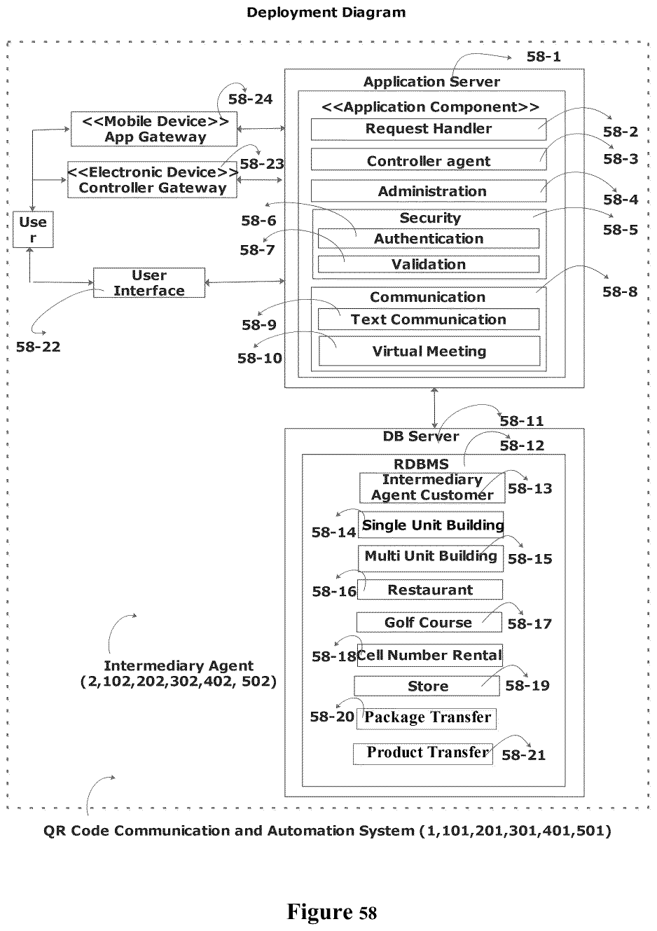

In order, to better describe these critical aspects of each preferred embodiment of the present invention, however, reference is now made to the deployment diagram of FIG. 58, wherein there is shown the various elements of an exemplary hardware and software based implementation of a QR Anonymous Communication and QR Automation system (1) constructed for single and multiunit buildings, QR Automation system (101) constructed for restaurants, QR Automation system (201) constructed for golf courses, QR Automation system (301) constructed for store in particular for grocery and convenient stores, QR Automation system (401) constructed for package transfer in particular for pharmacies and QR Automation system (501) constructed for product transfer in particular for entry less convenient stores in accordance with the teachings of the present invention.

Before continuing, however, it is noted that while the implementation depicted in FIG. 58 is exemplary of the preferred embodiments of the present invention, it is in no manner meant to be all encompassing or otherwise limiting of the wide range of implementations as are possible. It is also noted that implementation depicted in FIG. 58 is exemplary of the preferred embodiments of the present invention, only one or more of the preferred embodiments can be implemented in a single deployment and not all the preferred embodiments may be implemented in a single deployment.

In addition, it is noted that while some elements are in FIG. 58 shown to comprise hardware and others software, virtually any element could be implemented in either hardware or software or any combination thereof. Still further, it is noted that while for clarity of discussion various hardware elements are segregated between different machines and various software elements are segregated into various components, no such segregation should be deemed as required unless specifically stated herein and further or differing division into various particular components, modules, classes, objects, processes or the like should be taken as within the scope of the present invention as limited only by the claims appended hereto. Finally, to the extent that any structural (including software) element is stated as being adapted to perform some function, such language is to be taken as a positive structural limitation imposed upon the referenced element whereby the element is required to be actually adapted, programmed, configured or otherwise provided with the actual capability for performing the specified function. In no case shall such language be taken as merely a statement of intended use or the like, but to the contrary such language shall be in every case taken to read on all structures of the referenced element that are in any manner actually in the present tense configured to perform the specified function (as opposed to being merely capable of adaption for the conduct of the specified function).

Turning then to FIG. 58, an intermediary agent (2) or (102) or (202) or (302) or (402) or (502) (such as, for example, may comprise a specialized provider of the QR Automation services of the present invention; a provider of other products or services having need of QR Code Communication & Automation services, such as, for example, any business, single and multiunit buildings, restaurants, golf courses, stores, banks, airport, government buildings or the like) is shown for purposes of this exemplary discussion to have associated therewith one or more application servers 58-1 or database servers 58-11 upon which may be hosted software functionality necessary to operation within the framework of the present invention. In particular, an application server 58-1 would accept data through app gateway 58-24, controller gateway 58-23, as well as through user interface 58-22. QR Code inputs from app provided by intermediary agent (2, 102, 202, 302, 402 and 502) or from any app interfaced with intermediary agent (2, 102, 202, 302, 402 and 502) or from QR Code Reader app or from camera and responses from intermediary agent (2, 102, 202, 302, 402 and 502) would be communicated through app gateway 58-23. Inputs from microcontrollers in sensors and tag readers and responses, if any, from intermediary agent (2, 102, 202, 302, 402 and 502) would be communicated through controller gateway 58-23. Any input from app browser or mobile device browser or desktop browser and responses from intermediary agent (2, 102, 202, 302, 402 and 502) would be communicated through user interface 58-22. In particular, an application server 58-1 may host a request handler software component 58-2 adapted to handle app requests communicated through app gateway 58-24, controller agent 58-3 adapted to handle all controller requests communicated through controller gateway 58-23 and administration component 58-4 adapted to handle all other inputs through user interface 58-22 as well as to generate responses for app requests, controller requests and for other inputs as may be necessary in the operation of the present invention.

The request handler 58-2 hosted by the application server 58-1 may be adapted to handle or otherwise control all aspects of the requests from app gateway within the realm of responsibility of the intermediary agent (2, 102, 202, 302, 402 and 502), including receiving requests, storing and/or retrieving data pertinent to the processing of such requests and directing the authentication or validation or communication of requests and respond, if any, based upon the results of such authentication or validation or communication requests. In order, to improve efficiency and security of authentication or validation requests, the security component 58-5 may comprise one or more further specialized components such as, for example, an authentication component 58-6 or a validation component 58-7, which can be accessed by request handler, adapted to conduct the specialized task of authenticating using fingerprints or any other authentication methods, validating one-time passcodes, validating user id and password.

The administration 58-4 hosted by the application server 58-1 may be adapted to handle or otherwise control all aspects of the inputs from user interface 58-22 within the realm of responsibility of the intermediary agent (2, 102, 202, 302 402 and 502), including receiving inputs, storing and/or retrieving data pertinent to the processing of such inputs.

In order, to improve efficiency and security of communication requests, the communication component 58-8 may comprise one or more further specialized components such as, for example, a text communication component 58-9 or a video communication component 58-10, which can be accessed by request handler or administration, adapted to conduct the specialized task of providing text communication and/or video communication.

The controller agent 58-3 hosted by the application server 58-1 may be adapted to handle or otherwise control all aspects of the controller request (for example such as requests from sensors, tag readers and the like) within the realm of responsibility of the intermediary agent (2, 102, 202, 302. 402 and 502), including receiving controller requests, storing and/or retrieving data pertinent to the processing of such requests and directing the validation of controller requests and respond, if any, based upon the results of such validations. In order, to improve efficiency and security, the security component 58-5 may comprise one or more further specialized components such as, for example, a validation component 58-7, which can be accessed by controller agent, adapted to conduct the specialized task of comparing received controller identifier within the controller request with one of the saved controller identifiers. In addition to validating controller identifiers, validation component 58-7 may also be adapted to conduct the specialized task of comparing received tag identifier within the controller request with one of the saved tag identifiers.

An administration component 58-4 hosted by the application server 58-1 through which various aspects of the setup, maintenance and operation of the hardware and software systems of the intermediary agent (2, 102, 202, 302, 402 and 502) may be managed by inputs through user interface.

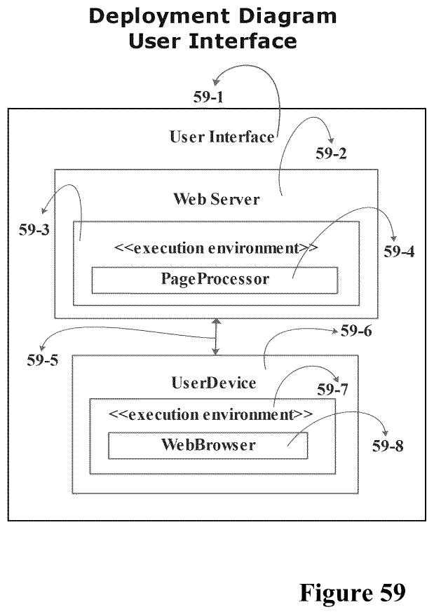

Although the user interface 58-22 may take a wide variety of forms depending upon the circumstances of any particular implementation, a typical user interface may be implemented as a web interface 59-1 as shown in FIG. 59, wherein there may be provided a page processor 59-4 hosted on an appropriate application components 59-3 installed on a dedicated web server 59-2 in an internet communication 59-5 with a user device 59-6, such as, for example, a personal computer, smart phone or the like, and on which is installed and/or hosted a web browser 59-8 running in a provided application components 59-7. In any case, as will be appreciated by those of ordinary skill in the art, the provision of a user interface 58-22, which of course should be secured, enables the various users, to maintain and/or otherwise manage the data stored in the intermediary agent customer database 58-13, single unit building database 58-14, multiunit building database 58-15, restaurant database 58-16, golf course database 58-17, cell number rental database 58-18, store database 58-19, package transfer database 58-20 and product transfer database 58-21 as may be appropriate as well as to generally manage and maintain the implemented QR Automation system (1. 101. 201, 301, 401 and 501).

In order, to efficiently manage and handle the large quantity of data that may typically be stored in connection with an implementation of the present invention, one or more dedicated database servers 58-11 hosting database management systems 58-12 are generally desired. As shown in FIG. 58, a typical database management system 58-12 may include an intermediary agent customer database 58-13 for storing a wide variety of generally customer centric data as may be required in the operation of the present invention, a single unit building database 58-14 for storing a wide variety of generally single unit building centric data as may be required in the operation of the present invention, a multiunit building centric database 58-15 for storing a wide variety of generally multiunit building centric data as may be required in the operation of the present invention, a restaurant database 58-16 for storing a wide variety of generally restaurant centric data generally as may be required in the operation of the present invention, a golf course database 58-17 for storing a wide variety of generally golf course centric data generally associated with the conduct of individual transactions in the operation of the present invention, a cell number rental database 58-18 for storing a wide variety of generally cell number rental centric data generally associated with the conduct of individual transactions in the operation of the present invention, a store database 58-19 for storing a wide variety of generally store centric data as may be required in the operation of the present invention, a package transfer database 58-20 for storing a wide variety of generally package transfer centric data as may be required in the operation of the present invention and a product transfer database 58-21 for storing a wide variety of generally product transfer centric data as may be required in the operation of the present invention.

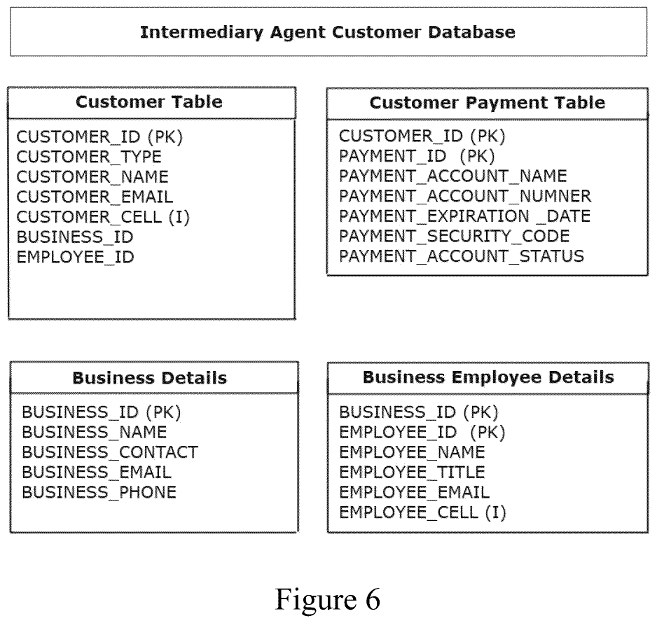

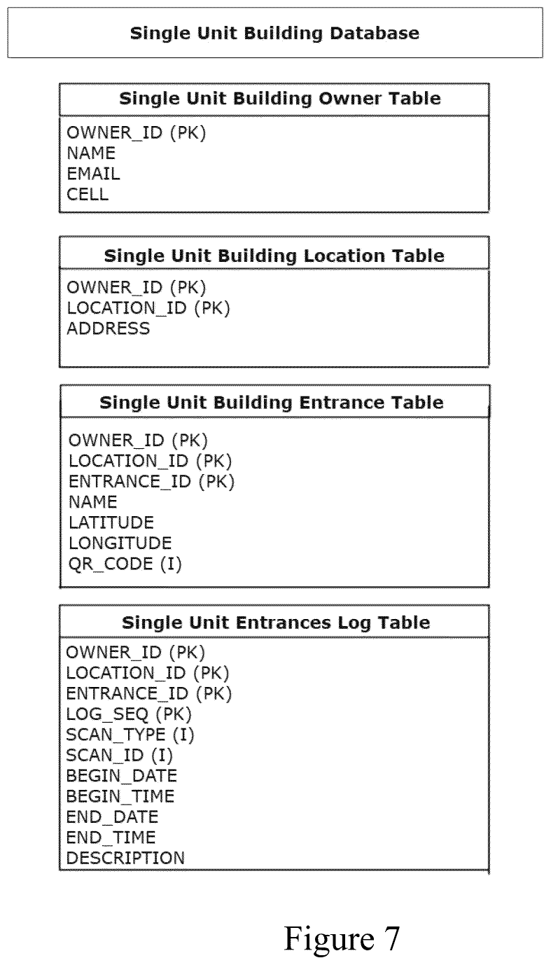

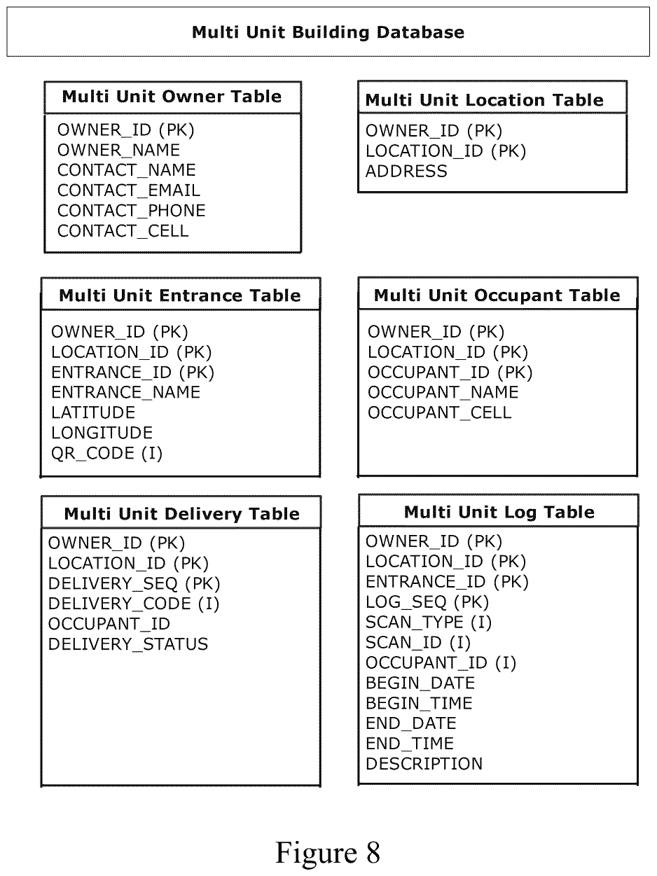

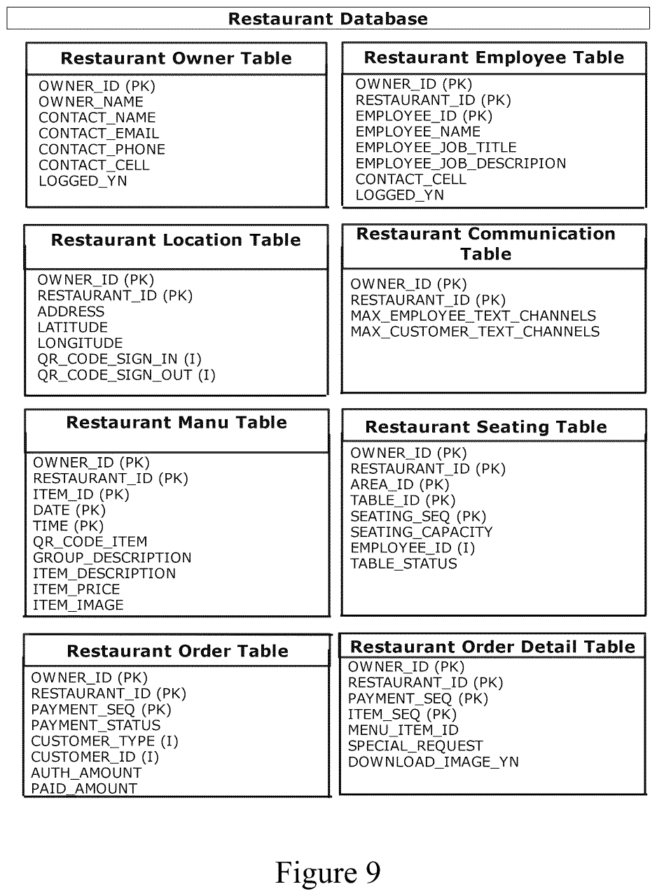

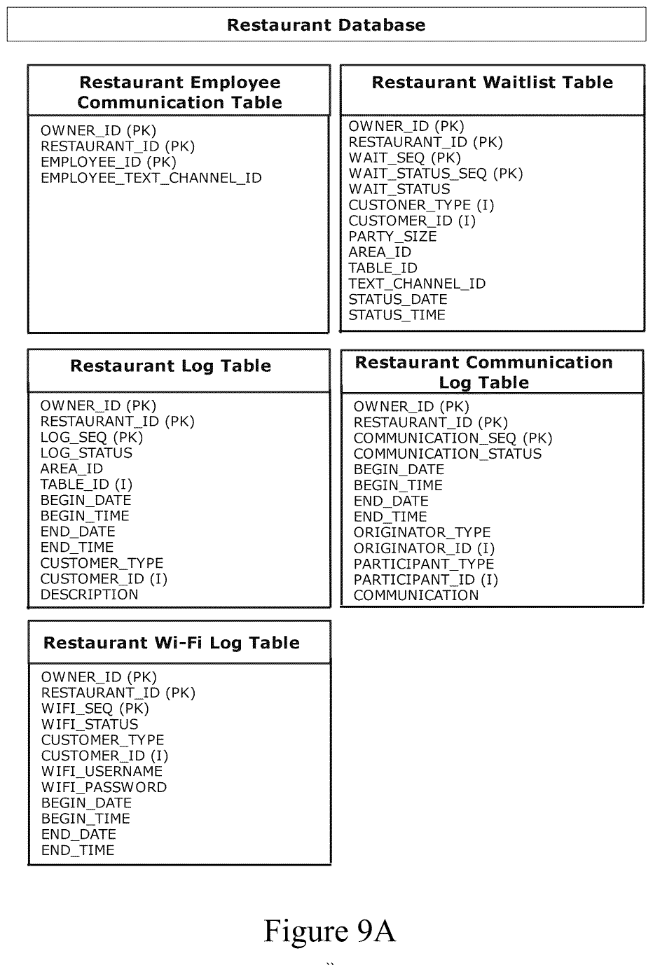

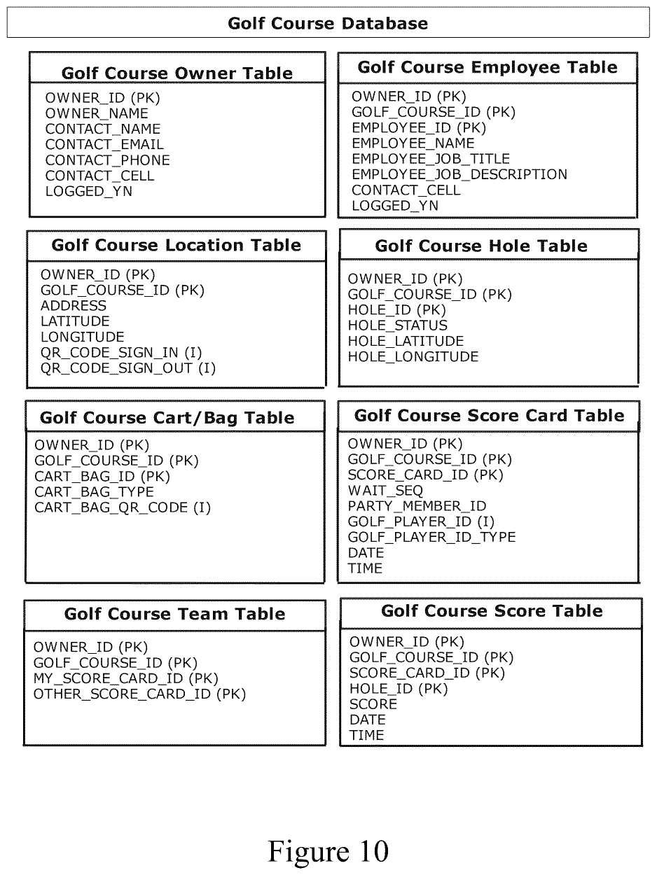

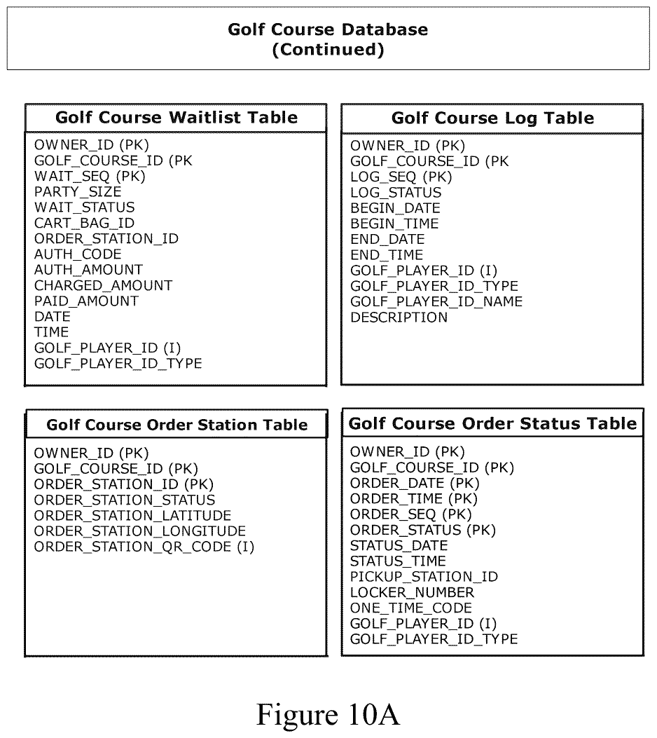

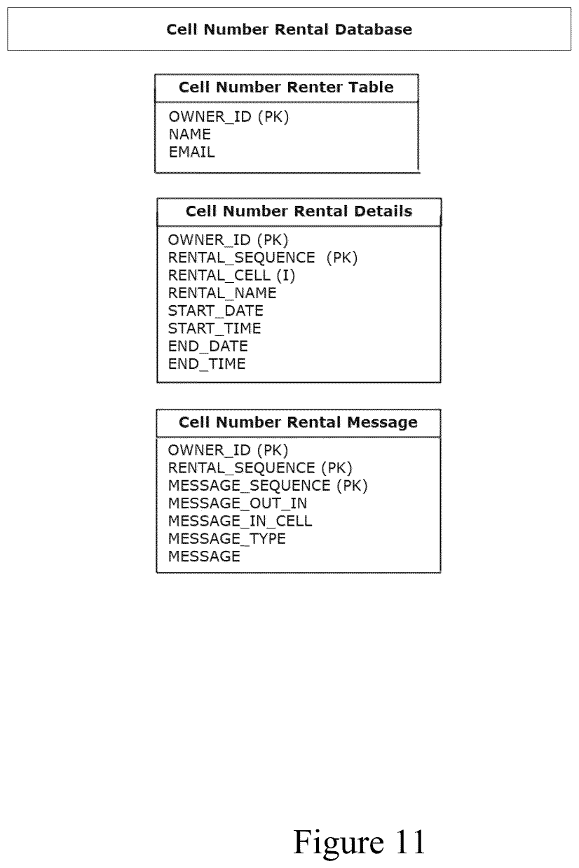

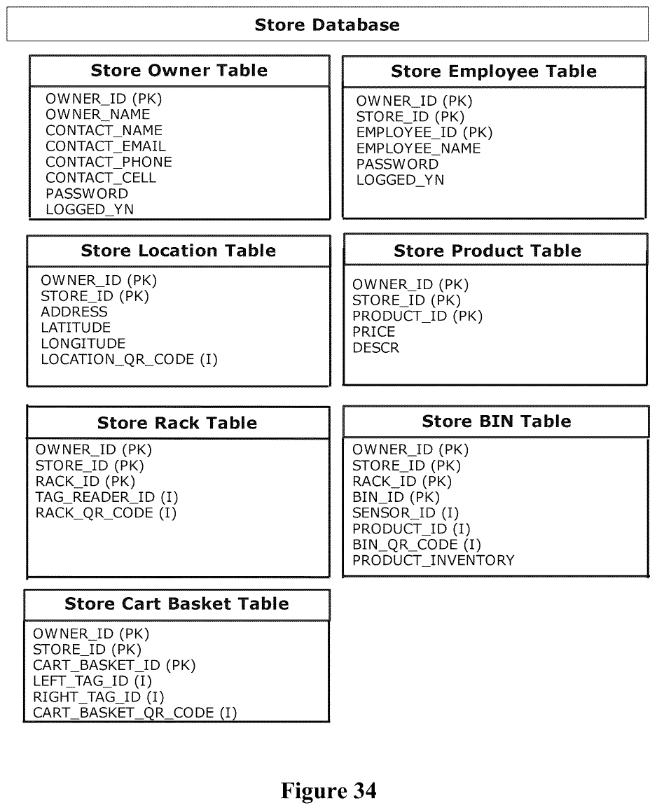

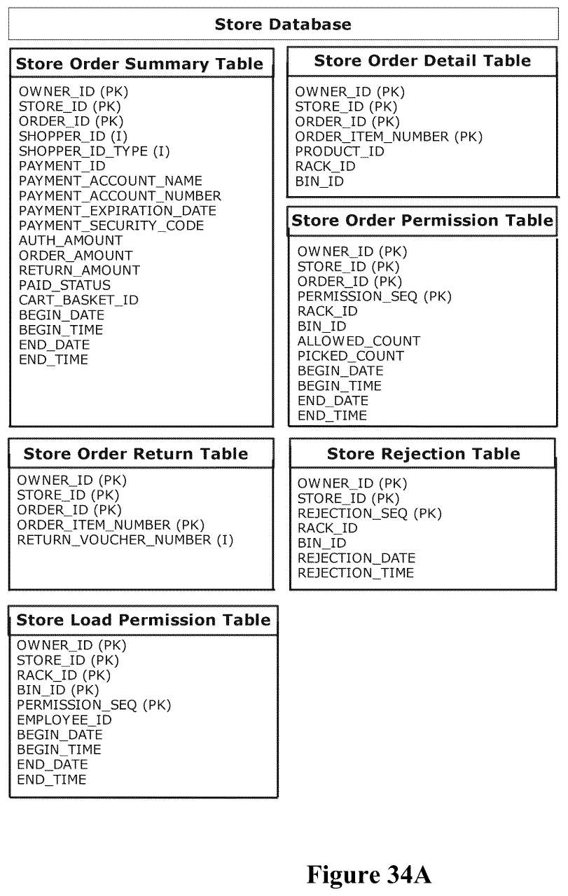

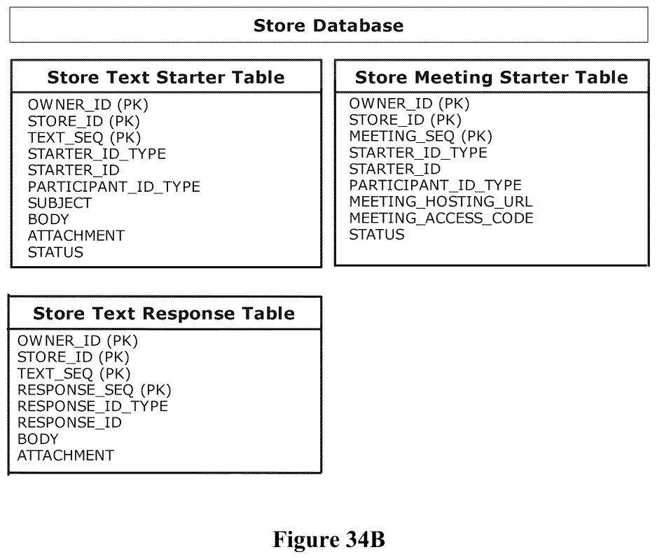

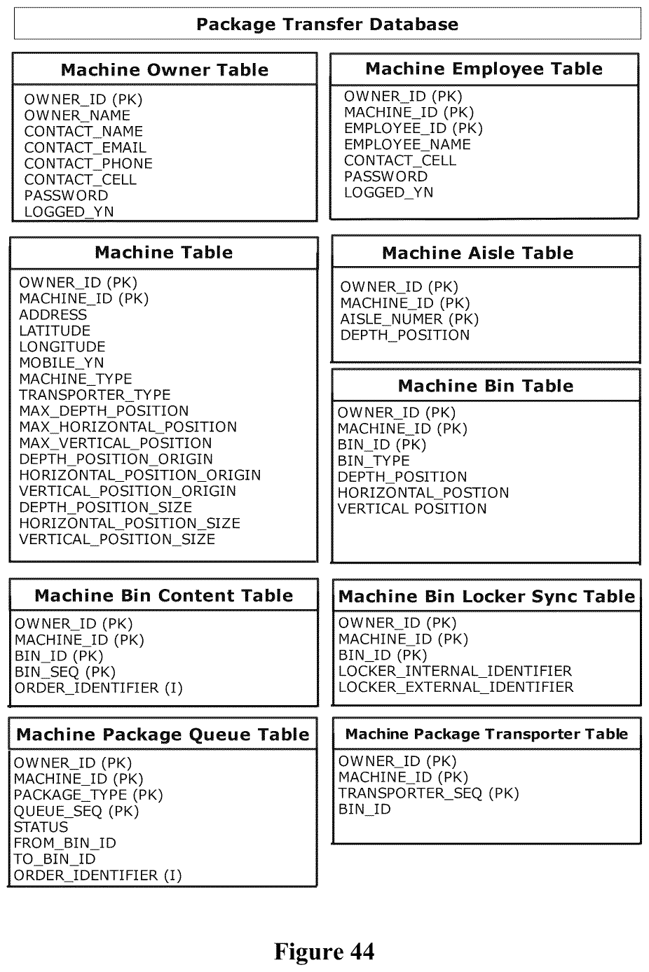

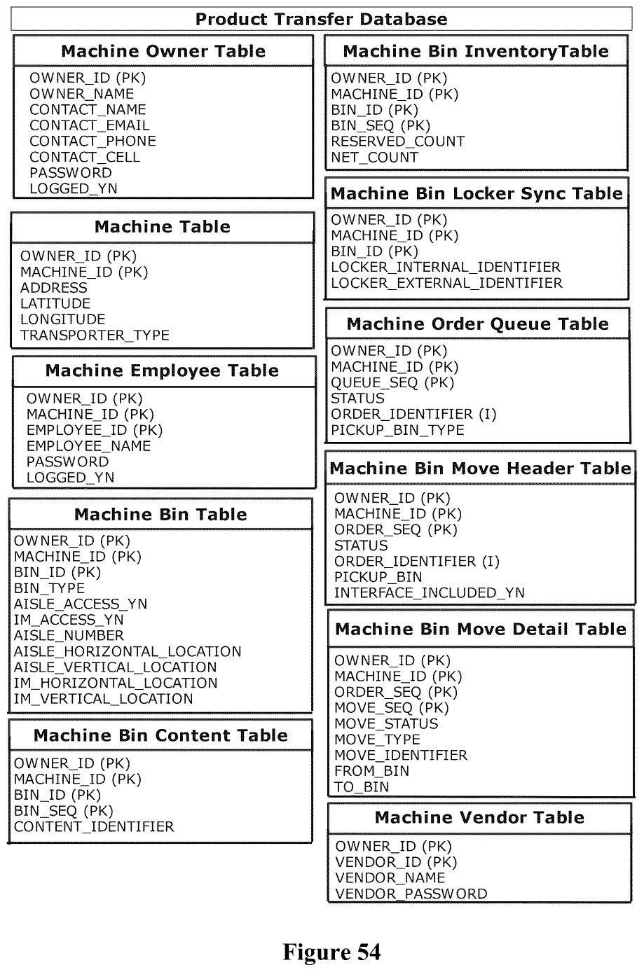

Although those of ordinary skill in the art will recognize that virtually unlimited alternatives are possible, FIG. 6 shows a very high-level but generally representative schema for an intermediary agent customer database 58-13, FIG. 7 shows a very high-level but also generally representative schema for a single unit building database 58-14, FIG. 8 shows a very high-level but also generally representative schema for a multiunit building database 58-15, FIGS. 9 & 9A shows a very high-level but also generally representative schema for a restaurant database 58-16, FIG. 10 shows a very high-level but also generally representative schema for a golf course database 58-17, FIG. 11 shows a very high-level but also generally representative schema for a cell number rental database 58-18, FIGS. 34, 34A and 34B show a very high-level but also generally representative schema for a store database 58-19, FIG. 44 show a very high-level but also generally representative schema for a package transfer database 58-20 and FIG. 54 show a very high-level but also generally representative schema for a product transfer database 58-21 each of which will be described in greater detail further herein in connection with an exemplary description of the conduct of a typical transaction.

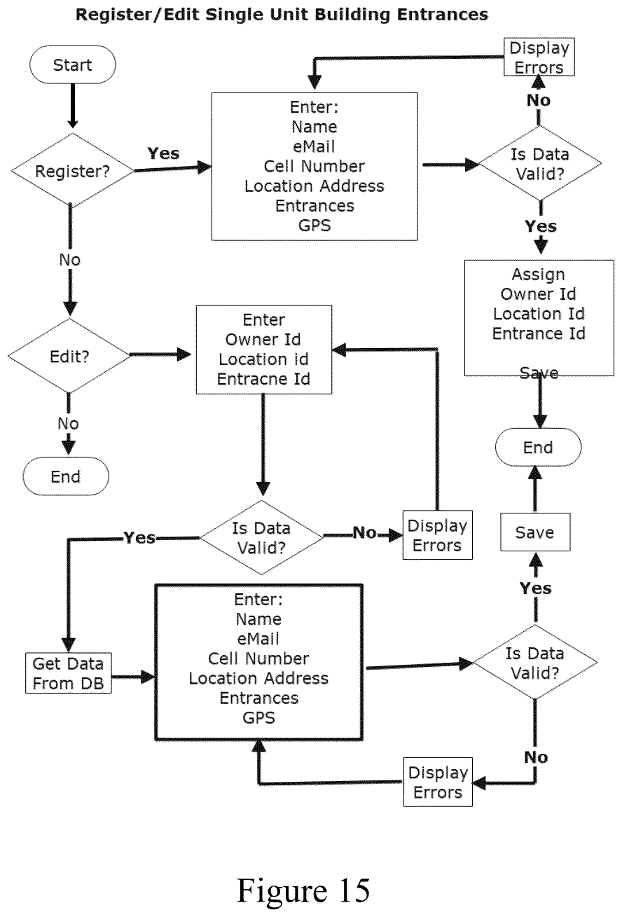

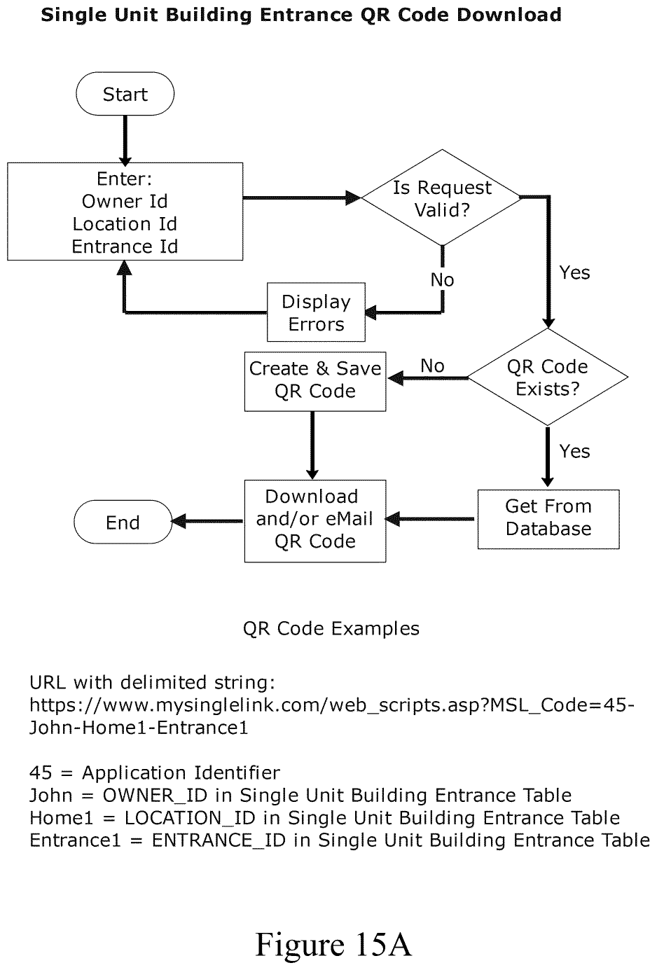

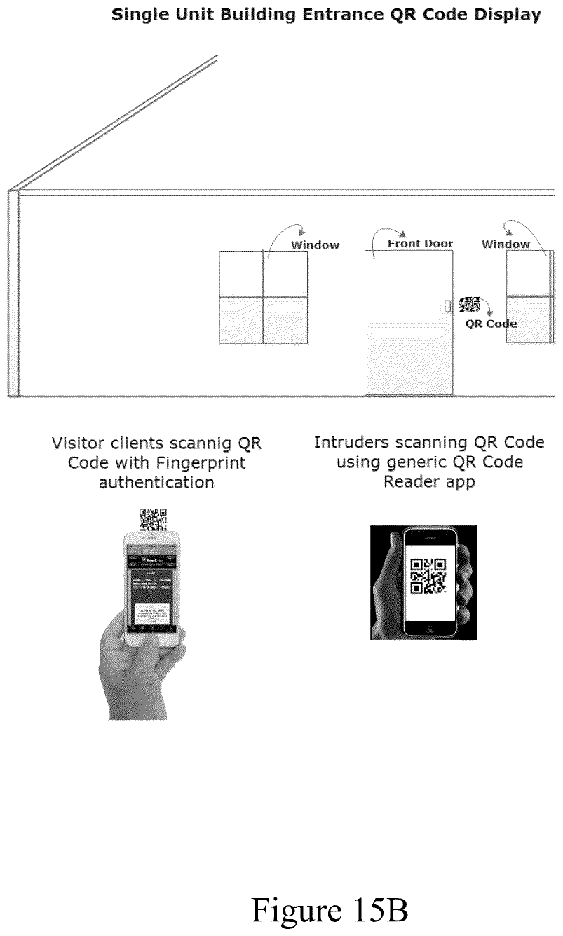

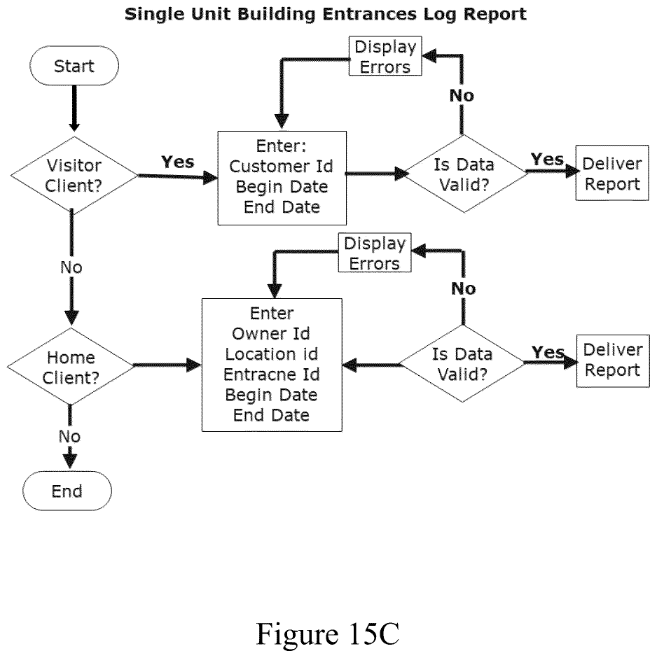

Additionally, a preferably app gateway 58-24 is provided for use in receiving app requests and issuing responses. As will be appreciated by those of ordinary skill in the art, such an app gateway 58-24 may be utilized to receive mobile requests from mobile devices as shown in FIGS. 15B, 17B, 21B, 25B, 25C, 25D, 25E, 25F, 37A, 37B, 39A, 39B and 39C and transmit generated responses back to mobile devices. The app requests and responses may be in any of a plurality of message formats such as, and not limited to, a comma or special character delimited message, an XML formatted message, a JASON formatted message, over any of a plurality of app operating systems and not limited to, iphone, android and Microsoft.

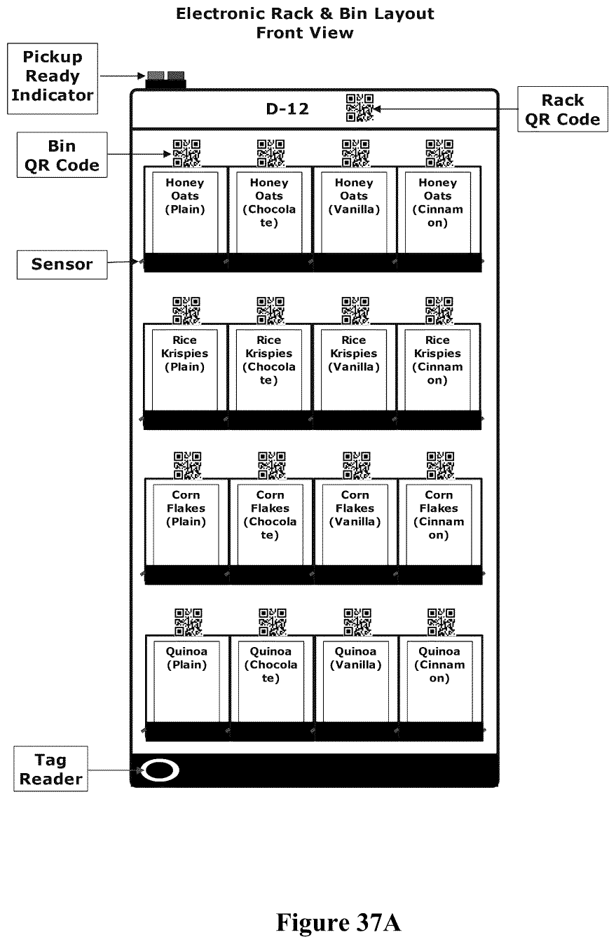

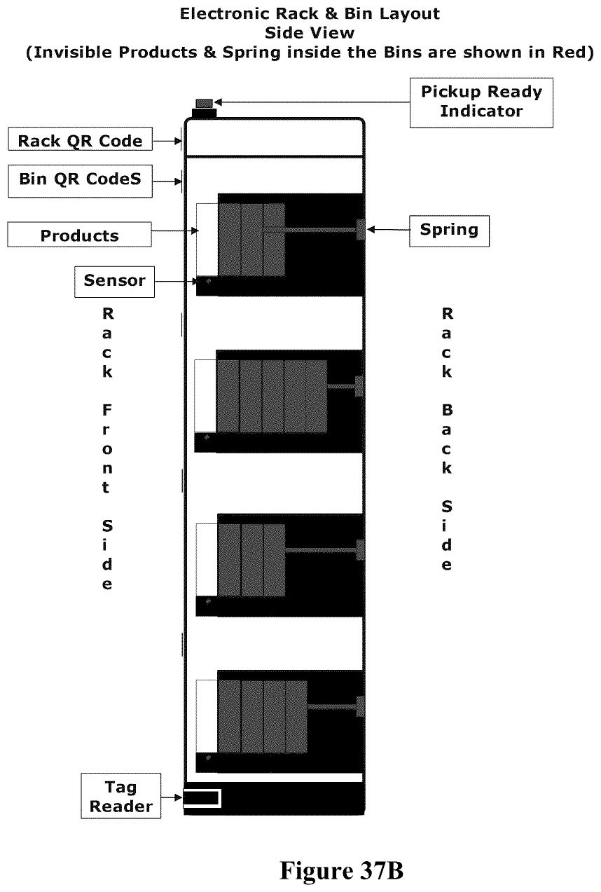

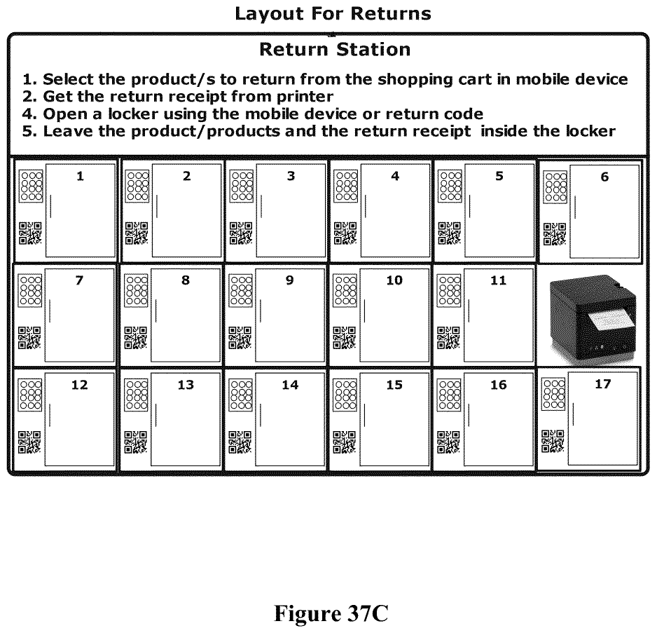

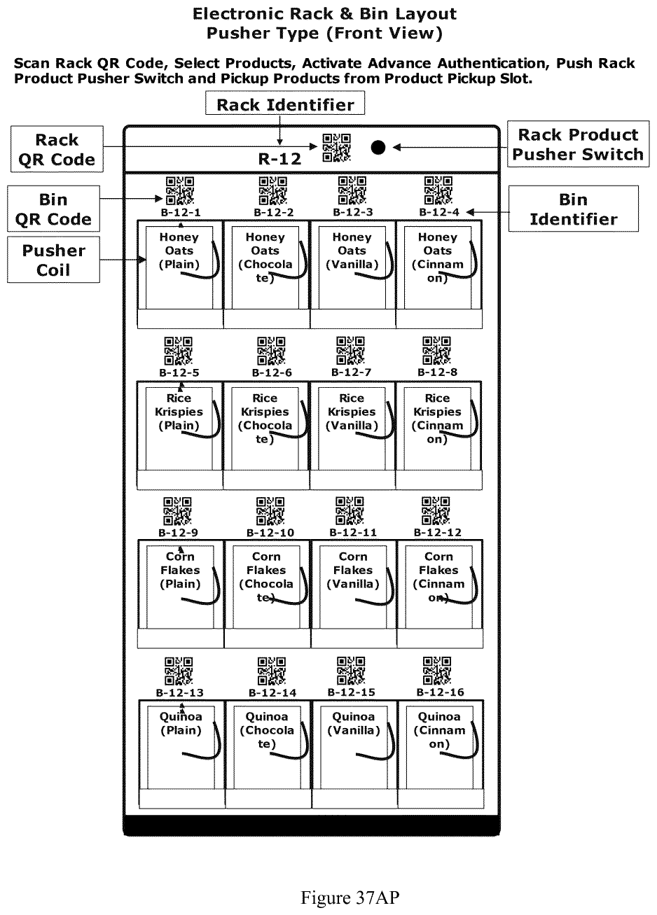

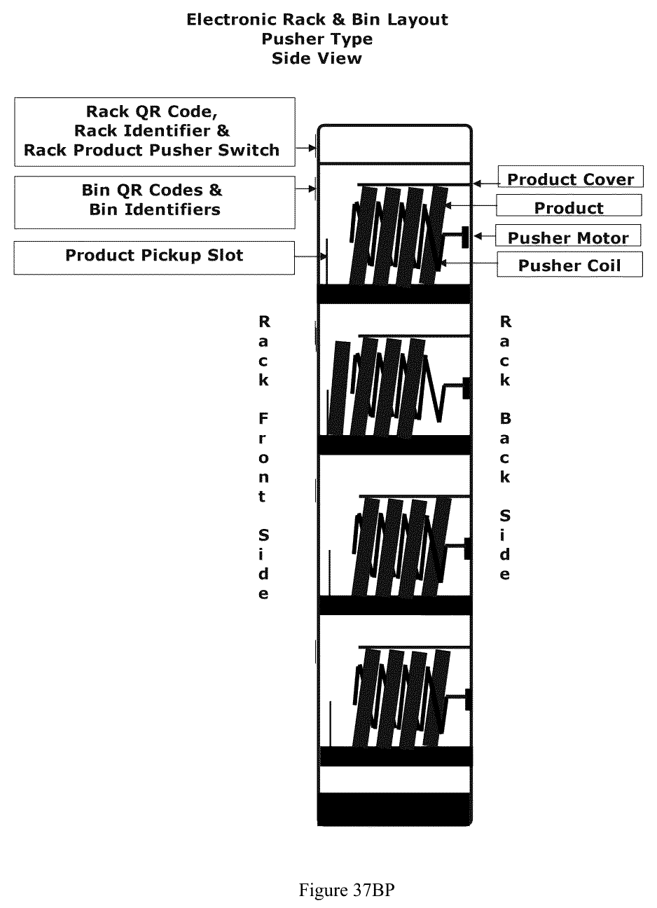

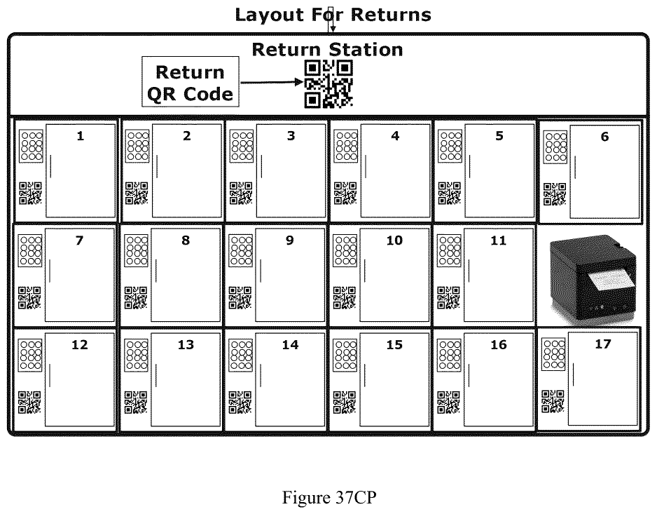

Additionally, a preferably controller gateway 58-23 is provided for use in receiving controller requests and issuing responses. As will be appreciated by those of ordinary skill in the art, such a controller gateway 58-23 may be utilized to receive controller requests from tag readers as shown in FIGS. 37A and 37B and transmit generated responses to turn on the green light and turn off red light or to turn off the green light and to turn on red light in the rack. to which the tag reader is attached to. As will be appreciated by those of ordinary skill in the art, such a controller gateway 58-23 may be utilized to receive controller requests from sensor as shown in FIGS. 37A and 37B and transmit generated responses to alert that a product has been shop lifted or not to alert. The controller requests and responses may be in any of a plurality of message formats such as, and not limited to, a comma or special character delimited message, an XML formatted message, a JASON formatted message, over any of a plurality of languages such as and not limited to, HTML (HTTP or HTTPS or SOAP), JavaScript, (C) programs, C++ programs, .NET and based on the Application Programming Interfaces (API) specification provided by the intermediary agent (2, 102, 202, 302, 402 and 502).

Additionally, a preferably security component 58-5 with authentication 58-6 and validation 58-7 components are provided for use in authenticating or validating data respectively and are readily available on demand for request handler, controller agent and administration agent.

Additionally, a preferably communication component 58-8 with text communication 58-9 and video communication 58-10 components are provided for use in providing text and/or video communication and are readily available on demand for administrator agent. Those of ordinary skill in the art will readily recognize that video communication can be for voice only or for voice and video.

In order to efficiently implement various preferred embodiments, the intermediary agent (2, 102, 202, 302, 402 or 502) may host one or more application components under application server such as administration (58-4), request handler (58-2). Administration (58-4) would receive the data through user interface (58-22) whereas request handler (58-2) would receive data through app gateway (58-24).

The administration component (58-4) will also be referred to as the administration component.

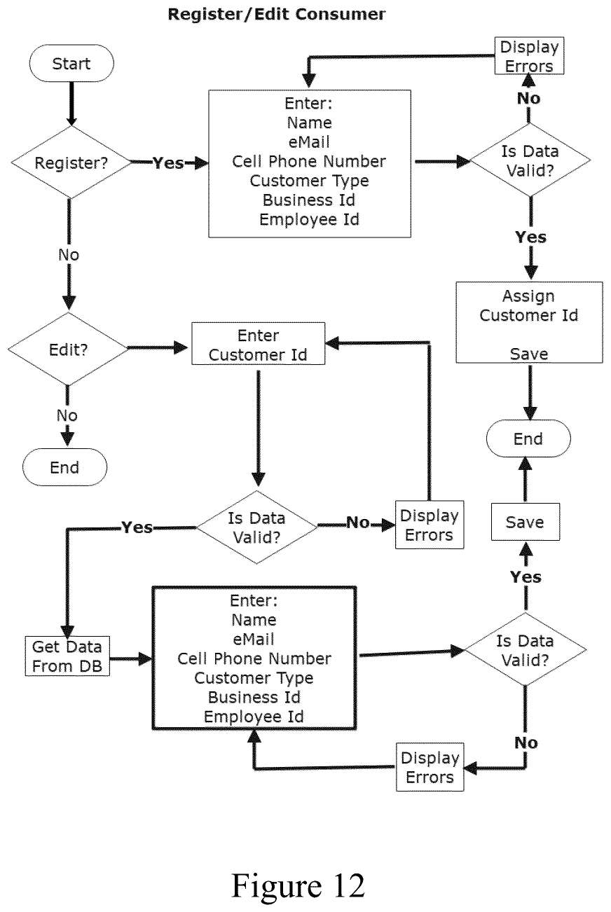

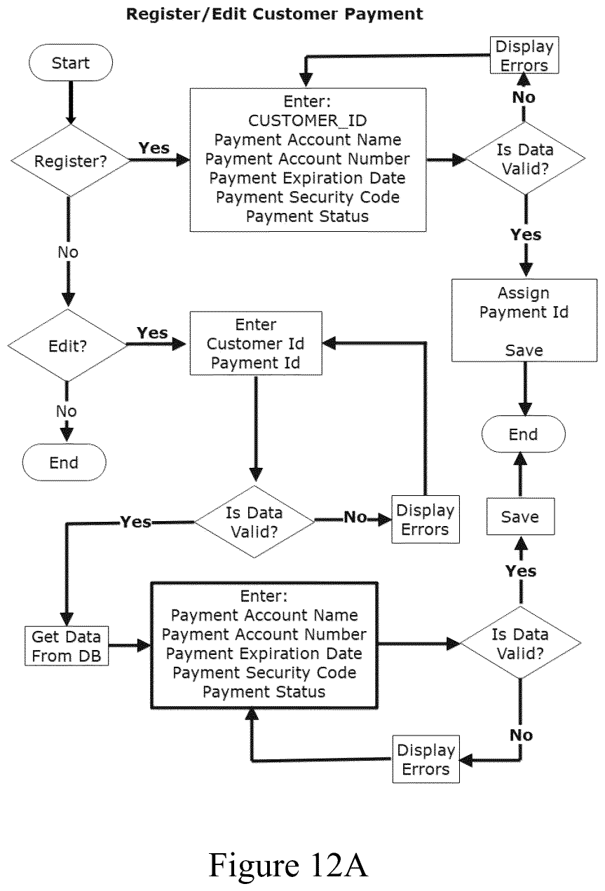

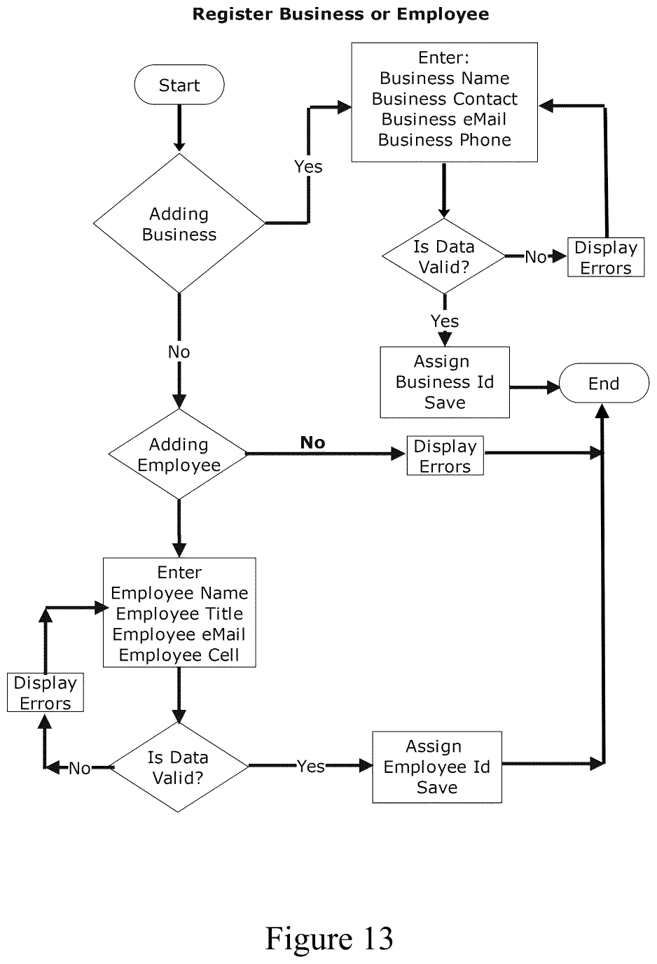

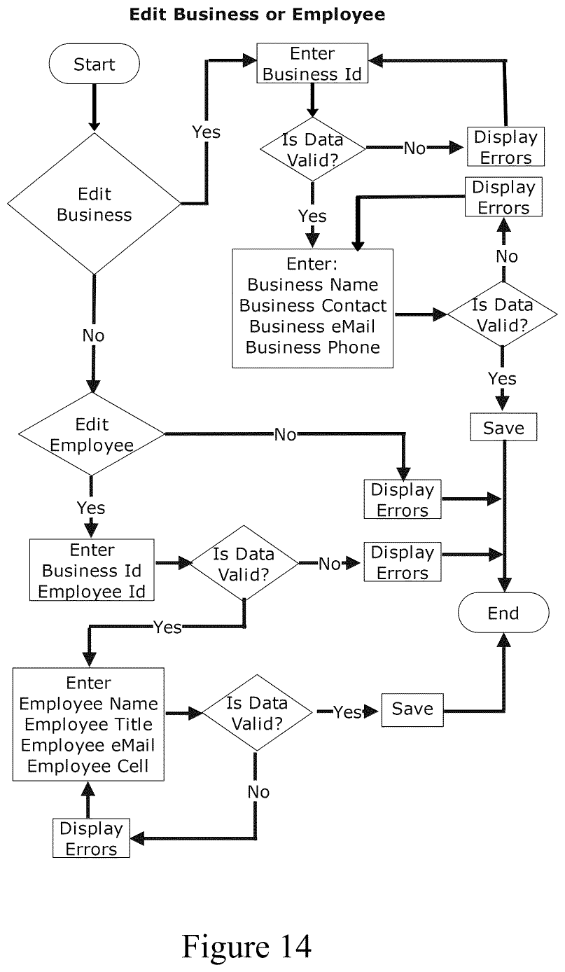

Intermediary agent (2, 102, 202, 302, 402 or 502) would provide customer web form for consumers to register and maintain their personal information (as shown in a flowchart in FIG. 12) as customers. Intermediary agent (2, 102, 202, 302, 402 or 502) would provide business web form for businesses to register and maintain their business information (as shown in a flowchart in FIGS. 13 & 14). Intermediary agent (2, 102, 202, 302, 402 or 502) would provide business web form for businesses to add or edit or delete employees (as shown in a flowchart in FIGS. 13 & 14) as employees. Intermediary agent (2, 102, 202, 302, 402 or 502) would provide business employee web form for employees to edit their own (as shown in a flowchart in FIG. 14).

Collectively, all consumers and all employees of businesses registered with the intermediary agent are referred as visitor clients. Identification information of visitor clients are known to intermediary agent (2, 102, 202, 302, 402 or 502). All the visitors who are not visitor clients are referred as intruders and the identification information of intruders are not known to intermediary agent (2, 102, 202, 302, 402 or 502).

Consumers would use customer web form provided by any intermediary agent (2, 102, 202, 302, 402 or 502) to register and maintain their information as shown in a flowchart in FIG. 12 and the administration component would process the request. When consumers use a customer web form to register, then the customer web form would send ‘C’ and ‘A’ for requestor type and requestor action respectively along with other information to indicate that the request is to register a consumer. When consumers use a web form to maintain their information then the web form would send ‘C’ and ‘E’ for requestor type and requestor action respectively along with other information to indicate that the request is to maintain a consumer information. Each consumer will be assigned a unique CUSTOMER_ID, a value of ‘C’ will be assigned for CUSTOMER_TYPE, values for CUSTOMER_NAME, CUSTOMER_EMAIL and CUSTOMER_CELL will be captured from the consumers and will be saved in customer table in intermediary agent customer database as shown in a class diagram, in FIG. 6.

When businesses and employees and maintain their information as visitors with an intermediary agent (2, 102, 202, 302, 402 or 502) as shown in flowcharts in FIGS. 13 & 14 using a web form, the administration component will process the request. Businesses would use business web form to register as a business, then the business web form would send ‘M’ and ‘A’ for requestor type and requestor action respectively along with other information to indicate that the request is to register a business.

Businesses would use business web form to register an employee, then the business web form would send ‘E’ and ‘A’ for requestor type and requestor action respectively along with other information to indicate that the request is to register an employee of s business.

Businesses would use business web form to maintain their information, then the business web form would send ‘M’ and ‘E’ for requestor type and requestor action respectively along with other information to indicate that the request is to maintain business information.

Businesses or a registered employee of a business use business employee web form to maintain employee information, then the business employee web form would send ‘E’ and ‘E’ for requestor type and requestor action respectively along with other information to indicate that the request is to maintain employee of a business information.

When businesses register their businesses and employees with an intermediary agent (2, 102, 202, 302, 402 or 502) as shown in flowcharts in FIGS. 13, each business will be assigned with a unique BUSINESS_ID and values for BUSINESS_NAME, BUSINESS_CONTACT, BUSINESS_EMAIL and BUSINESS_PHONE will be captured from businesses and will be saved in business details table as shown in a class diagram, in FIG. 6. Each employee of business will be assigned with a unique EMPLOYEE_ID under BUSINESS_ID, values for EMPLOYEE_NAME, EMPLOYEE_TITLE, EMPLOYEE_EMAIL, EMPLOYEE_CELL will be captured and saved in business employee details table as shown in a class diagram, in FIG. 6. Businesses would register their employees with an intermediary agent (2, 102, 202, 302, 402 or 502) as employees as shown in a flowchart in FIG. 13. Each employee of business will be assigned a unique CUSTOMER_ID, a value of ‘M’ will be assigned for CUSTOMER_TYPE, values for BUSINESS_ID, and EMPLOYEE_ID will be captured from businesses and will be saved in intermediary agent customer table as shown in a class diagram, in FIG. 6. Businesses would maintain their information and their employees' information with an intermediary agent (2, 102, 202, 302, 402 or 502) as shown in a flowchart in FIG. 14 and will be saved in customer table as shown in a class diagram, in FIG. 6. Each employee of the business would maintain their information with an intermediary agent (2, 102, 202, 302, 402 or 502) as shown in a flowchart in FIG. 14 and will be saved in business employee details table as shown in a class diagram, in FIG. 6.

As already described in ‘BRIEF SUMMARY OF THE INVENTION’ section, the content of the QR Code could be in any pre-defined format, but would generally be in an URL format with a link to a web page, known as QR Code web page, hosted by intermediary agent (2, 102, 202, 302, 402 or 502) and at least one parameter with a parameter name and a parameter value pair.

Any individual can use an app provided by the intermediary agent (2, 102, 202, 302, 402 or 502), or any app interfaced with the intermediary agent (2, 102, 202, 302, 402 or 502), or any generic QR Code Reader app or camera to scan the QR Code. Whan an individual uses an app provided by the intermediary agent (2, 102, 202, 302, 402 or 502), or any app interfaced with the intermediary agent (2, 102, 202, 302, 402 or 502), the QR Code web page will be executed in the in-app browser with all the parameters included in the QR Code, the device mobile number as a parameter with the name ‘customer identifier’, the device current latitude as a parameter with the name ‘latitude’ and the device current longitude as a parameter with the name ‘longitude’. When an individual uses any generic QR Code Reader app or camera, the QR Code web page will be executed in the device web browser with all the parameters included in the QR Code. The QR Code web page would save a blank as customer identifier and capture the latitude and longitude of the internet service provider providing the internet service for the web browser as latitude and longitude.

When QR Code web page is executed, the QR Code web page would parse the URL parameters received by the QR Code web page. If a pre-defined specific parameter holding a request message exists, for example the parameter ‘MSL_Code’, then the QR Code web page would save the value of the pre-defined specific parameter as request message and QR Code web page execution will continue, otherwise it will be terminated. If the request message is a delimited text with a pre-defined delimiter, then the QR Code web page would save the value of the first node in the request message as application identifier and the QR Code web page execution will continue, otherwise it will be terminated. If the application identifier is valid for current intermediary agent, then QR Code web page execution will continue, otherwise it will be terminated. For example, some of the valid values for application identifier could be ‘45’ or ‘65’ for intermediary agent 2, ‘77’ or ‘327’ or ‘87’ for intermediary agent 102, ‘77’ or ‘87’ or ‘97’ or ‘157’ or ‘167’ for intermediary agent 202, ‘107’ or ‘127’ or ‘147’ or ‘167’ or ‘187’ for intermediary agent 302, ‘207’ or ‘227’ or ‘247’ for intermediary agent 402 and ‘347’ or ‘367’ or ‘387’ or ‘307’ for intermediary agent 502 as already described in ‘BRIEF SUMMARY OF THE INVENTION’ section.

For application identifiers that require up front authentication of customers or verification of intruders, the QR Code web page will save ‘Y’ for upfront and for others it will save ‘N’ for upfront. If application identifier is ‘45’ in intermediary agent ‘2’ or ‘65’ in intermediary agent ‘2’ or ‘77’ in intermediary agent 102 or ‘77’ in intermediary agent 202 or ‘107’ in intermediary agent 302 or ‘127’ in intermediary agent 302 or ‘227’ in intermediary agent 402, then the QR Code web page will save ‘Y’ for upfront, otherwise QR Code web page will save ‘N’ for upfront.

If the QR Code web page execution continues, then the QR Code web page will transmit the browser type, request message, customer identifier, customer latitude and customer longitude to request handler (58-2) through app gateway (58-24). If the QR Code web page execution was done in an in-app browser, then the browser type would be ‘A’, customer identifier would be device mobile number, the customer latitude would be the device current latitude and the customer longitude would be the device current longitude. If the QR Code web page execution was done in a web browser, then the browser type would be ‘W’, customer identifier would be blank, the customer latitude would be the internet service provider's current latitude and the customer longitude would be the internet service provider's current longitude.

When the request handler (58-2) is executed, the request handler process will start. If the request handler process received a browser type, request message, customer identifier, customer latitude and customer longitude, then the request handler process will continue, otherwise it will be terminated. If the request message is blank or customer latitude is blank or customer longitude is blank then the request handler process will be terminated, otherwise it will continue. If the browser type is ‘A’ or ‘W’, then request handler process will continue, otherwise request handler process will be terminated.

If the browser type is ‘A’, then the request handler process would verify the existence of customer identifier in customer table in intermediary agent customer database (58-13) using customer identifier for CUSTOMER_ID. If the customer identifier exists in the customer table in intermediary agent customer database (58-13) then the request handler process would consider the customer as a visitor client and the request handler process will continue, otherwise it will be terminated. If upfront is ‘Y’, then the request handler process would request authentication component (58-6) under security component (58-5) to authenticate the customer identifier using fingerprint authentication or face id authentication or any other authentication method through the app. For a fingerprint or face id authentication, the authentication component (58-6) would request the customer to authenticate using the app. If upfront is ‘Y’ and if the authentication is not successful, then request handler process will be terminated. Then the request handler process would determine the customer type from CUSTOMER_TYPE in customer table in intermediary agent customer database (58-13) using customer identifier for CUSTOMER_ID. If the request handler process can determine the customer type and if the customer type is ‘C’ or ‘M’, then request handler process will continue, otherwise it will be terminated. If the customer type is ‘C’, then the request handler process would get customer name from CUSTOMER_NAME in customer table in intermediary agent customer database (58-13) using customer identifier for CUSTOMER_ID and save blanks for customer business name and customer employee title. If the customer type is ‘M’, then the request handler process would get the visitor business identifier and visitor employee identifier from BUSINESS_ID and EMPLOYEE_ID respectively from customer table in intermediary agent customer database (58-13) using customer identifier for CUSTOMER_ID. Then the request handler process would get the customer business name from BUSINESS_NAME in the business details table in intermediary agent customer database (58-13) using visitor business identifier for BUSINESS_ID. Then the request handler process would get the visitor employee name and customer employee title from EMPLOYEE_NAME and EMPLOYEE_TITLE respectively in business employee details table in intermediary agent customer database (58-13) using visitor business identifier for BUSINESS_ID and visitor employee identifier as EMPLOYEE_ID. The request handler process would use visitor employee name as customer name.

If the browser type is ‘W’, then the request handler process would consider the customer as an intruder. If upfront is ‘Y’, then the request handler process would use the validation component (58-7) under security component (58-5) to verify the intruder, otherwise the request handler process would use stored cookies in the browser to verify the intruder. If upfront is ‘Y’, the validation component (58-7) may use one-time passcode or any other method to validate the intruder. To use one-time passcode the validation component (58-7) would accept a mobile number from the intruder through the web browser in the intruder's device and send a one-time pass code to the said mobile number. Then the validation (58-7) component would accept a one-time passcode from the intruder from the web browser in the intruder's device. If the one-time code sent to intruder's mobile number and the one-time passcode accepted from the web browser in the intruder's device is one and the same, then the intruder will be considered as validated. If the validation is successful then the request handler process will continue, otherwise it will be terminated. Then the validation (58-7) would verify whether the intruder's mobile number exists in customer table as a registered consumer's mobile number. If the intruder's mobile number exists in customer table as a registered consumer's mobile number, then the request handler process will be terminated. This will ensure that registered consumers would use only an app provided by the intermediary (2, 102, 202, 302, 402 or 502) or would use only an app interfaced with the app provided by the intermediary agent (2, 102, 202, 302, 402 or 502). Then the request handler process will save the intruder's mobile number as customer identifier and ‘U’ as customer type. Then the request hander process would get intruder name. If the request handler (58-2) can get the intruder's name, then the request handler process would save the intruder's name as customer name. Then the request hander process would get the information whether the intruder represents any business or not. If the request hander process is able to determine whether the intruder represents a business or not, then the request hander process will continue, otherwise it will be terminated. If the intruder represents a business, then the request hander process would get the intruder's business name and business title. If the intruder represents a business, and if the request hander process is unable to get intruder's business name and business title then the request handler process will be terminated. If the intruder represents a business, and if the request hander process can get intruder's business name and intruder's business title then the request handler process would save intruder's business name and intruder's business title as customer business name and customer employee title respectively.

If the browser type is ‘W’ and if upfront is ‘N’, then the request hander process would retrieve the values of cookies CURRENT_CUSTOMER_TYPE, CURRENT_CUSTOMER_ID and CURRENT_CUSTOMER_NAME stored in the browser and save them as customer type, customer identifier and customer name respectively. If upfront is ‘N’ and if the request hander process cannot retrieve the values cookies CURRENT_CUSTOMER_TYPE, CURRENT_CUSTOMER_ID and CURRENT_CUSTOMER_NAME stored in the browser, then the request hander process will be terminated. If upfront is ‘N’ and if the request hander process can retrieve the values of cookies CURRENT_CUSTOMER_TYPE, CURRENT_CUSTOMER_ID and CURRENT_CUSTOMER_NAME stored in the browser, then the request hander process will save the values cookies CURRENT_CUSTOMER_TYPE, CURRENT_CUSTOMER_ID and CURRENT_CUSTOMER_NAME stored in the browser as customer type, customer identifier, and customer name respectively. If upfront is ‘N’ and if the request hander process can retrieve the values of cookies CURRENT_CUSTOMER_BUSINESS_NAME, CURRENT_CUSTOMER_EMPLOYEE_TITLE stored in the browser, then the request hander process will save the values cookies CURRENT_CUSTOMER_BUSINESS_NAME and CURRENT_CUSTOMER_EMPLOYEE_TITLE stored in the browser as customer business name and customer employee title respectively. If upfront is ‘N’ and if the request hander process can not retrieve the values of cookies CURRENT_CUSTOMER_BUSINESS_NAME and CURRENT_CUSTOMER_EMPLOYEE_TITLE from the browser, then the request hander process will save blank values as customer business name and customer employee title.

At any event, if the request hander process continues, the request hander process will have the values for customer identifier, customer type, customer name, customer business name, customer employee title, customer latitude and customer longitude.

Upon successful authentication of a visitor client or successful verification of an intruder, the request handler (58-2) would segregate the request message into various nodes using a pre-defined delimiter and save the value in the first node as application identifier. If the request handler (58-2) is able to determine the value for application identifier, then the request handler process will continue, otherwise it will be terminated.

Upon successful authentication of a visitor client or successful verification of an intruder, the request handler process will continue as described in respective embodiment. If the intermediary agent is 2 and if the application identifier is 45, then request handler process will continue as described in ‘QR Automation (QR Code Doorbell)’ section. If the intermediary agent is 2 and if the application identifier is 65, then request handler process will continue as described in ‘QR Code Communication & Automation (Intercom Video)’ section. If the intermediary agent is 102, then the request handler process will continue as described in ‘QR Code Communication & Automation (Restaurant Automation)’ section. If the intermediary agent is 202, then request handler process will continue as described in ‘QR Code Communication & Automation (Golf Course Automation)’ section. If the intermediary agent is 302, then request handler process will continue as described in ‘QR Code Communication & Automation (Store Automation)’ section. If the intermediary agent is 402, then request handler process will continue as described in ‘QR Code Communication & Automation (Package Transfer Automation)’ section. If the intermediary agent is 502, then request handler process will continue as described in ‘QR Code Communication & Automation (Product Transfer Automation)’ section.

### QR Automation (QR Code Doorbell)

Video Doorbell systems such as Ring by Amazon, Google Nest by Google, ADT Video Doorbell by ADT, Video Doorbell by Vivint and so on have been used by millions of consumers since 2012. As stated by Video Doorbell Systems, the primary objects are to deter porch piracy and to visually see visitors before communicating or letting them in. Video Doorbells do not provide a secure place to store packages and cannot protect packages left at the porch but can only deter porch pirates. It provides a two-way audio communication between video doorbell and video doorbell registered owners' mobile devices and one-way video streaming from video doorbell to doorbell registered owners' mobile devices in real time and record them for later viewing, if needed.

Because of the recent invention of electronic smart lockers such as MSL Smart Locker by MySingleLink, deliveries can be safely left inside a locker and the role of deterring porch pirates by Video Doorbell may not be required any longer. Still Video Doorbells can be used to view visitors but cannot positively identify all the visitors. The visitors can be friends and families or employees of companies such as deliveries, plumbing, air-conditioning, pest control, handy man, pet care, childcare, elderly care and the like or intruders. Visitors who cannot be positively identified may show identification cards such as business cards and driver's licenses through the video camera. But the video doorbell owners cannot verify the authenticity of such identification cards. Employees can take employer issued identification cards such as business cards with them, when leaving the employer. Employees can also make copies of employer issued identification cards. Even with facial recognition, it may not be possible to positively identify the unknown visitors because people move from place to place and from job to job. The unknown visitors cannot contact the video doorbell owners without the video doorbell owners providing their sensitive contact identifier such as cell phone number or email address or Snapchat code of Skype code or Whatsapp code and the like to the unknown visitors. It may not be safe for video doorbell owners to share sensitive information with unknown visitors. So, the video doorbell owners must let the unknown visitors without positive identification to enter secured areas by remotely unlocking doors fitted with electronic locks such as MySinglelink Lock, August Lock, Google Nest Yale Lock and so on or meet the visitors at the entrance. Even upon meeting at the entrance, the video doorbell owners cannot positively identify the unknown visitors from the identification documents.

A communication between the unknown visitors and the video doorbell owners where the visitors can provide a positively verifiable sensitive information such as cell phone number only to an intermediary agent and the video doorbell owner not providing any sensitive information such as their cell phone number or email address to the unknown visitor would be an ideal solution. The doorbell owner may or may not receive visitor's sensitive information such as cell phone number. Such a communication can be established using a QR Code issued by an intermediary agent and displayed by the video doorbell owner. QR Code would not include any sensitive information such as phone number or email address or msl wallet code or Snapchat code or Skype code or Whatsapp code or the like. Displaying the QR Code can be a complement to the Video Doorbell or can be a replacement for the Video Doorbell.

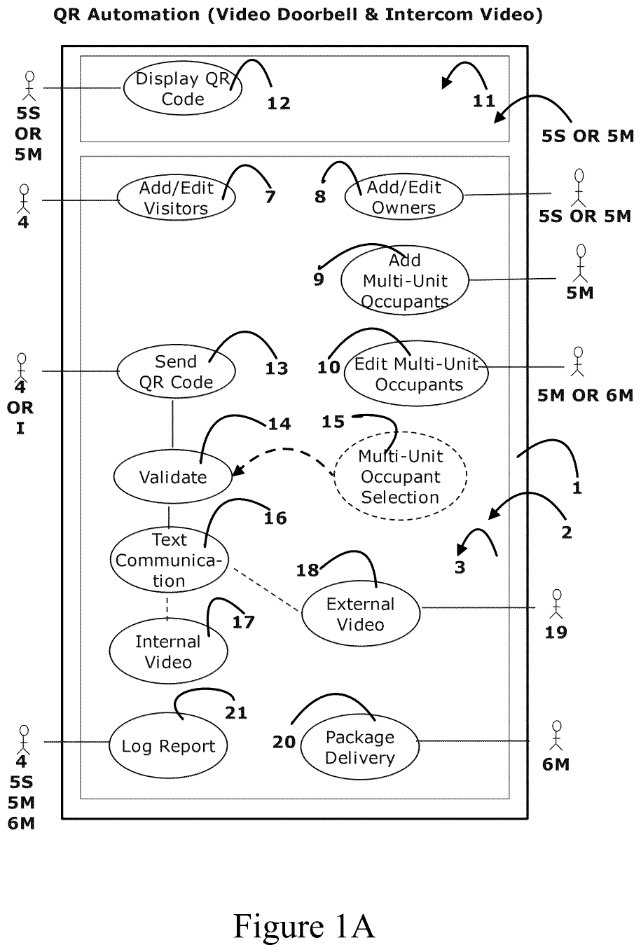

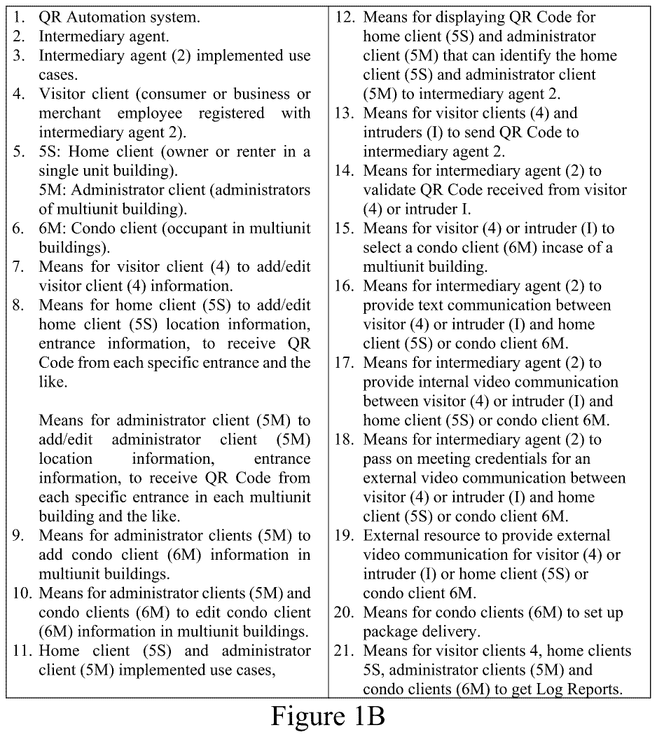

Referring now to the figures, and particularly to FIG. 1A in particular, the QR Automation system (1) of the present invention is shown to generally comprise an operative combination of a plurality of home clients (5S) implemented use cases 11 and a plurality of intermediary agent (2) implemented use cases 3. In particular, the home client (5S) of the present invention will generally display for a visitor (4) or for an intruder (I) a QR Code (12) containing a request message for identifying the home client (5S) to an intermediary agent (2) for the purpose of requesting that the intermediary agent (2) provide for the visitor (4) or the intruder (I) a communication channel between the visitor (4) or the intruder (I) and the home client (5S) with the consent of home client (5S) and without providing home client's (5S) sensitive information to the visitor (4) or the intruder (I).

Additionally, intermediary agent (2) provide a means 7 for any consumer to register and for any business to register their business and their employees as registered visitor clients (4).

Additionally, intermediary agent (2) provides a means 8 for occupants of any single unit building to register as home clients (5S).

Additionally, intermediary agent (2) provides a means 13 for visitor clients (4) and for intruders (I) to send request message by scanning a QR Code.

Additionally, intermediary agent (2) provides a means 14 for authenticating visitor clients (4) and validating intruders I.

Additionally, intermediary agent (2) provides a means 16 for a communication channel for texting between visitor clients (4) or intruders (I) with home clients (5S).

Additionally, intermediary agent (2) provides a means 17 for a communication channel for audio/video between visitor clients (4) or intruders (I) with home clients (5S).

Additionally, intermediary agent (2) provides a means 18 for exchanging credentials for audio/video communication channel provided by an external resource provider 19, between visitor clients (4) or intruders (I) and home clients (5S).

Additionally, intermediary agent (2) provides a means 20 for condo clients (6M) to set up a package delivery.

Additionally, intermediary agent (2) provides a means 21 for visitor clients (4) and home clients (5S) to view and/or download log reports created for any specific begin date, begin time, end date and end time.

Intermediary agent (2), visitor clients (4), home clients (5S) and intruders (I) can also be referred to as Intermediary agent, visitor clients, home clients and intruders respectively.

Home clients would use QR Automation system, as a complement or replacement to Video Doorbells in Single Unit Buildings.

Here are how home clients, visitor clients and intruders would use QR Automation system:

As described in ‘DETAILED DESCRIPTION OF THE PREFERRED EMBODIMENTS’ section, any consumer can use customer web form provided by intermediary agent to register and maintain their personal information with the intermediary agent as customer.

As described in ‘DETAILED DESCRIPTION OF THE PREFERRED EMBODIMENTS’ section, any business can use business web form provided by intermediary agent to register and maintain their business information with the intermediary agent as business.

As described in ‘DETAILED DESCRIPTION OF THE PREFERRED EMBODIMENTS’ section, any business can use business web form provided by intermediary agent to add or edit or delete business employees with the intermediary agent.

As described in ‘DETAILED DESCRIPTION OF THE PREFERRED EMBODIMENTS’ section, any registered business employee can use business employee maintenance web form provided by intermediary agent to edit their own information with the intermediary agent.

Home clients would register and maintain their information with an intermediary agent, receive and display a unique QR Code for each entrance as shown in flowcharts in FIGS. 15, 15A and as shown in FIG. 15B. Intermediary agent would use single unit building database as shown in a class diagram, in FIG. 7. Home clients will be assigned a unique OWNER_ID, values for NAME, EMAIL and CELL will be captured and saved in single unit building owner table as shown in a class diagram, in FIG. 7. Each home client building location will be assigned with a unique LOCATION_ID, value for ADDRESS will be captured and saved in single unit building location table as shown in a class diagram, in FIG. 7. Each entrance in each single unit building location will be assigned with a unique ENTRANCE_ID, values for NAME, LATITUDE, LONGITUDE will be captured and saved in single unit building entrance table as shown in a class diagram, in FIG. 7. Home clients can download QR Codes as shown in flowchart in FIG. 15A. Home clients would provide OWNER_ID, LOCATION_ID and ENTRANCE_ID to intermediary agent to download QR Codes. QR Codes will be saved as QR_CODE in single unit building entrance table as shown in a class diagram, in FIG. 7. Home clients can display unique QR Codes at each entrance, in each location, in each single unit building as shown in FIG. 15B.

When an individual scans a QR Code displayed at any entrance, at any location in any single unit building using an app provided by the intermediary agent or an app interfaced with intermediary agent or any generic QR Code Reader app or a camera, the content of the QR Code will be passed on to QR Code web page hosted by intermediary agent, upon verification of the QR Code by the QR Code web page, the information will be passed on to the request handler (58-2) in the intermediary agent to initiate a request handler process as described in ‘DETAILED DESCRIPTION OF THE PREFERRED EMBODIMENTS’ section and the request handler process will continue here.

When a QR Code is scanned by an individual, the request handler process would have saved the request message embedded in the QR Code as request message and the information of the individual scanned the QR Code as customer identifier, customer type, customer name, customer business name, customer employee title, customer latitude and customer longitude.

If the customer type is ‘C’ or ‘M’, then the customer will be referred to as visitor client, otherwise the customer will be referred to as intruder.

If the customer type is ‘C’, then the individual scanned the QR Code is a visitor client and does not represent any business. If the customer type is ‘M’, then the individual scanned the QR Code is a visitor client and represents a business. If customer type is ‘U’, then the individual scanned the QR Code is an intruder.

Then the request handler process would segregate the request message, based on a pre-defined procedure into four segments namely application identifier, owner identifier, location identifier and entrance identifier respectively. If the request handler process cannot break the request message into four segments the process will be terminated. If the application identifier is not for processing QR Codes from single unit building entrance, then the request handler process will be terminated. The owner identifier is also referred to as home client.

Then the request handler process would retrieve LATITUDE as entrance latitude and LONGITUDE as entrance longitude of the Single Unit Building Entrance from single unit building entrance table in single unit building database using owner identifier for OWNER_ID, location identifier for LOCATION_ID and entrance identifier for ENTRANCE_ID. If the request handler process cannot retrieve entrance latitude and longitude information, then the request handler process will be terminated.

Then the request handler process would start a new log in single unit entrances log table. The request handler process would retrieve the last log sequence from single unit entrances log table using owner identifier for OWNER_ID, location identifier for LOCATION_ID and entrance identifier for ENTRANCE_ID. If the request handler process can retrieve last log sequence then the request handler process would set a new log sequence by incrementing the last log sequence by 1, otherwise the request handler process would set new log sequence as 1. Then the request handler process would insert a new row in single unit entrances log table using owner identifier for OWNER_ID, location identifier for LOCATION_ID, entrance identifier for ENTRANCE_ID new log sequence for LOG_SEQ, customer type for SCAN_TYPE, customer identifier for SCAN_ID, current server date for BEGIN_DATE, current server time as BEGIN_TIME, current server date for END_DATE, current server time as END_TIME and blank value for DESCRIPTION.

When the request handler process terminates, the request handler process would update END_DATE, END_TIME and DESCRIPTION by using current server date for END_DATE, current server time for END_TIME and appending the reason for termination to DESCRIPTION in single unit entrances log table where OWNER_ID is equal to owner identifier, LOCATION_ID is equal to location identifier, ENTRANCE_ID is equal to entrance identifier and LOG_SEQ is equal to new log sequence.

If customer type is ‘C’ or ‘M’, then customer latitude and customer longitude would be the customer's current location. Then the request handler process would determine whether the customer's current location is within a certain limit from the entrance location based on customer latitude and customer longitude. If the distance between the customer current location and entrance location is within a certain limit, then the request handler process will continue, otherwise it will be terminated.

If customer type is ‘U’, then customer latitude and customer longitude would be the latitude and longitude of customer's internet service provider (ISP) providing internet service for the customer and customer latitude and customer longitude would be ISP latitude and longitude respectively. Then the request handler process would determine whether the ISP location is within a certain limit from the entrance location based on ISP latitude and longitude and entrance latitude and longitude. If the distance between ISP location and entrance location is within a certain limit, then the request handler process will save the values of customer type, customer identifier, customer name and customer business name and customer employee title as CURRENT_CUSTOMER_TYPE cookie, CURRENT_CUSTOMER_ID cookie and CURRENT_CUSTOMER_NAME cookie CURRENT_CUSTOMER_BUSINESS_NAME cookie, and CURRENT_CUSTOMER_EMPLOYEE_TITLE cookie respectively in the current browser and the request handler process will continue, otherwise the request handler process will delete the cookies CURRENT_CUSTOMER_TYPE cookie, CURRENT_CUSTOMER_ID cookie, CURRENT_CUSTOMER_NAME cookie, CURRENT_CUSTOMER_BUSINESS_NAME cookie, and CURRENT_CUSTOMER_EMPLOYEE_TITLE cookie and the request handler process will be terminated.

If the customer type is ‘C’, then customer identifier, and customer name would be collectively referred to as customer information, otherwise customer identifier, customer name, customer business name and customer employee title would be collectively referred to as customer information. It is also possible not to include customer identifier in customer information so that customer personal information may not be disclosed to home client. For example, when a delivery person's business information is included in the customer information then the delivery person's personal mobile phone number may not be included in the customer information. The customer may also add any information as text to the customer information.

The request handler process would send the customer information to home client as a notification to home clients' app.

Upon receiving customer information, the home clients can decide whether to communicate with the customer or not. If the home clients decide to communicate with the customer and if the QR Code Doorbell is used as complement to Video Doorbell, then the home clients can use the video doorbell communication channel to communicate with the customer.

If required, upon approval from home client in response to sending the customer information to the home client and if the customer is a visitor client, then the intermediary agent would facilitate a communication path for exchanging texts between home client app and visitor client app. Home client can positively verify the customer because the visitor client is authenticated through the intermediary agent.

If required, upon approval from home client in response to sending the customer information to the home client and if the customer is an intruder, then the intermediary agent would facilitate a communication path for exchanging texts between home client app and intruder mobile device browser. Home client can positively verify the intruder because the customer is verified through the intermediary agent.

If the home clients decide to communicate with the customer using QR Code Doorbell, then the home clients can use the text and/or video communication provided by the intermediary agent. In the case of visitor clients, the intermediary agent would provide text communication between visitor client app and home client app using the text communication component (58-9) under communication component (58-8). In case of intruders, the intermediary agent would provide text communication between intruder web browser and home client app using the text communication component (58-9) under communication component (58-8). In the case of visitor clients, the intermediary agent would provide a video communication between visitor client app and home client app using the video communication component (58-10) under communication component (58-8). In case of intruders, the intermediary agent would provide video communication between intruder web browser and home client (5S) app using the video communication component (58-10) under communication component (58-8). If the intermediary agent cannot provide video communication, then intermediary agent would request home client to use a video communication provided by external service providers and pass on credentials to visitor client or intruder through text communication component (58-9) to join the video communication provided by external service providers. If the intermediary agent cannot provide video communication, then intermediary agent would request visitor client or intruder to use video communication provided by external service providers and pass on credentials to home client through text communication component (58-9) to join video communication provided by external service providers.

The request handler (58-2) would update DESCRIPTION by appending every communication as it takes place between home client and visitor client or intruder to DESCRIPTION in single unit entrances log table where OWNER_ID is equal to owner identifier, LOCATION_ID is equal to location identifier, ENTRANCE_ID is equal to entrance identifier and LOG_SEQ is equal to new log sequence.

If the home clients decide to provide access to the visitor clients or intruders to enter through the locked entrance identified by the entrance identifier into a secured area, then the home clients would unlock the locked entrance identified by the entrance identifier remotely or at the entrance identified by the entrance identifier.

Home clients can always provide values for OWNER_ID, LOCATION_ID, ENTRANCE_ID, begin date and end date to intermediary agent to view and/or download log report as shown in flowchart in FIG. 15C.

Visitor clients can always provide values for CUSTOMER_ID, begin date and end date to intermediary agent to view and/or download log report as shown in flowchart in FIG. 15C.

### QR Code Communication & Automation

### Intercom Video

By design Video Doorbell Systems can be used only for Single Unit Buildings and cannot be used for Multiunit Buildings such as apartments or commercial office buildings or gated communities and the like because in a multiunit environment, each unit will be under the control of individual occupants. Also, there will be common areas shared by all occupants and restricted areas under the control of individual occupants. Visitors and occupants must pass through common areas before accessing restricted areas controlled by individual occupants. However, Video Doorbell Systems can be used by individual unit occupant at the entrance to their individual units but not at the entrance common to more than one unit. Multiunit Buildings such as apartments or commercial office buildings or gated communities and the like use Intercom video Systems rather than Video Doorbell Systems. The primary objects of Intercom video Systems are to provide live video stream from the Intercom video System located at the common entrance to a mobile device or a desk top device of a specific occupant chosen by the visitors from a list of occupants displayed by Intercom video Systems and to let individual occupants to provide access to visitors by unlocking a Common Electronic Access Door protecting common areas. The Common Electronic Access Door can be part of the Intercom video System or can be part of an external Electronic Access Door Control system.

The visitors can be friends and families or employees of companies providing services such as deliveries, plumbing, air-conditioning, handyman, pest control, pet care, child care, senior care and the like or intruders. Visitors who cannot be positively identified from the video, may show identification cards such as business cards and driver's licenses through the video. But the occupants cannot verify the authenticity of such identification cards. Even with facial recognition, it may not be possible to positively identify the unknown visitors because people move from place to place and from job to job. The unknown visitors cannot contact the occupants without the occupants providing their sensitive contact identifier such as cell phone number or email address to unknown visitors. It may not be safe for occupants to share sensitive information with unknown visitors. So, the occupants must let the unknown visitors without positive identification to enter common secured areas shared by other occupants by remotely unlocking doors controlled by Intercom video System or by external Electronic Access Door Control system. Even upon meeting at the common entrance, the occupants cannot positively identify the unknown visitors from the identification documents.

In Intercom video Systems, visitors must choose a unit occupant from a list of unit occupants displayed on the Intercom video System Monitor. When Intercom video Systems are used for Multiunit Buildings such as apartments or for offices or for gated communities and the like, the names of individual unit occupant will be published and will be visible publicly and can compromise their security.

Currently Intercom video Systems such as Butterflymx, Latchos, Swiftlane, Liftmaster and so on can be used for multiunit apartments or for commercial office buildings or for gated communities and the like. Multiunit apartments or commercial office buildings or gated community administrations are referred as administrator client, each individual unit occupants are referred as condo client.

Multiunit administrators can add, edit or delete unit and occupant information under each individual unit. Visitors can select a single unit occupant from a list of occupants displayed in the Intercom video System monitor so that a video communication can be established between the Intercom video System and the selected occupant's device. Because the names of the occupants are displayed on the Intercom video System monitor, the privacy of occupants will not be protected from visitors. The video communication cannot help the occupants to positively identify the visitors from videos received from Intercom video System. Moreover, Multiunit apartments, commercial office buildings and gated communities may already have video surveillance system where the videos from the video surveillance system and the video from Intercom video System can be one and the same and can be viewed by Multiunit administrators and by occupants in real time. When Multiunit apartments, commercial office buildings and gated communities have video surveillance system, the streaming of video to occupants from Intercom video System would be redundant. Unlike Video Doorbell Systems which uses just a camera to capture images, Intercom video System acts like kiosks with touch screen and controls. Kiosk like monitors and controls are required for Intercom video System because multiple users use Multiunit apartments, commercial office buildings or gated communities. The kiosk like Intercom video Systems may be cost prohibitive for many Multiunit apartments, commercial office buildings and gated communities.

A communication between the visitors and the occupants where the visitors can provide a positively authenticated or valid sensitive information such as fingerprint or cell phone number and the Intercom video does not provide any sensitive information such as occupant list or individual occupant information to the visitors would be an ideal solution. Such a communication can be established using a QR Code issued by an intermediary agent and displayed by Multiunit administrators near the Intercom video Systems as a complement to Intercom video Systems or displayed without Intercom video System as a replacement. If Multiunit apartments, commercial office buildings or gated communities have a video surveillance system with cameras and if the videos from those cameras are available for viewing by individual occupants, then capturing video images from Intercom video System will not be required.

Multiunit Building Administrators can register with an intermediary agent and receive a QR Code for each entrance (Note: Multifamily and commercial buildings can have more than one entrance). Using QR Automation system for Multiunit Buildings can be a complement to the Intercom video System or can be a replacement for the Intercom video System. When QR Code is displayed next to a functional Intercom video System then it will be a complement to Intercom video System. When QR Code is displayed without an Intercom video System then it will be a replacement to Intercom video System.

Referring now to the figures, and to FIGS. 1 & 1A in particular, the QR Automation system 1 of the present invention is shown to generally comprise an operative combination of a plurality administrator clients (5M) implemented use cases 11 and a plurality of intermediary agent (2) implemented use cases 3. In particular, administrator clients (5M) of the present invention will-generally display for a visitor (4) or intruder I, a QR Code 12 containing a request message for identifying the administrator client (5M) to an intermediary agent (2) for the purpose of requesting that the intermediary agent (2) provide for the visitor clients (4) or the intruders (I) a communication channel between the visitor clients (4) or the intruders (I) and a condo client (6M) with the consent of condo client (6M).

Additionally, intermediary agent (2) provides a means 7 for any consumer to register as a visitor client (4) and for business or merchants to register their business and their employers as visitor clients (4).

Additionally, intermediary agent (2) provides a means 8 for operators of multiunit buildings to register as administrator clients (5M).

Additionally, intermediary agent (2) provides a means 9 for administrator clients (5M) to add condo clients (6M).

Additionally, intermediary agent (2) provides a means 10 for administrator clients (5M) to edit condo clients (6M) information and condo clients (6M) to edit their own information.

Additionally, intermediary agent (2) provides a means 13 for visitor clients (4) and for intruders (I) to send request message by scanning the QR Code.

Additionally, intermediary agent (2) provides a means 14 for authenticating visitor clients (4) and for validating intruders (I).

Additionally, intermediary agent (2) provides a means 15 for visitor clients (4) and intruders (I) to select a condo client (6M) from condo client list maintained by administrator clients (5M).

Additionally, intermediary agent (2) provides a means 16 for a communication channel for texting between visitor clients (4) or intruders (I) with condo clients (6M).

Additionally, intermediary agent (2) provides a means 17 for a communication channel for audio/video between visitor clients (4) or intruders (I) with condo clients (6M).

Additionally, intermediary agent (2) provides a means 18 for exchanging credentials for a communication channel for audio/video, provided by an external resource provider 19, between visitors (4) or intruders (I) and condo clients (6M).

Additionally, intermediary agent (2) provides a means 21 for visitor clients (4), administrator clients (5M) and condo clients (6M) to view and/or download log reports created for any specific begin date, begin time, end date and end time.

Intermediary agent (2), visitor clients (4), intruders (I), administrator clients (5M) and condo clients (6M) can also be referred to as intermediary agent, visitor clients, intruders, administrator clients and condo clients respectively.

Here are how visitor clients, intruders, administrator clients and condo clients would use QR Automation system as a complement or replacement to Intercom Video Systems in Multi Unit Buildings:

As described in ‘DETAILED DESCRIPTION OF THE PREFERRED EMBODIMENTS’ section, any consumer can use customer web form provided by intermediary agent to register and maintain their personal information with the intermediary agent as customer.

As described in ‘DETAILED DESCRIPTION OF THE PREFERRED EMBODIMENTS’ section, any business can use business registration web form provided by intermediary agent to register and maintain their business information with the intermediary agent as business.

As described in ‘DETAILED DESCRIPTION OF THE PREFERRED EMBODIMENTS’ section, any business can use business registration web form provided by intermediary agent to add or edit or delete employees with the intermediary agent.

As described in ‘DETAILED DESCRIPTION OF THE PREFERRED EMBODIMENTS’ section, any registered employee or a business can use employee maintenance web form provided by intermediary agent to edit their own information with the intermediary agent.

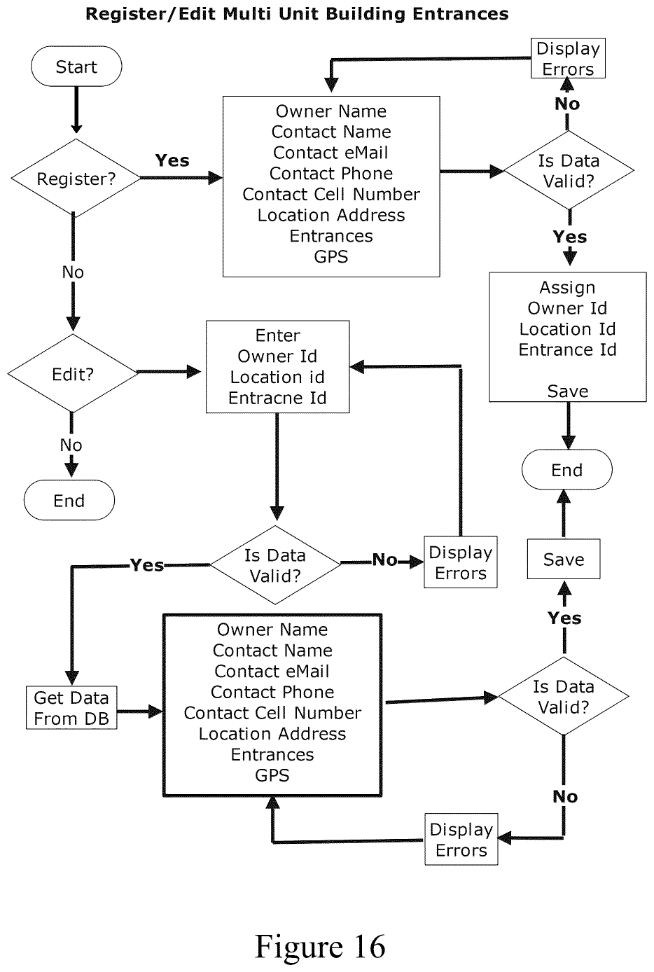

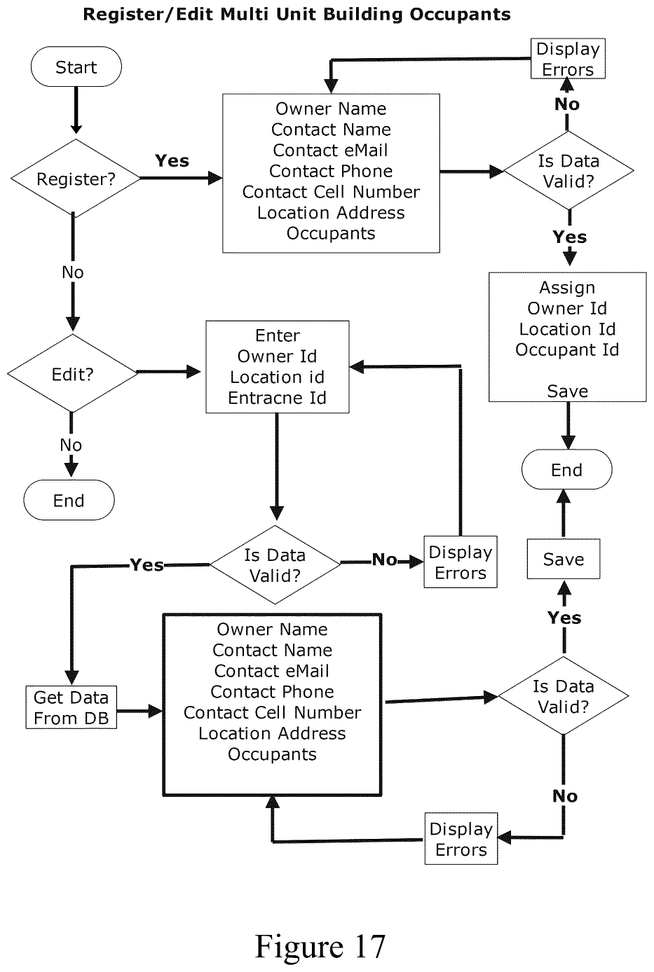

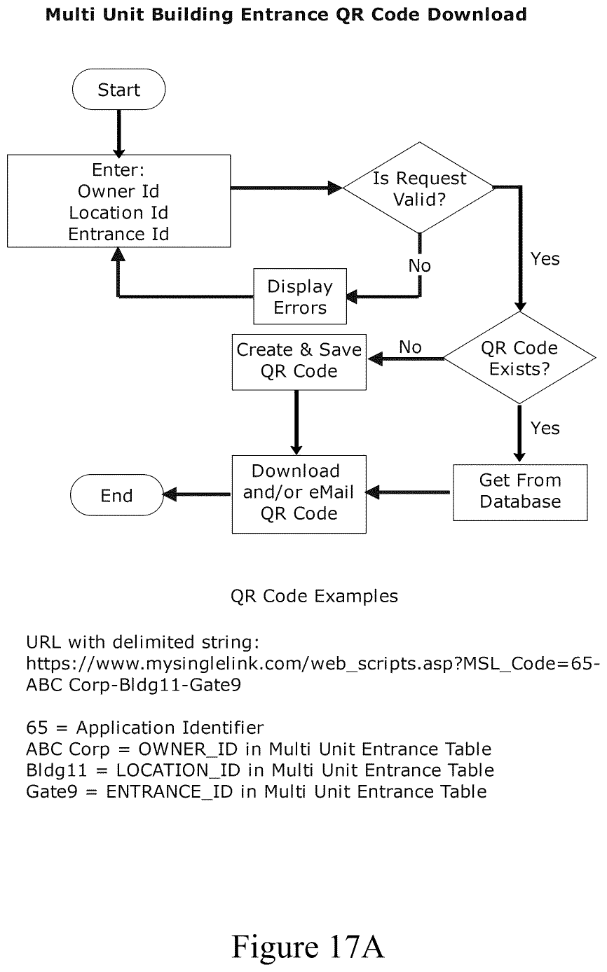

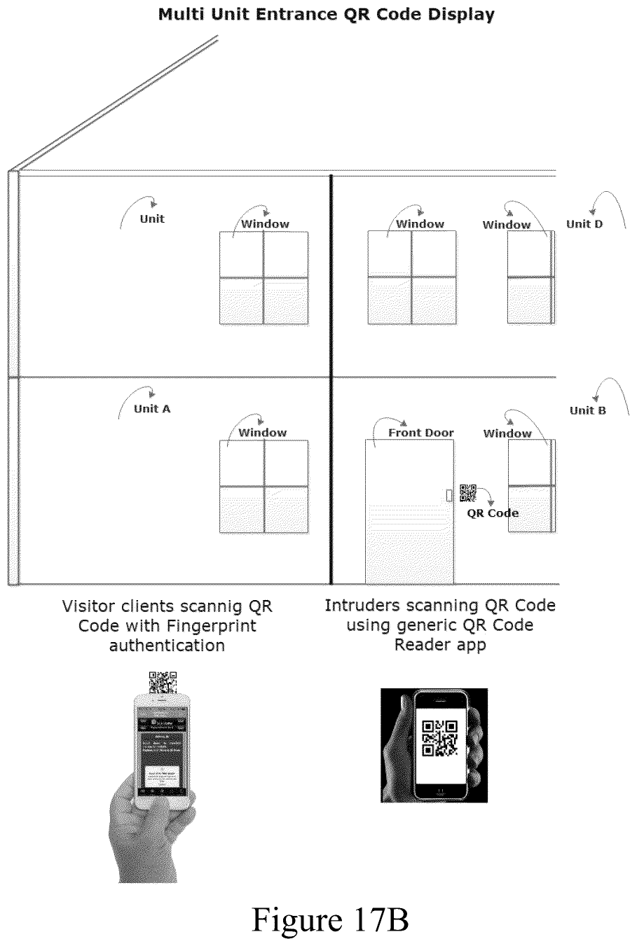

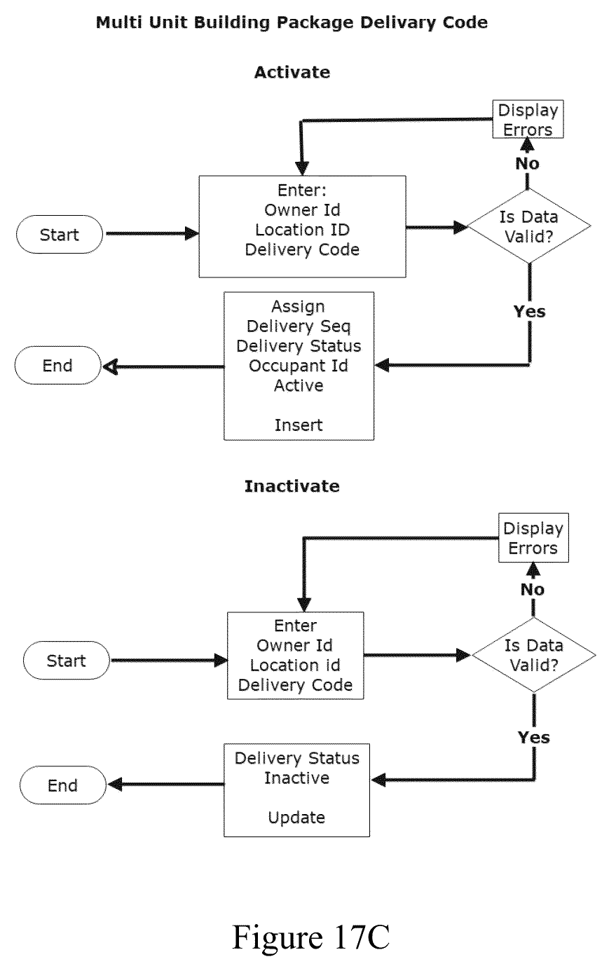

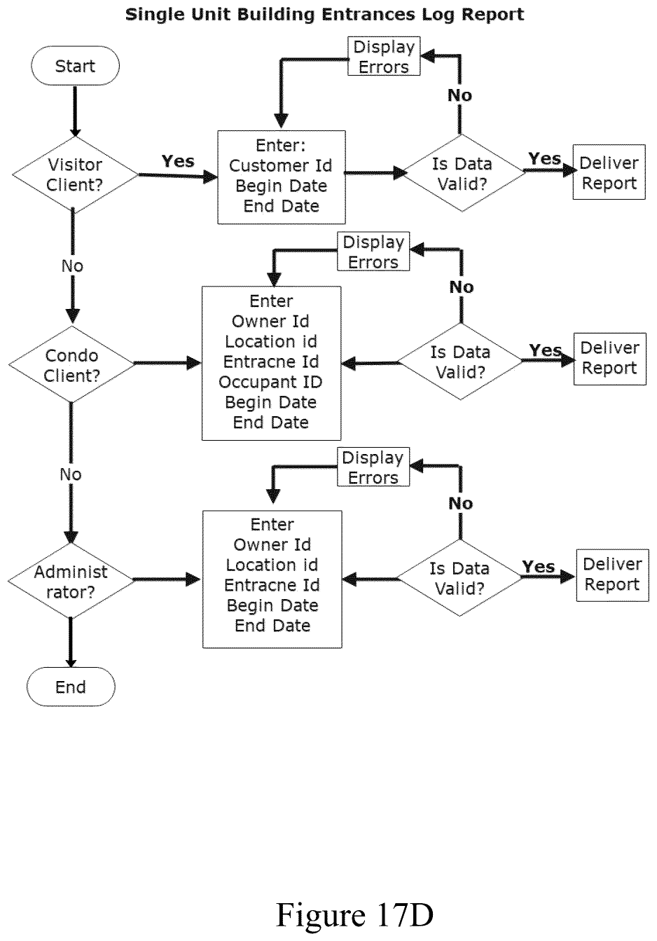

Administrator clients would register and maintain the entrances information of each entrance in each Multiunit Building under their operation with an intermediary agent as shown in flowchart in FIG. 16. Intermediary agent would use multiunit building database as shown in a class diagram, in FIG. 8. Each Multiunit Building operator will be assigned a unique OWNER_ID, values for OWNER_NAME, CONTACT_NAME, CONTACT_EMAIL, CONTACT_PHONE and CONTACT_CELL will be captured and saved in Multiunit Owner Table. Each Multiunit Building location will be assigned with a unique LOCATION_ID, value for ADDRESS will be captured and saved in Multiunit Location Table as shown in a class diagram, in FIG. 8. Each entrance in each Multiunit Building location will be assigned with a unique ENTRANCE_ID, values for ENTRANCE_NAME, LATITUDE, LONGITUDE will be captured and saved in Multiunit Entrance Table as shown in a class diagram, in FIG. 8. Each occupant in each Multiunit Building location will be assigned with a unique OCCUPANT_ID, values for OCCUPANT_NAME, OCCUPANT_CELL will be captured and saved in Multiunit Occupant Table as shown in a class diagram, in FIG. 8. Multiunit Building Administrators are referred as administrator clients and occupants are referred as condo clients. Administrator clients can download QR Codes as shown in flowchart in FIG. 17A. Administrator clients would provide Multiunit OWMER_ID, LOCATION_ID and ENTRANCE_ID to intermediary agent to download QR Codes. QR Codes will be saved as QR_CODE in Mule-Unit Entrance Table. Administrator clients can display unique QR Codes at each entrance, in each location, in each Multiunit Building as shown in FIG. 17B.

Individual Unit occupants are referred as condo clients would register with the intermediary agent and can use intermediary agent app or any app interfaced with intermediary agent to communicate. If condo client's cell number registered with the intermediary agent is same as the OCCUPANT_CELL saved in Multiunit Occupant Table as shown in a class diagram, in FIG. 8, then the condo client will receive a notification whenever a visitor or an intruder selects the condo client from the occupants list at the Multiunit Building location.

Each time intermediary agent receives a package delivery information from condo clients a new row in multiunit delivery table will be inserted using owner identifier for OWNER_ID, location identifier for LOCATION_ID, a unique assigned value for DELIVERY_SEQ, ‘A’ for DELIVERY STATUS to indicate that the status is active, a captured value from condo client for DELIVERY_CODE and a captured value from condo client for OCCUPANT_ID as shown in FIG. 17C. To get unique assigned value for DELIVERY_SEQ the intermediary agent would retrieve the last delivery sequence from multiunit delivery table using owner identifier for OWNER_ID and location identifier for LOCATION_ID. If the intermediary agent can retrieve last delivery sequence, then the intermediary agent would set new delivery sequence by incrementing the last delivery sequence by 1, otherwise the intermediary agent would set new delivery sequence as 1. The value for DELIVERY_CODE may be part of package tracking code and unique for a package and will be known only to delivery person who may be a visitor client or intruder.

When an individual scans a QR Code displayed at any entrance, at any location in any Multiunit Building using an app provided by the intermediary agent or an app interfaced with intermediary agent or any generic QR Code Reader app or a camera, the content of the QR Code will be passed on to QR Code web page hosted by intermediary agent, upon verification of the QR Code by the QR Code web page, the information will be passed on to the request handler (58-2) in the intermediary agent to initiate a request handler process as described in ‘DETAILED DESCRIPTION OF THE PREFERRED EMBODIMENTS’ section and the request handler process will continue here.

When a QR Code is scanned by an individual, the request handler process would have saved the request message embedded in the QR Code as request message and the information of the individual scanned the QR Code as customer identifier, customer type, customer name, customer business name, customer employee title, customer latitude and customer longitude.

If the customer type is ‘C’ or ‘M’, then the customer will be referred to as a visitor client, otherwise the customer will be referred to as an intruder.

If the customer type is ‘C’, then the individual scanned the QR Code is a visitor client and does not represent any business. If the customer type is ‘M’, then the individual scanned the QR Code is a visitor client and represents a business. If the customer type is ‘U’, then the individual scanned the QR Code is an intruder.

Then the request handler process would segregate the request message, based on a pre-defined procedure into four segments namely application identifier, owner identifier, location identifier and entrance identifier respectively. If the request handler process cannot break the request message into four segments the request handler process will be terminated. If the application identifier is not for processing QR Codes from multi-unit building entrance, then the request handler process will be terminated. The owner identifier is also referred to as administrator clients.

Then the request handler process would retrieve LATITUDE as entrance latitude and LONGITUDE as entrance longitude of the Multi Unit Building from multi-unit building entrance table in multi-unit building database using owner identifier for OWNER_ID, location identifier for LOCATION_ID and entrance identifier for ENTRANCE_ID. If the request handler process cannot retrieve entrance latitude and entrance longitude information, then the request handler process will be terminated.

Then the request handler process would start a new log in multi-unit entrances log table. The request handler process would retrieve the last log sequence from multi-unit entrances log table using owner identifier for OWNER_ID, location identifier for LOCATION_ID and entrance identifier for ENTRANCE_ID. If the request handler process can retrieve last log sequence then the request handler process would set a new log sequence by incrementing the last log sequence by 1, otherwise the request handler process would set new log sequence as 1. Then the request handler process would insert a new row in multi-unit entrances log table using owner identifier for OWNER_ID, location identifier for LOCATION_ID, entrance identifier for ENTRANCE_ID new log sequence for LOG_SEQ, customer type for SCAN_TYPE, customer identifier for SCAN_ID, current server date for BEGIN_DATE, current server time as BEGIN_TIME, current server date for END_DATE, current server time as END_TIME and blank value for DESCRIPTION.

When the request handler process terminates, the request handler process would update END_DATE, END_TIME and DESCRIPTION by using current server date for END_DATE, current server time for END_TIME and appending the reason for termination to DESCRIPTION in the last row in multi-unit entrances log table where OWNER_ID is equal to owner identifier, LOCATION_ID is equal to location identifier, ENTRANCE_ID is equal to entrance identifier and LOG_SEQ is equal to new log sequence.

If customer type is ‘C’ or ‘M’, then customer latitude and customer longitude would be the customer's current location. Then the request handler process would determine whether the customer's current location is within a certain limit from the entrance location based on customer latitude and customer longitude. If the distance between the customer current location and entrance location is within a certain limit, then the request handler process will continue, otherwise it will be terminated.

If customer type is ‘U’, then customer latitude and customer longitude would be the latitude and longitude of customer's internet service provider (ISP) providing internet service for the customer and customer latitude and customer longitude would be ISP latitude and longitude respectively. Then the request handler process would determine whether the ISP location is within a certain limit from the entrance location based on ISP latitude and longitude and entrance latitude and longitude. If the distance between ISP location and entrance location is within a certain limit, then the request handler process will save the values of customer type, customer identifier, customer name and customer business name and customer employee title as CURRENT_CUSTOMER_TYPE cookie, CURRENT_CUSTOMER_ID cookie and CURRENT_CUSTOMER_NAME cookie CURRENT_CUSTOMER_BUSINESS_NAME cookie, and CURRENT_CUSTOMER_EMPLOYEE_TITLE cookie respectively in the current browser and request handler process will continue, otherwise the request handler process will delete the cookies CURRENT_CUSTOMER_TYPE cookie, CURRENT_CUSTOMER_ID cookie, CURRENT_CUSTOMER_NAME cookie, CURRENT_CUSTOMER_BUSINESS_NAME cookie, and CURRENT_CUSTOMER_EMPLOYEE_TITLE cookie and the request handler process will be terminated.

If the customer type is ‘C’, then customer identifier, and customer name would be collectively referred to as customer information, otherwise customer identifier, customer name, customer business name and customer employee title would be collectively referred to as customer information. It is also possible not to include customer identifier in customer information so that customer personal information may not be disclosed to home client. For example, when a delivery person's business information is included in the customer information then the delivery person's personal mobile phone number may not be included in the customer information. The customer may also add any information as text to the customer information.

Then the request handler process would send the customer information to condo client as a notification to condo clients' app.

Upon receiving customer information, the condo clients can decide whether to communicate with the customer or not. If the condo clients decide to communicate with the customer and if the QR Code Intercom is used as complement to intercom video, then the condo clients can use the intercom video System communication channel to communicate with the customers.

If required, upon approval from condo client in response to sending the visitor client information to the condo client, the intermediary agent would facilitate a communication path for exchanging texts between condo client app and visitor client app. Condo client can positively verify the visitor client because the visitor client is authenticated through the intermediary agent.

If required, upon approval from condo client in response to sending the intruder information to the condo client, the intermediary agent would facilitate a communication path for exchanging texts between condo client app and intruder mobile device web browser. Condo client can positively verify the intruders because the intruders are verified through the intermediary agent.

If the condo clients decide to communicate with the visitor clients or intruders using QR Code Intercom, then the condo clients can use the text and/or video communication provided by the intermediary agent. In case of visitor clients, the intermediary agent would provide text communication between visitor client app and condo client app using the text communication component (58-9) under communication component (58-8). In case of intruders, the intermediary agent would provide text communication between intruder web browser and condo client app using the text communication component (58-9) under communication component (58-8). The intermediary agent would provide video communication between visitor client app and condo client app using the video communication component (58-10) under communication component (58-8). The intermediary agent would provide video communication between intruder web browser and condo client app using the video communication component (58-10) under communication component (58-8). If the intermediary agent cannot provide video communication, then intermediary agent would request condo client to use video communication provided by external service providers and pass on credentials to visitor client or intruder through text communication component (58-9) to join video communication provided by external service providers. If the intermediary agent cannot provide video communication, then intermediary agent would request visitor client or intruder to use video communication provided by external service providers and pass on credentials to condo client through text communication component (58-9) to join video communication provided by external service providers.

The request handler process would update DESCRIPTION by appending each and every communication as it takes place between condo client and visitor client or intruder to DESCRIPTION in the last row in multi-unit entrances log table where OWNER_ID is equal to owner identifier, LOCATION_ID is equal to location identifier, ENTRANCE_ID is equal to entrance identifier and LOG_SEQ is equal to new log sequence.

If the condo clients decide to provide access to the visitor clients or intruders to enter a secured area, then the condo clients would unlock the entrance remotely or at the entrance.

Condo clients can always provide values for OWNER_ID, LOCATION_ID, ENTRANCE_ID, OCCUPANT_ID, begin date and end date to intermediary agent to view and/or download log report as shown in flowchart in FIG. 15C.

Visitor clients can always provide values for CUSTOMER_ID, begin date and end date to intermediary agent to view and/or download log report as shown in flowchart in FIG. 15C.

Administrator clients can always provide values for OWNER_ID, LOCATION_ID, ENTRANCE_ID, begin date and end date to intermediary agent to view and/or download log report as shown in flowchart in FIG. 15C. The administrator client may not get personal information of visit clients or intruders for privacy protection.

### QR Code Communication & Automation

### Restaurant Automation

For decades Merchants at brick-and-mortar stores have been providing manual, paper-based Customer service using Public Address system. For example, guest sign-in through hosts at Restaurants, Customer Service Counters in grocery stores, in pharmacies, in medical offices and so on. In 1995 coaster pager systems was introduced and Merchants switched over from Public Address system to short range coaster pager systems which did not improve productivity. Even with coaster pager systems, Merchants still used hosts to maintain paper-based waitlists and Customers had to wait in line to hand over their information to hosts. The only modification was sending alerts to coaster pagers instead of making an announcement over Public Address System. This also forced Merchants to handover valuable pagers without taking any collateral or taking driver's license as collateral. Also, these coaster pagers are battery operated and required daily maintenance like charging. Later, from paper-based systems, Merchants switched over to computer-based systems using standalone computers without any networking capabilities. Merchants were able to use cell phones to send text messages to customers. This modification again did not improve productivity, because Merchants still had to hire hosts to enter information into computers, send text messages and Customers had to wait in line to hand over cell phone number and personal information to hosts. Also, there was an added cost in sending text messages. Merchants were able to send alerts through text messages instead of sending alerts to coaster pagers. With the introduction of internet, Merchants started using computers connected to cloud servers instead of using standalone computers. This enabled Merchants to accept reservations and appointments. Again, there was no improvement in productivity or in Customer Service, because still manual labor was required to accept verbally Customers' mobile phone numbers, personal information, enter them manually in the computer and Customers had to wait to hand over cell phone number and personal information to hosts. Also, handing over sensitive information like mobile phone numbers and/or emails verbally to hosts compromised Customers' privacy, because sensitive information was handed over verbally to employees and other nearby customers. With the introduction of kiosks customers were asked to enter the information in kiosks instead of verbally handing it over to hosts. This involved considerable cost and only one customer can use the kiosk at a time which added more wait time for the customers. Adding additional kiosks was out of reach for the majority of merchants.

In 2012 MySingleLink waitlist system using Bring Your Own Device concept was introduced based on patented authentication system. This was a real improvement with a reduction in labor cost and protected Customer sensitive information like mobile phone numbers and/or emails. Merchants displayed paper or plastic, or metal printed QR Codes at several locations. Customers simply scanned the QR Code while being near the locations where the QR Codes were displayed and entered required information. For security reasons customers not being at specific locations, based on GPS coordinates, were not allowed to submit the QR Codes. Even though text messages can be sent, it is not required. Customers received app alerts and/or were able to view their status in a queue on their mobile devices and/or on a display monitor in addition or instead of text messages. Bring Your Own Device systems also provided additional opportunities like accepting payments in advance so that Customers can walk out at the end without waiting to pay and without making payment manually. Customers at the time of signing-in were given the opportunity to authorize a certain amount for the goods and services they were going to receive. This enabled the Customers not to wait at the end to pay and helped the Merchants to serve more Customers. Not only this automated most of the work of hosts and of the employees serving products and services, but also protected Customers' sensitive information like credit card numbers, mobile phone numbers and emails. Bring Your Own Device systems also provided additional opportunities like accepting payments through a QR Code printed on receipts.

This invention is additional improvements to Bring Your Own Device systems to include QR Code Video for private communications with the Merchant, for private communications within a group, for public communications with the participants in the community, self-seating and self-checkout. For example, in a restaurant customers can communicate privately with employees of restaurant, can communicate privately with fellow guests in a group sharing a table and can communicate publicly with fellow guests concurrently present at the location without giving out sensitive information like mobile phone number or email addresses or any sensitive information. Through private communication with employees of restaurant, customers can open a tab, place orders, request for help and so on. Through private communication, customers can share transaction specific information with fellow guests in the group to share the tab. Through public communication, guests concurrently present at the location can exchange information about food and drinks and can make recommendations to each other. For example, in a restaurant customers can seat themselves with or without a guiding map displayed on customers' mobile devices, use a QR Code to communicate with video waiters, use a QR Code communicate with video wine connoisseur and use a QR Code for self-check-out. For example, merchants can also deploy robots with QR Codes to seat guests and or provide customer service.

Even though the example given here is for Restaurants, this invention is not limited to Restaurants. The same private and public communication with others in group, with employees of merchants and with others concurrently present in a specific location can be used in any private or public places like golf courses, stadiums, shopping malls, movie theaters, events like marathon and so on.

As another example, in a sports event any spectator can communicate privately with concession operators, communicate privately with fellow spectators in the group and can communicate publicly with fellow spectators in the sports event. Through private communication with employees, customers can open a tab, place orders, request for help and so on. Through private communication with fellow spectators in the group customers in the group can share the cost. Through public communication, participants can exchange information about sports with fellow spectators.

As another example, in a golf course any player can communicate privately with pro-shop and concession employees, communicate privately with fellow players in the team and can communicate publicly with fellow players in the golf course without sharing sensitive personal information like cell phone number and/or email address. Through private communication with pro-shop and concession employees, customers can open a tab, get a score card, place orders for drinks and food, request for help and so on. Through private communication with other players in the group, customers in the group can view each other's score cards. Each score card will be designated with a unique QR Code and each member in the group can scan the QR Code of fellow members' score card. Score cards can be digital or printed. Through public communication, players can exchange information about the golf course with fellow players. Golf players can also view the position of fellow players as they enter their score at the end of each hole. Golf players can view the score card only of the members in the group and not other players in the golf course. Knowing the position of fellow players in the golf course, players can keep a safe distance between each fellow and can move faster. More players can play at any given period. Pro-shop can address any problems immediately when players are not moving faster. Players can communicate with all fellow players for tips and recommendation without sharing sensitive personal information with each other.

It is impossible to provide all the examples where private and public communications can be exchanged without sharing sensitive information such as mobile phone number and/or emails.

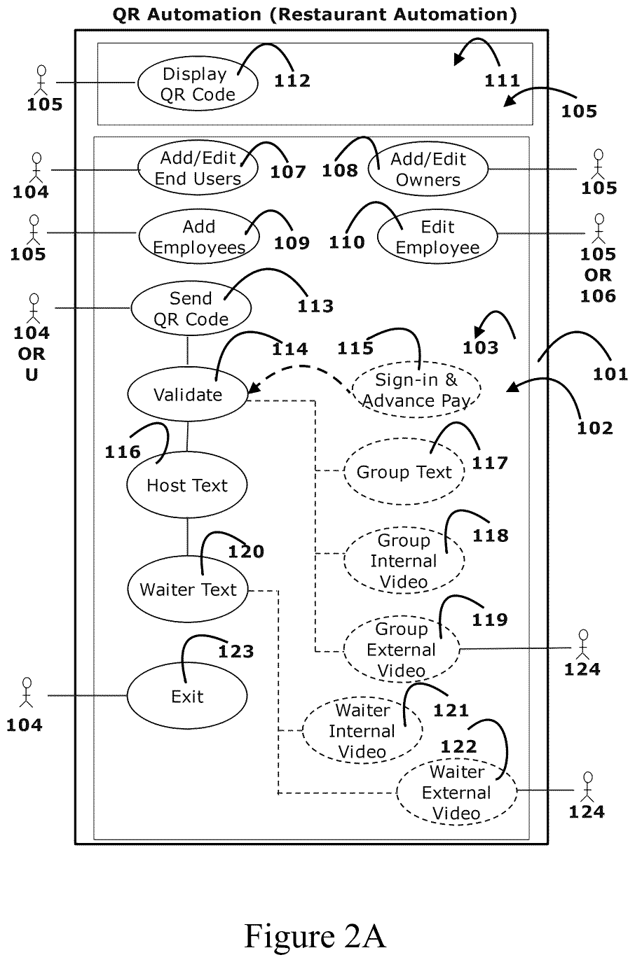

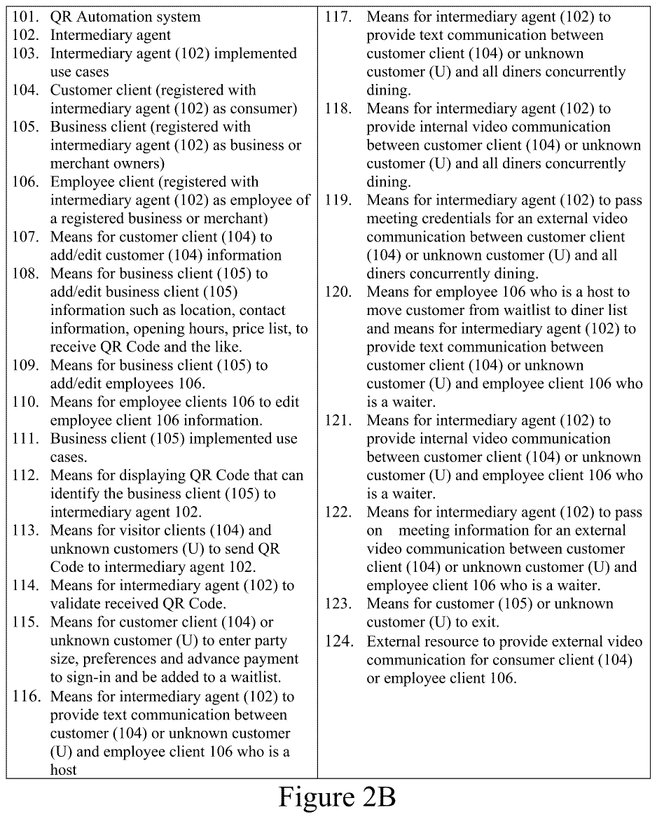

Referring now to the figures, and to FIG. 2A) in particular, the QR Automation system (101) of the present invention is shown to generally comprise an operative combination of a plurality of restaurant clients (105) implemented use cases (111) and a plurality of intermediary agent (102) implemented use cases (103). In particular, the restaurant client (105) of the present invention will generally display for a customer client (104) or unknown customer (U) a QR Code (112) containing a request message for identifying the restaurant client (105) to an intermediary agent (102) for the purpose of requesting that the intermediary agent (102) provide for the customer client (104) or the unknown customer (U) a communication channel between the customer client (104) or the unknown customer (U) and the restaurant employees (106).

Intermediary agent (102), customer clients (104), restaurant clients (105), restaurant employees (106) and unknown customer (U) are also referred to as intermediary agent, customer clients, restaurant clients, restaurant employees and unknown customers respectively.

Additionally, intermediary agent provide a means (107) for any consumer to register as a customer client.

Additionally, intermediary agent provides a means (108) for any restaurant to register as restaurant client.

Additionally, intermediary agent provides a means (109) for restaurant clients to add employee clients.

Additionally, intermediary agent provides a means (110) for restaurant clients to edit employee clients' information and employee clients to edit their own information.

Additionally, intermediary agent provides a means (113) for player clients and for unknown customers to send request message by scanning a QR Code.

Additionally, intermediary agent provides a means (114) for validating customer clients and unknown customers.

Additionally, intermediary agent provides a means (115) for customer clients and unknown customers to sign-in and authorize payment in advance.

Additionally, intermediary agent provides a means (116) for a communication channel for texting between customer clients or unknown customers with restaurant employees working as a host.

Additionally, intermediary agent provides a means (117) for a communication channel for texting between customer clients or unknown customers with fellow customer clients and unknown customers that are concurrently dining at the said restaurant client location.

Additionally, intermediary agent provides a means (118) for a communication channel for audio/video between customer clients or unknown customers with fellow customer clients and unknown customers that are concurrently dining at the said restaurant client location.

Additionally, intermediary agent provides a means (119) for exchanging credentials for audio/video meeting provided by an external resource provider (124) between customer clients or unknown customers with fellow customer clients and unknown customers that are concurrently dining at the said restaurant client location.

Additionally, intermediary agent provides a means (120) for a communication channel for texting between customer clients or unknown customers with restaurant employees working as waiters and would end the communication channel for texting between customer clients or unknown customers with restaurant employees working as hosts.

Additionally, intermediary agent provides a means (121) for a communication channel for audio/video between customer clients or unknown customers with restaurant employees working as waiters.

Additionally, intermediary agent provides a means (122) for exchanging credentials for audio/video meeting provided by an external resource provider (124) between customer clients or unknown customers with restaurant employees working as waiters.

Additionally, intermediary agent provides a means (123) for exiting the restaurant client locations and receive a copy of final receipt for the goods and services received.

Additionally, an external resource provider (124) can provide a means for external audio/video communication.

QR Code based communication can automate front and back-end workflow of any business and here is how customer clients, unknown customers, restaurant clients and employee clients would use QR Code for Restaurant Automation system, to automate front and back end of restaurant operations:

QR Code based communication system can use a database such as restaurant database with various tables such as restaurant owner table, restaurant employee table, restaurant location table, restaurant employee communication table, restaurant seating table, restaurant menu table, restaurant log table, restaurant communication log table, restaurant wi-fi log table, restaurant waitlist table, restaurant order table and restaurant order detail table as shown in a class diagram, in FIGS. 9 and 9A. In addition to restaurant database, QR Code based communication system can also use a database such as intermediary agent customer database with various tables such as customer table and customer payment table, as shown in a class diagram in FIG. 6.

Intermediary agent would use restaurant database as shown in a class diagram, in FIGS. 9 and 9A. Primary key fields in the restaurant database tables are marked as ‘(PK)’ and indexed fields in the restaurant database tables are marked as ‘(I)’.

Before continuing, however, it is noted that while the databases shown in class diagrams in FIGS. 6, 9 and 9A are exemplary of the preferred embodiments of the present invention, it is in no manner meant to be all encompassing or otherwise limiting of the wide range of implementations as are possible.

Those of ordinary skill in the art will readily recognize the SQL statements shown in describing the various embodiments to insert, update or retrieve rows from the tables in the databases as shown in class diagrams in FIGS. 6, 9 and 9A can be only examples, and the actual SQL statements can vary depending on the existing and future database management servers used by the intermediary agent.

As described in ‘DETAILED DESCRIPTION OF THE PREFERRED EMBODIMENTS’ section, any consumer can use customer web form provided by intermediary agent to register and maintain their personal information with the intermediary agent as customer.

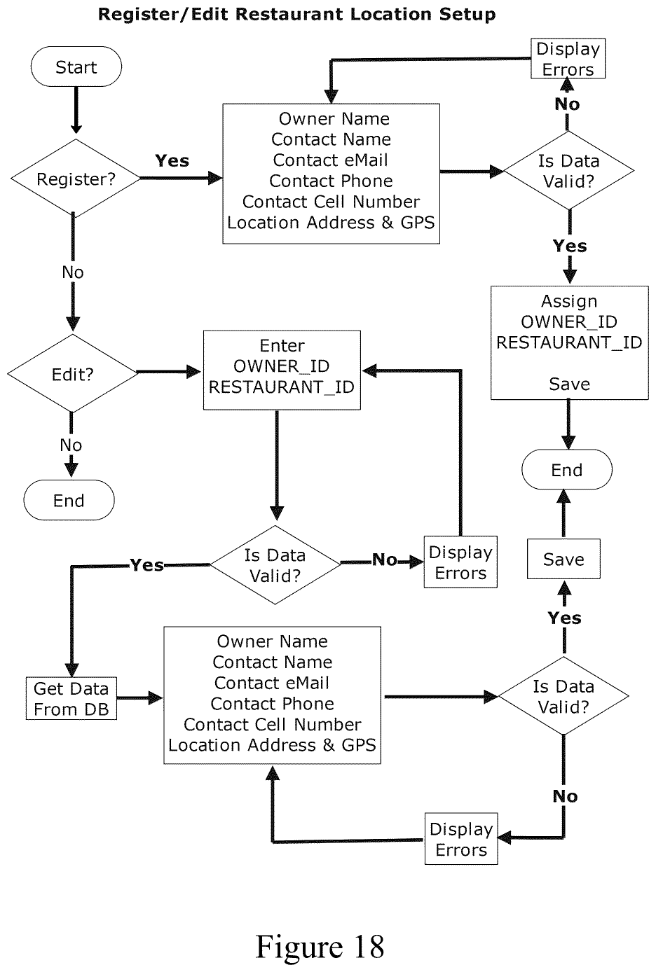

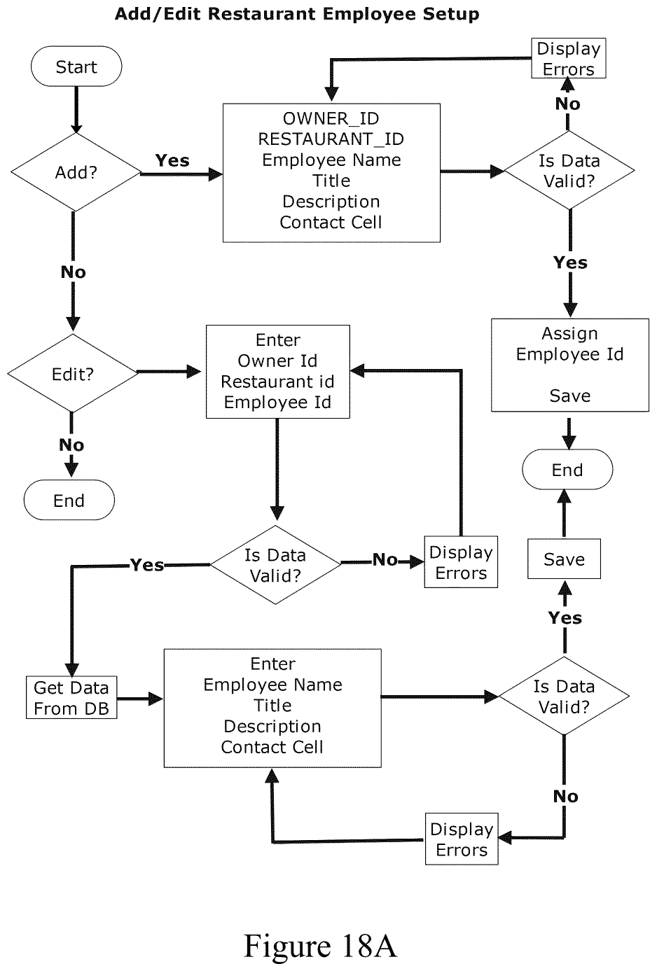

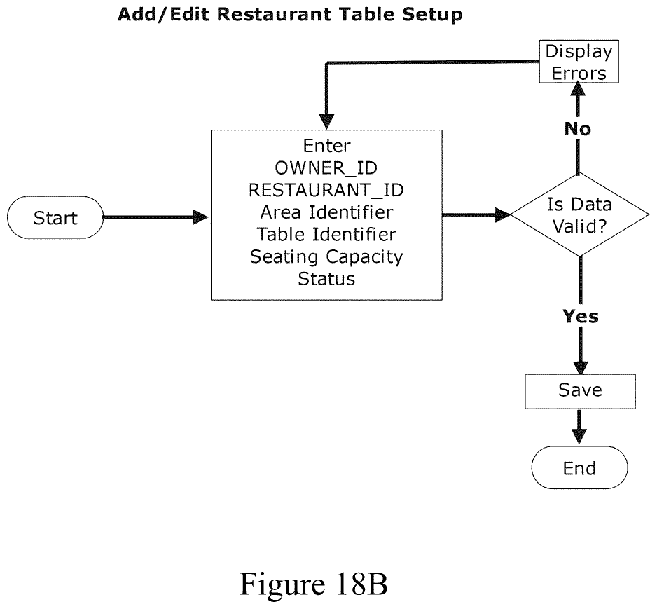

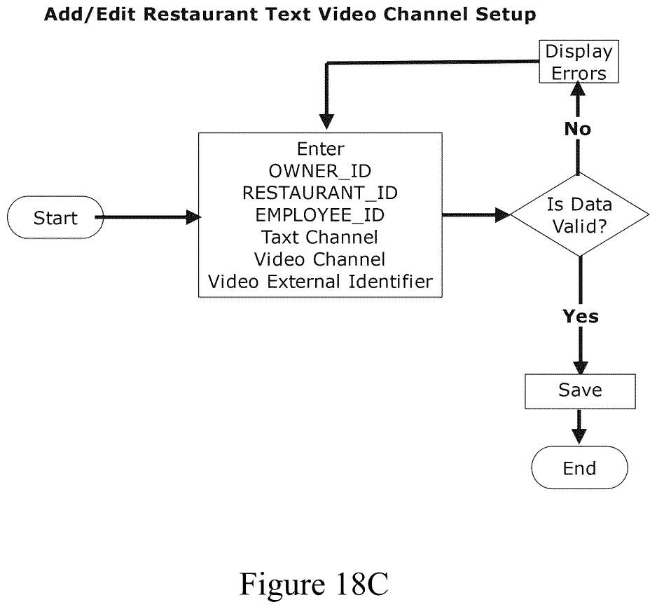

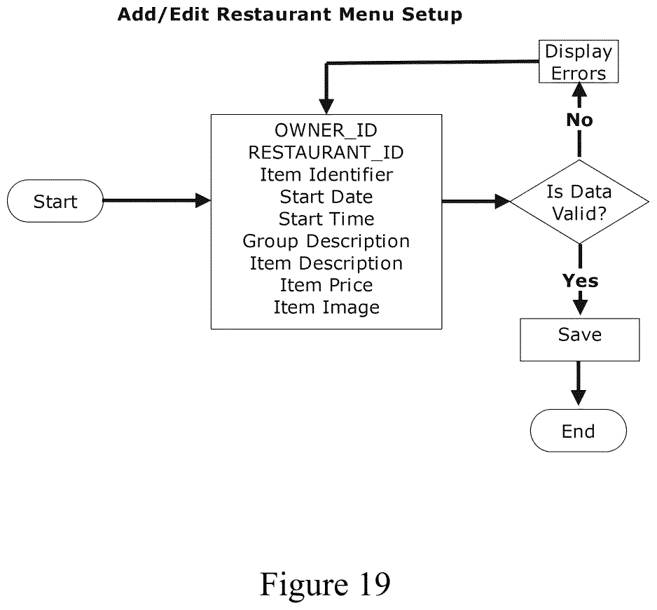

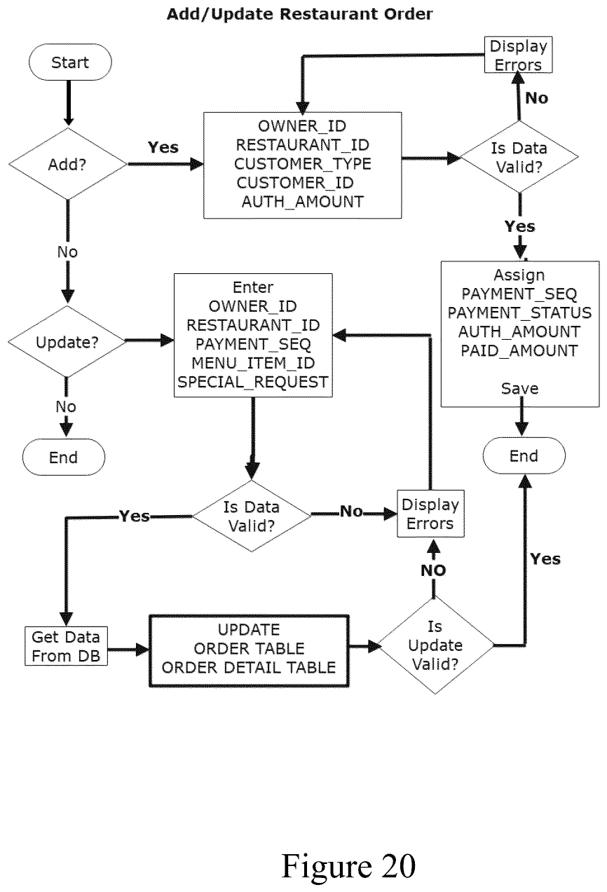

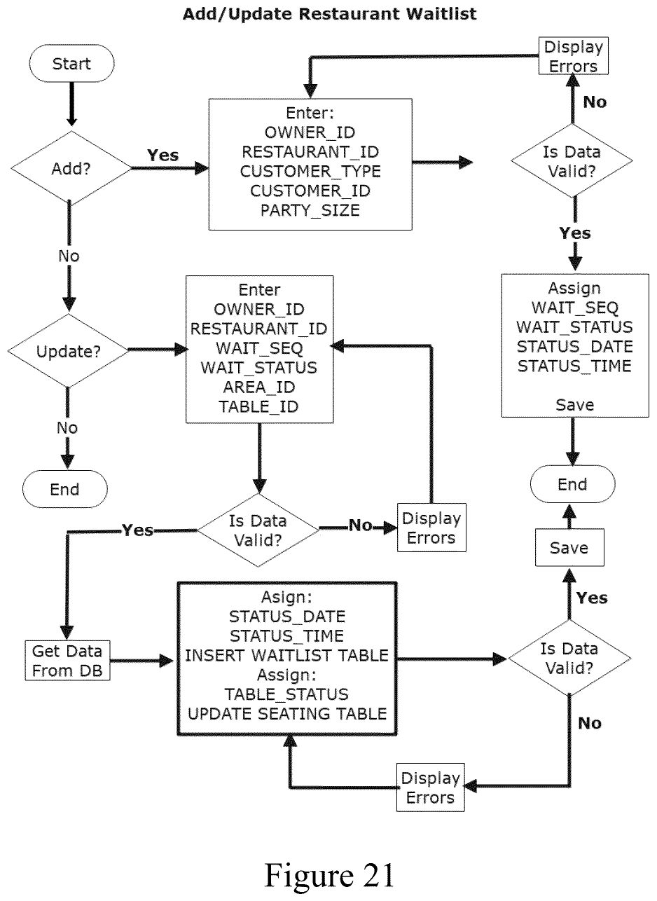

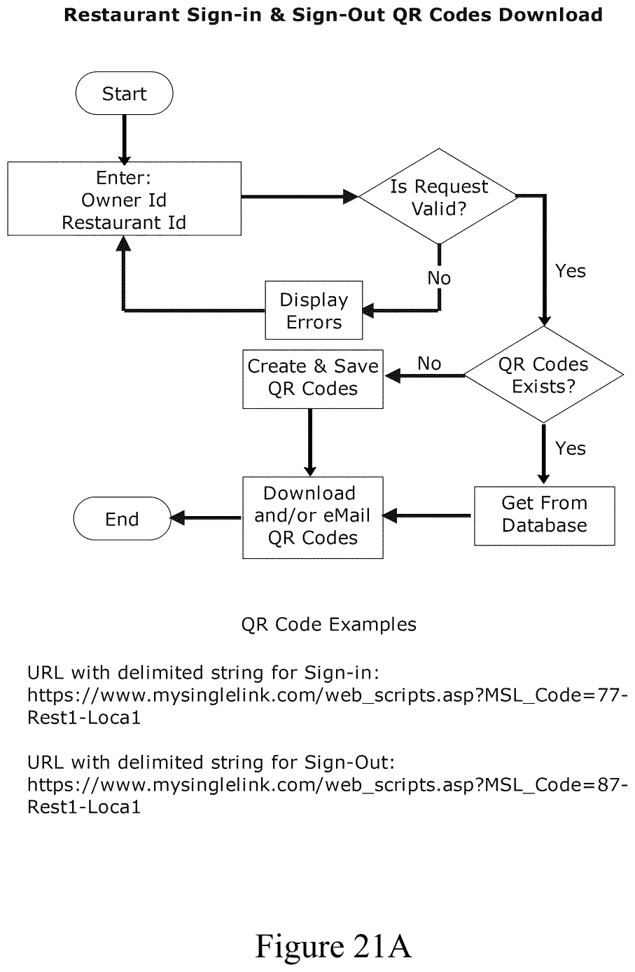

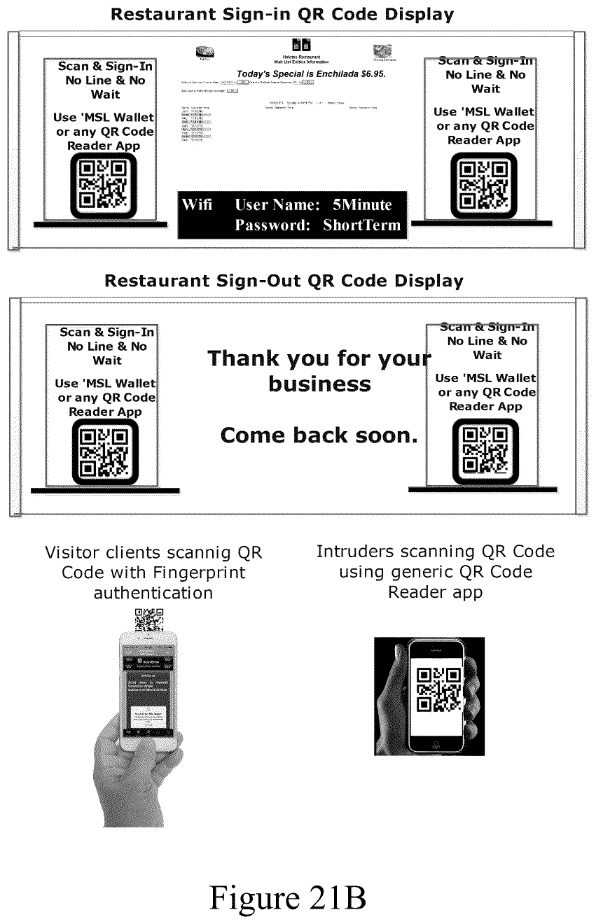

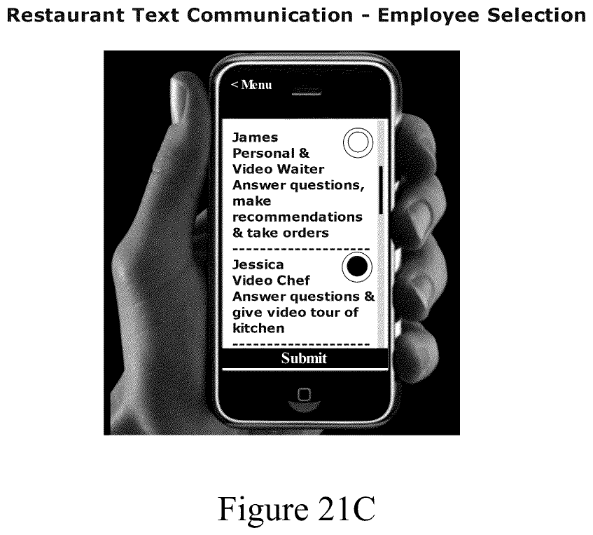

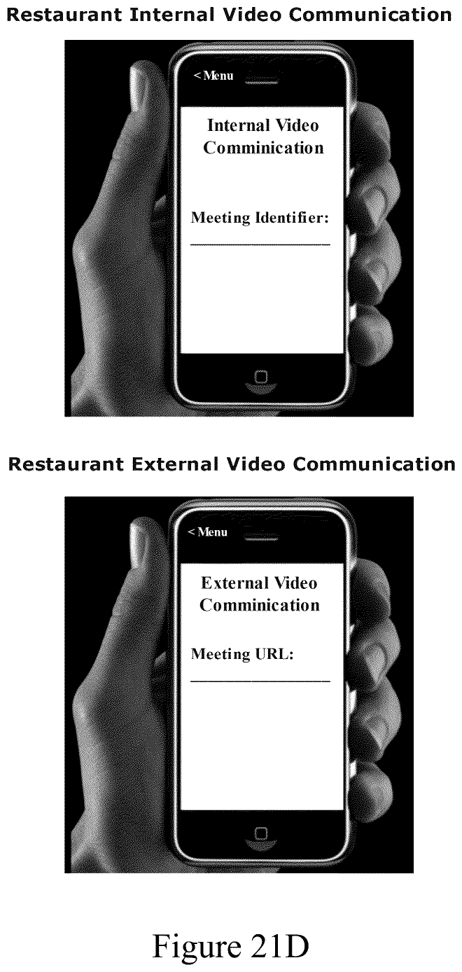

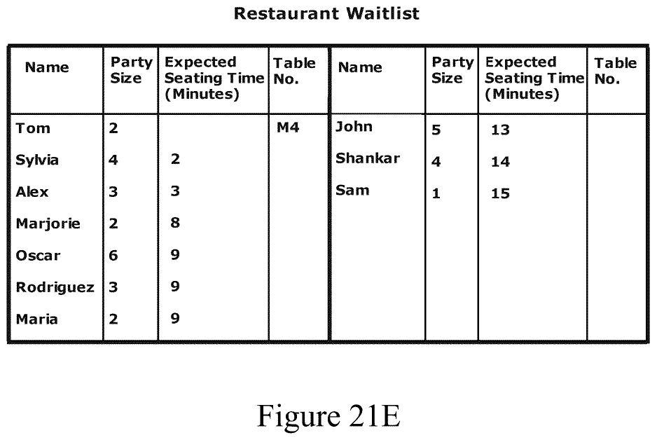

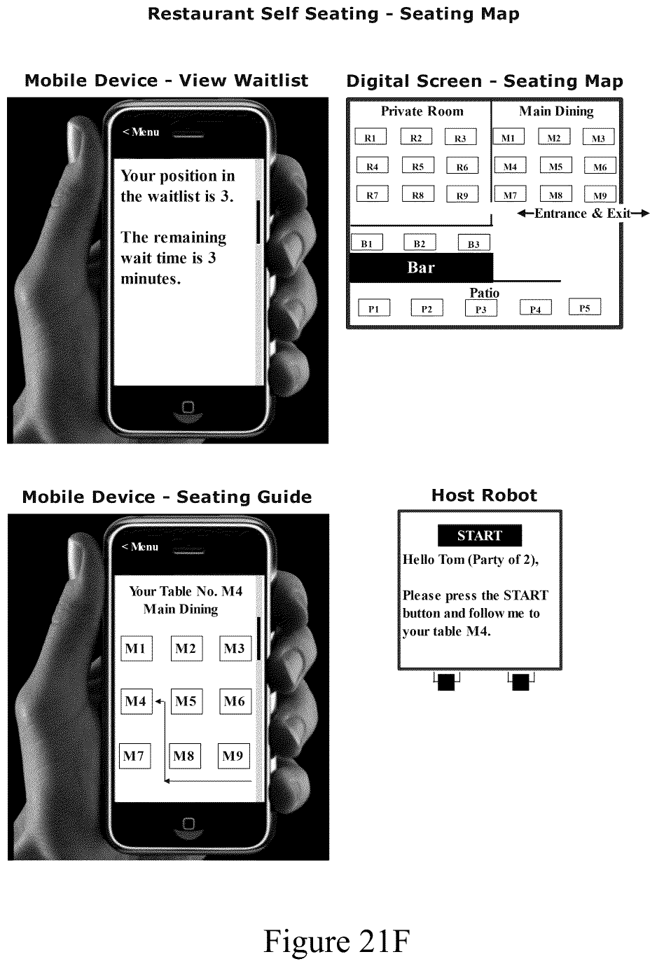

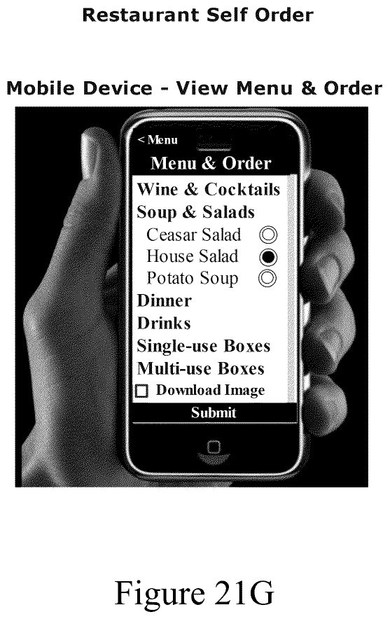

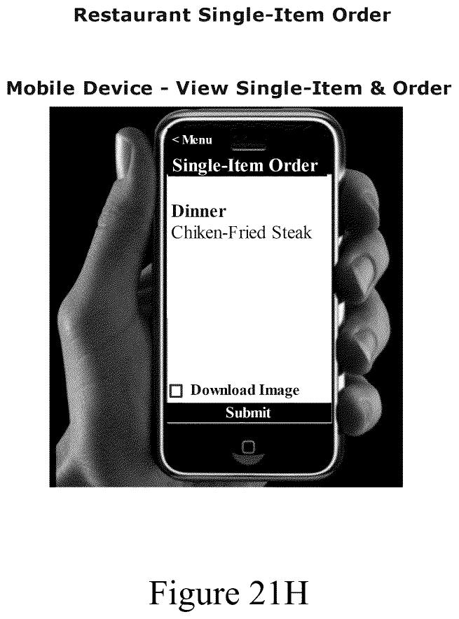

Restaurant owners would register as owner and edit their information as restaurant clients, restaurant clients would also add and edit employees, location, area, table, menu, communication channels, sing-in QR Code and sign-out QR Code information with the intermediary agent as shown in flowcharts in FIGS. 18, 18A, 18B, 18C and 19. Restaurant clients would also download and display a unique QR Code for sign-in and optionally a unique QR Code for sign-out for each restaurant location as shown in flowcharts in FIGS. 21A and 21B. Restaurant clients would also download and distribute printed menus for each restaurant location to visitor clients and unknown visitors.

Restaurant owners can register using an owner registration web form provided by intermediary agent using ‘A’ for action. Intermediary agent would assign a unique value for owner identifier and capture values for owner name, contact name, contact email, contact phone and contact cell as shown in FIG. 18. If the values are valid then the intermediary agent would insert a row into restaurant owner table using owner identifier for OWNER_ID, owner name for OWNER_NAME, contact name for CONTACT_NAME, contact email for CONTACT_EMAIL, contact phone for CONTACT_PHONE, contact cell for CONTACT_CELL and ‘N’ for LOGGED_YN. Restaurant owners can edit their information using owner registration web form provided by intermediary agent using ‘E’ for action. Intermediary agent would capture values for owner identifier, owner name, contact name, contact email, contact phone and contact cell as shown in FIG. 18. If the values are valid then the intermediary agent would update a row in restaurant owner table as shown in a class diagram as shown in FIG. 18 using owner identifier for OWNER_ID, owner name for OWNER_NAME, contact name for CONTACT_NAME, contact email for CONTACT_EMAIL, contact phone for CONTACT_PHONE, contact cell for CONTACT_CELL and ‘N’ for LOGGED_YN. Registered restaurant owners will be referred to as restaurant clients.

Restaurant owners can add a location using a location registration web form provided by intermediary agent using ‘A’ for action. Intermediary agent would capture values for owner identifier, address, latitude and longitude as shown in FIG. 18. If the captured values are valid, then the intermediary agent would assign a unique value for restaurant identifier, format the values for sign-in and for sign-out using an application identifier owner identifier and restaurant identifier. The intermediary agent would use a pre-defined delimiter, per-defined application identifier for sign-in, a pre-defined application identifier for sign-out, owner identifier and restaurant identifier. Then the intermediary agent would insert a row into restaurant location table using owner identifier for OWNER_ID, restaurant identifier for RESTAURANT_ID, address for ADDRESS, latitude for LATITUDE, longitude for LONGITUDE, sign-in for QR_CODE_SIGN_IN and sign-out for QR_CODE_SIGN_OUT.

Restaurant owners can edit location information using the location registration web form provided by intermediary agent using ‘E’ for action. Intermediary agent would capture values for owner identifier, restaurant identifier, address, latitude, and longitude as shown in FIG. 18. If the values are valid then the intermediary agent would update a row in restaurant location table using owner identifier for OWNER_ID, restaurant identifier for RESTAURANT_ID, address for ADDRESS, latitude for LATITUDE, longitude for LONGITUDE. The values for QR_CODE_SIGN_IN and QR_CODE_SIGN_OUT will not change, because the values for owner identifier and restaurant identifier did not change.

Restaurant owners can add or edit area and table information using table registration web form provided by intermediary agent. When restaurant clients add or edit an area or a table within an area the intermediary agent will capture the values for area identifier, table identifier, seating capacity and status as shown in FIG. 18B and save in restaurant seating table. The valid values for status would be ‘A’ to indicate that the table is available or ‘I’ to indicate that the table is inactive. Then the request handler process would insert a new row in the restaurant seating table in restaurant database. The request handler would retrieve the last SEATING_SEQ from the restaurant seating table using owner identifier for OWNER_ID, restaurant identifier for RESTAURANT_ID, area identifier for AREA ID and table identifier for TABLE ID. If the request handler process can retrieve a row then the request handler process would set new seating sequence by incrementing the value of SEATING_SEQ by 1, otherwise the request handler process would set new seating sequence as 1. Then the request handler process would insert a new row into restaurant seating table using owner identifier for OWNER_ID, restaurant identifier for RESTAURANT_ID, area identifier for AREA_ID, table identifier for TABLE_ID, new seating sequence for SEATING_SEQ, seating capacity for SEATING_CAPACITY, blank for EMPLOYEE_ID and status for TABLE_STATUS.

Each restaurant location can be divided into several areas (for example such as main dining area, patio, bar and the like). Customer clients and unknown customers, at the time of signing in or at the time of making a reservation, can select a preferred area. Each area can hold an unlimited number of tables.

Restaurant owners can add or edit employee information using employee registration web form provided by intermediary agent. To add an employee, restaurant owners would use ‘A’ for action and to edit an employee, restaurant owners would use ‘E’ for action. When restaurant clients add employees, each employee will be assigned with a unique employee identifier by the intermediary agent and values for name, title, description and contact cell will be captured as shown in FIG. 18A and saved in restaurant employee table. If the captured values are valid, then the intermediary agent would insert one row into restaurant employee table using owner identifier for OWNER_ID, restaurant identifier for RESTAURANT_ID, employee identifier for EMPLOYEE_ID, name for EMPLOYEE_NAME, title for EMPLOYEE_JOB_TITLE, description for EMPLOYEE_JOB_DESCRIPTION, contact cell for CONTACT_CELL and ‘N’ for LOGGED_YN. When restaurant clients edit employee information values for employee identifier, for name, title, description and contact cell will be captured by the intermediary agent as shown in FIG. 18A and saved in restaurant employee table. If the captured values are valid, then the intermediary agent would set name for EMPLOYEE_NAME, title for EMPLOYEE_JOB_TITLE, description for EMPLOYEE_JOB_DESCRIPTION, contact cell for CONTACT_CELL and ‘N’ for LOGGED_YN in restaurant employee table using owner identifier for OWNER_ID, restaurant identifier for RESTAURANT_ID, employee identifier for EMPLOYEE_ID.

Restaurant owners can add or edit employee communication channel information using employee communication web form provided by intermediary agent. When restaurant clients add or edit employee communication channel information employee identifier, text channel identifier will be captured from the restaurant owner as shown in FIG. 18C and saved in restaurant employee communication table. The intermediary agent would validate the captured information and insert or update a row in the restaurant employee communication table. The intermediary agent will start by saving ‘Y’ to channel validation. Then the intermediary agent would retrieve one row from restaurant communication table using owner identifier for OWNER_ID and restaurant identifier for RESTAURANT_ID. If the intermediary agent can retrieve one row, then the intermediary agent would save MAX_EMPLOYEE_TEXT_CHANNELS as maximum text channels. If the captured text channel identifier is equal or greater than 0 and equal or less than maximum text channels, then the intermediary agent will continue the validation process, otherwise it will save ‘N’ to channel validation and terminate the validation process. If the text channel identifier is greater than 0, then the intermediary agent will retrieve a row from restaurant employee communication table using owner identifier for OWNER_ID, restaurant identifier for RESTAURANT_ID, captured employee identifier is not equal to EMPLOYEE_ID and captured text channel identifier is equal to EMPLOYEE_TEXT_CHANNEL_ID. If the intermediary agent can retrieve at least one row from the restaurant employee communication table, then the intermediary agent will save ‘N’ to channel validation and terminate the validation process. This will confirm that each unique text channel will be assigned to only one employee. If channel validation is ‘Y’, then the intermediary agent will retrieve a row from restaurant employee communication table using owner identifier for OWNER_ID, restaurant identifier for RESTAURANT_ID and captured employee identifier for EMPLOYEE_ID. If the intermediary agent can retrieve one row from the restaurant employee communication table, then the intermediary agent will update the retrieved row by setting the captured text channel identifier for EMPLOYEE_TEXT_CHANNEL_ID using owner identifier for OWNER_ID, restaurant identifier for RESTAURANT_ID and captured employee identifier for EMPLOYEE_ID, otherwise the intermediary agent will insert a row using owner identifier for OWNER_ID, restaurant identifier for RESTAURANT_ID, captured employee identifier for EMPLOYEE_ID, captured text channel identifier for EMPLOYEE_TEXT_CHANNEL_ID.

Restaurant clients can add or edit menu items (price list) using a menu registration web form provided by the intermediary agent as shown in FIG. 19 and the information will be saved in the restaurant menu table. This would enable current customers to view and/or place orders directly to restaurant clients ordering system using user interface or verbally with employee clients working as waiters or with employee clients working as waiters using the communication channel provided by the intermediary agent. When restaurant clients add or edit a menu item, the values for item identifier, start date, start time, group description, item description, item price and item image will be captured by the intermediary agent as shown in FIG. 19 and saved in restaurant menu table. Item image may be uploaded from restaurant client devices and saved in the intermediary agent. Item image may be the location of the image in the intermediary agent. If the captured values are valid, then the intermediary agent would retrieve one row from restaurant menu table using owner identifier for OWNER_ID, restaurant identifier for RESTAURANT_ID, item identifier for ITEM_ID, start date for DATE and start time for TIME. If the captured values are valid, then the intermediary agent would retrieve one row from restaurant menu table using owner identifier for OWNER_ID, restaurant identifier for RESTAURANT_ID, item identifier for ITEM_ID, start date for DATE and start time for TIME. If the intermediary agent retrieved one row, then the intermediary agent would update the retrieved row in restaurant menu table by setting group description for GROUP_DESCRIPTION, item description for ITEM_DESCRIPTION, item price for ITEM_PRICE and item image for ITEM_IMAGE. If the intermediary agent did not retrieve a row, then the intermediary agent would insert a new row into the restaurant menu table. Before inserting a new row into the restaurant menu table, the intermediary agent would format the value for QR Code item using a pre-defined application identifier which may be for example ‘327’, a pre-defined delimiter, owner identifier, restaurant identifier and item identifier. Then the intermediary agent would insert a row in the restaurant menu table using owner identifier for OWNER_ID, restaurant identifier for RESTAURANT_ID, item identifier for ITEM_ID, start date for DATE, start time for TIME, QR Code item for QR_CODE_ITEM, group description for GROUP_DESCRIPTION, item description for ITEM_DESCRIPTION, item price for ITEM_PRICE and item image for ITEM_IMAGE.

Restaurant clients can download QR Code using a download web form provided by intermediary agent. To download sign-in and sign-out QR Codes the intermediary agent would use ‘S’ for action and to download a menu the intermediary agent would use ‘M’ for action. Restaurant clients can download QR_CODE_SIGN_IN and QR_CODE_SIGN_OUT as shown in flowchart in FIG. 21A. Restaurant clients would provide OWNER_ID and RESTAURANT_ID to intermediary agent to download QR_CODE_SIGN_IN and QR_CODE_SIGN_OUT. If QR_CODE_SIGN_IN and QR_CODE_SIGN_OUT do not exist in restaurant location table, the intermediary agent would create values for QR_CODE_SIGN_IN and for QR_CODE_SIGN_OUT and save them in restaurant location table. Restaurant clients would display QR_CODE_SIGN_IN and optionally QR_CODE_SIGN_OUT at one or more spots in restaurant location as shown in flowchart in FIG. 21B.

When an individual scans a QR Code displayed at any restaurant using an app provided by the intermediary agent or an app interfaced with intermediary agent or any generic QR Code Reader app or a camera, the content of the QR Code will be passed on to QR Code web page hosted by intermediary agent, upon verification of the QR Code by the QR Code web page, the information will be passed on to the request handler process in the intermediary agent to initiate a request handler process as described in ‘DETAILED DESCRIPTION OF THE PREFERRED EMBODIMENTS’ section and the request handler process will continue here. When a QR Code is scanned by an individual, the request handler process would have saved the request message embedded in the QR Code as request message and the information of the individual scanned the QR Code as customer identifier, customer type, customer name, customer business name, customer employee title, customer latitude and customer longitude. The customer identifier and customer type known to request handler process will also be referred to as current customer identifier and current customer type.

If the current customer type is ‘C’ or ‘M’, then the current customer will be referred to as a customer client, otherwise the current customer will be referred to as an unknown customer.

If the customer type is ‘C’, then the individual scanned the QR Code is a customer client and does not represent any business. If the customer type is ‘M’, then the individual scanned the QR Code is a customer client and represents a business. If the customer type is ‘U’, then the individual scanned the QR Code is an unknown customer.

All customers currently present at the restaurant location who are not current customer will be referred to as fellow customers.

Then the request handler process would segregate the request message, based on a pre-defined procedure into at least three segments namely application identifier, owner identifier, and restaurant identifier respectively. If the request handler process cannot break the request message into at least three segments the request handler process will be terminated. If the application identifier is not for processing QR Codes for restaurant sign-in or restaurant sign-out or single-item to buy, then the request handler process will be terminated. Application identifier ‘77’ may be for restaurant sign-in, ‘327’ may be to select a single item to buy and ‘87’ may be for restaurant sign-out. If the application identifier is ‘327’, then the request message will have additional segment item identifier. If the application identifier is ‘327’ and if additional segment item identifier does not present in the request message, then the request handler process will be terminated.

Then the request handler process would retrieve LATITUDE as restaurant latitude and LONGITUDE as restaurant longitude from restaurant location table in restaurant database (58-16) using owner identifier for OWNER_ID and restaurant identifier for RESTAURANT_ID. If the request handler process can retrieve restaurant latitude and restaurant longitude information, then the request handler process will continue otherwise it will be terminated.

In the case of a customer client the request handler process would also have received the location information of customer client (current latitude and longitude) of the mobile device used by the customer client. Then the request handler process would determine whether the customer client's location is within a certain limit from the restaurant location based on customer client's mobile device latitude and longitude and restaurant latitude and longitude. If the distance between customer client's location and restaurant location is within a certain limit, then the request handler process will continue, otherwise it will be terminated.

In the case of an unknown customer the request handler process would also have received the location information of the internet service provider (ISP latitude and longitude) providing internet service for the unknown customer. Then the request handler process would determine whether the unknown customer's ISP location is within a certain limit from the restaurant location based on ISP latitude and longitude and restaurant latitude and longitude. If the distance between ISP location and restaurant location is within a certain limit, then the request handler process will continue, otherwise it will be terminated.

If the application identifier 77 which is for signing-in then the request handler process will execute SIGN-IN process or if the application identifier is 327 which is for selecting a single item to purchase then the request handler process will execute the SINGLE-ITEM-SELECTION process or if the application identifier is 87 which is for signing-out then the request handler process will execute the SIGN-OUT process, otherwise the request handler process will be terminated. SIGN-IN, SINGLE-ITEM-SELECTION and SIGN-OUT processes are further described in greater detail herein.

SIGN-IN: The request handler process need to confirm that an active log does not exist currently in restaurant log table in merchant database. The request handler process would retrieve LOG_SEQ from restaurant log table using owner identifier for OWNER_ID, restaurant identifier for RESTAURANT_ID, ‘A’ for LOG_STATUS, current customer type for CUSTOMER_TYPE, current customer identifier for CUSTOMER_ID. If the request handler process can retrieve one or more rows, then the process will be terminated. This will prevent a signed-in customer signing-in again before signing-out.

Then the request handler process would start a new log in restaurant log table in restaurant database. The request handler would retrieve the last log sequence from the restaurant log table using owner identifier for OWNER_ID and restaurant identifier for RESTAURANT_ID. If the request handler process retrieves the last log sequence then the request handler process would set new log sequence by incrementing the last log sequence by 1, otherwise the request handler process would set new log sequence as 1. Then the request handler process would insert a new row in restaurant log table using owner identifier for OWNER_ID, restaurant identifier for RESTAURANT_ID, new log sequence for LOG_SEQ, blank value for AREA_ID, blank value for TABLE_ID, current server date for BEGIN_DATE, current server time for BEGIN_TIME, current server date for END_DATE, current server time for END_TIME, current customer type for CUSTOMER_TYPE, current customer identifier for CUSTOMER_ID and blank value for DESCRIPTION. When the request handler process terminates, the request handler process would update END_DATE, END_TIME and DESCRIPTION by using current server date for END_DATE, current server time for END_TIME and appending the reason for termination to DESCRIPTION in restaurant log table where OWNER_ID is equal to owner identifier, RESTAURANT_ID is equal to restaurant identifier, and LOG_SEQ is equal to new log sequence.

Then the request handler process would use the administration component under application server to capture party size, calculate an authorization amount based on the party size, get an approval from a payment processor, insert party size into restaurant waitlist table and insert the authorized amount into restaurant order table in restaurant database (58-16).

If the request handler process can capture party size information from customer client or unknown customer, the request handler process will continue, otherwise it will be terminated. The request handler process would request the administration component to calculate an authorize amount based on the party size and based on the setup set by the restaurant client and to receive an authorization for the calculated authorize amount from a payment processor. For example, if the restaurant client set up $15.00 for each one in the party size and if the party size is 4, then the calculated authorize amount would be $60.00. If capturing party size and getting an authorization from a payment processor for a calculated authorize amount is successful, then the request handler process will continue otherwise it will be terminated.

If the request handler process can calculate the authorize amount and able to get an authorization code from a payment processor, the request handler process will continue, otherwise it will be terminated.

The request handler process would insert a wait sequence in the restaurant waitlist table in restaurant database. The request handler process would retrieve the last wait sequence from restaurant waitlist table using owner identifier for OWNER_ID and restaurant identifier for RESTAURANT_ID. If the request handler process can retrieve last wait sequence, then the request handler process would set new wait sequence by incrementing the last wait sequence by 1, otherwise the request handler process would set new wait sequence as 1. Then the request handler process would insert a new row in restaurant waitlist table using owner identifier for OWNER_ID, restaurant identifier for RESTAURANT_ID, new wait sequence for WAIT_SEQ, 1 for WAIT_STATUS_SEQ, ‘W’ for WAIT_STATUS, current customer type for CUSTOMER_TYPE, current customer identifier for CUSTOMER_ID, captured party size for PARTY_SIZE, blank value for AREA_ID, blank value for TABLE_ID, blank value for TEXT_CHANNEL_ID, current server date for STATUS_DATE and current server time for STATUS_TIME. If the request handler process can insert a new row in the restaurant waitlist table the request handler process will continue, otherwise it will be terminated.

Then the request handler process would insert a payment sequence in the restaurant order table in restaurant database (58-16). The request handler process would retrieve the last payment sequence from the restaurant order table using owner identifier for OWNER_ID and restaurant identifier for RESTAURANT_ID. If the request handler process can retrieve the last payment sequence then the request handler process would set new payment sequence by incrementing the last payment sequence by 1, otherwise the request handler process would set new payment sequence as 1. Then the request handler process would insert a new row in restaurant order table using owner identifier for OWNER_ID, restaurant identifier for RESTAURANT_ID, new payment sequence for PAYMENT_SEQ, ‘A’ for PAYMENT STATUS to indicate that the payment status is active, current customer type for CUSTOMER_TYPE, current customer identifier for CUSTOMER_ID, authorized amount for AUTH AMOUNT and 0 for PAID AMOUNT.

If current customer type is an unknown customer, then the request handler process will save the values of customer type, customer identifier, customer name and customer business name and customer employee title as CURRENT_CUSTOMER_TYPE cookie, CURRENT_CUSTOMER_ID cookie and CURRENT_CUSTOMER_NAME cookie CURRENT_CUSTOMER_BUSINESS_NAME cookie, and CURRENT_CUSTOMER_EMPLOYEE_TITLE cookie respectively in the current browser and request handler process will continue, otherwise the request handler process will delete the cookies CURRENT_CUSTOMER_TYPE cookie, CURRENT_CUSTOMER_ID cookie, CURRENT_CUSTOMER_NAME cookie, CURRENT_CUSTOMER_BUSINESS_NAME cookie, and CURRENT_CUSTOMER_EMPLOYEE_TITLE cookie and the request handler process will be terminated.

Upon adding a new row in restaurant waitlist table and upon adding a new row in restaurant order table for a current customer client or unknown customer, the request handler process would load a web page referred to as mobile menu page hosted by intermediary agent into the in-app browser of customer client's mobile device or into the web browser of the unknown customer's mobile device and the request handler process will end.

Then current customer can continue and communicate with the restaurant owner, employee clients and fellow customers as described in Mobile Menu Page. The fellow customers can also simultaneously continue and transact with employee clients as described in Mobile Menu Page.

### Mobile Menu Page:

If a web browser is used in a mobile device, the web browser will have the values for current customer type and current customer identifier. If an in-app browser is used in a mobile app in a mobile device, the in-app browser will have the values for current customer type and current customer identifier.

When a mobile menu page is loaded, the mobile menu page will always have the values for current customer type and current customer identifier.

The mobile menu page hosted by the administrative component will have several options for the current customers to execute until the current customers decide to sign-out. At a minimum the menu will have options ‘Add Text Communication’, ‘Employee Communication’, ‘Internal Video Communication’, ‘External Video Communication’, ‘Fellow Customers Communication’, ‘Wi-Fi Access’, ‘View Waitlist’ and ‘Place a Self-Order’.

When the current customer selects the option ‘Add Text Communication’, the administrative component will process the request and upon verification, would make a text communication channel available for the current customer. If the intermediary agent is set up for to provide a text communication gateway, if the current customer has not been already assigned with a text communication channel number and if a text communication channel is available, then the administrative component would update the value for TEXT_CHANNEL_ID in the restaurant waitlist table with a text communication channel number and insert a new row in restaurant communication log table so that the communication can be logged.

To confirm that the intermediary agent is set up for to provide a text communication gateway, the administrative component would retrieve a row from restaurant communication table using owner identifier for OWNER_ID and restaurant identifier for RESTAURANT_ID. If the administrative component can retrieve a row, then the administrative component would save MAX_CUSTOMER_TEXT_CHANNELS from the retrieved row as maximum customer text channels, otherwise the administrative component would save 0 as maximum customer text channels. If maximum customer text channels is greater than 0, then the intermediary agent is set up to provide a text communication gateway, otherwise the intermediary agent is not set up to provide a text communication gateway.

To verify that the current customer has not been assigned with a text communication channel number, the administrative component would retrieve the latest single row of the current customer from restaurant waitlist table using owner identifier for OWNER_ID, restaurant identifier for RESTAURANT_ID, WAIT_SEQ is greater than 0, WAIT_STATUS_SEQ is equal to (maximum of (WAIT_STATUS_SEQ) for the same OWNER_ID, RESTAURANT_ID and WAIT_SEQ), WAIT_STATUS is equal to ‘W’ or ‘S’, current customer type for CUSTOMER_TYPE and current customer identifier for CUSTOMER_ID. The values in the retrieved row will be the latest information for the current customer. If the administrative component can retrieve one row from restaurant waitlist table and if the value of TEXT_CHANNEL_ID in the retrieved row is blank, then the administrative component would save the values of WAIT_SEQ and WAIT_STATUS_SEQ as the current wait sequence and current wait status sequence respectively, otherwise the administrative component will display an error indicating the request is invalid and terminate.

Then the administrative component would determine an unused text channel. The administrative component would save 0 as available text channel and start a loop using 1 as staring value, using maximum customer text channels as an ending value and incrementing by 1.

For each instance in the loop the administrative component would retrieve the latest row of all fellow customers and find whether the current instance in the loop is used as TEXT_CHANNEL_ID.

The administrative component would retrieve the rows from restaurant waitlist table using owner identifier for OWNER_ID, restaurant identifier for RESTAURANT_ID, WAIT_SEQ is greater than 0, WAIT_STATUS_SEQ is equal to (maximum of (WAIT_STATUS_SEQ) for the same OWNER_ID, RESTAURANT_ID and WAIT_SEQ), WAIT_STATUS is equal to ‘W’ or ‘S’, CUSTOMER_ID is not equal to current customer identifier and the current instance in the loop for TEXT_CHANNEL_ID. If administrative component can retrieve one or more rows, then the administrative component would move to the next instance in the loop, otherwise administrative component would save the current instance number in the loop as available text channel and exit the loop. This will ensure that the same text channel will not be used for more than one current customer. After looping through the loop to the end, if available text channel is 0, the administrative component will refresh the mobile menu page and display an error message indicating that a text communication cannot be added currently with a request to try again later and will terminate.

Once the current wait sequence, current wait status sequence and available text channel are determined and available text channel is not 0, the administrative component will update one row in the restaurant waitlist table using owner identifier for OWNER_ID, restaurant identifier for RESTAURANT_ID, current wait sequence for WAIT_SEQ, current wait status sequence for WAIT_STATUS_SEQ and by setting the value of available text channel for TEXT_CHANNEL_ID.

Once the current wait sequence, current wait status sequence and available text channel are determined and available text channel is updated in restaurant waitlist table, the administrative component would start a new communication log in restaurant communication log table in restaurant database. The request handler would retrieve the last communication sequence from the restaurant communication log table using owner identifier for OWNER_ID and restaurant identifier for RESTAURANT_ID. If the request handler process retrieves the last communication log sequence then the request handler process would set new communication log sequence by incrementing the last communication log sequence by 1, otherwise the request handler process would set new communication log sequence as 1. Then the request handler process would insert a new row in restaurant communication log table using owner identifier for OWNER_ID, restaurant identifier for RESTAURANT_ID, new communication log sequence for COMMUNICATION_SEQ, ‘A’ for communication status, current server date for BEGIN_DATE, current server time for BEGIN_TIME, current server date for END_DATE, current server time for END_TIME, current customer type for CUSTOMER_TYPE, current customer type for ORIGINATOR_TYPE, current customer identifier for ORIGINATOR_ID, blank value for PARTICIPANT_TYPE, blank value for PARTICIPANT_ID and blank value for COMMUNICATION.

When the current customer signs out, the sign-out process would update END_DATE, END_TIME and COMMUNICATION by using server date at the time of sign-out for END_DATE, server time at the time of sign-out for END_TIME and appending the text ‘End of Communication’ to COMMUNICATION in restaurant communication log table where OWNER_ID is equal to owner identifier, RESTAURANT_ID is equal to restaurant identifier, and COMMINICATION_SEQ is equal to new communication log sequence.

Upon adding a text communication channel, the current customers can communicate using texts with employees and with fellow customers using text communication component (58-9).

Then the administrative component will refresh the mobile menu page and display a successful message indicating that a text channel has been added.

When the current customer selects the option ‘Employee Communication’, the administrative component will verify that current customer type and current customer identifier have been set up as ORIGINATOR_TYPE and ORIGINATOR_ID respectively and the COMMUNICATION_STATUS is ‘A’ in the most recent row for the current customer in restaurant communication log table. If the verification fails, the administrative component will refresh the mobile menu page and display an error message indicating that an employee communication cannot be set up before adding a text communication and will terminate.

To verify that the current customer has been set up for text communication, the administrative component would retrieve the latest single row of the current customer from restaurant communication log table using owner identifier for OWNER_ID, restaurant identifier for RESTAURANT_ID, COMMUNICATION_SEQ is greater than 0, COMMINICATION_STATUS is equal to ‘A’, current customer type for ORIGINATOR TYPE and current customer identifier for ORIGINATOR_ID ORDER BY COMMUNICATION_SEQ DESC. ‘ORDER BY’ clause is used to expediate the retrieval of rows from restaurant communication log table.

The values in the retrieved row will be the latest information for the current customer. If the administrative component can retrieve one row from restaurant communication log table, then the administrative component would save the value of COMMUNICATION_SEQ as the current communication sequence, otherwise the administrative component will refresh the mobile menu page and display an error message indicating that an employee communication cannot be set up before adding a text communication and will terminate.

By communicating with employees, customers can request services, place orders, get answers and much more. For example, customers can request for any service, place drink orders with bar tenders, place orders with waiters, get help from wine connoisseurs, get help from chefs, request for internal web meeting, request for external web meeting and much more.

Each employee will be assigned a unique text channel. Employees can communicate simultaneously with an unlimited number of current clients using a single communication channel for text, the administrative component will let the current customer select an employee and a text communication. The text communication component will route the text messages between a selected current customer and a selected employee.

Then the administrative component will retrieve all the rows from the restaurant employee table by joining with restaurant employee communication table using owner identifier for OWNER_ID, restaurant identifier for RESTAURANT_ID, EMPLOYEE_ID is not blank, LOGGED_YN is ‘Y’ from restaurant employee table and joining OWNER_ID, RESTAURANT_ID and EMPLOYEE_ID from restaurant employee table with OWNER_ID, RESTAURANT_ID and EMPLOYEE_ID from restaurant employee communication table respectively and EMPLOYEE TEXT_CHANNEL_ID in restaurant employee communication table is not blank. If the administrative component cannot retrieve even one row from the query that joined restaurant employee table with restaurant employee communication table, then the administrative component will refresh the mobile menu page and display an error message indicating that an employee communication cannot be set up because no employee is available for communication and can try later and will terminate.

If the administrative component can retrieve one or more rows from the query that joined restaurant employee table with restaurant employee communication table, then the administrative component will refresh the mobile menu page and display the EMPLOYEE_NAME, EMPLOYEE_JOB_TITLE, EMPLOYEE_JOB_DESCRIPION and hide EMPLOYEE_ID in each retrieved row from restaurant employee table.

When the content of all the rows are displayed as shown in FIG. 21C the current customer can select a row to communicate with an employee. The current customer can scroll up or down to view the employees' name, title, and description.

When the current customer selects a row from the display, then the administrative component would update the restaurant communication log table by setting the values of ‘E’ and the EMPLOYEE_ID of the selected employee for PARTICIPANT_TYPE and PARTICIPANT_ID respectively in the latest row of the current customer in the restaurant communication log table. Then any text message sent by the current customer will be directed to the PARTICIPANT_TYPE and PARTICIPANT_ID stored in the latest row of the current customer in the restaurant communication log table and the text will be concatenated with the COMMUNICATION field in the latest row of the current customer in the restaurant communication log table.

The administrative component would update the values ‘E’ and the EMPLOYEE_ID of the selected employee for PARTICIPANT_TYPE and PARTICIPANT_ID respectively and append a text suggesting that ‘text message communication has been set up to communicate with employee’ and add the name of the EMPLOYEE_NAME of the selected employee to COMMUNICATION in restaurant communication log table using owner identifier for OWNER_ID, restaurant identifier for RESTAURANT_ID and current communication sequence for COMMUNICATION_SEQ.

To communicate with a different employee, then the current customer would select the option ‘Employee Communication’ from the menu again. To communicate with fellow customers, then the current customer would select the option ‘Fellow Customers Communication’ from the menu.

When the current customer selects the option ‘Fellow Customers Communication’, the administrative component will verify that current customer type and current customer identifier have been set up as ORIGINATOR_TYPE and ORIGINATOR_ID respectively and the COMMUNICATION_STATUS is ‘A’ in the most recent row for the current customer in restaurant communication log table. If the verification fails, the administrative component will refresh the mobile menu page and display an error message indicating that a fellow customers communication cannot be set up before adding a text communication and will terminate.

To verify that the current customer has been set up for text communication, the administrative component would retrieve the latest single row of the current customer from restaurant communication log table using owner identifier for OWNER_ID, restaurant identifier for RESTAURANT_ID, COMMUNICATION_SEQ is greater than 0, COMMINICATION_STATUS is equal to ‘A’, current customer type for ORIGINATOR TYPE and current customer identifier for ORIGINATOR_ID ORDER BY COMMUNICATION_SEQ DESC. ‘ORDER BY’ clause is used to expediate the retrieval of rows from restaurant communication log table.

The values in the retrieved row will be the latest information for the current customer. If the administrative component can retrieve one row from restaurant communication log table, then the administrative component would save the value of COMMUNICATION_SEQ as the current communication sequence, otherwise the administrative component will refresh the mobile menu page and display an error message indicating that a fellow customers communication cannot be set up before adding a text communication and will terminate.

By communicating with fellow customers, current customers can get help, recommendations and much more without providing personal information. For example, customers get help in selecting wines, menu items, knowing about services and employees and much more.

Each customer can get a unique text channel. The text message will be sent only to the customers having a unique text channel. The text communication component will route the text messages from current customer to fellow customers.

Then the administrative component would update the restaurant communication log table by setting the values of ‘C’ and a blank for PARTICIPANT_TYPE and PARTICIPANT_ID respectively in the latest row of the current customer in the restaurant communication log table. Then any text message sent by the current customer will be directed to the PARTICIPANT TYPE and PARTICIPANT_ID stored in the latest row of the current customer in the restaurant communication log table and the text will be concatenated with the COMMUNICATION field in the latest row of the current customer in the restaurant communication log table. When the values of PARTICIPANT_TYPE and PARTICIPANT_ID are ‘C’ and blank respectively, the text message will be sent to all the fellow customers.

The administrative component would update the values ‘C’ and a blank value for PARTICIPANT_TYPE and PARTICIPANT_ID respectively and append a text suggesting that ‘text message communication has been set up to communicate with fellow customers’ to COMMUNICATION in restaurant communication log table using owner identifier for OWNER_ID, restaurant identifier for RESTAURANT_ID and current communication sequence for COMMUNICATION_SEQ.

To communicate with an employee, then the current customer would select the option ‘Employee Communication’ from the menu.

During a text message exchange between a current customer and an employee, the current customer can request for a web meeting so that conversations can be exchanged between the current customer and the selected employee through a web meeting. In response to a request from a current customer, an employee can setup for an internal video meeting or for an external video meeting.

The internal video meeting will be hosted by virtual meeting component (58-10) whereas the external video meeting will be hosted by external web meeting service providers such as Zoom, Google Meet, Microsoft Teams and the link.

For an internal video meeting, the employee would use a virtual terminal to submit a request to virtual meeting component (58-10) to set up an internal video meeting by providing ‘E’ and merchant identifier as organizer type and organizer identifier. Upon receiving the organizer type, organizer identifier and a request to set up an internal video meeting, the virtual meeting component (58-10) would verify the organizer type and organizer identifier. If the organizer type is ‘E’, then virtual meeting component (58-10) would verify the organizer identifier in restaurant employee type using owner identifier for OWNER_ID, restaurant identifier for RESTAURANT_ID and organizer identifier for EMPLOYEE_ID. If virtual meeting component (58-10) can retrieve one row, then virtual meeting component (58-10) would respond with a unique internal video meeting identifier, otherwise virtual meeting component (58-10) would reject the request. Upon receiving a meeting identifier, the merchant would start the internal video meeting in a virtual terminal using the meeting identifier. Once the internal video meeting is started, the employee can send the internal video meeting identifier through a text message communication that is already in progress. Upon receiving a meeting identifier, the current customer would use the meeting identifier to join an internal web meeting.

For an external video meeting, the employee would request an external web meeting service provider to set up a video meeting and receive an URL and a meeting identifier. Upon receiving an URL and a meeting identifier, the merchant would start the external video meeting in a virtual terminal using the URL and the meeting identifier. Once the external video meeting is started, the employee can send the external video meeting URL and identifier through a text message communication that is already in progress. Upon receiving a meeting identifier, the current customer would use the URL and the meeting identifier to join an internal web meeting.

For an internal video meeting, the current customer would receive a meeting identifier whereas for external video meeting the current customer would receive an URL and a meeting identifier from the employee as part of a text message exchange. It is also possible for an employee to set up a video meeting without a request from the current customer and send video meeting information to the current customer as part of text message exchange started by the current customer.

At any event, when the current customer receives information about a video meeting, the customer can select the option ‘Internal Video Communication’ or ‘External Video Communication’ depending on the video meeting information.

When the current customer selects the option ‘Internal Video Communication’, the current customer would provide the meeting identifier as shown in FIG. 21D, to join an internal meeting hosted by virtual meeting component (58-10) and already started by the employee. When the administrative component receive a request for ‘Internal Video Communication’, the administrative component will also receive the meeting identifier. Then the administrative component would forward the current customer type, current customer identifier and meeting identifier received from the current customer as participant type, participant identifier and meeting identifier respectively to virtual meeting component (58-10). When the virtual meeting component (58-10) receives participant type, participant identifier and meeting identifier, the virtual meeting component (58-10) would verify the participant type and participant identifier. Upon verification of the participant type and participant identifier, virtual meeting component (58-10) would verify the meeting identifier. Upon verification of the meeting identifier, the virtual meeting component (58-10) would load the internal web meeting page tied to the meeting identifier in the current browser of the participant.

To verify the participant type and participant identifier the virtual meeting component (58-10) would retrieve the latest single row matching participant type and participant identifier from restaurant waitlist table using owner identifier for OWNER_ID, restaurant identifier for RESTAURANT_ID, WAIT_SEQ is greater than 0, WAIT_STATUS_SEQ is equal to (maximum of (WAIT_STATUS_SEQ) for the same OWNER_ID, RESTAURANT_ID and WAIT_SEQ), WAIT_STATUS is equal to ‘W’ or ‘S’, participant type for CUSTOMER_TYPE and participant identifier for CUSTOMER_ID. The values in the retrieved row will be the latest information for the participant. If the virtual meeting component (58-10) cannot retrieve one row from restaurant waitlist table, then the virtual meeting component (58-10) would reject the request and the administrative component refresh the menu page and will display an error indicating the request is invalid and terminate.

Upon verification of the participant type and participant identifier, virtual meeting component (58-10) would verify the meeting identifier and verify that the internal web meeting has been started and active. Upon verification of the meeting identifier, the virtual meeting component (58-10) would load the internal web meeting page tied to the meeting identifier in the current browser of the participant. When the current customer leaves the internal web meeting, the menu page will be refreshed. When there are no participants in an internal web meeting, the organizer of the internal web meeting will end the internal web meeting.

When the current customer selects the option ‘External Video Communication’, the current customer would provide the URL received from the employee as shown in FIG. 21D to join an external meeting hosted by an external service provider.

When the administrative component receive a request for ‘External Video Communication’, the administrative component will also receive an URL. Then the administrative component would verify the current customer and will load an external video communication page in the current employee's browser using the received URL. When the external video communication page is loaded the current customer would enter the meeting identifier received from the employee and if the meeting identifier is valid then the external video communication service provider will verify the meeting identifier and let the current customer to join the external video communication page.

To verify the current customer the administrative component would retrieve the latest single row matching current customer from restaurant waitlist table using owner identifier for OWNER_ID, restaurant identifier for RESTAURANT_ID, WAIT_SEQ is greater than 0, WAIT_STATUS_SEQ is equal to (maximum of (WAIT_STATUS_SEQ) for the same OWNER_ID, RESTAURANT_ID and WAIT_SEQ), WAIT_STATUS is equal to ‘W’ or ‘S’, current customer type for CUSTOMER_TYPE and current customer identifier for CUSTOMER_ID. The values in the retrieved row will be the latest information for the current customer. If the administrative component can retrieve one row from restaurant waitlist table, then the administrative component would load a page using the URL received with the request so that the current customer can join the external video communication page by entering the URL received from the employee, otherwise administrative component will refresh the menu page and will display an error indicating the request is invalid and terminate. When the current customer exits the loaded page, the menu page will be refreshed and wait for current customer input.

Those of ordinary skill in the art will readily recognize that internal video communication and external video communication not only can be used for one to one communication with an employee and a current customer, but it can also be used for one to many communication with an employee any and a group of customers.

Prior to getting seated, current customers can view their waiting status on a waitlist screen as shown in FIG. 21E. Current customers can also view their waiting status on their mobile device as shown in FIG. 21F (Mobile Device—View Waitlist) by selecting the option ‘View Waitlist’ from the menu page. If the current customer has been assigned a table, then the current customer can also view the seating guide as shown in FIG. 21F (Mobile Device—Seating Guide) to follow the directions by selecting the option ‘View Waitlist’ from the menu page. All the customers can also view the seating map displayed on a digital screen as shown in FIG. 21F (Digital Screen—Seating Map). If the current customer has been assigned a table, then the current customer can also press the start button on the ‘Host Robot’ as shown in FIG. 21F (Host Robot) to follow the robot to get seated. Once the current customer is seated, then the current customer wait status will be removed from the waitlist screen as shown in FIG. 21E.

In addition to placing orders with employees in person or through text messages, current customers can also select the option ‘Place a Self-Order’ from the menu page.

When the current customer selects the option ‘Place a Self-Order’, the administrative component will process the request and upon verification, would display an order processing page on the current customer's device.

If the merchant is set up a menu with at least one time, then the administrative component would display the order processing page with the menu and accept orders, otherwise administrative component would refresh the menu page with an error message indicating that a menu is not available.

Then the administrative component would display the order processing page with the menu as shown in 21G and accept orders. The current customer would simply select any number of groups and any number of items in the selected group to place an order. Those of ordinary skill in the art will readily recognize that customers can also scan QR Codes assigned to individual items in a printed or displayed menu to place an order.

Upon receipt of orders, customer type and customer identifier, the order processing page would add the order into the restaurant order detail table. In the process of adding the order into restaurant order detail table, if the order processing page is unbale to do so for any ordered item in the order the administration component would refresh the order processing page and display an error message indicating the reason for not being able to place the order. First, the order processing page would determine the item identifier for each ordered item from the current order information. If the intermediary agent is unable to determine the item identifier for any ordered item, then the administration component would refresh the order processing page and display an error message indicating the reason for not being able to place the order. Then, the administration component would retrieve item price, for each item, from restaurant menu table and calculate current order amount which would be the total of item price of all individual items in the current order plus any applicable service charges and taxes. The administration component would retrieve the ITEM PRICE, which is most recent based on current date and time, as item price for each item in the current order from restaurant menu table where OWNER_ID is equal to owner identifier, RESTAURANT_ID is equal to restaurant identifier and ITEM_ID is equal to item identifier. The administration component may also retrieve ITEM_IMAGE. If the administration component is unable to retrieve the item price for any item, the administration component would refresh the order processing page and display an error message indicating the reason for not being able to place the order. Then the administration component would retrieve the payment sequence and authorized amount from restaurant order table. The administration component would get the PAYMENT_SEQ as payment sequence, AUTH_AMOUNT as authorized amount from restaurant order table where OWNER_ID is equal to owner identifier, RESTAURANT_ID is equal to restaurant identifier, CUSTOMER_TYPE is equal to current customer type and CUSTOMER_ID is equal to current customer identifier. If the administration component is unable to retrieve authorized amount, then the administration component would refresh the order processing page and display an error message indicating the reason for not being able to place the order. If the current order amount plus grand order amount which is the total of all previous order amounts is over authorized amount, the administration component would refresh the order processing page and display an error message indicating the reason for not being able to place the order.

When submitting the request to place the order, if the check box ‘Download Image’ is checked, then the administrative component can save ‘Y’ for current download, otherwise the administrative component would save ‘N’ for current download.

Then the administration component would start the process of adding current order to restaurant order detail table by inserting one row for each ordered item in the current order into restaurant order detail table and add the current order amount to grand order amount. The administration component would retrieve the last item sequence from restaurant order detail table using owner identifier for OWNER_ID, restaurant identifier for RESTAURANT_ID and using payment sequence for PAYMENT_SEQ. If the administration component is not able to retrieve last item sequence the administration component would set last item sequence as 0. Then the administration component would set current item sequence to last item sequence plus 1, set current item identifier to item identifier for the current item from current order information, set current special request to special request for the current item from current order information and insert a new row in restaurant order detail table using owner identifier for OWNER_ID, restaurant identifier for RESTAURANT_ID, payment sequence for PAYMENT_SEQ, current item sequence for ITEM_SEQ, current item identifier for MENU_ITEM_ID, current special request for SPECIAL_REQUEST and current download for DOWNLOAD_IMAGE_YN. If the insert fails, the administration component would reverse the inserted rows for the current order, if any, and would refresh the order processing page and display an error message indicating the reason for not being able to place the order. Then the administration component would set last item sequence to current item sequence and repeat the process of adding the remaining ordered items in the current order. When all ordered items in the current order are inserted into the restaurant order details table, the administration component will add the current order amount to grand order amount.

In addition to placing an order using the option ‘Place a Self-Order’ or requesting an employee to place an order, the current customer could also scan a QR Code displayed for each item in the menu. When a current customer scans a QR Code displayed for an item in the menu the request will be processed as described in SINGLE-ITEM-SELECTION section.

When ordered items in the current order are inserted into the restaurant order details table, the administration component would also save an image for each ordered item where the current download is set to ‘Y’ so that the current customer can download the images into their mobile device. The saved image by the administration component would include the image, group description, item description, price and a QR Code so that the downloaded item can be purchased using the QR Code. This would enable the current customer to post the image in social networks such as face book, Instagram, tik tok, Google and more.

When the current customer selects the option ‘Wi-Fi Access’, the administrative component will process the request and upon verification, would display a wi-fi access page on the current customer's device. The wi-fi access page will display wi-fi user name, wi-fi password and usage time.

To verify the current customer the administrative component would retrieve the latest single row matching current customer from restaurant waitlist table using owner identifier for OWNER_ID, restaurant identifier for RESTAURANT_ID, WAIT_SEQ is greater than 0, WAIT_STATUS_SEQ is equal to (maximum of (WAIT_STATUS_SEQ) for the same OWNER_ID, RESTAURANT_ID and WAIT_SEQ), WAIT_STATUS is equal to ‘W’ or ‘S’, current customer type for CUSTOMER_TYPE and current customer identifier for CUSTOMER_ID. The values in the retrieved row will be the latest information for the current customer. If the administrative component can not retrieve one row from restaurant waitlist table, the administrative component will refresh the menu page and will display an error indicating the request is invalid and terminate.

Then the administrative component would retrieve the latest single row matching current customer from restaurant wi-fi log table using owner identifier for OWNER_ID, restaurant identifier for RESTAURANT_ID, WIFI_SEQ is greater than 0, current customer type for CUSTOMER_TYPE and current customer identifier for CUSTOMER_ID ORDER BY WIFI_SEQ DESC. ‘ORDER BY’ clause is used to expediate the retrieval of rows from restaurant wi-fi log table. If the administrative component can retrieve one row from restaurant wi-fi log table and if the value of WIFI STATUS from the retrieved row is ‘A’, then the administrative component will save the values of WIFI_USERNAME, WIFI_PASSWORD, BEGIN_DATE and BEGIN_TIME as wi-fi username, wi-fi password, begin date, begin time respectively from the retrieved row, otherwise the administrative component will insert a row into restaurant wi-fi log table.

To insert a new row into restaurant wi-fi log table, the administrative component will use a unique wi-fi username and wi-fi password already added to the restaurant internet router or create a unique wi-fi username and wi-fi password and add to the restaurant internet router. The interface used by the administrative component to manage the users in the restaurant internet router is beyond the score of this invention and is sufficient to note that wi-fi usernames and wi-fi passwords can be added or deleted from the restaurant internet router. The administrative component upon setting up wi-fi username and wi-fi password for the current user to access the restaurant wi-fi will determine a value for new wi-fi sequence and insert a row into restaurant wi-fi log table. To determine the value for a new wi-fi sequence, the administrative component will retrieve a single row from restaurant wi-fi log table using owner identifier for OWNER_ID, restaurant identifier for RESTAURANT_ID, WIFI_SEQ is greater than 0 ORDER BY WIFI_SEQ DESC. If the administrative component can retrieve one row from restaurant wi-fi log table, then the administrative component will set value for new wi-fi sequence as the value of WIFI_SEQ from the retrieved row plus 1, or will set value for new wi-fi sequence as 1. Then administrative component will set server date as begin date, server time as begin time and insert a row into restaurant wi-fi log table using owner identifier for OWNER_ID, restaurant identifier for RESTAURANT_ID, new wi-fi sequence for WIFI_SEQ, ‘A’ for WIFI_STATUS, current customer type for CUSTOMER_TYPE, current customer identifier for CUSTOMER_ID, wi-fi username for WIFI_USERNAME, wi-fi password WIFI PASSWORD, begin date for BEGIN_DATE, begin time for BEGIN_TIME, blank for END_DATE and blank for END_TIME.

Then the administrative component will calculate the used time in minutes using current server date and time, and begin date and time. The administrative component may also fetch information from restaurant wi-fi router.

Then the administrative component will calculate the grand order amount as described in SIGN_OUT section using restaurant order table, restaurant order detail table, restaurant menu table and any other table as required. Then the administrative component will calculate the free buyer wi-fi access time based on a preset formula and the grand order amount. Then the administrative component will calculate any excessive charges based on used time, free buyer wi-fi access time and a preset formula.

Then the administrative component will refresh the menu page and display wi-fi username, wi-fi password, purchased amount, free buyer wi-fi access time in minutes, used time in minutes and any excessive charges as shown in FIG. 21I.

Virtual terminal: Owner clients and employee clients can use an app provided by the intermediary agent or use any mobile device or desktop computer to access a virtual terminal login page hosted by the intermediary agent to log into a virtual terminal. If an app is used, the app at the time of loading has verified the mobile number of the device and saved the mobile number as mobile identifier in the app's database. If an app is used, the app at the time of loading would have captured the information whether the user is an owner or employee. If the user is an owner, then the app at the time of loading would have captured an owner identifier, verified owner identifier, saved ‘O’ as user type and saved user type and owner identifier in the app's database. If the user is an employee, then the app at the time of loading would have captured an owner identifier, captured a restaurant identifier, captured an employee identifier, verified owner identifier, verified restaurant identifier, verified employee identifier, saved ‘E’ as user type and saved user type, owner identifier, restaurant identifier and employee identifier in the app's database.

Every time the app is accessed, the app would authenticate the user using fingerprint authentication or face id authentication. If the authentication is successful, then the app would continue, otherwise the app would terminate.

If the user type saved in the app's database is ‘O’, then upon authentication, the app would access an app login page hosted by the administration component and the app login page would receive the user type, mobile identifier and owner identifier from the app's database. If the user type is ‘O’, then the app login page would also capture a restaurant identifier from the user. If the user type is ‘O’, then the app login page would retrieve one row from restaurant location table using owner identifier for OWNER_ID and restaurant identifier for RESTAURANT_ID. If the app login page can retrieve one row, then the app login page would continue, otherwise the app login page will display an error message and terminate. If the user type is ‘O’, then the app login page would retrieve one row from restaurant owner table using owner identifier for OWNER_ID and mobile identifier for CONTACT_CELL. If the app login page can retrieve one row and if the value of LOGGED_YN in the retrieved row is ‘N’, then the app login page would update the restaurant owner table by setting the value ‘Y’ for LOGGED_YN using owner identifier for OWNER_ID, otherwise the app login page will display an error message and terminate.

If the user type saved in the app's database is ‘E’, then upon authentication, the app would access an app login page hosted by the administration component and the app login page would receive the user type, mobile identifier, owner identifier, restaurant identifier and employee identifier from the app's database. If the user type received by the app login page is ‘E’, then the app login page would retrieve one row from restaurant employee table using owner identifier for OWNER_ID, restaurant identifier for RESTAURANT_ID, employee identifier for EMPLOYEE_ID and mobile identifier for CONTACT_CELL. If the app login page can retrieve one row and if the value of LOGGED_YN in the retrieved row is ‘N’, then the app login page would update the restaurant employee table by setting the value ‘Y’ for LOGGED_YN using owner identifier for OWNER_ID, restaurant identifier for RESTAURANT_ID and employee identifier for EMPLOYEE_ID, otherwise the app login page will terminate.

If the virtual terminal login page hosted by the administration component to log into a virtual terminal is accessed from a mobile device or from a computer, the virtual terminal login page will capture user type, owner identifier, restaurant identifier, employee identifier and cell phone number. If the user type is ‘O’, then the value for employee identifier can be left blank. The administration component upon receiving the captured information would verify the data and if the data is valid, it would send a one-time code to the captured cell phone number and provide an input option for the user to enter the one-time code sent to their cell phone number. If the administration component receives a one-time code from the user and if the one-time code the administration component received from the user is same as the one-time code the administration component sent to the user cell phone number, then the login process will continue, otherwise the administration component will display an error message and terminate.

If the user type is ‘O’, then the administration component would retrieve one row from restaurant location table using owner identifier for OWNER_ID and restaurant identifier for RESTAURANT_ID. If the administration component can retrieve one row, then the administration component would continue, otherwise the administration component will display an error message and terminate. If the user type ‘O’, then the administration component would retrieve one row from restaurant owner table using owner identifier for OWNER_ID and mobile identifier for CONTACT_CELL. If the administration component can retrieve one row and if the value of LOGGED_YN in the retrieved row is ‘N’, then the administration component would update the restaurant owner table by setting the value ‘Y’ for LOGGED_YN using owner identifier for OWNER_ID, otherwise the administration component will display an error message and terminate.

If the user type ‘E’, then the administration component would retrieve one row from restaurant employee table using owner identifier for OWNER_ID, restaurant identifier for RESTAURANT_ID, employee identifier for EMPLOYEE_ID and mobile identifier for CONTACT_CELL. If the administration component can retrieve one row and if the value of LOGGED_YN in the retrieved row is ‘N’, then the administration component would update the restaurant employee table by setting the value ‘Y’ for LOGGED_YN using owner identifier for OWNER_ID, restaurant identifier for RESTAURANT_ID and employee identifier for EMPLOYEE_ID, otherwise the administration component will display an error message and terminate.

The virtual terminal will save logged user type, owner identifier and restaurant identifier of logged in owner clients and employee clients. In the case of employee clients, the employee identifier will also be saved.

Logged in owner clients and/or employee clients can log out using a log out web form provided by administration component and accessible in the virtual terminal. The log out web form would capture a log out confirmation from the owner clients and/or employee clients. Upon capturing the log out confirmation the log out web form would submit the request to administration component. In the case of owner clients, the administration component would receive user type, owner identifier from the virtual terminal and a request to log out from the user. In case of employee clients the administration component would receive user type, owner identifier, restaurant identifier, employee identifier from virtual terminal and a request to log out from the user. In the case of owner clients, the administration component would retrieve one row from restaurant owner table using owner identifier for OWNER_ID. If the administration component can retrieve one row and if the value of LOGGED_YN in the retrieved row is ‘Y’, then the administration component would continue, otherwise the administration component would display an error message and terminate. In the case of owner clients, the administration component would update a row in the restaurant owner table using owner identifier for OWNER_ID and setting the value for LOGGED_YN to ‘N’. In the case of employee clients, the administration component would retrieve one row from restaurant employee table using owner identifier for OWNER_ID, restaurant identifier for RESTAURANT_ID, employee identifier for EMPLOYEE_ID and mobile identifier for CONTACT_CELL. If the administration component can retrieve one row and if the value of LOGGED_YN in the retrieved row is ‘Y’, then the administration component would continue, otherwise the administration component would display an error message and terminate. In case of employee clients, the administration component would update a row in restaurant employee table using owner identifier for OWNER_ID, restaurant identifier for RESTAURANT_ID, employee identifier for EMPLOYEE_ID and setting the value for LOGGED_YN to ‘N’. Logged out owners and/or merchants will not be able to use the virtual terminal options without logging in again.

Logged in owner clients and/or employee clients can use a virtual terminal web form provided by administration component to display all the relevant information about customer clients, unknown customers and their status in a waitlist displayed on one or more display monitors for customer clients and unknown customers to view. When restaurant clients and/or employee clients use virtual terminal web form to display waitlist information, then the virtual terminal web form would send ‘M’ and ‘W’ for display type and display content respectively along with other information to indicate that the request is to display waitlist information on display monitors.

Logged in owner clients and/or employee clients can use a virtual terminal web form provided by administration component to display all the relevant information in one more electronic dash boards that can be viewed and/or updated by owner clients and/or employee clients. When restaurant clients and/or employee clients use virtual terminal web form to display all the relevant information pertaining to such as table, waitlist, order, payment and the like, then the virtual terminal web form would send ‘D’ and ‘A’ for display type and display content respectively along with other information to indicate that the request is to display all the relevant information pertaining to such as table, waitlist, order, payment and the like on one or more dash boards.

When logged in owner clients and/or employee clients use virtual terminal web form to display all the relevant information pertaining to tables and waitlist then the virtual terminal web form would send ‘D’ and ‘W’ for display type and display content respectively along with other information to indicate that the request is to display all the relevant information pertaining to tables and waitlists on one or more dashboards dedicated for employees working as hosts and for employees working as bus person.

When logged in owner clients and/or employee clients use virtual terminal web form to display all the relevant information pertaining to orders then the virtual terminal web form would send ‘D’ and ‘O’ for display type and display content respectively along with other information to indicate that the request is to display all the relevant information pertaining to orders on one or more dashboards dedicated for employees acting as waiters and kitchen staff.

It is beyond the scope of this invention to fully describe all the information that can be included for viewing waitlist information by customer clients and unknown customers on display monitors and for viewing and/or for editing by restaurant clients and employee clients waitlist, table, order and payment information in the electronic dashboard. The information provided herein is only to illustrate how current customers can view waitlist information and how owner clients and/or employee clients can perform all the front of the house and back of the house operations based on the information displayed on dashboards. For example, current customers can view their place in the waiting and the remaining waiting period. For example, employee clients working as a host can view the information retrieved from various tables from restaurant database to manage tables efficiently and to seat customers to keep the table downtime to minimum. For example, employee clients working as waiters can view the information retrieved from various tables from restaurant database to manage orders and payments efficiently and to serve customers to keep the response time to customer requests to minimum. For example, employee clients working as cooks can view the information retrieved from various tables from restaurant database and from intermediary agent customer database to prepare orders quickly and to utilize the kitchen resources efficiently. For example, employee clients working as bus persons can view the information retrieved from various tables from restaurant database and from intermediary agent customer database to clean the tables quickly and to keep table downtime to minimum. For example, employee clients working as managers can view the information retrieved from various tables from restaurant database to supervise the whole operation within a restaurant to keep the restaurants more profitable and efficient. For example, owner clients can view the information retrieved from various tables from restaurant database to supervise the whole operation within one or more restaurants to keep the restaurants more profitable and efficient.

The logged in owner clients and employee clients can view and/or edit the contents in the dashboard using an app provided by intermediary agent or using a browser hosted on any mobile device or on any desktop computer that can connect to the intermediary agent over the internet.

The logged-in employee clients can also communicate with other logged-in employee clients through a text message. The logged-in employee clients can select one or more other logged-in employee clients and enter a text message and the entered text message will be delivered to the selected one or more other logged-in employees.

For the benefit of employee clients working as hosts, the administration component would let the said employee clients to select a row from restaurant waitlist table where the OWNER_ID is equal to owner identifier, RESTAURANT_ID is equal to restaurant identifier, WAIT_SEQ is greater than 0, WAIT_STATUS_SEQ is equal to (maximum of (WAIT_STATUS_SEQ) for the same OWNER_ID, RESTAURANT_ID and WAIT_SEQ), and WAIT_STATUS is equal to ‘W’ and to select a row from restaurant seating table where the OWNER_ID is equal to owner identifier, RESTAURANT_ID is equal to restaurant identifier and TABLE STATUS is equal to ‘A’. When the said employee client can select a row from restaurant waitlist table and a row from restaurant seating table, then the said employee client would seat current customer pertaining to the selected row in the restaurant waitlist table, insert a new row in restaurant waitlist table and update the selected row in restaurant seating table. To insert a new row in restaurant waitlist table, the administration component would increment the value of WAIT_STATUS_SEQ by 1 and use ‘S’ for WAIT_STATUS to indicate that the guests have been seated, AREA ID from selected restaurant seating table for AREA_ID, TABLE_ID from selected restaurant seating table for TABLE_ID, current server date for STATUS_DATE, current server time for STATUS_TIME and keep all other values same as in the selected row in restaurant waitlist table. To update the selected row in restaurant seating table, the administration component would use ‘U’ for TABLE STATUS to indicate that the table is unavailable.

To seat a current customer the employee working as a host can choose one of many available options such as using a robot, using a guide map displayed on current customer's mobile device, using a display monitor to display a guide map, personally escorting the current customers, requesting a host robot to escort the current customer and the like as shown in FIG. 21F. To use a host robot, the administration component can wirelessly communicate with the host robot and direct the host the robot to escort a current customer's party to a specific table or the employee working as a host can manually enter the required information on the host robot's panel to direct the host the robot to escort a current customer's party to a specific table.

In addition to placing orders using the option ‘Place a Self-Order’ in the mobile menu page, current customers can also use the text message communication or in-person communication to connect with an employee accepting orders and place orders. Logged in employees, upon receiving a request to place an order, would use the option ‘Order Page’ in the virtual terminal which will be interfaced with order processing page. Upon receiving the order information through either the mobile menu page or from the virtual terminal, the administration component would process the order in the same way as described in the mobile menu page.

### Single-Item-Selection

If the current customer type is an unknown customer, then the request handler process would confirm that cookies exist in the current browser for the current customer. It the CURRENT_CUSTOMER_TYPE cookie is equal to current customer type, CURRENT_CUSTOMER_ID cookie is equal to current customer identifier, CURRENT_CUSTOMER_NAME cookie is equal to current customer name CURRENT_CUSTOMER_BUSINESS_NAME cookie is equal to current customer business name, and CURRENT_CUSTOMER_EMPLOYEE_TITLE cookie is equal to current customer employee title then request handler process would continue, otherwise it will terminate.

The request handler process would confirm that an active log exists currently in restaurant log table in merchant database (58-16). The request handler process would retrieve LOG_SEQ as current log sequence from restaurant log table using owner identifier for OWNER_ID, restaurant identifier for RESTAURANT_ID, ‘A’ for LOG_STATUS, customer type for CUSTOMER_TYPE and customer identifier for CUSTOMER_ID. If the request handler process can retrieve one row of information, then the process will continue otherwise the process will be terminated.

Then the request handler process would process the request message and if the item identifier does not present in the request message, then the request handler process will be terminated.

Then the administrative component will process the item identifier, would display an order processing page with the single item description as shown in 21H on the current customer's device to add the item identifier into the restaurant order detail table.

In the process of adding the item identifier into restaurant order detail table, if the order processing page is unbale to add the item identifier into the restaurant order detail table, then the administration component would refresh the order processing page and display an error message indicating the reason for not being able to add the item identifier. First the administration component would retrieve item price for the item identifier from restaurant menu table and calculate current item amount which would be the total of item price plus any applicable service charges and taxes. The administration component would retrieve the ITEM_PRICE, which is most recent based on current date and time, as item price for the item identifier from restaurant menu table where OWNER_ID is equal to owner identifier, RESTAURANT_ID is equal to restaurant identifier and ITEM_ID is equal to item identifier. If the administration component is unable to retrieve the item price, the administration component would refresh the order processing page and display an error message indicating the reason for not being able to process the item.

Then the administration component would retrieve the payment sequence and authorized amount from restaurant order table. The administration component would get the PAYMENT_SEQ as payment sequence, AUTH_AMOUNT as authorized amount from restaurant order table where OWNER_ID is equal to owner identifier, RESTAURANT_ID is equal to restaurant identifier, CUSTOMER_TYPE is equal to current customer type and CUSTOMER_ID is equal to current customer identifier. If the administration component is unable to retrieve authorized amount, then the administration component would refresh the order processing page and display an error message indicating the reason for not being able to place the order. If the current item identifier amount plus grand order amount which is the total of all previous order amounts is over authorized amount, the administration component would refresh the order processing page and display an error message indicating the reason for not being able to process the item identifier.

When submitting the request to place the order to purchase the item identifier, if the check box ‘Download Image’ is checked, then the administrative component can save ‘Y’ for current download, otherwise the administrative component would save ‘N’ for current download.

Then the administration component would start the process of adding current item identifier to restaurant order detail table by inserting one row for the item identifier in the current order into restaurant order detail table and add the item identifier amount to grand order amount. The administration component would retrieve the last item sequence from restaurant order detail table using owner identifier for OWNER_ID, restaurant identifier for RESTAURANT_ID and using payment sequence for PAYMENT_SEQ. If the administration component is not able to retrieve last item sequence the administration component would set last item sequence as 0. Then the administration component would set current item sequence to last item sequence plus 1, set current item identifier to item identifier, set current special request to special request for the item identifier and insert a new row in restaurant order detail table using owner identifier for OWNER_ID, restaurant identifier for RESTAURANT_ID, payment sequence for PAYMENT_SEQ, current item sequence for ITEM_SEQ, item identifier for MENU_ITEM_ID, current special for SPECIAL_REQUEST and current download request for DOWNLOAD_IMAGE_YN. If the insert is successful, then the administration component would refresh the order processing page and display a successful message indicating that the selected single item has been added to the order, otherwise the administration component would refresh the order processing page and display an error message indicating the reason for not being able to process the item identifier.

If the insert is successful and if the current download is set to ‘Y’, then the administration component would save the image of the selected item for download so that the current customer can download the images into their mobile device. The saved image by the administration component would include the image, group description, item description, price and a QR Code so that the downloaded item can be purchased using the QR Code. This would enable the current customer to post the image in social networks such as face book, Instagram, tik tok, Google and more. In some embodiments the content of the image may vary. In some embodiments the administration component can also post image in social networks such as face book, Instagram, tik tok, Google and more on behalf of the customers with customers' permission.

### Sign-Out:

If the current customer type is an unknown customer, then the request handler process would confirm that cookies exist in the current browser for the current customer. It the CURRENT_CUSTOMER_TYPE cookie is equal to current customer type, CURRENT_CUSTOMER_ID cookie is equal to current customer identifier, CURRENT_CUSTOMER_NAME cookie is equal to current customer name CURRENT_CUSTOMER_BUSINESS_NAME cookie is equal to current customer business name, and CURRENT_CUSTOMER_EMPLOYEE_TITLE cookie is equal to current customer employee title then request handler process would continue, otherwise it will terminate.

The request handler process would confirm that an active log exists currently in restaurant log table in merchant database (58-16). The request handler process would retrieve LOG_SEQ as current log sequence from restaurant log table using owner identifier for OWNER_ID, restaurant identifier for RESTAURANT_ID, ‘A’ for LOG_STATUS, customer type for CUSTOMER_TYPE and customer identifier for CUSTOMER_ID. If the request handler process can retrieve one row of information, then the process will continue otherwise the process will be terminated.

Then the request handler process would capture a tip amount, a confirmation to sign-out from customer client or unknown customer, calculate a final amount, submit a request to payment processor to capture the final amount from the authorized amount, update PAYMENT_STATUS and PAID_AMOUNT in restaurant order table, update WAIT_STATUS in restaurant waitlist table and update LOG_STATUS in restaurant log table in restaurant database (58-16) appropriately.

Then the request handler process would retrieve PAYMENT_SEQ as current payment sequence form restaurant order table using owner identifier for OWNER_ID, restaurant identifier for RESTAURANT_ID, ‘A’ for PAYMENT_STATUS, customer type for CUSTOMER_TYPE and customer identifier for CUSTOMER_ID. If the request handler process can retrieve the current payment sequence, then the sign-out process will continue, otherwise it will be terminated.

Then the request handler process would set 0 for grand order amount. Then the request handler process would retrieve MENU ITEM_IDs from restaurant order detail table using owner identifier for OWNER_ID, restaurant identifier for RESTAURANT_ID, current payment sequence for PAYMENT_SEQ. Then the request handler process would retrieve ITEM_DESCRIPTION as current item description and ITEM_PRICE as current item price for each MENU_ITEM_ID retrieved from restaurant order detail table using owner identifier for OWNER_ID, restaurant identifier for RESTAURANT_ID and each MENU_ITEM_ID retrieved from restaurant order detail table for ITEM_ID. Then the request handler process would add each current item price retrieved from restaurant menu table to grand order amount.

Then the request handler process would use a preset free buyer wi-fi access time per dollar and grand order amount to calculate free buyer allowed wi-fi access time and would use restaurant wi-fi log table to calculate free buyer used wi-fi access time. The request handler process may also interface with restaurant wi-fi router to calculate free buyer used wi-fi access time. To calculate free buyer used wi-fi access time the request handler process would retrieve a single row from restaurant wi-fi log table using owner identifier for OWNER_ID, restaurant identifier for RESTAURANT_ID, WIFI_SEQ is greater than 0, customer type for CUSTOMER_TYPE and customer identifier for CUSTOMER_ID ORDER BY WIFI_SEQ DESC. If the request handler process can retrieve one row from restaurant wi-fi log table and if the value of WIFI_STATUS from the retrieved one row is ‘A’, then the request handler process would save the values of WIFI_SEQ, BEGIN_DATE and BEGIN_TIME from the retrieved row as wi-fi sequence, begin date and begin time respectively, otherwise the request handler process would save 0 for wi-fi sequence and blanks for begin date and begin time. If the values of begin date and begin time are blanks, then the request handler process would save 0 as calculate the free buyer used wi-fi access time, otherwise calculate the free buyer used wi-fi access time using the values of begin date, begin time, server date and server time. The request handler process may also interface with restaurant wi-fi router to calculate the free buyer used wi-fi access time. If free buyer used wi-fi access time is greater than free buyer allowed wi-fi access time, then the request handler process would use a preset free buyer excess wi-fi cost per a preset number of minutes to calculate free buyer wi-fi excess cost, otherwise the request handler process would save 0 as free buyer wi-fi excess cost. If free buyer wi-fi excess cost is greater than 0, then it will be added to the grand order amount.

Then the request handler process would create and display a receipt for customer clients or for unknown customers to view the receipt and add a tip amount. Then the request handler process would add the tip amount to grand order amount and submit a request to payment processor to capture grand order amount from the authorized amount. If the request fails, the sign-out process will be terminated. Then the request handler process would update PAID_AMOUNT to grand order amount in restaurant order table using owner identifier for OWNER_ID, restaurant identifier for RESTAURANT_ID and current payment sequence for PAYMENT_SEQ. If the request fails, the sign-out process will be terminated.

Then the request handler process would retrieve WAIT_SEQ as current wait sequence, PARTY_SIZE as current party size, AREA_ID as current area identifier and TABLE_ID as current table identifier form restaurant waitlist table using owner identifier for OWNER_ID, restaurant identifier for RESTAURANT_ID, ‘W’ or ‘S’ for WAIT_STATUS, customer type for CUSTOMER_TYPE and customer identifier for CUSTOMER_ID. If the request handler process can retrieve current wait sequence and other information, then the sign-out process will continue, otherwise it will be terminated.

Then the request handler process would insert a row in restaurant waitlist table using owner identifier for OWNER_ID, restaurant identifier for RESTAURANT_ID, current wait sequence for WAIT_SEQ, ‘C’ for WAIT_STATUS indicating that the table is ready for cleaning, current server date for STATUS_DATE and current server time for STATUS_TIME.

Then the request handler process would update LOG_STATUS to ‘I’, END_DATE to server current date and END_TIME to server current time in restaurant log table using owner identifier for OWNER_ID, restaurant identifier for RESTAURANT_ID and current log sequence for LOG_SEQ.

If wi-fi sequence is greater then 0, then the request handler process would set the values ‘I’, server date and server time for WIFI_STATUS, END_DATE and END_TIME respectively in a single row in restaurant wi-fi log table using owner identifier for OWNER_ID, restaurant identifier for RESTAURANT_ID and wi-fi sequence for WIFI_SEQ.

Then the request handler process would retrieve MENU ITEM IDs from restaurant order detail table using owner identifier for OWNER_ID, restaurant identifier for RESTAURANT_ID, current payment sequence for PAYMENT_SEQ. Then the request handler process would retrieve ITEM_DESCRIPTION as current item description and ITEM PRICE as current item price for each MENU_ITEM_ID retrieved from restaurant order detail table using owner identifier for OWNER_ID, restaurant identifier for RESTAURANT_ID and each MENU ITEM ID retrieved from restaurant order detail table for ITEM_ID. Then the request handler process would add each current item price retrieved from restaurant menu table to grand order amount.

If a customer client or unknown customer fails to submit a request for signing-out then employee clients would submit the request to sign-out one or more customer clients and unknown customers who have not signed out.

The self-updating dashboard would display the tables that are to be cleaned and self-updating app or web page in in busboys' mobile devices so that busboys can clear the table. Once a table is cleaned, busboys would send a request to the request handler through an user interface to indicate that a table has been clear.

Then the request handler process would insert a row in restaurant waitlist table using owner identifier for OWNER_ID, restaurant identifier for RESTAURANT_ID, current wait sequence for WAIT_SEQ, ‘I’ for WAIT_STATUS indicating that the wait sequence is inactive, current server date for STATUS_DATE and current server time for STATUS_TIME. The request handler would also insert a row in restaurant seating table using owner identifier for OWNER_ID, restaurant identifier for RESTAURANT_ID, current area identifier for AREA_ID, current table identifier for TABLE_ID and ‘A’ for TABLE_STATUS indicating that the table is ready for next guest.

### QR Code Communication & Automation

### Golf Course Automation

Purchasing products and services from Merchants is not always the same with every type of Merchant. In a full-service restaurant the customer is seated first, and the ordered item/s will be delivered to the table where the customer was seated. In a quick-service restaurant the customer places the order first and then picks up the order from a locker located over the counter, or a locker located at the curb, or a locker located at the drive-thru lane or from a counter or get it delivered to a vehicle or from a drive-thru window. So, the merchant needs to know the pick-up option from the customer. In both the above examples the customer is waiting at a specified place to receive the order. In a grocery or department store the customer picks up the goods and goes through a self-service check-out or through an employee managed check-out lane to pay for the picked-up items. In the above examples the customer pays and/or receives the goods at a pre-defined specific location and it may not be important for merchants to know the exact position of customers at any given time inside merchant's location, but it is important for merchants that the customer goes through a self-service check-out or employee managed check-out lane. In a golf course the customer individually or as a group moves from a hole to hole in an orderly fashion where only one customer or more than one customer in a group can use a specific tee-box at a time. In order for golf operators to operate golf courses efficiently, it is at most important for golf operators to know the exact position of each golf player in the golf course at any given time. Knowing the position of each golf player on the golf course is important to keep pace of play, avoid holding up of players because of slow playing players and to deliver orders, if any.

In a golf course, the golf course operator would never know the location of a players individually or as a group at any given time. Without knowing the actual location of all golf players, the golf course operator manages reservations, tee times, golf players starting time and keep the pace of play using marshals and rangers. Also, for golf courses selling food and drinks to golf players on the golf course is one of the main sources of income. Golf courses use golf carts loaded with food and drink to sell to golf players without knowing the current location of potential buyers. Also, the golf players may not get freshly prepared food. Knowing the current location of all Golf Players on the golf course would improve golf course operations and would increase revenue and profits. So, to know the location of golf players in a golf course, golf course operators use GPS tags without 2-way communication or GPS devices (such as iPad, android tablet, and the like) with 2-way communication. But unfortunately using GPS tags or GPS devices are cost prohibitive. Also, GPS enabled private golf carts may not be able to communicate with golf course operators and the golf course operators would not know the locations of private golf carts. Also, golf players walking instead of riding a cart carrying iPad or android tablet is cumbersome. The main purpose of equipping golf carts with GPS has been to help the golf player to navigate through the golf course and not for the golf course operators to know the position of golf players.

Golf players even with GPS devices must hand out personal sensitive information to golf course operators to communicate with each other.

For optimal use of golf course and to generate maximum revenue, golf course operators rely on operational metrics such as average wait time in teeing off from each tee-box and average pace of play. Based on average wait time and average pace of play, golf course operators schedule tee times. These operational metrics can only be a guessing game without proper tools. Even with proper tools these operational metrics are rule of thumb rather than precise. Average wait time and average pace of play data can be accumulated by installing GPS on each golf cart, providing GPS device to each walking golf player and by using sophisticated software in analyzing all data from all GPS devices. Even then updating operational metrics will be an on-going process and would change constantly. Even with proper devices and software, these operational metrics are average and not exact for current conditions at any given time. When golf course operators schedule tee times based on these average operational metrics, golf course operators do not maximize their green fees revenue. Tee time scheduling based on average wait time and average pace of play, may not yield optimal revenue from green fees. If players take more time and scheduling is done too frequently then players must wait too long in between holes. If players take less time and scheduling is done less frequently, then revenue from green fees would be low. The employees of golf course, known as marshals or rangers had to physically find out the bottle neck location, personally reach out to the players playing at a slower pace and request them to play faster. This is a cumbersome, time-consuming, and not a user-friendly process. The best option would be to schedule tee times based on the current position of each player on the golf course. It is not only important for golf course operators to know the current position of each player, but also important for each player to know the current position of all fellow players, especially the players just in front of them. This would help players to proactively keep up their pace of play. Also, it is important for players to receive friendly reminders through electronic communication to keep up the pace of play if their pace of play is slower than expected. The friendly reminders are a better alternative to giving verbal instructions from marshals or rangers. Experienced golf players with fast pace of play do not want to get bogged down behind inexperienced players with slow pace of play. Golf course operators would lose valuable fast-paced golfers' patronage and positive ratings if their pace of play is slowed down.

When more than one member in a family sign-in, only one member can sign-in on behalf of all members in the family through a single sign-in. Golf Players need to have a system where a single member in a family can sign-in more than one member in the family. Yet, each member in the family can have an individual score card, each member can view the score card of all members and the family can have more than one cart. All the members in the family move together from hole to hole.

When golf players play in a group against each other, individual players verbally communicate the score with each other. Golf players need to have a system where everyone in the group would know the score without verbally communicating and without exchanging personal sensitive information with each other.

Golf players need to know when to start teeing off from tee-box number one. They cannot start without being called to start by the golf course operator. Again, without knowing the position of last golf player teed off from tee-box number one, the golf course operator would give an approximate amount of time to clear the fairway in between tee-box number one and hole number one for the previous player called to start. The time required for each individual player or for all players in a family to clear the fairway from tee-box number one would vary considerably. Some golf players may even walk instead of driving a golf cart. Since this a guess, the golf player may be unnecessarily waiting too long to start, or the golf player may start too early. Also, the golf course operator would use a public address system to announce the name of the person to start teeing off from tee-box number one which may not get the attention of golf players.

One of the revenue generations for golf courses is selling food and drinks. Golf courses use golf carts loaded with food and drinks and hire employees to drive around to sell food and drinks without knowing where potential players are in the golf course. It is impossible, for golf course operators, to predict exactly how much and what can be sold at any given time before loading the golf cart with food and drink. Also, the food may be cold and soggy before it gets sold and may even be thrown away. Taking orders and delivering freshly prepared food to golf players, wherever they are on the golf course, would be a better alternative to driving golf carts loaded with prepared food and drinks looking for potential buyers.

So, knowing the position of each player on the golf course is essential for optimal scheduling of tee times and for letting golf players to place orders for food and drinks delivered to their golf carts. Some golf courses equip their golf carts with GPS which is expensive and is out of reach for many golf course operators. When almost all golf players carry mobile devices equipped with GPS, having GPS on the golf cart may be redundant. Also, some golf players may have their own golf carts that are not equipped with GPS. Also, some golf players may also prefer to walk than to ride a golf cart.

The object of this invention is to provide a method for golf course operators to know the position of each golf player, provide a method for golf players to communicate with golf course operators without handing out personal sensitive information like cell phone number and/or emails, and provide a method for all golf players to communicate with each other without sharing personal sensitive information like cell phone number and/or emails.

The object of this invention is to provide a method for golf course operators to send start requests to golf players through a private and/or public communication channel without sharing personal sensitive information like cell phone number and/or emails.

The object of this invention is to provide a method for registered and un-registered players to sign-in, use e-score cards, place orders and sign-out electronically using any mobile device.

The object of this invention is to provide a method for a member in a family be able to sign-in more than one family member through a single sign-in transaction and be able to maintain individual score cards.

The object of this invention is to provide a method for members in a group be able to see each other's score in real time without sharing sensitive information like cell phone number and/or emails.

The object of this invention is to provide a means for golf players to use electronic score cards with or without an app supported by golf course operators.

The object of this invention is also to provide a method for golf course operators to accept orders for food and drinks and deliver freshly cooked food faster for all Golf Players.

The object of this invention is to provide a means for the deliverer to know the position of the golf players who placed the orders.

The object of this invention is to provide a means for the deliverer to deliver the goods through a locker system when the position of the golf players placed the orders is not known, for example when the orders were not delivered before completing the last hole.

The object of this invention is to provide the technology at an affordable price and be implemented quickly.

The object of this invention is to deliver a method that is easy to use without any special hardware or training.

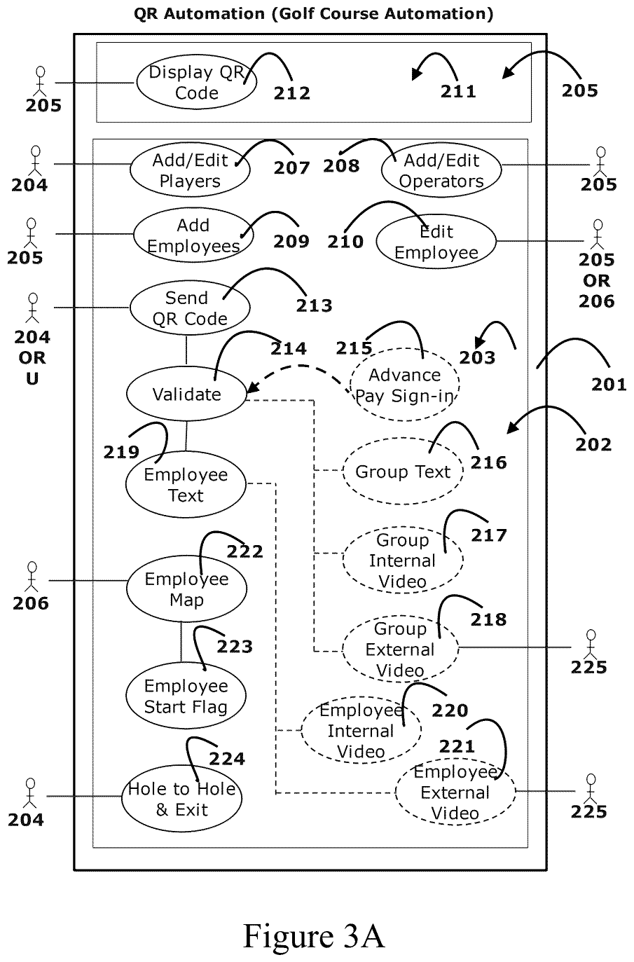

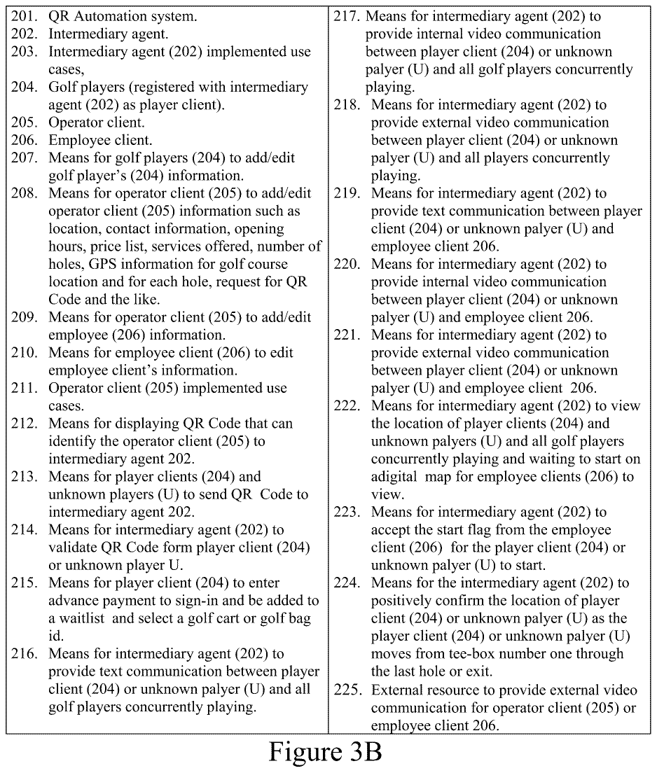

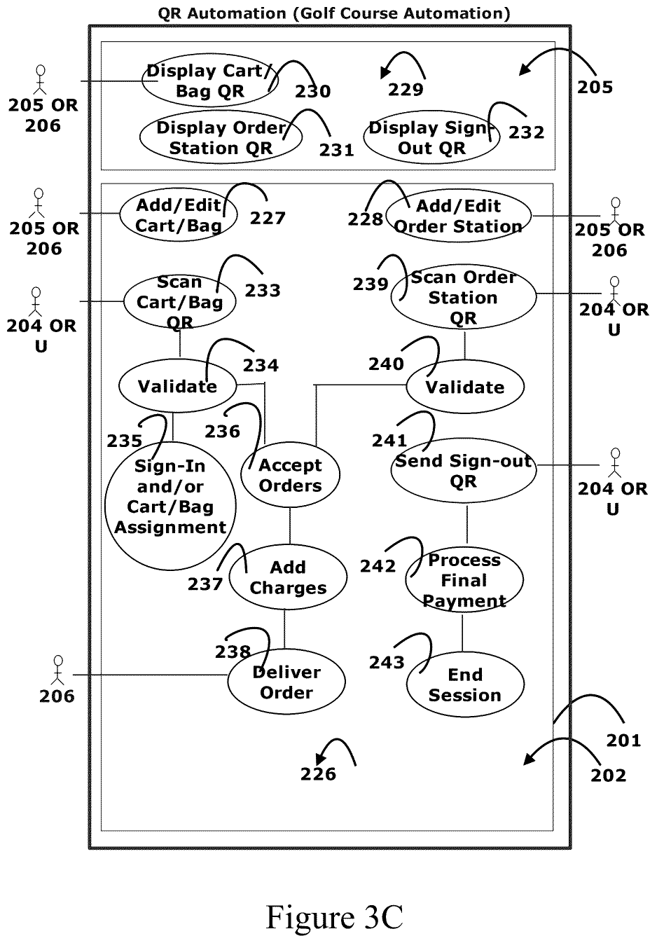

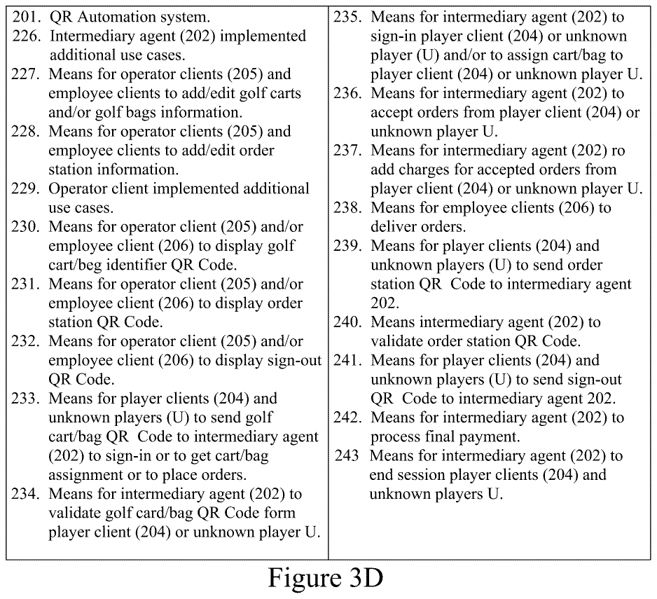

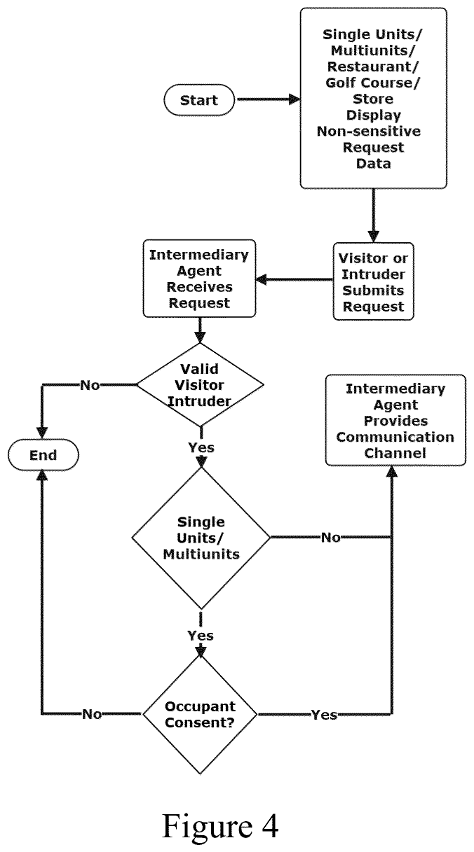

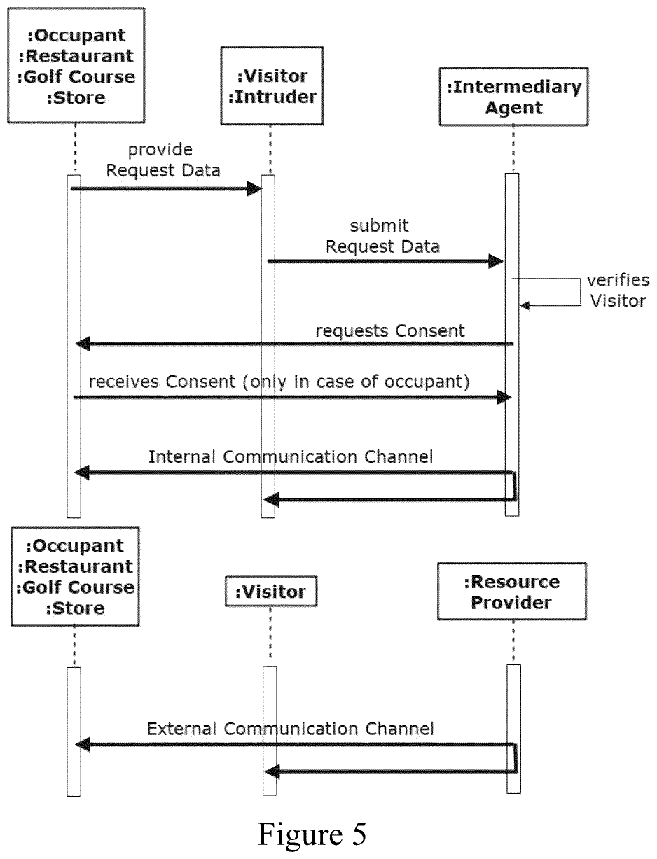

Referring now to the figures, and to FIGS. 3A and 3C in particular, the QR Automation system (201) of the present invention is shown to generally comprise an operative combination of a plurality of golf course operators (205) implemented use cases (211) and additional use cases (229) and a plurality of intermediary agent (202) implemented use cases (203) and additional use cases (226). For simplicity, golf course operators (205) are referred to as operator clients (205).

Intermediary agent (202), player clients (204), operator clients (205), employee clients (206) and unknown players (U) are also referred to as intermediary agent, player clients, operator clients, employee clients and unknown players respectively.

In particular, the operator client of the present invention will generally display for a player client or unknown player a sign-in QR Code (212) containing a request message for identifying the operator client to an intermediary agent for the purpose of requesting that the intermediary agent provide for the player client or the unknown player a communication channel between the player client or the unknown player and the employee clients.

In particular, the operator client of the present invention will generally display for a player client or unknown player a cart/bag QR Code (230) containing a request message for identifying golf cart/bag (227) to an intermediary agent for the purpose of requesting that the intermediary agent to sign-in player client or the unknown player or to get a cart/beg assigned to player client or the unknown player or to accept and deliver orders for player client or the unknown player currently using the cart/bag (227).

In particular, the operator client of the present invention will generally display for a player client or unknown player an order station identifier QR Code (231) containing a request message for identifying ordering station to an intermediary agent for the purpose of requesting that the intermediary agent to accept and deliver orders for products and services for the player client or the unknown player before the player client or the unknown player called to tee off from tee-box number one and after the player client or the unknown player entered the score for the last hole.

In particular, the operator client of the present invention will generally display for a player client or unknown player a sign-out QR Code (232) containing a request message for identifying the operator client to an intermediary agent for the purpose of requesting that the intermediary agent to process the final payment and end the session to terminate the communication channel between the player client or the unknown player and the employee clients

Additionally, intermediary agent provides a means (207) for any golf player to register as a player client.

Additionally, intermediary agent provides a means (208) for any golf course to register as operator client.

Additionally, intermediary agent provides a means (209) for operator clients to add employee clients

Additionally, intermediary agent provides a means (210) for operator clients to edit employee clients' information and employee clients to edit their own information.

Additionally, intermediary agent provides a means (227) for operator clients and employee clients to add/edit cart/bag information.

Additionally, intermediary agent provides a means (227) for operator clients and employee clients to add/edit order station information.

Additionally, intermediary agent provides a means (213) for player clients and for unknown players to send request message by scanning a QR Code.

Additionally, intermediary agent provides a means (214) for validating player clients and unknown players.

Additionally, intermediary agent provides a means (215) for player clients and unknown players to sign-in and authorize payment in advance.

Additionally, intermediary agent provides a means (216) for a communication channel for texting between player clients or unknown players with fellow players concurrently playing at the said operator client location.

Additionally, intermediary agent provides a means (217) for a communication channel for audio/video between player clients or unknown players with fellow player clients and unknown players who are concurrently playing at the said operator client location.

Additionally, intermediary agent provides a means (218) for exchanging credentials for audio/video meeting provided by an external resource provider (225) between player clients or unknown players with fellow player clients and unknown players that are concurrently playing at the said operator client location.

Additionally, intermediary agent provides a means (219) for a communication channel for texting between player clients or unknown players with employee clients.

Additionally, intermediary agent provides a means (220) for a communication channel for audio/video between player clients or unknown players with employee clients.

Additionally, intermediary agent provides a means (221) for exchanging credentials for audio/video meeting provided by an external resource provider (225) between player clients or unknown players with employee clients.

Additionally, intermediary agent provides a means (222) for employee clients to view position of player clients and unknown players on a map and/or in a text format in an app or in a browser.

Additionally, intermediary agent provides a means (223) for employee clients to send start flag to player clients and unknown players waiting to start playing from tee-box number one.

Additionally, intermediary agent provides a means (224) for player clients or unknown players to move from hole to hole and exit from playing golf.

Additionally, intermediary agent provides a means (233) for player clients or unknown players to sign-in or to get a cart/bag assigned to player clients or unknown players or to place orders while being in between tee off number one and the last hole. The means (233) further comprises means (234) for validation and means (235) for signing-in, in case the player client or unknown player has not already signed-in. The means (233) further comprises means (234) for validation and means (235) for registering a cart/bag, in case a cart/bag has not already been registered to the player client or unknown play. The means (233) further comprises means (234) for validation, means (236) to accept orders, means (237) to add charges and means (238) to deliver orders, in case the player client or unknown player has already signed in.

Additionally, intermediary agent provides a means (239) for player clients or unknown players to place orders from ordering stations. The means (239) further comprises means (240) for validation, means (236) to accept orders, means (237) to add charges and means (238) to deliver orders.

Additionally, the intermediary agent provides a means (241) for player clients or unknown players to sign-out and receive a final receipt for the goods and services received from the golf course. The means (241) further comprises means (242) to process final payment and means (243) to end the session.

Additionally, an external resource provider (225) can provide a means for external audio/video communication.

QR Code based communication can automate front and back-end workflow of any business and here is how player clients, unknown players, operator clients and employee clients would use QR Code for Golf Course Automation system, to automate front and back end of golf course operations:

QR Code based communication can fully automate or reduce the functions of Pro-shop staff, drink cart staff, waiters, marshals, managers and more.

QR Code based communication system can use a database such as golf course database with various tables such as golf course owner table, golf course employee table, golf course location table, golf course hole table, golf course cart/bag table, golf course score card table, golf course team table, golf course score table, golf course waitlist table and golf course log table as shown in a class diagram, in FIGS. 10 & 10A. In addition to golf course database, QR Code based communication system can also use a database such as intermediary agent customer database with various tables such as customer table and customer payment table, as shown in a class diagram in FIG. 6.

Primary key fields in the golf course database tables and in intermediary agent customer database are marked as ‘(PK)’ and indexed fields in the golf course database tables and in intermediary agent customer database are marked as ‘(I)’.

The valid values for HOLE_STATUS in gold course hole table are ‘A’ (Active) and ‘I’ (Inactive). The valid values for CART_BAG_TYPE in gold course cart/bag table are ‘C’ (Cart) and ‘B’ (Bag). The valid values for WAIT_STATUS in gold course waitlist table are ‘W’ (Waiting), ‘P’ (Playing), ‘C’ (Completed) and ‘I’ (Inactive). The valid values for LOG_STATUS in gold course log table are ‘A’ (Active) and ‘I’ (Inactive). The valid values for ORDER_STATION_STATUS in gold course order station table are ‘A’ (Active) and ‘I’ (Inactive). The valid values for ORDER_STATUS in gold course order status table are ‘O’ (Ordered), ‘L’ (Loaded) and ‘D’ (Delivered).

Before continuing, however, it is noted that while the databases shown in class diagrams in FIGS. 6, 10 and 10A are exemplary of the preferred embodiments of the present invention, it is in no manner meant to be all encompassing or otherwise limiting of the wide range of implementations as are possible.

Those of ordinary skill in the art will readily recognize the SQL statements shown in describing the various embodiments to insert, update or retrieve rows from the tables in the databases as shown in class diagrams in FIGS. 6, 10 and 10A can be only examples, and the actual SQL statements can vary depending on the existing and future database management servers used by the intermediary agent.

As described in ‘DETAILED DESCRIPTION OF THE PREFERRED EMBODIMENTS’ section, any consumer can use customer web form provided by intermediary agent to register and maintain their personal information with the intermediary agent as customer.

Both player clients and unknown players will be generally referred to as current players.

For player clients, the value for player client identifier type would be ‘C’ whereas for unknown players, the value for unknown player identifier type would be ‘U’.

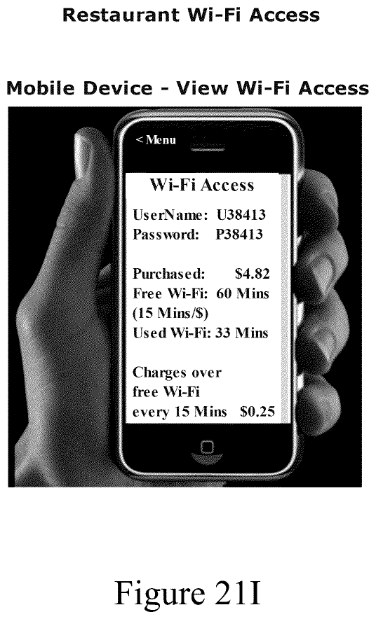

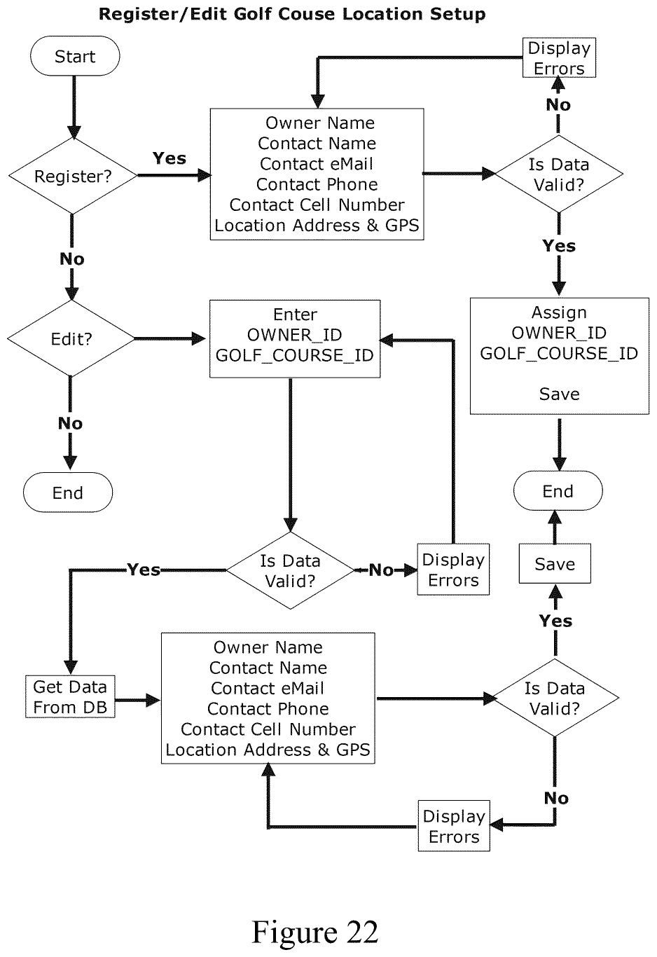

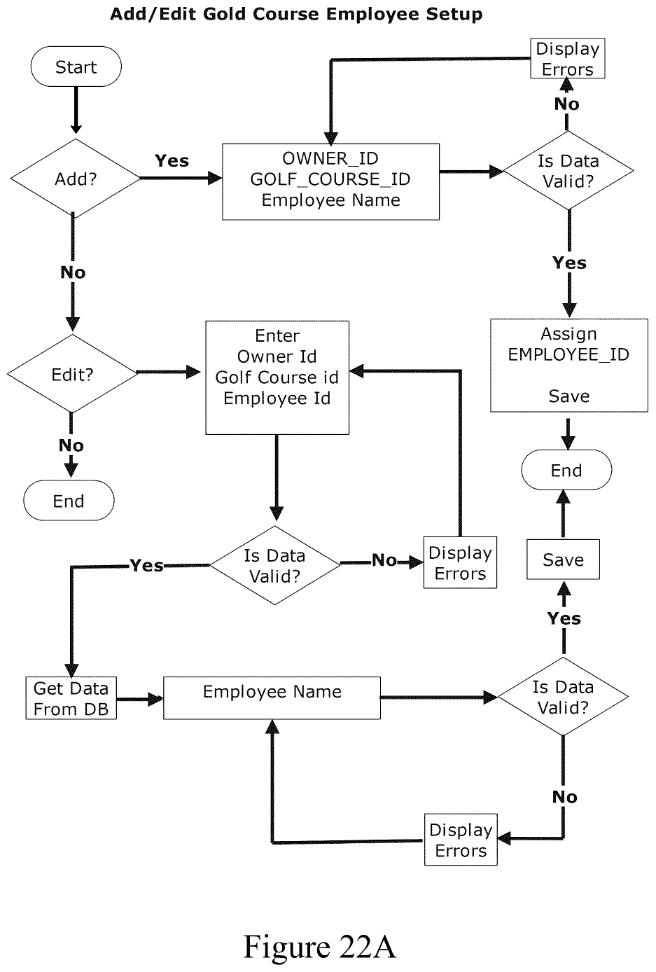

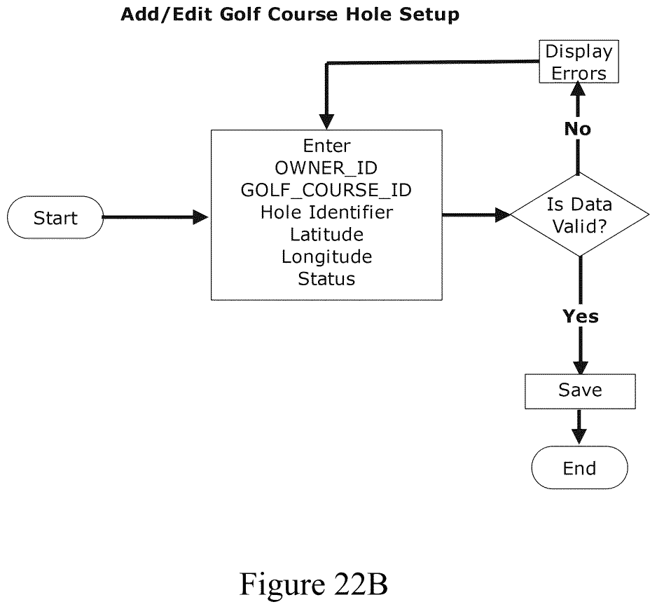

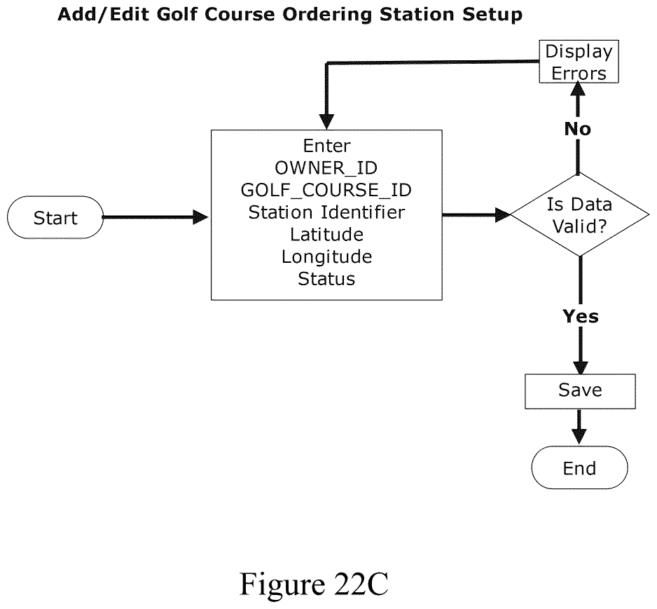

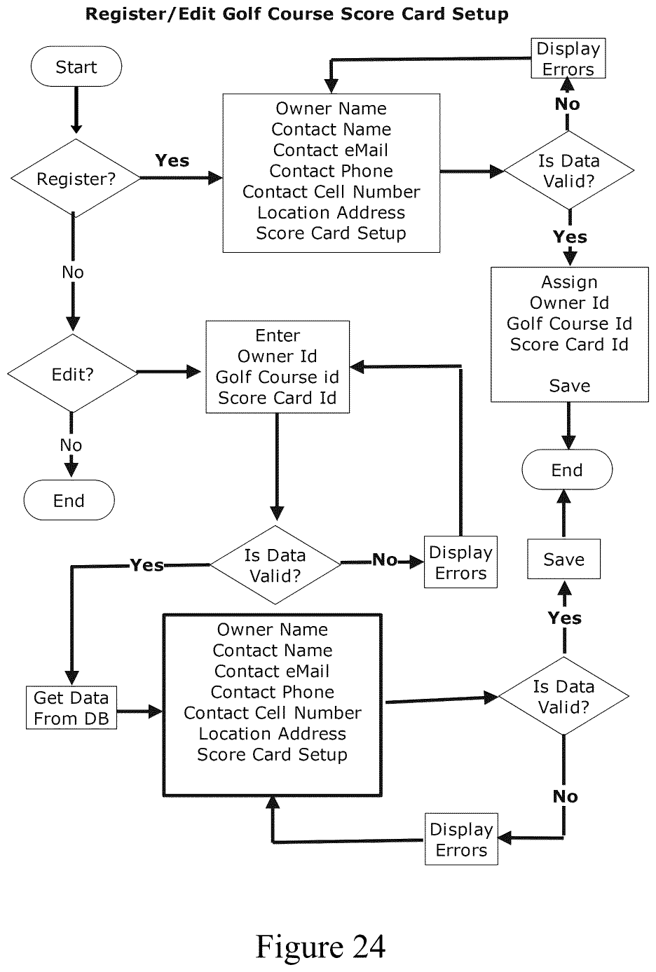

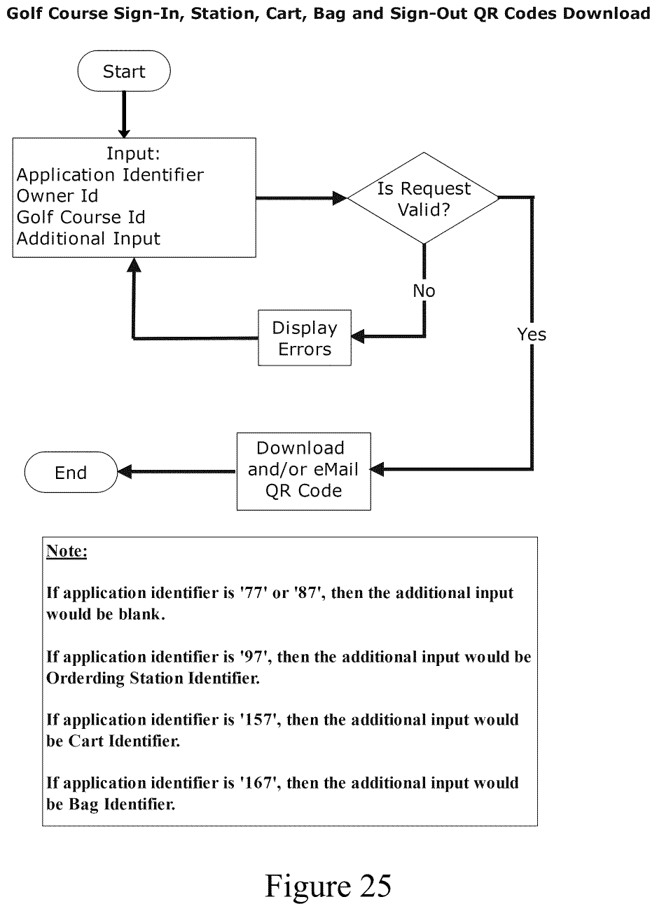

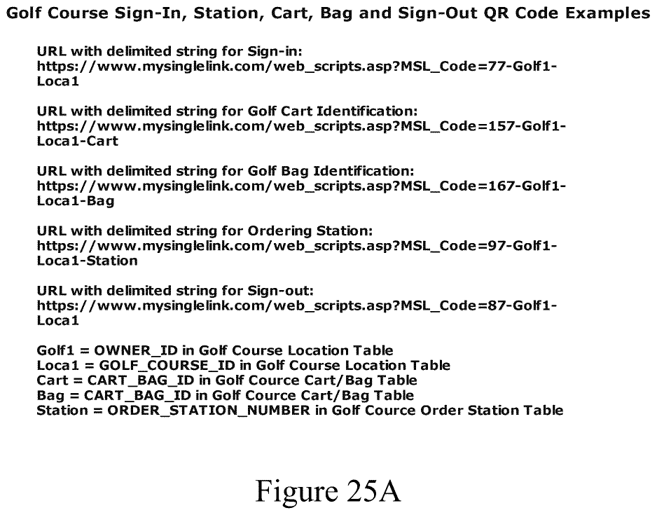

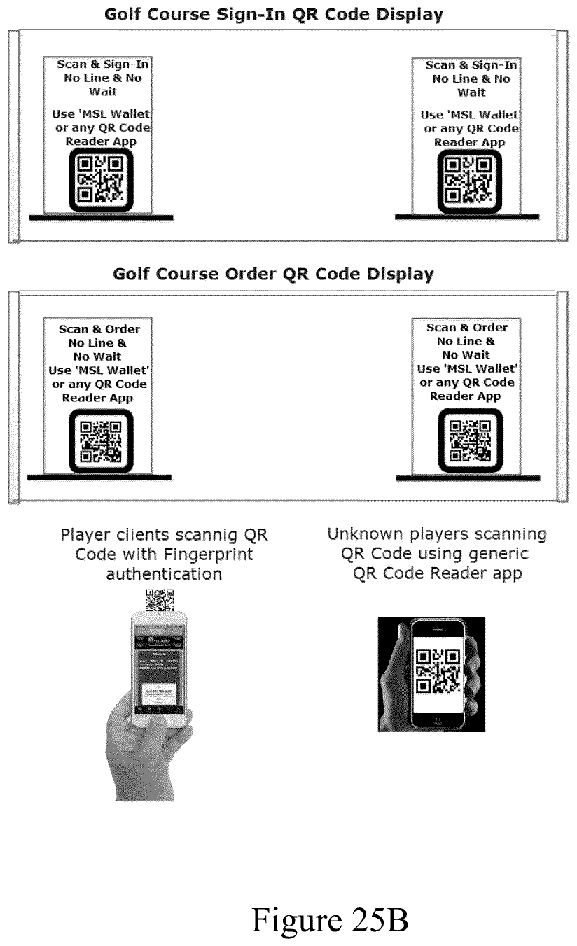

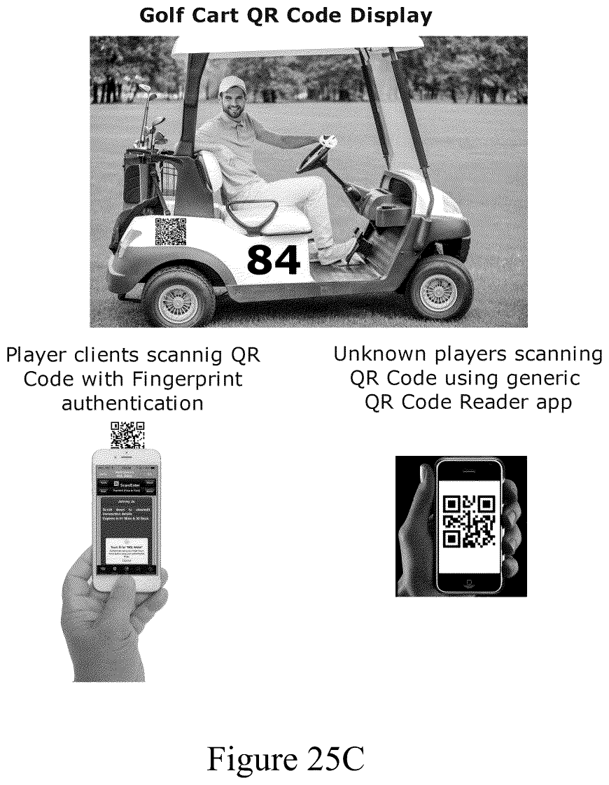

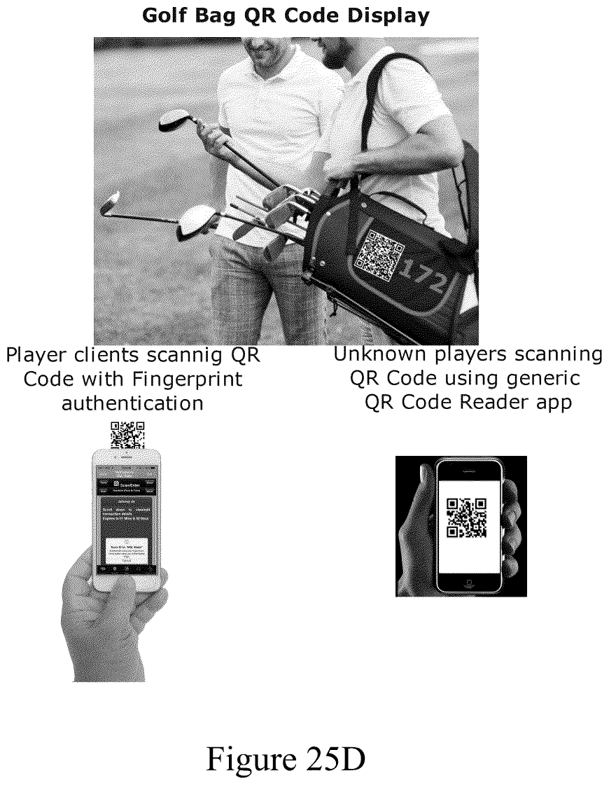

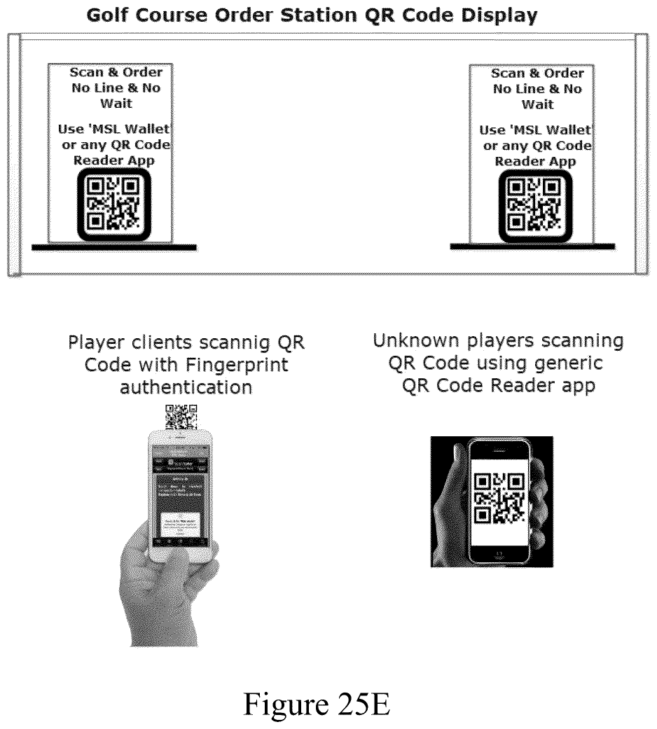

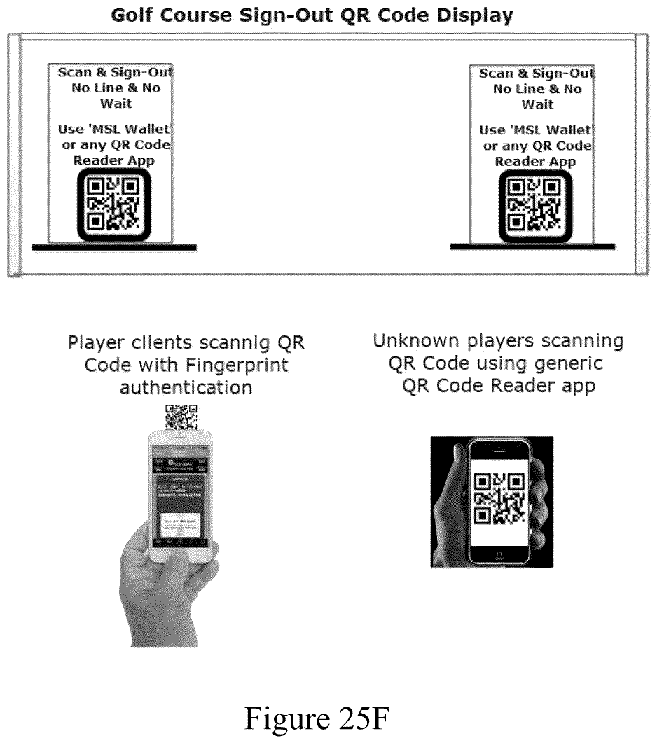

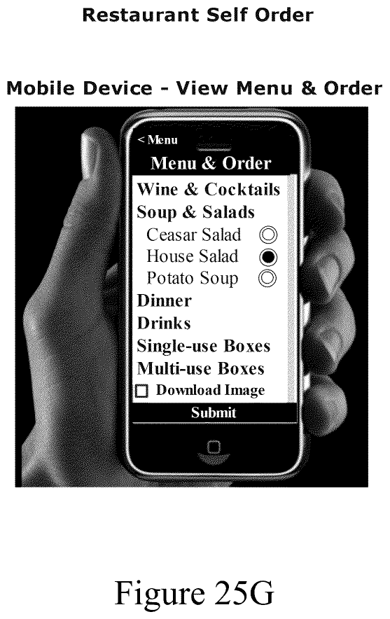

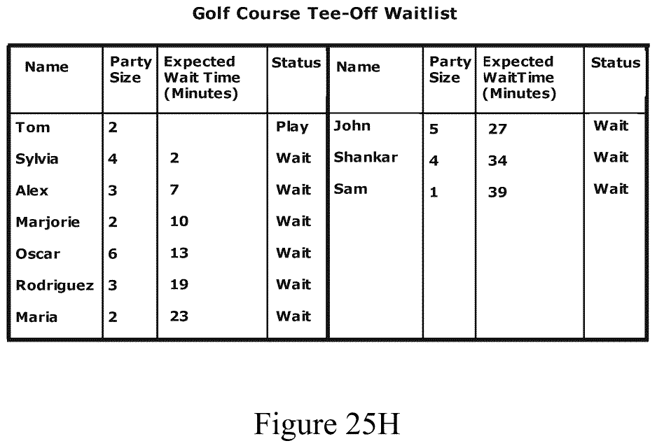

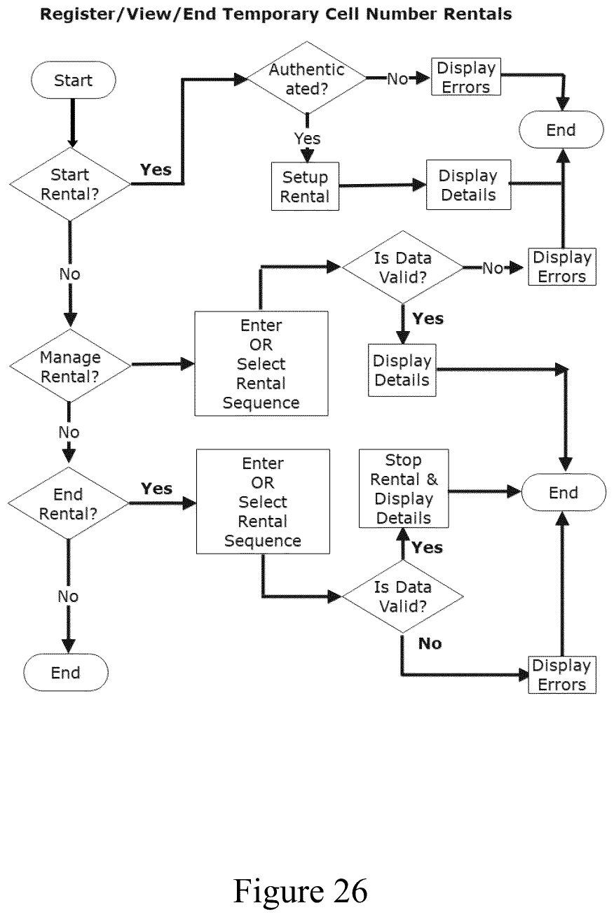

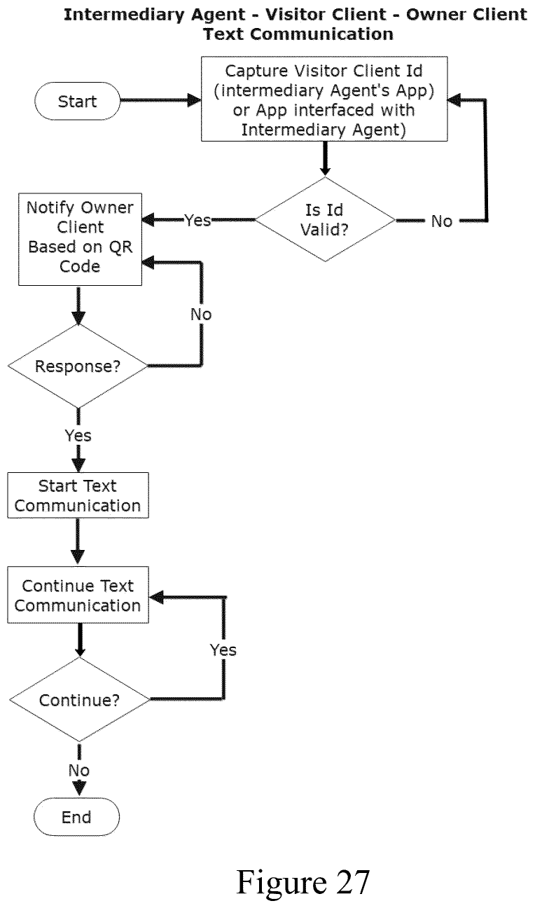

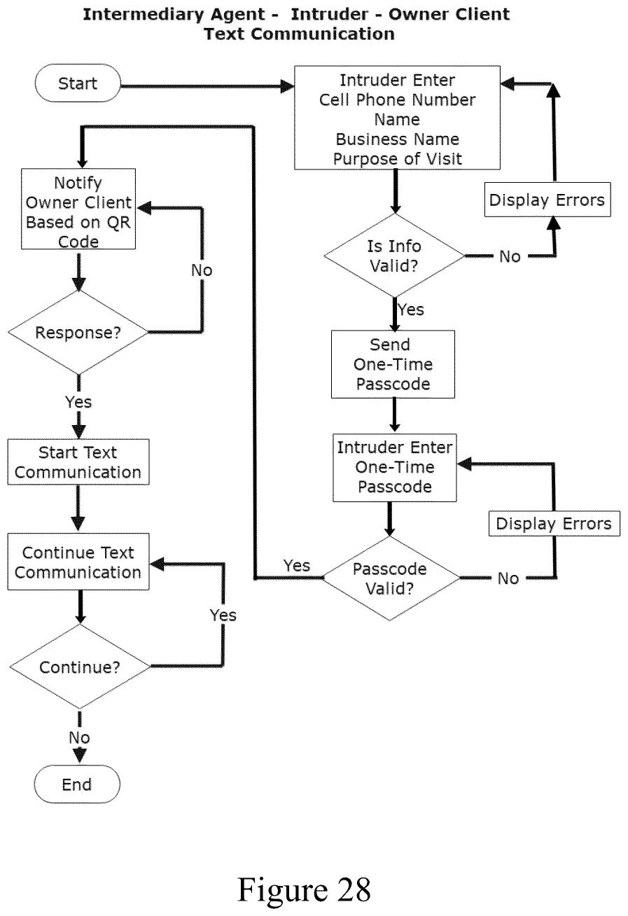

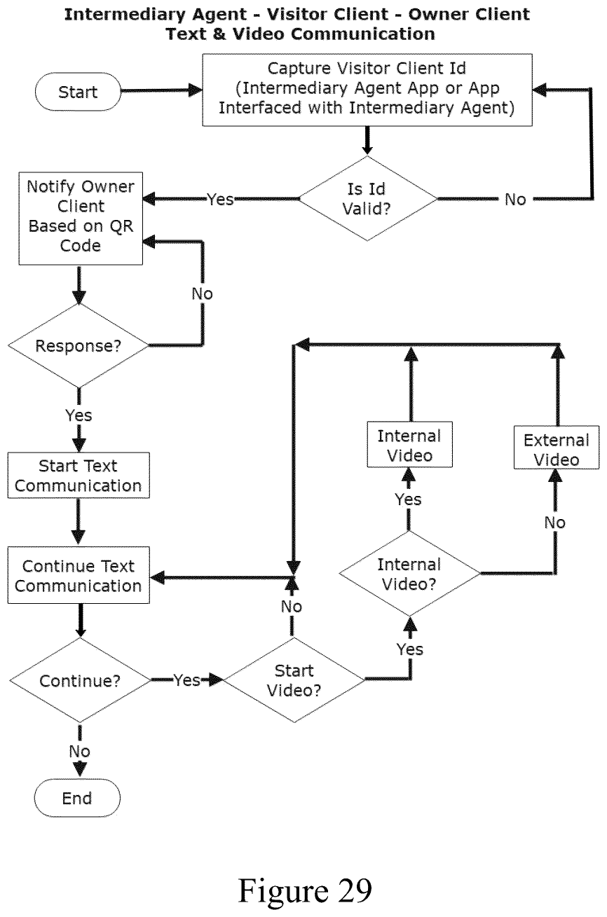

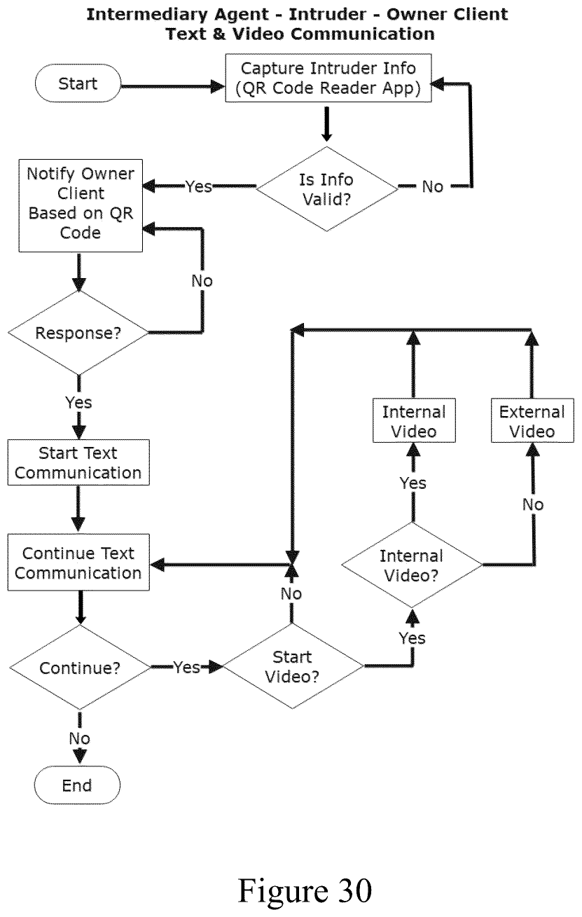

Golf course owners would register as owner and edit their information as operator clients, operator clients would also add and edit employees, location, hole, golf cart, golf bag, score card, sing-in QR Code, sign-out QR Code, cart QR Code, bag QR Code and ordering station QR Code information with the intermediary agent as shown in flowcharts in FIGS. 22, 22A, 22B, 22C, 23 and 24. Operator clients would also download and display a unique QR Code for sign-in, a unique QR Code for each ordering station, a unique QR Code for each golf cart, a unique QR Code for each golf bag, a unique QR Code for sign-out for each gold course location as shown in flowcharts in FIGS. 25 and 25A. Operator clients would also download and attach a unique QR Code for each cart and unique QR Codes to be attached to bags in each golf course location.

Golf course owners can register using an owner registration web form provided by intermediary agent using ‘A’ for action. Intermediary agent would assign a unique value for owner identifier and capture values for owner name, contact name, contact email, contact phone and contact cell as shown in FIG. 22. If the values are valid then the intermediary agent would insert a row into golf course owner table as shown in a class diagram as shown in FIG. 10 using owner identifier for OWNER_ID, owner name for OWNER_NAME, contact name for CONTACT_NAME, contact email for CONTACT_EMAIL, contact phone for CONTACT_PHONE and contact cell for CONTACT_CELL. Golf Course owners can edit their information using owner registration web form provided by intermediary agent using ‘E’ for action. Intermediary agent would capture values for owner identifier, owner name, contact name, contact email, contact phone and contact cell as shown in FIG. 22. If the values are valid then the intermediary agent would update a row in golf course owner table as shown in a class diagram as shown in FIG. 10 using owner identifier for OWNER_ID, owner name for OWNER_NAME, contact name for CONTACT_NAME, contact email for CONTACT_EMAIL, contact phone for CONTACT_PHONE and contact cell for CONTACT_CELL. Registered golf course owners will be referred to as operator clients.

Golf course owners can add a location using a location registration web form provided by intermediary agent using ‘A’ for action. Intermediary agent would capture values for owner identifier, address, latitude, and longitude as shown in FIG. 22. If the captured values are valid, then the intermediary agent would assign a unique value for golf course identifier, format the values for sign-in and for sign-out using an application identifier owner identifier and golf course identifier. The intermediary agent would use a pre-defined delimiter, per-defined application identifier for sign-in, a pre-defined application identifier for sign-out, owner identifier and golf course identifier. Then the intermediary agent would insert a row into golf course location table using owner identifier for OWNER_ID, golf course identifier for RESTAURANT_ID, address for ADDRESS, latitude for LATITUDE, longitude for LONGITUDE, sign-in for QR_CODE_SIGN_IN and sign-out for QR_CODE_SIGN_OUT.

Golf course owners can edit a location information using location registration web form provided by intermediary agent using ‘E’ for action. Intermediary agent would capture values for owner identifier, golf course identifier, address, latitude and longitude as shown in FIG. 22. If the values are valid then the intermediary agent would update a row in golf course location table as shown in a class diagram as shown in FIG. 10 using owner identifier for OWNER_ID, golf course identifier for GOLF_COURSE_ID, address for ADDRESS, latitude for LATITUDE, longitude for LONGITUDE. The values for QR_CODE_SIGN_IN and QR_CODE_SIGN_OUT will not change, because the values for owner identifier and golf course identifier did not change.

Golf course owners can add or edit employee information using employee registration web form provided by intermediary agent. To add an employee, golf course owners would use ‘A’ for action and to edit an employee, golf course owners would use ‘E’ for action. When golf course owners add employees, each employee will be assigned with a unique employee identifier by the intermediary agent and values for name, title, description and contact cell will be captured as shown in FIG. 22A and saved in golf course employee table. If the captured values are valid, then the intermediary agent would insert one row into golf course employee table using owner identifier for OWNER_ID, golf course identifier for GOLF_COURSE_ID, employee identifier for EMPLOYEE_ID, name for EMPLOYEE_NAME, title for EMPLOYEE_JOB_TITLE, description for EMPLOYEE_JOB_DESCRIPTION, contact cell for CONTACT_CELL and ‘N’ for LOGGED_YN. When golf course owners edit employee information values for employee identifier, for name, title, description and contact cell will be captured by the intermediary agent as shown in FIG. 22A and saved in golf course employee table. If the captured values are valid, then the intermediary agent would set name for EMPLOYEE_NAME, title for EMPLOYEE_JOB_TITLE, description for EMPLOYEE_JOB_DESCRIPTION, contact cell for CONTACT_CELL and ‘N’ for LOGGED_YN in golf course employee table using owner identifier for OWNER_ID, golf course identifier for GOLF_COURSE_ID and employee identifier for EMPLOYEE_ID.

Golf course owners can add or edit hole information using hole registration web form provided by intermediary agent. When operator clients add or edit a hole, the intermediary agent will capture the values for hole identifier, latitude, longitude and status as shown in FIG. 22B and save in golf course hole table as shown in a class diagram, in FIG. 10. The valid values for status would be ‘A’ to indicate that the hole is active or ‘I’ to indicate that the hole is inactive. Then the request handler would insert a new row or update an existing row in the golf course hole table in golf course database. The request handler would retrieve a row from the golf course hole table using owner identifier for OWNER_ID, golf course identifier for GOLF_COURSE_ID and hole identifier for HOLE_ID. If the request handler can retrieve a row then the request handler would update the row in golf course hole table using owner identifier for OWNER_ID, golf course identifier for GOLF_COURSE_ID, hole identifier for HOLE_ID, status for HOLE_STATUS, latitude for HOLE LATITUDE and longitude for HOLE LONGITUDE, otherwise the request handler would insert a new row using owner identifier for OWNER_ID, golf course identifier for GOLF_COURSE_ID, hole identifier for HOLE_ID, status for HOLE_STATUS, latitude for HOLE_LATITUDE and longitude for HOLE_LONGITUDE into golf course hole table.

Each golf course location can have an unlimited number of holes.

Golf course owners can add or edit ordering station information using order station registration web form provided by intermediary agent. When operator clients add or edit an ordering station, the intermediary agent will capture the values for station identifier, latitude, longitude and status as shown in FIG. 22C and save in golf course order station table as shown in a class diagram, in FIG. 10. The valid values for status would be ‘A’ to indicate that the ordering station is active or ‘I’ to indicate that the ordering station is inactive. Then the request handler would insert a new row or update an existing row in the golf course order station table in golf course database. The request handler would retrieve a row from the golf course order station table using owner identifier for OWNER_ID, golf course identifier for GOLF_COURSE_ID and station identifier for ORDER_STATION_ID. If the request handler can retrieve a row then the request handler would update the row in golf course order station table using owner identifier for OWNER_ID, golf course identifier for GOLF_COURSE_ID, station identifier for ORDER_STATION_ID, status for ORDER_STATION_STATUS, latitude for ORDER STATION LATITUDE and longitude for ORDER_STATION_LONGITUDE, otherwise the request handler would insert a new row using owner identifier for OWNER_ID, golf course identifier for GOLF_COURSE_ID, station identifier for ORDER_STATION_ID, status for ORDER STATION STATUS, latitude for ORDER_STATION_LATITUDE and longitude for ORDER STATION LONGITUDE into golf course order station table.

Each golf course location can have an unlimited number of order stations.

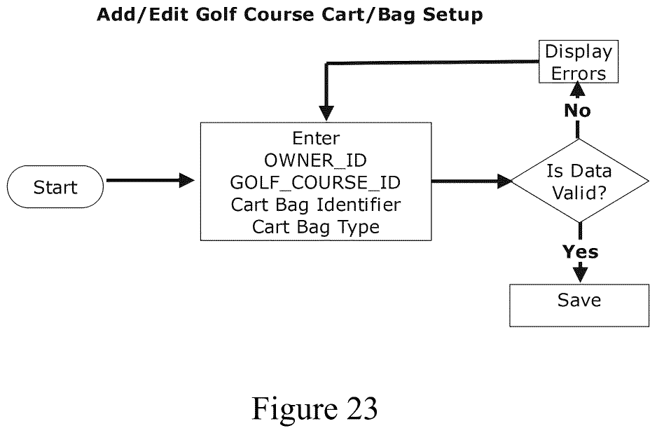

Golf course owners or employees can add or edit cart/bag information using cart bag registration web form provided by intermediary agent. When operator clients add or edit a cart bag, the intermediary agent will capture the values for cart bag identifier and for cart bag type as shown in FIG. 23 and save in golf course cart/bag table as shown in a class diagram, in FIG. 10. The valid values for cart bag type would be ‘C’ to indicate that the cart bag identifier is for golf cart or ‘B’ to indicate that the cart bag identifier is for golf bag. Then the request handler would insert a new row or update an existing row in the golf course cart/bag table in golf course database. The request handler would retrieve a row from the golf course cart/bag table using owner identifier for OWNER_ID, golf course identifier for GOLF_COURSE_ID and cart bag identifier for CART_BAG_ID. If the request handler retrieved a row, then the request handler would update the row in golf course cart/bag table, otherwise the request handler would insert a new row into golf course cart/bag table.

Before inserting or updating a row in golf course cart/bag table, the request handler would format the QR Code. The content of the formatted QR Code would be an application identifier, owner identifier, golf course identifier and cart bag identifier concatenated with a pre-defined delimiter, for example ‘-’. For example, if the cart bag type is ‘C’, then the application identifier could be ‘157’ or if the cart bag type is ‘B’, then the application identifier could be ‘167’. If the request handler did not retrieve a row then the request handler would insert a row in golf course cart/bag table using owner identifier for OWNER_ID, golf course identifier for GOLF_COURSE_ID, cart bag identifier captured from golf course owners and/or employees for CART_BAG_ID, cart bag type captured from golf course owners and/or employees for CART_BAG_TYPE and intermediary agent formatted QR Code for CART_BAG_QR_CODE.

If the request handler retrieved a row then the request handler would update the row in golf course cart/bag table, using owner identifier for OWNER_ID, golf course identifier for GOLF_COURSE_ID, cart bag identifier captured from golf course owners and/or employees for CART_BAG_ID, cart bag type captured from golf course owners and/or employees for CART_BAG_TYPE and intermediary agent formatted QR Code for CART_BAG_QR_CODE.

Golf course owners and employees can download QR Cods using a QR Code download web form provided by intermediary agent. Intermediary agent would capture values for application identifier, OWNER_ID, GOLF_COURSE_ID and an additional input as shown in FIG. 25 and save a blank value for QR Code. The valid values for application identifier would be 77, 157, 167, 97 and 87. If the application identifier is ‘77’ or ‘87’, the additional input would be blank. If the application identifier is ‘157’, then the additional input would be a cart identifier. If the application identifier is ‘167’, then the additional input would be a bag identifier. If the application identifier is ‘97’, then the additional input would be an ordering station identifier.

The intermediary agent would retrieve one row from golf course location table using owner identifier for OWNER_ID, golf course identifier for GOLF_COURSE_ID. If the request handler retrieved a row and if the application identifier is 77, then the request handler would save QR_CODE_SIGN_IN from the retrieved row as QR Code. If the request handler retrieved a row and if the application identifier is 87, then the request handler would save QR_CODE_SIGN_OUT from the retrieved row as QR Code.

If the application identifier is 157, then the valid value for additional input would be a golf cart identifier. The intermediary agent would retrieve one row from golf course cart/beg table using owner identifier for OWNER_ID, golf course identifier for GOLF_COURSE_ID, additional input for CART_BAG_ID and ‘C’ for CART_BAG_TYPE. If the request handler retrieved a row, then the request handler would save CART_BAG_QR_CODE from the retrieved row as QR Code.

If the application identifier is 167, then the valid value for additional input would be a golf bag identifier. The intermediary agent would retrieve one row from golf course cart/beg table using owner identifier for OWNER_ID, golf course identifier for GOLF_COURSE_ID, additional input for CART_BAG_ID and ‘B’ for CART_BAG_TYPE. If the request handler retrieved a row, then the request handler would save CART_BAG_QR_CODE from the retrieved row as QR Code.

If the application identifier is 97, then the valid value for the additional input would be an ordering station identifier. The intermediary agent would retrieve one row from golf course order station table using owner identifier for OWNER_ID, golf course identifier for GOLF_COURSE_ID, and additional input for ORDER_STATION_ID. If the request handler retrieved a row, then the request handler would save ORDER_STATION_QR_CODE from the retrieved row as QR Code.

Upon verifying the captured data and if QR Code is not blank, then the intermediary agent would download the QR Code as shown in FIG. 25A.

Upon verifying the captured data and if QR Code is blank, then the intermediary agent would display an error in QR Code download web form.

Operator clients can display the unique sign-in QR Codes at waiting areas and/or at entrances at one or more spots for player clients and for unknown players to sign-in. QR Codes can be displayed at an unlimited number of spots.

Operator clients can display and provide access to unique cart/bag QR Codes for player clients and for unknown players to pick-up carts or bag identifiers upon signing-in. Golf cart and bag identifiers can be left at unlimited number of spots.

Operator clients can display and provide access to unique ordering QR Codes for player clients and for unknown players to place orders before teeing off for the first hole and after teeing off for the last hole or after exiting the game.

Operator clients can display the unique sign-out QR Codes at exits at one or more spots for player clients and for unknown players to sign-out. QR Codes can be displayed at an unlimited number of spots.

Golf course owners and/or employees set up all the required tables in the golf course database and displayed all the QR Codes, the players can start scanning the QR Codes or access the MOBILE_MENU_PAGE in their mobile devices to use the Golf Course Automation system. Golf course owners and/or employees set up all the required tables in the golf course database and displayed all the QR Codes, the employees can log into VIRTIAL_TERMAL in their mobile devices or in their desktop devices to use the Golf Course Automation system.

When an individual scans a QR Code displayed at any golf course location using an app provided by the intermediary agent or an app interfaced with intermediary agent or any generic QR Code Reader app or a camera, the content of the QR Code will be passed on to QR Code web page hosted by intermediary agent, upon verification of the QR Code by the QR Code web page, the information will be passed on to the request handler process in the intermediary agent to initiate a request handler process as described in ‘DETAILED DESCRIPTION OF THE PREFERRED EMBODIMENTS’ section and the request handler process will continue here. When a QR Code is scanned by an individual, the request handler process would have saved the request message embedded in the QR Code as request message and the information of the individual scanned the QR Code as customer identifier, customer type, customer name, customer business name, customer employee title, customer latitude and customer longitude. The customer identifier and customer type known to request handler process will also be referred to as current customer identifier and current customer type.

If the customer type is ‘C’, then the individual scanned the QR Code is a player client and does not represent any business. If the customer type is ‘M’, then the individual scanned the QR Code is a player client and represents a business. If the customer type is ‘U’, then the individual scanned the QR Code is an unknown player.

All customers currently present at the golf course location who are not current customer will be referred to as fellow players.

Then the request handler process would segregate the request message, based on a pre-defined procedure into 3 or 4 segments. If the request message had 3 segments then the 3 segments would be application identifier, owner identifier, and golf course identifier respectively. If the request message had 4 segments and if the value in the first segment is 97, then the 4 segments would be application identifier, owner identifier, golf course identifier and ordering station identifier respectively. If the request message had 4 segments and if the value in the first segment is 157, then the 4 segments would be application identifier, owner identifier, golf course identifier and golf cart identifier respectively. If the request message had 4 segments and if the value in the first segment is 167, then the 4 segments would be application identifier, owner identifier, golf course identifier and golf bag identifier respectively.

If the request handler process cannot break the request message into 3 or 4 segments the request handler process will be terminated. If the application identifier is not for processing QR Codes for golf course, then the request handler process will be terminated. If the application identifier 77 or if the application identifier is 97 or if the application identifier is 157 or if the application identifier is 167 or if the application identifier is 87 then the request handler process will continue, otherwise it will be terminated.

Then the request handler process would retrieve LATITUDE as golf course latitude and LONGITUDE as golf course longitude from golf course location table in golf course database (58-16) using owner identifier for OWNER_ID and golf course identifier for GOLF_COURSE_ID. If the request handler process can retrieve one row, then the request handler process will save LATITUDE and LONGITUDE from the retrieved row as golf course latitude and golf course longitude and continue otherwise it will be terminated.

In the case of a player client the request handler process would also have received the location information of player client (current latitude and longitude) of the mobile device used by the player client. Then the request handler process would determine whether the player client's location is within a certain limit from the golf course location based on player client's mobile device latitude and longitude and golf course latitude and longitude. If the distance between the player client's location and golf course location is within a certain limit, then the request handler process will continue, otherwise it will be terminated.

In the case of an unknown player the request handler process would also have received the location information of the internet service provider (ISP latitude and longitude) providing internet service for the unknown player. Then the request handler process would determine whether the unknown player's ISP location is within a certain limit from the golf course location based on ISP latitude and longitude and golf course latitude and longitude. If the distance between ISP location and golf course location is within a certain limit, then the request handler process will continue, otherwise it will be terminated.

If the application identifier 77, request handler process will execute PLAYER_SIGN-IN_PROCESS.

If the application identifier 157, request handler process will execute PLAYER CART_ASSIGNMENT_PROCESS.

If the application identifier 167, request handler process will execute PLAYER_BAG_ASSIGNMENT_PROCESS.

If the application identifier 97, request handler process will execute PLAYER_ORDER_PROCESS.

If the application identifier 87, request handler process will execute PLAYER_SIGN-OUT_PROCESS.

PLAYER_SIGN-IN_PROCESS, PLAYER_CART_ASSIGNMENT_PROCESS, PLAYER_BAG_ASSIGNMENT_PROCESS. PLAYER_ORDER_PROCESS and PLAYER_SIGN-OUT_PROCESS are further described in greater detail herein.

### Player_Sign-In_Process:

The request handler would confirm that an active log does not exist currently in golf course log table for the current player. The request handler would retrieve a row from golf course log table using owner identifier for OWNER_ID, golf course identifier for GOLF_COURSE_ID, ‘A’ for LOG_STATUS, current player identifier type for GOLF_PLAYER_ID_TYPE and current player identifier for GOLF_PLAYER_ID. If the request handler can retrieve one or more rows, then the process will be terminated. This will prevent a signed-in player signing-in again before signing-out.

In player client the request handler would get the PAYMENT_ACCOUNT_NUMBER as current customer payment account number, PAYMENT_EXPIRATION_DATE as current customer payment account expiration date and PAYMENT_SECURITY_CODE as current customer payment security code from customer payment table where CUSTOMER_ID is player client. In case of unknown player, the request handler would capture current customer payment account number, current customer payment account expiration date and current customer payment security code from unknown player. If the request handler gets current customer payment account number, current customer payment account expiration date and current customer payment account security code, the process will continue, otherwise it will be terminated.

Then the request handler would insert a new row in golf course log table. The request handler would retrieve the last log sequence from golf course log table using owner identifier for OWNER_ID and golf course identifier for GOLF_COURSE_ID. If the request handler retrieves last log sequence then the request handler would set new log sequence by incrementing the last log sequence by 1, otherwise the request handler would set new log sequence as 1. Then the request handler would insert a new row in golf course log table using owner identifier for OWNER_ID, golf course identifier for GOLF_COURSE_ID, new log sequence for LOG_SEQ, ‘A’ for LOG_STATUS, current server date for BEGIN_DATE, current server time for BEGIN_TIME, blank value for END_DATE, blank value for END_TIME, blank value for DESCRIPTION, customer type for GOLF_PLAYER_ID_TYPE and customer identifier for GOLF_PLAYER_ID. When the process terminates, the request handler would update LOG_STATUS to ‘I’, END_DATE, END_TIME and DESCRIPTION by using current server date for END_DATE, current server time for END_TIME and appending the reason for termination to DESCRIPTION in golf course log table where OWNER_ID is equal to owner identifier, GOLF_COURSE_ID is equal to golf course identifier, ‘A’ is equal to LOG_STATUS, type is equal to GOLF_PLAYER_ID_TYPE and current player identifier is equal to GOLF_PLAYER_ID. current player identifier

If the process continues, then the request handler process would use the administration component under application server to capture party size. If the request handler process captures party size information from player client or unknown player, the process will continue, otherwise it will be terminated. The request handler process would request the administration component under application server as shown in FIG. 58 to calculate an authorize amount based on the party size and based on the setup set by the owner client and to receive an authorization code for the calculated authorize amount from a payment processor using current customer payment account number, current customer payment account expiration date and current customer payment security code. For example, if the golf course owner set up $75.00 for each one in the party size and if the party size is 4, then the calculated authorize amount would be $300.00. If capturing party size and getting an authorization code from a payment processor for a calculated authorize amount is successful, then the process will continue otherwise it will be terminated.

The request handler would retrieve the last wait sequence from golf course waitlist table using owner identifier for OWNER_ID and golf course identifier for GOLF_COURSE_ID. If the request handler retrieves last wait sequence, then the request handler would set new wait sequence by incrementing the last wait sequence by 1, otherwise the request handler would set new wait sequence as 1. The new wait sequence would also be referred to as current player's wait sequence. Then the request handler would insert a new row in golf course waitlist table using owner identifier for OWNER_ID, golf course identifier for GOLF_COURSE_ID, current player's wait sequence for WAIT_SEQ, ‘W’ for WAIT_STATUS, current player identifier type for GOLF_PLAYER_ID_TYPE, current player identifier for GOLF_PLAYER_ID, captured party size for PARTY_SIZE, authorization code received from payment processor for AUTH_CODE, calculated authorize amount for AUTH AMOUNT, 0 for CHARGED_AMOUNT, blank for CART_BAG_ID, blank for ORDER_STATION_ID, 0 for PAID_AMOUNT, current server date for DATE and current server time for TIME. If the request handler inserts the new row in golf course waitlist table, then the process will continue, otherwise it will be terminated.

If current player is unknown player, then the request handler process will save the values of current player identifier, current player identifier type, current player identifier name, current player business name and current player employee title as CURRENT_CUSTOMER_TYPE cookie, CURRENT_CUSTOMER_ID cookie and CURRENT_CUSTOMER_NAME cookie CURRENT_CUSTOMER_BUSINESS_NAME cookie and CURRENT_CUSTOMER_EMPLOYEE_TITLE cookie respectively in the current browser and request handler process will continue, otherwise the request handler process will delete the cookies CURRENT_CUSTOMER_TYPE cookie, CURRENT_CUSTOMER_ID cookie, CURRENT_CUSTOMER_NAME cookie, CURRENT_CUSTOMER_BUSINESS_NAME cookie, and CURRENT_CUSTOMER_EMPLOYEE_TITLE cookie and the request handler process will be terminated.

Upon adding the new row in golf course waitlist table for current player, the intermediary agent would also setup a communication gateway for the said current players to communicate with employee clients through text and or video. Player clients can communicate using the app provided by the intermediary agent or any app interfaced with intermediary agent whereas unknown clients can communicate using a browser. The employee clients can communicate using an app and/or a browser. If the intermediary agent cannot setup a communication gateway for video communication, then the employee client would use an external communication channel and share the external communication channel credentials with the current player through the communication gateway setup by the intermediary agent. At any event, the current players can communicate with employee clients and also fellow current players in the golf course where OWNER_ID is equal to owner identifier and GOLF_COURSE_ID is equal to golf course identifier.

Then the request handler process would load a web page referred to as MOBILE_MENU_PAGE hosted by intermediary agent into the in-app browser of current player's mobile device or into the web browser of the unknown player's mobile device and the request handler process will end.

Then current customer can continue and communicate with the restaurant owner, employee clients and fellow customers as described in MOBILE_MENU_PAGE. The fellow customers can also simultaneously continue and transact with employee clients as described in MOBILE_MENU_PAGE.

### Player_Cart_Assignment_Process:

Upon signing-in, current player can get assignment of any golf cart or golf bag by scanning a golf cart or golf bag identifier QR Code displayed on golf carts or golf bags, if the current player has not been assigned with a golf cart or golf bag. To assign a golf cart to a current player, the request handler process will confirm that the current player is signed-in, will verify that the golf cart identifier is valid and has not been assigned to any player.

Upon signing-in, if the current player has already been assigned with a golf cart golf bag identifier and if the current player has already teed off from tee-box number one, then request handler process can accept an order from current player that can be delivered to the golf cart identified by the golf cart identifier or a golf bag identified by the golf bag identifier.

When PLAYER_CART_ASSIGNMENT_PROCESS is executed, the request handler process will have the values for application identifier, owner identifier, golf course identifier, golf cart identifier, current player identifier and current player identifier type. If the application identifier is 157, the request handler process will continue, otherwise it will be terminated. Then the request handler would validate the golf cart identifier in the golf course cart/bag table using owner identifier for OWNER_ID, golf course identifier for GOLF_COURSE_ID, golf cart identifier for CART_BAG_ID and ‘C’ for CART_BAG_TYPE. If the request handler verifies that golf cart identifier exists in golf course cart/bag table, then the process will continue otherwise it will be terminated. This will confirm that the golf cart identifier is valid.

The request handler would retrieve the first row searching LOG_SEQ in a descending order from golf course log table where OWNER_ID is equal to owner identifier, GOLF_COURSE_ID is equal to golf course identifier, LOG_STATUS is equal to ‘A’, GOLF_PLAYER_ID is equal to current player identifier and GOLF_PLAYER_ID_TYPE is equal to current player identifier type. If the request handler process retrieves one row, then the process will continue, otherwise it will be terminated. This will confirm that the current player is signed in.

The request handler would retrieve the first row searching WAIT_SEQ in a descending order from golf course waitlist table where OWNER_ID is equal to owner identifier, GOLF_COURSE_ID is equal to golf course identifier, GOLF_PLAYER_ID_TYPE is equal to current player identifier type and GOLF_PLAYER_ID is equal to current player identifier. If the request handler process retrieves a row the process will continue, otherwise it will be terminated. Then the request handler would save WAIT_SEQ, WAIT_STATUS and CART_BAG_ID from the retrieved row as database wait sequence, database wait status and database cart bag identifier respectively. If database wait status is equal to ‘I’, request handler process will terminate, otherwise request handler process will continue. This will confirm that the current player's wait status is not inactive.

If database cart bag identifier is blank, then the request handler process would assign the golf cart identifier to the current player. This will confirm that a golf cart identifier has not been assigned to the current player. To assign the golf cart identifier to the current player, the request handler process would confirm that the golf cart identifier has not been assigned and then update the row in golf course waitlist table. The request handler would retrieve the first row searching WAIT_SEQ in a descending order from golf course waitlist table where OWNER_ID is equal to owner identifier, GOLF_COURSE_ID is equal to golf course identifier, and CART_BAG_ID is equal to golf cart identifier. If the request handler process retrieves a row from golf course waitlist table and if the value of WAIT_STATUS in the retrieved row is not ‘I’, then the request handler process will terminate. This will confirm that a golf cart identifier will not be assigned to more than one current player. If the request handler process continues, then the request handler process would update the golf course waitlist table by setting the value of CART_BAG_ID to golf cart identifier where OWNER_ID is equal to owner identifier, GOLF_COURSE_ID is equal to golf course identifier and WAIT_SEQ is equal to database wait sequence. If the golf course waitlist table update is successful, then the request handler process will be directed to MOBILE_MENU_PAGE and the request handler process will display a successful message on the MOBILE_MENU_PAGE.

If database cart bag identifier is equal to golf cart identifier, then the request handler process will continue, otherwise the request handler process will be terminated.

If the request handler process continues and if the database wait status is not equal to ‘P’, then the request handler process will be terminated. This will confirm that the current player has already been assigned with the golf cart identifier, the current player is playing and has teed off from tee-box number one.

If the request handler process continues, then the request handler process will be directed to MOBILE_MENU_PAGE to accept an order from the current player that can be delivered to the cart displaying the golf cart identifier and the request handler process will display a successful message on the MOBILE_MENU-PAGE.

If request handler process is terminated during the execution of PLAYER_CART_ASSIGNMENT_PROCESS, the request handler process will save a blank for golf cart identifier and will be directed to MOBILE_MENU_PAGE and the request handler process will display an error message on the MOBILE-MENU_PAGE.

### Player_Bag_Assignment_Process:

Upon signing-in, current player can get assignment of any golf cart or golf bag by scanning a golf cart or golf bag identifier QR Code displayed on golf carts or golf bags, if the current player has not been assigned with a golf cart or golf bag. To assign a golf bag to a current player, the request handler process will confirm that the current player is signed-in, will verify that the golf bag identifier is valid and has not been assigned to any player.

Upon signing-in, if the current player has already been assigned with a golf cart or golf bag identifier and if the current player has already teed off from tee-box number one, then request handler process can accept an order from current player that can be delivered to the golf cart identified by the golf cart identifier, or a golf bag identified by the golf bag identifier.

When PLAYER_BAG_ASSIGNMENT_PROCESS is executed, the request handler process will have the values for application identifier, owner identifier, golf course identifier, golf bag identifier. current player identifier and current player identifier type. If the application identifier is 167, the request handler process will continue, otherwise it will be terminated. Then the request handler would validate golf bag identifier using golf course cart/bag table using owner identifier for OWNER_ID, golf course identifier for GOLF_COURSE_ID, golf bag identifier for CART_BAG_ID and ‘B’ for CART_BAG_TYPE. If the request handler verifies that golf bag identifier exists in golf course cart/bag table, then the process will continue otherwise it will be terminated. This will confirm that the golf bag identifier is valid.

The request handler would retrieve the first row searching LOG_SEQ in a descending order from golf course log table where OWNER_ID is equal to owner identifier, GOLF_COURSE_ID is equal to golf course identifier, LOG_STATUS is equal to ‘A’, GOLF_PLAYER_ID is equal to current player identifier and GOLF_PLAYER_ID_TYPE is equal to current player identifier type. If the request handler process retrieves one row, then the process will continue, otherwise it will be terminated. This will confirm that the current player is signed in.

The request handler would retrieve the first row searching WAIT_SEQ in a descending order from golf course waitlist table where OWNER_ID is equal to owner identifier, GOLF_COURSE_ID is equal to golf course identifier, GOLF_PLAYER_ID_TYPE is equal to current player identifier type and GOLF_PLAYER_ID is equal to current player identifier. If the request handler process retrieves a row the process will continue, otherwise it will be terminated. Then the request handler would save WAIT_SEQ, WAIT_STATUS and CART_BAG_ID from the retrieved row as database wait sequence, database wait status and database cart bag identifier respectively. If database wait status is equal to ‘I’, request handler process will terminate, otherwise request handler process will continue. This will confirm that the current player's wait status is not inactive.

If database cart bag identifier is blank, then the request handler process would assign the golf bag identifier to the current player. This will confirm that a golf bag identifier has not been assigned to the current player. To assign the golf bag identifier to the current player, the request handler process would confirm that the golf bag identifier has not been assigned and then update the row in golf course waitlist table. The request handler would retrieve the first row searching WAIT_SEQ in a descending order from golf course waitlist table where OWNER_ID is equal to owner identifier, GOLF_COURSE_ID is equal to golf course identifier, and CART_BAG_ID is equal to golf bag identifier. If the request handler process retrieves a row from golf course waitlist table and if the value of WAIT_STATUS in the retrieved row is not ‘I’, then the request handler process will terminate. This will confirm that a golf bag identifier will not be assigned to more than one current player. If the request handler process continues, then the request handler process would update the golf course waitlist table by setting the value of CART_BAG_ID to golf bag identifier where OWNER_ID is equal to owner identifier, GOLF_COURSE_ID is equal to golf course identifier and WAIT_SEQ is equal to database wait sequence. If the golf course waitlist table update is successful, then the request handler process will be directed to MOBILE_MENU_PAGE and the request handler process will display a successful message on the MOBILE_MENU_PAGE.

If database cart bag identifier is equal to golf bag identifier, then the request handler process will continue, otherwise the request handler process will be terminated. If the request handler process continues and if the database wait status is not equal to ‘P’, then the request handler process will be terminated. This will confirm that the current player has already been assigned with the golf bag identifier, the current player is playing and has teed off from tee-box number one.

If the request handler process continues, then the request handler process will be directed to MOBILE_MENU_PAGE to accept an order from the current player that can be delivered to the golf bag displaying the golf bag identifier and the request handler process will display a successful message on the MOBILE_MENU_PAGE.

If the request handler process is terminated during the execution of PLAYER_CART_ASSIGNMENT_PROCESS, the request handler process will save blank for golf bag identifier and will be directed to MOBILE_MENU_PAGE and the request handler process will display an error message on the MOBILE_MENU_PAGE.

### Player_Order_Process:

Upon signing-in, current player can place an order from an ordering station before teeing off from tee-box number one or after entering the score for last hole or after leaving the game.

To accept an order from an ordering station from a current player, the request handler process will confirm that the current player is signed-in, will verify that the current player has not teed off from tee-box number one or will verify that the current player has already completed playing the golf.

When PLAYER_ORDER_PROCESS is executed, the request handler process will have the values for application identifier, owner identifier, golf course identifier and ordering station identifier. If the application identifier is 97, the request handler process will continue, otherwise it will be terminated. Then the request handler would validate ordering station identifier using golf course order station table using owner identifier for OWNER_ID, golf course identifier for GOLF_COURSE_ID and ordering station identifier for ORDER_STATION_ID. If the request handler verifies that ordering station identifier exists in golf course order station table, then the process will continue otherwise it will be terminated. This will confirm that the ordering station identifier is valid.

The request handler process would confirm that an active log does exist currently in golf course log table for the current player. The request handler would retrieve the first row searching LOG_SEQ in a descending order from golf course log table where OWNER_ID is equal to owner identifier, GOLF_COURSE_ID is equal to golf course identifier, LOG_STATUS is equal to ‘A’, GOLF_PLAYER_ID is equal to current player identifier and GOLF_PLAYER_ID_TYPE is equal to current player identifier type. If the request handler process retrieves one row, then the process will continue, otherwise it will be terminated. This will confirm that the current player is signed in.

The request handler would retrieve the first row searching WAIT_SEQ in a descending order from golf course waitlist table where OWNER_ID is equal to owner identifier, GOLF_COURSE_ID is equal to golf course identifier, GOLF_PLAYER_ID_TYPE is equal to current player identifier type and GOLF_PLAYER_ID is equal to current player identifier. If the request handler process retrieves a row the process will continue, otherwise it will be terminated. Then the request handler would save WAIT_SEQ, WAIT_STATUS and CART_BAG_ID from the retrieved row as database wait sequence, database wait status and database cart bag identifier respectively. If database wait status is equal to ‘W’ or ‘C’, the request handler process will continue, otherwise request handler process will terminate. This will confirm that the current player is waiting to tee off from tee box number one or the current player has completed playing golf.

If the request handler process continues, the request handler process will be directed to MOBILE_MENU_PAGE to accept an order from the current player that can be delivered to the ordering station displaying the ordering station identifier and the request handler process will display a successful message on the MOBILE_MENU_PAGE.

If the request handler process is terminated during the execution of PLAYER_CART_ASSIGNMENT_PROCESS, the request handler process will save blank for ordering station identifier and will be directed to MOBILE_MENU_PAGE and the request handler process will display an error message on the MOBILE_MENU_PAGE.

### Player_Sign-Out_Process:

When PLAYER_SIGN-OUT_PROCESS is executed, the request handler process will have the values for application identifier, owner identifier and golf course identifier. If the application identifier is 87, the request handler process will continue, otherwise it will be terminated.

If the current player identifier type is an unknown customer, then the request handler process would confirm that cookies exist in the current browser for the current customer. It the CURRENT_CUSTOMER_TYPE cookie is equal to current customer type, CURRENT_CUSTOMER_ID cookie is equal to current customer identifier, CURRENT_CUSTOMER_NAME cookie is equal to current customer name CURRENT_CUSTOMER_BUSINESS_NAME cookie is equal to current customer business name, and CURRENT_CUSTOMER_EMPLOYEE_TITLE cookie is equal to current customer employee title then request handler process would continue, otherwise it will terminate.

The request handler process would confirm that an active log does exist currently in golf course log table for the current player. The request handler would retrieve the first row searching LOG_SEQ in a descending order from golf course log table where OWNER_ID is equal to owner identifier, GOLF_COURSE_ID is equal to golf course identifier, LOG_STATUS is equal to ‘A’, GOLF_PLAYER_ID is equal to current player identifier and GOLF_PLAYER_ID_TYPE is equal to current player identifier type. If the request handler process retrieves one row, then the request handler process will save the value for LOG_SEQ from the retrieved row as database log sequence and continue, otherwise it will be terminated. This will confirm that the current player is signed in.

Then the request handler would retrieve the first row searching WAIT_SEQ in a descending order from golf course waitlist table where OWNER_ID is equal to owner identifier, GOLF_COURSE_ID is equal to golf course identifier, GOLF_PLAYER_ID_TYPE is equal to current player identifier type and GOLF_PLAYER_ID is equal to current player identifier. If the request handler process retrieves a row the process will continue, otherwise it will be terminated. Then the request handler would save WAIT_SEQ, WAIT_STATUS, AUTH_AMOUNT and CHARGED_AMOUNT from the retrieved row as database wait sequence, database wait status, database authorized amount and database charged amount respectively. If database wait status is equal to ‘W’ or ‘C’, the request handler process will continue, otherwise request handler process will terminate. This will confirm that the current player is waiting to tee off from tee box number one or the current player has completed playing golf.

If the database authorized amount is greater than the database charged amount, then the request handler process would capture a tip amount where the database charged amount plus the captured amount does not exceed the authorized amount, otherwise the request handler process would save 0 for captured tip amount. Then the request handler process would get a confirmation to sign-out from player client or unknown player, calculate database charged amount plus captured tip amount as final amount, submit a request to payment processor to capture the final amount from the database authorized amount, update PAID_AMOUNT and WAIT_STATUS in golf course waitlist table appropriately.

Then the request handler process will update the retrieved row in golf course waitlist table by setting ‘I’ for WAIT_STATUS, final amount for PAID_AMOUNT, current server date for DATE and current server time for TIME using owner identifier for OWNER_ID, golf course identifier for GOLF_COURSE_ID and database wait sequence for WAIT_SEQ.

Then the request handler process will update a row in golf course log table by setting ‘I’ for LOG_STATUS, current server date for DATE and current server time for TIME using owner identifier for OWNER_ID, golf course identifier for GOLF_COURSE_ID and database log sequence for LOG_SEQ.

If the intermediary agent can update a row in golf course log table and a row golf course waitlist table, then the intermediary agent would display a successful message and stop the process, otherwise the intermediary agent would terminate the process.

### Mobile_Menu_Page:

When MOBILE_MENU_PAGE is executed, the request handler process will have the values for application identifier, owner identifier, golf course identifier, current player identifier and current player identifier type. The request handler process may also have value for a success message or value for an error message. The request handler process may also have value for golf cart identifier. The request handler process may also have value for golf bag identifier. The request handler process may also have value for order station identifier.

The MOBILE_MENU_PAGE will be accessible from current player's mobile device from the time the current player is signed in and until the current player signs out.

The MOBILE_MENU_PAGE will refresh itself at a preset interval to process and display the most rennet data from the golf course database. The MOBILE_MENU_PAGE can also be refreshed by current player by tapping on a refresh button in the MOBILE_MENU_PAGE.

The request handler process would confirm that an active log does exist currently in golf course log table for the current player. The request handler would retrieve a row from golf course log table using owner identifier for OWNER_ID, golf course identifier for GOLF_COURSE_ID, ‘A’ for LOG_STATUS, current player identifier type for GOLF_PLAYER_ID_TYPE and current player identifier for GOLF_PLAYER_ID. If the request handler process can retrieve one row, then the request handler process will continue, otherwise the request handler process will display an error message and will be terminated.

Then the request handler process would confirm that WAIT_STATUS of the current player in golf course waitlist table is active, The request handler process would retrieve the first row searching WAIT_SEQ in a descending order from golf course waitlist table where OWNER_ID is equal to owner identifier, GOLF_COURSE_ID is equal to golf course identifier, GOLF_PLAYER_ID_TYPE is equal to current player identifier type and GOLF_PLAYER_ID is equal to current player identifier. If the request handler process retrieves a row and if the value of WAIT_STATUS in the retrieved row is not ‘I’, then the request handler would save WAIT_SEQ, PARTY_SIZE, WAIT_STATUS, CART_BAG_ID, AUTH_AMOUNT and CHARGED_AMOUNT from the retrieved row as database wait sequence, database party size, database wait status, database cart bag identifier, database authorized amount and database charged amount respectively, otherwise the request handler process will display an error message and request handler process be terminated. This will confirm that the current player's wait status is not inactive.

Then the request handler process will validate golf card identifier, golf bag identifier and order station identifier, if required.

Then the request handler process will process an order, if required. The request handler process would save ‘N’ for golf cart order menu, ‘N’ for golf bag order menu and ‘N’ for station order menu.

If the value for golf card identifier exists and is not blank, then the request handler process would save ‘Y’ for golf cart order menu. If the value for golf bag identifier exists and is not blank, then the request handler process would save ‘Y’ for golf bag order menu. If the value for ordering station identifier exists and is not blank, then the request handler process would save ‘Y’ for station order menu, otherwise the request handler process would save a blank for ordering station identifier.

If golf cart order menu is equal to ‘Y’ and if golf card identifier is not equal to database cart bag identifier, then the request handler process would save an error message and save ‘N’ to golf cart order menu. If golf bag order menu is equal to ‘Y’ and if golf bag identifier is not equal to database cart bag identifier, then the request handler process would save an error message and save ‘N’ to golf bag order menu. If station order menu is equal to ‘Y’, then the request handler process would retrieve a row from golf course order station table where OWNER_ID is equal to owner identifier, GOLF_COURSE_ID is equal to golf course identifier and ORDER_STATION_ID is equal to ordering station identifier. If the request handler process cannot retrieve a row from golf course order station table, then the request handler process would save an error message and save ‘N’ to station order menu.

If golf cart order menu is ‘Y’ or golf bag order menu is ‘Y’ or station order menu is ‘Y’, then the request handler process would save ‘Y’ for order menu, otherwise the request handler process would save ‘N’ for order menu.

If the authorized amount is greater than the charged amount, then the request handler process would save authorized amount minus charged amount as available amount, otherwise the request handler process would save 0 for available amount. If order menu is ‘Y’ and if the available amount is 0 then the request handler process would save an error message and save ‘N’ for order menu.

If the value of order menu is ‘Y’, then request handler process would interface with any ordering system to place an order. The request handler process would send current player identifier, current player identifier type and available amount to the ordering system and would receive order number and order amount in response. If the ordering system accepts an order, then the request handler process would receive an order number that is greater than 0 and an order amount that is greater than 0, otherwise the request handler process would receive 0 as an order number and 0 as an order amount. The ordering system would accept an order only if the order amount is less than or equal to the available amount.

If the value of order menu is ‘Y, if the order number is greater than zero and if the order amount is greater than zero then the request handler would add the order amount to CHARGED_AMOUNT and set ORDER_STATION_ID to ordering station identifier in golf course waitlist table and insert the order number as ORDER_SEQ in golf course order status table. The ordering station identifier will be blank, if the order is not placed from an ordering station. The request handler would set CHARGED_AMOUNT to CHARGED_AMOUNT plus order amount and set ORDER_STATION_ID to ordering station identifier in golf course waitlist table where OWNER_ID is equal to owner identifier, GOLF_COURSE_ID is equal to golf course identifier, WAIT_SEQ is equal to database wait sequence. Then the request handler would insert a row in golf course order status table using owner identifier for OWNER_ID, golf course identifier for GOLF_COURSE_ID, server date for ORDER_DATE, server time for ORDER_TIME, order number for ORDER_SEQ, ‘O’ for ORDER_STATUS, server date for STATUS_DATE, server time for STATUS_TIME, blank for PICKUP_STATION_ID, blank for LOCKER NUMBER, blank for ONE_TIME_CODE, current player identifier type for GOLF_PLAYER_ID_TYPE and current player identifier for GOLF_PLAYER_ID. If the request handler process adds the order amount to CHARGED_AMOUNT and inserts the order number as ORDER_SEQ, then the request handler process would save a success message, otherwise the request handler process would save an error message. An example of a success message could be ‘Order has been processed successfully’ and an example of an error message could be ‘Unable to process the order’.

If an error message is available and not blank or if a success message is available and not blank then the request handler process would display error, or success message on a pop-up window with a close button. The current player would tap on the close button to close the pop-up window.

Then the request handler would save blanks for golf card identifier, golf bag identifier and ordering station identifier to prevent an order being processed more than once when the MOBILE_MENU_PAGE is refreshed again. Then the request handler would also save blanks for success message and error message to prevent the same message is displayed more than once.

The request handler process would have at least Order Status and Play Status sections in the MOBILE_MENU_PAGE as shown in FIG. 25G, The current order status message and the current play status message will be displayed in Order Status section and Play Status section respectively. The request handler process would also have Score Entry Web Form as shown in FIG. 25G, if a score entry from the current player is required.

To compose current order status message, the request handler process would set a blank for current order status message and use the information from golf course waitlist table, golf course cart/bag table and golf course order status table.

Then the request handler process would retrieve the first row searching WAIT_SEQ in a descending order from golf course waitlist table where OWNER_ID is equal to owner identifier, GOLF_COURSE_ID is equal to golf course identifier, GOLF_PLAYER_ID_TYPE is equal to current player identifier type and GOLF_PLAYER_ID is equal to current player identifier. If the request handler process retrieves a row and if the value of WAIT_STATUS in the retrieved row is not ‘I’, then the request handler would save WAIT_SEQ, PARTY_SIZE, WAIT_STATUS, CART_BAG_ID and ORDER_STATION_ID from the retrieved row as database wait sequence, database party size, database wait status, database cart bag identifier and database order station identifier respectively, otherwise the request handler process will display an error message and request handler process be terminated.

Then the request handler process would retrieve a row from golf course cart/bag table where OWNER_ID is equal to owner identifier, GOLF_COURSE_ID is equal to golf course identifier and CART_BAG_ID is equal to database cart bag identifier. If the request handler process retrieves a row then the request handler process will save the value of CART_BAG_TYPE as database cart bag type, otherwise the request handler process will display an error message and request handler process be terminated.

Then the request handler process would retrieve the first row searching SERVER_DATE and SERVER_TIME in a descending order from golf course order status table where OWNER_ID is equal to owner identifier, GOLF_COURSE_ID is equal to golf course identifier, GOLF_PLAYER_ID is equal to current player identifier and GOLF_PLAYER_ID_TYPE is equal to current player identifier type ORDER BY SERVER_DATE DESC, SERVER_TIME DESC. If the request handler process retrieves a row and if the value of ORDER STATUS in the retrieved row is ‘O’ or ‘L’, then the request handler save process will the values of ORDER STATUS. PICKUP_STATION_ID, LOCKER_NUMBER and ONE_TIME_CODE as database order status, database pickup station identifier, database locker number and database one time code respectively, otherwise the request handler process will save blank values for database order status, database pickup station identifier, database locker number and database one time code.

If database order status is equal to ‘O’ and if the database order station identifier is blank and if the database cart bag type is ‘C’, then the current player would have placed an order to be delivered to a location in the golf course where current player's golf cart can be located.

If database order status is equal to ‘O’ and if the database order station identifier is blank and if the database cart bag type is ‘B’, then the current player would have placed an order to be delivered to a location in the golf course where current player's golf bag can be located.

If database order status is equal to ‘O’ and if the database order station identifier is not blank, then the current player would have placed an order to be delivered to a locker near ordering station.

If database order status is equal to ‘O’ and if the database wait status ‘P’ and if the database cart bag type is ‘C’, then the request handler process would save a message for current order status message indicating that the pending order will be delivered to the current player's golf cart. For example, the message “Your order is being processed and will be delivered to your golf cart” could be saved as current order status message.

If database order status is equal to ‘O’ and if the database wait status ‘P’ and if the database cart bag type is ‘B’, then the request handler process would save a message for current order status message indicating that the pending order will be delivered at a location near current player's golf bag is found. For example, the message “Your order is being processed and will be delivered to you at a location where your golf bag can be found” could be saved as current order status message.

If database order status is equal to ‘O’ and if the database wait status ‘W’ or ‘C’ and if the database order station identifier is not blank, then the request handler process would save a message for current order status message indicating that the pending order will be delivered to a locker placed at the ordering station. For example, the message “Your order is being processed and will be placed in a locker at the ordering station where the order was placed” could be saved as current order status message.

If database order status is equal to ‘O’ and if the database wait status ‘W’ or ‘C’ and if the database order station identifier is blank, then the request handler process would save a message for current order status message indicating that the pending order will be delivered to a locker placed at an ordering station which is also referred to as order pick up station. For example, the message “Your order is being processed and will be placed in a locker at an ordering station” could be saved as current order status message.

If database order status is equal to ‘L’, then the order has been delivered to a locker in an ordering station and the request handler process would save a message for current order status message indicating that the order has been delivered to a locker near an ordering station. For example, the message “Your order has been delivered to a locker near order an ordering station” could be saved as current order status message. The current order status message would also include the database pickup station identifier and database locker number.

If current order status message is blank and if the database wait status is ‘P’ and if the database cart bag type is ‘C’, then the request handler process would save a message indicating that the current player can place an order while playing golf by scanning the QR Code displayed on current player's golf cart. For example, the message “Orders can be placed by scanning the QR Code displayed on the golf cart” could be saved as current order status message.

If current order status message is blank and if the database wait status is ‘P’ and if the database cart bag type is ‘B’, then the request handler process would save a message indicating that the current player can place an order while playing golf by scanning the QR Code displayed on current player's golf bag. For example, the message “Orders can be placed by scanning the QR Code displayed on the golf bag” could be saved as current order status message.

If current order status message is blank and if the database wait status is ‘W’ or ‘C’, then the request handler process would save a message indicating that the current player can place an order while not playing golf by scanning the QR Code displayed at the ordering station. For example, the message “Orders can be placed by scanning the QR Code displayed at an ordering station” could be saved as current order status message.

Then the request handler process would display current order status message under Order Status section.

Upon knowing that an order is in a specific locker in a specific database order station identifier (also referred to as database order pick-up identifier), the current player would use a one-time code or scan the QR Code displayed on the locker using a fingerprint and pick-up the order.

To compose current play status message, the request handler process would set a blank for current play status message and use the information from golf course waitlist table, golf course score card table, golf course score table and golf course team table.

Then the request handler process would retrieve the first row searching WAIT_SEQ in a descending order from golf course waitlist table where OWNER_ID is equal to owner identifier, GOLF_COURSE_ID is equal to golf course identifier, GOLF_PLAYER_ID_TYPE is equal to current player identifier type and GOLF_PLAYER_ID is equal to current player identifier. If the request handler process retrieves a row and if the value of WAIT_STATUS in the retrieved row is not ‘I’, then the request handler would save WAIT_SEQ, PARTY_SIZE, WAIT_STATUS from the retrieved row as database wait sequence, database party size and database wait status respectively, otherwise the request handler process will display an error message and request handler process be terminated.

Then the request handler process would retrieve a row from golf course score card table for each member in the database party size starting from 0 for PARTY_MEMBER_ID and ending with database party size minus 1 for PARTY_MEMBER_ID to get score card identifier for each member in the database party size. For the primary member in the party, a value of 0 will be assigned to PARTY_MEMBER_ID. For additional members in the party a value of 1 or more will be assigned to PARTY_MEMBER_ID. Primary member is the player responsible for the payment and will be considered as the leader of the party. For example, for a database party size of 3 the starting party number will be 0 and the ending party number will be 2. The score card identifier for party number 0, party number 1 and party number 2 will be score card identifier zero, score card identifier one and score card identifier two respectively. For example, the SQL statement used to get score card identifier zero for party number 0 will be retrieving a row from golf course score card table using owner identifier for OWNER_ID, golf course identifier for GOLF_COURSE_ID, database wait sequence for WAIT_SEQ, current player identifier for GOLF_PLAYER_ID, current player identifier type for GOLF_PLAYER_ID_TYPE and 0 for PARTY_MEMBER_ID. If the request handler process retrieves one row from golf course score card table for each member in the party, then score card identifier zero, score card identifier one and score card identifier two will be the value of SCORE_CARD_ID from the retrieved row for PARTY_MEMBER_ID is 0, PARTY MEMBER ID is 1 and PARTY_MEMBER_ID is 2 respectively, otherwise blank values for score card identifier zero, score card identifier one and score card identifier two will be saved.

If the database wait status is ‘W’ and if the score card identifier zero is blank, then the current player is waiting to get permission from the employee to tee off from tee off station 0. Note that score cards will be assigned to each member in the party by the employee when it is safe for the current player to tee off from tee off station 0.

If the database wait status is ‘W’ and if the score card identifier zero is not blank, then the current player has received the permission from the employee to tee off from tee off station 0 and in the process of teeing off from tee off station 0. Note that score cards will be assigned to each member in the party by the employee when it is safe for the current player to tee off from tee off station 0.

If the database wait status is ‘W’ and if the score card identifier zero is blank, then the request handler process would save the message ‘Please wait to get the permission to tee off from tee off station 0. Watch the display monitor at the tee off station 0 to view the permission status.’ for current play status message.

If the database wait status is ‘W’ and if the score card identifier zero is not blank, then the request handler process would save the message ‘Permission has been granted to tee off from tee off station 0. Please enter 0 as score for hole identifier 0 for each member in the party and tee off from tee off station 0.’ for current play status message.

If the database wait status is ‘P’, then the request handler process would retrieve the most recent hole identifier and score for each score card identifier in the party from the golf course score table. The most recent hole identifier for score card identifier zero, score card identifier one and score card identifier two would be hole identifier zero, hole identifier one and hole identifier two respectively. The score for the most recent hole identifier for score card identifier zero, score card identifier one and score card identifier two would be score zero, score one and score two respectively. For example, to get hole identifier zero and score zero for score card identifier zero, the request handler process would retrieve the first row searching HOLE_ID in a descending order from golf course score table where OWNER_ID is equal to owner identifier, GOLF_COURSE_ID is equal to golf course identifier, SCORE_CARD_ID is equal to score card identifier zero ORDER BY HOLE_ID DESC. If the request handler process retrieves a row, then the request handler process would save the value of HOLE_ID and SCORE as hole identifier zero and score zero respectively, otherwise the request handler process would display an error message and terminate.

If the database wait status is ‘P’ then the request handler process would determine whether the fair way is clear for the current player and the party to continue playing and also would determine whether the current player and the party are holding up any fellow player or fellow players. To determine whether the fair way is clear and whether the current player and the party are holding up any fellow player or fellow players, the request handler process would verify that the most recent completed hole identifier by any fellow player is same as the most recent completed hole identifier of the current player and the date and time of the score entry by the fellow player is prior to the date and time of score entry by the current player or the date and time of the score entry by the fellow player is later than the date and time of score entry by the current player. The request handler process would save ‘N’ to fellow player indicating there are no fellow player or players at the same hole identifier as the hole identifier of the current player of the party. Then the request handler process would retrieve a single row from golf course score table using owner identifier for OWNER_ID, golf course identifier for GOLF_COURSE_ID, SCORE_CARD_ID is not equal to score card identifier zero, SCORE_CARD_ID is not equal to score card identifier one, SCORE_CARD_ID is not equal to score card identifier two, HOLE_ID is equal to (maximum of (HOLE_ID) for the same OWNER_ID, GOLF_COURSE_ID and SCORE_CARD_ID) and HOLE_ID is equal to hole identifier zero ORDER BY SCORE_CARD_ID DESC. If the request handler process retrieves one row from golf course score table and if the DATE+TIME of the retrieved row is prior than the date plus time of the current player score card, then the request handler process would save ‘L’ for fellow player indicating that a fellow player is leading the current player and the party. If the request handler process retrieves one row from golf course score table and if the DATE+TIME of the retrieved row is later than the date plus time of the current player score card, then the request handler process would save ‘F’ for fellow player indicating that a fellow player is following the current player and the party. If the value of fellow player is ‘L’, then the request handler process would include a text ‘Please be aware that a fellow player playing ahead of you might not have cleared the fair way’ to the current play status message. If the value of fellow player is ‘F’, then the request handler process would include a text ‘Please be aware that you may be holding up one or more fellow players’ to the current play status message.

If the current player or any member in the party participates in a team, then the request handler process would also include the team player information and the up to date score. To get the team score information, the request handler process would retrieve the rows from golf course team table to get team score card identifier and then the request handler process would retrieve the rows from golf course score table for each team score card identifier to get team hole identifier and team score. Then the request handler process would include the current player identifier, party member identifier, team score card identifier, team hole identifier and team score in the current play status message. For example, to get the team score card identifier for current player, the request handler process would retrieve rows from golf course team table using owner identifier for OWNER_ID, golf course identifier for GOLF_COURSE_ID, score card identifier zero for MY_SCORE_CARD_ID. If the request handler process retrieves any row, then the request handler process would save the value of OTHER SCORE CARD ID from the retrieved rows as team score card identifier. Then the request handler process would retrieve rows from golf course table using owner identifier for OWNER_ID, golf course identifier for GOLF_COURSE_ID, team score card identifier for SCORE_CARD_ID. If the request handler process retrieves any row, then the request handler process would save the value of HOLE ID and SCORE from the retrieved rows as team hole identifier and team score respectively. Then the request handler process would use party member identifier, team score card identifier, team hole identifier and team score to include the team message into current play status message.

Then the request handler process would display current order status message under Order Status section, current play status message under Play Status section as shown in FIG. 25B.

If the database wait status is ‘W’ and if the score card identifier zero is not blank, then the employee has given permission for the current player and the party to tee off from tee off station 0 and the request handler process would display the Score Entry section in MOBILE_MENU_PAGE as shown in FIG. 25G for the current player to enter 0 as score for hole number 0 for all the players in the party and tap on Submit button. Upon accepting and verifying the data, the request handler process would insert a row for each score card identifier in the current player party for hole number 0 with score 0. For example, for score card identifier zero, the request handler would insert a row in golf course score table using owner identifier for OWNER_ID, golf course identifier for GOLF_COURSE_ID, score card identifier zero for SCORE_CARD_ID, 0 for HOLE_ID, 0 for SCORE, current server date for DATE and current server time for TIME. Then the request handler process would update the golf course waitlist table by setting the value of WAIT_STATUS to ‘P’ where OWNER_ID is equal to owner identifier, GOLF_COURSE_ID is equal to golf course identifier and WAIT_SEQ is equal to database wait sequence. This would indicate the employee that the current player and the party has teed off from tee off station 0. Then the request handler process will refresh the MOBILE_MENU_PAGE.

If the database wait status is ‘P’, then the current player and the party will be playing the golf and will be given a chance to select a hole identifier and enter the score in the Score Entry section in MOBILE_MENU_PAGE as shown in FIG. 25G. Upon selecting a hole identifier and entering the score, the current player would tap on Submit button and the request handler process would process the request. Upon accepting and verifying the data, the request handler process would insert a row for each score card identifier in the current player party for a selected hole identifier. The valid hole identifier for the current player to select would be the next hole identifier on the way to the last hole identifier or the last hole identifier. To quit the golf game in the middle, the current player would select the last hole identifier and enter 0 as the score. To continue playing the golf game, current player would select the next hole identifier on the way to the last hole identifier. For example, for score card identifier zero, the request handler would insert a row in golf course score table using owner identifier for OWNER_ID, golf course identifier for GOLF_COURSE_ID, score card identifier zero for SCORE_CARD_ID, selected hole identifier for HOLE_ID, entered score for SCORE, current server date for DATE and current server time for TIME. If the current player has selected the last hole identifier, then the request handler process would update the golf course waitlist table by setting the value of WAIT_STATUS to ‘C’ where OWNER_ID is equal to owner identifier, GOLF_COURSE_ID is equal to golf course identifier and WAIT_SEQ is equal to database wait sequence. This would indicate for the employee that the player has completed playing golf. Then the request handler process will refresh the MOBILE_MENU_PAGE.

### Virtual Terminal:

Operator clients and employee clients can use an app provided by the intermediary agent or use any mobile device or desktop computer to access a virtual terminal login page hosted by the intermediary agent to log into a virtual terminal. If an app is used, the app at the time of loading has verified the mobile number of the device and saved the mobile number as mobile identifier in the app's database. If an app is used, the app at the time of loading would have captured the information whether the user is an owner or employee. If the user is an owner, then the app at the time of loading would have captured an owner identifier, verified owner identifier, saved ‘O’ as user type and saved user type and owner identifier in the app's database. If the user is an employee, then the app at the time of loading would have captured an owner identifier, captured a golf course identifier, captured an employee identifier, verified owner identifier, verified golf course identifier, verified employee identifier, saved ‘E’ as user type and saved user type, owner identifier, golf course identifier and employee identifier in the app's database.

Every time the app is accessed, the app would authenticate the user using fingerprint authentication or face id authentication. If the authentication is successful, then the app would continue, otherwise the app would terminate.

If the user type saved in the app's database is ‘O’, then upon authentication, the app would access an app login page hosted by the administration component and the app login page would receive the user type, mobile identifier and owner identifier from the app's database. If the user type is ‘O’, then the app login page would also capture a golf course identifier from the user. If the user type is ‘O’, then the app login page would retrieve one row from golf course location table using owner identifier for OWNER_ID and golf course identifier for GOLF_COURSE_ID. If the app login page can retrieve one row, then the app login page would continue, otherwise the app login page will display an error message and terminate. If the user type is ‘O’, then the app login page would retrieve one row from golf course owner table using owner identifier for OWNER_ID and mobile identifier for CONTACT_CELL. If the app login page can retrieve one row and if the value of LOGGED_YN in the retrieved row is ‘N’, then the app login page would update the golf course owner table by setting the value ‘Y’ for LOGGED_YN using owner identifier for OWNER_ID, otherwise the app login page will display an error message and terminate.

If the user type saved in the app's database is ‘E’, then upon authentication, the app would access an app login page hosted by the administration component and the app login page would receive the user type, mobile identifier, owner identifier, golf course identifier and employee identifier from the app's database. If the user type received by the app login page is ‘E’, then the app login page would retrieve one row from golf course employee table using owner identifier for OWNER_ID, golf course identifier for GOLF_COURSE_ID, employee identifier for EMPLOYEE_ID and mobile identifier for CONTACT_CELL. If the app login page can retrieve one row and if the value of LOGGED_YN in the retrieved row is ‘N’, then the app login page would update the golf course employee table by setting the value ‘Y’ for LOGGED_YN using owner identifier for OWNER_ID, golf course identifier for GOLF_COURSE_ID and employee identifier for EMPLOYEE_ID, otherwise the app login page will terminate.

If the virtual terminal login page hosted by the administration component to log into a virtual terminal is accessed from a mobile device or from a computer, the virtual terminal login page will capture user type, owner identifier, golf course identifier, employee identifier and cell phone number. If the user type is ‘O’, then the value for employee identifier can be left blank. The administration component upon receiving the captured information would verify the data and if the data is valid, it would send a one-time code to the captured cell phone number and provide an input option for the user to enter the one-time code sent to their cell phone number. If the administration component receives a one-time code from the user and if the one-time code the administration component received from the user is same as the one-time code the administration component sent to the user cell phone number, then the login process will continue, otherwise the administration component will display an error message and terminate.

If the user type is ‘O’, then the administration component would retrieve one row from golf course location table using owner identifier for OWNER_ID and golf course identifier for GOLF_COURSE_ID. If the administration component can retrieve one row, then the administration component would continue, otherwise the administration component will display an error message and terminate. If the user type ‘O’, then the administration component would retrieve one row from golf course owner table using owner identifier for OWNER_ID and mobile identifier for CONTACT_CELL. If the administration component can retrieve one row and if the value of LOGGED_YN in the retrieved row is ‘N’, then the administration component would update the golf course owner table by setting the value ‘Y’ for LOGGED_YN using owner identifier for OWNER_ID, otherwise the administration component will display an error message and terminate.

If the user type ‘E’, then the administration component would retrieve one row from golf course employee table using owner identifier for OWNER_ID, golf course identifier for GOLF_COURSE_ID, employee identifier for EMPLOYEE_ID and mobile identifier for CONTACT_CELL. If the administration component can retrieve one row and if the value of LOGGED_YN in the retrieved row is ‘N’, then the administration component would update the golf course employee table by setting the value ‘Y’ for LOGGED_YN using owner identifier for OWNER_ID, golf course identifier for GOLF_COURSE_ID and employee identifier for EMPLOYEE_ID, otherwise the administration component will display an error message and terminate.

The virtual terminal will save logged user type, owner identifier and golf course identifier of logged in operator clients and employee clients. In the case of employee clients, the employee identifier will also be saved.

Logged in operator clients and/or employee clients can log out using a log out web form provided by administration component and accessible in the virtual terminal. The log out web form would capture a log out confirmation from the operator clients and/or employee clients. Upon capturing the log out confirmation the log out web form would submit the request to administration component. In the case of operator clients, the administration component would receive user type, owner identifier from the virtual terminal and a request to log out from the user. In the case of employee clients, the administration component would receive user type, owner identifier, golf course identifier, employee identifier from virtual terminal and a request to log out from the user. In the case of operator clients, the administration component would retrieve one row from golf course owner table using owner identifier for OWNER_ID. If the administration component can retrieve one row and if the value of LOGGED_YN in the retrieved row is ‘Y’, then the administration component would continue, otherwise the administration component would display an error message and terminate. In the case of operator clients, the administration component would update a row in the golf course owner table using owner identifier for OWNER_ID and setting the value for LOGGED_YN to ‘N’. In the case of employee clients, the administration component would retrieve one row from golf course employee table using owner identifier for OWNER_ID, golf course identifier for GOLF_COURSE_ID, employee identifier for EMPLOYEE_ID and mobile identifier for CONTACT_CELL. If the administration component can retrieve one row and if the value of LOGGED_YN in the retrieved row is ‘Y’, then the administration component would continue, otherwise the administration component would display an error message and terminate. In the case of employee clients, the administration component would update a row in golf course employee table using owner identifier for OWNER_ID, golf course identifier for GOLF_COURSE_ID, employee identifier for EMPLOYEE_ID and setting the value for LOGGED_YN to ‘N’. Logged out operators and/or employees will not be able to use the virtual terminal options without logging in again.

Logged in owner clients and/or employee clients can use a virtual terminal web form provided by administration component to display all the relevant information about player clients, unknown players and their status in a waitlist displayed on one or more waitlist display monitors for player clients and unknown players to view. When operator clients and/or employee clients use virtual terminal web form to display information on one or more waitlist display monitors, then the virtual terminal web form would send ‘M’ and ‘W’ for display type and display content respectively along with other information to indicate that the request is to receive waitlist information for displaying on waitlist display monitors. The administration component, upon receiving the request to retrieve information for waitlist display, the administration component would retrieve relevant data from golf course waitlist table, golf course log table and golf course score card table. The administration component would retrieve data of all current players whose status in golf course waitlist table is ‘W’. Then the administration component would retrieve data from golf course log table for each row retrieved from golf course waitlist table to get the name and data from golf course score card table for each row retrieved from golf course waitlist table to get the score card identifier. Then the administration component would format the waitlist data based on the information retrieved from golf course waitlist table, golf course log table and golf course score card table. Then the administration component would refresh one or more waitlist display monitors as shown in FIG. 25H.

The administration component would retrieve all rows from golf course waitlist table using owner identifier for OWNER_ID, golf course identifier for GOLF_COURSE_ID, ‘W’ for WAIT_STATUS ORDER BY WAIT_SEQ DESC. Then the administration component for each retrieved row from golf course waitlist table would save the values of PARTY SIZE, GOLF_PLAYER_ID and GOLF_PLAYER_ID_TYPE as database party size, database golf player identifier and database golf player identifier type respectively. Then the administration component for each retrieved row from golf course waitlist table would retrieve one row from golf course log table using owner identifier for OWNER_ID, golf course identifier for GOLF_COURSE_ID, ‘A’ for LOG_STATUS, database golf player identifier for GOLF_PLAYER_ID and database golf player identifier type GOLF_PLAYER_ID_TYPE ORDER BY LOG_SEQ DESC. Then the administration component would save the values of WAIT_SEQ and GOLF_PLAYER_ID_NAME from the one row retrieved from golf course log table as database golf player wait sequence and database golf player name respectively. Then the administration component for each retrieved row from golf course waitlist table would retrieve one row from golf course score card table using owner identifier for OWNER_ID, golf course identifier for GOLF_COURSE_ID, database golf player wait sequence for WAIT_SEQ, database golf player identifier for GOLF_PLAYER_ID, database golf player identifier type GOLF_PLAYER_ID_TYPE and 0 for PARTY MEMBER ID. Since 0 is used for PARTY_MEMBER_ID only the primary member information will be retrieved from golf course score card table. If the administration component can retrieve one row from golf course score card table, then the administration component would save the value of SCORE_CARD_ID from the one row retrieved from course score card table as database golf player score card identifier, otherwise the administration component would save blank for database golf player score card identifier. Then the administration component would use the values of database golf player name and database golf player party size of each row retrieved from golf course waitlist table to populate the data on the waitlist display monitor. The administration component would use the value of database golf player name to populate the first column in the waitlist display monitors. The administration component would use the value of database golf player party size to populate the second column in the waitlist display monitors. Then the administration component would calculate an estimated wait time for each row retrieved from golf course waitlist table based on the date and time of each tee-off from tee box number 1 and use the estimated wait time to populate the third column in the waitlist display monitors. Then the administration component would use the text ‘Wait’ if the value of database golf player score card identifier is blank, otherwise the administration component would use the text ‘Play’ to populate the fourth column in the waitlist display monitors.

### Pro-Shop & Tee-Off Permission

When logged in operator clients and/or employee clients use virtual terminal web form to display all the relevant information pertaining to hole identifier, score and waitlist then the virtual terminal web form would send ‘D’ and ‘W’ for display type and display content respectively along with other information to indicate that the request is to display all the relevant information pertaining to hole identifier, score and waitlists on one or more dashboards dedicated for employees working as pro-shop employees who provide permission for current players to tee-off from tee box for hole number 1. The virtual terminal web form can be set up to send the request at periodic intervals to display the information on dashboard also take necessary actions.

The administration component, upon receiving the request to retrieve information from pro-shop employees providing permission for current players to tee-off from tee box for hole number 1, the administration component would retrieve relevant data from golf course waitlist table, golf course log table and golf course score card table. The administration component would retrieve data of all current players whose status in golf course waitlist table is ‘W’. Then the administration component would retrieve data from golf course log table for each row retrieved from golf course waitlist table to get the name and data from golf course score card table for each row retrieved from golf course waitlist table to get the score card identifier. Then the administration component would format the waitlist data based on the information retrieved from golf course waitlist table, golf course log table and golf course score card table. Then the administration component would refresh the dashboard as shown in FIG. 25H.

The administration component would retrieve all rows from golf course waitlist table using owner identifier for OWNER_ID, golf course identifier for GOLF_COURSE_ID, ‘W’ for WAIT_STATUS ORDER BY WAIT_SEQ DESC. Then the administration component for each retrieved row from golf course waitlist table would save the values of WAIT_SEQ, PARTY_SIZE, GOLF_PLAYER_ID and GOLF_PLAYER_ID_TYPE as database wait sequence, database party size, database golf player identifier and database golf player identifier type respectively. Then the administration component for each retrieved row from golf course waitlist table would retrieve one row from golf course log table using owner identifier for OWNER_ID, golf course identifier for GOLF_COURSE_ID, ‘A’ for LOG_STATUS, database golf player identifier for GOLF_PLAYER_ID and database golf player identifier type GOLF_PLAYER_ID_TYPE ORDER BY LOG_SEQ DESC. Then the administration component would save the value of GOLF_PLAYER_ID_NAME from the one row retrieved from golf course log table as database golf player name. Then the administration component for each retrieved row from golf course waitlist table would retrieve one row from golf course score card table using owner identifier for OWNER_ID, golf course identifier for GOLF_COURSE_ID, database golf player wait sequence for WAIT_SEQ, database golf player identifier for GOLF_PLAYER_ID, database e golf player identifier type GOLF_PLAYER_ID_TYPE and 0 for PARTY_MEMBER_ID. Since 0 is used for PARTY_MEMBER_ID only the primary member information will be retrieved from golf course score card table. If the administration component can retrieve one row from golf course score card table, then the administration component would save the value of SCORE_CARD_ID from the one row retrieved from course score card table as database golf player score card identifier, otherwise the administration component would save blank for database golf player score card identifier. Then the administration component would use the values of database golf player name and database golf player party size to populate the data on the dashboard. Then the administration component would set a value of ‘Y’ database tee-off available. If the value of database golf player score card identifier is not blank for any row retrieved from golf course waitlist table, then the administration component would change value database tee-off available from ‘Y’ to ‘N’. This will ensure that the pro-shop employee will not give permission to more than one current player to tee-off from tee box number 1. The administration component would use the value of database golf player name to populate the first column in the dashboard. The administration component would use the value of database golf player party size to populate the second column in the dashboard. Then the administration component would calculate an estimated wait time for each row retrieved from golf course waitlist table based on the date and time of each tee-off from tee box number 1 and use the estimated wait time to populate the third column in the dashboard. The administration component would calculate an estimated wait time only for the current players where the database golf player score card identifier is blank. Then the administration component would use the text ‘Wait’ if the value of database golf player score card identifier is blank, otherwise the administration component would use the text ‘Play’ to populate the fourth column in the waitlist display monitors.

If the value of database tee-off available is ‘Y’, then the administration component would confirm that the fairway between the tee-off station for hole number 1 and the putting station for hole number 1 is clear before giving permission for any current player to tee-off from tee-box number 1. To confirm that the fairway is clear for a current player to tee-off from tee-off station for hole number 1, the administration component would retrieve relevant data from golf course waitlist table, golf course score card table and golf course score table. The administration component would retrieve data of all current players whose status in golf course waitlist table is ‘P’. Then the administration component would retrieve data from golf course score card table for each row retrieved from golf course waitlist table to get the score card identifier. Then the administration component would retrieve data from golf course score table for each row retrieved from golf course score card table to get the latest hole identifier. If the latest hole identifier for any row retrieved from golf course score table is for hole identifier 0, then the administration component would set the value for database tee-off available to ‘N’. This will ensure that the pro-shop employee will not give permission to any current player when fairway for tee box number 1 is not cleared. If the value of database tee-off available is ‘Y’, then the administration component would provide a form for the pro-shop employees to select a player waiting to tee-off from tee box for hole number 1. If the pro-shop employee selects a player waiting to tee-off from tee box for hole number 1, then the administration component would assign a unique score card identifier for each party member in the selected player and save the assigned score card identifier in the golf course score card table, a notification will be sent to the selected player and the waitlist display monitors will be refreshed. The administration component would use a value of 0 as party member identifier for the primary member in the party and increment the party member identifier by 1 to each remaining member in the party.

The administration component would retrieve all rows from golf course waitlist table using owner identifier for OWNER_ID, golf course identifier for GOLF_COURSE_ID, ‘P’ for WAIT_STATUS ORDER BY WAIT_SEQ DESC. Then the administration component for each retrieved row from golf course waitlist table would save the values of WAIT_SEQ, PARTY_SIZE, GOLF_PLAYER_ID and GOLF_PLAYER_ID_TYPE as database wait sequence, database party size, database golf player identifier and database golf player identifier type respectively. Then the administration component for each retrieved row from golf course waitlist table would retrieve one row from golf course score card table using owner identifier for OWNER_ID, golf course identifier for GOLF_COURSE_ID, database golf player wait sequence for WAIT_SEQ, database golf player identifier for GOLF_PLAYER_ID, database golf player identifier type GOLF_PLAYER_ID_TYPE and 0 for PARTY_MEMBER_ID. Since 0 is used for PARTY_MEMBER_ID only the primary member information will be retrieved from golf course score card table. Then the administration component would save the value of SCORE CARD ID from the one row retrieved from course score card table as database golf player score card identifier. Then the administration component would set a value of ‘Y’ database tee-off available. Then the administration component for each retrieved row from golf course waitlist table would retrieve one row from golf course score table using owner identifier for OWNER_ID, golf course identifier for GOLF_COURSE_ID, database golf player score card identifier for SCORE_CARD_ID ORDER BY HOLE_ID DESC. This will ensure that the administration component would receive the score only for the latest hole identifier. If the value of HOLE_ID in the retrieved row from the golf course score table is 0, then the administration component would change the value of database tee-off available from ‘Y’ to ‘N’. This will ensure that the fairway is clear to tee-off from tee box for hole number 1. If the value of database tee-off available is ‘Y’, then administration component would provide a form for the pro-shop employees providing permission for current players to tee-off from tee box for hole number 1 to select a current player waiting to tee off from tee box for hole number 1. When the administration component receives a current player identifier and current player identifier type for giving permission to tee off from tee box for hole number 1, the administration component would assign a unique golf course card identifier for each party member of the current player. The administration component would use 0 as party member identifier for current player identifier and increment the value of party member identifier by 1 for each member in the party. Then the administration component for each party member in each retrieved row from golf course waitlist table would insert a row into golf course score card table using owner identifier for OWNER_ID, golf course identifier for GOLF_COURSE_ID, unique score card identifier for SCORE_CARD_ID, database wait sequence for WAIT_SEQ, party member identifier for PARTY_MEMBER_ID, current player identifier for GOLF_PLAYER_ID, current player identifier type for GOLF_PLAYER_ID_TYPE, current database server date for DATE and current database server time TIME. Upon inserting all the rows into golf course score card table, the administration component would refresh the data in the waitlist display monitors.

### Marshals & Rangers:

The administration component, upon receiving the request from employees acting as marshals and rangers for scores of current players through a terminal web form, the administration component would retrieve relevant data from golf course waitlist table, golf course log table, golf course score card table and golf course score table. The virtual terminal web form can be set up to send the request at periodic intervals to display the information on dashboard also take necessary actions.

The information provided to marshals and rangers would help them to identify the bottle neck in keeping the pace of the game and take corrective actions, if needed. The administration component would retrieve data of all current players whose status in golf course waitlist table is ‘P’. Then the administration component would retrieve data from golf course log table for each row retrieved from golf course waitlist table to get the name, data from golf course score card table for each row retrieved from golf course waitlist table to get the score card identifier and data from golf course score table for each row retrieved from golf course waitlist table to get the score. The number of rows retrieved from golf course score table for each row in golf course waitlist table would be the number of holes the current player has completed. The administration component would retrieve all rows from golf course waitlist table using owner identifier for OWNER_ID, golf course identifier for GOLF_COURSE_ID, ‘P’ for WAIT_STATUS ORDER BY WAIT_SEQ DESC. Then the administration component for each retrieved row from golf course waitlist table would save the values of WAIT_SEQ, PARTY_SIZE, GOLF_PLAYER_ID and GOLF_PLAYER_ID_TYPE as database wait sequence, database party size, database golf player identifier and database golf player identifier type respectively. Then the administration component for each retrieved row from golf course waitlist table would retrieve one row from golf course log table using owner identifier for OWNER_ID, golf course identifier for GOLF_COURSE_ID, ‘A’ for LOG_STATUS, database golf player identifier for GOLF_PLAYER_ID and database golf player identifier type GOLF_PLAYER_ID_TYPE ORDER BY LOG_SEQ DESC. Then the administration component would save the value of GOLF_PLAYER_ID_NAME from the one row retrieved from golf course log table as database golf player name. Then the administration component for each retrieved row from golf course waitlist table would retrieve one row from golf course score card table using owner identifier for OWNER_ID, golf course identifier for GOLF_COURSE_ID, database golf player wait sequence for WAIT_SEQ, database golf player identifier for GOLF_PLAYER_ID, database golf player identifier type GOLF_PLAYER_ID_TYPE and 0 for PARTY MEMBER ID. Since 0 is used for PARTY_MEMBER_ID only the primary member information will be retrieved from golf course score card table. If the administration component can retrieve one row from golf course score card table, then the administration component would save the value of SCORE_CARD_ID from the one row retrieved from course score card table as database golf player score card identifier, otherwise the administration component would save blank for database golf player score card identifier. Then the administration component for each retrieved row from golf course waitlist table would retrieve one or more rows from golf course score table using owner identifier for OWNER_ID, golf course identifier for GOLF_COURSE_ID and database golf player score card identifier for SCORE_CAR_ID ORDER BY HOLE_ID. Since 0 is used for PARTY_MEMBER_ID only the primary member information will be retrieved from golf course score table. If the administration component can retrieve one row from golf course score table, then the administration component would save the value of HOLE_ID, DATE and TIME for each row retrieved from golf course score table as database hole identifier, database date and database time respectively. Then the administration component would format the data received from golf course database and would display the formatted data on the dashboard. Based on the information displayed on the dashboard, the marshals and rangers would correct any problems that slow down the pace of the game.

### Order Deliveries:

When an order is ready, the kitchen staff would leave the order at a designated place where one of the order deliverers can pick up and deliver the order to a current player who placed the order. An order receipt attached to the order will have an order number in a QR Code or any other machine-readable format which is a concatenated data of order date, order time and order sequence with any separator in between the concatenated data.

When logged in operator clients and/or employee clients use virtual terminal web form to display all the relevant information pertaining to orders then the virtual terminal web form would send ‘D’, ‘O’, order number and ‘I’ for display type, display content order number and retrieval type respectively along with other information to indicate that the request is to display all the relevant information pertaining to orders on one or more dashboards dedicated for employees acting as order deliverers.

Upon receiving the input, the administration component would break the order number into order date, order time and order sequence, retrieve the required data from golf course order status table, golf course waitlist table, golf course log table, golf course scored card table, golf course score table and golf course cart/bag table.

If the retrieval type is ‘I’, then the administration component would only retrieve the data from the golf course database.

The administration component would retrieve a single row from golf course order status table using the order date, order time and order sequence to get golf player identifier and golf player identifier type, a most rent single row from golf course waitlist table using golf player identifier and golf player identifier type to get wait status, wait sequence and cart/bag identifier, a most recent single row from golf course log table using golf player identifier and golf player identifier type to get golf player name, a single row from golf course score card table using golf player identifier, golf player identifier type and wait sequence to get golf player score card identifier, a most recent single row from golf course score table using score card identifier to get golf player hole identifier and a single row from golf course cart/bag table using cart/bag identifier to get golf player cart/bag type.

The administration component would retrieve the most recent row from golf course order status table using owner identifier for OWNER_ID, golf course identifier for GOLF_COURSE_ID, order date for ORDER_DATE, order time for ORDER TIME and order sequence for ORDER_SEQ ORDER BY STATUS_DATE DESC, STATUS_TIME DESC. If the administration component retrieves one row from golf course order status table, then the administration component would save the values of ORDER_STATUS, GOLF_PLAYER_ID and GOLF_PLAYER_ID_TYPE from the retrieved row as database order status, database golf player identifier and database golf player identifier type respectively, otherwise the administration component would respond to the virtual terminal indicating that the order number is invalid and terminate the process. If order status is ‘O’ then the administration component would continue. If the order status ‘L’ then the administration component would respond to the virtual terminal indicating that the order has already been placed in a locker and terminate the process. If the order status ‘D’ then the administration component would respond to the virtual terminal indicating that the order has already been delivered and terminate the process.

Then the administration component would retrieve the most recent single row from golf course waitlist table using owner identifier for OWNER_ID, golf course identifier for GOLF_COURSE_ID, WAIT_SEQ is greater than 0, database golf player identifier for GOLF_PLAYER_ID and database golf player identifier type for GOLF_PLAYER_ID_TYPE ORDER BY WAIT_SEQ DESC. If the administration component retrieves one row, then the administration component would save the values of WAIT_SEQ, WAIT_STATUS, CART_BAG_ID and ORDER_STATION_ID from the retrieved row as database golf wait sequence, database wait status, database cart beg identifier and database order station identifier respectively, otherwise the administration component would respond to the virtual terminal indicating that the order number is invalid and terminate the process.

If the database wait status is ‘W’ or ‘P’ or ‘C’, then the administration component would continue processing the request, otherwise the administration component would respond to the virtual terminal indicating that the order number is invalid and terminate the process.

If the database wait status is ‘W’ or ‘C’ and if the order station identifier is blank, then the administration component would respond to the virtual terminal indicating that the current player is not playing, and the order can be left in a locker in any order station and stop the process.

If the database wait status is ‘W’ or ‘C’ and if the order station identifier is not blank, then the administration component would respond to the virtual terminal indicating that the current player is not playing, and the order can be left in a locker in the order station identified by order station identifier and stop the process.

Then the administration component would retrieve the most recent row from golf course log table using owner identifier for OWNER_ID, golf course identifier for GOLF_COURSE_ID, ‘A’ for LOG_STATUS, database golf player identifier for GOLF_PLAYER_ID and database golf player identifier type GOLF_PLAYER_ID_TYPE ORDER BY LOG_SEQ DESC. Then the administration component would save the value of GOLF_PLAYER_ID_NAME from the one row retrieved from golf course log table as database golf player name.

Then the administration component would retrieve one row from golf course score card table using owner identifier for OWNER_ID, golf course identifier for GOLF_COURSE_ID, database wait sequence for WAIT_SEQ, database golf player identifier for GOLF_PLAYER_ID, database golf player identifier type GOLF_PLAYER_ID_TYPE and 0 for PARTY_MEMBER_ID. Since 0 is used for PARTY_MEMBER_ID only the primary member information will be retrieved from golf course score card table. If the administration component can retrieve one row from golf course score card table, then the administration component would save the value of SCORE_CARD_ID from the one row retrieved from course score card table as database score card identifier, otherwise the administration component would respond to the virtual terminal indicating that the order number is invalid and terminate the process.

Then the administration component would retrieve the most recent row from golf course score table using owner identifier for OWNER_ID, golf course identifier for GOLF_COURSE_ID and database score card identifier for SCORE_CAR_ID ORDER BY HOLE_ID DESC. If the administration component can retrieve one row from golf course score table, then the administration component would save the value of HOLE_ID from the retrieved row as database hole identifier.

Then the administration component would retrieve a row from golf course cart/bag table using owner identifier for OWNER_ID, golf course identifier for GOLF_COURSE_ID and database cart beg identifier for CART_BAG_ID. If the administration component can retrieve one row from golf course cart/bag table, then the administration component would save the value of CART_BAG_TYPE from the retrieved row as database cart bag type.

Then the administration component would format a response using the values of database golf player name, database hole identifier, database cart beg identifier and database cart bag type and would display the formatted response on the dashboard.

Based on the information displayed on the dashboard, the order deliverer would track the current player and hand over the order or leave it in a locker.

If the order deliverer is instructed to leave the order in a locker in a specific order station, then the order deliverer would interface with the locker service provider and get an available locker number and a one-time code in a specific order station.

If the order deliverer is instructed to leave the order in a locker in any order station, then the order deliverer would interface with the locker service provider and get an available order station identifier, a locker number and a one-time code.

At any event, the order deliverer would know the database hole identifier, database cart beg identifier and database cart bag type before delivering the order in person to a player or order station identifier, locker number and one time code before leaving the order in a locker.

When logged in the order deliverer would use virtual terminal web form to update order delivery information and the virtual terminal web form would send ‘D’, ‘O’, order number, pickup station identifier, locker number, one time code and ‘U’ for display type, display content, order number, pickup station identifier, locker number, one time code and retrieval type respectively along with other information to indicate that the request is to update order status.

If pickup station identifier is not blank, then the administration component would verify the pickup station identifier. The administration component would retrieve one row from golf course order station table using owner identifier for OWNER_ID, golf course identifier for GOLF_COURSE_ID, pickup station identifier for ORDER STATION_ID and ‘A’ for ORDER_STATION_STATUS. If the administration component retrieves one row, then the administration component will continue, otherwise the administration component would respond to the virtual terminal indicating that the pickup station identifier is invalid and terminate the process.

Upon receiving the input and if the retrieval type is ‘U’, the administration component would break the order number into order date, order time and order sequence, retrieve the most recent data from golf course order status table and insert a row into golf course order status table with a new order status.

The administration component would retrieve the most recent row from golf course order status table using owner identifier for OWNER_ID, golf course identifier for GOLF_COURSE_ID, order date for ORDER_DATE, order time for ORDER TIME and order sequence for ORDER_SEQ ORDER BY STATUS_DATE DESC, STATUS_TIME DESC. If the administration component retrieves one row from golf course order status table, then the administration component would save the values of ORDER_STATUS, GOLF_PLAYER_ID, GOLF_PLAYER_ID_TYPE and PICKUP_STATION_ID from the retrieved row as database order status, database player identifier, database player identifier type and database pickup station identifier respectively, otherwise the administration component would respond to the virtual terminal indicating that the order number is invalid and terminate the process. If order status is ‘O’ then the administration component would continue. If the order status ‘L’ then the administration component would respond to the virtual terminal indicating that the order has already been placed in a locker and terminate the process. If the order status ‘D’ then the administration component would respond to the virtual terminal indicating that the order has already been delivered and terminate the process.

If the locker number in the input is blank, then the administration component would set a value of ‘D’, value of blank, value of blank and value of blank for insert status, insert pickup station identifier, insert locker number and insert one time code respectively, otherwise the administration component would set a value of ‘L’, value of pickup station identifier from the input, value of locker number from the input and value of one time code from the input for insert status, insert pick up station identifier, insert locker number and insert one time code respectively. Then the administration component would insert a row in golf course order status table using owner identifier for OWNER_ID, golf course identifier for GOLF_COURSE_ID, order date for ORDER_DATE, order time for ORDER_TIME, order sequence for ORDER_SEQ, insert status for ORDER_STATUS, server date for SERVER_DATE, server time for SERVER_TIME, insert pickup station identifier for PICKUP_STATION_ID, insert locker number for LOCKER_NUMBER, insert one time code for ONE_TIME_CODE, database player identifier for GOLF_PLAYER_ID and databased player identifier type for GOLF_PLAYER_ID_TYPE.

If the administration component is interfaced to communicate with locker service provider and if the order is placed inside a locker, then the administration component would also send the database player identifier, database player identifier type, pickup station identifier and locker number so that the locker service provider would accept a fingerprint to open the locker.

It is beyond the scope of this invention to provide the details of the interfaces between administration component and locker service provider.

When logged in the order deliverer receives a notification from locker service provider that an order has been picked up from a specific locker in a specific pickup station identifier, the order deliverer would use virtual terminal web form to update order pickup information and the virtual terminal web form would send ‘D’, ‘O’, pickup station identifier, locker number and ‘P’ for display type, display content, pickup station identifier, locker number and retrieval type respectively along with other information to indicate that the request is to update order status.

The administration component would retrieve the most recent row from golf course order status table using owner identifier for OWNER_ID, golf course identifier for GOLF_COURSE_ID, ORDER_DATE is greater then blank, ORDER_TIME is greater then blank, ORDER_SEQ is greater than 0, pickup station identifier for PICKUP_STATION_ID and locker number for LOCKER NUMBER ORDER BY STATUS_DATE DESC, STATUS_TIME DESC. The administration component would retrieve the most recent row of an order where the pickup station identifier is provided by the order deliverer and the locker number is provided by the order deliverer. If the administration component retrieves one row, then the administration component would save the values of ORDER_DATE, ORDER_TIME, ORDER_SEQ, ORDER_STATUS, ONE_TIME_CODE, GOLF_PLAYER_ID and GOLF_PLAYER_ID_TYPE. from the retrieved single row as database order date, database order time, database order sequence, database order status, database one time code, database player identifier and database player identifier type respectively and continue, otherwise the administration component would respond to the virtual terminal indicating that the request is invalid and terminate the process. If database order status is ‘L’, then the administration component would continue, otherwise the administration component would respond to the virtual terminal indicating that the request is invalid and terminate the process. Then the administration component would insert a row into golf course order status table using owner identifier for OWNER_ID, golf course identifier for GOLF_COURSE_ID, database order date for ORDER DATE, database order time for ORDER_TIME, database order sequence for ORDER_SEQ, ‘D’ for ORDER_STATUS, current server date for SERVER_DATE, current server time for SERVER_TIME, pickup station identifier for PICKUP_STATION_ID, locker number for LOCKER_NUMBER, database one time code for ONE_TIME_CODE, database player identifier for GOLF_PLAYER_ID and database player identifier type for GOLF_PLAYER_ID_TYPE.

When logged in owner clients and/or employee clients use virtual terminal web form to display all the relevant information pertaining to hole identifier and score then the virtual terminal web form would send ‘D’ and ‘S’ for display type and display content respectively along with other information to indicate that the request is to display all the relevant information pertaining to hole identifiers and scores on one or more dashboards dedicated for employees acting as marshals and/or rangers.

Logged in operator clients and/or employee clients can use a virtual terminal web form provided by administration component to display all the relevant information in one more electronic dash boards that can be viewed and/or updated by operator clients and/or employee clients. When operator clients and/or employee clients use virtual terminal web form to display all the relevant information pertaining to such as hole identifier, score, waitlist, order, payment and the like, then the virtual terminal web form would send ‘D’ and ‘A’ for display type and display content respectively along with other information to indicate that the request is to display all the relevant information pertaining to such as hole identifier, score, waitlist, order, payment and the like on one or more dash boards. It is beyond the scope of this invention to describe all possible web forms that can be set up for owners and employees to retrieve information from golf course databases.

### Temporary Mobile Phone Numbers

With certain type of merchants, for example in golf courses, only a certain number of customers can be accommodated at any given time, known as capacity or occupancy. Even when merchants serve less than their capacity or occupancy, some merchants would require their customers to wait in line for certain type of services. For example, medicine pickup over the counter in a pharmacy or customer service counter in a grocery store or merchandise return desk in a brick-and-mortar location. Instead of asking their customers to wait in line, some merchants would request their customers to pick up number from a dISPenser where the numbers in the dISPenser are printed in a sequential order. Merchants use the general practice of first come first served. So, the merchants need to know the order in which customers are requesting for help. With the introduction of mobile phones and internet, merchants instead of giving numbers to customers or instead of asking merchants to wait in line, merchants ask the customers to leave their cell phone numbers so that merchants could send a text message when the merchant is ready to serve the customer. Also, in the name of protecting the environment, merchants demand customers' cell phone numbers instead of handing over sales receipts. Cell phone numbers are given verbally to employees of the merchants where other customers can also hear the conversation. Merchants not only used customers' cell phone numbers to send ready text message but also used for sending promotional messages. These unprotected mobile phone numbers end up in the hands of robe callers.

This invention is intended for customers to use temporary mobile phone numbers wherever providing permanent mobile numbers are not required. This invention provides a means for consumers to receive and use, on demand, temporary mobile numbers for a noticeably brief period. These temporary and on-demand mobile numbers are reusable, can be used by more than one consumer and can be used only for a single transaction at a time. For example, customers can use temporary mobile phone numbers instead of giving their permanent mobile phone numbers when signing-in with a host or signing-in at customer service desk or to receive an electronic receipt.

When a cell phone number is rented, any incoming message will be sent as a notification to intermediary agent's app in renter's mobile device. It may also be sent to renter's mobile device as a text message. The renter can respond to the incoming message from intermediary agent's app in renter's mobile device or as a test message from renter's mobile device. Here is how temporary rental of mobile phone number works:
1. Mobile device holders would receive an app issued by or interfaced with an intermediary agent, provide a verifiable mobile phone number and setup a payment account.
2. Intermediary agent may hold one or more mobile phone numbers for rental.
3. Intermediary agent would rent any available mobile phone number for any mobile device holder registered with the intermediary agent.
4. At the time of requesting the intermediary agent for a rental mobile phone number, the device owner would specify the start date and time and the end date and time.
5. Upon approval of the request to rent a mobile phone number, only for the rental period, the intermediary agent would send any text message received to the rented mobile phone number to the renter's mobile device as a notification through intermediary agent's app or to the renter's mobile device.
6. Any text message received by any mobile phone number set aside for rental by the intermediary agent and not rented will be ignored.
7. The mobile device holder will always be able to view mobile phone rental information and the text messages received by the intermediary agent and sent to mobile device during those rental periods.

### QR Code Communication & Automation

### Store Automation

In a traditional grocery or convenient or department store referred as store, the shoppers were directed by the store operators to pick up the goods and then go through a self-service check-out or through an employee managed check-out lane, so that the store operator can collect the payment for the picked-up items. In the above example the store operator receives the payment and hands over the goods to the shopper at a pre-defined specific location and it may not be important for stores to know the exact position of shoppers at any given time inside store's location, but it is important for stores that the shopper goes through a self-service check-out or employee managed check-out lane. To provide a self-check-out, stores started using self-serving counter-top scanners to let the shoppers scan the bar code printed on each product and weight sensors to verify that each item placed in a shopping bag matched the weight of the last item being scanned. This eliminated or at least reduced the number of employees managing check-out lanes. Still stores had to use employees to monitor self-check-out lanes to reduce or eliminate thefts and shoppers must wait and pass through self-check-out lanes.

Self-served stores, referred as go store, let shoppers simply go through an entrance equipped with a turnstile and scanner that would scan a static QR Code displayed in a mobile device presented by the shopper and then lets shoppers pick up the goods and walk out without going through a check-out lane or check-out locker, for example Amazon Go store by Amazon. The technology used in Amazon Go store, referred as amazon go store technology, is based on check-in through a secured entrance, several hardware equipped with computer vision cameras, sensors and shopper surveillance software to follow every move of shoppers to detect what shoppers take with them. With amazon go store technology shoppers can shop faster and easier without check-out lanes and store operators can reduce the operational cost and not being vulnerable for shoplifting. But unfortunately, amazon go store technology comes at a steep cost and uses surveillance technology to record every move of shoppers even when the shoppers are not picking up any goods. Still employees need to monitor captured videos constantly.

In addition to shopping without check-out lanes, it is also important for shoppers not to sacrifice their privacy, have the option to communicate on demand with employees and also get suggestions and recommendations on products from fellow shoppers shopping at the store concurrently.

To secure, automate and to protect shoppers privacy, MySingleLink introduced secured and automated self-check-out lanes without employees monitoring self-check-out lanes and without compromising shoppers' privacy, where shoppers would place the items in a secured area on a feeding conveyor, then the feeding conveyor would move items to a holding conveyor where the items will be scanned and weighed before the holding conveyor moves the items to a pickup chamber where the pickup chamber will be protected by an electronic lock and accessible from an unsecured area. Upon placing all the items on the feed conveyor, the shoppers would pay and exit the secured to an unsecured area where the shoppers can unlock the electronic lock and pickup the goods from the pickup chamber. The items that are not scanned and weighed in the holding conveyor will be diverted to a reject chamber.

The object of this invention is to provide a method for shoppers to purchase products without passing through restricted check-in and check-out lanes and for store operators to secure products from shop lifting.

The object of this invention is to provide a method to protect shopper privacy.

The object of this invention is to provide a method for shoppers to enter without checking-in through a restricted entrance.

The object of this invention is to provide a method for shoppers (registered shoppers and unknown shoppers) to sign-in easily and quickly. Signed-in shoppers are referred as signed-in shoppers.

The object of this invention is to design and build self-service racks where one or more self-service racks can be joined together to form an aisle.

The object of this invention is to provide a means to attach self-service bins to self-service racks.

The object of this invention is to provide a means for shoppers to have access to self-service bins to get pricing, product information and to pick up products.

The object of this invention is to provide a means for shoppers to get permission before picking up products.

The object of this invention is to provide a means for shoppers to know when to pick up products.

The object of this invention is to provide alerts to shoppers when a product is picked up without proper permission.

The object of this invention is to provide a means for shoppers to have access to a return station to return products before exiting.

The object of this invention is to provide a means for shoppers to exit without going through check-out lanes.

The object of this invention is to provide a means for store operators and employee clients to have access to self-service bins to stock products.

The object of this invention is to provide a means for store operators and employee clients to maintain inventory in self-service bins.

The object of this invention is to display real time information on desktops and on mobile devices for employees to provide remote or in-person shopper service.

The object of this invention is to provide alerts to store operators and employees when a product is picked up without proper permission.

The object of this invention is to automatically keep track of inventory in each bin in each rack.

The object of this invention is to provide alerts to store operators and employees when inventory of a product in any bin is below certain level.

The object of this invention is to automatically keep track of inventory of returned items.

The object of this invention is to accept returns automatically without employees managing return goods.

The object of this invention is to automatically monitor products from being stolen.

The object of this invention is to provide the technology at an affordable price and implemented quickly.

The object of this invention is to provide the technology for self-service racks with self-service bins to be portable and easy to install.

The object of this invention is to provide the technology to add or remove self-service racks with self-service bins easily.

The object of this invention is to deliver a method that is easy to use without any special training.

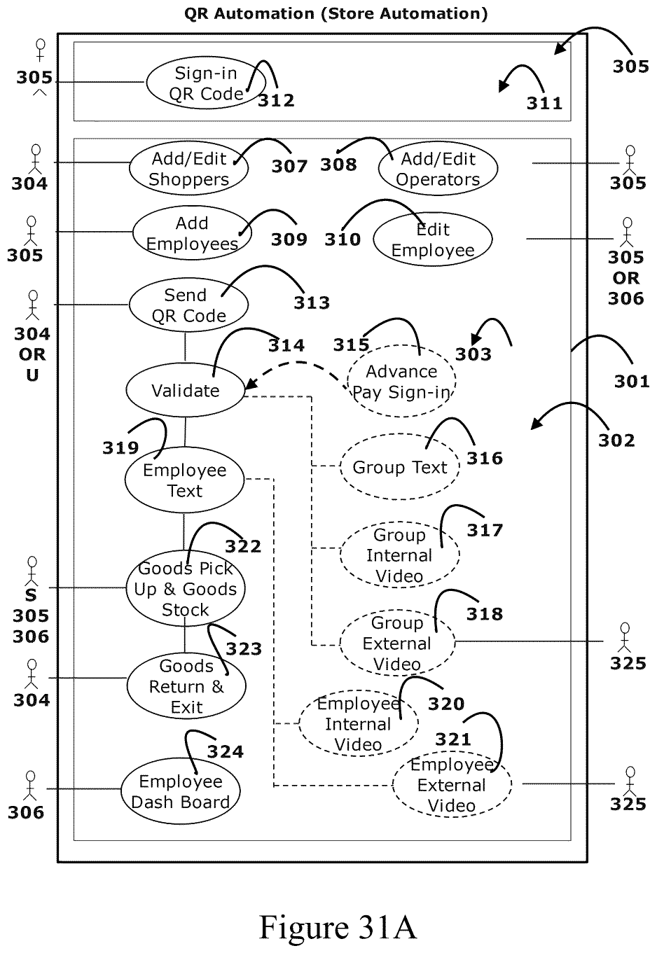

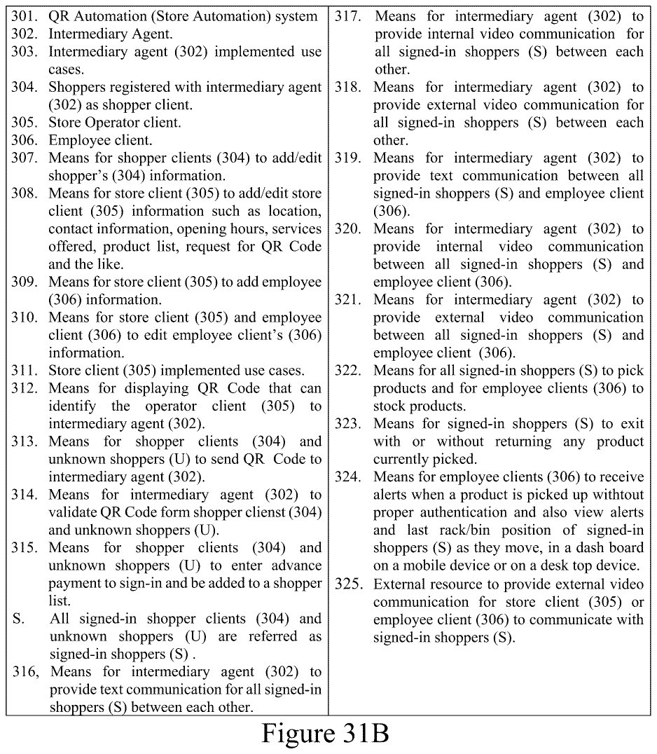

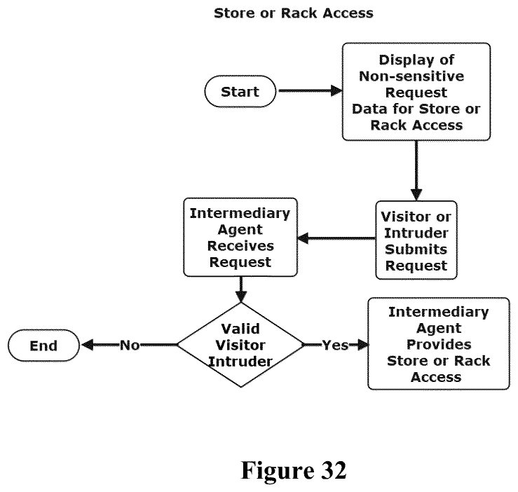

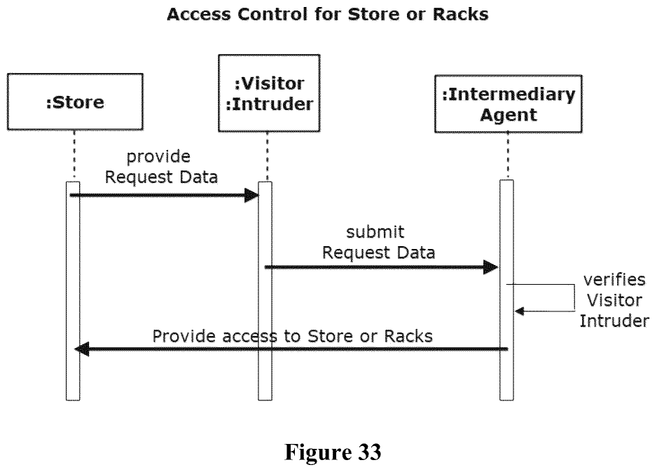

Referring now to the figures, and to FIG. 31A in particular, the QR Automation related to Store Automation system (301) of the present invention is shown to generally comprise an operative combination of a plurality of store operators (305) implemented use cases (311) and a plurality of intermediary agent (302) implemented use cases (303). For simplicity, QR Automation related to Store Automation is referred as Store Automation and store operators (305) are referred as store clients (305). In particular, the store client (305) and/or employee clients (306) of the present invention will generally display for registered shoppers referred as shopper clients (304) and for unregistered shoppers referred as unknown shoppers (U) a sign-in QR Code (312) containing a request message for identifying the store client (305) and additional data to an intermediary agent (302) for the purpose of requesting that the intermediary agent (302) provide for the shopper clients (304) and unknown shoppers (U) a communication channel between the shopper clients (304) or unknown shoppers (U) and the employee clients (306) and for the purpose of automating store operations at the front and back ends. For simplicity signed-in shopper clients (304) and signed-in unknown shoppers (U) collectively are referred as signed-in shoppers (S).

Intermediary agent (302), shopper clients (304), store clients (305), employee clients (306), signed-in shoppers (S) and unknown shoppers (U) are also referred to as intermediary agent, shopper clients, store clients, employee clients, signed-in shoppers and unknown shoppers respectively.

Additionally, intermediary agent provides a means (307) for any shopper to register as a shopper client.

Additionally, intermediary agent provides a means (308) for any store operator to register as store client

Additionally, intermediary agent provides a means (309) for store clients to add employee clients.

Additionally, intermediary agent provides a means (310) for store clients to add/edit employee clients (306) information and employee clients (306) to edit their own information.

Additionally, intermediary agent provides a means (313) for shopper clients and for unknown shoppers (U) to send request message by scanning a QR Code and sign-in.

Additionally, intermediary agent provides a means (314) for validating shopper clients and unknown shoppers (U).

Additionally, intermediary agent provides a means (315) for shopper clients and unknown shoppers (U) to sign-in and authorize payment in advance.

Signed-in shopper clients and signed-in unknown shoppers (U) are generally referred as singed-in shoppers (S).

Additionally, intermediary agent provides a means (316) for a communication channel for texting between signed-in shoppers (S) at the said store client location.

Additionally, intermediary agent provides a means (317) for a communication channel for audio/video between signed-in shoppers (S) at the said shopper client location.

Additionally, intermediary agent provides a means (318) for exchanging credentials for audio/video meeting provided by an external resource provider (325) between current shoppers (S) at the said store client location.

Additionally, intermediary agent provides a means (319) for a communication channel for texting between signed-in shoppers (S) and employee clients (306).

Additionally, intermediary agent provides a means (320) for a communication channel for audio/video between signed-in shoppers (S) and employee clients (306).

Additionally, intermediary agent provides a means (321) for exchanging credentials for audio/video meeting provided by an external resource provider (325) between signed-in shoppers (S) and employee clients 306.

Additionally, intermediary agent provides a means (322) for signed-in shoppers (S) to view product information and pick up products.

Additionally, intermediary agent provides a means (323) for signed-in shoppers (S) to exit with or without returning any product/s. Upon exit signed-in shoppers (S) would receive an electronic receipt and be signed-out.

Additionally, intermediary agent provides a means (324) for employee clients to access a dashboard which can display the identification of the rack and/or bins that was last scanned by signed-in shoppers (S) and all alert messages about possible shop lifting.

Additionally, an external resource provider (325) can provide a means for external audio/video communication.

QR Code based store automation can eliminate check-out counters and can eliminate or reduce the functions of employees helping shopper clients, unknown shoppers (U) and signed-in shoppers (S). QR Code based store automation can be used by store operators to build new or convert existing stores.

QR Code based store automation can use a database such as store database with various tables such as store owner table, store employee table, store location table, store product table, store rack table, store bin table, store cart basket table, store order summary table, store order detail table, store order return table, store text starter table, store text response table and store meeting starter table as shown in a class diagram in FIGS. 34, 34A and 34B. In addition to store database, QR Code based store automation system can also use a database such as intermediary agent customer database with various tables such as customer table and customer payment table, as shown in a class diagram in FIG. 6. Primary key and indexed fields in the store database are marked as ‘(PK)’ and ‘(I)’ respectively.

Before continuing, however, it is noted that while the databases shown in class diagrams in FIGS. 6, 34, 34A and 34B is exemplary of the preferred embodiments of the present invention related to store automation, it is in no manner meant to be all encompassing or otherwise limiting of the wide range of implementations as are possible.

Those of ordinary skill in the art will readily recognize the SQL statements shown in describing the various embodiments to insert, update or retrieve rows from the tables in the databases as shown in class diagrams in FIGS. 6, 34, 34A and 34B can be only examples, and the actual SQL statements can vary depending on the existing and future database management servers used by the intermediary agent.

As described in ‘DETAILED DESCRIPTION OF THE PREFERRED EMBODIMENTS’ section, any consumer can use customer web form provided by intermediary agent to register and maintain their personal information with the intermediary agent as customer. Registered customers are referred to as shopper clients and customers shopping without registering will be referred to as unknown shoppers.

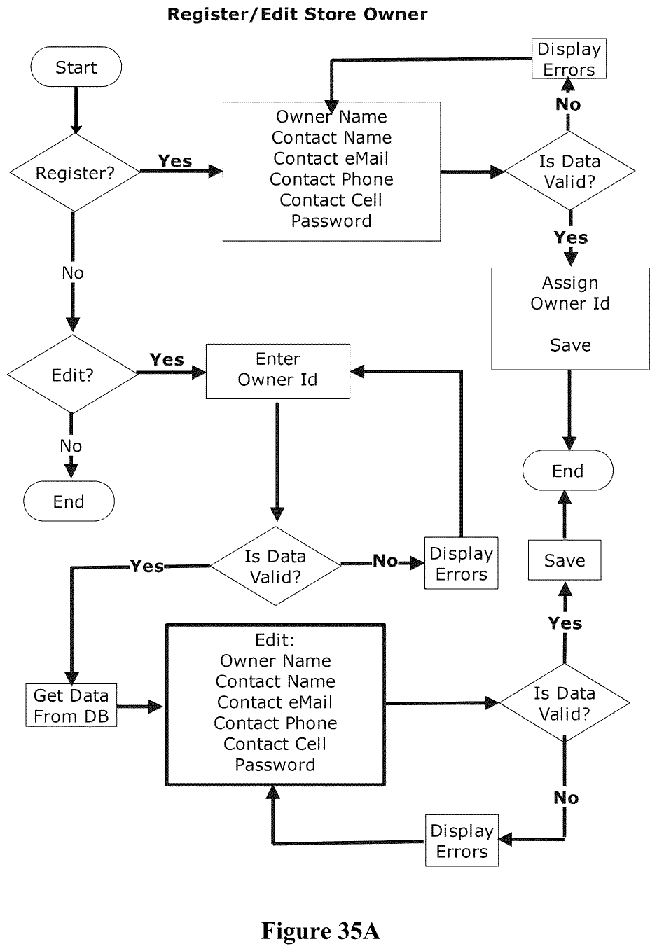

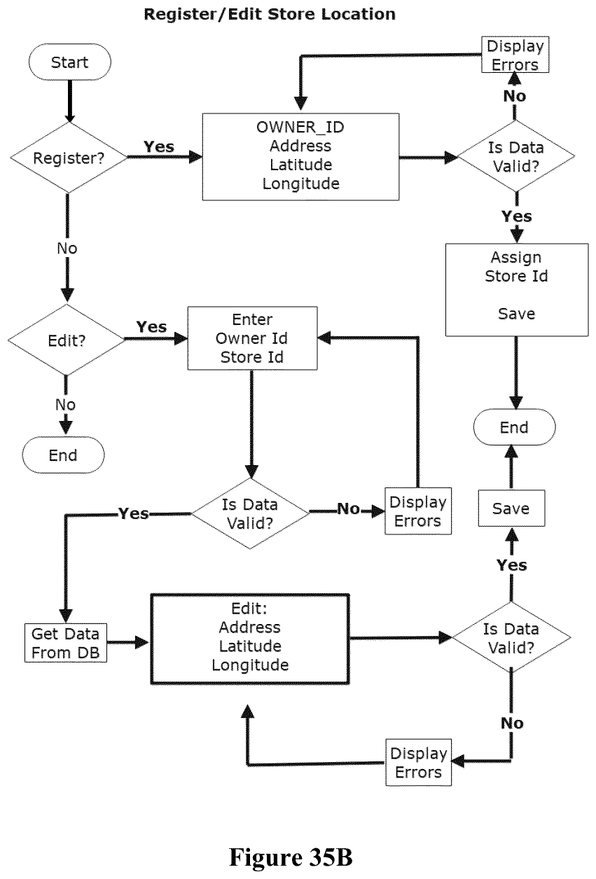

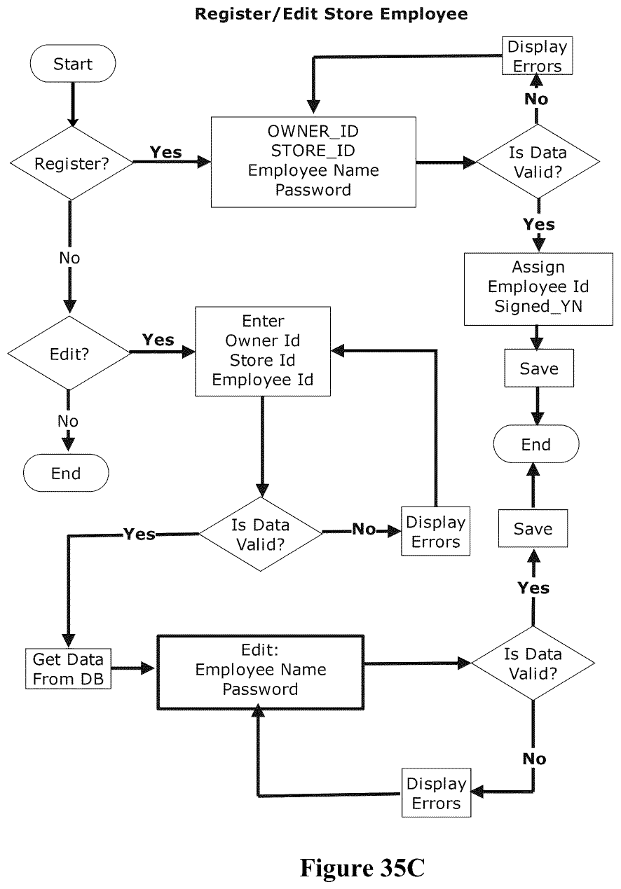

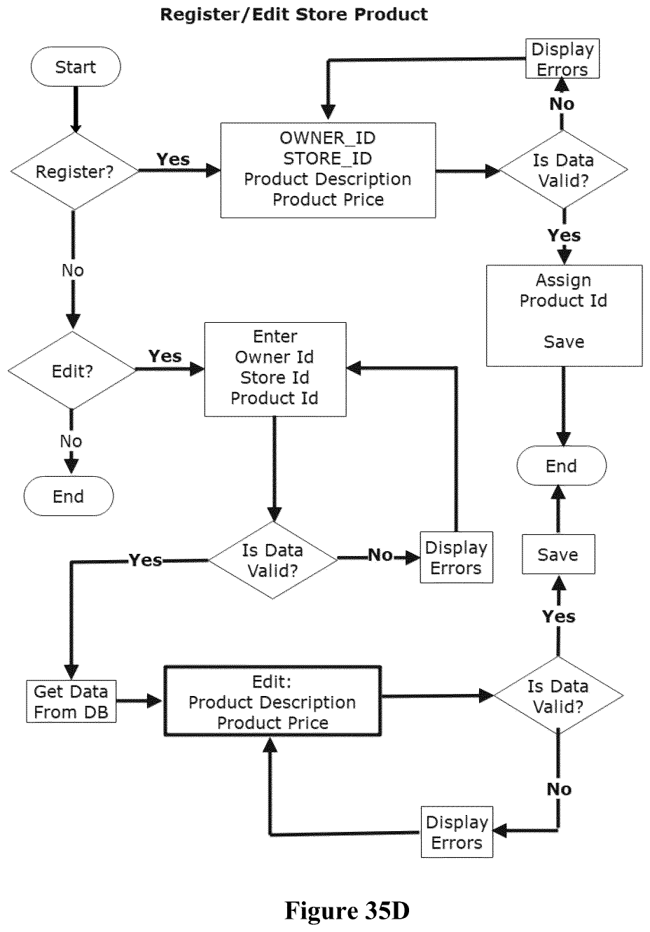

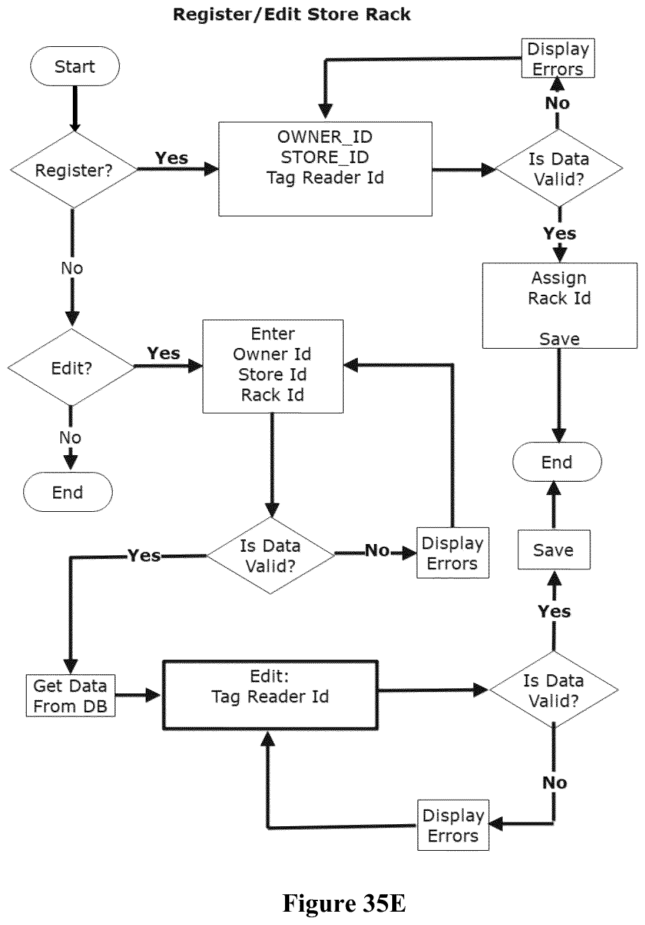

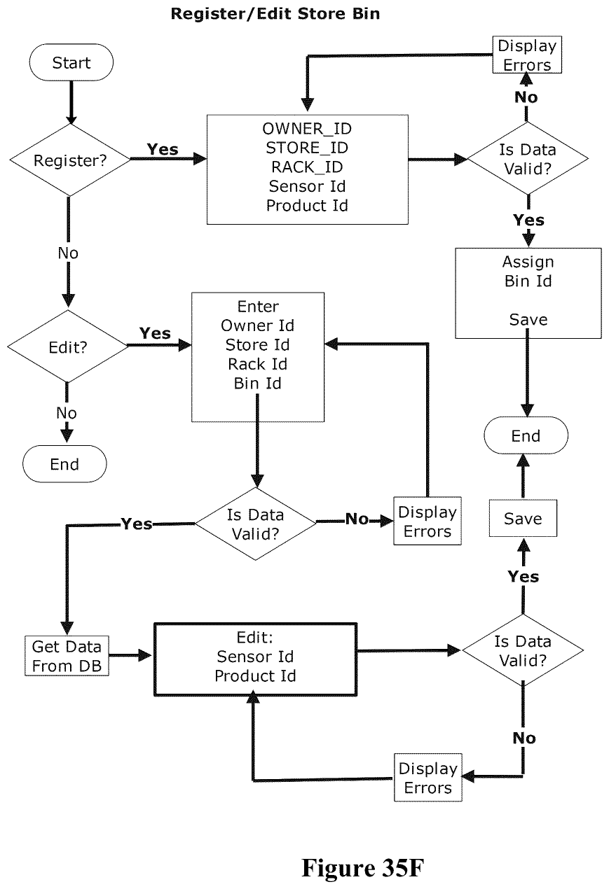

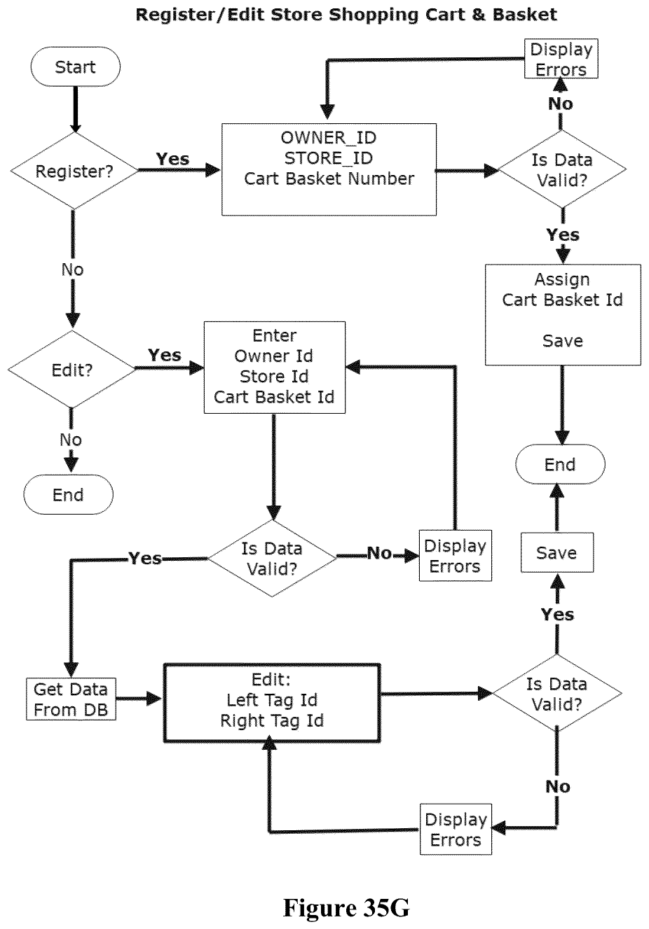

Store owners can register using an owner registration web form provided by intermediary agent using ‘A’ for action. Intermediary agent would assign a unique value for owner identifier and capture values for owner name, contact name, contact email, contact phone, contact cell and password as shown in FIG. 35A If the values are valid then the intermediary agent would insert a row into store owner table using owner identifier for OWNER_ID, owner name for OWNER_NAME, contact name for CONTACT_NAME, contact email for CONTACT_EMAIL, contact phone for CONTACT_PHONE, contact cell for CONTACT_CELL, password for PASSWORD and ‘N’ for LOGGED_YN. Store owners can edit their information using owner registration web form provided by intermediary agent using ‘E’ for action. Intermediary agent would capture values for owner identifier, owner name, contact name, contact email, contact phone, contact cell, password for PASSWORD and ‘N’ for LOGGED_YN as shown in FIG. 35A. If the values are valid then the intermediary agent would update a row in store owner table as shown in a class diagram as shown in FIG. 34 using owner identifier for OWNER_ID, owner name for OWNER_NAME, contact name for CONTACT_NAME, contact email for CONTACT_EMAIL, contact phone for CONTACT_PHONE, contact cell for CONTACT_CELL, password for PASSWORD and ‘N’ for LOGGED_YN. Registered store owners will be referred to as store clients.

Store clients can add a location using a location registration web form provided by intermediary agent using ‘A’ for action. Intermediary agent would capture values for owner identifier, address, latitude and longitude as shown in FIG. 35B. If the captured values are valid, then the intermediary agent would assign a unique value for store identifier and insert a row into store location table using owner identifier for OWNER_ID, store identifier for STORE_ID, address for ADDRESS, latitude for LATITUDE and longitude for LONGITUDE. Store operators can edit location information using the location registration web form provided by intermediary agent using ‘E’ for action. Intermediary agent would capture values for owner identifier, store identifier, address, latitude, and longitude as shown in FIG. 35B. If the values are valid then the intermediary agent would update a row in store location table using owner identifier for OWNER_ID, store identifier for STORE_ID, address for ADDRESS, latitude for LATITUDE, longitude for LONGITUDE.

Store clients can register using an employee registration web form provided by intermediary agent using ‘A’ for action. Values for OWNER_ID, STORE_ID, EMPLOYEE_NAME and PASSWORD will be provided by store clients, a unique value for EMPLOYEE_ID, a value ‘N’ for LOGGED_YN will be assigned and saved in store employee table as shown in a class diagram, in FIG. 35C by the intermediary agent. Registered employees will be referred to as employee clients. Store clients or employee client can maintain employee information using an employee registration web form provided by intermediary agent using ‘E’ for action. Intermediary agent would use OWNER_ID and STORE_ID and values for EMPLOYEE_ID, EMPLOYEE_NAME and PASSWORD provided by the store client or employee client, a value ‘N’ will be used for LOGGED_YN and saved in store employee table as shown in a class diagram, in FIG. 35C by the intermediary agent.

Store clients and employee clients will be collectively referred to as store operator clients.

Store operator clients would also register and maintain product information using a product maintenance web form provided by intermediary agent, in each store as shown in a flowchart in FIG. 35D. When ‘A’ for action is used, a unique product identifier will be assigned by the intermediary agent, otherwise product identifier will be provided by the store or employee client. When ‘A’ for action is used, the stores will provide values for OWNER_ID. STORE_ID, PRICE and DESCR, otherwise the stores will provide values for OWNER_ID. STORE_ID, PRODUCT_ID, PRICE and DESCR. The data will be saved in store product table as shown in a class diagram, in FIGS. 34, 34A and 34B by intermediary agent.

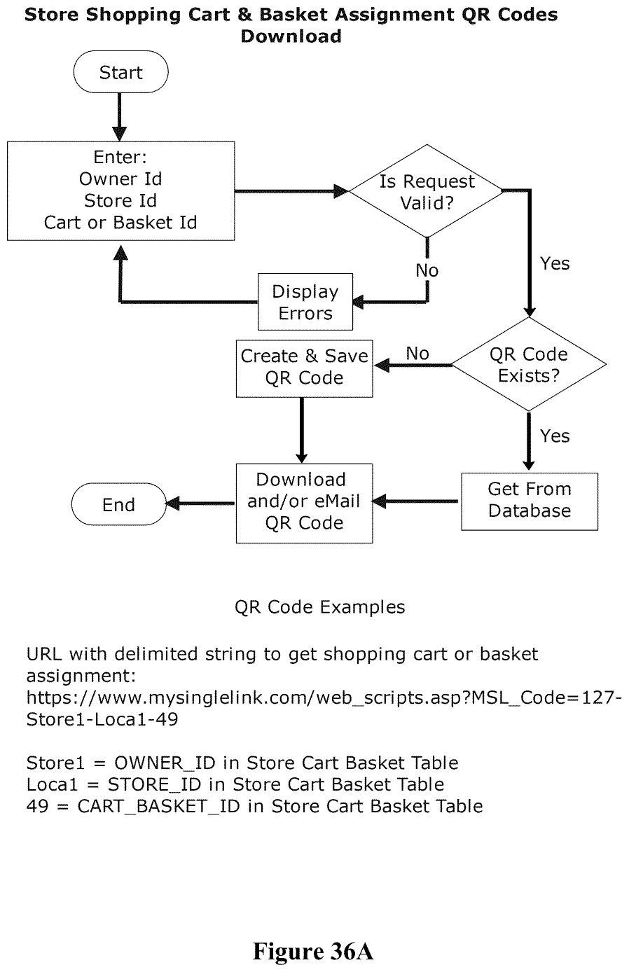

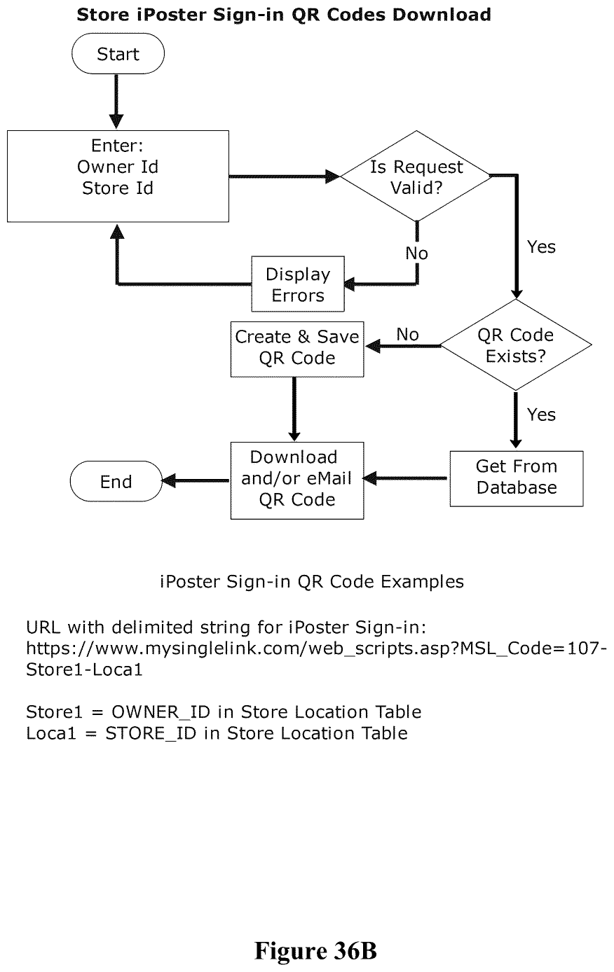

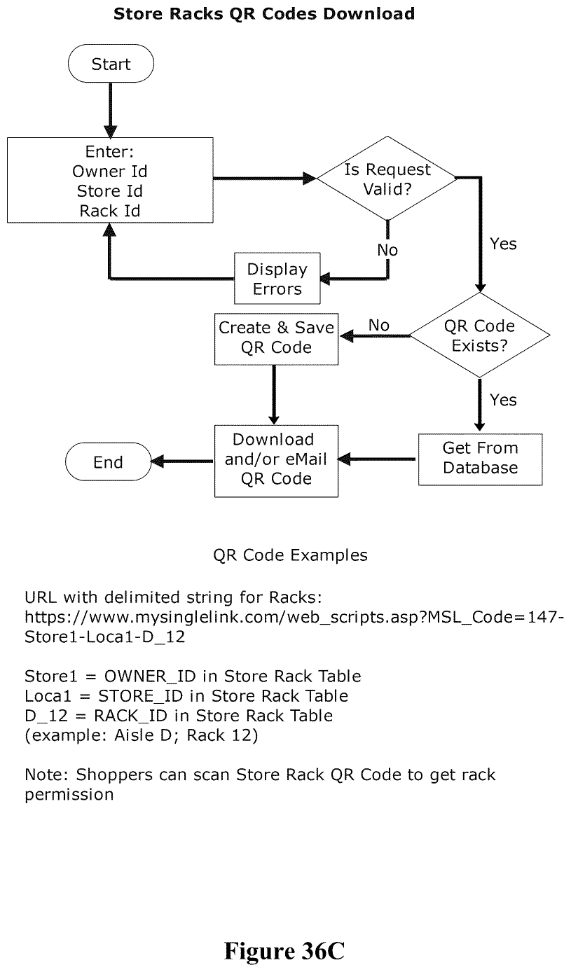

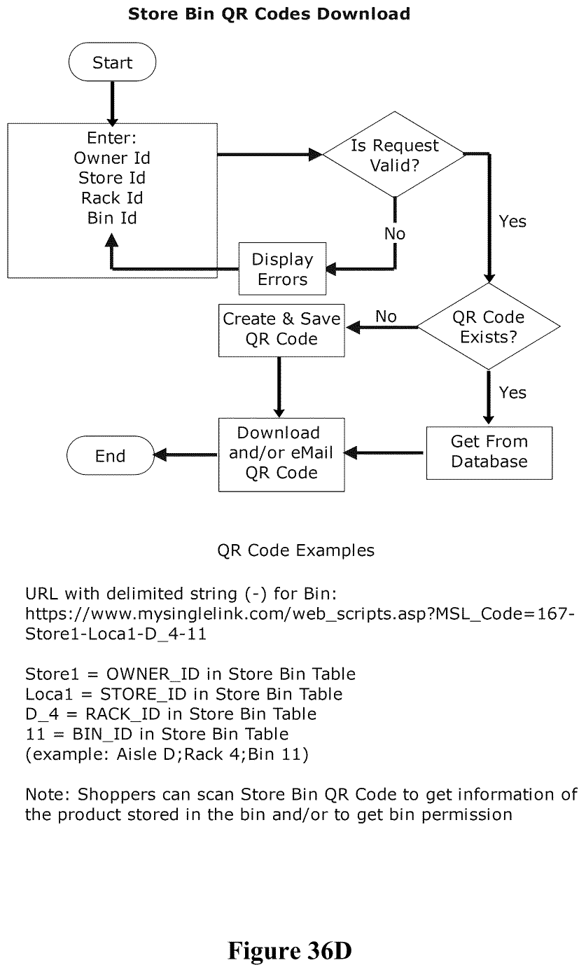

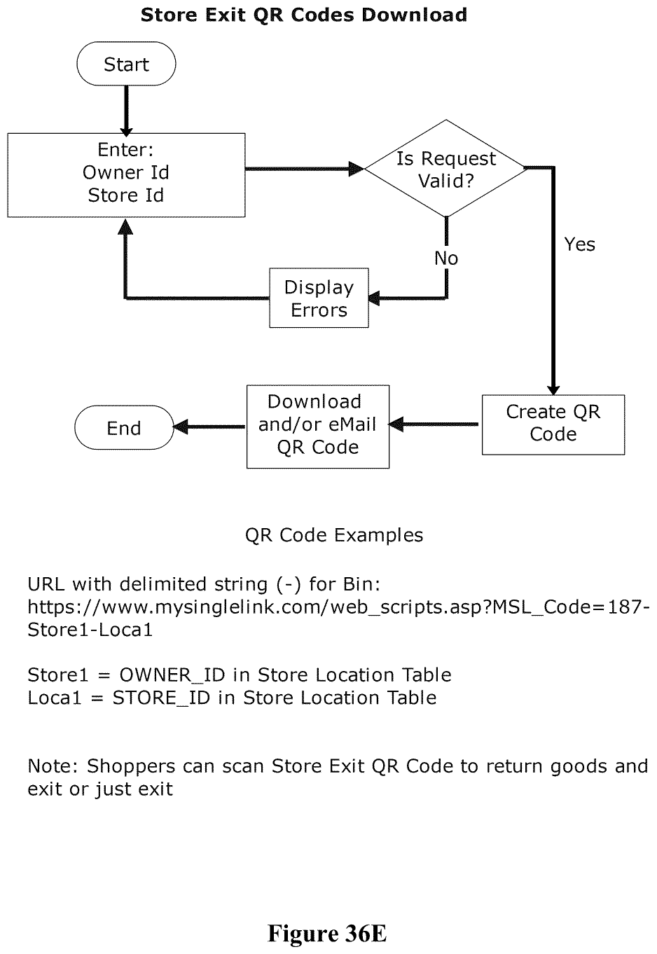

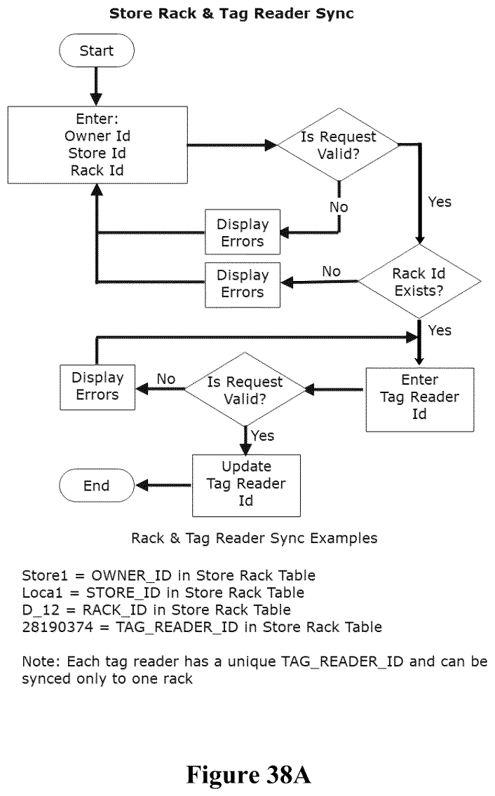

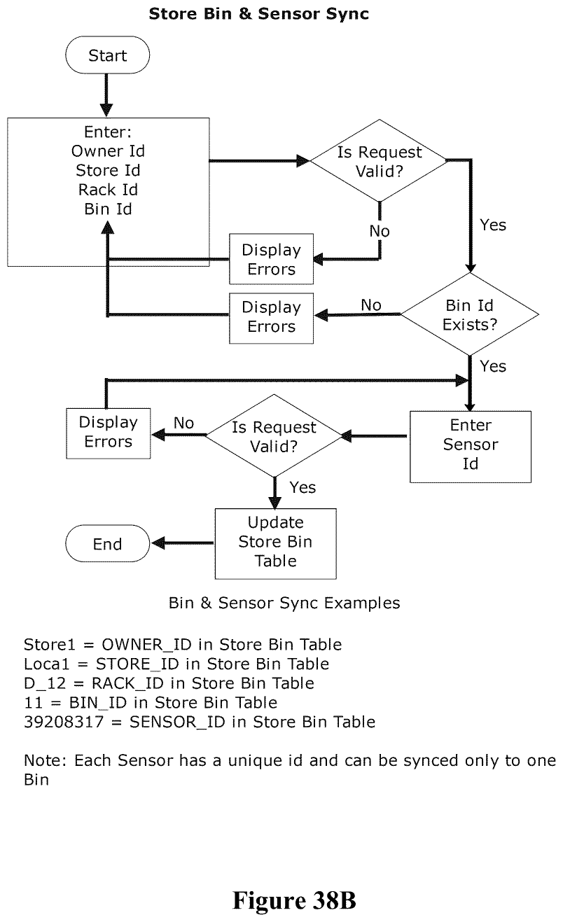

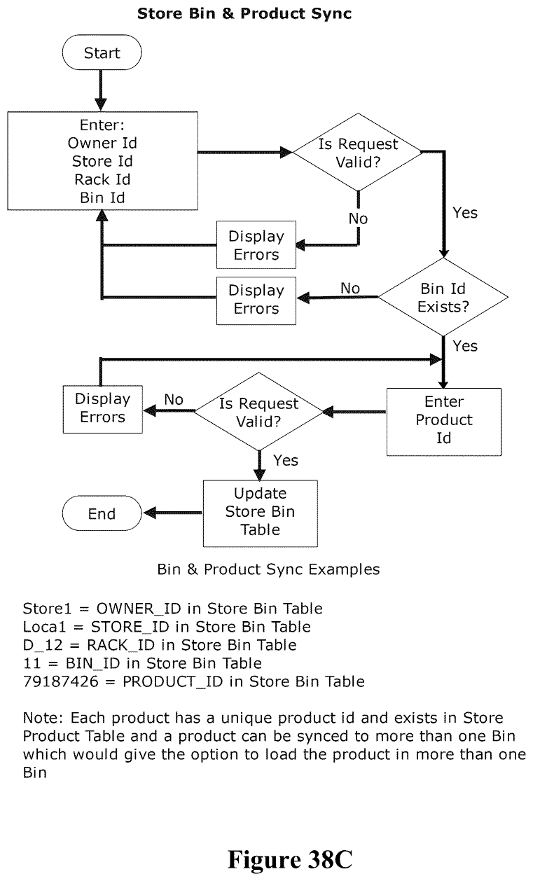

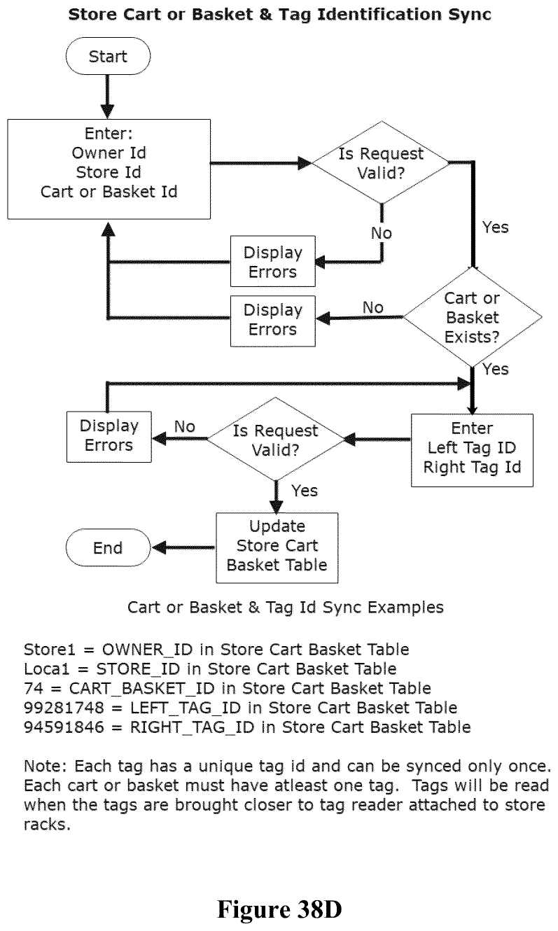

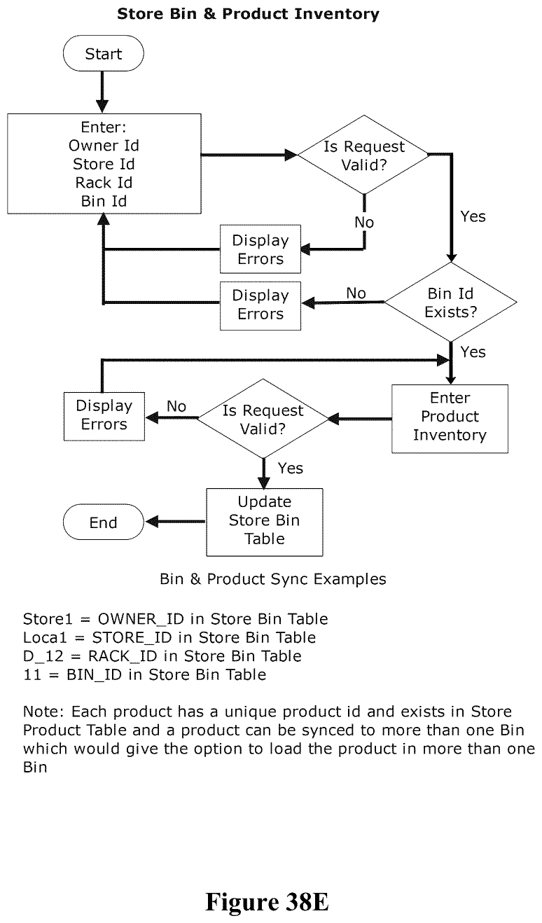

Store operator clients would also register and maintain rack information using a rack maintenance web form provided by intermediary agent, in each store as shown in a flowchart in FIG. 35E. When ‘A’ for action is used, a unique rack identifier will be assigned by the intermediary agent, otherwise rack identifier will be provided by the store or employee client. Each rack will have one or more tag readers and each tag reader will have unique tag reader identifier which may be assigned by tag reader manufacturer. Tag readers fitted to racks can read tags attached to shopping carts and shopping baskets only when the shopping carts or shopping baskets are placed in close proximity of the tag readers. When ‘A’ for action is used, the stores will provide values for OWNER_ID, STORE_ID and TAG_READER_ID and intermediary agent will assign a unique value for RACK_ID, otherwise stores will provide values for OWNER_ID. STORE_ID, RACK_ID and TAG_READER_ID. The intermediary agent would format the data for RACK_QR_CODE by concatenating the values ‘147’, ‘-’, OWNER_ID, ‘-’, STORE_ID, ‘-’ and RACK ID. The data will be saved in store rack table as shown in a class diagram, in FIGS. 34, 34A and 34B by intermediary agent. Each registered store can have one or more racks with unique rack identifier, rack permission QR Code and tag reader identifier. Store and employee clients would download RACK_QR_CODE as shown in a flowchart in FIG. 36C. The RACK_QR_CODE can be attached to each rack as shown in FIGS. 37A and 37B. The RACK_QR_CODE is also referred as rack permission QR Code. The unique rack permission QR Code can be used by signed-in shoppers to get a rack permission or by shopper clients and unknown shoppers to sign-in and get a rack permission. When rack permission is granted and active, shoppers can pick one or more products from any bin attached to the said rack. Store operator clients can also sync each rack with a tag reader attached to the said rack and maintain rack and tag reader sync information with the intermediary agent as shown in a flowchart in FIG. 38A. Value for TAG_READER_ID will be provided by store clients or by employee clients and will be captured and saved in store rack table for each OWNER_ID, STORE_ID and RACK_ID as shown in a class diagram, in FIGS. 34, 34A and 34B by the intermediary agent. Stores operator clients can attach tag readers with unique identifiers along with rack permission QR Codes to each rack. Stores can also sync racks with identifiers of tag readers attached to the said racks.

Each registered rack can have one or more bins. One or more item of the same product can be stocked in each bin. Same products can be stocked in more than one bin. Each bin will be fitted with an electronic sensor to protect the product being picked up without valid permission. Each sensor will have a unique sensor identifier.

Store operator clients would also register and maintain bin information using a bin maintenance web form provided by intermediary agent, in each store as shown in a flowchart in FIG. 35F. When ‘A’ for action is used, a unique bin identifier will be assigned by the intermediary agent, otherwise bin identifier will be provided by the store or employee client. Each bin will have a sensor and each sensor will have unique sensor identifier which may be assigned by sensor manufacturer. Sensors fitted to bins can sense the movement or products in the bin. When ‘A’ for action is used, the stores will provide values for OWNER_ID, STORE_ID, RACK_ID, SENSOR_ID, PRODUCT_ID, PRODUCT_INVENTORY and intermediary agent will assign a unique value for BIN_ID, otherwise stores will provide values for OWNER_ID. STORE_ID, RACK_ID, BIN_ID, SENSOR_ID, PRODUCT_ID and PRODUCT INVENTORY. Before saving the data in the store bin table, the intermediary agent would format the data for BIN_QR_CODE by concatenating the values ‘167’, ‘-’, OWNER_ID, ‘-’, STORE_ID, ‘-’, RACK_ID, ‘-’ and BIN_ID. The data will be saved in store bin table as shown in a class diagram, in FIGS. 34, 34A and 34B by intermediary agent. PRODUCT_ID must exist in store product table before being entered into store bin table. When a product is picked up from the bin, the product inventory in the bin will be automatically adjusted by intermediary agent. When a product is loaded into the bin, the product inventory will be adjusted by intermediary agent based on the number of items of the product being loaded. Stores would download BIN_QR_CODE as shown in a flowchart in FIG. 36D. The BIN_QR_CODE can be attached to each bin in each rack as shown in FIGS. 37A and 37B. The BIN_QR_CODE can be scanned by signed-in shoppers to view product information of the product stored in said bin. The BIN_QR_CODE is also referred to as bin permission QR Code. The unique bin permission QR Code can be used by signed-in shoppers to get bin permission or by shopper clients and unknown shoppers to sign-in and get a bin permission. When bin permission is granted and active, signed-in shoppers can pick products, one or more times, from the bin for which the permission is granted and active.

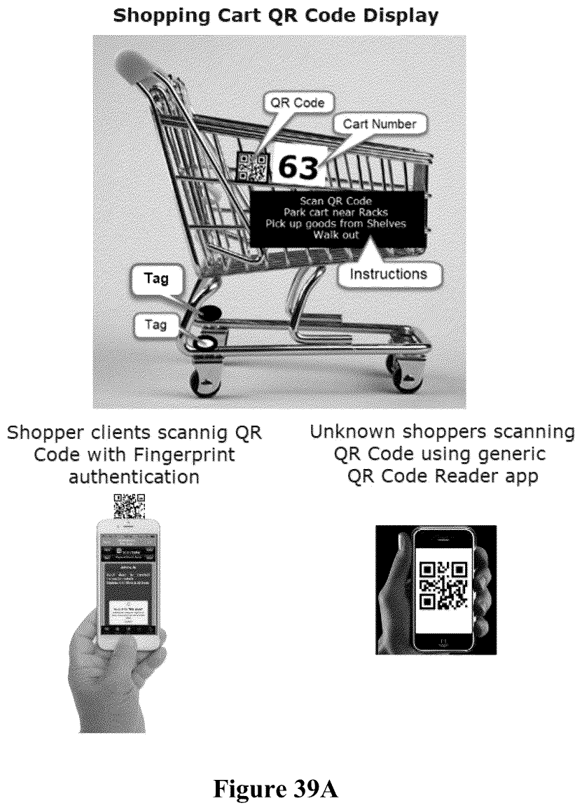

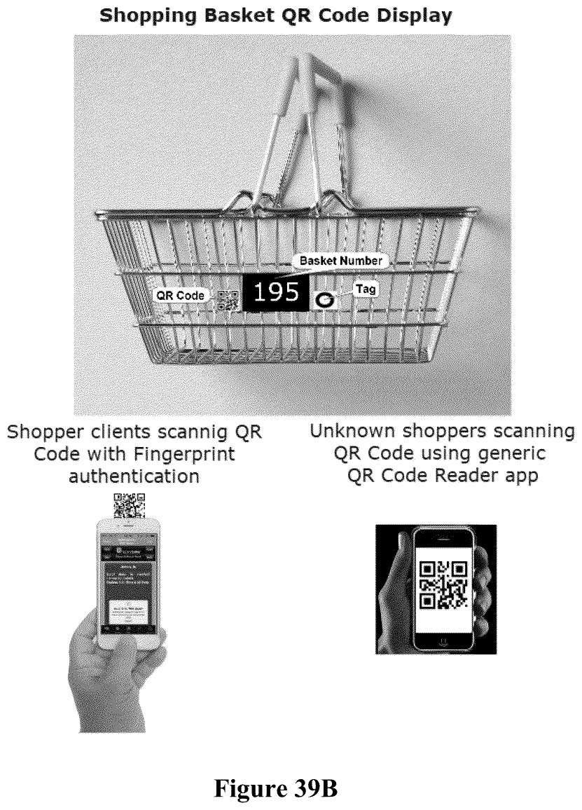

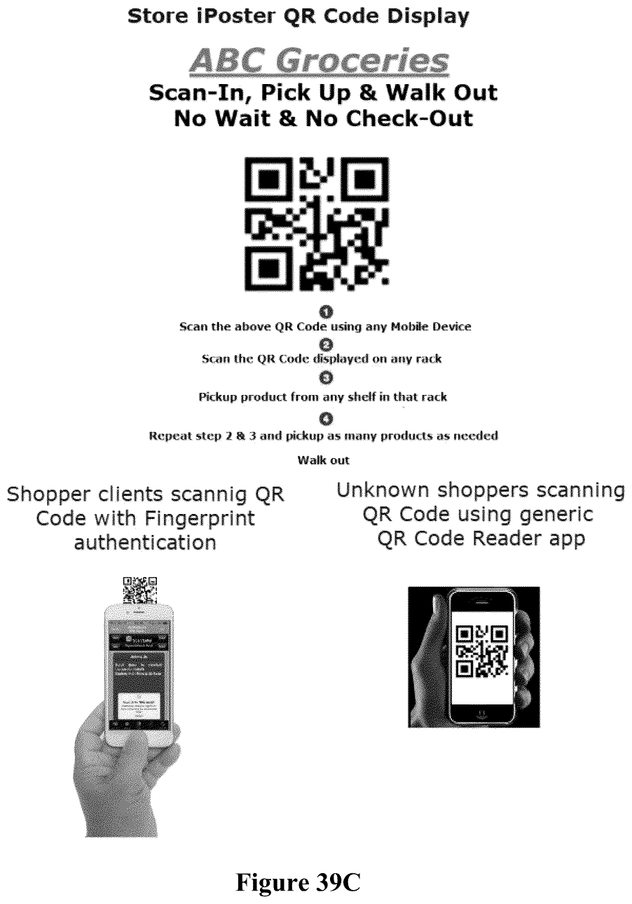

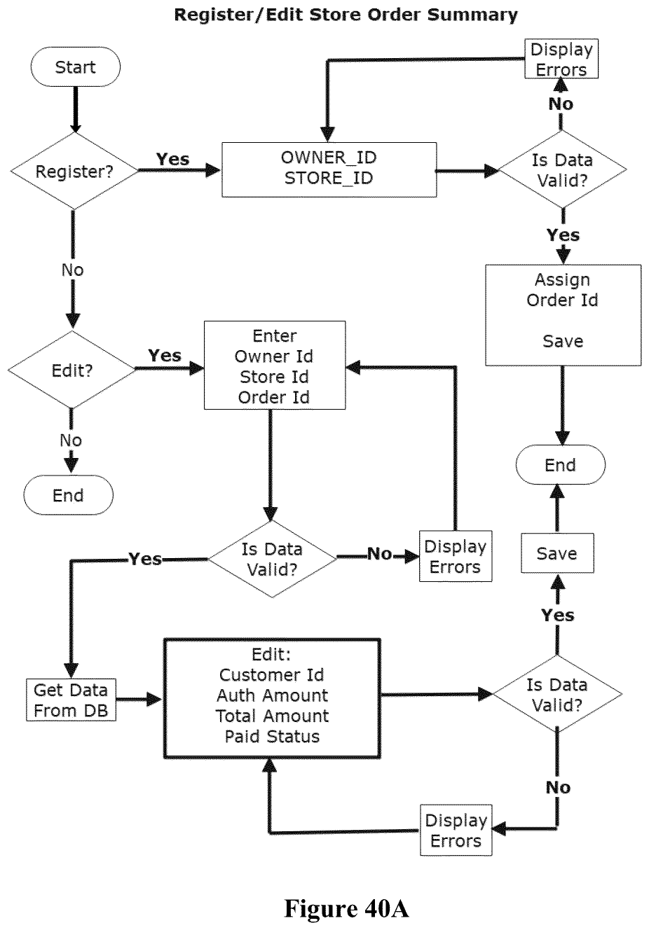

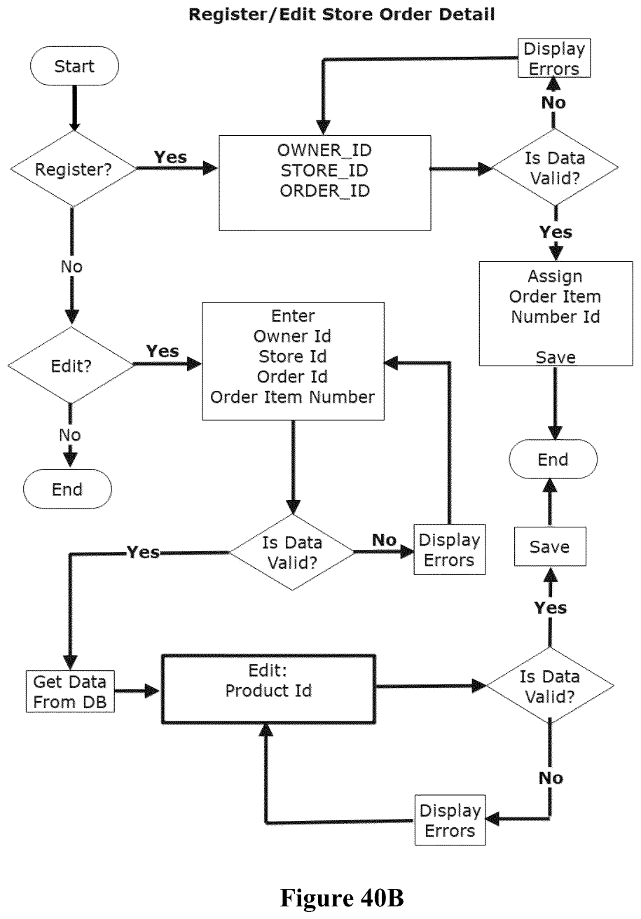

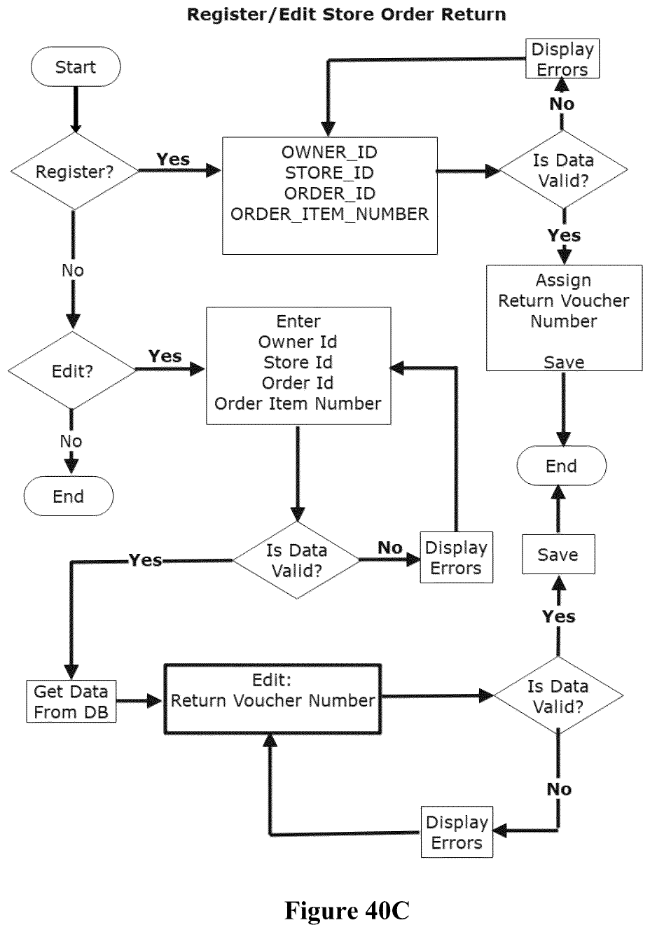

Each registered store can have one or more shopping carts and/or one or more shopping baskets. Each shopping cart and each shopping basket can have one or more machine-readable tags with unique tag identifiers. The value for tag identifiers may be assigned by tag manufacturers. Stores would also register and maintain cart and/or shopping basket information using a cart maintenance web form provided by intermediary agent, in each store as shown in a flowchart in FIG. 35G. When ‘A’ for action is used, a unique car/basket identifier will be assigned by the intermediary agent, otherwise cart/basket identifier will be provided by the store or employee client. When ‘A’ for action is used, the stores will provide values for OWNER_ID, STORE_ID, LEFT_TAG_ID, RIGHT_TAG_ID and intermediary agent will assign a unique value for CART_BASKET_ID, otherwise stores will provide values for OWNER_ID. STORE_ID, CART_BASKET_ID, LEFT_TAG_ID and RIGHT_TAG_ID. Before saving the data in the store bin table, the intermediary agent would create a QR Code based on the values of OWNER_ID. STORE_ID and CART_BASKET_ID, The data will be saved in store cart basket table as shown in a class diagram, in FIGS. 34, 34A and 34B by intermediary agent. Each shopping cart and/or shopping basket will be attached with a unique CART_BASKET_ID which is referred to as shopping 3 cart and/or shopping basket identifier and an unique associated CART_BASKET_QR_CODE which is referred as shopping cart or shopping basket assignment QR Code as shown in FIGS. 39A and 39B.

The unique shopping cart or shopping basket assignment QR Code can be used by signed-in shoppers to get a shopping cart or shopping basket assignment or by shopper clients and unknown shoppers to sign-in and get a shopping cart or shopping basket assignment. Signed-in shoppers can shop with or without the shopping cart and/or shopping basket. Stores would download shopping cart or shopping basket assignment QR Code and attach the said QR Code and the unique shopping cart identifier to each shopping cart or shopping basket as shown in a flowchart in FIG. 36A. Store operator clients can attach tags with unique tag identifiers along with assignment QR Codes to each shopping cart. Stores can also sync shopping carts with identifiers of tags attached to the said shopping carts. Store operator clients can attach tags with unique tag identifiers along with assignment QR Codes to each shopping basket. Stores can also sync shopping baskets with identifiers of tags attached to the said shopping baskets. Store operator clients can display and provide access to unique cart/basket QR Codes for signed-in shoppers to pick-up carts or baskets or for shopper clients and for unknown shoppers to sign-in and pick-up carts or baskets at the same time. Shopping cart and baskets can be left at unlimited number of spots.

Each registered store can have one or more iPosters printed with unique iPoster sign-in QR Code specific for each registered location. Stores would download iPoster Sign-in QR Code as shown in a flowchart in FIG. 36B, and create and display iPosters as shown in FIG. 39C. Each store location will be assigned with a unique STORE_ID and an associated LOCATION_QR_CODE under OWNER_ID and STORE_ID and saved in store location table as shown in a class diagram, in FIGS. 34, 34A and 34B by intermediary agent. The same iPoster can be displayed at any number of spots in each store as shown in FIG. 39C. The iPosters could be used by shopper clients and unknown shoppers to sign-in.

Store operator clients would display one or more racks in each registered store where products will be loaded in bins attached to racks as shown in a diagram in FIGS. 37A and 37B. The racks will also be fitted with pickup ready indicator green and red lights and tag reader. Each bin will also be fitted with sensor with unique identifier which will be electronically identified by intermediary agent. Each bin will also be identified by unique bin QR Code, and each rack will be identified by unique rack QR Code. Store operator clients can display and provide access to unique bin QR Codes on each bin in each rack for signed-in shoppers to get bin permission or for shopper clients and for unknown shoppers to sign-in and get bin permission at the same time.

Store operator clients would also sync each bin with a sensor identifier attached to the said bin and maintain bin and sensor identifier sync information with the intermediary agent as shown in a flowchart in FIG. 38B. Value for SENSOR_ID will be provided by store clients or by employee clients and will be captured and saved in Store Bin Table for each OWNER_ID, STORE_ID, RACK_ID and BIN_ID in Store Database as shown in a class diagram, in FIGS. 34, 34A and 34B by the intermediary agent.

Store operator clients would also sync each bin in each rack with a unique product identifier loaded into the said bin and maintain bin and product identifier sync information with the intermediary agent as shown in a flowchart in FIG. 38C. Value for PRODUCT_ID will be selected by store clients or by employee clients from store product table as shown in a class diagram, in FIGS. 34, 34A and 34B and will be captured and saved in store bin table for each OWNER_ID, STORE_ID, RACK_ID and BIN_ID as shown in a class diagram, in FIGS. 34, 34A and 34B by intermediary agent.

Store clients would also maintain product inventory in each bin in each rack as shown in a flowchart in FIG. 38E. Store clients would use the virtual terminal using an app and/or a browser. Stores can also scan the bin permission QR Code to maintain the product inventory. Product inventory will be saved in store bin table for each OWNER_ID, STORE_ID, RACK_ID and BIN_ID as shown in a class diagram, in FIGS. 34, 34A and 34B by intermediary agent.

Store clients can display and provide access to unique return station QR Codes for signed-in shoppers to return goods and exit or just exit.

Store clients can attach sensors with unique identifiers along with bin permission QR Codes to each bin. Stores can also sync bins with identifiers of sensors attached to the said bins.

Upon setting up all the required table in store database, the store will be ready to serve shoppers.

The intermediary agent would receive data from shopper clients, unknown shoppers, stores and employee clients through app gateway or through user interface. If the data is received through app gateway, then the origin of the data would be a shopper app issued by the intermediary agent or any third-party shopper app interfaced with the intermediary agent or any operator app issued by the intermediary agent. If the data is received through user interface, then the origin of the data would be a shopper website hosted by intermediary agent or any shopper website interfaced with the intermediary agent or operator dashboard hosted by intermediary agent or operator website hosted by intermediary agent. If the data is received through app gateway or through user interface, then the data might or might not include QR Code content. If the data includes QR Code content, then it will be categorized as scan data, otherwise will be categorized as input data.

The intermediary agent would also receive data related to event triggers from electronic hardware components through controller gateway. If the data is received through controller gateway, then the origin of the data would be a hardware component such as tag reader attached to a rack or a sensor attached to a bin. The data received through controller gateway will be categorized as controller data.

Irrespective of channel through which the data was received and irrespective of origin of the data, the intermediary agent would use application components and application components in turn would use database server to insert, update or retrieve rows from tables in customer database as shown in a class diagram in FIG. 10 and in store database as shown in a class diagram in FIGS. 34, 34A and 34B.

Shopper clients and unknown shoppers use the same procedure to purchase and pay. Shoppers will scan a QR Code displayed on an iPoster at the entrance. Signed-in shoppers can pick up products from any bins in any rack with valid permissions. When any product from any bin in any rack is picked up without a valid permission, the intermediary agent would activate still and/or video camaras to capture the image of the person picking up the product and alert employee clients and display the details in virtual terminal which can be accessed using mobile devices and/or desktop computers by the employee clients. This would ensure that the shoppers would be charged only for the products picked up by the said shoppers with valid permission and no product can be picked up without valid permission. The shoppers scan a QR Code displayed on the shopping cart or basket. Then the shoppers would park the shopping cart or place the basket in a rack to get the permission to pick up any item from the rack. When the shopping cart or basket is removed from the rack, the shopper will not have permission to pick up any item from the rack. Shoppers with shopping cart or shopping basket can get the valid permission from the intermediary agent by parking the shopping cart or by placing the shopping basket such a way that the machine-readable tag reader attached to the rack will be able to read one of the machine-readable tags attached to the shopping cart or to the shopping basket. Upon verification of the machine-readable tag, the signed-in shoppers with shopping cart or shopping baskets would get the permission from the intermediary agent to pick any product from any bin within the rack for which the shopper has received the permission. Shoppers without shopping cart or shopping baskets can get the valid permission from the intermediary agent by scanning the QR Code displayed on the rack. Upon verification of the scanned QR Code, the signed-in shoppers would get the permission from the intermediary agent to pick any product or products from any bin within the rack for which the shopper has received the permission. If the shopper is an unknown shopper, then the unknown shopper would also provide the one-time code that the unknown shopper received at the time of signing-in. As an indication that a shopper is granted permission to pick any product from any bin for any number of times within a rack, the green light attached to the said rack will be turned on and the red light attached to the rack will be turned off. If machine-readable tags attached to the shopping cart or the shopping basket is used to get the permission, then the permission will be revoked when the shopping cart of shopping basket is removed from the tag reader attached to the rack. If a QR Code attached to the rack is used to get the permission, then the permission will be revoked when the shopper requests the intermediary agent to revoke the permission. As an indication that the permission to pick any product from any bin for any number of times within a rack is revoked, the red light attached to the said rack will be turned on and the green light attached to the rack will be turned off. Shoppers can also get a single bin permission from the intermediary agent to pick up a product one or more times by scanning the QR Code displayed on the bin. Upon verification of the scanned QR Code, the signed-in shoppers would get the permission from the intermediary agent to pick a product one or more times from the permitted bin. Once the shoppers picked up the items for a preset number of times, the permission will be revoked. If the shopper is an unknown shopper, then the unknown shopper would also provide the one-time code that the unknown shopper received at the time of signing-in. Upon expiration of a pre-determined time limit, the permission will be revoked. On the other hand, signed-in shoppers can also request the intermediary agent to revoke the single bin permission from their mobile devices. Signed-in shoppers can view the permission details on their mobile devices. The shoppers can also scan the QR Code displayed on the bin to revoke the permission.

At the end of shopping, shoppers can scan the QR Code displayed on a iPoster at the exit and leave the store. If any picked item is to be returned, then shoppers before exiting would scan the items to be returned, leave them at the return drop box and get a receipt for the returned items. Shoppers can leave picked up but unwanted products in one or more stations specifically placed to accept returns near exits. If there are any product/s to be returned, signed-in shoppers can select the product/s to be returned from the order details displayed on their mobile devices and pick up a return receipt printed with information about returned product/s from a cloud printer attached to the return station. The return receipt would also include instructions on how to open one of the electronic lockers attached to the return station. Signed-in shoppers can leave product/ss to be returned and the printed receipt inside a locker as per the instructions printed on the receipt. If there are no product/s to be returned, signed-in shopper clients can use the app and signed-in unknown shopper ca use the browser to notify the intermediary agent that the signed-in shopper is exiting. This would ensure that signed-in shoppers can return unwanted products without using an employee managed return counters and also signed-in shoppers can exit without going through check-out counters. If there are no product pick-ups for a pre-determined time, the signed-in shoppers will be automatically singed-out.

When an individual scans a QR Code displayed at any store using an app provided by the intermediary agent or an app interfaced with intermediary agent or any generic QR Code Reader app or a camera, the content of the QR Code will be passed on to QR Code web page hosted by intermediary agent, upon verification of the QR Code by the QR Code web page, the information will be passed on to the request handler process in the intermediary agent to initiate a request handler process as described in ‘DETAILED DESCRIPTION OF THE PREFERRED EMBODIMENTS’ section and the request handler process will continue here. When a QR Code is scanned by an individual, the request handler process would have saved the request message embedded in the QR Code as request message and the information of the individual scanned the QR Code as customer identifier, customer type, customer name, customer business name, customer employee title, customer latitude and customer longitude.

The request handler process would save the values of customer identifier, customer type, customer name, customer business name, customer employee title, customer latitude and customer longitude as current shopper identifier, current shopper identifier type, current shopper name, current shopper business name, current shopper employee title, current shopper latitude and current shopper longitude respectively.

If the current shopper identifier type is ‘C’, then the individual scanned the QR Code will be referred to as current shopper client and does not represent any business. If the current shopper identifier type is ‘M’, then the individual scanned the QR Code will be referred to as current shopper client and represents a business. If the current shopper identifier type is ‘U’, then the individual scanned the QR Code will be referred to as current unknown shopper. The current shopper client or the current unknown shopper will be referred to as current shopper.

All shoppers currently present at the store location other than the current shopper will be referred to as current fellow shoppers.

Then the request handler process would segregate the request message, based on a pre-defined procedure into at least three segments namely application identifier, owner identifier, and store identifier respectively. If the request handler process cannot break the request message into at least three segments the request handler process will be terminated. If the application identifier is not for processing QR Codes for store sign-in or store sign-out or cart/backet assignment or rack access or bin access, then the request handler process will be terminated. Application identifier ‘77’ may be for store sign-in, ‘127’ may be for cart/basket assignment, ‘147’ may be for rack access or ‘167’ may be for bin access and ‘187’ may be for store sign-out. If the application identifier is ‘127’ or ‘147’, then the request message will have at least 4 segments. If the application identifier is ‘127’ or ‘147’ and if the request message does not have at least 4 segments, then the request handler process will be terminated. If the application identifier is ‘167’, then the request message will have at least 5 segments. If the application identifier is ‘167’ and if the request message does not have at least 5 segments, then the request handler process will be terminated.

Then the request handler process would retrieve LATITUDE as store latitude and LONGITUDE as store longitude from store location table in store database (58-19) using owner identifier for OWNER_ID and store identifier for STORE_ID. If the request handler process can retrieve store latitude and store longitude information, then the request handler process will continue otherwise it will be terminated.

In the case of a current shopper client the request handler process would also have received the location information of current shopper client (current latitude and longitude) of the mobile device used by the current shopper client. Then the request handler process would determine whether the current shopper client's location is within a certain limit from the store location based on current shopper client's mobile device latitude and longitude and store latitude and longitude. If the distance between the current shopper client's location and store location is within a certain limit, then the request handler process will continue, otherwise it will be terminated.

In the case of a current unknown shopper the request handler process would also have received the location information of the internet service provider (ISP latitude and longitude) providing internet service for the current unknown shopper. Then the request handler process would determine whether the current unknown shopper's ISP location is within a certain limit from the store location based on ISP latitude and longitude and store latitude and longitude. If the distance between ISP location and store location is within a certain limit, then the request handler process will continue, otherwise it will be terminated.

If the application identifier ‘107’ or ‘127’ or ‘147’ or ‘167’ or ‘187, then the request handler process will continue, otherwise the request handler process will be terminated.

If the application identifier ‘107’, the request handler process will execute SHOPPER_SIGN_IN_PROCESS. If the application identifier ‘127’, then the request handler process would segregate the request message, based on a pre-defined procedure into 4 segments namely application identifier, owner identifier, store identifier and shopping cart basket identifier respectively and would execute SHOPPER_CART_BASKET_ASSIGNMENT_PROCESS. If the application identifier is ‘147’, then the request handler process would segregate the request message, based on a pre-defined procedure into 4 segments namely application identifier, owner identifier, store identifier and rack identifier respectively and the request handler process will execute SHOPPER_RACK_PERMISSION_PROCESS. If the application identifier is ‘167’, then the request handler process would segregate the request message, based on a pre-defined procedure into 5 segments namely application identifier, owner identifier, store identifier, rack identifier and bin identifier respectively and the request handler process will execute SHOPPER_BIN_PERMISSION_PROCESS. If the application identifier is ‘187’, then the request handler process would segregate the request message, based on a pre-defined procedure into 3 segments namely application identifier, owner identifier, and store identifier respectively and the request handler process will execute SHOPPER_EXIT_PROCESS.

SHOPPER_SIGN_IN_PROCESS, SHOPPER_CART_BASKET_ASSIGNMENT_PROCESS, SHOPPER_RACK_PERMISSION_PROCESS, SHOPPER_BIN_PERMISSION_PROCESS and SHOPPER_EXIT_PROCESS are further described in greater detail herein.

### Shopper_Sign in Process:

The request handler process would confirm that an unpaid payment does not exist currently in store order summary table for the current shopper. The request handler would retrieve latest row of the current shopper from store order summary table using owner identifier for OWNER_ID, store identifier for STORE_ID, ORDER_ID in ascending sequence, current shopper identifier type for SHOPPER_ID_TYPE and current shopper identifier for SHOPPER_ID. If request handler can retrieve one row and if the value of PAID STATUS in the retrieved row is ‘U’, then the current shopper will be direct to SHOPPER_MOBILE_MENU_PAGE.

Once it is determined that an unpaid payment does not exist currently in store order summary table for the current shopper, the request handler would get payment information from the current shopper.

In case of shopper client, the request handler would let the shopper client to select a PAYMENT_ID from customer payment table where CUSTOMER_ID is current shopper identifier and request handler would save the PAYMENT_ID as current shopper payment identifier. When a PAYMENT_ID is selected, the request handler would save the PAYMENT_ACCOUNT_NUMBER as current shopper payment account number, PAYMENT_EXPIRATION_DATE as current shopper payment account expiration date and PAYMENT_SECURITY_CODE as current shopper payment security code from customer payment table where CUSTOMER_ID is current shopper identifier and PAYMENT_ID is current shopper payment identifier.

In case of unknown shopper, the request handler would capture current shopper payment account number, current shopper payment expiration date and current shopper payment security code from unknown shopper. If request handler gets current shopper payment account number, current shopper payment expiration date and current shopper payment security code from unknown shopper, the request handler would save a blank as current shopper payment identifier and the process will continue, otherwise it will be terminated.

If the process continues, then the request handler would use the administration component under application server to receive an authorization code for a preset authorize amount set by the store or by the intermediary agent from a payment processor using current shopper payment account number, current shopper payment expiration date and current shopper payment security code. For example, operator client can set $75.00 as preset authorize amount. If the operator client has not set any preset authorize amount, then the intermediary agent would use an amount set by the intermediary agent as preset authorize amount. If getting an authorization code from a payment processor for a preset authorize amount is successful, then the process will continue otherwise it will be terminated.

Then the request handler would insert a new row in store order summary table in store database (58-19). The request handler would retrieve the last (maximum) order identifier from store order summary table using owner identifier for OWNER_ID and store identifier for STORE_ID. If the request handler retrieves last order identifier, then the request handler would set current shopper order identifier by incrementing the last order identifier by 1, otherwise the request handler would set current shopper order identifier as 1. Then the request handler would insert a new row in store order summary table using owner identifier for OWNER_ID, store identifier for STORE_ID, current shopper order identifier for ORDER_ID, current shopper identifier for SHOPPER_ID, current shopper identifier type for SHOPPER_ID_TYPE, current shopper payment identifier for PAYMENT_ID, current shopper identifier name PAYMENT_ACCOUNT_NAME, current shopper account number payment PAYMENT_ACCOUNT_NUMBER, current shopper payment expiration date PAYMENT_EXPIRATION_DATE, current shopper payment security code PAYMENT_SECURITY_CODE, preset authorize amount for AUTH_AMOUNT, 0 for ORDER_AMOUNT, 0 for RETURN_AMOUNT, ‘U’ for PAID_STATUS, blank value for CART_BASKET_ID, server date for BEGIN_DATE, server time for BEGIN_TIME, blank for END_DATE and blank for END_TIME.

If the process of inserting a new row in store order summary table, then the process will continue, otherwise it will be terminated.

If current shopper is a current unknown customer, then the request handler process will save the values of current shopper identifier type, current shopper identifier, current shopper name, current shopper business name and current shopper employee title as CURRENT_CUSTOMER_TYPE cookie, CURRENT_CUSTOMER_ID cookie and CURRENT_CUSTOMER_NAME cookie CURRENT_CUSTOMER_BUSINESS_NAME cookie, and CURRENT_CUSTOMER_EMPLOYEE_TITLE cookie respectively in the current browser and request handler process will continue, otherwise the request handler process will delete the cookies CURRENT_CUSTOMER_TYPE cookie, CURRENT_CUSTOMER_ID cookie, CURRENT_CUSTOMER_NAME cookie, CURRENT_CUSTOMER_BUSINESS_NAME cookie, and CURRENT_CUSTOMER_EMPLOYEE_TITLE cookie and the request handler process will be terminated.

Upon adding the new row in store order summary table for current shopper, the intermediary agent would also setup a communication gateway for the said current shopper to communicate with employee clients through text and or video. Current shopper client can communicate using the app provided by the intermediary agent or any app interfaced with intermediary agent whereas current unknown shopper can communicate using a browser. The employee clients can communicate using an app and/or a browser. If the intermediary agent cannot setup a communication gateway for video communication, then the employee client would use an external communication channel and share the external communication channel credentials with the current shopper through the communication gateway setup by the intermediary agent. At any event, the current shopper can communicate with employee clients and also with fellow current shoppers in the store where OWNER_ID is equal to owner identifier and STORE_ID is equal to store identifier.

If the process is terminated, the request handler would notify the current shopper that the process was terminated and the reason for termination.

If the application identifier in the QR Code that directed the current shopper to SHOPPER_SIGN_IN_PROCESS is 107, then the intermediary agent would notify the current shopper that the process was executed successfully and current shopper will be directed to SHOPPER_MOBILE_MENU_PAGE.

If the application identifier in the QR Code that directed the current shopper to SHOPPER_SIGN_IN_PROCESS is 127, then the current shopper will be directed to SHOPPER_CART_BASKET_ASSIGNMENT_PROCESS.

If the application identifier in the QR Code that directed the current shopper to SHOPPER_SIGN_IN_PROCESS is 147, then the current shopper will be directed to SHOPPER_RACK_PERMISSION_PROCESS.

If the application identifier in the QR Code that directed the current shopper to SHOPPER_SIGN_IN_PROCESS is 167, then the current shopper will be directed to SHOPPER_BIN_PERMISSION_PROCESS.

If the application identifier in the QR Code that directed the current shopper to SHOPPER_SIGN_IN_PROCESS is 187, then the intermediary agent would notify the current shopper that the process was executed successfully and current shopper will be directed to SHOPPER_MOBILE_MENU_PAGE.

In addition to processing the data scanned by shoppers, the intermediary agent would also process the incoming data received by the intermediary agent through controller gateway.

The intermediary agent would process controller data from controllers and sensors to update data in store database. To process controller data, the intermediary agent would use controller processes namely CONTROLLER_TAG_READER_PROCESS and CONTROLLER_SENSOR_PROCESS which may be hosted under controller agent. Controller processes CONTROLLER_TAG_READER_PROCESS and CONTROLLER_SENSOR_PROCESS are only examples and any number of controller processes can be used. CONTROLLER_TAG_READER_PROCESS and CONTROLLER_SENSOR_PROCESS are further described in greater detail herein. It is beyond the scope of this invention to fully describe all the electronic devices that can be installed in store locations, the content of data exchanged between electronic devices and intermediary agent and the method of exchange between electronic devices and intermediary agent. The information provided herein is only to illustrate how electronic devices can monitor product pick up and secure products from being shop lifted.

If the incoming data is received through controller gateway has values for parameter TAG_READER_ID to access the data from store rack table in store database as shown in a class diagram in FIG. 34, then the intermediary agent would consider the origin of the incoming data is a tag reader. If the incoming date is received through controller gateway has values for parameter SENSOR_ID to access the data from store bin table in store database as shown in a class diagram in FIG. 34, then the intermediary agent would consider the origin of the incoming data is a sensor. If the incoming date is received through controller gateway and if the origin of the incoming data is not a tag reader and is not a sensor, then the process will be terminated. If the incoming data is received through controller gateway, then the incoming data will be categorized as controller data. If the received data is characterized as controller data and if the origin of the incoming data is a tag reader, then the process will be directed to CONTROLLER_TAG_READER_PROCESS. If the received data is characterized as controller data and if the origin of the incoming data is a sensor, then the process will be directed to CONTROLLER_SENSOR_PROCESS.

Operators and employees can use a Virtual Terminal hosted by an intermediary agent to update data in various tables in store database.

Virtual Terminal is further described in greater detail herein. It is beyond the scope of this invention to fully describe all the functions that can be included in Virtual Terminal and the content of data exchanged between Virtual Terminal and intermediary agent and the method of exchange between Virtual Terminal and intermediary agent. The information provided herein is only to illustrate how Virtual Terminal can automate the back end of the automation.

### Shopper_Mobile_Menu_Page:

When SHOPPER_MOBILE_MENU_PAGE is executed, the request handler process will have the values for application identifier, owner identifier, store identifier, current shopper identifier and current shopper identifier type. The request handler process may also have value for a success message or value for an error message. The request handler process may also have value for shopping cart and basket identifiers. The request handler process may also have value for rack and bin permission statuses.

The SHOPPER_MOBILE_MENU_PAGE will be accessible from current shopper's mobile device from the time the current shopper is signed in and until the current shopper signs out. Using the SHOPPER_MOBILE_MENU_PAGE, the shoppers can view the details of items picked up from the bins and the details of items returned. Shoppers can also use the SHOPPER_MOBILE_MENU_PAGE to communicate using text or video with employees and fellow shoppers.

The SHOPPER_MOBILE_MENU_PAGE will refresh itself at a preset interval to process and display the most rennet data from the store database. The SHOPPER_MOBILE_MENU_PAGE can also be refreshed by current shopper by tapping on a refresh button in the SHOPPER_MOBILE_MENU_PAGE.

The request handler process would confirm that an active order does exist currently in store order summary table for the current shopper. The request handler would retrieve the most recent row for the current shopper from store order summary table using owner identifier for OWNER_ID, store identifier for STORE_ID, ORDER_ID is not blank, current shopper identifier type for SHOPPER_ID_TYPE and current shopper identifier for SHOPPER_ID ORDER BY BEGIN_DATE DESC, BEGIN_TIME DESC. If the request handler process can retrieve one row and it the value of PAID_STATUS in the retrieved row is ‘U’, then the request handler process would save the value of ORDER_ID and AUTH_AMOUNT as database order identifier and database authorized amount respectively and continue, otherwise the request handler process will display an error message, the request handler process will be terminated, and the current shopper cannot access the SHOPPER MOBILE_MENU_PAGE.

If the database authorized amount is greater than 0, then the request handler would create a product array with columns for detail number, identifier, description, price and return status. The request handler would load the columns detail number and identifier in the product array with the values of ORDER_DETAIL_NUMBER and PRODUCT_ID respectively from each row in store order detail table where OWNER_ID is store operator identifier, STORE_ID is store identifier, ORDER_ID is database order identifier. If the number of rows loaded in product array is one or more than 1, then the request handler would load the columns description and price in the product array with the values of DESCR and PRICE respectively for each identifier in the product array from store product table where OWNER_ID is store operator identifier, STORE_ID is store identifier, PRODUCT_ID is the value from column identifier in product array. If description and price columns in product array is populated for all the identifiers in the product array, then the request handler would populate blanks as the return status for each item in the product array. The request handler would retrieve one row for each detail number in the product array from store order return table using OWNER_ID is store operator identifier, STORE_ID is store identifier, ORDER_ID is database order identifier and ORDER ITEM NUMBER is detail number in the product array. If the request handler retrieves one row from store order return table for a detail number in the product array, then the request handler would populate the value of return status in the product array for the detail number in the product array as ‘RETUNED’. Then the request handler would display the content of the product array in the SHOPPER MOBILE_MENU_PAGE. The request handler would also display the database authorized amount and the total of price column for all the detail numbers excluding the detail numbers that are marked as ‘RETURNED’ in the return status column.

Then the request handler would display the current rack and bin permission details. The request handler would retrieve the latest single row from store order permission table where OWNER_ID is owner identifier, STORE_ID is store identifier, ORDER_ID is database order identifier and searching BEGIN_DATE and BEGIN_TIME in a descending order. If the value of END_DATE and END_TIME from the single retrieved row are blank, then the request handler would save the values of RACK_ID, BIN_ID, ALLOWED_COUNT and PICKED_COUNT from the single retrieved row as database rack identifier, database bin identifier, database allowed count and database picked count respectively, otherwise the request handler would save blank value, blank value, 0 and 0 for database rack identifier, database bin identifier, database allowed count and database picked count respectively. If database rack identifier and database bin identifier are not blank, then the request handler would display a message stating that the shopper has permission to pick up the product from a bin identified by database rack identifier and database bin identifier. The display message would also include the values of database allowed count and database picked count. If the database rack identifier is not blank and database bin identifier is blank, then the request handler would display a message stating that the shopper has permission to pick up the product from any bin in the rack identified by database rack identifier. The display message would also include the values of database allowed count and database picked count.

Then the request handler would display the current communication details using current shopper identifier and current shopper identifier type for STARTER_ID and STARTER_ID_TYPE. This would ensure that the current communication details are started by current shopper identifier and current shopper identifier type. The current communication details may be for text or for video or for both. The request handler would retrieve the latest rows from store text starter table where OWNER_ID is owner identifier, STORE_ID is store identifier, TEXT_SEQ is greater than 0, STARTER_ID is current shopper identifier, STARTER_ID_TYPE is current shopper identifier type and STATUS is ‘A’ ORDER BY TEXT SEQ DESC. If the request handler retrieves one or more rows from store text starter table, then the request handler would save the values of TEXT_SEQ, PARTICIPANT_ID_TYPE, SUBJECT, BODY and ATTACHMENT from the retrieved rows as database text sequence, database participant identifier type, database subject, database body and database attachment in an array. If one or more rows are retrieved, then the request handler would display a message stating that the shopper is in text communication. The display message would also include the values of database participant identifier type, database subject, database body and database attachment. Then the request handler would retrieve rows from store text response table for each row in the array where OWNER_ID is owner identifier, STORE_ID is store identifier and TEXT_SEQ is database text sequence from the array ORDER BY RESPONSE_SEQ DESC. If the request handler retrieves one or more rows from store text response table for each retrieved row from store text starter table, then the request handler would save the values of RESPONSE_ID_TYPE, RESPONSE_ID, BODY and ATTACHMENT as database response identifier type and database response identifier, response body and response attachment respectively. In some embodiments for the sake of security, the request handler would use database response identifier type token and database response identifier token instead of database response identifier type and database response identifier. The display message would also include the values of database response identifier type and database response identifier or database response identifier type token and database response identifier token. The display message would also include the values of response body and response attachment.

Then the request handler would display the current communication details using current shopper identifier and current shopper identifier type for RESPONSE_ID and RESPONSE_ID_TYPE when accessing the data from store text response table. This would ensure that the current communication details are responses from current shopper identifier and current shopper identifier type. The current communication details may be for text or for video or for both. The request handler would retrieve the latest rows from store text starter table where OWNER_ID is owner identifier, STORE_ID is store identifier, TEXT_SEQ is greater than 0, STARTER_ID is not blank, STARTER_ID_TYPE is not blank and STATUS is ‘A’ ORDER BY TEXT_SEQ DESC. The request handler would skip rows where the values of STARTER ID and STARTER_ID_TYPE in the retrieved rows is equal to current shopper identifier and current shopper identifier type respectively. If the request handler retrieves at least one row after skipping the rows, if any, from store text starter table, then the request handler would save the values of TEXT_SEQ, STARTER_ID, STARTER_ID_TYPE, PARTICIPANT_ID_TYPE, SUBJECT, BODY and ATTACHMENT from the retrieved rows as database text sequence, database starter identifier, database starter identifier type, database participant identifier type, database subject, database body and database attachment in an array. Then the request handler would retrieve rows from store text response table for each row tin the array where OWNER_ID is owner identifier, STORE_ID is store identifier, TEXT_SEQ is database text sequence from the array, RESPONSE_ID_TYPE is current shopper identifier type and RESPONSE_ID is current shopper identifier ORDER BY RESPONSE_SEQ DESC.

If the request handler retrieves one or more rows from store text response table for each retrieved row from store text starter table, then the request handler would display a message stating that the shopper is in response communication. The display message would also include the values of database starter identifier, database starter identifier type, database subject, database body and database attachment. In some embodiments for the sake of security, the request handler would use database starter identifier type token and database starter identifier token instead of database starter identifier type and database starter identifier.

The SHOPPER_MOBILE_MENU_PAGE will have several options for the current shoppers to execute until the current shoppers decide to sign-out. At a minimum the SHOPPER_MOBILE_MENU_PAGE will have options ‘Start Text Communication’, ‘Start Meeting Communication’, and ‘Respond Text Communication’.

When the current shopper selects the option ‘Start Text Communication’, the administrative component will process the request and upon verification, would make a text communication available for the current shopper with employees or with other current shoppers. If the intermediary agent is not set up to provide a text communication gateway, then the intermediary agent will display an error indicating the request is invalid and terminate. Then the administrative component will retrieve a row from store order summary table using owner identifier for OWNER_ID, store identifier for STORE_ID, ORDER_ID is greater than blank, current shopper identifier for SHOPPER_ID and current shopper identifier type for SHOPPER_ID_TYPE order by BEGIN_DATE DESC, BEGIN_TIME DESC. If the administrative component retrieves one row from store order summary table then the administrative component would save the value of PAID_STATUS from the retrieved row as database paid status, otherwise the administrative component would save a blank value for database paid status. If database paid status is not ‘U’ then the administrative component will display an error indicating the request is invalid and terminate. This will ensure that the current shopper has not signed out. Then the administrative component would capture a value of ‘E’ or ‘S’ from the current shopper for new participant identifier type. A value of ‘E’ would denote that the new participant identifier type is an employee and a value of ‘S’ would denote that the new participant identifier type is a fellow shopper. Then the administrative component would capture a values for subject, body and attachment from the current shopper for new subject, new body and new attachment respectively. Then the administrative component will retrieve a row from store text starter table using owner identifier for OWNER_ID, store identifier for STORE_ID and TEXT_SEQ is equal to (maximum of (TEXT_SEQ) for the same OWNER_ID and STORE_ID). If the administrative component can retrieve one row then the administrative component would set the value of TEXT_SEQ from the retrieved row plus 1 as new text sequence, otherwise the administrative component would set 1 as new text sequence. Upon capturing the required information from the current shopper and setting up a value for new text sequence, the administrative component will insert a new row into store text starter table using owner identifier for OWNER_ID, store identifier for STORE_ID, new text sequence for TEXT_SEQ, current shopper identifier type for STARTER_ID_TYPE, current shopper identifier for STARTER_ID, new participant identifier type for PARTICIPANT_ID_TYPE, new subject for SUBJECT, new body for BODY, new attachment for ATTACHMENT and ‘A’ for STATUS.

When the current customer signs out, the sign-out process would update STATUS as ‘I’ in store text starter table, where OWNER_ID is equal to owner identifier, STORE_ID is equal to store identifier, and TEXT_SEQ is equal to new text sequence.

Upon starting text communications, the current customers can communicate using texts with employees and with fellow customers using text communication component (58-9).

Then the administrative component will refresh the SHOPPER_MOBILE_MENU_PAGE and display a successful message indicating that a text communication has been started.

When the current shopper selects the option ‘Start Meeting Communication’, the administrative component will process the request and upon verification, would make a meeting communication available for the current shopper with employees or with other current shoppers. If the intermediary agent is set up to provide a meeting communication gateway, then the current shopper would receive a meeting URL and a meeting access code from the intermediary agent, otherwise the current shopper would receive a URL and a meeting access code from third party meeting service providers such as Google meet and zoom. Then the administrative component will retrieve a row from store order summary table using owner identifier for OWNER_ID, store identifier for STORE_ID, ORDER_ID is greater than blank, current shopper identifier for SHOPPER_ID and current shopper identifier type for SHOPPER_ID_TYPE order by BEGIN_DATE DESC, BEGIN_TIME DESC. If the administrative component retrieves one row from store order summary table, then the administrative component would save the value of PAID_STATUS from the retrieved row as database paid status, otherwise the administrative component would save a blank value for database paid status. If database paid status is not ‘U’ then the administrative component will display an error indicating the request is invalid and terminate. This will ensure that the current shopper has not signed out. Then the administrative component would capture a value of ‘E’ or ‘S’ from the current shopper for new participant identifier type. A value of ‘E’ would denote that the new participant identifier type is an employee and a value of ‘S’ would denote that the new participant identifier type is a fellow shopper. Then the administrative component would capture a value of meeting URL and a value for meeting password from the current shopper. Then the administrative component will retrieve a row from store meeting starter table using owner identifier for OWNER_ID, store identifier for STORE ID and MEETING_SEQ is equal to (maximum of (MEETING_SEQ) for the same OWNER_ID and STORE_ID). If the administrative component can retrieve one row then the administrative component would set the value of MEETING_SEQ from the retrieved row plus 1 as new meeting sequence, otherwise the administrative component would set 1 as new meeting sequence.

Upon capturing the required information from the current shopper and setting up a value for new meeting sequence, the administrative component will insert a new row into store meeting starter table using owner identifier for OWNER_ID, store identifier for STORE_ID, new meeting sequence for MEETING_SEQ, current shopper identifier type for STARTER_ID_TYPE, current shopper identifier for STARTER_ID, new participant identifier type for PARTICIPANT_ID_TYPE, meeting URL for MEETING_HOSTING_URL, meeting password for MEETING_ACCESS_CODE and ‘A’ for STATUS. When the current customer signs out, the sign-out process would update STATUS as ‘I’ in store meeting starter table, where OWNER_ID is equal to owner identifier, STORE_ID is equal to store identifier, and MEETING_SEQ is equal to new meeting sequence.

Upon starting meeting communications, the current customers can communicate using meetings with employees and with fellow customers using meeting URL and meeting password.

Then the administrative component will refresh the SHOPPER_MOBILE_MENU_PAGE and display a successful message indicating that a meeting communication has been started.

When the current shopper selects the option ‘Respond Text Communication’, the administrative component will process the request and upon verification, would add a response to a text communication. Then the administrative component will retrieve a row from store order summary table using owner identifier for OWNER_ID, store identifier for STORE_ID, ORDER_ID is greater than blank, current shopper identifier for SHOPPER ID and current shopper identifier type for SHOPPER_ID_TYPE order by BEGIN_DATE DESC, BEGIN_TIME DESC. If the administrative component retrieves one row from store order summary table, then the administrative component would save the value of PAID_STATUS from the retrieved row as database paid status, otherwise the administrative component would save a blank value for database paid status. If database paid status is not ‘U’ then the administrative component will display an error indicating the request is invalid and terminate. This will ensure that the current shopper has not signed out. Then the administrative component would display the details of currently active text communications where current shoppers can add a response, so that the current shopper can select an active text communication.

Then the administrative component would retrieve all rows from store text starter table using owner identifier for OWNER_ID, store identifier for STORE_ID, TEXT_SEQ is greater then 0, ‘S’ for PARTICIPANT_ID_TYPE and ‘A’ for STATUS ORDER BY TEXT_SEQ DESC.

If the administrative component retrieves one or more rows, then the administrative component would save the values of TEXT_SEQ, SUBJECT, BODY and ATTACHMENT as array text sequence, array subject, array body and array attachment in an array, otherwise the administrative component would display a message indicating that no text communication is available and terminate.

Then the administrative component would display the values of array text sequence, array subject, array body and array attachment from each row in the array and would accept the value of array text sequence from a single row in the array as a selected text sequence.

Then the administrative component would accept a text as response text. The administrative component can also accept an attachment as response attachment, otherwise a blank will be saved as response attachment.

Upon receiving selected text sequence, response text and response attachment, the administrative component would retrieve a row from store text response table using owner identifier for OWNER_ID, store identifier for STORE_ID, selected text sequence for TEXT_SEQ and RESPONSE_SEQ is equal to (maximum of (RESPONSE_SEQ) for the same OWNER_ID, STORE ID and TEXT_SEQ). If the administrative component retrieves one row then the administrative component will save the value of RESPONSE_SEQ from the retrieved row plus 1 as new response sequence, otherwise the administrative component will save 1 as new response sequence. Then the administrative component would insert a row into store text response table using owner identifier for OWNER_ID, store identifier for STORE_ID, selected text sequence for TEXT_SEQ, new response sequence for RESPONSE_SEQ, current shopper identifier type for RESPONSE_ID_TYPE, current shopper identifier for RESPONSE_ID, response text for BODY and response attachment for ATTACHMENT.

Then the administrative component will refresh the SHOPPER_MOBILE_MENU_PAGE and display a successful message indicating that a response to a text communication has been added.

### Shopper_Cart_Basket_Assignment_Process:

When this process is executed, the request handler would have the values for application identifier, owner identifier, store identifier, current shopper identifier, current shopper identifier type and shopping cart basket identifier, otherwise the process will be terminated.

If the application identifier is 127 then the process will continue, otherwise it will be terminated.

The request handler would determine the current order identifier by retrieving the most recent row from store order summary table for the current shopper identifier and current shopper identifier type. The request handler would retrieve the most recent single row from store order summary table using owner identifier for OWNER_ID, store identifier for STORE_ID, value of ORDER_ID is greater then 0, current shopper identifier for SHOPPER_ID and current shopper identifier type for SHOPPER_ID_TYPE ORDER BY BEGIN_DATE DESC, BEGIN_TIME DESC. If the request handler retrieves one row, then the request handler would save the value of ORDER_ID, PAID_STATUS and CART_BASKET_ID as database order identifier, database paid status and database cart backet identifier respectively and continue, otherwise the request handler would direct the current shopper to SHOPPER_SIGN_IN_PROCESS. If database paid status is ‘P’, then the request handler would direct the current shopper to SHOPPER_SIGN_IN_PROCESS. If database paid status is ‘U’ and if database cart basket identifier is blank then the request handler would continue, otherwise the request handler would terminate the process.

If the process continues, the request handler would update the retrieved one row in store order summary table by setting CART_BASKET_ID with shopping cart basket identifier where OWNER_ID is owner identifier, STORE_ID is store identifier and ORDER_ID is database order identifier.

If the row update process is not successful, the process will be terminated.

If the process is terminated, the request handler would notify the current shopper that the process was terminated and the reason for termination, otherwise the request handler would notify the current shopper that the process was executed successfully and would redirect the current shopper to SHOPPER_MOBILE_MENU_PAGE.

### Shopper_Rack_Permission_Process:

When this process is executed, the request handler would have the values for application identifier, owner identifier, store identifier, current shopper identifier, current shopper identifier type and rack identifier, otherwise the process will be terminated.

If the application identifier is 147 then the process will continue, otherwise it will be terminated.

Then the request handler would validate rack using store rack table using owner identifier for OWNER_ID, store identifier for STORE_ID and rack identifier for RACK_ID. If the request handler verifies that rack identifier exists in store rack table, then the process will continue otherwise it will be terminated.

Then the request handler would determine the current order identifier by retrieving the most recent row from store order summary table for the current shopper identifier and current shopper identifier type. The request handler would retrieve the most recent single row from store order summary table using owner identifier for OWNER_ID, store identifier for STORE_ID, value of ORDER_ID is greater then 0, current shopper identifier for SHOPPER_ID and current shopper identifier type for SHOPPER_ID_TYPE ORDER BY BEGIN_DATE DESC, BEGIN_TIME DESC. If the request handler retrieves one row, then the request handler would save the value of ORDER_ID and PAID_STATUS as database order identifier and database paid status respectively and continue, otherwise the request handler would direct the current shopper to SHOPPER_SIGN_IN_PROCESS. If database paid status is ‘P’, then the request handler would direct the current shopper to SHOPPER_SIGN_IN_PROCESS. If database paid status is ‘U’ then the request handler would continue, otherwise the request handler would terminate the process.

Then the request handler would stop any permission that is active in store order permission table. The request handler would retrieve the most recent PERMISSION_SEQ, RACK_ID, END_DATE and END_TIME from store order permission table where OWNER_ID is owner identifier, STORE_ID is store identifier, ORDER_ID is database order identifier and searching BEGIN_DATE and BEGIN_TIME in a descending order. If the request handler can retrieve a single row, then the request handler would save PERMISSION_SEQ, RACK_ID, END_DATE and END_TIME in the retrieved single row as database permission sequence, database rack identifier, database end date and database end time respectively, otherwise the request handler would save 0 for database permission sequence. If the database permission sequence greater than 0 and database end date and database end time are blanks, then the request handler would set current server date as SERVER_DATE and current server time as SERVER_TIME in store order permission table where OWNER_ID is owner identifier, STORE_ID is store identifier, ORDER_ID is database order identifier and PERMISSION_SEQ is database permission sequence. If the update in store order permission table is not successful, then the request handler would notify the operator client. If the database rack identifier is same as rack identifier then the process will end.

If the process continues, then the request handler would insert a new row in store order permission table using owner identifier for OWNER_ID, store identifier for STORE_ID, database order identifier for ORDER_ID, database permission sequence+1 for PERMISSION_SEQ, rack identifier for RACK_ID, blank for BIN_ID, 1 for ALLOWED_COUNT, 0 for PICKED_COUNT, current server date for BEGIN_DATE, current server time for BEGIN_TIME, blank value for END_DATE and blank value for END_TIME.

If the row insert process is not successful, the request handler will notify the operator client and the process will be terminated.

If the process is terminated, the request handler would notify the current shopper that the process was terminated and the reason for termination, otherwise the request handler would notify the current shopper that the process was executed successfully, and the current shopper has the permission to pick up a product from the rack and would redirect the current shopper to SHOPPER_MOBILE_MENU_PAGE.

### Shopper_Bin_Permission_Process:

When this process is executed, the request handler would have the values for application identifier, owner identifier, store identifier, current shopper identifier, current shopper identifier type, rack identifier and bin identifier otherwise the process will be terminated.

If the application identifier is 167 then the process will continue, otherwise it will be terminated.

Then the request handler would validate rack and bin identifiers using store bin table using owner identifier for OWNER_ID, store identifier for STORE_ID, rack identifier for RACK_ID and bin identifier for BIN_ID. If the request handler verifies that rack identifier and bin identifier exist in store bin table, then the process will continue otherwise it will be terminated.

The request handler would capture the requested number of times that the current shopper would like to pick-up the product from the bin. If the request handler can capture requested number of times then request handler would save the requested number of times as allowed times, otherwise the request handler would save 1 as allowed times.

Then the request handler would determine the current order identifier by retrieving the most recent row from store order summary table for the current shopper identifier and current shopper identifier type. The request handler would retrieve the most recent single row from store order summary table using owner identifier for OWNER_ID, store identifier for STORE_ID, value of ORDER_ID is greater then 0, current shopper identifier for SHOPPER_ID and current shopper identifier type for SHOPPER_ID_TYPE ORDER BY BEGIN_DATE DESC, BEGIN_TIME DESC. If the request handler retrieves one row, then the request handler would save the value of ORDER_ID and PAID STATUS as database order identifier and database paid status respectively and continue, otherwise the request handler would direct the current shopper to SHOPPER_SIGN_IN_PROCESS. If database paid status is ‘P’, then the request handler would direct the current shopper to SHOPPER_SIGN_IN_PROCESS. If database paid status is ‘U’ then the request handler would continue, otherwise the request handler would terminate the process.

Then the request handler would stop any permission that is active in store order permission table. The request handler would retrieve the most recent PERMISSION_SEQ, RACK_ID, END_DATE and END_TIME from store order permission table where OWNER_ID is owner identifier, STORE ID is store identifier, ORDER_ID is database order identifier and searching BEGIN_DATE and BEGIN_TIME in a descending order. If the request handler can retrieve a single row, then the request handler would save PERMISSION_SEQ, RACK_ID, BIN_ID, END_DATE and END_TIME in the retrieved single row as database permission sequence, database rack identifier, database bin identifier, database end date and database end time respectively, otherwise the request handler would save 0 for database permission sequence. If the database permission sequence greater than 0 and database end date and database end time are blanks, then the request handler would set current server date as SERVER_DATE and current server time as SERVER_TIME in store order permission table where OWNER_ID is owner identifier, STORE_ID is store identifier, ORDER_ID is database order identifier and PERMISSION_SEQ is database permission sequence. If the update in store order permission table is not successful, then the request handler would notify the operator client. If the database rack identifier is same as rack identifier and dataset bin identifier is same as bin identifier then the process will end.

If the process continues, then the request handler would verify that product is available in the bin. The request handler would retrieve PRODUCT_INVENTORY from store bin table where OWNER_ID is owner identifier, STORE_ID is store identifier, RACK_ID is rack identifier and BIN_ID is bin identifier. If the request handler can retrieve one row from store bin table then the request handler would save the value of PRODUCT_INVENTORY in the retrieved row as product inventory, otherwise the request handler would save 0 as product inventory and the process will be terminated. If the process continues and if allowed times is greater than product inventory, then the request handler would save product inventory as allowed times.

If the process continues, then the request handler would insert a new row in store order permission table using owner identifier for OWNER_ID, store identifier for STORE_ID, database order identifier for ORDER_ID, database permission sequence for PERMISSION_SEQ, rack identifier for RACK_ID, bin identifier for BIN_ID, allowed times for ALLOWED_COUNT, 0 for PICKED_COUNT, server date for BEGIN_DATE, server time for BEGIN_TIME, blank value for END_DATE and blank value for END_TIME.

If the row insert process is not successful, the process will be terminated.

If the process is terminated, the request handler would notify the current shopper that the process was terminated and the reason for termination, otherwise the request handler would notify the current shopper that the process was executed successfully, and the current shopper has the permission to pick up a product from the bin and would redirect the current shopper to SHOPPER_MOBILE_MENU_PAGE.

### Shopper_Exit_Process:

When this process is executed, the request handler would have the values for application identifier, owner identifier, store identifier, current shopper identifier and current shopper identifier type otherwise the process will be terminated.

If the application identifier is 187 then the process will continue, otherwise it will be terminated.

Then the request handler would determine the database order identifier by retrieving the most recent row from store order summary table for the current shopper identifier and current shopper identifier type. The request handler would retrieve the most recent single row from store order summary table using owner identifier for OWNER_ID, store identifier for STORE_ID, value of ORDER_ID is greater then 0, current shopper identifier for SHOPPER ID and current shopper identifier type for SHOPPER_ID_TYPE ORDER BY BEGIN_DATE DESC, BEGIN_TIME DESC. If the request handler retrieves one row, then the request handler would save the value of ORDER_ID, AUTH_AMOUNT, ORDER_AMOUNT and PAID_STATUS as database order identifier, database authorized amount, database order amount and database paid status respectively and continue, otherwise the request handler would direct the current shopper to SHOPPER_SIGN_IN_PROCESS. If database paid status is ‘U’ then the request handler would continue, otherwise the request handler would direct the current shopper to SHOPPER_SIGN_IN_PROCESS.

If the database order amount is not 0, the request handler would create a product array with columns for detail number, identifier, description and price. The request handler would load the columns detail number and identifier in the product array with the values of ORDER_DETAIL_NUMBER and PRODUCT_ID respectively from each row in store order detail table where OWNER_ID is store operator identifier, STORE_ID is store identifier, ORDER_ID is database order identifier. If the number of rows loaded in product array is one or more than 1, then the process will continue, otherwise it will be terminated. Then the request handler would load the columns description and price in the product array with the values of DESCR and PRICE respectively for each identifier in the product array from store product table where OWNER_ID is store operator identifier, STORE_ID is store identifier, PRODUCT_ID is the value from column identifier in product array. If description and price columns in product array is populated for all the identifiers in the product array, then the process will continue, otherwise it will be terminated.

If the process continues, the request handler would display detail number, description and price of all the rows in the product array in current shopper's device and the request handler would also provide an option for the current shopper to select any product by detail number to return. The current shopper can select items by detail number to return and exit or can exit without selecting any item to return. If the current shopper selected one or more items by detail number to return then the request handler would insert one row for each selected item into store order return table using store operator identifier for OWNER_ID, store identifier for STORE_ID, database order identifier for ORDER_ID and detail number from product array in each row for ORDER_ITEM_NUMBER. Then the request handler would calculate the total of price in product array for the items selected for return as return amount. Then the request handler would update store order summary table by setting the return amount for RETURN_AMOUNT where OWNER_ID is store operator identifier, STORE_ID is store identifier and ORDER_ID is database order identifier. If the insert of return items into store order return table and update of RETURN AMOUNT in store order summary table are successful, the process will continue, otherwise it will be terminated. If the current shopper has selected at least one item to return, then a return confirmation slip will be printed on the cloud printer attached to the return station. The return confirmation slip will have the description with price of items returned, total return amount, a locker number and a locker code. The current shopper can leave the return items and the confirmation slip inside the designated locker. The current shopper can use the locker code printed on the confirmation slip to open the locker. If the current shopper is a shopper client, then the shopper client also have an option to open the locker by scanning the QR Code displayed on the locker instead of entering the locker code printed on the return confirmation slip. If the process continues, the request handler would update PAID_STATUS with ‘P’, END_DATE with current server date and END_TIME with current server time in store order summary table where OWNER_ID is operator identifier, STORE_ID is store identifier and ORDER_ID database order identifier. If the store order summary table update is successful, the request handler would display a successful message on current shopper device, otherwise the process will be terminated.

If the process continues, the request handler would also update STATUS with ‘I’ in store text starter table where OWNER_ID is operator identifier, STORE_ID is store identifier, searching TEXT_SEQ in descending order, STARTER_ID_TYPE is equal to current shopper identifier type and STARTER_ID is equal to current shopper identifier and STATUS is equal to ‘A’. If the store text starter table update is not successful, the request handler would notify the employee clients.

If the process continues, the request handler would also update STATUS with ‘I’ in store meeting starter table where OWNER_ID is operator identifier, STORE_ID is store identifier, searching MEETING_SEQ in descending order, STARTER_ID_TYPE is equal to current shopper identifier type and STARTER_ID is equal to current shopper identifier and STATUS is equal to ‘A’. If the store meeting starter table update is not successful, the request handler would notify the employee clients.

### Virtual Terminal:

It is beyond the scope of this invention to fully describe all the information that can be included for viewing and/or for editing data in virtual terminal. The information provided herein is only to illustrate how store and/or employee clients can perform all front and back of the house operations based on the information displayed on the virtual terminal.

For example, employee clients whose responsibilities include protecting product from shop lifting can view the information retrieved from various tables from store database and from customer database to respond quickly for any activities related to shop lifting. For example, when any product is picked up from a bin without proper permission, an alert will be sent to all employee clients and will be displayed on the virtual terminal.

For example, employee clients responsible to stock merchandise in bins can get alerts and view the information retrieved from various tables from store database to stock the merchandise quickly on bins.

For example, store clients can view the information retrieved from various tables from store database and from customer database to supervise the whole operation within one or more stores to keep the stores more profitable and efficient.

Store clients and employee clients can use a virtual terminal app provided by the intermediary agent or use any mobile device or desktop browser as virtual terminal browser to access a virtual terminal.

If a virtual terminal app is used, the virtual terminal app at the time of loading has verified the mobile number of the device and saved the mobile number as mobile identifier in the virtual terminal app's database. If a virtual terminal app is used, the virtual terminal app at the time of loading would have captured the information whether the user is an owner or employee. If the user is an owner, then the virtual terminal app at the time of loading would have captured an owner identifier, verified owner identifier, saved ‘O’ as user type and saved user type and owner identifier in the virtual terminal app's database. If the user is an employee, then the virtual terminal app at the time of loading would have captured an owner identifier, captured a store identifier, captured an employee identifier, verified owner identifier, verified store identifier, verified employee identifier, saved ‘E’ as user type and saved user type, owner identifier, store identifier and employee identifier in the virtual terminal app's database. Every time the virtual terminal app is accessed and if the virtual terminal app has not been authenticated, the virtual terminal app would authenticate the user using fingerprint authentication or face id authentication. If the virtual terminal is not authenticated, then the virtual terminal app would terminate. Then the virtual terminal app would retrieve the value of user type from virtual terminal app's database. If the user type is ‘O’, then the virtual terminal app would capture a value for store identifier from the user and save in the virtual terminal app's database. If the user type is ‘E’, then the virtual terminal app would capture a value for employee identifier from the user and save in the virtual terminal app's database. Once the virtual terminal app is authenticated, the virtual terminal would display a virtual terminal menu which will be refreshed without authentication until the virtual terminal app is exited. Every time the virtual terminal menu is refreshed, the virtual terminal menu would retrieve the user type, mobile identifier, owner identifier and store identifier from the virtual terminal app's database. Then the virtual terminal menu would retrieve one row from store location table using owner identifier for OWNER_ID and store identifier for STORE ID. If the virtual terminal menu can retrieve one row, then the virtual terminal menu would continue, otherwise the virtual terminal menu will display an error message and terminate. If the user type is ‘O’, then the virtual terminal menu would retrieve one row from store owner table using owner identifier for OWNER_ID and mobile identifier for CONTACT_CELL. If the virtual terminal menu can retrieve one row, then the virtual terminal menu would save the values of PASSWORD and LOGGED_YN as database password and database logged, otherwise the virtual terminal menu will display an error message and terminate. If database logged is ‘N’, then the virtual terminal app would display a virtual terminal app login page, capture a password from the user and save the captured password as input password. If the database password is not same as the input password, then virtual terminal app login page will display an error message and terminate. Then the virtual terminal app login page would update a row in store owner table using owner identifier for OWNER_ID and set the value LOGGED_YN to ‘Y’. If the user type is ‘E’, then the virtual terminal menu would retrieve one row from store employee table using owner identifier for OWNER_ID, store identifier for STORE_ID and employee identifier for EMPLOYEE_ID. If the virtual terminal menu can retrieve one row, then the virtual terminal menu would save the values of PASSWORD and LOGGED_YN as database password and database logged, otherwise the virtual terminal menu will display an error message and terminate. If database logged is ‘N’, then the virtual terminal app would display a virtual terminal app login page, capture a password from the user and save the captured password as input password. If the database password is not same as the input password, then virtual terminal app login page will display an error message and terminate. Then the virtual terminal app login page would update a row in store employee table using owner identifier for OWNER_ID, store identifier for STORE_ID and employee identifier for EMPLOYEE_ID and set the value LOGGED_YN to ‘Y’.

The above process would confirm that a user using an app would be authenticated and logged in using a password only once until the user exits the virtual terminal.

If a virtual terminal browser is used, the virtual terminal will retrieve the values for user type, owner identifier, store identifier and employee identifier from the virtual terminal browser that were saved as cookies. If the virtual terminal is not able to retrieve the values for user type, owner identifier, store identifier and employee identifier, then the virtual terminal would save blanks for user type, owner identifier, store identifier and employee identifier. If the user type is blank, then the virtual terminal would accept a value from the user for user type where valid values would be ‘O’ or ‘E’. If the owner identifier is blank, then the virtual terminal would accept a value from the user for owner identifier. If the store identifier is blank, then the virtual terminal would accept a value from the user for store identifier. If user type is ‘E’ and employee identifier is blank, then the virtual terminal would accept a value from the user for employee identifier. Then the virtual terminal would verify the value of owner identifier by retrieving one row from store owner table using owner identifier for OWNER_ID. If the virtual terminal is able to retrieve one row, then the virtual terminal would save the values of PASSWORD and LOGGED_YN from the retrieved row as database owner password and database owner logged, otherwise the virtual terminal would delete user type, owner identifier, store identifier and employee identifier cookies, display an error message and terminate. Then the virtual terminal would verify the value of store identifier by retrieving one row from store location table using owner identifier for OWNER_ID and store identifier for STORE_ID. If the virtual terminal is not able to retrieve one row, then the virtual terminal would delete user type, owner identifier, store identifier and employee identifier cookies, display an error message and terminate. If user type is ‘E’, then the virtual terminal would verify the value of employee identifier by retrieving one row from store employee table using owner identifier for OWNER_ID, store identifier for STORE_ID and employee identifier for EMPLOYEE_ID. If the virtual terminal is able to retrieve one row, then the virtual terminal would save the values of PASSWORD and LOGGED_YN from the retrieved row as database employee password and database employee logged, otherwise the virtual terminal would delete user type, owner identifier, store identifier and employee identifier cookies, display an error message and terminate. If user type is ‘O’ and if database owner logged is ‘N’, then the virtual terminal would accept a value for input owner password from the user. If database owner password is same as input owner password, then the virtual terminal would update a row in store owner table using owner identifier for OWNER_ID and set the value LOGGED_YN to ‘Y’ and save user type, owner identifier, store identifier, and blank as user type cookie, owner identifier cookie, store identifier cookie and employee identifier cookie respectively. If user type is ‘E’ and if database employee logged is ‘N’, then the virtual terminal would accept a value for input employee password from the user. If database employee password is same as input employee password, then the virtual terminal would update a row in store employee table using owner identifier for OWNER_ID, store identifier for STORE_ID and employee identifier for EMPLPYEE_ID and set the value LOGGED_YN to ‘Y’ and save user type, owner identifier, store identifier, and employee identifier as user type cookie, owner identifier cookie, store identifier cookie and employee identifier cookie respectively, otherwise virtual terminal page would delete user type, owner identifier, store identifier and employee identifier cookies and terminate.

The above process would confirm that a user using a browser would be logged in using a password only once until the user exits the virtual terminal. In some embodiments, when a virtual terminal browser is used and if the user type is ‘O’ a two factor authentication (2FA) may also be used using CONTACT_CELL in store owner table.

Once a user is logged into a virtual terminal using a virtual terminal app or a virtual terminal browser, the user will have access to the virtual terminal and the virtual terminal would display a virtual terminal menu. When a virtual terminal is started or refreshed, the virtual terminal menu would display current communication details using employee identifier and ‘E’ for STARTER_ID and STARTER_ID_TYPE respectively. This would ensure that the current communication details are started by employee identifier. The current communication details may be for text or for video or for both. The virtual terminal would retrieve the latest rows from store text starter table where OWNER_ID is owner identifier, STORE_ID is store identifier, TEXT_SEQ is greater than 0, STARTER_ID is employee identifier, STARTER_ID_TYPE is ‘E’ and STATUS is ‘A’ ORDER BY TEXT SEQ DESC. If the virtual terminal retrieves one or more rows from store text starter table, then the virtual terminal would save the values of TEXT_SEQ, PARTICIPANT_ID_TYPE, SUBJECT, BODY and ATTACHMENT from the retrieved rows as database text sequence, database participant identifier type, database subject, database body and database attachment in an array. If virtual terminal retrieves one or more rows, then the virtual terminal would display a message stating that the employee is in text communications with a participant types identified by database participant identifier type in the array. The display message would also include the values of database subject, database body and database attachment from the array.

Then the virtual terminal would retrieve rows from store text response table for each database text sequence in the array where OWNER_ID is owner identifier, STORE_ID is store identifier and TEXT_SEQ is database text sequence ORDER BY RESOINSE_SEQ DESC. If the virtual terminal retrieves one or more rows from store text response table for each retrieved row from store text starter table, then the virtual terminal would save the values of RESPONSE_ID_TYPE, RESPONSE_ID, BODY and ATTACHMENT as database response id type, database response id, database response body and database response attachment respectively, otherwise the virtual terminal would save blanks for database response identifier type, database response identifier, database response body and database response attachment respectively for each retrieved row from store text starter table. The display message would also include the values of database response identifier type, database response identifier, database response body and database response attachment. In some embodiments for the sake of security, the virtual terminal would use database response identifier type token and database response identifier token instead of database response identifier type and database response identifier in the display message. Then the virtual terminal would display the message.

Then the virtual terminal would display the current communication details using employee identifier and ‘E’ for RESPONSE_ID and RESPONSE_ID_TYPE when accessing the data from store text response table. This would ensure that the current communication details are responses from employee identifier. The current communication details may be for text or for video or for both. The virtual terminal would retrieve rows from store text starter table where OWNER_ID is owner identifier, STORE_ID is store identifier, TEXT_SEQ is greater than 0, STARTER_ID is not blank, STARTER_ID_TYPE is not blank and STATUS is ‘A’ ORDER BY TEXT_SEQ DESC. The virtual terminal would skip rows where the values of STARTER ID and STARTER_ID_TYPE in the retrieved rows is equal to employee identifier and ‘E’ respectively. If the virtual terminal retrieves one or more rows after skipping the rows, if any, from store text starter table, then the virtual terminal would save the values of TEXT_SEQ, STARTER_ID, STARTER_ID_TYPE, PARTICIPANT_ID_TYPE, SUBJECT, BODY and ATTACHMENT from the retrieved rows as database text sequence, database starter identifier, database starter identifier type, database participant identifier type, database subject, database body and database attachment in an array. Then the virtual terminal would retrieve rows from store text response table for each row saved in the array where OWNER_ID is owner identifier, STORE ID is store identifier, TEXT_SEQ is database text sequence, RESPONSE_ID_TYPE is ‘E’ and RESPONSE_ID is employer identifier ORDER BY RESPONSE_SEQ DESC.

If the virtual terminal retrieves one or more rows from store text response table for each retrieved row from store text starter table, then the virtual terminal would display a message stating that the employee is in response communication. The display message would also include the values of database starter identifier, database starter identifier type, database subject, database body and database attachment. In some embodiments for the sake of security, the virtual terminal would use database starter identifier type token and database starter identifier token instead of database starter identifier type and database starter identifier.

Then the virtual terminal would display the current shopper permission details by retrieving rows from store order permission table using owner identifier for OWNER_ID, store identifier for STORE_ID, ORDER_ID is not blank, END_DATE is blank and END_TIME is blank ORDER BY PERMISSION_SEQ DESC. The virtual terminal would save the values of ORDER_ID, RACK_ID, BIN_ID, ALLOWED_COUNT, PICKED_COUNT, BEGIN_DATE and BEGIN_TIME from each retrieved row and display as shopper permission detail.

Then the virtual terminal would display the current employee permission details by retrieving rows from store load permission table using owner identifier for OWNER_ID, store identifier for STORE_ID, RACK_ID is not blank, BIN_ID is not blank, employee identifier for EMPLOYEE_ID, END_DATE is blank and END_TIME is blank ORDER BY PERMISSION_SEQ DESC. The virtual terminal would save the values of EMPLOYEE_ID, RACK_ID, BIN_ID, PERMISSION_SEQ, BEGIN_DATE and BEGIN_TIME from each retrieved row and display as employee permission detail.

The virtual terminal will have several options for the store operators and employees to execute. At a minimum the virtual terminal will have options ‘Start Text Communication’, ‘Start Meeting Communication’, ‘Respond Text Communication’, ‘Bin Inventory Maintenance’ and ‘Sign Out’.

When the employee selects the option ‘Start Text Communication’, the virtual terminal will process the request and upon verification, would make a text communication available for the employees with current shoppers. If the intermediary agent is not set up to provide a text communication gateway, then the intermediary agent will display an error indicating the request is invalid and terminate. Then the virtual terminal will retrieve a row from store employee table using owner identifier for OWNER_ID, store identifier for STORE_ID, employee identifier for EMPLOYEE_ID and ‘Y’ for LOGGED_YN. If the virtual terminal does not retrieve one row from store employee table then the virtual terminal would display an error and terminate. This will ensure that the employee is logged in. Then the virtual terminal would save ‘S’ for new participant identifier type. A value of ‘S’ would denote that the new participant identifier type is a shopper. Then the virtual terminal would capture a values for subject, body and attachment from the employee for new subject, new body and new attachment respectively. Then the virtual terminal will retrieve a row from store text starter table using owner identifier for OWNER_ID, store identifier for STORE_ID and TEXT_SEQ is equal to (maximum of (TEXT_SEQ) for the same OWNER_ID and STORE_ID). If the virtual terminal can retrieve one row then the virtual terminal would set the value of TEXT_SEQ from the retrieved row plus 1 as new text sequence, otherwise the virtual terminal would set 1 as new text sequence. Upon capturing the required information from the employee and setting up a value for new text sequence, the virtual terminal will insert a new row into store text starter table using owner identifier for OWNER_ID, store identifier for STORE_ID, new text sequence for TEXT_SEQ, ‘E’ for STARTER_ID_TYPE, employee identifier for STARTER_ID, new participant identifier type for PARTICIPANT_ID_TYPE, new subject for SUBJECT, new body for BODY, new attachment for ATTACHMENT and ‘A’ for STATUS.

When the employee signs out, the sign-out process would update STATUS as ‘I’ in store text starter table, where OWNER_ID is equal to owner identifier, STORE_ID is equal to store identifier, and TEXT_SEQ is equal to new text sequence.

Upon starting text communications, the employee can communicate using texts with customers. In some embodiments, the owner clients can also set up communication to communicate with customers and employees.

Then the virtual terminal will refresh the virtual terminal menu and display a successful message indicating that a text communication has been started.

When the employee selects the option ‘Start Meeting Communication’, the virtual terminal will process the request and upon verification, would make a meeting communication available for the employees with current shoppers. If the intermediary agent is set up to provide a meeting communication gateway, then the employee would receive a meeting URL and a meeting access code from the intermediary agent, otherwise the employee can set up meeting with third party meeting service providers such as Google meet and zoom and receive a URL and a meeting access code. Then the virtual terminal will retrieve a row from store employee table using owner identifier for OWNER_ID, store identifier for STORE_ID, employee identifier for EMPLOYEE_ID and ‘Y’ for LOGGED_YN. If the virtual terminal does not retrieve one row from store employee table then the virtual terminal would display an error and terminate. This will ensure that the employee is logged in. Then the virtual terminal would save ‘S’ for new participant identifier type. A value of ‘S’ would denote that the new participant identifier type is a shopper. Then the virtual terminal would capture a value of meeting URL and a value for meeting password from the employee. Then the virtual terminal will retrieve a row from store meeting starter table using owner identifier for OWNER_ID, store identifier for STORE_ID and MEETING_SEQ is equal to (maximum of (MEETING_SEQ) for the same OWNER_ID and STORE_ID). If the virtual terminal can retrieve one row then the virtual terminal would set the value of MEETING SEQ from the retrieved row plus 1 as new meeting sequence, otherwise the virtual terminal would set 1 as new meeting sequence. Upon capturing the required information from the employee and setting up a value for new meeting sequence, the virtual terminal will insert a new row into store meeting starter table using owner identifier for OWNER_ID, store identifier for STORE_ID, new meeting sequence for MEETING_SEQ, ‘E’ for STARTER_ID_TYPE, employee identifier for STARTER_ID, new participant identifier type for PARTICIPANT_ID_TYPE, meeting URL for MEETING_HOSTING_URL, meeting password for MEETING_ACCESS_CODE and ‘A’ for STATUS. When the employee signs out, the sign-out process would update STATUS as ‘I’ in store meeting starter table, where OWNER_ID is equal to owner identifier, STORE_ID is equal to store identifier, and MEETING_SEQ is equal to new meeting sequence.

Upon starting meeting communications, the employee can communicate using meetings with current customers using meeting URL and meeting password. In some embodiments, the owner clients can also set up communication to communicate with customers and employees.

Then the virtual terminal will refresh the virtual terminal menu and display a successful message indicating that a meeting communication has been started.

When the employee selects the option ‘Respond Text Communication’, the virtual terminal will process the request and upon verification, would add a response to a text communication. Then the virtual terminal will retrieve a row from store employee table using owner identifier for OWNER_ID, store identifier for STORE_ID, employee identifier for EMPLOYEE_ID and ‘Y’ for LOGGED_YN. If the virtual terminal does not retrieve one row from store employee table then the virtual terminal would display an error and terminate. This will ensure that the employee is logged in. Then the virtual terminal would display the details of currently active text communications where employee can add a response, so that the employee can select an active text communication. Then the virtual terminal would retrieve all rows from store text starter table using owner identifier for OWNER_ID, store identifier for STORE_ID, TEXT_SEQ is greater then 0, ‘S’ for PARTICIPANT_ID_TYPE and ‘A’ for STATUS ORDER BY TEXT_SEQ DESC.

If the administrative component retrieves one or more rows, then the virtual terminal would save the values of TEXT_SEQ, SUBJECT, BODY and ATTACHMENT as array text sequence, array subject, array body and array attachment in an array, otherwise the virtual terminal would display a message indicating that no text communication is available and terminate.

Then the virtual terminal would display the values of array text sequence, array subject, array body and array attachment from each row in the array and would accept the value of array text sequence from a single row in the array as a selected text sequence. Then the virtual terminal would accept a text as response text. The virtual terminal can also accept an attachment as response attachment, otherwise a blank will be saved as response attachment.

Upon receiving selected text sequence, response text and response attachment, the virtual terminal would retrieve a row from store text response table using owner identifier for OWNER_ID, store identifier for STORE_ID, selected text sequence for TEXT_SEQ and RESPONSE_SEQ is equal to (maximum of (RESPONSE_SEQ) for the same OWNER_ID, STORE ID and TEXT_SEQ). If the virtual terminal retrieves one row then the virtual terminal will save the value of RESPONSE_SEQ from the retrieved row plus 1 as new response sequence, otherwise the virtual terminal will save 1 as new response sequence. Then the virtual terminal would insert a row into store text response table using owner identifier for OWNER_ID, store identifier for STORE_ID, selected text sequence for TEXT_SEQ, new response sequence for RESPONSE SEQ, ‘E’ for RESPONSE_ID_TYPE, employee identifier for RESPONSE_ID, response text for BODY and response attachment for ATTACHMENT.

Then the virtual terminal will refresh the virtual terminal menu and display a successful message indicating that a response to a text communication has been added.

When the employee selects the option ‘Bin Inventory Maintenance’, the virtual terminal will present a ‘Bin Inventory Maintenance’ form to accept a scanned data or a manually entered data for a bin inventory identifier and a value for bin quantity. In some embodiments the virtual terminal menu will include a ‘Bin Inventory Maintenance’ form which can be accessed without selecting the option ‘Bin Inventory Maintenance’. When a QR Code is scanned or a value is entered in the ‘Bin Inventory Maintenance’ form for bin inventory identifier, the virtual terminal will receive the scanned data or the manually entered data. If it is a scanned data, then the scanned data will be in a pre-defined format which would generally be in an URL format with names and value pairs in the query string of the URL. For example, the string in the name would be ‘MSL_Code’ and the string in the value would for bin quantity inventory identifier. If it is a manually entered data, the manually entered data will be in a pre-defined format and will be bin inventory identifier. For example, the bin inventory identifier could be ‘167-Stor1-Local-A_39-21’ as shown in FIG. 36D which is a string with 5 segments using ‘-’ as a segment separator. If the virtual terminal can separate the bin inventory identifier into input application identifier, input owner identifier, input store identifier, input rack identifier and input bin identifier, then the virtual terminal will continue processing the data from the ‘Bin Inventory Maintenance’ form, otherwise the virtual terminal will refresh the virtual terminal menu and display an error message. If the input application identifier is ‘167, input owner identifier is owner identifier and input store identifier is store identifier, then the virtual terminal will continue processing the data from the form, otherwise the virtual terminal will terminate processing the data from the form, refresh the virtual terminal menu and display an error message. Then the virtual terminal will verify the input rack identifier and input bin identifier by retrieving a row from store bin table using owner identifier for OWNER_ID, store identifier for STORE_ID, input rack identifier for RACK_ID and input bin identifier for BIN_ID. If the virtual terminal is not able to retrieve a single row, then the virtual terminal will terminate processing the data from the form, refresh the virtual terminal menu and display an error message. Then the virtual terminal will confirm that shopper product pick up permission from the bin identified by the bin inventory identifier is not active. The virtual terminal would retrieve a single row from store order permission table using owner identifier for OWNER_ID, store identifier for STORE_ID, ORDER_ID is not blank, PERMISSION_SEQ is greater than 0, input rack identifier for RACK_ID, blank for BIN_ID, blank for END_DATE and blank for END_TIME. If the virtual terminal retrieves at least one row, then the virtual terminal will terminate processing the data from the form, refresh the virtual terminal menu and display an error message indicating that the selected bin is not available to load products. The virtual terminal would retrieve a single row from store order permission table using owner identifier for OWNER_ID, store identifier for STORE_ID, ORDER_ID is not blank, PERMISSION_SEQ is greater than 0, input rack identifier for RACK_ID, input bin identifier for BIN_ID, blank for END_DATE and blank for END_TIME. If the virtual terminal retrieves at least one row, then the virtual terminal will terminate processing the data from the form, refresh the virtual terminal menu and display an error message indicating that the selected bin is not available to load products.

To get permission to load or unload product into the selected bin, the employee would have left blank for bin quantity in the ‘Bin Inventory Maintenance’ form. To update the inventory in store bin table, the employee would have entered a value for bin quantity in the ‘Bin Inventory Maintenance’ form.

If the value for bin quantity in the ‘Bin Inventory Maintenance’ form is blank, then the virtual terminal would confirm that the permission to load and/or unload the bin identified by the bin inventory identifier is not active. The virtual terminal would retrieve one row from store load permission table using owner identifier for OWNER_ID, store identifier for STORE_ID, input rack identifier for RACK_ID, input bin identifier for BIN_ID and PERMISSION_SEQ is equal to (maximum of (PERMISSION_SEQ) for the same OWNER_ID, STORE_ID, RACK_ID and BIN_ID). If the virtual terminal retrieves one row, if the value of EMPLOYEE_ID is equal to employee identifier and if the values of END_DATE and END_TIME in the retrieved row are blanks, then the virtual terminal will terminate processing the data from the form, refresh the virtual terminal menu and display an error message indicating that the selected bin already has permission to load or unload product by the employee. If the virtual terminal retrieves one row, if the value of EMPLOYEE_ID is not equal to employee identifier and if the values of END_DATE and END_TIME in the retrieved row are blanks, then the virtual terminal will terminate processing the data from the form, refresh the virtual terminal menu and display an error message indicating that the employee does not have permission to load or unload product in the selected bin.

If the virtual terminal retrieves one row, then the virtual terminal will use the value of PERMISSION SEQ from the retrieved row plus 1 as new permission sequence, otherwise the virtual terminal will use 1 as new permission sequence. Then the virtual terminal would insert a row into store load permission table using owner identifier for OWNER_ID, store identifier for STORE_ID, input rack identifier for RACK_ID, input bin identifier for BIN_ID, new permission sequence PERMISSION_SEQ, employee identifier for EMPLOYEE_ID, current server date for BEGIN_DATE, current server time for BEGIN_TIME, blank for END_DATE and blank for END_TIME. Then the virtual terminal will refresh the virtual terminal menu and display a successful message indicating that the employee has been given permission to load or unload product into the selected bin.

If the value for bin quantity in the ‘Bin Inventory Maintenance’ form is not blank, then the virtual terminal would verify the value for bin quantity. If the value for bin quantity is not a whole positive number, then the virtual terminal will terminate processing the data from the form, refresh the virtual terminal menu and display an error message indicating that the selected bin quantity is not valid. Then the virtual terminal would confirm that the employee has the permission to update inventory in the bin. Then the virtual terminal would retrieve one row from store load permission table using owner identifier for OWNER_ID, store identifier for STORE_ID, input rack identifier for RACK_ID, input bin identifier for BIN_ID, PERMISSION_SEQ is equal to (maximum of (PERMISSION_SEQ) for the same OWNER_ID, STORE_ID, RACK_ID and BIN_ID) and employee identifier for EMPLOYEE_ID. If the virtual terminal retrieves one row and if the values of END_DATE and END_TIME are blanks, then the virtual terminal would save the value of PERMISSION_SEQ from the retrieved row plus 1 as new permission sequence and the virtual terminal would continue processing the data from the form, otherwise the virtual terminal would refresh the virtual terminal menu and display an error message indicating that the selected bin is not available to update the inventory. Then the virtual terminal would update the inventory in store bin table and would update the END_DATE and END_TIME in store load permission table. To update the inventory, the virtual terminal would update a row in store bin table by setting the value of PRODUCT_INVENTORY to bin quantity where OWNER_ID is owner identifier, STORE_ID is store identifier, RACK_ID is input rack identifier and BIN_ID is input bin identifier. To update the END_DATE and END_TIME in store load permission table, the virtual terminal would insert a row using owner identifier for OWNER_ID, store identifier for STORE_ID, input rack identifier for RACK_ID, input bin identifier for BIN_ID, new permission sequence PERMISSION_SEQ, employee identifier for EMPLOYEE_ID, current server date for END_DATE and current server time for END_TIME. Then the virtual terminal will refresh the virtual terminal menu and display a successful message indicating that the inventory has been updated and employee's permission to load or unload product into the selected bin has been stopped.

When the employee selects the option ‘Log Out’, the virtual terminal will process the request and upon verification, would log out the employee. Once an employee is logged out, the employee would log in again to access the virtual terminal. Then the virtual terminal will retrieve a row from store employee table using owner identifier for OWNER_ID, store identifier for STORE_ID, employee identifier for EMPLOYEE_ID and ‘Y’ for LOGGED_YN. If the virtual terminal does not retrieve one row from store employee table, then the virtual terminal would display an error and terminate. This will ensure that the employee is logged in.

Then the virtual terminal would inactivate any active text communication and any active meeting communication started by the employee. In some embodiments, the employee can transfer any active text communication and any active meeting communication to any employee currently logged in. To inactivate any text communication the virtual terminal would update all the rows in store text starter table using owner identifier for OWNER_ID, store identifier for STORE_ID, TEXT_SEQ is greater than 0, ‘E’ for STARTER_ID_TYPE, employee identifier for STARTER ID and ‘A’ for STATUS and by setting the STATUS to ‘I’. To inactivate any meeting communication the employee would terminate any existing meeting and then the virtual terminal would update all the rows in store meeting starter table using owner identifier for OWNER_ID, store identifier for STORE_ID, MEETING_SEQ is greater than 0, ‘E’ for STARTER_ID_TYPE, employee identifier for STARTER_ID and ‘A’ for STATUS and by setting the STATUS to ‘I’.

Then the virtual terminal would end any load permission. To end load permission, the virtual terminal would update all the rows in store load permission table using owner identifier for OWNER_ID, store identifier for STORE_ID, RACK_ID is not blank, BIN_ID is not blank, PERMISSION_SEQ is greater than 0, employee identifier for EMPLOYEE_ID, END_DATE is blank and END_TIME is blank and by setting END_DATE to current server date and by setting END_TIME to current server time. Then the virtual terminal would update store employee table using owner identifier for OWNER_ID, store identifier for STORE_ID, employee identifier for EMPLOYEE_ID and ‘Y’ for LOGGED_YN and by setting the LOGGED_YN to ‘N’.

Then the virtual terminal will refresh the virtual terminal and display a successful message indicating that the employee has been logged out.

### Controller_Tag_Reader_Process:

Controller tag reader process is an entry point for processing the data received from a tag reader through controller gateway and processed by controller agent.

When the controller tag reader process terminates before fully executing the controller tag reader process, the controller agent may notify the operator for termination reason. If the received data has values for tag reader identifier and tag identifier, then the process would validate the values of tag reader identifier and tag identifier received from a tag reader and set rack permission or revoke a rack permission in store order permission table based on the value of tag identifier as shown in a class diagram in FIGS. 34, 34A and 34B, otherwise the process will be terminated. When a tag identifier is placed in the close proximity of the tag reader, then the tag reader would capture the value of tag identifier and send the values tag reader identifier and tag identifier to the intermediary agent. When a tag identifier is moved away from the close proximity of the tag reader, then the tag reader would send the value tag reader identifier and a blank as tag identifier to the intermediary agent.

Then the controller agent would retrieve the values for OWNER_ID, STORE_ID and RACK ID from store rack table using tag reader identifier for TAG READER ID. If the controller agent can retrieve one row then the controller agent would save values of OWNER_ID, STORE ID and RACK ID as database owner identifier, database store identifier and database rack identifier and the process will continue, otherwise it will be terminated.

If the value of tag identifier is not blank, then the controller agent would initiate a rack permission. The controller agent would retrieve the value for ORDER_ID from the latest single row in store order summary table where OWNER_ID is equal to database owner identifier, STORE_ID is equal to database store identifier, searching ORDER_ID in descending order, PAID STATUS is equal to ‘U’ and CART_BASKET_ID is equal to tag identifier. If the controller agent can retrieve a single row in store order summary table, then the controller agent would save the value of ORDER_ID from the retrieved single row as database order identifier, otherwise the process will be terminated. Then the controller agent would insert a new row in store order permission table. The controller agent would retrieve the value of PERMISSION SEQ from the latest single row in store order permission table where OWNER_ID is equal to database owner identifier, STORE_ID is equal to database store identifier, ORDER_ID is equal to database order identifier and searching PERMISSION_SEQ in descending order. If the controller agent retrieves a single row in store order permission table, then the controller agent would save the value of PERMISSION_SEQ plus 1 as new permission number, otherwise the controller agent would save 1 as new permission number. The controller agent would insert a new row in store order permission table using database owner identifier for OWNER_ID, database store identifier for STORE_ID, database order identifier for ORDER_ID, new permission number for PERMISSION_SEQ, database rack identifier for RACK ID, blank for BIN_ID, 1 for ALLOWED_COUNT, 0 for PICKED COUNT, server date for BEGIN_DATE, server time for BEGIN_TIME, blank for END_DATE and blank for END_TIME. If the new row insert is successful, then the controller agent would send a successful response to the tag reader, otherwise the controller agent would send a failure response to the tag reader. When the tag reader receives a successful response, the tag reader would turn on green light and turn off red light attached to the tag reader. When the tag reader receives a failure response, the tag reader would turn off green light and turn on red light attached to the tag reader. Upon a preset time is passed, the controller agent would automatically revoke the permission and the tag reader would automatically turn off green light and turn on red light. To revoke the permission, the controller agent would update a row in the store order permission table using database owner identifier for OWNER_ID, database store identifier for STORE ID, database order identifier for ORDER_ID, new permission number for PERMISSION_SEQ and by setting server date for END_DATE and server time for END_TIME. When the green light is on, shoppers can pick up goods for any number of times from any number of bins attached to the rack for which the permission is granted.

If the value of tag identifier is blank, then the controller agent would revoke a rack permission. The controller agent would update a row in store order summary table using database owner identifier for OWNER_ID, database store identifier for STORE_ID, ORDER_ID in not blank, PERMISSION_SEQ is greater than 0, database rack identifier for RACK_ID, blank for BIN_ID, END_DATE is blank and END_TIME is blank ORDER BY PERMISSION SEQ and by setting the value of server date for END_DATE and server time for END_TIME. Then the controller agent would send a successful response to the tag reader. When the tag reader receives a successful response, the tag reader would turn off green light and turn on red light attached to the tag reader.

### Controller_Sensor_Process:

Controller sensor process is an entry point for processing the data received from a sensor through controller gateway by controller agent. The purpose of controller sensor process is to enable shoppers with valid permission to pick-up a product from a bin and at the same time alert store employees when a product is picked-up without a valid permission. When the controller sensor process terminates before fully executing the controller sensor process, the controller agent may notify operator client for termination reason and may insert a row in store rejection table. If the received data has values for sensor identifier, then the process would validate the value of sensor identifier received from a sensor using store bin table, receive order identifier from store order permission table, retrieve price from store product table, add price to the total amount in store order summary table, insert product identifier in store order detail table, update inventory in store bin table and respond with a successful or failure response, otherwise the process will be terminated.

The controller agent would retrieve the values for OWNER_ID, STORE_ID, RACK ID, BIN_ID and PRODUCT ID from store bin table using sensor identifier for SENSOR ID. If the controller agent can retrieve one row then the controller agent would save values of OWNER_ID, STORE_ID, RACK_ID, BIN_ID and PRODUCT_ID as database owner identifier, database store identifier, database rack identifier, database bin identifier and database product identifier respectively and the process will continue, otherwise it will be terminated.

When the bin to which the controller sensor is attached to is in maintenance mode, then the controller agent would end the controller sensor process. To verify that the bin is not in maintenance mode, the controller agent would retrieve the latest single row in store load permission table where OWNER_ID is equal to database owner identifier, STORE_ID is equal to database store identifier, RACK_ID is equal to database rack identifier, BIN_ID is equal to database bin identifier, searching PERMISSION_SEQ in descending order, END_DATE is equal to blank and END_TIME is equal to blank. If the controller agent can retrieve a single row in store load permission table, then the controller agent would consider that the bin is in maintenance mode and the controller agent would end the controller sensor process, otherwise the process will continue.

Then the controller agent would retrieve ORDER_ID, PERMISSION_SEQ, BIN_ID, ALLOWED_COUNT and PICKED_COUNT from the latest single row in store order permission table where OWNER_ID is equal to database owner identifier, STORE_ID is equal to database store identifier, i searching ORDER_ID in descending order, searching PERMISSION_SEQ in descending order, RACK_ID is equal to database rack identifier, BIN_ID is equal to blank or database bin identifier, END_DATE is equal to blank and END_TIME is equal to blank. The controller agent would save blank for database order identifier. If the controller agent can retrieve a single row in store order permission table and if the value of BIN_ID is blank, then the controller agent would save ‘R’ for database bin level, otherwise the controller agent would save ‘B’ for database bin level. If the controller agent can retrieve a single row in store order permission table and if database bin level is ‘R’, then the controller agent would save the values of ORDER_ID, PERMISSION_SEQ, ALLOWED_COUNT and PICKED_COUNT from the retrieved single row as database order identifier, database permission sequence, database allowed count and database picked count respectively. If the controller agent can retrieve a single row in store order permission table and if database bin level is ‘B’ and if the value of ALLOWED_COUNT is greater than the value of PICKED_COUNT in the retrieved single row, then the controller agent would save the values of ORDER_ID, PERMISSION_SEQ, ALLOWED_COUNT and PICKED_COUNT from the retrieved single row as database order identifier, database permission sequence, database allowed count and database picked count respectively.

If the value of database order identifier is blank, then the process will be terminated, otherwise the controller agent would retrieve the value of PRICE from store product table, add the value of PRICE to the value of ORDER AMOUNT in store order summary table and would insert a new row in store order detail table. To retrieve the value of PRICE from store product table the controller agent would retrieve a single row in store product table where OWNER_ID is equal to database owner identifier, STORE_ID is equal to database store identifier and PRODUCT ID is equal to database product identifier. If the controller agent can retrieve a single row in store product table, then the controller agent would save the value of PRICE from the retrieved single row as database price amount, otherwise the process will save blank for database order identifier. If the value of database order identifier is not blank, the controller agent would add the database price amount to the value of ORDER AMOUNT in store order summary table by setting the ORDER AMOUNT to ORDER AMOUNT+database price amount where OWNER_ID is equal to database owner identifier, STORE_ID is equal to database store identifier and ORDER_ID is equal to database order identifier. If adding the database price amount to ORDER AMOUNT in store order summary table is successful, then the controller agent would insert a new row in store order detail table, otherwise the process will save blank as database order identifier. To insert a new row into store order detail table, the controller agent would retrieve the value of ORDER_ITEM_NUMBER from the latest single row in store order detail table where OWNER_ID is equal to database owner identifier, STORE_ID is equal to database store identifier, ORDER_ID is equal to database order identifier and searching ORDER_ITEM_NUMBER in descending order. If the controller agent retrieves a single row in store order detail table, then the controller agent would save the value of ORDER_ITEM_NUMBER plus 1 as new order item number, otherwise the controller agent would save 1 as new order item number. Then the controller agent would insert a new row in store order detail table using database owner identifier for OWNER_ID, database store identifier for STORE_ID, database order identifier for ORDER_ID, new order item number for ORDER ITEM NUMBER, database product identifier for PRODUCT_ID, database rack identifier for RACK ID and database bin identifier for BIN_ID. If the insert of new row in store order detail table is successful, then the controller agent would adjust the inventory in store bin table by updating the value of PRODUCT INVENTORY in store bin table. The controller agent would decrease the value of PRODUCT_INVENTORY by 1 in store bin table where OWNER_ID is equal to database owner identifier, STORE_ID is equal to database store identifier, RACK_ID is equal to database rack identifier and BIN_ID is equal to database bin identifier. If the update of PRODUCT_INVENTORY in store bin table is not successful, then the controller agent may notify operator client.

If database bin level is ‘B’, then the controller agent would adjust the value of PICKED COUNT in store order permission table with or without revoking the permission based on database allowed count and database picked count. If database allowed count is equal to database picked count+1, then the controller agent would increase the value of PICKED COUNT by 1 and revoke the permission in store order permission table. The controller agent would set PICKED_COUNT to PICKED_COUNT+1, END_DATE to server date and END_TIME to server time where OWNER_ID is equal to database owner identifier, STORE_ID is equal to database store identifier, ORDER_ID is equal to database order identifier and PERMISSION_SEQ is equal to database permission sequence. If the update of PICKED_COUNT, END_DATE and END_TIME in store order permission table is not successful, then the controller agent may notify operator client. If allowed count is not equal to picked count+1, then the controller agent would increase the value of PICKED_COUNT by 1. The controller agent would set PICKED_COUNT to PICKED_COUNT+1 where OWNER_ID is equal to database owner identifier, STORE_ID is equal to database store identifier, ORDER_ID is equal to database order identifier and PERMISSION_SEQ is equal to database permission sequence. If the update of PICKED_COUNT in store order permission table is not successful, then the controller agent may notify operator client.

If the controller sensor process is fully executed without termination and if the database order identifier is not blank and if the AUTH AMOUNT is not more than ORDER_AMOUNT in store order summary table, then the controller agent would revoke the shopper's permission in store order permission table. The controller agent would retrieve AUTH_AMOUNT and ORDER_AMOUNT from store order summary table where OWNER_ID is equal to database owner identifier, STORE_ID is equal to database store identifier and ORDER_ID is equal to database order identifier. If the controller agent can retrieve one row and if the value of AUTH_AMOUNT is not more than the value of ORDER AMOUNT, then the controller agent would revoke the shopper's permission in store order permission table by updating END_DATE with the value server date and by updating END_TIME with the value of server time. The controller agent would update END_DATE with server date and END_TIME with server time in store order permission table where OWNER_ID is equal to database owner identifier, STORE_ID is equal to database store identifier and ORDER_ID is equal to database order identifier, PERMISSION_SEQ is equal to database permission sequence, END_DATE is blank and END_TIME is blank. If the update of END_DATE and END_TIME in store order permission table is not successful, the controller agent may send notify operator client.

If the controller sensor process terminated before fully executing the controller sensor process or if the database order identifier is blank, then the controller agent would insert a new row into store rejection table. To insert a new row into store rejection table, the controller agent would determine a new rejection number. The controller agent would retrieve the value of REJECTION NUMBER from the latest single row in store rejection table where OWNER_ID is equal to database owner identifier, STORE_ID is equal to database store identifier and searching REJECTION NUMBER in descending order. If the controller agent retrieves a single row in store rejection table, then the controller agent would save the value of REJECTION_NUMBER plus 1 as new rejection number, otherwise the controller agent would save 1 as new rejection number. The controller agent would insert a new row in store rejection table using database owner identifier for OWNER_ID, database store identifier for STORE_ID, new rejection number for REJECTION_NUMBER, database rack identifier for RACK ID, database bin identifier for BIN_ID, server date for REJECTION_DATE and server time for REJECTION TIME. If the new row insert is not successful, then the controller agent would send a notification to operator and/or employees.

In some embodiments the product pickup by shoppers from electronic racks can incorporate product pushers as shown in FIGS. 37AP and 37BP instead of using sensors and tag readers as shown in FIGS. 37A and 37B. The stores that use product pusher racks would also use an intermediary agent, application server and a database just like the stores using electronic racks with sensors and tag readers.

In some embodiments the product pickup by shoppers from electronic racks can also provide return station as shown in FIG. 37CB.

The front view of a product pusher electronic rack is shown in FIG. 37AP whereas the side view of a product pusher electronic rack is shown in FIG. 37BP. Rack Identifier, Rack QR Code, Bin QR Code, Bin Identifier, Rack Product Pusher Switch, Pusher Coil, Pusher Motor, Product Cover and Product Pickup Slot are some of the parts installed in product pusher electronic racks. Return QR Code, Lockers and Cloud Printer are some of the parts installed in return station.

Just like the automated stores that use electronic racks fitted with sensors and tag readers, the automated stores that use product pusher electronic racks can also use Pre-Authorization iPosters with a QR Code. The Pre-Authorization iPosters will be used for payment pre-authorization by shoppers.

Just like the sensors and tag readers are used for product pickup in automated stores that use electronic racks fitted with sensors and tag readers, the rack QR code and rack product pusher switch are used for product pickup in automated stores that use product pusher electronic racks.

Just like the automated stores that use electronic racks fitted with sensors and tag readers, the automated stores that use product pusher electronic racks can also use Exit iPosters with a QR Code. The Exit iPosters will be used by shoppers before exiting the store.

Just like the automated stores that use electronic racks fitted with sensors and tag readers, the automated stores that use product pusher electronic racks can also use the return QR code displayed on return stations. Products can be returned after exiting the store where return stations will be placed. Return credits, if any will be processed by employees before payment pre-authorization is settled.

Just like the QR Codes used in automated stores that use electronic racks fitted with sensors and tag readers, QR Codes in the automated stores that use product pusher electronic racks would also be in a pre-defined format having various segments such as an application identifier and related information. Just like the sensors and tag readers used in automated stores that use electronic racks fitted with sensors and tag readers, rack product pusher switch used in automated stores that use product pusher electronic racks also be in a pre-defined format having various segments such as an application identifier and related information. Just like that electronic racks fitted with sensors and tag readers, the automated stores that use product pusher electronic racks would also use a request handler software to manage all the requests communicated through various gateways and to generate responses.

When a QR Code is scanned using an app provided by intermediary agents or interfaced with intermediary agents, then the shopper scanned the QR Code would be a registered shopper and will be referred to as shopper client. When a QR Code is scanned using a mobile browser, then the shopper scanned the QR Code would not be a registered shopper and will be referred to as unknown shopper. Both shopper clients and unknown shoppers will be referred to as shoppers. In some embodiments, when an app is used to scan a QR Code, then the location where the QR Code is authorized to be displayed and location of the mobile device where the QR Code is scanned can be matched to make sure the QR Code is scanned at the right location. The coordinates of the area where the QR Code is authorized to be displayed can be retrieved from a database and the coordinates of the location of the mobile device can be captured from the app. If the distance between those coordinates are above certain limit then the app can reject the scanned QR Code.

When a QR Code is scanned the request handler would receive the content of the QR Code which will be referred to as request message. When a rack product pusher switch is pushed the request handler would receive the content of the rack product pusher which will also be referred to as request message.

When a QR Code in the Pre-Authorization iPosters is scanned and if the pre-authorization is successful, then the authorized amount can be used to pickup products from any one or more product pusher electronic racks within the Store. When a Bin QR Code displayed on electronic racks is scanned, products information can be viewed. When a Rack QR Code displayed on electronic racks is scanned, products can be added to virtual shopping cart or removed from virtual shopping cart or an advance authentication can be activated. When a rack product pusher is pushed and if rack product pusher is in active status, then the selected products will be pushed from the coils to product pickup slots. When a QR Code in Exit iPosters is scanned, the shopper will be marked as exited. Whan a Return QR Code displayed on return stations is scanned, purchased products can be returned. Not all the shoppers will scan the Return QR Code displayed on return stations. A settlement process the run at preset time will settle the purchased transactions and also include return transactions, is any.

The database used by stores with product pusher racks, at a minimum, would include store owner table to maintain store owner information, store location table to maintain store location information, store employee table to maintain store employee information, store product table to maintain store product information, store rack table to maintain store rack information, store bin table to maintain store bin information, store product inventory table to maintain store product inventory, store payment authorization table to maintain customer payment authorization information, store virtual shopping cart table to maintain store virtual shopping cart information, store advance authentication table to maintain store advance authentication, store product return locker header table to maintain store product return locker information and store product return locker activity table to maintain store product return locker activity information.

In the database, the fields in the tables that are part of a primary key will be marked as (PK). Primary keys are used to avoid duplicate rows.

The store owner table would include fields such as store owner identifier (PK), status and so no. The values of status could be ‘A’ or ‘I’ to denote that the owner is active or inactive respectively.

The store location table would include fields such as store owner identifier (PK), store location identifier (PK), status and so no. The values of status could be ‘A’ or ‘I’ to denote that the location is active or inactive respectively.

The store employee table would include fields such as store owner identifier (PK), store location identifier (PK), employee identifier (PK), status and so no. The values of status could be ‘A’ or ‘I’ to denote that the employee is active or inactive respectively.

The store product table would include fields such as store owner identifier (PK), store location identifier (PK), product identifier (PK), product description, product price and so no.

The store rack table would include fields such as store owner identifier (PK), store location identifier (PK), rack identifier (PK) where the rack identifier would be an identifier to identify a rack, status and so on. The values of status could be ‘A’ or ‘I’ to denote that the rack is active or inactive respectively.

The store bin table would include fields such as store owner identifier (PK), store location identifier (PK), rack identifier (PK) and bin identifier (PK) where the rack identifier would be an identifier to identify a rack, bin identifier to identify a bin within the rack, bin status and so on. The values of bin status could be ‘A’ or ‘I’ to denote that the bin is active or inactive respectively.

The store product inventory table would include store owner identifier (PK), store location identifier (PK), rack identifier (PK), bin identifier (PK), product identifier, and quantity (inventory) of products stored inside the bin. All the products stored inside a bin identifier within a rack identifier would be the same product. Same products can be stored in more than one rack or bin.

The store payment authorization table would include fields such as store owner identifier (PK), store location identifier (PK), payment authorization identifier (PK), payment authorization sequence (PK), authorization status, authorized amount, used amount, refund amount, external authorization identifier, payment authorization start date hour minute second and payment authorization end date hour minute second so on. The values for authorization status could be ‘A’ or ‘I’ or ‘C’ to denote that the payment authorization is active, inactive, or closed respectively. The value for external authorization identifier could be the confirmation code received from the card processor when a payment transaction is approved. The external authorization identifier will be used when the amount used for purchases is settled.

The store virtual shopping cart table would include fields such as store owner identifier (PK), store location identifier (PK), payment authorization identifier (PK), payment authorization sequence (PK), rack identifier (PK), bin identifier (PK), bin selected sequence (PK) and bin selected status. The values for bin selected status could be ‘S’ or ‘C’ or ‘P’ or ‘R’ or ‘Z’ to denote that the bin is selected or cancelled (removed) or purchased or refund requested or refund processed respectively.

The store advance authentication table would include fields such as store owner identifier (PK), store location identifier (PK), rack identifier (PK), advance authentication sequence (PK), advance authentication status, payment authorization identifier, payment authorization sequence, advance authentication start date hour minute second, advance authentication end date hour minute second, and so no. The values for advance authentication status could be ‘A’ or ‘I’ to denote that the advance authentication is active or inactive respectively.

The store product return locker header table would include fields such as store owner identifier (PK), store location identifier (PK), locker number (PK), external identifier and so on. If the locker is a stand alone mechanical locker, then the value of external identifier will be blank. If the locker is a smart locker, then the value of external identifier will not be blank and the external identifier is the internal identifier of lockers provided by the locker service provider and will be used to set up one-time code.

The store product return locker activity table would include fields such as store owner identifier (PK), store location identifier (PK), locker number (PK), activity sequence (PK), locker status, one-time code, payment authorization identifier, payment authorization sequence and so no. The values for locker status could be ‘A’ or ‘U’ or ‘I’ to denote that the locker is available, unavailable, or inactive respectively. The values for one-time code could be a number when the locker status is ‘A’ or ‘U’, otherwise it will be blank.

Product pusher technology used in vending machine can be considered as prior art and the product pusher technology used in product pusher electronic racks significantly differs from the product pusher technology used in vending machines.

Following is a description of important differences between vending machines and product pusher electronic racks.

The front end, back end, user interface, product security, product pickup methodology, payment methodology and electronics used in product pusher electronic racks are significantly different from the ones used in vending machines. In a vending machine, the front end consists of various mechanical devices such as keypad, touch screen, or buttons to accept the input of the code corresponding to the desired product. In a vending machine, the front end would also include payment acceptor and a drop box where the products will be dropped. In a vending machine, the back end consists of a software controlling various hardware used as front end. In product pusher electronic racks, Rack Identifier, Rack QR Code, Bin QR Code, Bin Identifier, Rack Product Pusher Switch, Pusher Coil, Pusher Motor, Product Cover and Product Pickup Slot would function as front end. In store automation that uses product pusher electronic racks, the mobile devices that scan the Pre-Authorization iPosters QR Code, Exit iPosters QR Code and Return QR Code displayed on return stations would also function as front end. In product pusher electronic racks, the application server accepting and processing the input from mobile devices that scans the Pre-Authorization iPosters QR Code, Rack QR Code, the Bin QR Code, Exit iPosters QR Code, Return QR Code and the input from electronic devices such as Rack Product Pusher Switch would function as back end.

All the products in a vending machine are visible through a secured transparent glass whereas the products in each bin in product pusher electronic racks is secured by a product cover which can be transparent or non-transparent. In some embodiments the electronic racks with product pusher may also display an image of the stored product in the bins in front of the product pickup slot. In some embodiments the electronic racks with product pusher may also use a door with a glass in addition to product cover, especially when the electronic racks are temperature controlled.

In a vending machine shoppers make the payment after selecting the product, because the vending machine must know the total amount to be collected. In Store Automation shoppers would set up payment authorization before selecting the product or products, because the stores do not know the total amount to be collected until the products are pushed into Product Pickup Slots in one or more racks. In a vending machine the payment can be made only for a product selected in a single vending machine. In Store Automation, the authorized payment can be used to purchase any number of products from any product pusher electronic rack within a store.

In a vending machine, merchants would set up product description, price of products and inventory of the products stored in each bin in a software stored in the vending machine. In Store Automation, merchants would set up the product identifiers of products stored in each bin, bin identifier and their stock up inventory in store product inventory table. The stock up inventory is the quantity of products stocked in each bin by the merchant. The inventory in the store product inventory table will change as products are pushed into Product Pickup Slots.

In a vending machine, shoppers select a product using a keypad and the selected key pad identifier will be stored in a software in the vending machine. In Store Automation shoppers scan a Rack QR Code and select products using a mobile device to add the products to a virtual shopping cart, to remove products from virtual shopping cart and to activate an advance authentication prior to pushing the Rack Product Pusher Switch. In Store Automation shoppers scan a Return QR Code and select products using a mobile device to return products to a locker.

In Store Automation, the mobile device would communicate with the application server using app gateway (58-24) or user interface (58-22) as shown in FIG. 58 to submit a request and receive a response. In Store Automation, the Rack Product Pusher Switch would communicate with the application server using the controller gateway (58-23) as shown in FIG. 58 to submit the request and receive a response.

In a vending machine, products can be picked up from a drop box where the product will be dropped into. Because dropping of products may cause damage to the products, only selective products can be used in vending machines. In Store Automation products can be picked up from a product pickup slot where the product will be pushed into that will not cause damage to products. To avoid damage to products, the vending machines may use elevators to gently drop product into the drop box. Elevators are not required in Store Automation.

In a vending machine only one product can be dropped into the drop box at a time whereas In Store Automation unlimited number of products can be pushed into Product Pickup Slot simultaneously.

In a vending machine only one shopper can select one product at a time whereas In Store Automation unlimited number of shoppers can select unlimited number of products simultaneously.

In Store Automation only one shopper can activate an advance authentication and pickup products from Product Pickup Slots in a single rack, but unlimited number of shoppers can select products simultaneously in any rack.

The Store Automation with product pusher electronic rack would allow shoppers to return product or products whereas vending machine will not allow for shoppers to return product or products.

Following is a description of the method used to connect various parts used in Store Automation using electronic racks with product pushers.

The Rack Product Pusher Switch will be connected to all Pusher Motors in the rack. Each Pusher Motor will be identified by a unique Bin Identifier where the Pusher Motor is connected to the bin.

When Rack Product Pusher Switch in a product pusher electronic rack is pushed, the Rack Product Pusher Switch will communicate with the application server and Rack Product Pusher Switch will receive an approval or denial response. If the response is an approval response, then the response will also include one or more Bin Identifiers. The Rack Product Pusher Switch will activate the Pusher Motors that are connected to the one or more Bin Identifiers received with the approval response. The Bin Identifiers received with approval response would be the bins where the products selected by the shoppers are stored. When a Pusher Motor is activated, the Pusher Motor will rotate Pusher Coil which will push one product for each turn into the Product Pickup Slot. The products pushed into the Product Pickup Slot can be picked up by shoppers. In vending machines, when payment is made for a selected product, the Pusher Motor of the selected product will be activated. In vending machines, when the Pusher Motor is activated, the Pusher Motor will rotate Pusher Coil which will push one product for each turn and drop the product into a drop box. The product dropped into the drop box can be picked up by shoppers. In vending machines, only one pusher motor can be activated at a time, whereas in product pusher electronic rack, unlimited number of pusher motors can be activated simultaneously.

The product pusher electronic rack in Store Automation may not use a transparent glass to product the products as is done in vending machines. The product pusher electronic rack in Store Automation may use a secured Product Cover to protect the products being picked up by unauthorized users. The same secured Product Cover may be used by merchants to uncover and load the products into Pusher Coil.

Here is the brief description of how Store Automation with product pusher electronic rack would work:

Merchants set up racks, bins, return stations, QR Codes and load products.

Shoppers open payment pre-authorization, select and pickup products from one or more racks.

Shoppers close payment pre-authorization and exit.

Shoppers return products, if needed.

Merchants process returned products.

Merchants process settlement of purchases, returns and payment pre-authorization.

Here is the step by step description of how Store Automation with product pusher electronic rack would work:

Prospective store owners would register with intermediary agent and the information will be maintained in store owner table.

Registered store owners would add, modify or delete store information using the forms provided by intermediary agent and the information will be maintained in store location table.

Registered store owners would add, modify or delete employees using the forms provided by intermediary agent and the information will be maintained in store employee table. Active employees would modify their own information using the forms provided by intermediary agent and the information will be maintained in store employee table.

Active employees would add, modify or delete product information using the forms provided by intermediary agent and the information will be maintained in store product table. In some embodiments non-products such as gift card and pre-paid cards can also be sold as products. For example, when a gift card is purchased from a bin, the gift card will also be activated when the gift card is pushed to product pickup slot.

Active employees would add, modify or delete rack information using the forms provided by intermediary agent and the information will be maintained in store rack table.

Active employees would add, modify or delete bin information using the forms provided by intermediary agent and the information will be maintained in store bin table.

Active employees would add, modify or delete product stocked information using the forms provided by intermediary agent and the information will be maintained in store product inventory table.

Active employees would print and display Rack QR Codes downloaded using forms provided by intermediary agent. Rack identifier will also be displayed on each rack.

Active employees would print and display Bin QR Code downloaded using forms provided by intermediary agent. Bin identifier will also be displayed on each bin.

Shoppers would scan the Bin QR Codes to view the description and other details of the products stored in the bins.

Active employees would print and display Pre-Authorization iPosters, Exit iPosters and Return QR Code.

Active employees would pickup returned products from lockers and process the product returns using an intermediary agent provided product return form as explained in product return credits application.

Automated payment settlement process would settle pre-authorized amount and close the payment pre-authorization using automated payment settlement application.

Shoppers would use any app provided by the intermediary agent or interfaced with intermediary agent or a mobile browser to scan any QR Code displayed at any store automation location.

When a QR Code displayed at any store automation location is scanned, the request handler would receive the content of the QR code which will be in a pre-defined format holding application identifier and other information related to the application identifier. The content of the QR Code will be referred to as request message.

When a rack product pusher switch is pushed, the request handler would receive the identification of the of the rack product pusher switch which will be in a pre-defined format holding application identifier and other information related to the application identifier. The content of the rack product pusher switch identification will be referred to as request message.

If the content of the request message is in the required pre-defined format, then the request handler would segregate the value of application identifier from the request message, otherwise the request handler would terminate the process. If the application identifier is to process pre-authorization payment or to process bin identifier or to process rack identifier or to process rack product pusher switch identification or to process exit or to process product returns, then the request handler would execute pre-authorization payment application or bin identifier application or rack identifier application or pusher switch application or exit application or product return application respectively.

If the application identifier is valid, then the request handler would also pass on the value of request message to the application being executed, otherwise the process will be terminated.

If pusher switch application is executed then the request handler would receive a response from pusher switch application which the request handler would return to the rack product pusher switch as a response. As explained before, the rack product pusher switch will push the products from coils to product pickup slots as required.

The applications that the request handler can execute are described hereunder.

Pre-authorization payment application: If the request handler could segregate the request message, based on a pre-defined procedure, into various segments such as application identifier, owner identifier and location identifier, then the request handler would continue the process, otherwise it will be terminated. If the application identifier is to process pre-authorization payment application then the process will continue, otherwise it will be terminated. If the process continues, the request handler would save the owner identifier and the location identifier as QR code owner identifier and QR code location identifier respectively, otherwise the process will be terminated.

If the process continues, then the request handler would determine whether a payment authorization is active for the shopper at the location. To determine whether a payment authorization is active, the request handler would retrieve the payment authorization information from the shopper mobile device and verify whether the payment authorization is active in store payment authorization table.

When shoppers initiate a payment authorization using an app and if the values for owner identifier, location identifier and payment authorization identifier are saved in the app, then the request handler would save the values of owner identifier, location identifier and payment authorization identifier as shopper owner identifier, shopper location identifier and shopper payment authorization identifier respectively and save ‘Y’ as shopper identifier found, otherwise the request handler would save ‘N’ as shopper identifier found.

When shoppers initiate a payment authorization using a mobile browser and if the values for owner identifier, location identifier and payment authorization identifier cookies are saved in the mobile browser, then the request handler would save the cookie values of owner identifier, location identifier and payment authorization identifier as shopper owner identifier, shopper location identifier and shopper payment authorization identifier respectively and save ‘Y’ as shopper identifier found, otherwise the request handler would save ‘N’ as shopper identifier found.

If shopper identifier found is ‘Y’, then the request handler would retrieve a single row from store payment authorization table where store owner identifier is equal to shopper owner identifier, store location identifier is equal to shopper location identifier, payment authorization identifier is equal to shopper payment authorization identifier and payment authorization sequence is equal to latest payment authorization sequence for the selected store owner identifier, store location identifier and payment authorization identifier. If a row is retrieved from the store payment authorization table and if the value of payment authorization status in the retrieved row is ‘A’, then the request handler would save ‘A’ as the value for shopper payment authorization status, otherwise the request handler would save ‘I’ as the value for shopper payment authorization status.

If shopper payment authorization status is ‘A’, shopper owner identifier is equal to QR code owner identifier and shopper location identifier is equal to QR code location identifier, then the request handler would inform the shopper that a payment authorization is active and another payment authorization cannot be created and terminate the process. In some embodiments the shoppers may be allowed to add additional payment to a payment authorization that is active.

If the process continues, then the request handler would accept payment information and an amount from the shopper and process the data for a payment authorization. The user can use any credit or debit or pre-paid or gift card. Cash paying shoppers can use a cash acceptor machine and receive a pre-paid digital number or a card. If the cash paying shoppers receive a pre-paid digital number then, the shopper can use the pre-paid digital number as a card. The request handler would receive a card number and an amount which the request handler would use with a payment processor for a pre-authorization. If the pre-authorization is successful, then the request handler would receive a pre-authorization code which the request handler would save as card external authorization code.

If the payment authorization is successful, the amount will be saved as new payment authorization amount, a new payment authorization identifier and a new payment authorization sequence will be generated. The new payment authorization identifier will be the last few digits of the payment card number used to create the payment authorization. To avoid payment authorization identifier duplicates, the number of digits used in last few digits of the payment card to generate new payment authorization identifier should be long enough that the payment authorization identifier would always be unique among the payment authorization identifiers that are currently active within a owner identifier and location identifier.

To generate a new payment authorization sequence, the request handler would retrieve a single row from store payment authorization table where store owner identifier is equal to QR code owner identifier, store location identifier is equal to QR code location identifier, payment authorization identifier is equal to new payment authorization identifier and payment authorization sequence is equal to the value of payment authorization sequence in the latest row for the selected store owner identifier, store location identifier and payment authorization identifier. If a row is retrieved from the store payment authorization table, then the request handler would save the value of shopper payment authorization sequence plus 1 as the new payment authorization sequence, otherwise the request handler would save 1 as the new payment authorization sequence.

Then a row will be inserted in the store payment authorization table using the values of QR code owner identifier for owner identifier, QR code location identifier for location identifier, new payment authorization identifier for payment authorization identifier, new payment authorization sequence for payment authorization sequence,

new payment authorization amount for pre-authorized amount, 0 for used amount, 0 for refund amount, card external authorization code for external authorization identifier and ‘A’ for authorization status. If an app is used by the shoppers to initiate the payment authorization, then the QR code owner identifier, QR code location identifier and new payment authorization identifier will also be saved in the app as owner identifier, location identifier and payment authorization identifier respectively. If a mobile browser is used by the shoppers to initiate the payment authorization, then the QR code owner identifier, QR code location identifier and new payment authorization identifier will also be saved in the mobile browser as owner identifier, location identifier and payment authorization identifier cookies.

Bin identifier application: If the request handler could segregate the request message, based on a pre-defined procedure, into various segments such as application identifier, owner identifier, location identifier, rack identifier and bin identifier, then the request handler would continue the process, otherwise it will be terminated. If the application identifier is to process bin identifier application then the process will continue, otherwise it will be terminated. If the process continues, the request handler would save the owner identifier, the location identifier, rack identifier and bin identifier as QR code owner identifier, QR code location identifier, QR code rack identifier and QR code bin identifier respectively, otherwise the process will be terminated.

Then the request handler would retrieve one row from store product inventory table for each saved database bin identifier where store owner identifier is equal to QR code owner identifier, store location identifier is equal to QR code location identifier, rack identifier is equal to QR code rack identifier and bin identifier is equal to QR code bin identifier. Then the request handler would save the values of product identifier and quantity from the one row retrieved from store product inventory table as database product identifier and database quantity.

Then the request handler would retrieve one row from store product table where store owner identifier is equal to QR code owner identifier, store location identifier is equal to QR code location identifier and product identifier is equal to database product identifier. Then the request handler would save the values of product description and product price from the one row retrieved from store product table as database product description and database product price.

Then the request handler would display database product description, database product price and database quantity and terminate the process.

Rack identifier application: If the request handler could segregate the request message, based on a pre-defined procedure, into various segments such as application identifier, owner identifier, location identifier and rack identifier, then the request handler would continue the process, otherwise it will be terminated. If the application identifier is to process rack identifier application then the process will continue, otherwise it will be terminated. If the process continues, the request handler would save the owner identifier, the location identifier and rack identifier as QR code owner identifier, QR code location identifier and QR code rack identifier respectively, otherwise the process will be terminated.

The request handler would set the current advance authentication to inactive status, if the current active advance authentication is active and expired. The request handler would retrieve one row from store advance authentication table where store owner identifier is equal to QR code owner identifier, store location identifier is equal to QR code location identifier, rack identifier is equal to QR code rack identifier and advance authentication sequence is equal to the latest advance authentication sequence of the selected store owner identifier, store location identifier and rack identifier. If a row from store advance authentication table is retrieved and if the value of advance authentication status in the retrieved row is ‘A’ and if the request handler server current date hour minute second minus the value of advance authentication start date hour minute second in the retrieved row is more than a pre-set value in seconds, then the request handler would save the value of advance authentication sequence from the retrieved row as database advance authentication sequence and inactivate the current advance authentication. To inactivate the current advance authentication, the request handler would update a row in store advance authentication table by setting the value of advance authentication status to ‘I’ and advance authentication end date hour minute second to request handler server current date hour minute second in store advance authentication table where store owner identifier is equal to QR code owner identifier, store location identifier is equal to QR code location identifier, rack identifier is equal to QR code rack identifier and advance authentication sequence is equal to database advance authentication sequence. If Rack Pusher Switch is pushed when the current advance authentication is active, then all the selected products in the virtual shopping cart will be pushed into product slot. If Rack Pusher Switch is not pushed when the current advance authentication is active within a preset time, then the current advance authentication will expire and become inactive. If Rack Pusher Switch is pushed when the current advance authentication is not active, then products will not be pushed into product pickup slot.

If the Rack QR Code is scanned from an app, then the request handler would save the values of owner identifier, location identifier and payment authorization identifier saved in the app as device owner identifier, device location identifier and device payment authorization identifier. If the Rack QR Code is scanned from a mobile device, then the request handler would save the values of owner identifier, location identifier and payment authorization identifier cookies in the mobile browser as device owner identifier, device location identifier and device payment authorization identifier. If the request handler is unable to retrieve device owner identifier, device location identifier or device payment authorization identifier from the app or from the mobile browser, then the request handler would inform the shopper that setting up a payment authorization using the Pre-Authorization iPoster is required before scanning the Rack QR Code and terminate the process.

If the process continues, then the request handler would verify that the information from the request message and the information from the app or the mobile browser is valid by comparing the values QR code owner identifier and QR code location identifier with device owner identifier and device location identifier respectively. If the information from the request message and the information from the app or mobile device does not match, then the request handler would inform the shopper that the scanned QR Code is invalid and terminate the process.

If the process continues, then the request handler would verify that the information retrieved from the app or from the mobile browser is valid by retrieving the latest single row from store payment authorization table where store owner identifier is equal to device owner identifier, store location identifier is equal to device location identifier, payment authorization identifier is equal to device payment authorization identifier and payment authorization sequence is equal to latest payment authorization sequence for the selected store owner identifier, store location identifier and payment authorization identifier. If a row is retrieved and if the value of authorization status in the single retrieved row is ‘A’ then the process will save the value of payment authorization sequence from the single retrieved row as database payment authorization sequence and will continue, otherwise the request handler would inform the shopper that setting up a payment authorization using the iPoster is required before scanning the Rack QR Code and terminate the process.

If the process continues, then the request handler would verify that the advance authentication for the shopper is not active. The request handler would retrieve one row from store advance authentication table where store owner identifier is equal to QR code owner identifier, store location identifier is equal to QR code location identifier, rack identifier is equal to QR code rack identifier and advance authentication sequence is equal to the latest authentication sequence of the selected store owner identifier, store location identifier and rack identifier. If a row is retrieved and if the value of authentication status in the retrieved row is ‘A’ and if the values of payment authorization identifier and payment authorization sequence from the retrieved row are equal to device payment authorization identifier and database payment authorization sequence respectively, then the request handler would inform the shopper that Rack QR Code cannot be scanned when advance authentication is active and terminate the process.

If the process continues, then the shopper will be presented with 3 options namely ‘Add To Virtual Shopping Cart’, ‘Remove From Virtual Shopping Cart’ and ‘Activate Advance Authentication’ to choose from. If the shopper selects an option, then the request handler would execute a process based on the shopper selection and the values of QR code owner identifier, QR code location identifier, QR code rack identifier, device payment authorization identifier and database payment authorization sequence will be passed on to the executed processes. If the shopper selected the option to add one or more products to virtual shopping cart then the request handler would execute the process ‘Add To Virtual Shopping Cart’. If the shopper selected the option to remove one or more products from virtual shopping cart then the request handler would execute the process ‘Remove From Virtual Shopping Cart’. If the shopper selected the option to activate an advance authentication, then the request handler would execute the process ‘Activate An Advance Authentication’.

Add To Virtual Shopping Cart: When Add To Virtual Shopping Cart process is executed, the process will also receive the values of QR code owner identifier, QR code location identifier, QR code rack identifier, device payment authorization identifier and database payment authorization sequence, otherwise the process will terminate.

The process will continue only if the calculated available amount for the shopper is greater than 0. To determine the calculated available amount, the request handler would retrieve database authorized amount and database used amount from payment authorization table and determine calculated pending amount by retrieving rows from the store virtual shopping cart table, store product inventory table and store product table. To retrieve database authorized amount and database used amount, the request handler would retrieve one row from store payment authorization table where store owner identifier is equal to QR code owner identifier, store location identifier is equal to QR code location identifier, payment authorization identifier is equal to device payment authorization identifier and payment authorization sequence is equal to database payment authorization sequence. If a row is retrieved and if the value of authorization status in the retrieved row is ‘A’, then the request handler would save the values of authorized amount and used amount from the retrieved row as database authorized amount and database used amount respectively and continue, otherwise the request handler would inform the shopper that authorized amount is not available and terminate the process. To determine calculated pending amount, the request handler would retrieve all the latest single rows from store virtual shopping cart table where store owner identifier is equal to QR code owner identifier, store location identifier is equal to QR code location identifier, payment authorization identifier is equal to device payment authorization identifier, payment authorization sequence is equal to database payment authorization sequence, rack identifier is equal to QR code rack identifier, bin identifier is not blank, bin selected sequence is the latest bin selected sequence of the selected store owner identifier, store location identifier, payment authorization identifier, payment authorization sequence, rack identifier and bin identifier. The request handler would save the value of bin identifier from each retrieved row where the value of bin selected status in the retrieved row is ‘S’ as database bin identifier. Then the request handler would retrieve one row from store product inventory table for each saved database bin identifier where store owner identifier is equal to QR code owner identifier, store location identifier is equal to QR code location identifier, rack identifier is equal to QR code rack identifier and bin identifier is equal to database bin identifier. Then the request handler would save the value of product identifier from each retrieved row from store product inventory table as database product identifier.

Then the request handler would retrieve one row from store product table for each saved database product identifier where store owner identifier is equal to QR code owner identifier, store location identifier is equal to QR code location identifier and product identifier is equal to database product identifier. Then the request handler would save the value of product price from each retrieved row from store product table as database product price. Then the request handler would sum up all the database product price to save calculated pending amount. Then the request handler would calculate the calculated available amount using the formula database authorized amount minus database used amount minus calculated pending amount.

If the calculated available amount is grater than 0, then the process will continue, otherwise the request handler would inform the shopper that enough authorized amount is not available to add a product to virtual shopping cart and terminate the process.

If the process continues, then the request handler would display a list of available products for the shopper to select one product at a time to add to virtual shopping cart. To format a list of available products, the request handler would start with a blank list of available products and would retrieve all the products stored in the bins of the rack identified by QR code owner identifier, QR code location identifier and QR code rack identifier. The request handler would retrieve all the rows from store product inventory table where the owner identifier is equal to QR code owner identifier, location identifier is equal to QR code location identifier, rack identifier is equal to QR code rack identifier, bin identifier is not blank and the quantity is greater than 0. For each retrieved row from the store product inventory table, the request handler would save bin identifier as database bin identifier and product identifier as database product identifier. For each retrieved row from the store product inventory table, the request handler would retrieve one row from store product table where store owner identifier is equal to QR code owner identifier, store location identifier is equal to QR code location identifier, product identifier is equal to database product identifier. For each retrieved row from the store product table, the request handler would save the values of product description and product price as database product description and database product price. Then the request handler would insert a row into list of available products with the values of QR code owner identifier, QR code location identifier, QR code rack identifier database bin identifier, database product description and database product price. Once all the rows are inserted into list of available products, the request handler would display each row in the list of available products with the values of database product description and database product price.

When a row is selected from the displayed list of available products, the intermediary agent would receive the QR code owner identifier, QR code location identifier, the QR code rack identifier and database bin identifier from the selected row. Then the request handler would determine the calculated available amount using various tables in the database as explained before. If the database product price is greater than calculated available amount, then request handler would inform the shopper that the price of the selected product is more than the available amount, terminate the current process and execute the process again.

If the current process continues, then the request handler would retrieve one row from store virtual shopping cart table which would be the latest row based on the value of bin selected sequence where store owner identifier is equal to QR code owner identifier, store location identifier is equal to QR code location identifier, payment authorization identifier is equal to device payment authorization identifier, payment authorization sequence is equal to database payment authorization sequence, rack identifier is equal to QR code rack identifier and bin identifier is database bin identifier. If a row is retrieved from store virtual shopping cart table and if the value of bin selected status in the retrieved row is ‘S’, then the request handler would inform the shopper that a product from a bin cannot be selected more than once, terminate the current process and execute the process again.

If the current process continues and a row was retrieved from virtual shopping cart table, then the request handler would save the value of bin selected sequence from the retrieved row plus 1 as calculated bin selected sequence. If the current process continues and a row was not retrieved from virtual shopping cart table, then the request handler would save 1 as calculated bin selected sequence.

Then the request handler would insert a row into store virtual shopping cart table using the values QR code owner identifier, QR code location identifier, device payment authorization identifier, database payment authorization sequence, QR code rack identifier, database bin identifier, calculated bin selected sequence and ‘S’ for store owner identifier, store location identifier, payment authorization identifier, payment authorization sequence, rack identifier, bin identifier, bin selected sequence and bin selected status respectively.

Then the request handler would execute ‘Add To Virtual Shopping Cart’ process repeatedly until the shopper terminates the process. This would enable the shopper to add as many products as possible from the displayed list of available products into virtual shopping cart.

Remove From Virtual Shopping Cart: When Remove From Virtual Shopping Cart process is executed, the process will also receive the values of QR code owner identifier, QR code location identifier, QR code rack identifier, device payment authorization identifier and database payment authorization sequence, otherwise the process will terminate.

If the process continues, the request handler would display a selected product list for the shopper to select one or more products at a time to remove from virtual shopping cart that are in the status of being selected. The request handler would also display the instructions on how to select a product to remove from virtual shopping cart. To format a selected product list, the request handler would start with a blank selected product list and would retrieve all the products waiting to be purchased in virtual shopping cart. The request handler would retrieve all the rows from store virtual shopping cart table where store owner identifier is equal to QR code owner identifier, store location identifier is equal to QR code location identifier, payment authorization identifier is equal to device payment authorization identifier, payment authorization sequence is equal to database payment authorization sequence, rack identifier is equal to QR code rack identifier, bin identifier is not blank, bin selected sequence is the latest bin selected sequence of the selected store owner identifier, store location identifier, payment authorization identifier, payment authorization sequence, rack identifier and bin identifier.

For each retrieved row where the value of bin selected status in the retrieved row is equal to ‘S’, the request handler would save the value of bin identifier as database bin identifier, the value of bin selected sequence as database bin selected sequence.

For each saved database bin identifier, the request handler would retrieve a row from store product inventory table where store owner identifier is equal to QR code owner identifier, store location identifier is equal to QR code location identifier, rack identifier is equal to QR code rack identifier and bin identifier is equal to database bin identifier. Then the request handler would save the values of product identifier

and quantity from each retrieved row from store product inventory table as database product identifier and database quantity.

Then the request handler would retrieve one row from store product table where store owner identifier is equal to QR code owner identifier, store location identifier is equal to QR code location identifier, product identifier is equal to database product identifier. For each retrieved row from the store product table, the request handler would save the values of product description and product price as database product description and database product price.

Then the request handler would insert a row into selected product list with the values of QR code owner identifier, QR code location identifier, QR code rack identifier, database bin identifier, database bin selected sequence, database product description, database product price and database quantity. Once all the rows are inserted into selected product list, the request handler would display each row in the selected product list with the values of database product description, database product price and database quantity.

When one or more rows are selected from the displayed selected product list, the intermediary agent would receive the QR code owner identifier, QR code location identifier, the QR code rack identifier, database bin identifier and database bin selected sequence from each selected row. Then the request handler would save the values of QR code owner identifier, QR code location identifier, QR code rack identifier, database bin identifier and database bin selected sequence of each selected row as selected owner identifier, selected location identifier, selected rack identifier, selected bin identifier and selected bin selected sequence. Then the request handler would update the rows by setting the value of bin selected status to ‘C’ in store virtual shopping cart table where store owner identifier is equal to selected owner identifier, store location identifier is equal to selected location identifier, payment authorization identifier is equal to device payment authorization identifier, payment authorization sequence is equal to database payment authorization sequence, rack identifier is equal to selected rack identifier, bin identifier is equal to selected bin identifier, bin selected sequence is equal to selected bin selected sequence.

Then the request handler would reload rows into selected product list and display each row in the selected product list with the values of database product description and database product price repeatedly until the shopper terminates the process. This would enable the shopper to remove as many products as possible from store virtual shopping cart table that the shopper does not want to purchase.

Activate An Advance Authentication: When Activate An Advance Authentication process is executed, the process will also receive the values of QR code owner identifier, QR code location identifier, QR code rack identifier, device payment authorization identifier and database payment authorization sequence, otherwise the process will terminate.

If one or more products have been selected for purchase then the advance authentication can be activated. To verify that there are one or more products have been selected for purchase by the shopper, the request handler would retrieve rows from store virtual shopping cart table where store owner identifier is equal to QR code owner identifier, store location identifier is equal to QR code location identifier, payment authorization identifier is equal to device payment authorization identifier, payment authorization sequence is equal to database payment authorization sequence, rack identifier is equal to QR code rack identifier, bin identifier is not blank, bin selected sequence is equal to the latest bin selected sequence of the selected store owner identifier, store location identifier, payment authorization identifier, payment authorization sequence, rack identifier and bin identifier. If the value of bin selected status is ‘S’ in at least one row retrieved from store virtual shopping cart table, then the process will continue, otherwise the request handler would inform the shopper that at least one product must be selected for purchase before requesting to activate an advance authentication and terminate the process.

If the process continues, then the request handler would verify that the latest advance authentication sequence in store advance authentication table is not active. To verify that the latest advance authentication sequence in store advance authentication table is not active, the request handler would retrieve one row from store advance authentication table where store owner identifier is equal to QR code owner identifier, store location identifier is equal to QR code location identifier, rack identifier is equal to QR code rack identifier and advance authentication sequence is equal to the latest advance authentication sequence of the selected store owner identifier, store location identifier and rack identifier. If a row is retrieved and the value of advance authentication status in the retrieved row is ‘A’, then the request handler would inform the shopper that an advance authentication cannot be activated now and try again later and terminate the process. If the process continues and a row is retrieved from the store advance authentication table, then the request handler would save the value of advance authentication sequence from the retrieved row plus 1 as calculated advance authentication sequence. If the process continues and a row is not retrieved from the store advance authentication table, then the request handler would save 1 as calculated advance authentication sequence.

Then the request handler would insert a row in store advance authentication table using the values of QR code owner identifier, QR code location identifier, QR code rack identifier, calculated advance authentication sequence, ‘A’, device payment authorization identifier, database payment authorization sequence, request handler current server date hour minute second, and blank for store owner identifier, store location identifier, rack identifier, advance authentication sequence, advance authentication status, payment authorization identifier, payment authorization sequence, advance authentication start date hour minute second and advance authentication end date hour minute second respectively.

Then the request handler would inform the shopper that an advance authentication has been activated and the Rack Product Pusher Switch must be pushed within 15 seconds and get the selected products from the Product Pickup Slots and terminate the process.

Pusher switch application: If the request handler could segregate the request message, based on a pre-defined procedure, into various segments such as application identifier, owner identifier, location identifier and rack identifier, then the request handler would continue the process, otherwise it will be terminated. If the application identifier is to process pusher switch application then the process will continue, otherwise it will be terminated. If the process continues, the request handler would save the owner identifier, the location identifier and rack identifier as switch owner identifier, switch location identifier and switch rack identifier respectively.

If the request is valid, then the request handler would create a bin identifier list with bin identifiers where the products in the bin identifiers should be moved to product pickup slots. Then the request handler would adjust the product inventory of the products stored in the bin identifier list, add the cost of the products stored in the bin identifier list to used amount in the payment authorization table, set bin selected status to ‘P’ of the products stored in the bin identifier list in store virtual shopping cart table and return an approval response with the bin identifier list.

If the request is not valid then the request handler would return a denial response without any bin identifiers. Upon receiving an approval response, Rack Product Pusher Switch would activate the Pusher Motors connected to bins identified in the list of bin identifiers received with the approval response to push the products from coils to product pickup slots.

If the process continues, the request handler would verify the received data by retrieving one row from store rack table where store owner identifier is equal to switch owner identifier, store location identifier is equal to switch location identifier, rack identifier is equal to switch rack identifier and status is equal to ‘A’. If a row is retrieved then the process will continue, otherwise it will be terminated.

If the process continues, request handler would retrieve a single row from store advance authentication table where store owner identifier is equal to switch owner identifier, store location identifier is equal to switch location identifier, rack identifier is equal to switch rack identifier and advance authentication sequence is the latest advance authentication sequence of the selected store owner identifier, store location identifier and rack identifier.

If a row is retrieved and if the value of advance authentication status in the retrieved row is ‘A’, then the request handler would save the values of payment authorization identifier, payment authorization sequence and advance authentication start date hour minute second in the retrieved row as database payment authorization identifier, database payment authorization sequence and database advance authentication start date hour minute second respectively and the process will continue, otherwise the request handler would return a denial response without any bin identifiers and terminate the process.

If the process continues and if the request handler server current date hour minute second minus database advance authentication start date hour minute second is greater than a pre-set value in seconds, then the request handler would return a denial response without any bin identifiers and terminate the process.

If the process continues, then the request handler would retrieve a single row from store payment authorization table where store owner identifier is equal to switch owner identifier, store location identifier is equal to switch location identifier, payment authorization identifier is equal to database payment authorization identifier and payment authorization sequence is equal to database payment authorization sequence. If a row is retrieved and if the value of authorization status in the retrieved row is ‘A’, then the process will continue, otherwise the request handler would return a denial response without any bin identifiers and terminate the process.

If the process continues, then the request handler would retrieve all the products waiting to be purchased in store virtual shopping cart table. The request handler would retrieve all rows from store virtual shopping cart table where store owner identifier is equal to switch owner identifier, store location identifier is equal to switch location identifier, payment authorization identifier is equal to database payment authorization identifier, payment authorization sequence is equal to database payment authorization sequence, rack identifier is equal to switch rack identifier, bin identifier is not blank, bin selected sequence is the latest bin selected sequence of the selected store owner identifier, store location identifier, payment authorization identifier, payment authorization sequence, rack identifier and bin identifier.

For each retrieved row from store virtual shopping cart table where the value of bin selected status in the retrieved row is equal to ‘S’, the request handler would save the value of bin identifier as database bin identifier, the value of bin selected sequence as database bin selected sequence.

For each saved database bin identifier, the request handler would retrieve a row from store product inventory table where store owner identifier is equal to switch owner identifier, store location identifier is equal to switch location identifier, rack identifier is equal to switch rack identifier bin identifier is equal to database bin identifier. If a row is retrieved from store product inventory table, then the request handler would save the values of product identifier and quantity from the retrieved row from store product inventory table as database product identifier and database quantity.

If database quantity is greater than 0, then the request handler would retrieve one row from store product table where store owner identifier is equal to switch owner identifier, store location identifier is equal to switch location identifier, product identifier is equal to database product identifier. If database quantity is greater than 0 and a row is retrieved from store product table, then the request handler would save the value of product price as database product price.

If database quantity is greater than 0, then the request handler would update a single row in store payment authorization table by setting the value of used amount to used amount plus database product price where store owner identifier is equal to switch owner identifier, store location identifier is equal to switch location identifier, payment authorization identifier is equal to database payment authorization identifier and payment authorization sequence is equal to database payment authorization sequence.

If database quantity is greater than 0, then the request handler would update a single row in store payment product inventory table by setting the value of quantity to quantity minus 1 where store owner identifier is equal to switch owner identifier, store location identifier is equal to switch location identifier, rack identifier is equal to switch rack identifier and bin identifier is equal to database bin identifier.

If database quantity is greater than 0, then the request handler would update one row by setting the value of bin selected status to ‘P’ in store virtual shopping cart table where store owner identifier is equal to switch owner identifier, store location identifier is equal to switch location identifier, payment authorization identifier is equal to database payment authorization identifier, payment authorization sequence is equal to database payment authorization sequence, rack identifier is equal to switch rack identifier, bin identifier is equal to database bin identifier, bin selected sequence is equal to database bin selected sequence.

If database quantity is greater than 0, then the request handler would add database bin identifier to bin identifier list.

When the request handler processes all the rows retrieved from store virtual shopping cart table, the request handler would return an approval response with the bin identifiers stored in bin identifier list.

Exit application: If the request handler could segregate the request message, based on a pre-defined procedure, into various segments such as application identifier, owner identifier and location identifier, then the request handler would continue the process, otherwise it will be terminated. If the application identifier is to process Exit application then the process will continue, otherwise it will be terminated. If the process continues, the request handler would save the owner identifier and location identifier as exit owner identifier and exit location identifier respectively.

If the QR Code from an exit iposter is scanned from an app, then the request handler would save the values of owner identifier, location identifier and payment authorization identifier saved in the app as device owner identifier, device location identifier and device payment authorization identifier. If the QR Code from an exit iposter is scanned from a mobile device, then the request handler would save the values of owner identifier, location identifier and payment authorization identifier cookies in the mobile browser as device owner identifier, device location identifier and device payment authorization identifier. If the request handler is unable to retrieve device owner identifier, device location identifier or device payment authorization identifier from the app or from the mobile browser, then the request handler would inform the shopper that setting up a payment authorization using the Pre-Authorization iPoster is required before scanning a QR Code on an exit iPoster and terminate the process.

If the process continues, then the request handler would verify that the information retrieved from the app or from the mobile browser is valid by comparing the values of exit owner identifier and exit location identifier with device owner identifier and device location identifier respectively. If exit owner identifier and exit location identifier are valid then the process will continue, otherwise the request handler would inform the shopper that the scanned QR Code is not valid and terminate the process.

If the process continues, then the request handler would verify that the information retrieved from the app or from the mobile browser is valid by retrieving the latest single row from store payment authorization table where store owner identifier is equal to device owner identifier, store location identifier is equal to device location identifier, payment authorization identifier is equal to device payment authorization identifier and payment authorization sequence is equal to latest payment authorization sequence for the selected store owner identifier, store location identifier and payment authorization identifier. If a row is retrieved and if the value of authorization status in the single retrieved row is ‘A’ then the process will save the value of payment authorization sequence, authorized amount and used amount from the single retrieved row as database payment authorization sequence, database authorized amount and database used amount respectively and will continue, otherwise the request handler would inform the shopper that setting up a payment authorization using the Pre-Authorization iPoster is required before scanning the QR Code on exit iPoster and terminate the process.

Then the request handler would display a receipt. To display a receipt, the request handler would retrieve rows from store virtual shopping cart table, store product inventory table and store product table and insert the values into receipt product list.

The request handler would retrieve all the rows from store virtual shopping cart table where store owner identifier is equal to device owner identifier, store location identifier is equal to device location identifier, payment authorization identifier is equal to device payment authorization identifier, payment authorization sequence is equal to database payment authorization sequence, rack identifier is not blank, bin identifier is not blank and bin selected status is ‘P’. Then the request handler would save the values of rack identifier and bin identifier from each row retrieved from store virtual shopping cart table as database rack identifier and database bin identifier. For each saved database rack identifier and database bin identifier, the request handler would retrieve a row from store product inventory table where store owner identifier is equal to device owner identifier, store location identifier is equal to device location identifier, rack identifier is equal to database rack identifier and bin identifier is equal to database bin identifier. Then the request handler would save the value of product identifier from the retrieved row from store product inventory table as database product identifier.

Then the request handler would retrieve one row from store product table where store owner identifier is equal to device owner identifier, store location identifier is equal to device location identifier, product identifier is equal to database product identifier. For each retrieved row from the store product table, the request handler would save the values of product description and product price as database product description and database product price. Then the request handler would add a row with the values of database product description and database product price to receipt product list.

Upon adding the values from all retrieved rows into receipt product list, the request handler would display the values of database product description and database product price of each row from the receipt product list. Then the request handler would also display database authorized amount and database used amount.

The receipt would also display the message that the payment card will be charged only for the used amount.

Then the request handler would update a single row in store payment authorization table by setting the value of authorization status to ‘I’ where store owner identifier is equal to device owner identifier, store location identifier is equal to device location identifier, payment authorization identifier is equal to database payment authorization identifier and payment authorization sequence is equal to database payment authorization sequence.

Then the request handler would inform the shopper that products can be returned, if any, before exiting the store and terminate the process.

Product return application: If the request handler could segregate the request message, based on a pre-defined procedure, into various segments such as application identifier, owner identifier and location identifier, then the request handler would continue the process, otherwise it will be terminated. If the application identifier is to process Product return application then the process will continue, otherwise it will be terminated. If the process continues, the request handler would save the owner identifier and location identifier as return owner identifier and return location identifier respectively.

If the Return QR Code is scanned from an app, then the request handler would save the values of owner identifier, location identifier and payment authorization identifier saved in the app as device owner identifier, device location identifier and device payment authorization identifier. If the Return QR Code is scanned from a mobile device, then the request handler would save the values of owner identifier, location identifier and payment authorization identifier cookies in the mobile browser as device owner identifier, device location identifier and device payment authorization identifier. If the request handler is unable to retrieve device owner identifier, device location identifier or device payment authorization identifier from the app or from the mobile browser, then the request handler would inform the shopper that setting up a payment authorization using the Pre-Authorization iPoster is required before scanning the Return QR Code and terminate the process.

If the process continues, then the request handler would verify that the information retrieved from the app or from the mobile browser is valid by comparing the values of return owner identifier and return location identifier with device owner identifier and device location identifier respectively. If return owner identifier and return location identifier are valid then the process will continue, otherwise the request handler would inform the shopper that the scanned QR Code is not valid and terminate the process.

If the process continues, then the request handler would verify that the information retrieved from the app or from the mobile browser is valid by retrieving the latest single row from store payment authorization table where store owner identifier is equal to device owner identifier, store location identifier is equal to device location identifier, payment authorization identifier is equal to device payment authorization identifier and payment authorization sequence is equal to latest payment authorization sequence for the selected store owner identifier, store location identifier and payment authorization identifier. If a row is retrieved and if the value of authorization status in the single retrieved row is ‘I’ then the process will save the value of payment authorization sequence from the single retrieved row as database payment authorization sequence and will continue, otherwise the request handler would inform the shopper that setting up a payment authorization using the Pre-Authorization iPoster and exiting using an Exit iPoster is required before scanning the Return QR Code and terminate the process.

If the process continues, the request handler would display a purchased product list for the shopper to select one or more purchased products to return purchased products from virtual shopping cart that are in the status of being purchased and has not been already returned. To format a purchased product list, the request handler would start with a blank purchased product list and then add rows into purchased product list. Then the request handler would retrieve all the purchased products that have not been returned in virtual shopping cart in all product pusher electronic racks. The request handler would retrieve all the rows from store virtual shopping cart table where store owner identifier is equal to device owner identifier, store location identifier is equal to device location identifier, payment authorization identifier is equal to device payment authorization identifier, payment authorization sequence is equal to database payment authorization sequence, rack identifier is not blank, bin identifier is not blank and bin selected sequence is not blank.

If at least one row is retrieved from store virtual shopping cart table where the values of bin selected status is ‘P’, then the process will continue, otherwise the request handler would inform the shopper no product is available to return and terminate the process.

For each retrieved row from store virtual shopping cart table where the value of bin selected status in the retrieved row is equal to ‘P’, the request handler would save the value of rack identifier as database rack identifier the value of bin identifier as database bin identifier, the value of bin selected sequence as database bin selected sequence.

For each saved database bin identifier, the request handler would retrieve a row from store product inventory table where store owner identifier is equal to device owner identifier, store location identifier is equal to device location identifier, rack identifier is equal to database rack identifier and bin identifier is equal to database bin identifier. Then the request handler would save the value of product identifier from each retrieved row from store product inventory table as database product identifier.

Then the request handler would retrieve one row from store product table where store owner identifier is equal to device owner identifier, store location identifier is equal to device location identifier, product identifier is equal to database product identifier. For each retrieved row from the store product table, the request handler would save the values of product description and product price as database product description and database product price. Then the request handler would add a row with the values database product description, database product price, device owner identifier, device location identifier, database rack identifier, database bin identifier and database bin selected sequence to return product list.

After adding all the rows into return product list, the request handler would display each row in the return product list with the values of database product description and database product price. The values of device owner identifier, device location identifier, database rack identifier, database bin identifier and database bin selected sequence will not be displayed.

If the number of rows in the return product list is one or more than 1, then the request handler would designate a locker number and a one-time code. To get the locker number and the one-time code, the request handler would retrieve one row from store product return locker activity table where store owner identifier is equal to device owner identifier, store location identifier is equal to device location identifier and the activity sequence is equal to the latest activity sequence for the selected store owner identifier and store location identifier. If one or more rows are retrieved and if at least one row with the value of ‘A’ for locker status then the request handler would save the values of locker number, activity sequence and the one-time code of the one row as database locker number, database locker activity sequence and database locker one-time code, otherwise the request handler would inform the shopper that a return locker is not available and try again and terminate the process.

Then the request handler would add 1 database locker activity sequence. The request handler would insert a row into store product return locker activity table using the values of device owner identifier, device location identifier, database locker number, database locker activity sequence, ‘U’, database locker one-time code, device payment authorization identifier and database payment authorization sequence for store owner identifier, store location identifier, locker number, activity sequence, locker status, one-time code, payment authorization identifier and payment authorization sequence respectively.

When one or more rows are selected from the displayed return product list, the intermediary agent would receive the device owner identifier, device location identifier, the database rack identifier, database bin identifier and database bin selected sequence from each selected row. Then the request handler would save the values of device owner identifier, device location identifier, database rack identifier, database bin identifier and database bin selected sequence of each selected row as selected owner identifier, selected location identifier, selected rack identifier, selected bin identifier and selected bin selected sequence. Then the request handler would update the rows by setting the value of bin selected status to ‘R’ in store virtual shopping cart table where store owner identifier is equal to selected owner identifier, store location identifier is equal to selected location identifier, payment authorization identifier is equal to device payment authorization identifier, payment authorization sequence is equal to database payment authorization sequence, rack identifier is equal to selected rack identifier, bin identifier is equal to selected bin identifier and bin selected sequence is equal to selected bin selected sequence.

The payment card will be credited for the returned products when the return products are verified by the employees. Then the request handler would inform the shopper that payment for the returned products will be credited to their payment card after the return products are verified by the employees.

Then the request handler would inform the shopper that a return receipt is printed on the printer. The receipt will include the list of the products returned, the locker number where the products can be left, the one-time code to open the locker and details on how the shopper would receive the payment for the returned products.

In some embodiments shopper clients can scan the QR Code displayed on the lockers using the app to open the locker instead of entering a one-time code.

The employees will periodically check the lockers for returned goods and process the refund as explained in product return credits application.

Product return credits application: Employees can use a form provided by the intermediary agent to process the refunds. Employees would enter values for store owner identifier, store location identifier, store employee identifier and a password to access the product return credits form.

The request handler would verify the credentials entered in the form and if the credentials are valid then the request handler will save store owner identifier and store location identifier as form owner identifier and form location identifier respectively and the process will continue, otherwise the process will be terminated.

If the process continues, the employee will be given a choice to add/edit lockers or process refunds. By selecting add/edit lockers option, the employees can maintain the information in the store product return locker header table and store product return locker activity table.

When process refunds option is selected, the employee will get a list of unavailable lockers. Unavailable lockers are the lockers where the shoppers have left the products that are to be refunded by the employees. To provide a list of unavailable lockers, the request handler would start with a blank list of unavailable lockers. Then the request handler would retrieve rows from store product return locker activity table where store owner identifier is equal to form owner identifier, store location identifier is equal to form location identifier, locker number is not blank and activity sequence is equal to latest activity sequence for the selected store owner identifier, store location identifier and locker number. If one or more rows are retrieved from store product return locker activity table, then the request handler would select only the rows where the value of locker status is ‘U’ and add the values of locker number and activity sequence as database locker number and database locker activity sequence respectively to the list of unavailable lockers.

Once the list of unavailable lockers is populated, the request handler would select one locker at a time from the list of unavailable lockers for the employee to process the refund for the returns. When a locker number from the list of unavailable lockers is selected by the request handler, the request handler would create a new refund product list which will be displayed to the employee so that one or more products can be selected from the refund product list by the employee to process the refund. To create a refund product list for a specific locker the request handler would save the selected locker number as current locker number and retrieve rows from store product return locker activity table where store owner identifier is equal to form owner identifier, store location identifier is equal to form location identifier, locker number is equal to current locker number and activity sequence is equal to latest activity sequence for the selected store owner identifier, store location identifier and locker number. If a row is retrieved, then the request handler would save the values of locker number, activity sequence, payment authorization identifier and payment authorization sequence as database locker number, database activity sequence, database payment authorization identifier and database payment authorization sequence respectively from each row.

Then the request handler would retrieve rows from virtual shopping cart table where store owner identifier is equal to form owner identifier, store location identifier is equal to form location identifier, payment authorization identifier is equal to database payment authorization identifier, payment authorization sequence is equal to database payment authorization sequence, rack identifier is not blank, bin identifier is not blank, bin selected sequence is not blank and bin selected status is equal to ‘R’. For each retrieved row from virtual shopping cart table, the request handler would save the values of rack identifier, bin identifier and bin selected sequence as database rack identifier, database bin identifier and database bin selected sequence respectively.

For each retrieved row from virtual shopping cart table, the request handler would retrieve a row from store product inventory table where store owner identifier is equal to form owner identifier, store location identifier is equal to form location identifier, rack identifier is equal to database rack identifier and bin identifier is equal to database bin identifier. Then the request handler would save the value of product identifier from each retrieved row from store product inventory table as database product identifier.

For each retrieved row from store product inventory table, the request handler would retrieve a row from store product table where store owner identifier is equal to form owner identifier, store location identifier is equal to form location identifier and product identifier is equal to database product identifier. Then the request handler would save the values of product description, product price from the retrieved row as database product description and database product price respectively.

Then the request handler would insert form owner identifier, form location identifier, database locker number, database activity sequence, database payment authorization identifier, database payment authorization sequence, database rack identifier, database bin identifier, database bin selected sequence, database product identifier, database product description and database product price as a row into refund product list.

Upon inserting all the rows into refund product list, the request handler would present a form to the employee with the data from refund product list with a check box for each row so that the employee can select a row or unselect row to issue a refund. The request handler would also add 2 submit buttons to the form where one button will be to close the from and terminate the process and another button is to process the refund for the selected rows.

If the employee selects the cancel button, the request handler would uncheck all the rows in refund product list and skip processing the refund. If the employee selects the button to process the refund then the request handler would process the refund.

To process the refund, the request handler would add up the database product price of all the rows in the refund product list where check box is checked by the employee and save the added up database product price as current refund amount. Then the request handler would update the refund amount in store payment authorization table by setting up the value of refund amount to refund amount plus current refund amount where store owner identifier is equal to form owner identifier, store location identifier is equal to form location identifier, payment authorization identifier is equal to database payment authorization identifier and payment authorization sequence is equal to database payment authorization sequence.

Then the request handler one row at a time would retrieve the values of database payment authorization identifier, database payment authorization sequence, database rack identifier, database bin identifier, database bin selected sequence from refund product list where check box is checked and would update the bin selected status in store virtual shopping cart table by setting up the value of bin selected status to ‘Z’ where store owner identifier is equal to form owner identifier, store location identifier is equal to form location identifier, payment authorization identifier is equal to database payment authorization identifier and payment authorization sequence is equal to database payment authorization sequence, rack identifier is equal to database rack identifier, bin identifier is equal to database bin identifier, bin selected sequence is equal to database bin selected sequence and bin selected status is equal to ‘R’.

Then the request handler would create a random number that is not currently being used as one-time code in any locker. Then the request handler would insert a row into store product return locker activity table using form owner identifier for store owner identifier, form location identifier for store location identifier, database locker number for locker number, database activity sequence plus 1 for activity sequence, ‘A’ for locker status, random number for one-time code, blank for payment authorization identifier and blank for payment authorization sequence.

Then the request handler would set the random number as one-time code in the locker. If the locker is an electronic locker managed by locker service provider then the request. handler would send the locker internal identifier and the one-time code. The internal identifier is the information provided by the locker service provider and saved as external identifier in store product return locker header table. If the locker is a manual locker then the employee will be instructed to set the one-time code manually in the locker. The request handler would retrieve one row from store product return locker header table where store owner identifier is equal to form owner identifier, store location identifier is equal to form location identifier and locker number is equal to database locker number. If a row is retrieved from store product return locker header table and the value of external identifier is not blank, then the request handler would send the one-time code and the external identifier to the electronic locker service provider with a request to set the one-time code, otherwise the request handler would request the employee to set the random number as one-time code for the locker manually.

The request handler may continue to process returns for lockers from the list of unavailable lockers until all the lockers in the list of unavailable lockers are processed.

Automated payment settlement application: Merchants can set up to run automated payment settlement application. It can be set up to run more than once everyday but usually set up to run once after the location is closed for the day. If the location closes before midnight, then the application can be set up to run before midnight for today's transactions. If the location does not close before midnight, then the application can be set up to run after midnight for yesterday's transactions. The application may also be set up to process transactions that were not processed in a pre-defined prior number of days. Merchants will run product return credits application to process refunds before the scheduled time to run automated payment settlement application. When the application is executed, the request handler would receive owner identifier, location identifier and would determine the begin date hour minute seconds and end date hour minute seconds based on the date or dates for which the transactions are processed. The request handler would save owner identifier, location identifier, begin date hour minute seconds and end date hour minute seconds as settlement owner identifier, settlement location identifier, settlement begin date hour minute seconds and settlement end date hour minute seconds respectively.

The request handler would programmatically inactivate shoppers who have signed-in and have not signed-out for a longer period of time. The request handler would retrieve all the rows from store payment authorization table where store owner identifier is equal to settlement owner identifier, store location identifier is equal to settlement location identifier, payment authorization identifier is not blank, payment authorization sequence is not blank, authorization status is equal to ‘A’, payment authorization start date hour minute second is less than settlement begin date hour minute seconds. If one or more rows are retrieved from store payment authorization table, then the request handler would save ‘Y’ for extend begin, otherwise save ‘N’ to extend begin. If extend begin is equal to ‘Y’, then the request handler would update store payment authorization table by setting up the value of authorization status to ‘I’ where store owner identifier is equal to settlement owner identifier, store location identifier is equal to settlement location identifier, payment authorization identifier is not blank, payment authorization sequence is not blank, authorization status is equal to ‘A’, payment authorization start date hour minute second is less than settlement begin date hour minute seconds. If extend begin is equal to ‘Y’, then the request handler would deduct number of seconds in a day from settlement begin date hour minute seconds.

Then the request handler would retrieve all the rows from store payment authorization table where store owner identifier is equal to settlement owner identifier, store location identifier is equal to settlement location identifier, payment authorization identifier is not blank, payment authorization sequence is not blank, authorization status is equal to ‘I’, payment authorization start date hour minute second is greater than or equal to settlement begin date hour minute seconds and payment authorization end date hour minute second is less than or equal to settlement end date hour minute seconds. The authorization status of ‘I’ will ensure that the shopper has exited the store.

For each retrieved row from store payment authorization table, the request handler would save the values of authorized amount, used amount, refund amount and external authorization identifier as database authorized amount, database used amount, database refund amount and database external authorization identifier respectively. Then the request handler would send a request to payment card processor to capture the database used amount-database refund amount as the final amount identified by database external authorization identifier as pre-authorization identifier.

For each retrieved row from store payment authorization table, the request handler would update the store payment authorization table by setting the value of authorization status to ‘C’ where store owner identifier is equal to the value of store owner identifier from the retrieved row, store location identifier is equal to the value of store location identifier from the retrieved row, payment authorization identifier is equal to the value of payment authorization identifier from the retrieved row and payment authorization sequence is equal to the value of payment authorization sequence from the retrieved row.

### QR Code Communication & Automation

### Package Transfer Automation

The purpose of order pickup counters is to pass purchased items from secured area to unsecured area manually. The purchased items are handed over by employees to identified buyers. The buyers might have purchased the items at the store or remotely. At the stores, buyers can use order counters to place pickup orders with employees verbally or use self-serving ordering stations. Remotely or at the stores, buyers can place pickup orders using an app or web site. Whether bought online or at the store, buyers can use mobile wallet. At any event, stores would receive pickup orders at the order preparation stations such as restaurant kitchen, pharmacy prescription filling area, grocery stores, medical supply stores, office supply stores and the like and prepare the orders. Once an order is prepared and packaged, the pickup order will be moved to order pickup counters where it will be stored until the buyer is ready to pick up. The employee managing the pickup counter will announce the order number or buyer name when the order is ready. In case of pickup orders placed remotely or for orders placed for later pickup, the buyer may also receive a notification to their mobile devices when the order is ready. Upon receipt of order ready notification, the buyers would go to the pickup counters and wait in line to present an identification to the employee managing the pickup counter and receive the order over the counter. For security reasons, the pickup counters are managed by employees. To save cost, stores have started using pickup racks in unprotected areas instead of pickup counters connecting protected and unprotected areas. Since pickup racks are placed in unprotected areas and are not guarded except by video cameras, pickup racks are not as safe as pickup counters. Moreover, the stores rely on the honesty of persons picking up the orders from pickup racks and or recorded video. Since the unprotected pickup racks are placed inside the stores, the buyers cannot pickup the orders at the curbside or from drive-thru lane.

Pickup orders placed remotely can also be for drive-thru pickup. To provide faster pickup, stores are dedicating drive-thru lanes for remote orders. But unfortunately, buyers whose order is ready for pickup must wait behind buyers whose order is not ready. Also, the orders placed in advance may not be freshly prepared.

To reduce the employee cost and reduce wait time for buyers, stores are using electronic locker hubs where employees would leave the orders as soon as they are ready whether the buyers are ready to pickup or not. Buyers would stand in line to reach the central control unit of the hub to enter a code and pick up the package. Even though locker hubs reduced employee cost, still the use of lockers is not efficient, packages may stay inside the locker for long time because of uncertainty when the packages will be picked up. Moreover, electronic locker hubs cannot be used for drive-thru pickup.

To better use electronic locker and to reduce the employee cost further and to reduce wait time for buyers considerably, stores are using stand alone and stackable electronic lockers such as MySingleLink lockers where buyers at the arrival of store location can notify the store that the buyer is ready to pickup an order, just by scanning a QR Code placed at the store inside, curbside, drive-thru and parking lot. When the order is ready for pickup, the buyers will be notified through mobile phone and or through display monitors. Since, only buyers who have been notified that their orders are ready for pick up can by pass others and go to the lockers whether the lockers are placed in store, at the curbside or at the drive-thru lane, the wait time is reduced considerably. This just in time electronic lockers enabled stores to handle more orders per locker because orders will be loaded into the electronic lockers only when buyers are ready to pick up. This just in time electronic lockers also enabled buyers to receive freshly prepared and packaged orders because orders will be prepared and packaged only when buyers are ready to pick up. Since the electronic lockers can be placed at the curbside and at the drive-thru, at the time of closing, stores can leave the orders that are not picked up during normal open hours. This enabled the stores to reduce labor cost considerably.

Unfortunately, electronic lockers such as MySingleLink lockers may not solve all the problems faced by stores handling pickup orders. The employees must constantly monitor the availability of lockers, select an available locker and enter order information to load pickup orders. So, adding a package transporter which can scan an order receipt attached to a pickup order and to move the pickup order to an intermediary bin and then to pick up locker when the recipients are read to pick up would be a desirable feature especially for locker stations that can handle orders from multiple stores such as airport and food court order pickup lockers. Also, locker stations without a package transporter, robots and autonomous vehicles may not be able to load the pickup orders into electronic lockers. Also, when the number of pickup orders waiting to be loaded into electronic lockers exceed the number of electronic lockers, then the employees, robots and autonomous vehicles must wait for an electronic locker to be available. Also, pickup orders can be loaded into lockers only during open hours. This might not be a problem for stores where the number of pickup orders is low in volume and order pickup is allowed only during open hours such as restaurants but will be a major problem for stores where the number of pickup orders are high in volume and 24/7 order pick up is desirable such as pharmacies, convenient stores, grocery stores and the like. So, using an intermediary bin holder in addition to moving packages directly into order pickup lockers will solve the problems when the number of pickup orders are high in volume and when 24/7 pickup service is desirable.

The Package Transfer Automation based on QR Code Communication & Automation can handle packages automatically and can receive and deposit packages from and to autonomous vehicles and robots. Package transfer automation can include a package transfer machine which can be a package direct transfer machine or a package intermediary transfer machine. Package intermediary transfer machine can handle packages at high volume with a very few electronic lockers and also provide 24/7 pickup service.

The electronic lockers provided for order pick up is also referred to as outgoing package bins and vice versa.

The object of this invention is to provide a method for employees, robots and autonomous vehicles to leave pickup orders in a package incoming hole in a package direct transfer machine or in a package intermediary transfer machine for an automated transfer of pickup orders from package incoming hole to package outgoing bin with or without a package intermediary bin.

The object of this invention is to provide a method for employees, robots and autonomous vehicles just to leave pickup orders in a package incoming bin of a package intermediary transfer machine for an automated transfer of pickup orders from package incoming bin to package outgoing bin through an intermediary bin.

The object of this invention is also to provide an endless belt where pickup orders can be left and pickup orders can be moved from endless belt to package incoming bin whenever package incoming bin is available.

The object of this invention is to provide a method for package direct transfer machine and for package intermediary transfer machine to scan the receipt of incoming packages and to validate the packages with an external or internal order processor.

The object of this invention is to design and build package direct transfer machine with automated two-directional package transporters and robots to move package transporter loaded with incoming packages from incoming package holes to outgoing package bins.

The object of this invention is to design and build package direct transfer machine with automated two-directional package transporters and robots that can carry packages in horizontal direction (x-direction) and in vertical direction (y-direction).

The object of this invention is to design and build package intermediary transfer machine with automated three-directional package transporters and robots to move package transporter loaded with incoming packages from incoming package bins to intermediary package bins and from intermediary package bins to package outgoing bins.

The object of this invention is to design and build package intermediary transfer machine with automated three-directional package transporters and robots that can carry packages in horizontal direction (x-direction), in vertical direction (y-direction) and in front to back (z-direction). The z-direction is 90° (perpendicular) to the x-direction and y-direction.

The object of this invention is to provide a means for shoppers to have access to electronic lockers to pick up goods securely.

The object of this invention is to provide a means for operators to place electronic lockers accessible from indoors, curbside, drive-thru lanes and parking lots.

The object of this invention is to provide a means for authorized incoming package depositors such as operator clients, employee clients, robots, autonomous vehicles, and any employees of any entities that participate in order management system that can be interfaced with the intermediary agent to deposit incoming packages.

The object of this invention is to provide a means for delivery robots and autonomous vehicles to load incoming bins.

The object of this invention is to provide a means for delivery robots and autonomous vehicles to transfer packages to external boxes and lockers.

The object of this invention is to provide the technology at an affordable price and be implemented quickly.

The object of this invention is to provide the technology for package direct transfer machine and package intermediary transfer machine to be portable and easy to install.

The object of this invention is to deliver a method that is easy to use without any special training.

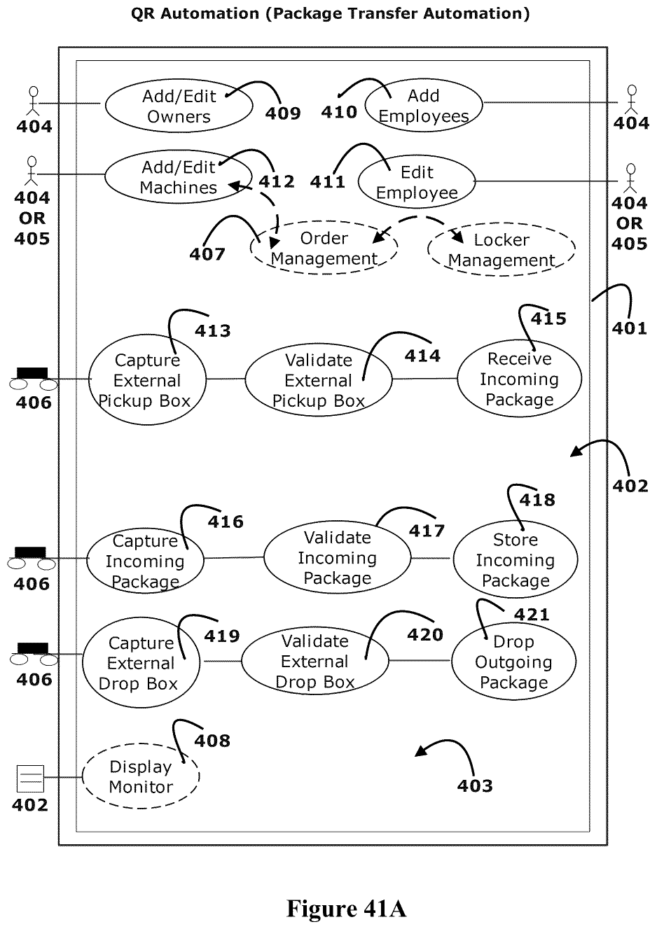

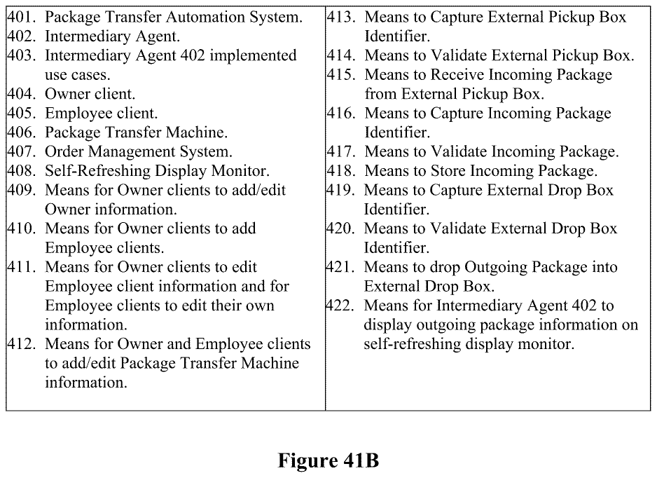

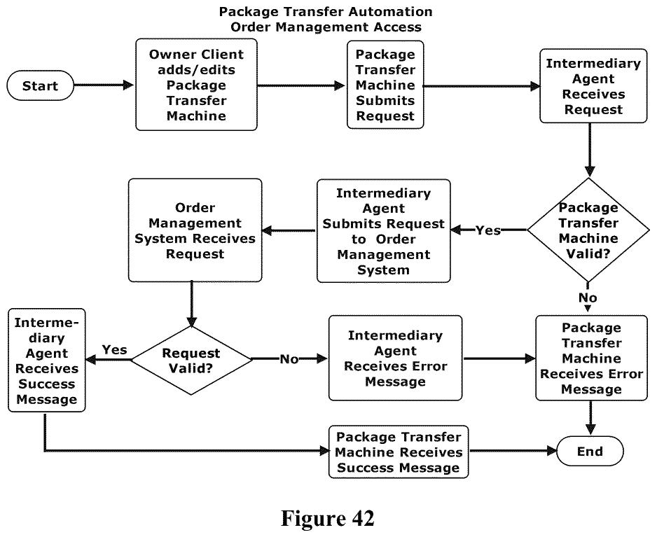

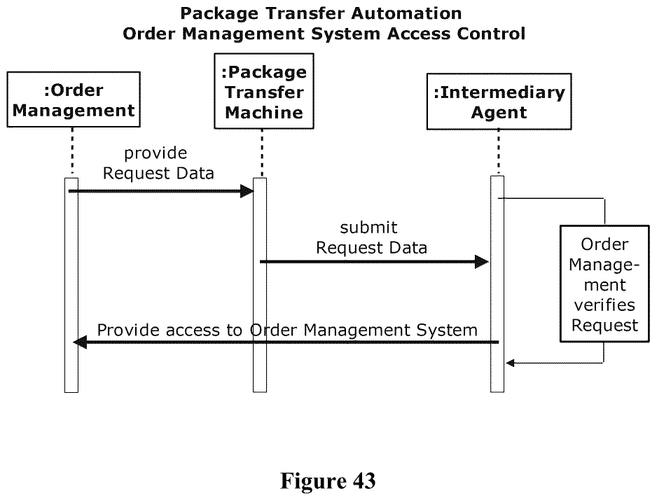

Referring now to the figures, and to FIG. 41A in particular, the QR Automation related to Package Transfer Automation system (401) of the present invention is shown to generally comprise a plurality of intermediary agent (402) implemented use cases (403). For simplicity, QR Automation related to Package Transfer Automation is referred to as Package Transfer Automation. In particular, the intermediary agent (402) provides a means (409) for owner client (404) to add or edit owner client (404) information. Owner clients are also referred as store clients (404).

Additionally, intermediary agent (402) provides a means (410) for operator clients (404) to add employee clients (405) information.

Additionally, intermediary agent (402) provides a means (411) for operator clients (404) to edit employee clients (405) information and employee clients (405) to edit their own information.

Additionally, intermediary agent (402) provides a means (412) for operator clients (404) and employee clients (405) to add and edit package transfer machines (406).

Additionally, intermediary agent (402) provides a means (407) for package transfer machines (406) to communicate with order and locker management (407) systems.

Additionally, intermediary agent (402) provides a means to display information on a display monitor (408).

Additionally, intermediary agent (402) provides a means (413) for package transfer machines (406) to capture external pickup box identifiers. External pickup box may be standalone boxes or installed on robots and autonomous vehicles.

Additionally, intermediary agent (402) provides a means (414) for package transfer machines (406) to validate external pickup box identifiers.

Additionally, intermediary agent (402) provides a means (415) to receive incoming packages from external pickup box.

Additionally, intermediary agent (402) provides a means (416) for package transfer machines (406) to capture incoming package identifiers.

Additionally, intermediary agent (402) provides a means (417) for package transfer machines (406) to validate incoming package identifiers.

Additionally, intermediary agent (402) provides a means (418) for package transfer machines (406) to store incoming packages in package outgoing bins or in package intermediary bins.

Additionally, intermediary agent (402) provides a means (419) for package transfer machines (406) to capture external drop box identifiers. External drop box may be standalone boxes or installed on robots and autonomous vehicles.

Additionally, intermediary agent (402) provides a means (420) for package transfer machines (406) to validate external drop box identifiers.

Additionally, intermediary agent (402) provides a means (421) to drop outgoing packages to external drop box.

Package transfer automation can be used by merchants to build new or convert existing brick and mortar stores into pickup counter less stores for customers to pick up the packages 24 hours a day and 7 days a week (24/7) from secured electronic lockers placed in store, curbside and drive-thru lanes and here is how it works:

Package transfer automation can eliminate pick up counters and can eliminate or reduce the functions of employees who are responsible in handing out packages to customers.

Package transfer automation can use a database such as package transfer database with various tables such as machine owner table, machine employee table, machine table, machine aisle table, machine bin table, machine bin content table, machine bin locker sync table, machine package queue table and machine package transporter table as shown in a class diagram in FIG. 44. The valid values for MACHINE TYPE in machine table are ‘D’ (Direct Transfer) and ‘I’ (Intermediary Transfer). The valid values for TRANSPORTER_TYPE in machine table are ‘R’ (Rail) and ‘B’ (Robot). The valid values for MAX_DEPTH_POSITION in machine table are 1 and 2. In some embodiments, it can be even more than 2. The valid values for DEPTH_POSITION_ORIGIN in machine table are ‘R’ (Front) and ‘B’ (Back). The valid values for HORIZONTAL_POSITION_ORIGIN in machine table are ‘L’ (Left) and ‘R’ (Right). The valid values for VERTICAL_POSITION_ORIGIN in machine table are ‘T’ (Top) and ‘B’ (Bottom). The valid values for BIN_TYPE in machine bin table are ‘N’ (Incoming), ‘I’ (Intermediary) and ‘O’ (Outgoing).

Primary key fields in the package transfer database tables are marked as ‘(PK)’ and indexed fields in the restaurant database tables are marked as ‘(I)’. In addition to package transfer database, QR Code based communication system can also use a database such as intermediary agent customer database with various tables such as customer table and customer payment table, as shown in a class diagram in FIG. 6.

Before continuing, however, it is noted that while the databases shown in class diagrams in FIGS. 6 and 44 are exemplary of the preferred embodiments of the present invention, it is in no manner meant to be all encompassing or otherwise limiting of the wide range of implementations as are possible.

Those of ordinary skill in the art will readily recognize the SQL statements shown in describing the various embodiments to insert, update or retrieve rows from the tables in the databases as shown in class diagrams in FIGS. 6 and 44 can be only examples, and the actual SQL statements can vary depending on the existing and future database management servers used by the intermediary agent.

Intermediary agent (402), operator clients (404), employee clients (405), package transfer machine (406), order and locker management (407) and display monitor (408) are also referred as intermediary agent, operator clients, employee clients, package transfer machine, order and locker management and display monitor respectively.

### General Information:

Package transfer machines can be a package direct transfer machine where the packages will be moved from package incoming bin to package outgoing bin or package intermediary transfer machine where packages will be moved from package incoming bin to package intermediary bin and from package intermediary bin to package outgoing bin.

Any authorized incoming package depositor could use the package transfer machine to move incoming packages to outgoing bins.

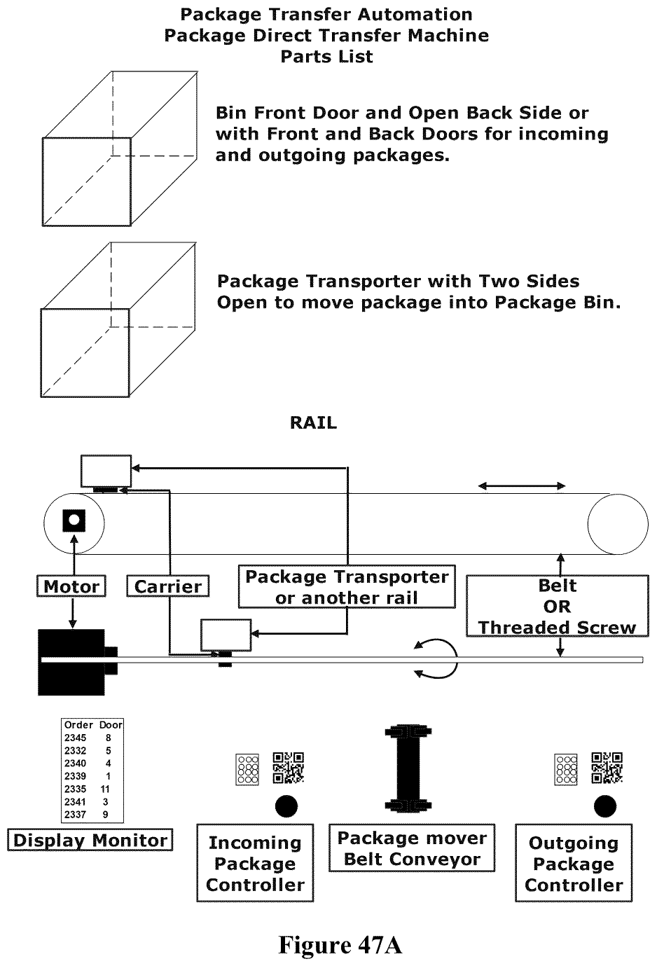

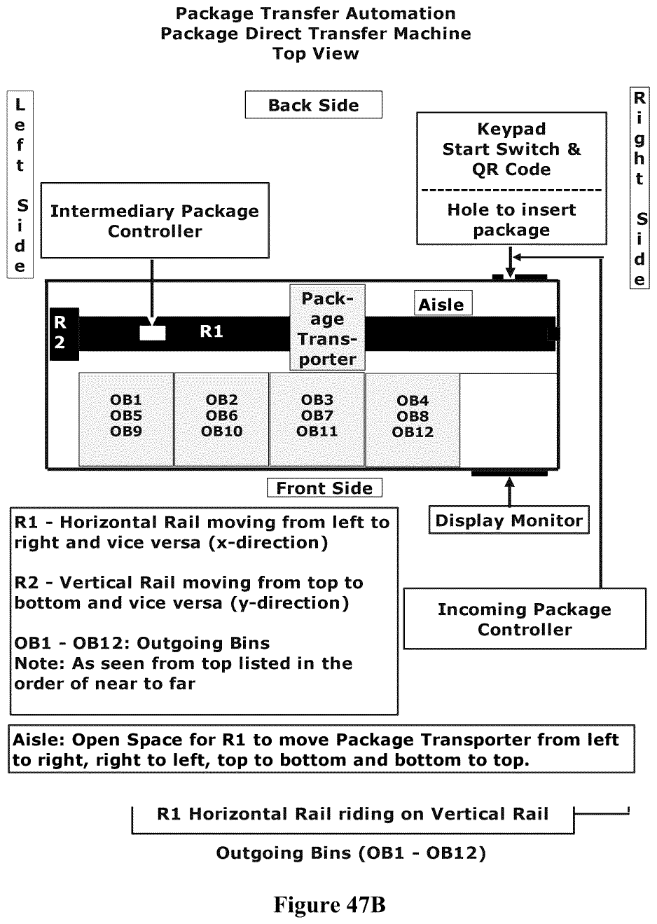

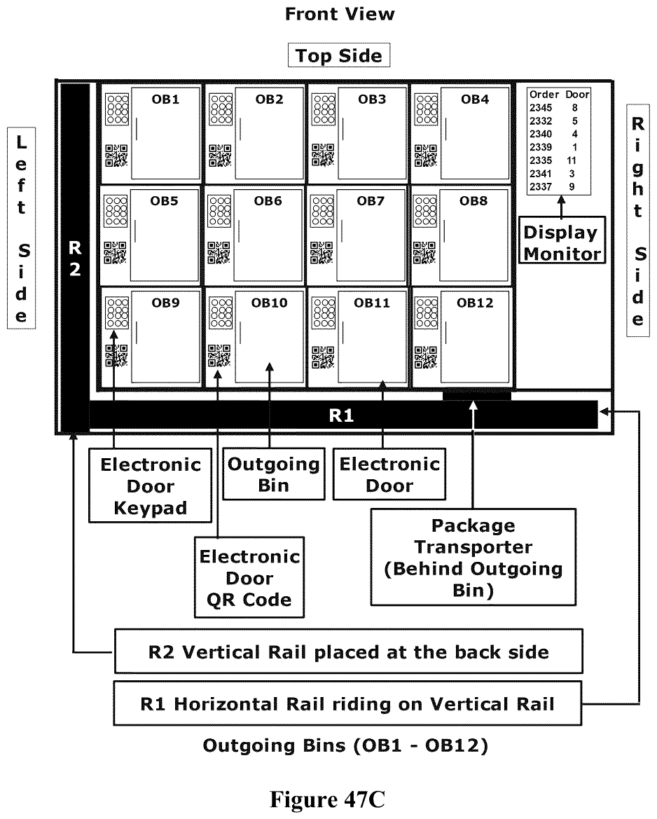

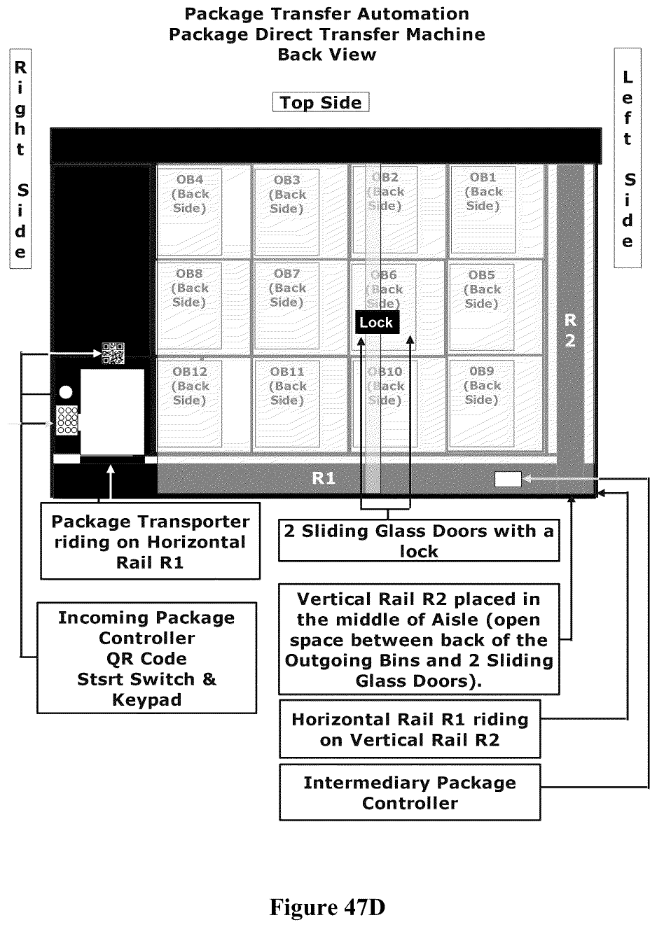

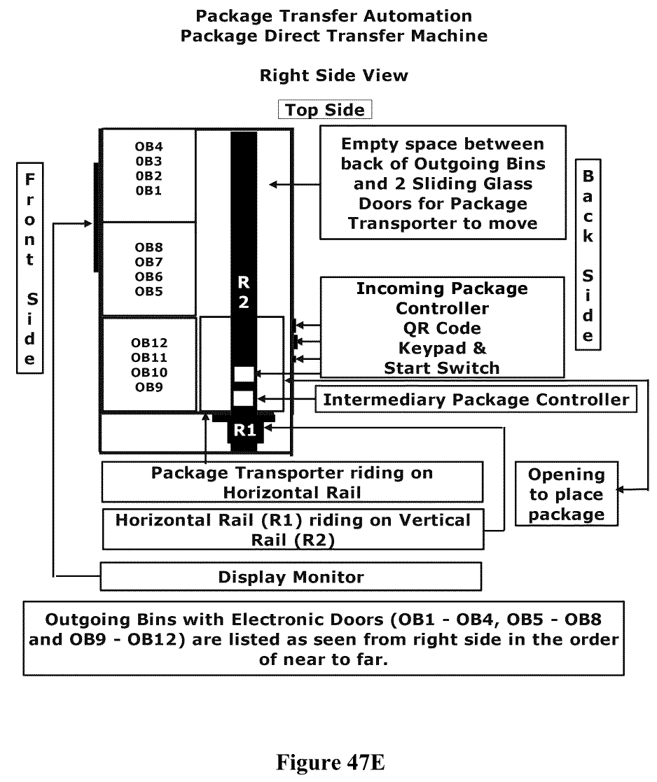

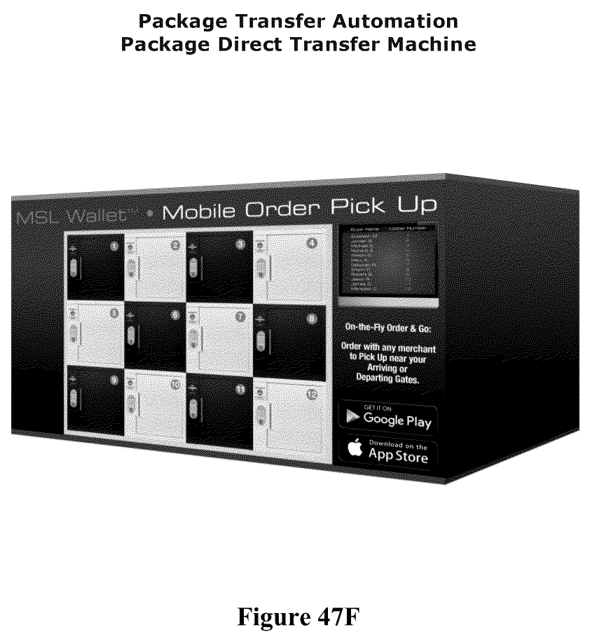

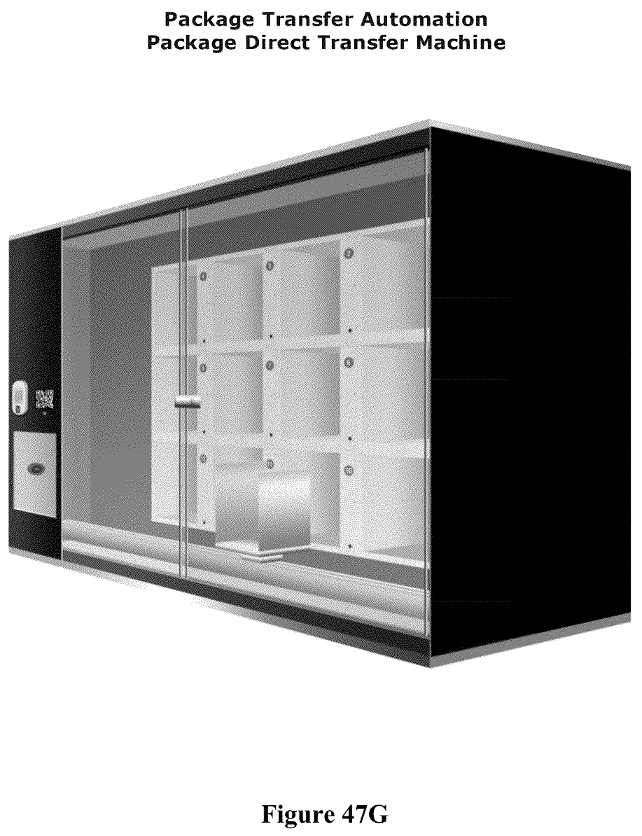

If the package transfer machine is a package direct transfer machine, then incoming package depositors can leave the incoming packages in the package transporter through the hole provided to leave the incoming packages in the package direct transfer machine as shown in FIG. 47D. Even though the hole provided to leave the incoming packages are shown in the back side of the package direct transfer machine, it can be located anywhere accessible to incoming package depositors.

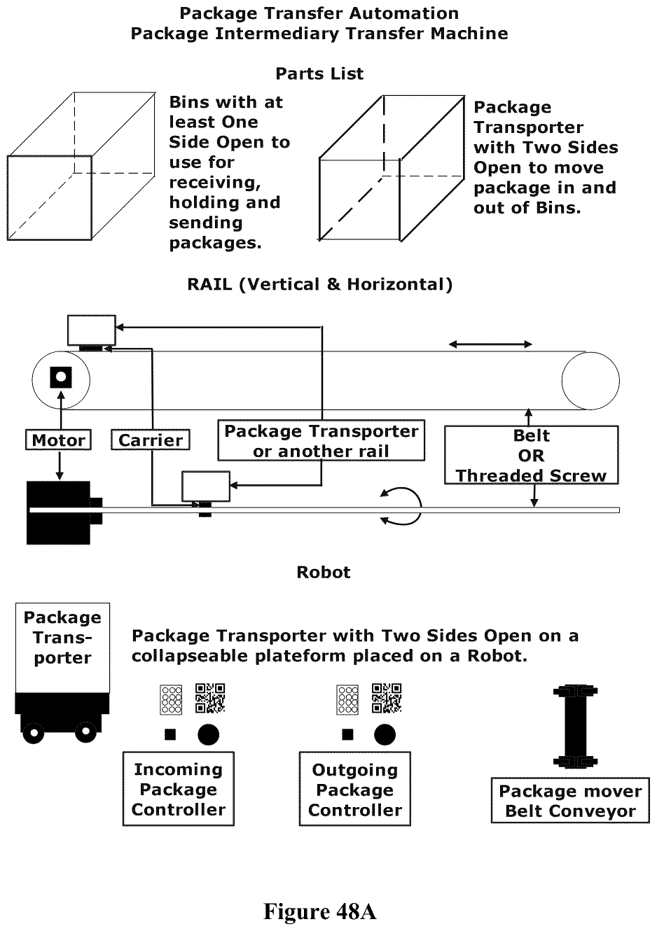

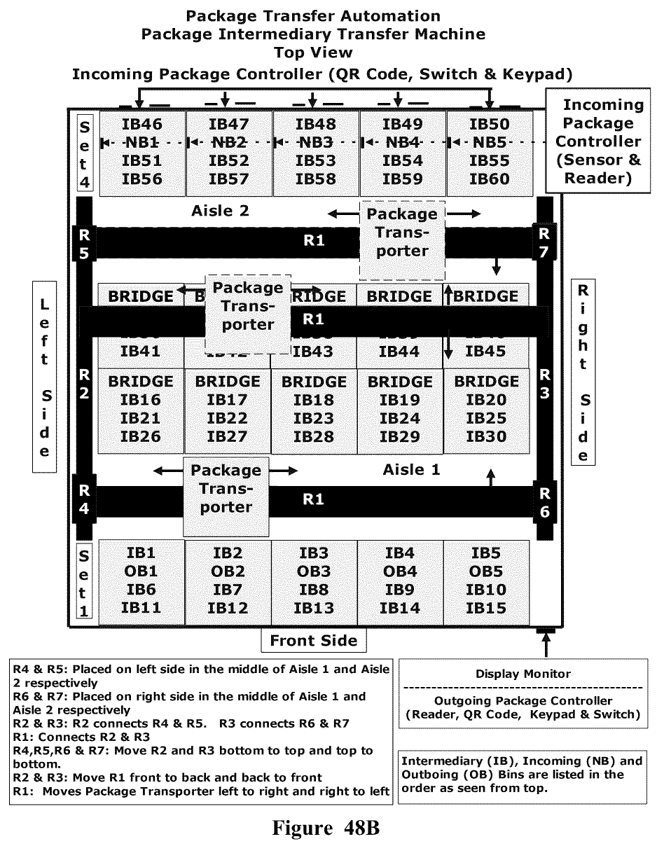

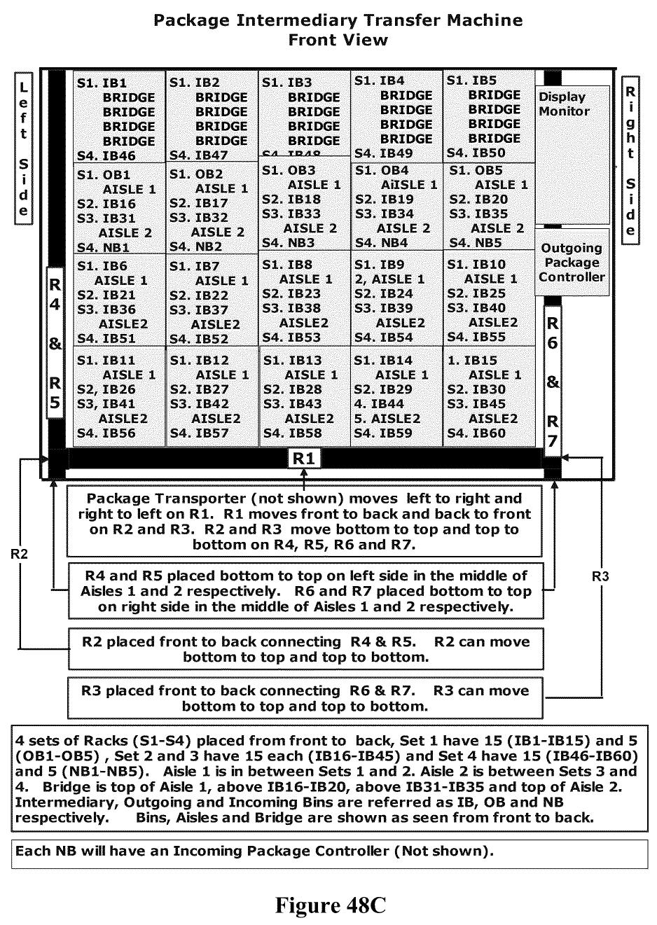

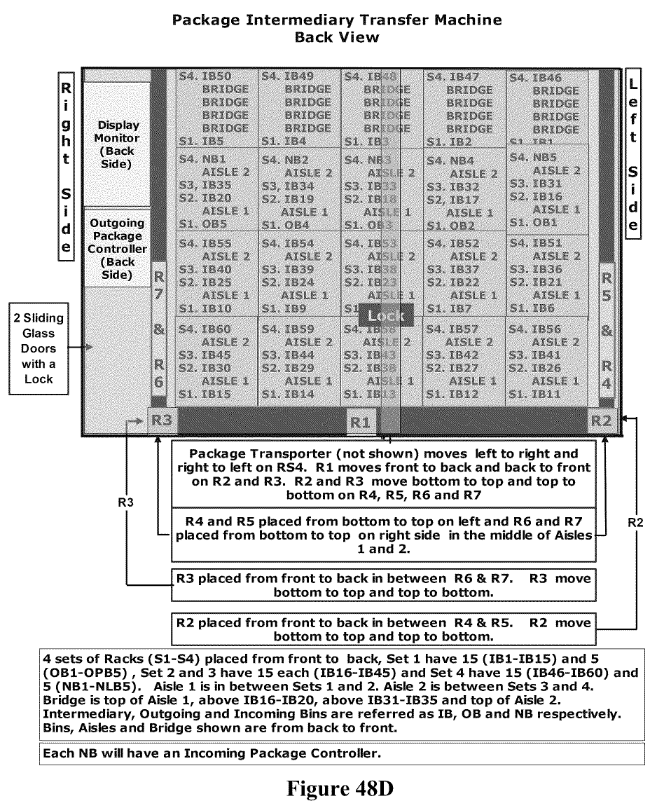

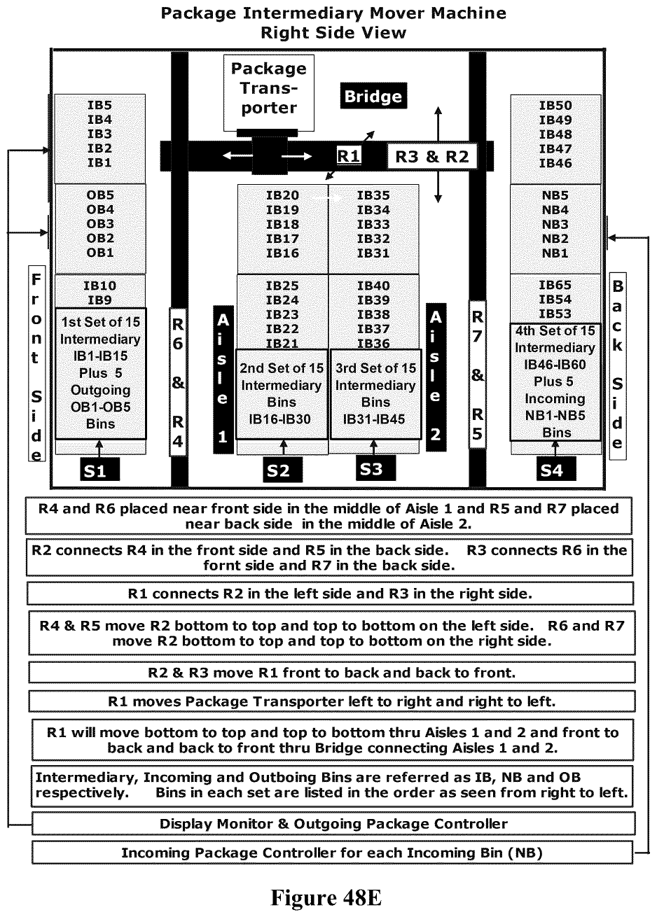

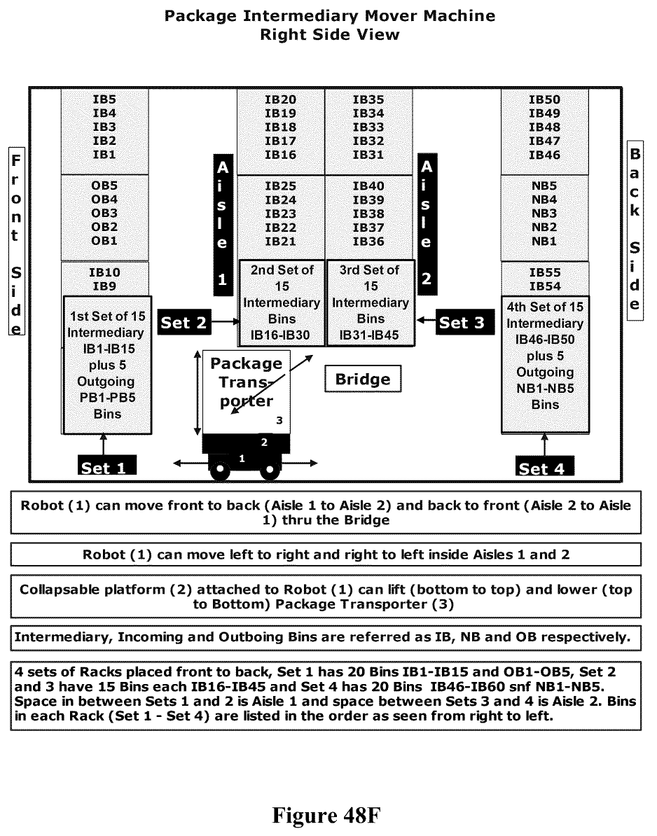

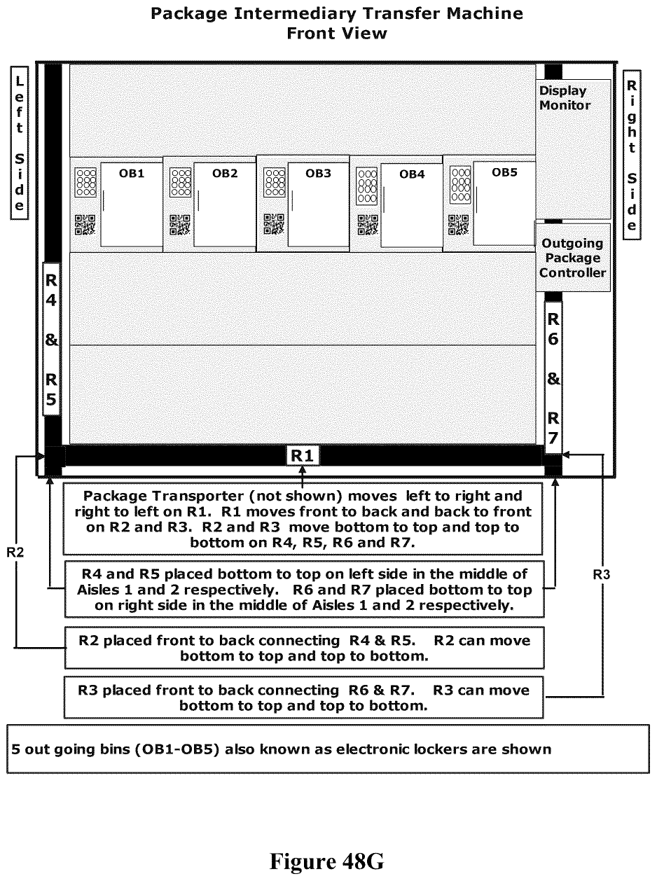

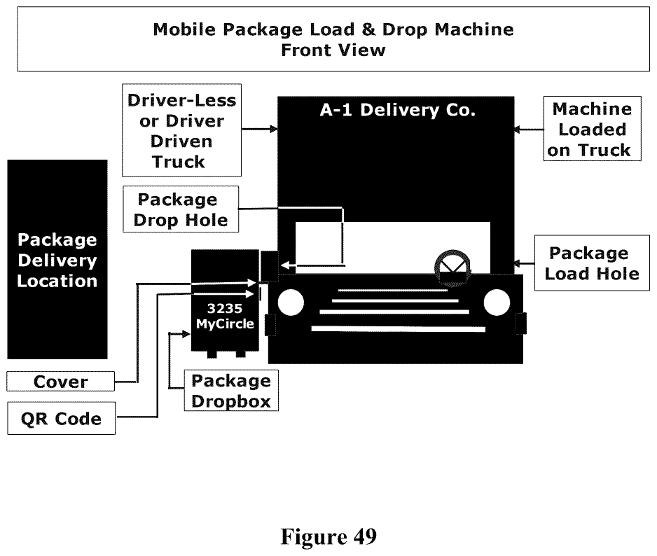

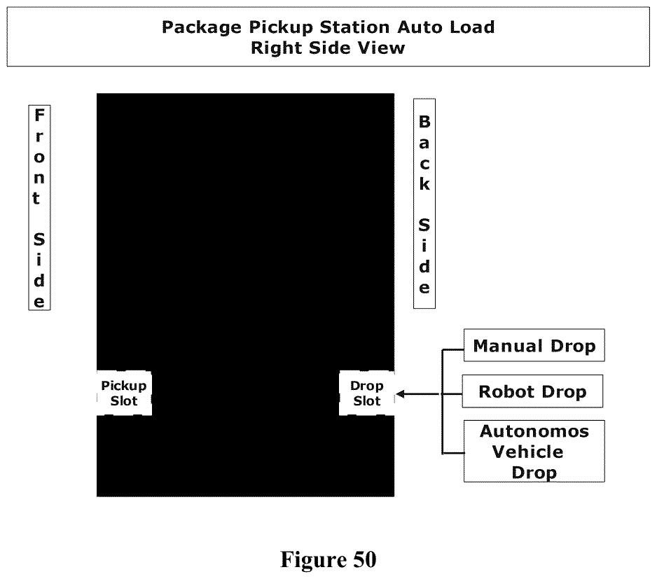

If the package transfer machine is a package intermediary transfer machine, then incoming package depositors can leave the incoming packages in one of the incoming bins (NB1-NB5) as shown in FIG. 48B. Even though the incoming bins to leave the incoming packages are shown in the back side of the package intermediary transfer machine, it can be located anywhere accessible to incoming package depositors.

If the package transfer machine is a package direct transfer machine, then the incoming package controller would be attached to the hole provided to receive incoming packages, as shown in FIG. 47D.

If the package transfer machine is a package intermediary transfer machine, then incoming package controller would be attached to each incoming bin (NB1-NB5) where incoming packages will be left by incoming package depositors as shown in FIG. 48B.

The QR Code, keypad and start switch included in the incoming package controller will be easily accessible to authorized incoming package depositors whereas the reader, QR Code, keypad and start switch included in the outgoing package controller will be easily accessible to outgoing package recipients. The outgoing package controller will not be included in the package direct transfer machines.

Once incoming packages are moved from incoming bin to intermediary bin, the incoming packages will be treated as outgoing packages. When the package intermediary transfer machine is used, outgoing packages will be moved to outgoing package bins only when package recipients are ready to pick up the outgoing packages. The package intermediary transfer machines would provide an outgoing package controller for package recipients to input package identifier to indicate that the package recipient of a specific outgoing package is ready to pick up.

In a package transfer machine, the package outgoing bin would be an electronic locker or an outgoing bin with an electronic door as shown in FIG. 47C for package direct transfer machine and as shown in FIG. 48G for package intermediary transfer machine. The electronic locker or the outgoing bin with an electronic door would have a spring-loaded flap that can be pushed open when the outgoing packages are pushed into the electronic locker or the outgoing bin from the package transporter. This spring-loaded flap will prevent the package recipients from reaching inside the electronic locker or the outgoing bin beyond the spring-loaded flap. The electronic locker may also be referred to as outgoing bin. The outgoing bin with an electronic door may also be referred to as electronic locker.

To accept the incoming packages from depositors, to move packages and to let the package recipients to pick up outgoing packages, the package transfer machines use incoming package controller, intermediary package controller and outgoing package controller respectively. The incoming package controller will have a reader to automatically read incoming package identifier, a keypad where the package depositors can enter package identifier, a QR Code where package depositors can scan and enter package identifier and a start switch where the package depositors can activate the incoming package controller. The intermediary package controller will have wired and/or wireless connections to direct the rails, robots, package movers inside package transports or robots and package movers inside intermediary bins. The outgoing package controller will have a reader to automatically read package identifier, a keypad where the package recipients can enter package identifier, a QR Code where package recipients can scan and enter package identifier and a start switch where the package recipients can activate the outgoing package controller.

Incoming package controller, intermediary package controller and outgoing package controller are embedded with programmable firmware where the programs can be downloaded into the firmware. These programs control the actions of controllers to execute specific tasks when needed. For example, the firmware in incoming package controller will be programmed to handle incoming packages, the firmware in outgoing package controller will be programmed to handle outgoing packages and the firmware in intermediary package controller will be programmed to handle movement of packages from incoming package bins to intermediary package bins and from intermediary package bins to electronic lockers. For the intermediary package controller to move packages from one bin to another bin, the intermediary package controller need to know the layout details of individual bins in the package transfer machine. To get the bin layout details from the intermediary agent, a download switch will be added to the intermediary package controller. When the download switch is activated, the firmware in the intermediary package controller would download bin layout details from intermediary agent into the intermediary package controller firmware's database. The intermediary package controller firmware's database may have tables like machine table, machine aisle table, machine bin table and machine package transporter table as they are in package transfer database and as shown in a class diagram in FIG. 44.

Incoming package controller, intermediary package controller and outgoing package controller are also embedded with communication hardware and software to communicate with the intermediary agent.

Intermediary package controller may be programmed to communicate with the intermediary agent, periodically, to move packages that are in incoming package queue and outgoing package queue in pending status where the status in the machine package queue table will be indicated as ‘P’. The intermediary package controller would communicate with the intermediary agent to process incoming package requests in the incoming package queue in pending status, when a request is received from the incoming package controller. The intermediary package controller would communicate with the intermediary agent to process outgoing package request in the outgoing package queue in pending status when a request is received from the outgoing package controller. In addition to communicating with the intermediary agent by the intermediary controller when a request is received from incoming package controller or outgoing package controller, the intermediary package controller may also be programmed to communicate with the intermediary agent periodically as per the schedule stored in the firmware in the intermediary package controller.

In order for the incoming package controller to send the request to process incoming package requests in the incoming package queue, incoming package controller will be programmed to communicate with the intermediary package controller when an incoming package identifier is automatically received or when the depositors activate the switch connected to the incoming package controller.

In order, for the outgoing package controller to send the request to process outgoing requests in the outgoing package queue, outgoing package controller will be programmed to communicate with the intermediary package controller when an outgoing package identifier is received or when the package recipients activate the switch connected to the outgoing package controller.

The incoming package controller will be mounted to incoming package hole or incoming package bins depending on the type of package transfer machine, the outgoing package controller will be mounted such that it is accessible to package recipients picking up the packages and the intermediary package controller can be mounted anywhere.

If the package transfer machine is a package direct mover, then the package will be directly deposited into package transporter. If the package transfer machine is a package intermediary mover, then the package will be directly deposited into one of the incoming package bins.

If the package transfer machine is a package direct mover, then outgoing package controller may not be used, because the package will be transported directly from the hole provided to receive incoming packages to the electronic locker.

The package transporter and the bins would have package mover placed inside. The package mover can be any device that can move packages such as endless belt or spiral wire or rollers to push the packages outward and the like. The package transporter will have openings on both sides and the package mover inside the package transporter can move the packages in both directions. The bins will have openings on only one side and the package mover inside the bins can move the packages only in one direction. The package mover can move the packages only for a distance not exceeding the depth of the bins or the depth of the package transporter. The intermediary package controller can have wired or wireless connections with package movers inside the bins. The intermediary package controller can control the movement of package mover inside each individual bin independently. The intermediary package controller can have wired or wireless connections with package mover inside package transporter when the package transporter is mounted on rails. The intermediary package controller can have wireless connections with package mover inside package transporter when the package transporter is mounted on robots. The intermediary package controller would control the movement of package transporter, the movement of package mover placed inside the package transporter and the movement of package mover placed inside the bins. The intermediary package controller can have wired or wireless connections with package transporter when the package transporter is mounted on rails. The intermediary package controller can have wireless connections with package transporter when the package transporter is mounted on robots. The intermediary package controller will give directions to rails when the package transporter is mounted on rails. The intermediary package controller will give directions to robots when the package transporter is mounted on robots.

If the package transfer machine is a package direct mover, then the intermediary package controller will direct the rails R1 and R2 to move the package transporter horizontally (x-direction) and vertically (y-direction) as shown in FIGS. 47B, 47C, 47D and 47E.

If the package transfer machine is a package intermediary mover fitted with rails, then the intermediary package controller will direct the rails R1, R2, R3, R4, R5, R6 and R7 to move the package transporter horizontally (x-direction), vertically (y-direction) and perpendicular to horizontal and vertical directions (z-direction) as shown in FIGS. 48B, 48C, 48D, 48E and 48G.

If the package transfer machine is a package intermediary mover fitted with robot, then the intermediary package controller will direct the robot to move the package transporter horizontally (x-direction), vertically (y-direction) and perpendicular to horizontal and vertical directions (z-direction) as shown in FIG. 48F. The package transporter will be mounted on a collapsible platform which in turn is mounted on a robot.

At any event the intermediary package controller can control the movement of package transporter, the package mover inside the package transporter and the package mover inside the bins.

### Incoming Packages:

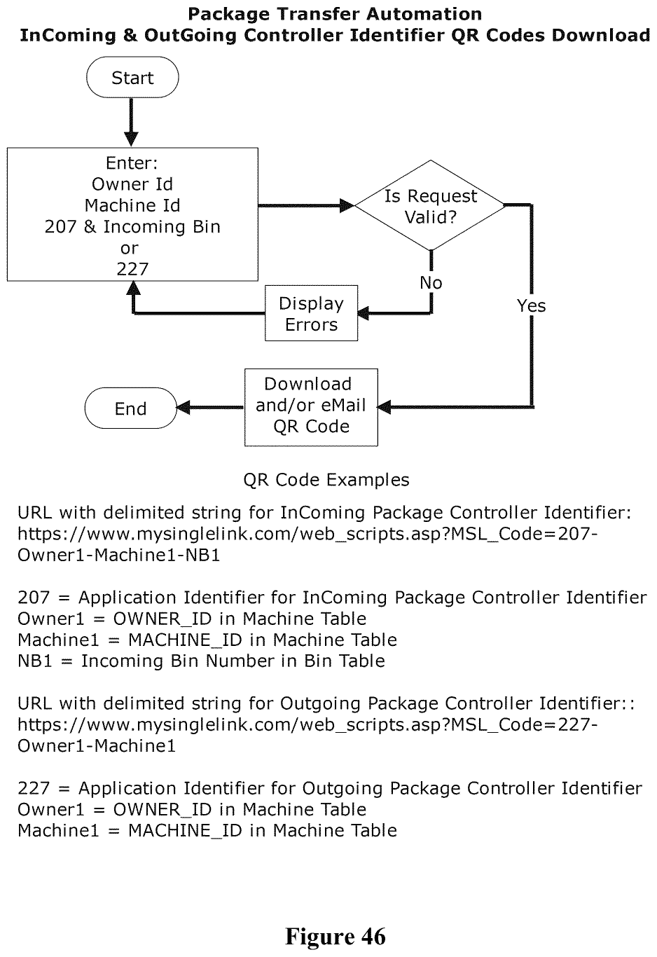

Package transfer machine would use incoming package controller to handle incoming packages. The purpose of incoming package controller is to accept incoming package identifier, request the intermediary agent to add the incoming package identifier to an incoming package queue and to request intermediary package controller to start the process of pending incoming package identifiers waiting in the incoming package queue to be processed. The incoming package controller will have interconnected hardware such as sensor, reader, keypad, start switch and a firmware programmed to handle incoming packages. The incoming package controller would also display a QR Code. They can be mounted in a single enclosure or in multiple enclosures. Each incoming package controller will be associated with an incoming package controller identifier which would be an application identifier, owner identifier, machine identifier and an incoming bin number. If the package transfer machine is a package direct transfer machine, the incoming bin number could be blank. As an example, the application identifier for an incoming package controller identifier could be 207. The content of the QR Code would include a web page associated with the intermediary agent and incoming package controller identifier as shown in FIG. 46. The content of the QR Code can be downloaded and displayed on the incoming package bin. The incoming package depositors will have the option to drop the package in the incoming package bin or to enter a package identifier in the keypad or to scan the QR Code, enter a package identifier and activate the start switch.

When an incoming package is deposited, the firmware would receive a signal from the sensor that a package is deposited, and the firmware would instruct the reader to electronically read the incoming package identifier attached to the incoming package. The reader could be such as a QR Code reader, bar code reader, RFID reader, NEC, and the like. When an incoming package identifier is electronically captured, the firmware would communicate with the intermediary agent by sending the incoming package identifier and the unique incoming package controller identifier. When an incoming package identifier is entered in the keypad, the firmware would capture the input from the keypad and communicate with the intermediary agent by sending the incoming package identifier and the unique incoming package controller identifier. When an incoming package identifier is entered in a web page accessed by scanning the QR Code, the web page would capture the input from the web page as incoming package identifier and communicate with the intermediary agent by sending incoming package identifier and the unique incoming package controller identifier. When the start switch is activated, the incoming package controller would communicate with the intermediary package controller to indicate that one or more incoming packages may be in the incoming package queue for the intermediary agent to process. The incoming package identifier can be any identifier to track the package and also known to the package recipient. A unique identifier associated with a package such as order number, tracking number and the like can be an incoming package identifier.

Upon receiving the incoming package controller identifier and incoming package identifier, the intermediary agent would verify the data and if the data is valid, then the intermediary agent would add the package identifier to an incoming package queue. The intermediary agent would verify package identifier with an order management system.

When the incoming package controller sends the incoming package controller identifier and the package identifier information to the intermediary agent and if the data is valid as determined by the intermediary agent, the incoming package controller would also send a request to the intermediary package controller to process incoming packages waiting to be processed in the incoming package queue.

The incoming package depositors can also activate the start switch in the incoming package controller, so that the incoming package controller can send a request to the intermediary package controller to process incoming package waiting to be moved in the package transporter or in an incoming package bin. Before sending a request to the intermediary package controller, the incoming package controller would confirm that a package is waiting to be moved in the incoming package bin using the sensor connected to the incoming package controller.

The incoming package controller can send the request to process the incoming packages waiting to be moved in the package transporter or in an incoming package bin, only if a communication channel to communicate with intermediary package controller is available.

The intermediary package controller periodically and/or when a request is received from incoming package controller would request the intermediary agent to process incoming packages waiting to be processed in the incoming package queue.

If there is a package identifier in the incoming package queue waiting to be processed, then the package identifier would be the package identifier of a package waiting to be moved in the package transporter or in an incoming package bin.

### Outgoing Packages:

Package transfer machine would use outgoing package controller to handle outgoing packages. In order for package recipients to pick up packages, the outgoing packages must be moved from intermediary package bins to electronic lockers. The outgoing packages will be moved from intermediary package bins to electronic lockers only when the package recipients are ready to pick up the packages. The purpose of outgoing package controller is to know when the package recipients are ready to pick up the outgoing packages, request the intermediary agent to add the outgoing package identifier to an outgoing package queue and to request intermediary package controller to start the process of pending outgoing package identifiers waiting in the outgoing package queue to be processed. If the package transfer machine is a package direct transfer machine, then the outgoing package controller may not be used, because the outgoing packages will be directly transported to the outgoing package bin from incoming package bin. The outgoing package controller will have interconnected hardware such as reader, keypad, start switch and a firmware programmed to handle outgoing packages. The outgoing package controller would also display a QR Code. They can be mounted in a single enclosure or in multiple enclosures. Each outgoing package controller will be associated with an outgoing package controller identifier which would be an application identifier, owner identifier and machine identifier. As an example, the application identifier for an outgoing package controller identifier could be 227. The content of the QR Code would include a web page associated with the intermediary agent and outgoing package controller identifier as shown in FIG. 46. The content of the QR Code can be downloaded and displayed accessible to outgoing package recipients. The outgoing package recipients will have the option to present a QR Code with the outgoing package identifier to the reader installed as part of outgoing package controller or to enter a package identifier in the keypad or to scan the QR Code, enter a package identifier and activate the start switch.

When an outgoing package identifier is presented, the firmware would instruct the reader to electronically read the presented outgoing package identifier. The reader could be such as a QR Code reader, bar code reader, RFID reader, NEC, and the like. When an outgoing package identifier is electronically captured, the firmware would communicate with the intermediary agent by sending the outgoing package identifier and the unique outgoing package controller identifier. When an outgoing package identifier is entered in the keypad, the firmware would capture the input from the keypad and communicate with the intermediary agent by sending the outgoing package identifier and the unique outgoing package controller identifier. When an outgoing package identifier is entered in a web page accessed by scanning the QR Code, the web page would capture the input from the web page as outgoing package identifier and communicate with the intermediary agent by sending outgoing package identifier and the unique outgoing package controller identifier. When the start switch is activated, the outgoing package controller would communicate with the intermediary package controller to indicate that one or more outgoing packages may be in the outgoing package queue for the intermediary agent to process.

Upon receiving the outgoing package controller identifier and outgoing package identifier, the intermediary agent would verify the data and if the data is valid, then the intermediary agent would add the package identifier to an outgoing package queue. The intermediary agent would verify that the outgoing package is stored in one of the intermediary package bins.

When the outgoing package controller sends the outgoing package controller identifier and the package identifier information to the intermediary agent and if the data is valid as determined by the intermediary agent, the outgoing package controller would also send a request to the intermediary package controller to process outgoing packages waiting to be processed in the outgoing package queue.

The outgoing package recipients can also activate the start switch in the outgoing package controller, so that the outgoing package controller can send a request to the intermediary package controller to process outgoing package waiting to be moved in intermediary package bins.

The outgoing package controller can send the request to process the outgoing packages waiting to be moved in the intermediary package bins, only if a communication channel to communicate with intermediary package controller is available.

The intermediary package controller periodically and/or when a request is received from outgoing package controller would request the intermediary agent to process outgoing packages waiting to be processed in the outgoing package queue.

### Intermediary Package Controller:

Periodically and/or when a request is received from incoming package controller, the intermediary package controller would communicate with the intermediary agent to get the details of incoming package to be moved. Periodically and/or when a request is received from outgoing package controller, the intermediary package controller would communicate with the intermediary agent to get the details of outgoing package to be moved. Each intermediary package controller will be associated with an intermediary package controller identifier which would be an application identifier, owner identifier and machine identifier. As an example, the application identifier for an intermediary package controller identifier could be 247. When communicating with intermediary agent, the intermediary package controller would always include the intermediary package controller identifier and a request type. The request type would be ‘NI’ for incoming package inquire, ‘Or’ for outgoing package inquire, ‘NU’ for incoming package update and ‘OU’ for outgoing package update.

Upon receipt of a request from intermediary package controller, the intermediary agent would retrieve the earliest active pending move from incoming package queue if the request type is incoming package inquire or earliest pending active move from outgoing package queue if the request type is outgoing package inquire. If there is an active row in the incoming package queue table for incoming package inquire request or an active row in the outgoing package queue table for outgoing package inquire request, then the intermediary agent would retrieve package identifier and the from bin number from incoming package queue table for incoming package inquire or from outgoing package queue table for outgoing package inquire, otherwise the intermediary agent would send 0 to intermediary package controller as response to indicate that there are no more pending move. If the intermediary agent retrieved an active row, then the intermediary agent would determine to-bin number based on the type of package transfer machine and based on type of the request. If the package transfer machine is package direct transfer machine and if the from bin number is blank, then the intermediary agent would pick an unoccupied outgoing package bin as to-bin number. If the package transfer machine is package intermediary transfer machine and if the from bin number is an incoming package bin, then the intermediary agent would pick an unoccupied intermediary package from-bin as to-bin number. If the package transfer machine is package intermediary transfer machine and if the from bin number is an intermediary package bin, then the intermediary agent would pick an unoccupied outgoing package bin as to-bin number. Once the package identifier, from-bin number and to-bin number are determined, the intermediary agent would respond to intermediary package controller with package identifier, from-bin number, and to-bin number.

If the response from intermediary agent for incoming package inquire or outgoing package inquire is a package identifier, from-bin, and to-bin, then the intermediary package controller would move the package from from-bin to to-bin. To move the package, the intermediary package controller would communicate with the rails if the package transporter were mounted on rails. To move the package, the intermediary package controller would communicate with the robot if the package transporter were mounted on a robot. The intermediary package controller would use information from machine table, machine aisle table, machine bin table, machine package responder table saved in a database in intermediary package controller firmware.

If the package transfer machine is package direct transfer machine and if the package transporter is mounted on a rail, then the intermediary agent would instruct rail R1 to move the package transporter horizontally and would instruct rail R2 to move the package transporter vertically as shown in FIGS. 47B, 47C, 47D and 47E. If the package transfer machine is package direct transfer machine and if the package transporter is mounted on a robot, then the intermediary agent would instruct robot to move the package transporter horizontally and vertically.

If the package transfer machine is a package intermediary transfer machine, then the package intermediary transfer machine would use bins, aisles, and a bridge. The aisles will be used to access bins by the package transporter and bridge will be used to move the package transporter from aisle to aisle. The package transporter will move in x and y directions within an aisle and will move in z-direction through a bridge.

If the package transfer machine is a package intermediary transfer machine and if the package transporter is mounted on a rail, then the intermediary package controller can instruct rails R1, R2, R3, R4, R5, R6 and R7 to move the package transporter from any bin to any bin as shown in FIGS. 48B, 48C, 48D and 48E. If the package transfer machine is package intermediary transfer machine and if the package transporter is mounted on a robot, then the intermediary package controller can instruct Robot to move the package transporter from any bin to any bin as shown in FIG. 48F.

To move packages from any bin to any bin using rails, the package transporter will ride on rail R1 where R1 is connected in between rails R2 and R3 where R2 is connected between rails R4 and R5 and R3 is connected between rails R6 and R7. To move the package transporter in x-direction, the intermediary package controller would direct the rail R1 to move package transporter which rides on R1 in x-direction. To avoid any collusion between rails and bins and any collusion between package transporter and bins, intermediary package controller would direct the rail R1 to move the package transporter in x-direction only when rail R1 is in one of the aisles. To move the package transporter in y-direction, the intermediary package controller would direct the rails R4, R5, R6 and R7 to move rails R2, R3 in y-direction. This would make rail R1 which is connected in between R2 and R3 move in y-direction. This would make package transporter riding on rail R1 to move in y-direction. To avoid any collusion between rails and bins and any collusion between package transporter and bins, intermediary package controller would direct the rails R4, R5, R6 and R7 to move rails R2, R3 in y-direction only when rail R1 is in one of the aisles. To move the package transporter in z-direction, the intermediary package controller would direct the rails R4, R5, R6 and R7 to move rails R2 and R3 in y-direction to bridge level. This would make rail R1 which is connected in between R2 and R3 move in y-direction to bridge level. Then the intermediary package controller would direct the rails R2 and R3 to move rail R1 in z-direction through the bridge to a desired aisle. This would also cause the package transporter to move to the desired aisle. Once the package transporter reaches a desired aisle, then the package controller can move the package transporter in x and y directions to reach any bin.

To move packages from any bin to any bin using robot, the package transporter will ride on collapsible ladder mounted on robot. To move the package transporter in x-direction, the intermediary package controller would direct the robot to move package transporter which rides on collapsible ladder mounted on robot in x-direction. To avoid any collusion between robot and bins and any collusion between package transporter and bins, intermediary package controller would direct the robot to move the package transporter in x-direction only when the robot is in one of the aisles. To move the package transporter in y-direction, the intermediary package controller would direct the robot to expand or fold collapsible ladder in y-direction. This would make the package transporter which is mounted on collapsible ladder move in y-direction. To avoid any collusion between rails and bins and any collusion between package transporter and bins, intermediary package controller would direct the robot to move package transporter in y-direction only when robot is in one of the aisles. To move the package transporter in z-direction, the intermediary package controller would direct the robot to move package transporter in y-direction to bridge level. Then the intermediary package controller would direct the robot to move in z-direction through the bridge to a desired aisle. This would also cause the package transporter to move to the desired aisle. Once the package transporter reaches a desired aisle, then the package controller can direct the robot to move the package transporter in x and y directions to reach any bin.

The intermediary package controller would retrieve various parameters of package transfer machine, positions of aisles, positions of bins and current position of package transporter from machine table, machine aisle table, machine bin table and machine package transporter table stored in intermediary package controller firmware. All the positions of incoming package bins, outgoing package bins, intermediary package bins, current package transporter position, layout of aisles, layout of bridge, type of package transfer machine and transport type and the like will be known to the firmware in the intermediary package controller. The home location of package transporter, if the package transfer machine is a package direct transfer machine, will also be known to the firmware in the intermediary package controller. The positions of bins would include aisle number, horizontal and vertical positions.

The intermediary package controller would determine the current position of the package transporter, the position of from-bin and the position of to-bin. The position would include the depth position, horizontal position, and vertical position. The depth position, horizontal position and vertical position origin would also be known to the firmware. So, the intermediary package controller would know the aisle number, horizontal position and vertical position of the package transporter, from-bin, and to-bin. If the position of package transporter is not same as position of from-bin, then the intermediary package controller would move the package transporter to position of from-bin. Once the package transporter is in the position of from-bin, the intermediary package controller would communicate with the package mover inside the from-bin to move the package from from-bin to package transporter. Once the package is inside the package transporter, the intermediary package controller would move the package transporter from from-bin position to to-bin position. Once the package transporter is at the to-bin position, the intermediary package controller would communicate with package mover inside the package transporter to move package from package transporter to to-bin.

Once the intermediary package controller successfully moves the packages from from-bin to to-bin, the intermediary package controller would update the information in machine package transport table in intermediary package controller firmware, so that the intermediary package controller would always know the position of the package transporter and would communicate with the intermediary agent with an update request. If the package is moved from incoming package bin, then the value for request type would be ‘NU’. If the package is moved from intermediary package bin, then the value for request type would be ‘OU’. The update request sent by intermediary package controller to intermediary agent would include intermediary package controller identifier, request type, package identifier, from-bin, and to-bin. Upon receiving an update request, the intermediary agent would validate the received data. If the value of the received data is valid, then the intermediary agent would update machine package transporter table with to-bin, update the status in machine package queue table to ‘I’ and update machine bin content table with package identifier. After sending the update request to the intermediary agent, the intermediary package controller would repeat the process starting from sending an inquire request and completing the cycle with sending an update request until the inquire request receives 0 as response.

If the package has been moved to an electronic locker, then the intermediary agent would also communicate with the order management system so that the locker system database will be updated for the electronic locker to use a unique one-time code or for a specific wallet user, who made the payment for the package using a wallet, to use a one-time authentication. The authentication method could be fingerprint, face id, or any biometric authentication.

If the intermediary package controller is not able to move the package, the intermediary package controller would communicate with the intermediary agent with the owner identifier, machine identifier, package type, package identifier, from-bin where the package is supposed to be moved from, to-bin where the package is supposed to be moved to and an indicator to indicate that the package move failed. Then the intermediary agent may notify the owner client and/or employee clients about the failure.

The bin to which the incoming package is moved can be an intermediary bin or could be an outgoing bin. When an incoming package is moved to an intermediary bin, the incoming package will then be referred to as outgoing package. When an outgoing package is moved to outgoing bin, the outgoing package information (outgoing package identifier and locker external identifier) will be displayed on the display monitor when the display monitor is refreshed next time. The outgoing package recipient will use the one-time code of a specific package identifier or scan the QR Code displayed on a specific electronic locker based on the information displayed on the display monitor.

When an outgoing package is moved to an outgoing bin, the intermediary package controller or incoming package controller would notify the intermediary agent about the move and the intermediary agent would know about the content of the outgoing bin where the outgoing package was moved to. The intermediary agent would also know the external and internal identifier of the electronic lock attached to the outgoing bin.

The display monitor placed visible to package recipients in the package transfer machine would display the package identifier or the name of the outgoing package recipient and locker number. If the one-time code is last few digits (example 4-6) of package identifier and if the outgoing package identifier excluding the one-time code is unique for each package, then the outgoing identifier excluding the one-time code will be displayed on the display monitor.

The intermediary agent would provide content of the outgoing bin which would be outgoing package identifier, the internal identifier of the electronic lock attached to the outgoing bin to order management system. If a one-time code is already assigned to the outgoing package identifier and the one-time code is already known to the package recipient such as last few digits of tracking number or last few digits of credit card number and the like, then the order management system may use the previously assigned one-time code, otherwise the order management system would create a random number as one-time code and communicate the one-time code to the outgoing package recipient. The order management system would provide the electronic locker internal identifier and the one-time code to the locker management system. If the order management system accepted payment for the outgoing package identifier through a mobile wallet and if the locker management system is also interfaced with the same mobile wallet, then the order management system may provide the mobile wallet user identifier of the buyer of outgoing package identifier and the electronic locker internal identifier to the locker management system. At any event, the order management system would provide a one-time code and electronic locker internal number and/or mobile wallet user identifier of the buyer and electronic locker internal number to the locker management system.

The outgoing package recipient would know the electronic locker external number from the display monitor and/or would receive a notification with the electronic locker external number. The outgoing package recipient would then scan the QR Code displayed on the front side of the electronic locker or enter the one-time code on the keypad attached to the electronic locker to open the electronic locker and pick up the goods. The electronic locker would send the internal number and the one-time code or the internal number only. Upon receiving the electronic locker internal number and one-time code the electronic locker server would verify the one-time code by comparing the one-time code received from the order management system for the same electronic locker internal number. Upon receiving the electronic locker internal number without a one-time code, the electronic locker server would verify whether a mobile wallet authentication is received and by comparing the mobile wallet user identifier and the electronic locker internal identifier received as part of the mobile wallet authentication are the same as mobile wallet user identifier of the buyer and electronic locker internal number received from order management system. Upon verification of the one-time code or authentication of buyer, the locker management system would instruct the electronic locker to unlock the electronic locker door. The locker management system would also notify the order management system that a verified outgoing package recipient has successfully unlocked the electronic locker by providing the electronic locker internal number.

The order management system, in turn, would notify the intermediary agent that a verified outgoing package recipient has successfully unlocked the electronic locker by providing the electronic locker internal number. Then the intermediary agent would update the information in the package transfer database to note that the outgoing bin is available.

Package depositors will always be able to drop the packages without waiting for the package recipients to be ready to pick up the packages.

Package recipients will always be able to pick up the packages inside the store, at the curbside and at the drive-thru 24 hours a day and 7 days a week.

More than one package recipient would be able to pick up the orders at the same time.

Merchants will be able to leave large volumes of pickup orders with a few electronic lockers.

This would ensure that the package recipients will be able to pick up order 24/7 without waiting in line for a long time.

Package droppers, package recipients, owner clients and employee clients would use services provided by intermediary agent to maintain the required information in various databases for QR Automation for package transfer automation to work.

The package transfer machines can be a package direct transfer machine or package intermediary transfer machine.

Machine owners and/or employee clients using any web site maintained by intermediary agent can maintain data in various tables in package transfer database as shown in a class diagram in FIG. 44.

Machine owners would register as owner clients and maintain their contact, location, employee, and machine identifier with an intermediary agent. Intermediary agent would use package transfer database to store the information.

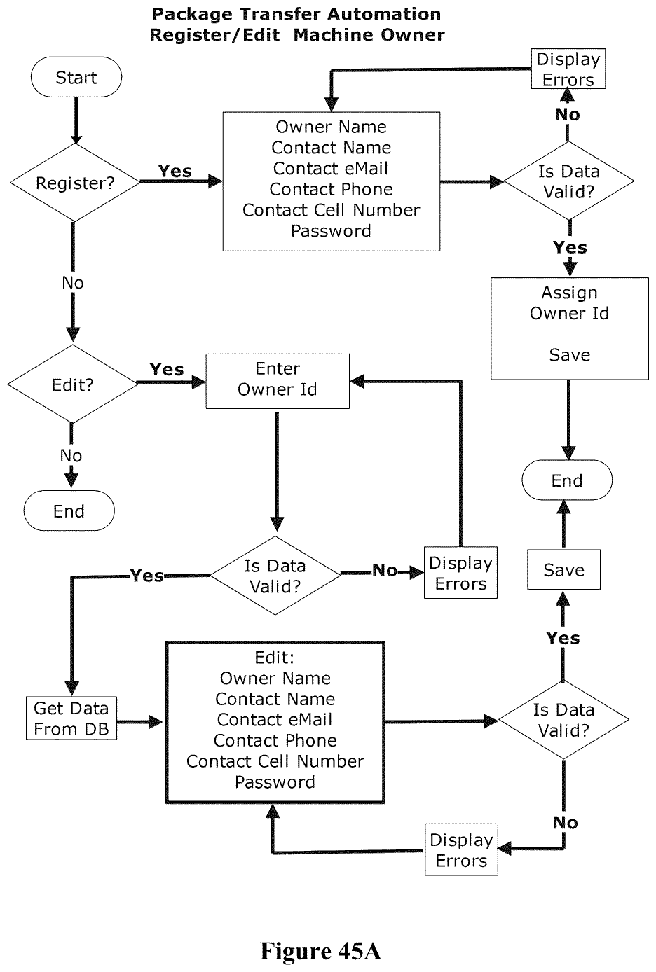

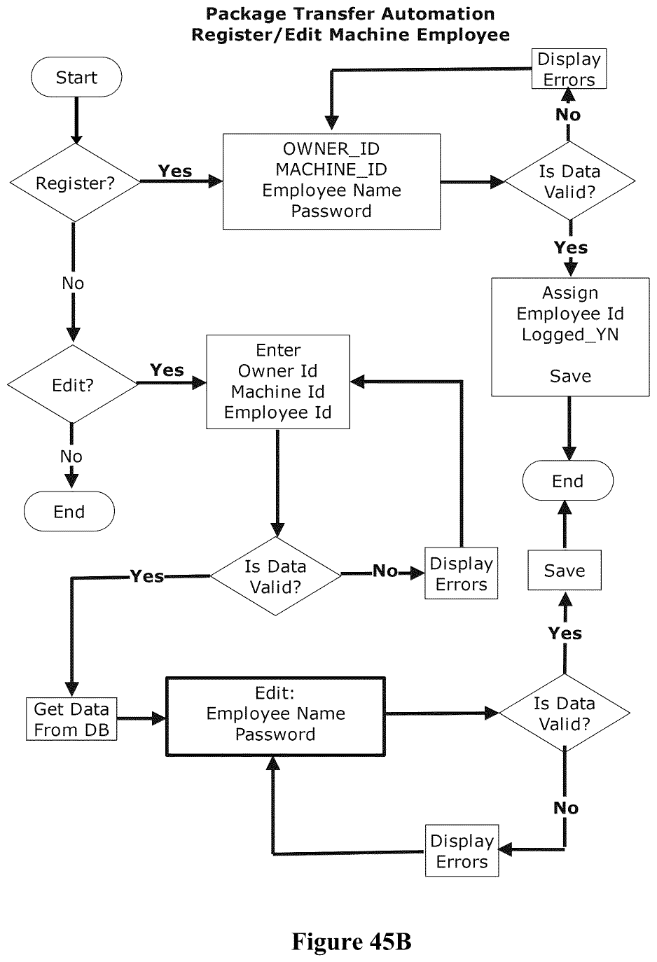

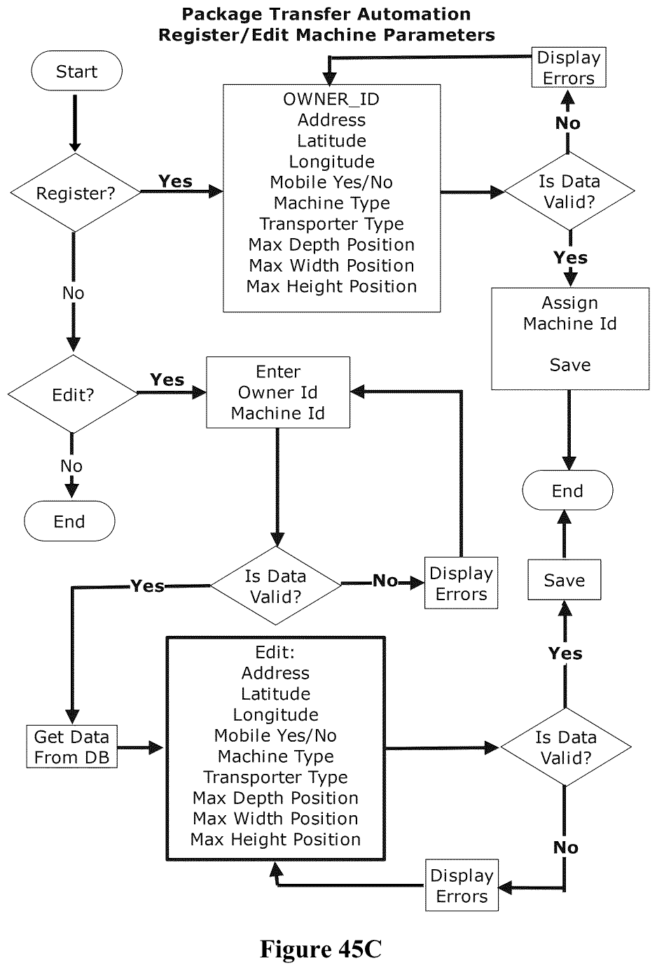

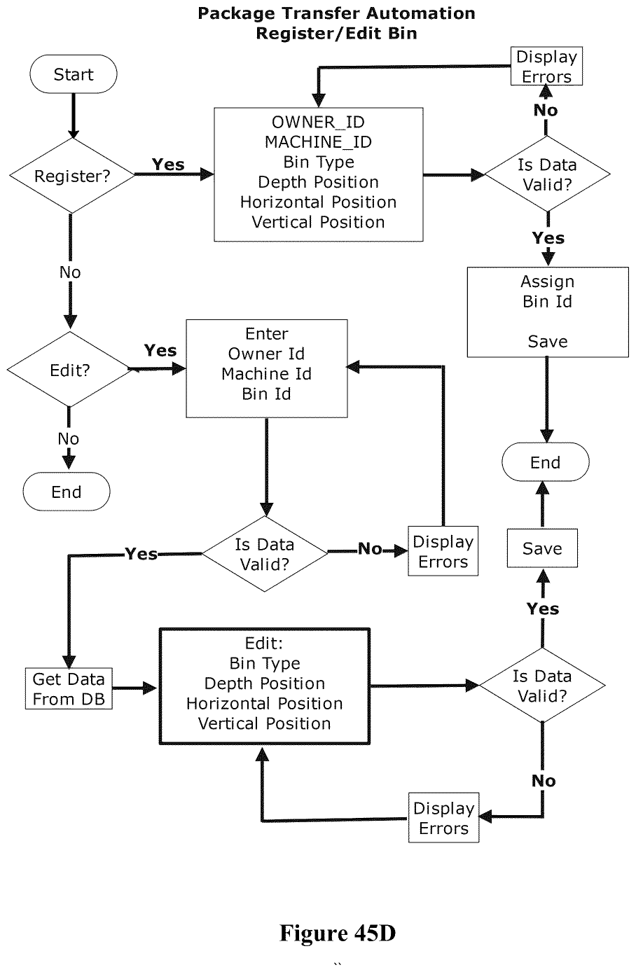

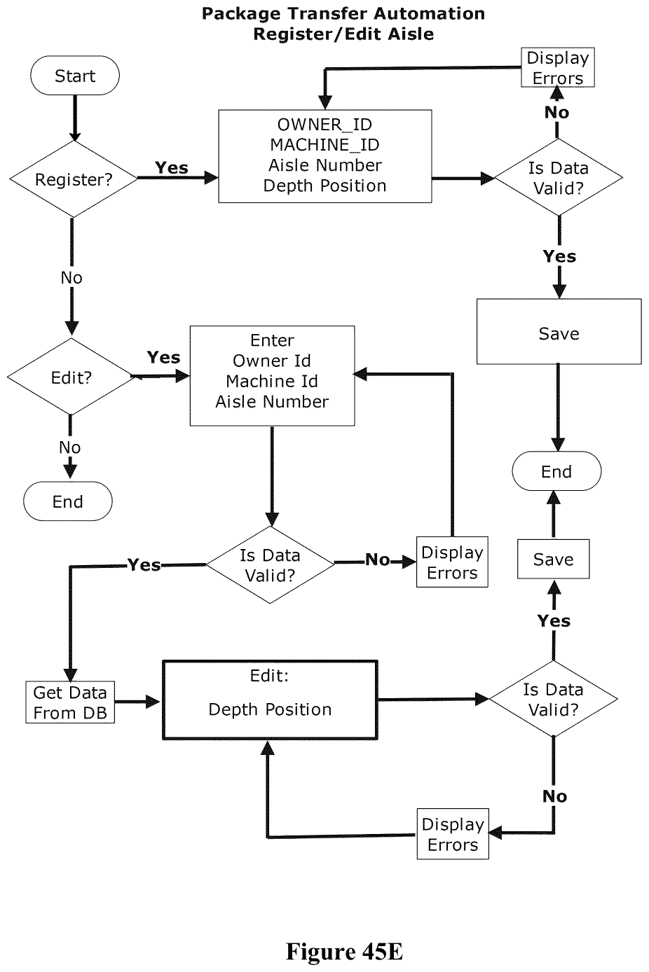

Machine owners would register as owners and edit their information as owner clients, owner clients would also add and edit employees, location, bin, aisle, incoming and outgoing controller information with the intermediary agent as shown in flowcharts in FIGS. 45A, 45B, 45C, 45D and 45E. Machine owners would also download and display a unique QR Code for incoming controller identifier and a unique QR Code for outgoing controller identifier for each machine location as shown in flowchart in FIG. 46.

Machine owners can register using an owner registration web form provided by intermediary agent using ‘A’ for action. Intermediary agent would assign a unique value for owner identifier and capture values for owner name, contact name, contact email, contact phone, contact cell password as shown in FIG. 45A. If the values are valid then the intermediary agent would insert a row into machine owner table using owner identifier for OWNER_ID, owner name for OWNER_NAME, contact name for CONTACT_NAME, contact email for CONTACT_EMAIL, contact phone for CONTACT_PHONE, contact cell for CONTACT_CELL, password for PASSWORD and ‘N’ for LOGGED_YN. Machine owners can edit their information using owner registration web form provided by intermediary agent using ‘E’ for action. When machine owners maintain their information, the intermediary agent would use a password to verify the machine owners. Intermediary agent would capture values for owner identifier, owner name, contact name, contact email, contact phone, contact cell and password as shown in FIG. 45A. If the values are valid then the intermediary agent would update a row in machine owner table as shown in a class diagram as shown in FIG. 44 using owner identifier for OWNER_ID, owner name for OWNER_NAME, contact name for CONTACT_NAME, contact email for CONTACT_EMAIL, contact phone for CONTACT_PHONE, contact cell for CONTACT_CELL, password for PASSWORD and ‘N’ for LOGGED_YN. Registered machine owners will be referred to as machine owners or package machine transfer owners.

Package machine transfer owners can add a machine or edit machine parameters using a machine registration web form as shown in FIG. 45C. Machine owners can add a machine using a machine registration web form provided by intermediary agent using ‘A’ for action. Machine owners can also edit machine parameters using a machine registration web form provided by intermediary agent using ‘E’ for action. When a machine is added, the intermediary agent would assign a unique value for machine identifier. When machine parameters are edited, the intermediary agent would use a password to verify the machine owners. When machine parameters are edited, machine owners provide the machine identifier for which the parameters are edited. Intermediary agent would capture values for owner identifier, ADDRESS, LATITUDE, LONGITUDE, MOBILE_YN, MACHINE_TYPE, TRANSPORTER_TYPE, MAX_DEPTH_POSITION, MAX_HORIZONTAL_POSITION, MAX_VERTICAL_POSITION, DEPTH_POSITION_ORIGIN, HORIZONTAL_POSITION_ORIGIN, VERTICAL_POSITION_ORIGIN, DEPTH_POSITION_SIZE, HORIZONTAL_POSITION_SIZE and VERTICAL_POSITION_SIZE as shown in FIG. 45C. If the machine is mounted on a mobile vehicle, then the value MOBILE_YN would be ‘Y’, otherwise it will be ‘N’. If the machine type is direct mover, then the value MACHINE TYPE would be ‘D’, otherwise it will be ‘I’. Direct mover machines will not have any intermediary bins. If the machine uses rails to move the package transporter, then the value TRANSPORTER TYPE would be ‘R’, otherwise it will be ‘B’. The MAX DEPTH POSITION will be the number of sets where each set will have a set of bins plus number of aisles where each aisle will serve (2) sets of bins. For package direct transfer machine, the MAX DEPTH POSITION will be (2) as shown in FIGS. 47A through 47G. For package intermediary transfer machine, the MAX_DEPTH_POSITION will be multiples of 3 as shown in FIGS. 48A through 48F. The MAX_HORIZONTAL_POSITION will depend on the width of the machine and MAX_VERTICAL_POSITION will depend on height of the machine. If counting of depth position is from front, then DEPTH_POSITION_ORIGIN will be ‘F’, otherwise it will be ‘B’. If counting horizontal position is from left, then HORIZONTAL_POSITION_ORIGIN will be ‘L’, otherwise it will be ‘R’. If counting of vertical position is from top, then VERTICAL_POSITION_ORIGIN will be ‘T’, otherwise it will be ‘B’. Machine owners and/or employees can maintain the information in machine table.

Package machine transfer owners can add an employee or edit employee information using an employee registration web form as shown in FIG. 45B. Machine owners can add an employee using an employee registration web form provided by intermediary agent using ‘A’ for action.

Machine owners can also edit employee information using a employee registration web form provided by intermediary agent using ‘E’ for action. When an employee is added, the intermediary agent would assign a unique value for employee identifier for each employee under each owner identifier and under each machine identifier. When employee information is added or edited, the intermediary agent would use a password to verify the user. When employee information is edited, machine owners provide the employee identifier. Intermediary agent would insert/update a row in machine employee table using owner identifier for OWNER_ID, machine identifier for MACHINE_ID, unique employee identifier for EMPLOYEE_ID and values captured from package machine transfer owners and/or employees for EMPLOYEE_NAME for PASSWORD and ‘N’ or LOGGED_YN. Machine owners can add and edit the information in machine employee table whereas employees can maintain only their own information in machine employee table.

Package machine transfer owners can add an aisle or edit aisle information using an aisle registration web form as shown in FIG. 45E Machine owners can add an aisle using an aisle registration web form provided by intermediary agent and using ‘A’ for action. Machine owners can also edit aisle information using an aisle registration web form provided by intermediary agent using ‘E’ for action. When aisle information is added or edited, the intermediary agent would use a password to verify the user. When an aisle is added, the intermediary agent would assign a unique value for aisle identifier for each aisle under each owner identifier and under each machine identifier. When aisle information is edited, machine owners provide the aisle identifier. Intermediary agent would insert/update rows in aisle table using owner identifier for OWNER_ID, machine identifier for MACHINE_ID, values captured from owners and/or employees for AISLE_NUMBER and DEPTH_POSITION. Machine owners and/or employees can maintain the information in aisle table. For package direct transfer machines, the AISLE_NUMBER will be 1 and DEPTH_POSITION will be 2, if the DEPTH_POSITION_ORIGIN in machine table is ‘F’. For package direct transfer machines, the AISLE_NUMBER will be 1 and DEPTH_POSITION will 1, if the DEPTH_POSITION_ORIGIN in machine table is ‘B’. For package intermediary transfer machines, the DEPTH_POSITION for AISLE_NUMBER 1 will be (2) and for every 3^{rd} DEPTH_POSITION starting from DEPTH_POSITION 2, the AISLE_NUMBER will increment by 1. For example, the DEPTH_POSITION for AISLE_NUMBER (2) will be 5, the DEPTH_POSITION for AISLE_NUMBER 3 will be 8 and so on.

Package machine transfer owners can add a bin or edit bin information using a bin registration web form as shown in FIG. 45D. Machine owners can add a bin using a bin registration web form provided by intermediary agent and using ‘A’ for action. Machine owners can also edit bin information using an bin registration web form provided by intermediary agent using ‘E’ for action. When bin information is added or edited, the intermediary agent would use a password to verify the user. When a bin is added, the intermediary agent would assign a unique value for bin identifier for each bin under each owner identifier, under each machine identifier and under each aisle identifier. Intermediary agent would insert/update rows in bin table using owner identifier for OWNER_ID, machine identifier for MACHINE_ID, values captured from owners and/or employees for BIN_ID, BIN_TYPE, DEPTH_POSITION, HORIZONTAL POSITION and VERTICAL_POSITION. The valid values for BIN_TYPE would be ‘N’ for package incoming bins, ‘I’ for package intermediary bins and ‘O’ for package outgoing bins. The DEPTH_POSITION, HORIZONTAL_POSITION and VERTICAL_POSITION cannot be more than MAX_DEPTH_POSITION, MAX_HORIZONTAL_POSITION and MAX_VERTICAL_POSITION saved in machine table respectively. There cannot be any bin in aisles or in bridge. Machine owners and/or employees can maintain the information in bin table.

Package machine transfer owners can add a bin locker sync or edit bin locker sync formation using a bin locker sync web form. Machine owners can add a bin locker sync using a bin locker sync registration web form provided by intermediary agent and using ‘A’ for action. Machine owners can also edit bin locker sync information using an bin locker sync registration web form provided by intermediary agent using ‘E’ for action. When bin locker sync information is added or edited, the intermediary agent would use a password to verify the user. Intermediary agent would insert/update rows in bin locker sync table using owner identifier for OWNER_ID, machine identifier for MACHINE_ID, values captured from owners and/or employees for BIN_ID, LOCKER_INTERNAL_IDENTIFIER and for LOCKER_EXTERNAL_IDENTIFIER. BIN_ID can be only valid BIN_ID from machine bin table where BIN_TYPE is ‘O’.

Package transfer machines come in (4) types namely package direct transfer machine with rails, package direct transfer machine with robots, package intermediary transfer machine with rails and package intermediary transfer machine with robots. All the machine types have 3 controllers namely incoming package controller, intermediary package controller and outgoing package controller. All the controllers have firmware and loading of appropriate software into the firmware is required. The software loaded into the controller firmware would include a URL to communicate with the intermediary agent. At a minimum, the URL would include the intermediary agent server information, owner identifier and machine identifier. The intermediary package controller would also have a database in the firmware with machine table and machine package transport table similar to machine table and machine package transporter table in package transfer database in intermediary agent server as shown in a class diagram in FIG. 44. Once appropriate software is loaded into the 3 controllers' firmware, the owner and/or employee clients can download the machine table information into the intermediary package controller database by activating a switch provided with the intermediary package controller. The information in machine table and machine package transport table will be used by intermediary package controller to move the packages from from-bin to to-bin and track the package transporter.

Intermediary agent would insert/update rows in package queue table using owner identifier for OWNER_ID, machine identifier for MACHINE_ID, values received from package incoming controller or package outgoing controller for PACKAGE_TYPE, FROM BIN_ID and ORDER_IDENTIFIER. The valid values for PACKAGE_TYPE would be ‘N’ for incoming packages and ‘O’ for outgoing packages.

Intermediary agent would insert/update rows in bin content table using owner identifier for OWNER_ID, machine identifier for MACHINE_ID, values assigned by intermediary agent for BIN_ID, BIN_SEQ and ORDER_IDENTIFIER when the package was dropped in package incoming bin and when the package is moved from from-bin to to-bin. Values for ORDER_IDENTIFIER will be captured from incoming package or from the person dropped the package in the incoming bin.

Owner and employee clients can send owner identifier and machine identifier to package machine manufacturer so that the required software would be loaded into the (2) firmware used in package direct transfer machine namely incoming package controller and intermediary package controller or 3 firmware used in the package intermediary transfer machine namely incoming package controller, intermediary package controller and outgoing package controller.

Owner and employee clients can download the QR Codes as shown in FIG. 46. Owner and employee clients would attach the incoming package controller identifier QR Code to incoming package controller. If the package transfer machine is a package intermediary transfer machine, then owner and employee clients would also attach the outgoing package controller identifier QR Code to outgoing package controller.

Owner and employee clients can activate the update switch in the intermediary package controller as needed to download the bin mapping information stored in machine table, aisle table and bin table in package transfer database. Owner and employee clients would activate the update switch in the intermediary package controller before starting the operation and whenever the data in any one of the bin mapping information tables is modified.

Package droppers, and package recipients would use QR Code for Package Transfer Automation system, to automate front and back of operations to handle pick up orders where employees leave pick up orders without waiting for pick up recipients to show up and pick up recipients can pick-up orders 24/7 from electronic lockers placed inside store, at the curbside and at the drive-thru lane. In some embodiments Package Transfer Automation system can use sprint-thru driveways instead of drive-thru lanes.

Package dropper would drop the incoming packages into package transporter provided by package direct transfer machine or to an incoming package bin provided by package intermediary transfer machine. The incoming package controller attached to the incoming package hole, or the incoming package bin would automatically scan the receipt or shipping label attached to the incoming package and capture the package identifier.

As an alternative, the package dropper can also leave the incoming package inside the incoming package hole or incoming package bin and enter a package identifier on the keypad attached to the incoming package hole or incoming package bin so that the incoming package controller would capture the package identifier through the keypad.

Upon capturing the package identifier, the incoming package controller would communicate with the intermediary agent and send application identifier, owner identifier, machine identifier, incoming package bin identifier and incoming package identifier to the intermediary agent. If the package was dropped directly into package transporter as in the case of package direct transfer machine, the incoming package bin identifier would be blank. If the application identifier, owner identifier, machine identifier, incoming package bin identifier and incoming package identifier are valid, then the intermediary agent would insert the package identifier into package queue table. If the package identifier is inserted into package queue table, then the incoming package controller will receive a successful message, otherwise it will receive a failure message. If the incoming package controller receives a successful message, then the incoming package controller would also request intermediary package controller to send a request to the intermediary agent to process requests in the incoming package queue.

As another alternative the package dropper can also leave the incoming package inside the incoming package hole or incoming package bin, scan a QR Code displayed as part of incoming package controller using any generic QR Code reader. The package dropper will be directed to a web page coded in the QR Code and the package dropper would manually enter the package identifier. An application identifier, owner identifier, machine identifier and incoming bin number would also be coded in the QR Code. The web page would send the application identifier, owner identifier, machine identifier, incoming bin number and incoming package identifier to the intermediary agent. If the web page receives a successful message from the intermediary agent as a response, then the package dropper would activate the start button attached to the incoming package controller. Upon activation of the start button the incoming package controller would request intermediary package controller to send a request to the intermediary agent to process requests in the incoming package queue.

When the intermediary agent processes pending requests in incoming package queue, the incoming package will be moved to an intermediary package bin or to an electronic locker and the order management system will be notified. If the package is moved to an electronic locker, then the display monitor would display package identifier (without one-time code) and the electronic locker external number. Upon arrival at the order pick up location, the package recipient would get the electronic locker external number that matches their package identifier from the display monitor. If the package identifier is not displayed in the display monitor, then the package recipient would enter the package identifier in the keypad connected to outgoing package controller or scan a QR Code displayed on the outgoing package controller and enter the package identifier in a web page. If the package identifier is not displayed in the display monitor, the package recipient can activate the switch connected to the outgoing package controller.

Upon activation of the switch connected to the outgoing package controller, the outgoing package controller would request intermediary package controller to send a request to the intermediary agent to process requests in the outgoing package queue.

Upon finding out the electronic locker external number, the package recipient would enter the one-tine code received from the order management system or printed on sales receipt or follow the instructions posted near the electronic locker to open the electronic locker and pick up the package. As an alternative, the package recipient can also use a mobile wallet app to scan a QR Code displayed on the electronic locker and use a fingerprint or face id or any biometric data to authenticate to open the locker and pick up the package.

The intermediary agent would receive the requests from incoming package controller, intermediary package controller and outgoing package controller through controller gateway and would use application components and application components in turn would use database server to insert, update or retrieve rows from all the tables in package transfer database as shown in a class diagram in FIG. 44.

Intermediary agent, controller gateway, application servers, database servers, databases are only examples and any number of agents, controller gateways, application servers, database servers and databases can be used.

First, the request handler would categorize the request received through controller gateway into different categories namely incoming package data, intermediary package data, and outgoing package data. The request handler would use DATA_CATEGORIZATION_PROCESS to categorize the data and would direct the request to INCOMING_PACKAGE_PROCESS or INTERMEDIARY_PACKAGE_PROCESS or OUTGOING_PACKAGE_PROCESS based on the categorization of the received data. INCOMING_PACKAGE_PROCESS, INTERMEDIARY_PACKAGE_PROCESS and OUTGOING_PACKAGE_PROCESS are only examples, and any number of processes can be used. INCOMING PACKAGE PROCESS, INTERMEDIARY_PACKAG_PROCESS and OUTGOING_PACKAGE_PROCESS are further described in greater detail herein.

It is beyond the scope of this invention to fully describe all the information that can be included in the data received through the controller gateway. The information provided herein is only to illustrate how packages received through incoming package bins are transported to outgoing package bins with or without the use of intermediary package bins.

It is beyond the scope of this invention to fully describe all the electronic devices that can be installed in package transfer machines, the content of data exchanged between electronic devices and intermediary agent and the method of exchange between electronic devices and intermediary agent. The information provided herein is only to illustrate how electronic devices can monitor incoming packages and transport incoming packages from incoming package bins to outgoing package bins.

It is beyond the scope of this invention to fully describe on how the package recipients and intermediary agent would communicate with electronic locker service providers. The information provided herein is only to illustrate how electronic lockers can be used as outgoing package bins.

### Data_Categorization_Process:

Data categorization process is an entry point for processing incoming data. If the data categorization process terminates before fully executing the data categorization process, the intermediary agent may notify package transfer machine owner and employees and/or display a message for termination reason. If the incoming data is received through controller gateway, then the process will continue, otherwise it will be terminated. If the process continues and if the incoming data has values for parameters application identifier, owner identifier and machine identifier, then the process will continue, otherwise it will be terminated. If the process continues and if the value for application identifier is 207 or 227 or 247 then the process will continue, otherwise it will be terminated. If the process continues, then the request handler would verify the values of owner identifier and machine identifier. The request handler would retrieve the values for MACHINE TYPE from machine table using owner identifier for OWNER_ID and machine identifier for MACHINE_ID. If the request handler can retrieve one row, then the request handler would save the value of MACHINE_TYPE as machine type and the data categorization process will continue, otherwise it will be terminated.

If the data categorization process continues and if the application identifier is 207 which identifies that the incoming data is from incoming package controller, then the request handler would direct the request to INCOMING PACKAGE PROCESS. If the data categorization process continues and if the application identifier is 227 which identifies that the incoming data is from outgoing package controller, then the request handler would direct the request to OUTGOING PACKAGE PROCESS. If the data categorization process continues and if the application identifier is 247 which identifies that the incoming data is from intermediary package controller, then the request handler would direct the request to INTERMEDIARY_PACKAGE_PROCESS.

### Incoming_Package_Process:

Incoming package process is an entry point for processing the data received from incoming package controller through controller gateway. If the incoming package process terminates before fully executing the incoming package process, the intermediary agent may notify package transfer machine owner and employees and/or display a message for termination reason.

If the request handler is directed to incoming package process by data categorization process, then the incoming package process will continue, otherwise it will be terminated. If the incoming package process continues and if the data received from incoming package controller has values for parameters incoming bin number and package identifier, then the incoming package process will continue, otherwise it will be terminated. If the incoming bin number is blank and if the machine type is ‘D’ or if the incoming bin number is not blank and if the machine type is ‘I’, then the incoming package process will continue, otherwise it will be terminated. If the incoming bin number is not blank and if the machine type is ‘I’, then the request handler would verify the existence of incoming bin number by retrieving one row in machine bin table using owner identifier for OWNER_ID, machine identifier for MACHINE_ID, incoming bin number for BIN_ID and ‘N’ for BIN_TYPE. If the request handler can retrieve one row, then the incoming package process will continue, otherwise it will be terminated.

If the incoming package process continues, then the request handler would insert a new row into machine package queue table. The request handler would retrieve the value of QUEUE_SEQ from the latest row in machine package queue table using owner identifier for OWNER_ID, machine identifier for MACHINE_ID, ‘N’ for PACKAGE_TYPE and QUEUE_SEQ in descending order. If the request handler can retrieve one row, then the request handler would save the value of QUEUE_SEQ plus 1 as new queue sequence, otherwise the request handler would save 1 as new queue sequence.

Then the request handler would insert a new row in machine package queue table using owner identifier for OWNER_ID, machine identifier for MACHINE_ID, ‘N’ for PACKAGE_TYPE, new queue sequence for QUEUE_SEQ, ‘P’ for STATUS, incoming bin number for FROM_BIN_ID, blank for TO_BIN_ID and package identifier for ORDER_IDENTIFIER.

If the insert is successful, then the incoming package process will end, otherwise it will be terminated.

### Outgoing Package Process:

Outgoing package process is an entry point for processing the data received from outgoing package controller through controller gateway. If the outgoing package process terminates before fully executing the outgoing package process, the intermediary agent may notify package transfer machine owner and employees and/or display a message for termination reason.

If the request handler is directed to the outgoing package process by data categorization process, then the outgoing package process will continue, otherwise it will be terminated. If the outgoing package process continues and if the data received from outgoing package controller has values for parameter package identifier, then the outgoing package process will continue, otherwise it will be terminated. If the machine type is ‘I’, then the outgoing package process will continue, otherwise it will be terminated. If the outgoing package process continues, then the request handler would verify the existence of package identifier by retrieving one row in machine bin content table using owner identifier for OWNER_ID, machine identifier for MACHINE_ID, BIN_ID is not blank, ordering BIN_SEQ in descending order and package identifier for ORDER_IDENTIFIER. If the request handler can retrieve one row, then the request handler would save the value of BIN_ID in the retrieved one row as from bin number and the outgoing package process will continue, otherwise it will be terminated.

If the outgoing package process continues, then the request handler would insert a new row into machine package queue table. The request handler would retrieve the value of QUEUE_SEQ from the latest row in machine package queue table using owner identifier for OWNER_ID, machine identifier for MACHINE_ID, ‘O’ for PACKAGE_TYPE and QUEUE_SEQ in descending order. If the request handler can retrieve one row, then the request handler would save the value of QUEUE_SEQ plus 1 as new queue sequence, otherwise the request handler would save 1 as new queue sequence.

Then the request handler would insert a new row in machine package queue table using owner identifier for OWNER_ID, machine identifier for MACHINE_ID, ‘O’ for PACKAGE_TYPE, new queue sequence for QUEUE_SEQ, ‘P’ for STATUS, from bin number for FROM BIN_ID, blank for TO_BIN_ID and package identifier for ORDER_IDENTIFIER.

If the insert is successful, then the outgoing package process will end, otherwise it will be terminated.

### Intermediary Package Process:

Intermediary package process is an entry point for processing the data received from intermediary package controller through controller gateway. If the intermediary package process terminates before fully executing the intermediary package process, the intermediary agent may notify package transfer machine owner and employees and/or display a message for termination reason.

If the request handler is directed to intermediary package process by data categorization process, then the intermediary package process will continue, otherwise it will be terminated. If the intermediary package process continues and if the data received from intermediary package controller has values for parameter request type, then the intermediary package process will continue, otherwise it will be terminated. If the value for the parameter request type is ‘NI’ which is for incoming package inquire or ‘Or’ which is for outgoing package inquire or ‘NU’ which is for incoming package update or ‘OU’ which is for outgoing package update, then the intermediary package process will continue, otherwise it will be terminated. If the intermediary package process continues and if the value for the parameter request type is ‘NI’, then the intermediary agent would direct the request to INTERMEDIARY_PACKAGE_INCOMING_INQUIRE_PROCESS. If the intermediary package process continues and if the value for the parameter request type is ‘OI’, then the intermediary agent would direct the request to INTERMEDIARY_PACKAGE_OUTGOING_INQUIRE_PROCESS. If the intermediary package process continues and if the value for the parameter request type is ‘NU’, then the intermediary agent would direct the request to INTERMEDIARY_PACKAGE_INCOMING_UPDATE_PROCESS.

If the intermediary package process continues and if the value for the parameter request type is ‘OU’, then the intermediary agent would direct the request to INTERMEDIARY_PACKAGE_OUTGOING_UPDATE_PROCESS.

### Intermediary_Package_Incoming_Inquire_Process:

Intermediary package incoming inquire process is an entry point for processing the data received from intermediary package controller through controller gateway for incoming package inquire. If the intermediary package incoming inquire process terminates before fully executing the intermediary package incoming inquire process, the intermediary agent may notify package transfer machine owner and employees and/or display a message for termination reason. The intermediary agent would verify whether any request for incoming package in machine package queue table is in pending status. The request handler would retrieve the values of FROM_BIN_ID and ORDER_IDENTIFIER from a single row in machine package queue table using owner identifier for OWNER_ID, machine identifier for MACHINE_ID, ‘N’ for PACKAGE_TYPE, ordering QUEUE_SEQ in ascending order, ‘P’ for STATUS and blank for TO BIN_ID. If the request handler can retrieve a single row, then the request handler would save the values of FROM BIN_ID and ORDER_IDENTIFIER from the retrieved row as from-bin and package identifier respectively, otherwise the request handler would send 0 as response to intermediary package controller and end the intermediary package incoming inquire process.

If the intermediary package incoming inquire process continues and if the machine type is ‘D’, then the intermediary agent would determine whether an unoccupied outgoing package bin is available. The request handler would save the value of each BIN_ID in a bin identifier array from each row in machine bin table using owner identifier for OWNER_ID, machine identifier for MACHINE_ID, BIN_ID is not blank, and ‘O’ for BIN TYPE.

If the intermediary package incoming inquire process continues and if the machine type is ‘I’, then the intermediary agent would determine whether an unoccupied intermediary package bin is available. The request handler would save the value of each BIN_ID in a bin identifier array from each row in machine bin table using owner identifier for OWNER_ID, machine identifier for MACHINE_ID, BIN_ID is not blank, and ‘I’ for BIN TYPE.

For each bin identifier in bin identifier array, the request handler would retrieve one row from machine bin content table until a row is found using owner identifier for OWNER_ID, machine identifier for MACHINE_ID, bin identifier for BIN_ID, ordering BIN_SEQ in descending order and blank for ORDER_IDENTIFIER. If a row is retrieved, the request handler would save the value of BIN_ID in the retrieved row as to-bin, otherwise the request handler would send 0 as response to intermediary package controller and end the intermediary package incoming inquire process.

If the intermediary package incoming inquire process continues, the request handler would send from-bin, to-bin, and package identifier as response to intermediary package controller and end the intermediary package incoming inquire process.

### Intermediary_Package_Outgoing_Inquire_Process:

Intermediary package outgoing inquire process is an entry point for processing the data received from intermediary package controller through controller gateway for outgoing package inquire. If the intermediary package outgoing inquire process terminates before fully executing the intermediary package outgoing inquire process, the intermediary agent may notify package transfer machine owner and employees and/or display a message for termination reason. If the machine type is ‘D’, then request handler would terminate the intermediary package outgoing inquire process.

The intermediary agent would verify whether any request for outgoing package in machine package queue table is in pending status. The request handler would retrieve the values of FROM_BIN_ID and ORDER_IDENTIFIER from a single row in machine package queue table using owner identifier for OWNER_ID, machine identifier for MACHINE_ID, ‘O’ for PACKAGE_TYPE, ordering QUEUE_SEQ in ascending order, ‘P’ for STATUS and blank for TO_BIN_ID. If the request handler can retrieve a single row, then the request handler would save the values of FROM_BIN_ID and ORDER_IDENTIFIER from the retrieved row as from-bin and package identifier respectively, otherwise the request handler would send 0 as response to intermediary package controller and end the intermediary package outgoing inquire process.

If the intermediary package outgoing inquire process continues and if the machine type is ‘I’, then the intermediary agent would determine whether an unoccupied outgoing package bin is available. The request handler would save the value of each BIN_ID in a bin identifier array from each row in machine bin table using owner identifier for OWNER_ID, machine identifier for MACHINE_ID, BIN_ID is not blank, and ‘O’ for BIN_TYPE.

For each bin identifier in bin identifier array, the request handler would retrieve one row from machine bin content table until a row is found using owner identifier for OWNER_ID, machine identifier for MACHINE_ID, bin identifier for BIN_ID, ordering BIN_SEQ in descending order and blank for ORDER_IDENTIFIER. If a row is retrieved, the request handler would save the value of BIN_ID in the retrieved row as to-bin, otherwise the request handler would send 0 as response to intermediary package controller and end the intermediary package outgoing inquire process.

If the intermediary package outgoing inquire process continues, the request handler would send from-bin, to-bin, and package identifier as response to intermediary package controller and end the intermediary package outgoing inquire process.

### Intermediary_Package_Incoming_Update_Process:

Intermediary package incoming update process is an entry point for processing the data received from intermediary package controller through controller gateway for intermediary package incoming update. If the intermediary package incoming update process terminates before fully executing the intermediary package incoming update process, the intermediary agent may notify package transfer machine owner and employees and/or display a message for termination reason.

If the request handler is directed to intermediary package incoming update process by data categorization process, then the intermediary package incoming update process will continue, otherwise it will be terminated. If the intermediary package incoming update process continues and if the data received from intermediary package controller has values for parameters from-bin identifier, to-bin identifier, and package identifier, then the intermediary package incoming update process will continue, otherwise it will be terminated. If the from-bin identifier is blank and if the machine type is ‘D’ or if the from-bin identifier is not blank and if the machine type is ‘I’, then the intermediary package incoming update process will continue, otherwise it will be terminated. If the intermediary package incoming update process continues, if the from-bin identifier is not blank and if the machine type is ‘I’, then the request handler would verify the existence of from-bin identifier by retrieving one row in machine bin table using owner identifier for OWNER_ID, machine identifier for MACHINE_ID, from-bin identifier for BIN_ID and ‘N’ for BIN TYPE. If the request handler can retrieve one row, then the intermediary package incoming update process will continue, otherwise it will be terminated.

If the intermediary package incoming update process continues and if the machine type is ‘D’, then the request handler would verify the existence of to-bin identifier by retrieving one row in machine bin table using owner identifier for OWNER_ID, machine identifier for MACHINE_ID, to-bin identifier for BIN_ID and ‘O’ for BIN_TYPE. If the request handler can retrieve one row, then the intermediary package incoming update process will continue, otherwise it will be terminated.

If the intermediary package incoming update process continues and if the machine type is ‘I’, then the request handler would verify the existence of to-bin identifier by retrieving one row in machine bin table using owner identifier for OWNER_ID, machine identifier for MACHINE_ID, to-bin identifier for BIN_ID and ‘I’ for BIN_TYPE. If the request handler can retrieve one row, then the intermediary package incoming update process will continue, otherwise it will be terminated.

If the intermediary package incoming update process continues, the request handler would verify the existence of package identifier by retrieving one row in machine package queue table using owner identifier for OWNER_ID, machine identifier for MACHINE_ID, ‘N’ for PACKAGE_TYPE, ordering QUEUE_SEQ in ascending order, ‘P’ for STATUS, from-bin identifier for FROM BIN_ID and package identifier for ORDER_IDENTIFIER. If the request handler can retrieve one row, then the request handler would save the value of QUEUE_SEQ in the retrieved one row as queue sequence and the intermediary package incoming update process will continue, otherwise it will be terminated.

If the intermediary package incoming update process continues, the request handler would update the information in machine package queue table, machine package transporter table and machine bin content table.

If the intermediary package incoming update process continues, then the request handler would set the value for STATUS to ‘I’ and the value for TO_BIN_ID to to-bin identifier in machine package queue table using owner identifier for OWNER_ID, machine identifier for MACHINE_ID, ‘N’ for PACKAGE_TYPE, queue sequence for QUEUE_SEQ. from-bin identifier for FROM_BIN_ID and package identifier for ORDER_IDENTIFIER.

If the intermediary package incoming update process continues, then the request handler would insert a new row into machine package transporter table. The request handler would retrieve the value of TRANSPORTER_SEQ from the latest row in machine package transporter table using owner identifier for OWNER_ID, machine identifier for MACHINE_ID and ordering TRANSPORTER_SEQ in descending order. If the request handler can retrieve one row, then the request handler would save the value of TRANSPORTER_SEQ plus 1 as new transporter sequence, otherwise the request handler would save 1 as new transporter sequence. Then the request handler would insert a new row in machine package transporter table using owner identifier for OWNER_ID, machine identifier for MACHINE_ID, new transporter sequence for TRANSPORTER SEQ and to-bin identifier for BIN_ID.

If the intermediary package incoming update process continues, then the request handler would insert a new row into machine bin content table. The request handler would retrieve the value of BIN SEQ from the latest row for to-bin identifier in machine bin content table using owner identifier for OWNER_ID, machine identifier for MACHINE_ID, to-bin identifier for BIN_ID and ordering BIN_SEQ in descending order. If the request handler can retrieve one row, then the request handler would save the value of BIN_SEQ plus 1 as new bin sequence, otherwise the request handler would save 1 as new bin sequence. Then the request handler would insert a new row in machine bin content table using owner identifier for OWNER_ID, machine identifier for MACHINE_ID, to-bin identifier for BIN_ID, new bin sequence for BIN_SEQ and package identifier for ORDER_IDENTIFIER.

### Intermediary_Package_Outgoing_Update_Process:

Intermediary package outgoing update process is an entry point for processing the data received from intermediary package controller through controller gateway for outgoing package update. If the intermediary package outgoing update process terminates before fully executing the intermediary package outgoing update process, the intermediary agent may notify package transfer machine owner and employees and/or display a message for termination reason. If the machine type is ‘D’, then request handler would terminate the intermediary package outgoing update process.

If the intermediary package outgoing update process continues and if the machine type is ‘I’, then the request handler would verify the existence of to-bin identifier by retrieving one row in machine bin table using owner identifier for OWNER_ID, machine identifier for MACHINE_ID, to-bin identifier for BIN_ID and ‘O’ for BIN_TYPE. If the request handler can retrieve one row, then the intermediary package outgoing update process will continue, otherwise it will be terminated.

If the intermediary package outgoing update process continues, the request handler would verify the existence of package identifier by retrieving one row in machine package queue table using owner identifier for OWNER_ID, machine identifier for MACHINE_ID, ‘O’ for PACKAGE_TYPE, ordering QUEUE_SEQ in ascending order, ‘P’ for STATUS, from-bin identifier for FROM_BIN_ID and package identifier for ORDER_IDENTIFIER. If the request handler can retrieve one row, then the request handler would save the value of QUEUE_SEQ in the retrieved one row as queue sequence and the intermediary package outgoing update process will continue, otherwise it will be terminated.

If the intermediary package outgoing update process continues, the request handler would update the information in machine package queue table, machine package transporter table and machine bin content table.

If the intermediary package outgoing update process continues, then the request handler would set the value for STATUS to ‘I’ and the value for TO_BIN_ID to to-bin identifier in machine package queue table using owner identifier for OWNER_ID, machine identifier for MACHINE_ID, ‘O’ for PACKAGE_TYPE, queue sequence for QUEUE_SEQ. from-bin identifier for FROM_BIN_ID and package identifier for ORDER_IDENTIFIER.

If the intermediary package outgoing update process continues, then the request handler would insert a new row into machine package transporter table. The request handler would retrieve the value of TRANSPORTER_SEQ from the latest row in machine package transporter table using owner identifier for OWNER_ID, machine identifier for MACHINE_ID and ordering TRANSPORTER SEQ in descending order. If the request handler can retrieve one row, then the request handler would save the value of TRANSPORTER_SEQ plus 1 as new transporter sequence, otherwise the request handler would save 1 as new transporter sequence. Then the request handler would insert a new row in machine package transporter table using owner identifier for OWNER_ID, machine identifier for MACHINE_ID, new transporter sequence for TRANSPORTER_SEQ and to-bin identifier for BIN_ID.

If the intermediary package outgoing update process continues, then the request handler would insert a new row into machine bin content table. The request handler would retrieve the value of BIN SEQ from the latest row for to-bin identifier in machine bin content table using owner identifier for OWNER_ID, machine identifier for MACHINE_ID, to-bin identifier for BIN_ID and ordering BIN_SEQ in descending order. If the request handler can retrieve one row, then the request handler would save the value of BIN_SEQ plus 1 as new bin sequence, otherwise the request handler would save 1 as new bin sequence. Then the request handler would insert a new row in machine bin content table using owner identifier for OWNER_ID, machine identifier for MACHINE_ID, to-bin identifier for BIN_ID, new bin sequence for BIN_SEQ and package identifier for ORDER_IDENTIFIER.

### QR Code Communication & Automation

### Product Transfer Automation

The purpose of any check-out counter whether it is employee managed check-out or self-check-out, is to let the shoppers (buyers) to move the products (goods) from protected area to unprotected area upon making a payment at the employee managed check-out or at the self-check-out for the products to be moved from protected area to unprotected area. Protected area is the area where the products are stocked in bins. An unprotected area is the area where the shoppers can carry out only the purchased items through an exit. Moving any product from a protected area to unprotected area without making a payment at the employee managed check-out or self-check-out is considered as shop lifting. Store operators have been trying to find an easy and economical way to eliminate or reduce the number of employee (associate) managed check-out counters. So, a self-check-out process was introduced where the shoppers are asked to scan and bag each product to be purchased. Self-check-out merely depended on the details of the scanned item and on the weight of the bag in which each product to be purchased is placed. The details of the scanned item would include the description, weight, and price. So, after scanning an item, if it is not bagged or an item that weights differently from the scanned item is bagged based on the weight of the bag, the shoppers will be asked to place the scanned item in the bag before letting the shopper bag next item. So, the self-check-out counters merely depend on the weight of the item being bagged rather than the scanned item is bagged. For any help, the shopper will be asked to contact an associate monitoring the self-check-out counters or an associate will be automatically notified to render help to the shopper. Once all the items are scanned, the shoppers are asked to make the payment. Upon notification that the payment is processed successfully, the shoppers can move the scanned and bagged products from protected area to unprotected area. The success of any self-check-out depends on the honesty of shoppers and on enforcement of severe punishment for shoplifting. Because of the vulnerabilities associated with self-check-out, always self-check-out counters are closely monitored by associates and video cameras. Because of the fear that shoppers may be wrongfully accused of shoplifting, the shoppers may prefer employee managed check-out counters rather than self-check-out counters. Employees are required to manage self-check-out counters.

As an alternative, stores such as Walmart and Sam's Club allow shoppers to scan each product to be moved from protected area to unprotected area, make the payment for the products to be moved and walk through an employee managed security check point. At the employee managed security check point, products at random are manually scanned to ensure that unpaid item or items are not being moved. Again, this process depends on the honesty of shoppers and on enforcement of severe punishment for shoplifting.

A newly developed hardware and software technology has introduced a method for shoppers to grab and go which transformed traditional grocery or convenient or department stores into check-out counter less stores known as autonomous stores. These newly developed hardware and software technologies can be cost prohibitive and also invade into shoppers' privacy. Autonomous stores use high-definition cameras to monitor every movement of shoppers and capture the information of the product or products being picked up from the bins. The number of high-definition cameras and associated software depends on the size of autonomous stores.

As an alternative, stores can also provide electronic lockers such as MySingleLink lockers where individual products are scanned before being placed in a shopping cart or shopping basket, shopping carts or shopping baskets are left inside electronic lockers from protected area and shopping carts, or shopping baskets are retrieved from electronic lockers from unprotected area. Electronic lockers can also be used for products purchased online where employees can leave online purchases inside electronic lockers and buyers can pick them up from electronic lockers. Any electronic locker that is loaded with purchased items will become unavailable until the loaded items are picked up by buyers.

The best alternative would be entry less stores using an entry less autonomous system. The transfer of products from bins holding the products to curbside and drive-thru lockers where the products can be picked up by customers, even without entering the stores can be fully automated using robots and/or multi-directional product transporters. The object of an entry less autonomous system is to automatically move products from bins holding products to customers wherever they are. So, any store can be converted into an entry less autonomous store at an affordable cost by using product transfer automation technology. Product transfer automation uses low-cost technologies such as scanners, readers, sensors, and multi-directional product transporters rather than high-cost technologies such as high-definition cameras, high-resolution scanners, and image processing software. In addition to providing technologies to convert traditional stores to entry less autonomous stores, product transfer automation can also provide options for shoppers to communicate on demand with employees, and to get suggestions and recommendations on products from fellow shoppers shopping at the entry less autonomous stores concurrently.

The object of this invention is to provide a method for shoppers to purchase & pickup products without entering stores and for store operators to secure products from shoplifting. The object of this invention is to provide a method to protect shoppers' privacy.

The object of this invention is to design and build automated multi-directional product transporters using rails, conveyor belts and robots that can transfer products from one or more product bins located in one or more racks placed in one or more aisles to one or more secured lockers where one or more multi-directional product transporters and robots can collect products in specific orders and move them to secured lockers.

The object of this invention is to provide a means for shoppers to have access to electronic lockers to pick up goods.

The object of this invention is to provide a means for operators to place electronic lockers at curbside, drive-thru lanes, and parking lots.

The object of this invention is to display real-time information on desktops and on mobile devices for employees to provide remote or in-person customer service.

The object of this invention is to automatically keep track of inventory in each bin, in each rack, in each aisle and by product.

The object of this invention is to provide a means for operators and vendors to know the inventory by bins and by products on demand from anywhere.

The object of this invention is to provide alerts to store operators and employees when inventory of a product in any bin is below a certain level.

The object of this invention is to provide entry less autonomous store technology at an affordable price and implemented quickly.

The object of this invention is to provide entry less autonomous store technology to be portable and easy to install.

The object of this invention is to deliver a method that is easy to use without any special training.

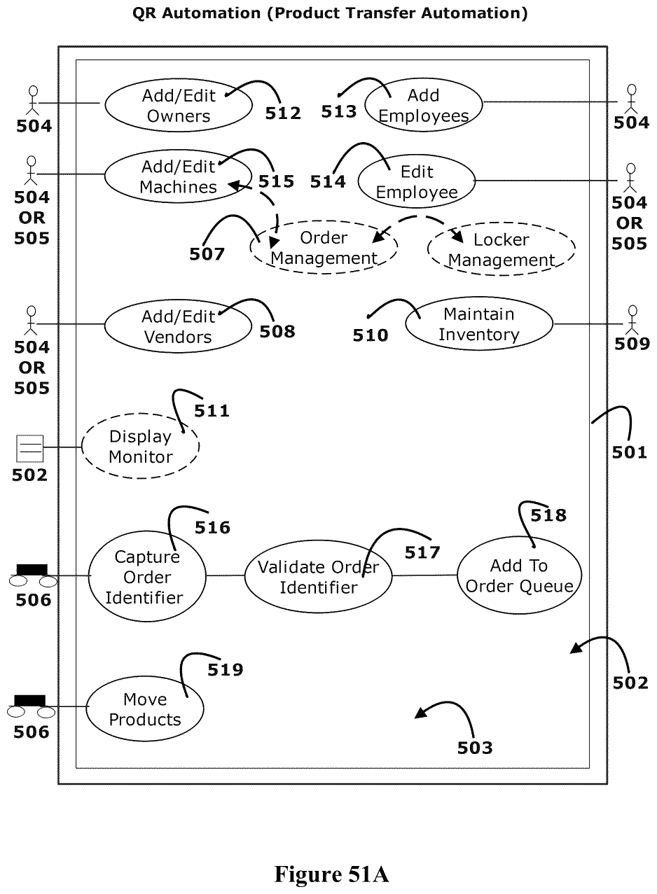

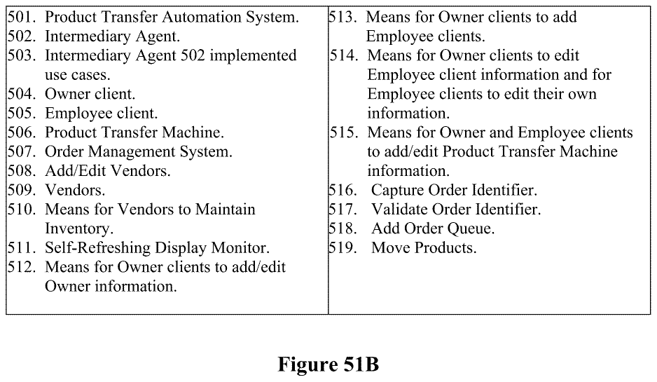

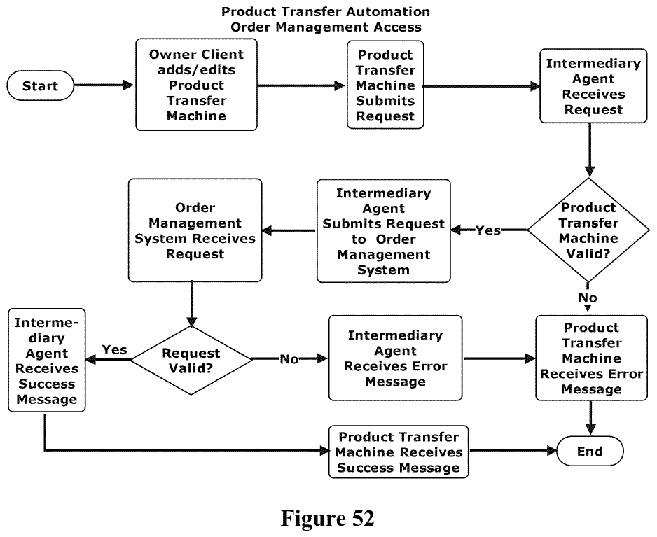

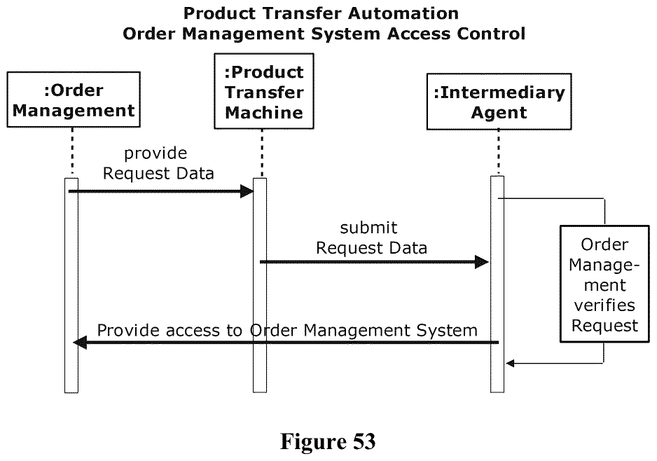

Referring now to the figures, and to FIG. 51A in particular, the QR Automation related to Product Transfer Automation system (501) of the present invention is shown to generally comprise a plurality of intermediary agent (502) implemented use cases (503). For simplicity, QR Automation related to Product Transfer Automation is referred to as Product Transfer Automation. In particular, the intermediary agent (502) provides a means (512) for owner client (504) to add or edit owner client (504) information. Owner clients are also referred to as operator clients (504).

Additionally, intermediary agent (502) provides a means (513) for operator clients (504) to add employee clients (505) information.

Additionally, intermediary agent (502) provides a means (514) for operator clients (504) to edit employee clients (505) information and employee clients (505) to edit their own information.

Additionally, intermediary agent (502) provides a means (515) for operator clients (504) and employee clients (505) to add and edit product transfer machines (506).

Additionally, intermediary agent (502) provides a means (507) for product transfer machines (506) to communicate with order and locker management systems.

Additionally, intermediary agent (502) provides a means (508) for operator clients (504) and employee clients (505) to add and edit vendor information (509).

Additionally, intermediary agent (502) provides a means (510) for vendors (509) to maintain inventory information.

Additionally, intermediary agent (502) provides a means to display pickup information for customers on a display monitor (511).

Additionally, intermediary agent (502) provides a means (516) for product transfer machines (506) to accept or capture order identifier.

Additionally, intermediary agent (502) provides a means (517) for product transfer machines (506) to validate order identifier.

Additionally, intermediary agent (502) provides a means (518) for product transfer machines (506) to add order identifier into an order queue.

Additionally, intermediary agent (502) provides a means (519) for product transfer machines (506) to process order queue and move products from product bins to order pickup bins.

Product transfer automation can be used by merchants to build new or convert existing brick and mortar stores with customer entrance into entry less autonomous stores for customers to pick up the orders 24 hours a day and 7 days a week (24/7) from secured electronic lockers placed at curbside and drive-thru lanes and is how it works:

Product transfer automation can remove entrances for customers and can eliminate or reduce the functions of employees who are responsible for managing stores.

Product transfer automation can use a database such as product transfer database with various tables such as machine owner table, machine table, machine employee table, machine vendor table, machine bin table, machine bin content table, machine bin locker sync table, machine order queue table, machine bin inventory table, machine bin move header table and machine bin move detail table as shown in a class diagram in FIG. 54. The valid values for TRANSPORTER TYPE in machine table are ‘R’ (Rail) and ‘B’ (Robot). The valid values for BIN TYPE in machine bin table are ‘P’ (Product), ‘I’ (Intermediary), ‘D’ (Drive-Thru) and ‘C’ (Curbside). The valid values for PICKUP BIN TYPE in machine order queue table are ‘D’ (Drive-Thru) and ‘C’ (Curbside). The valid values for STATUS in machine bin move header table are ‘A’ (Active) and ‘I’ (InActive). The valid values for MOVE STATUS in machine bin move detail table are ‘P’ (Pending), ‘A’ (Active) and ‘I’ (InActive). The valid values for MOVE TYPE in machine bin move detail table are ‘P’ (Product) and ‘I’ (Intermediary). The valid values for STATUS in machine order queue table are ‘P’ (Pending) and ‘I’ (Inactive).

Before continuing, however, it is noted that while the databases shown in class diagrams in FIG. 54 is exemplary of the preferred embodiments of the present invention related to product transfer automation, it is in no manner meant to be all encompassing or otherwise limiting of the wide range of implementations as are possible.

Before continuing, however, it is noted that the intermediary agent can use a single SQL to access data from each table or use a single SQL joining multiple tables to access data from multiple tables. For the sake of clarity, the SQLs provided as examples for accessing information from database will use a single table in each SQL, instead of using SQLs joining multiple tables.

Intermediary agent (502), operator clients (504), employee clients (505), product transfer machine (506), order and locker management (507), vendor clients (509) and display monitor (511) are also referred to as intermediary agent, operator clients, employee clients, product transfer machine, order and locker management, vendor clients and display monitor respectively.

Product transfer machines can have product bins, intermediary bins, and order pickup bins. Each product bin can hold one or more items of the same product having the same unique product identifier. Each intermediary bin can hold some or all products that are part of a unique order identifier. Each order pickup bin can hold all products that are part of a unique order identifier. Order pickup bins can be drive-thru order pickup bin or curbside order pickup bin.

Product transfer machines can have product bins stacked and accessible from product aisles. Product transfer machines can have one or more product aisles where each product aisle can have one product transporter that can move in horizontal and vertical directions. Product transports can ride on rails or robots and will transport products from product bins to intermediary bins. Each product bin may be fitted with spiral product pushers or conveyor belt to push one item at a time from product bins into product transporter.

Product transfer machines can have intermediary bins stacked and accessible by product transporter from product aisles and by intermediary transporter from intermediary aisle. Each product transporter may be fitted with a conveyor belt to push products from the product transporter to intermediary bins. Product transfer machines can have one intermediary aisle where the intermediary aisle can have one intermediary transporter that can move products in horizontal and vertical directions. Intermediary transporters can ride on rails or robots and will transport products from intermediary bins to order pickup bins. Each intermediary bin may be fitted with a conveyor belt to push products from intermediary bins to intermediary transporters. Each intermediary transporter may be fitted with a conveyor belt to push products from intermediary transporters to order pickup bins.

Product transfer machines can have order pickup bins stacked and accessible from curbside and/or from drive-thru lane from the front side and accessible from intermediary aisle from the back side. Order pickup bin would be an electronic locker or an order pickup bin with an electronic door. The electronic locker or the order pickup bin with an electronic door would have a spring-loaded flap that can be pushed open when the products are pushed into the electronic locker or the order pickup bin from the intermediary transporter. This spring-loaded flap will prevent the order pickup customers from reaching inside the electronic locker or the order pickup bin beyond the spring-loaded flap. The electronic locker may also be referred to as order pickup bin. The order pickup bin with an electronic door may also be referred to as electronic locker.

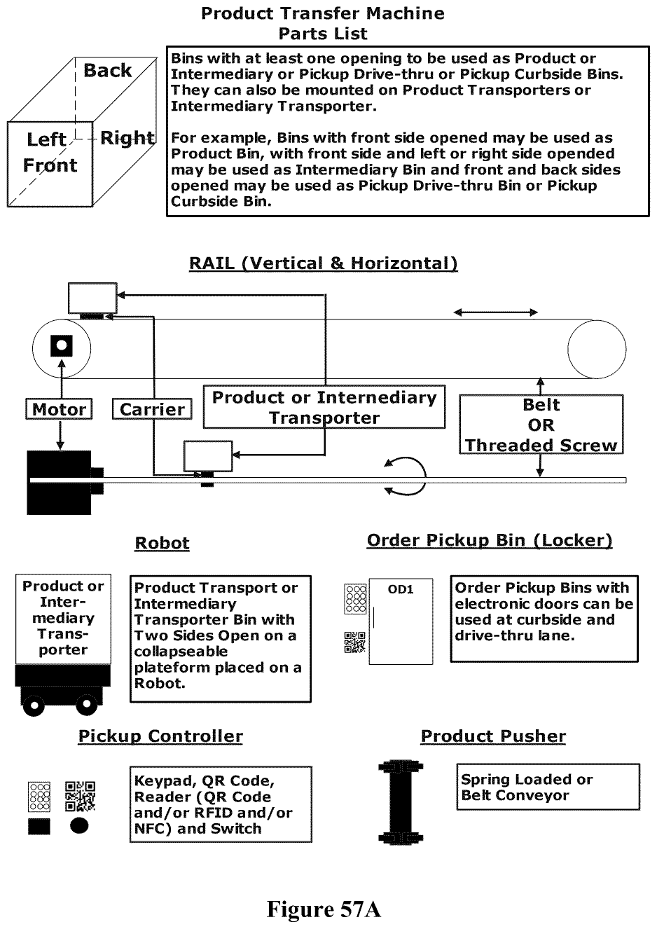

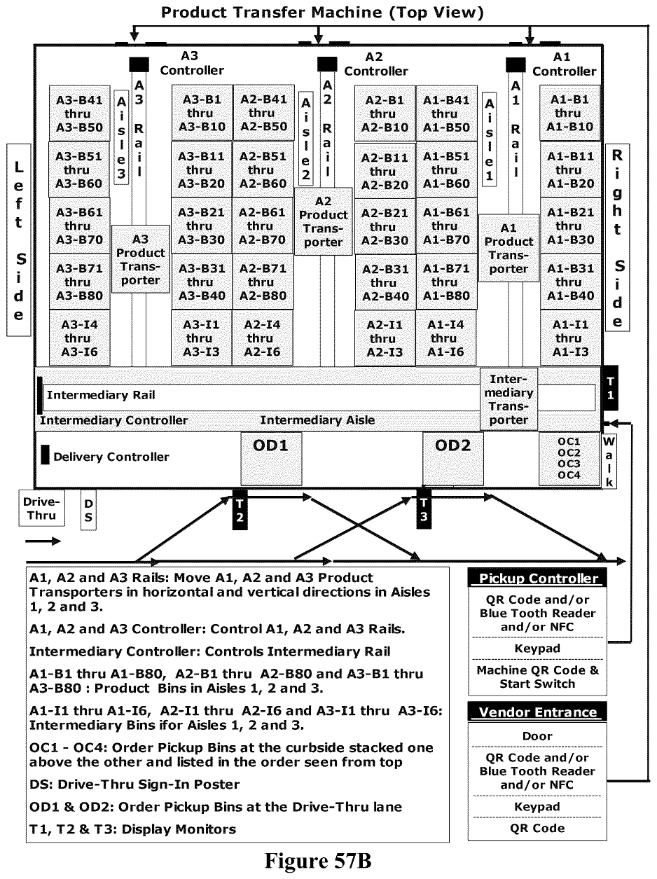

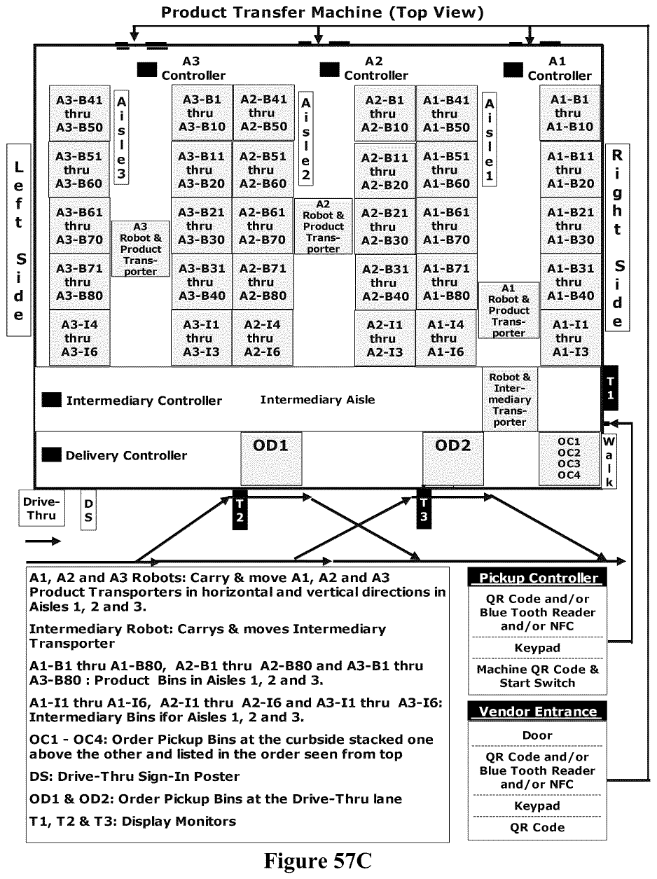

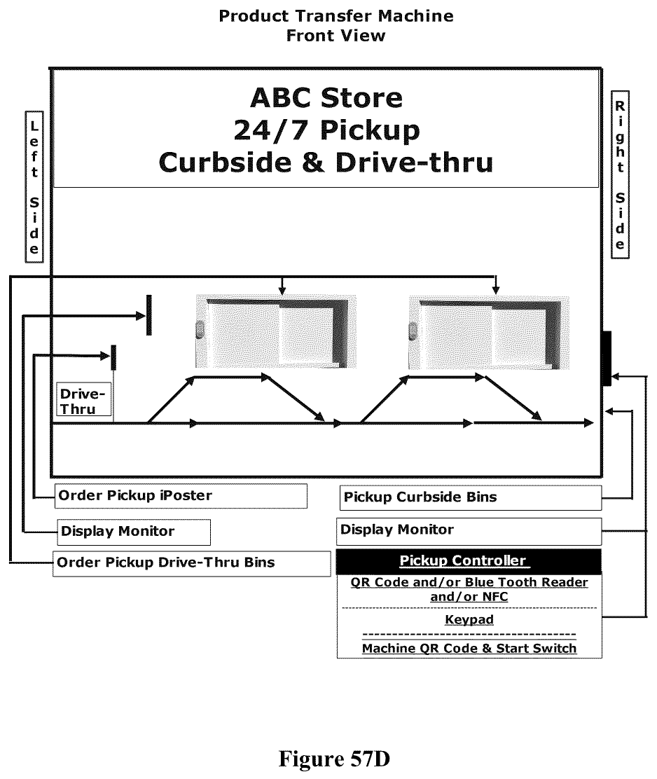

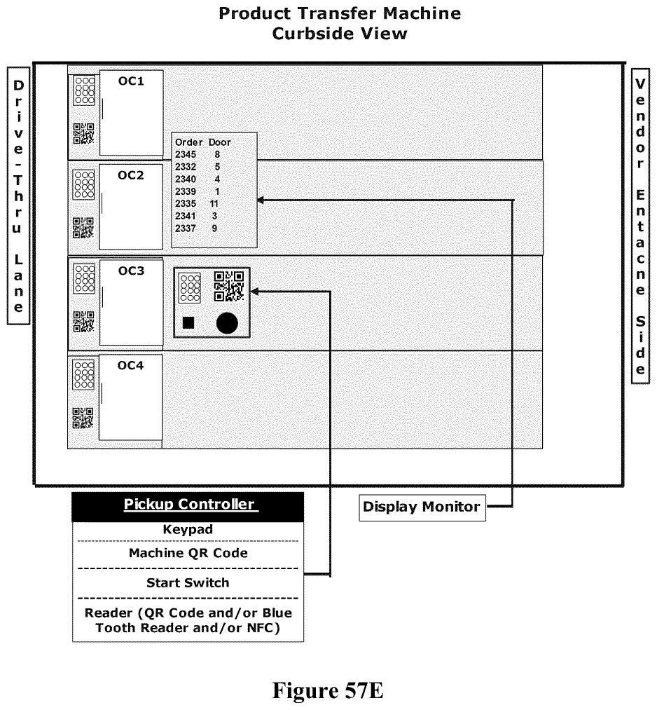

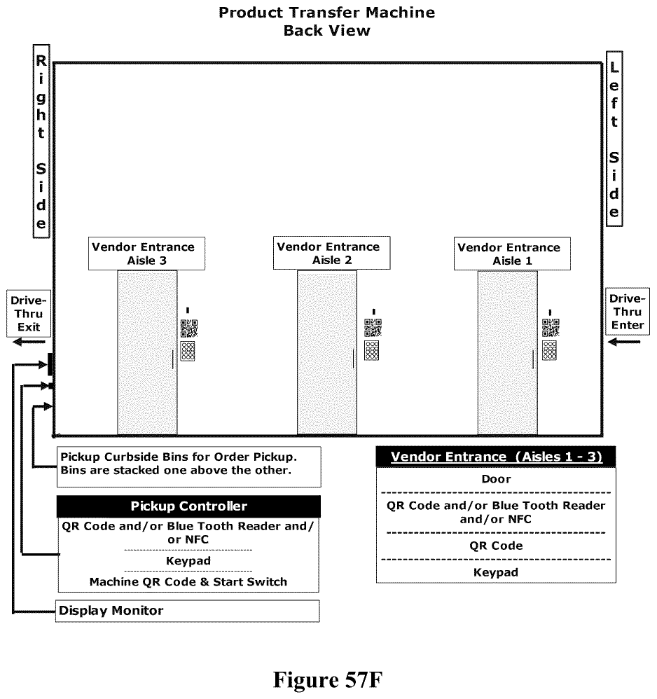

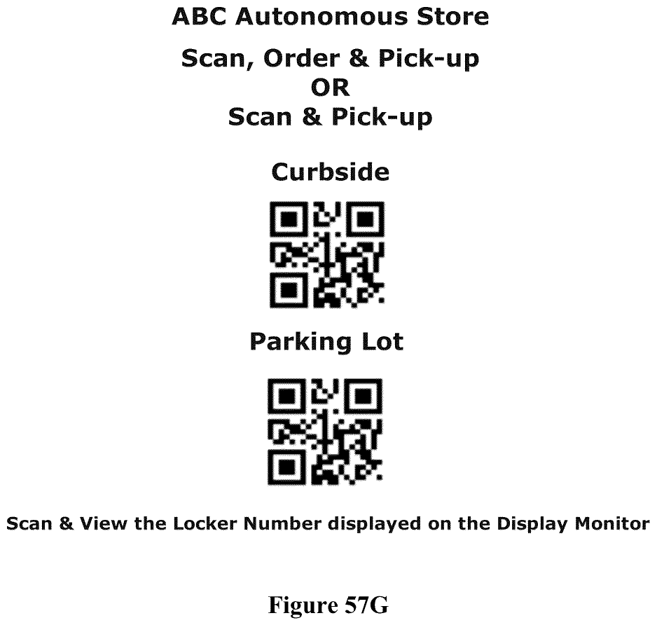

The various parts used in product transfer machines are shown in FIG. 57A. The various parts and location of each part in a product transfer machine using product transporters and intermediary transporter riding on rails as seen from top are shown in FIG. 57B. The various parts and location of each part in a product transfer machine using product transporters and intermediary transporter mounted on robots as seen from top are shown in FIG. 57C. The various parts and location of each part in a product transfer machine as seen from front (drive-thru lane) are shown in FIG. 57D. In some embodiments, driveway with sprint-thru lockers may be used instead of drive-thru lane so that more lockers can be placed. The various parts and location of each part in a product transfer machine as seen from curbside are shown in FIG. 57E. The various parts and location of each part in a product transfer machine as seen from back side are shown in FIG. 57F.

Any registered vendor can have access to enter any aisle of product transfer machines through secured doors. Each secured door can lead the authorized vendors to an aisle where product bins are located. Secured doors with mechanical and/or electronic locks are placed at the back side of the product transfer machines. The details of locks securing the doors are beyond the scope of this invention. It is sufficient to mention that the vendor entrance doors are secured and provide access for vendors to enter. Vendors can stock products into product bins and can maintain the inventory in each product bin using a mobile app issued by intermediary agent or interfaced with intermediary agent or using a web site maintained by intermediary agent or interfaced with intermediary agent. Vendors may also get notification when the inventory in a product bin reaches below a certain level. Vendors can enter the product transfer machine using the secured doors at the back side of the product transfer machine as shown in FIG. 57F. Vendors can access one or more product bins designated for any specific product. The designated product bin or bins for any specific product is stored in the machine bin content table as shown in FIG. 54. The location of any specific bin is stored in the machine bin table as shown in FIG. 54. Upon knowing the aisle number, and bin identifier, vendor can enter the product transfer machine and stock the product in product bins and can update the inventory in the machine bin inventory table as shown in FIG. 54. Machine owners, employees and vendors can maintain the inventory in machine bin inventory table.

Customers can place orders remotely or at the location using an app issued by any order management system or interfaced with any order management system server or using a web site hosted any order management system or interfaced with any order management system server.

The intermediary agent would also provide an interface for the order management system to receive product identifiers and the inventory of product identifiers. The order management system will also provide an interface for the intermediary agent to receive order details and to send notification when products are moved to pick up bins. Providing the details about the order management system is beyond the scope of this invention. It is sufficient to mention that customers can place orders with any order management system, where the order management system has the interface with the intermediary agent to receive order identifiers and inventory of order identifiers and the intermediary agent has the interface to receive order details, to send notification when products are moved to pick up bins and to send notification when inventory level falls below certain level in any product bin.

Products in orders will be moved to order pickup bins only when order pickup customers are ready to pick up the orders. The product transfer machines would provide a pickup controller at the curbside for order pickup customers to input order identifier to indicate that a customer of a specific order is ready to pick up as shown in FIG. 57A. The pickup controller, consisting of QR Code, keypad, start switch and a reader will be easily accessible for customers to place an order and sign-in to pickup or to sign-in to pickup an already placed order. The reader would be capable of receiving data from QR Code and/or RFID and/or NFC and the like. The pickup controller is also referred to as pickup ready controller or order pickup ready controller. The pickup controller is placed at the front side of the product transfer machine as shown in FIGS. 57B, 57C, 57D and 57E. The product transfer machine can also display QR Codes printed on iPosters in parking lots as shown in FIG. 57D. The QR Code in parking lot pickup iPoster is like QR Code in pickup controller, but with different content. Parking lot pickup iPoster can be displayed at each parking space in drive-thru lane and at each parking space in parking lot. The QR Code in the pickup controller and the QR Code in parking lot pickup iPoster can be used by the customers to place an order and sign-in to pick up or to sign-in to pick up an already placed order as shown in FIG. 57G.

Customers arriving at the curbside of the location without placing an order in advance can scan the QR Code in the pickup controller placed at the curbside, select the option to place an order and place an order with an order management system. Customers arriving at the parking lot of the location without placing an order in advance can scan the QR Code in the parking lot pickup iPoster placed at the drive-thru lane or at any parking spot, select an option to place an order and place an order with an order management system.

After placing an order remotely in advance or at the location, the customer at the location intended to pick up the order at the curbside, would let the reader in the pickup controller to capture a QR Code received from the order management system or enter a code received from the order management system in the keypad in the pickup controller and activate the switch in the pickup controller or scan a QR Code in the pickup controller and enter a code received from the order management system in a web site to let the intermediary agent know that the customer is ready to pick up an order at the curbside.

When the customer lets the reader in the pickup controller to capture a QR Code received order management system, the pickup controller would automatically send a request to the intermediary agent with an application identifier of 347.

When the customer enters a code received from the order management system in the keypad in the pickup controller and activate the switch in the pickup controller the pickup controller would automatically send a request to the intermediary agent with an application identifier of 347.

When the customer scans the QR Code in the pickup controller and enters an order identifier received from the order management system in a web site, then the web site would send a request to the intermediary agent with an application identifier encoded in the QR Code which may be 367.

In case the customer is accessing the product transfer machine from curbside, the customer would activate the switch in the pickup controller so that the pickup controller would request the delivery controller to move the products from product bins to order pickup bins. The delivery controller would also periodically move the products from product bins to order pickup bins without receiving a request from pick up controller.

After placing an order remotely in advance or at the location, the customer at the location intended to pick up the order in the parking lot, would scan a QR Code in the parking lot pickup iPoster and enter an order identifier received from the order management system in a web site to let the intermediary agent to know that the customer is ready to pick up an order at the parking lot, then the web site would send a request to the intermediary agent with an application identifier encoded in the QR Code which may be 387.

The various details of product transfer machine such as product bins, intermediary bins, order pickup bins at the curbside, order pickup bins at drive-thru lane, display monitors, pickup iPosters, pickup controller, delivery controller, product controllers, intermediary controller, product transporters, intermediary transporter and the like are shown in FIGS. 57A, 57B, 57C, 57D, 57E, 57F and 57G. FIG. 57A relates to various parts used in a typical product transfer machine, FIG. 57B relates to transporters using rails, FIG. 57C relates to transporters using robots, FIG. 57D relates to layout of various components of product transfer machine as seen from front side (drive-thru side), FIG. 57E relates to layout of various components of product transfer machine as seen from curbside, 57F relates to layout of various components of product transfer machine as seen from back side and 57G relates to QR Code to place an order and sign-in to pick up or to sign-in to pick up an already placed order used in product transfer machine.

To move products and to let the order pick up customers to pick up orders, the product transfer machines use pickup controller, iPoster, delivery controller, product controller, product transporter, intermediary controller and intermediary transporter. The pickup controller will be placed at the curbside and will have a reader to read an order identifier, a keypad to accept an order identifier, a QR Code that can be scanned to enter an order identifier in a web site and a start switch where the pickup controller can be activated. The iPoster will be placed at the drive-thru lane or at parking spots and will have a QR Code that can be scanned to enter an order identifier in a web site. The delivery controller will have wired and/or wireless connections with the product controller placed in the aisles that would direct the rails or robots carrying product transporters, product movers inside product transporters and product movers inside product bins. The delivery controller will have wired and/or wireless connections with intermediary controller that would direct the rail or robot carrying intermediary transporters, product movers inside intermediary bins and product movers inside intermediary transporters. Product movers inside intermediary bins would move products from intermediary bins into an intermediary transporter whereas product movers inside an intermediary transporter would move products from intermediary transporter into pickup bins.

Delivery controller is embedded with programmable firmware where the programs can be downloaded into the firmware. Delivery controller firmware will be programmed to send a inquire request to the intermediary agent, receive a response with from-bin and to-bin information, direct product controller and intermediary controller to move products from from-bin to to-bin and then send an update request to the intermediary agent so that the intermediary agent can update the information. Each bin will have x-position and y-position where x-position is positioned from the home position in x-direction and y-position is position from the home position in y-direction. For example, the request will be 72,36,144,18 to move products from a bin located at 72 inches from transporter home position in x-direction and 36 inches from transporter home position in y-direction to a bin located at 144 inches from transporter home position in x-direction and 18 inches from transporter home position in y-direction.

The intermediary agent will use machine bin move header table and machine bin move detail table to store individual product movement in any order detail received from order management system. When an inquire request is received, the intermediary agent will retrieve the information from machine bin move header table and machine bin move detail table. When an update request is received, the intermediary agent would update the information from machine bin move header table and machine bin move detail table.

The product controller and intermediary controller will also have programmable firmware where the programs can be downloaded into the firmware. These programs would accept the request from the delivery controller and move the products as per the request.

For the delivery controller to send requests to product controllers and to intermediary controller, the delivery controller must know the layout details of individual bins in the product transfer machine. The layout details of individual bins may change from time to time. To get the bin current layout details from the intermediary agent, a download switch will be added to the delivery controller. When the download switch is activated, the firmware in the delivery controller will download the current bin layout details from intermediary agent into the firmware's database. The firmware's database may have a table like machine table and machine bin table in product transfer database as shown in a class diagram in FIG. 54.

Pickup controller and delivery controller are also embedded with communication hardware and software to communicate with the intermediary agent.

The pickup controller would send an order identifier to intermediary agent when pickup controller receives an order identifier through reader or through keypad. If the order identifier is valid, then the intermediary agent would insert a row in machine order queue table using order identifier with a status of ‘P’. Whenever the pickup controller sends an order identifier successfully through the reader or keypad or when the switch connected to the pickup controller is activated, the pickup controller would also request delivery controller to process pending orders in machine order queue table.

The web site accepting the content of the QR Code in the pickup controller would also send an order identifier to intermediary agent when the web site receives an order identifier. If the order identifier is valid, then the intermediary agent would insert a row in machine order queue table using order identifier with a status of ‘P’. When the pickup customer sends an order identifier through the QR Code then the pickup controller cannot request delivery controller to process pending order in machine order queue table. The delivery controller will also periodically check the machine order queue table and process order identifiers being in ‘P’ status. When delivery controller begin processing order identifiers that are in ‘P’ status in machine order queue table, the status of order identifiers in machine order queue table will be updated to ‘A’. When an order pick up customer picks up an order the status of the order identifier that is being picked up in machine order queue table will be updated to ‘I’.

The delivery controller would receive move type, from-bin and to-bin information in response to inquire requests from intermediary agent and then would direct a product controller to move the product from a product bin (from-bin) to an intermediary bin (to-bin) or direct intermediary controller to move the products from an intermediary bin (from-bin) to an order pickup bin (to-bin) depending on move type.

The product transporter and the product bins would have a product mover placed inside. The product mover can be any device that can move products such as endless belt or spiral wire or rollers to push the products outward and the like. The product bins will have openings on only one side and the product mover inside the product bins can move the products only in one direction. The product transporter will have openings on both sides and the product mover inside the product transporter can move the products in both directions.

The product controller can have wired or wireless connections with product mover inside the product bins. The product controller would control the movement of the product mover inside each individual product bin independently. The product controller can have wired or wireless connections with product movers inside the product transporter when the product transporter is mounted on rails. The product controller can have wireless connections with product movers inside product transporter when the product transporter is mounted on robots. The product controller would control the movement of product transporter, the movement of product mover placed inside the product transporter and the movement of product mover placed inside the product bins. The product mover can move the products only for a distance not exceeding the depth of the product bins or the depth of a product transporter, whichever is less.

The intermediary controller can have wired or wireless connections with intermediary transporter when the intermediary transporter is mounted on rails. The intermediary controller can have wireless connections with intermediary transporter when the intermediary transporter is mounted on robots. The intermediary controller will give directions to rails when the intermediary transporter is mounted on rails. The intermediary controller will give directions to robots when the intermediary transporter is mounted on robots.

If a product transfer machine is fitted with rails to move products, then the product controller in aisles will direct the rail in respective aisle to move products from a product bin to an intermediary bin. For example A1 Controller would direct A1 Rail, A2 Controller would direct A2 Rail and so on. If a product transfer machine is fitted with robots to move products, then the product controller in aisles will direct the robot in respective aisle to move products from a product bin to an intermediary bin. For example A1 Controller would direct A1 Robot, A2 Controller would direct A2 Robot and so on.

If a product transfer machine is fitted with rail to move products, then the intermediary controller in intermediary aisle will direct the intermediary rail to move products from intermediary bins to an order pickup bin. If a product transfer machine is fitted with robot to move products, then the intermediary controller in intermediary aisle will direct the intermediary robot to move products from intermediary bins to an order pickup bin.

If a product transporter or intermediary transporter uses a rail, then the respective transporter will ride on respective rail. If a product transporter or intermediary transporter uses a robot, then the respective transporter will be mounted on a collapsible platform which in turn will be mounted on respective robot.

When a product is moved, the intermediary agent would update the information in machine bin move header table and machine bin move detail table.

When a product is moved from a product bin, the intermediary agent would insert a row in machine bin inventory table in intermediary agent's database with new inventory information so that the information in the machine bin inventory table will always be up to date.

When a product is moved into an intermediary bin, the intermediary agent would insert a row in machine bin content table in intermediary agent's database using order identifier as new content identifier so that the information in the machine bin content table will always be up to date. This would enable the intermediary agent to use any intermediary bin only for a single order.

When a product or products are moved from an intermediary bin, the intermediary agent would insert a row in machine bin content table in intermediary agent's database using blank as new content identifier so that the information in the machine bin content table will always be up to date. This would enable the intermediary agent to use the intermediary bin for a new order.

When a product is moved into a pickup bin, the intermediary agent would insert a row in machine bin content table in intermediary agent's database using order identifier as new content identifier so that the information in the machine bin content table will always be up to date. This would enable the intermediary agent not to use the pickup bin for any order until the order is picked up from the pickup bin.

When an order is picked up from a pickup bin, the locker management system would notify the order management system that an order has been picked up from a locker and the order management system in turn would request the intermediary agent to insert a row in machine bin content table in intermediary agent's database using blank as new content identifier so that the information in the machine bin content table will always be up to date. This would enable the intermediary agent to use the pickup bin for a new order.

At any event, vendors stock products in product bins and/or update the inventory, buyers input order identifier in pickup controller reader or key pad or using QR Code or buyers input order identifier using QR Code in iPoster, delivery controller periodically and when a request is received from pickup controller through start switch would move products from product bins to intermediary bins and from intermediary bins to order pickup bins and buyers would pick up products from order pickup bins.

Order recipients will always be able to pick up orders outside without entering stores, at the curbside and at the drive-thru 24 hours a day and 7 days a week.

More than one order recipient would be able to pick up orders at the same time.

Merchants will always be able to keep autonomous stores open 24/7 without employees handling products.

Vendors, order recipients, owner clients and employee clients would use services provided by intermediary agent to maintain the required information in various databases for QR Automation for product transfer automation to work:

Owner clients and/or employee clients using any web site maintained by intermediary agent can maintain data in various tables in product transfer database as shown in a class diagram in FIG. 54.

Owner clients would register as operators and maintain their contact, location, employee, and machine identifier with an intermediary agent. Intermediary agent would use product transfer database to store the information.

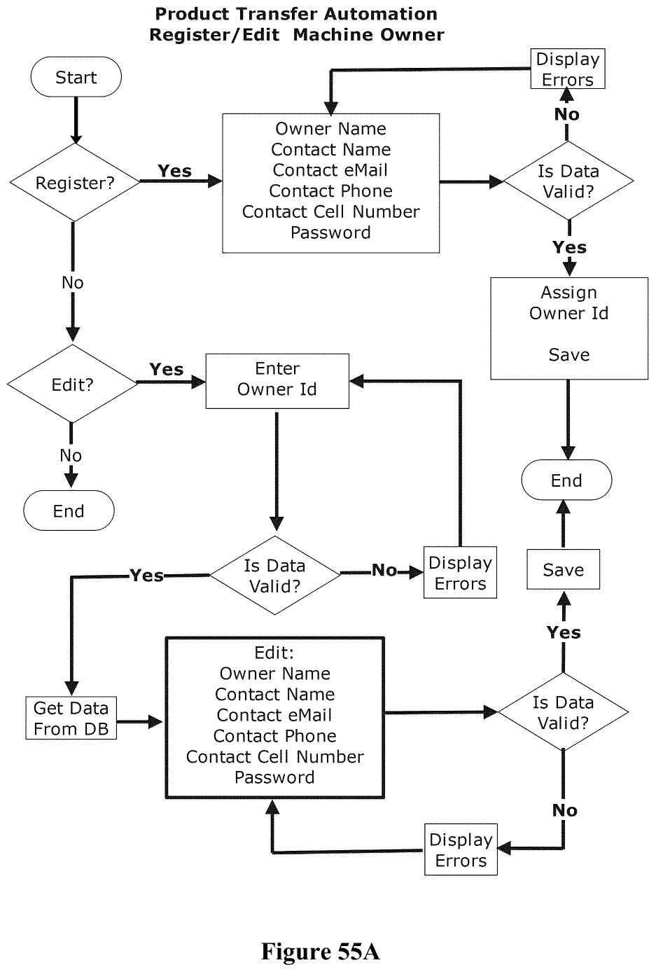

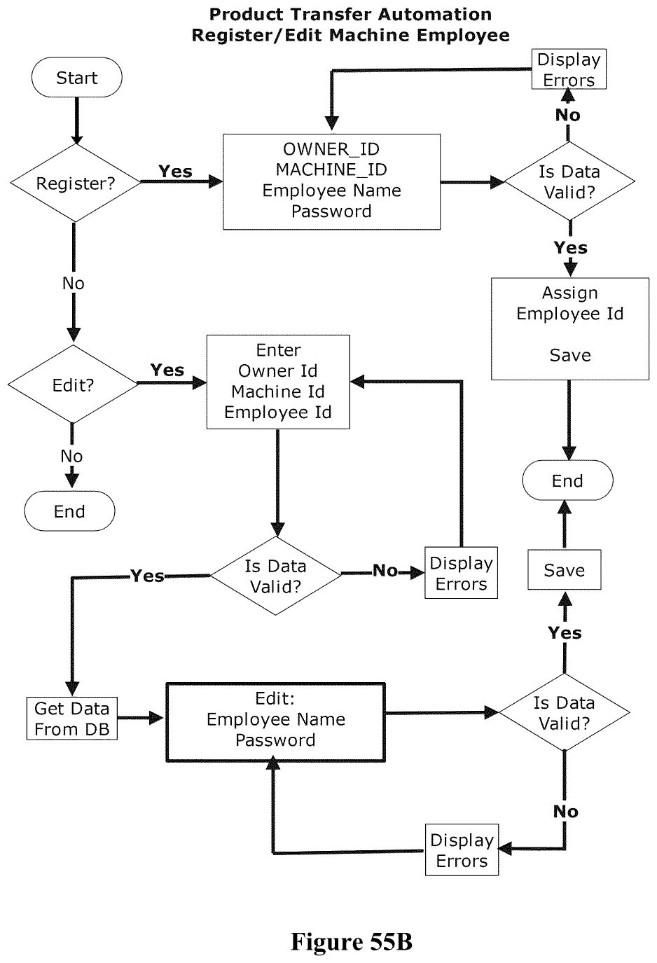

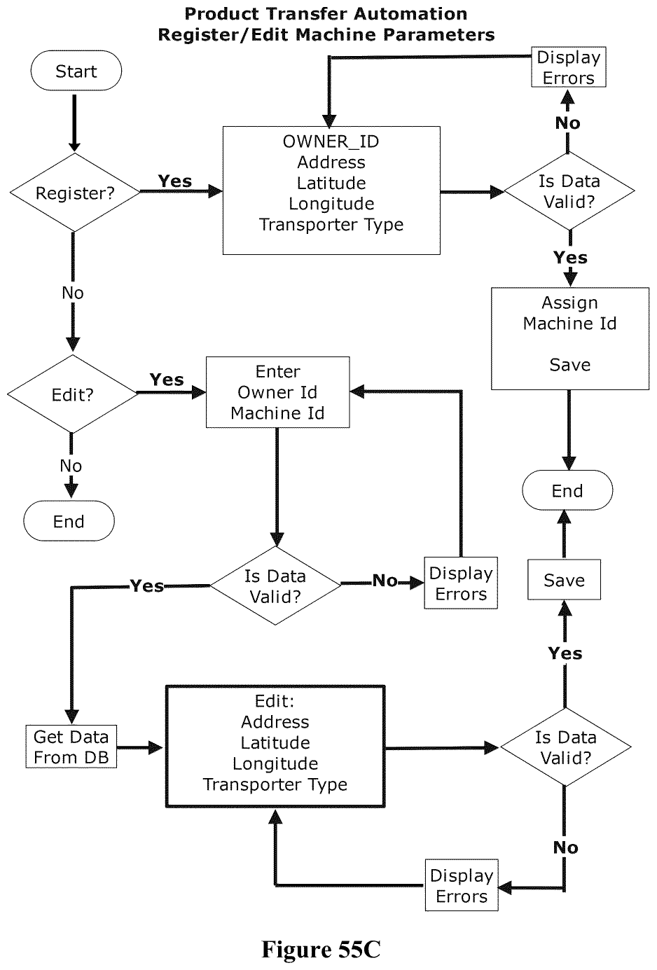

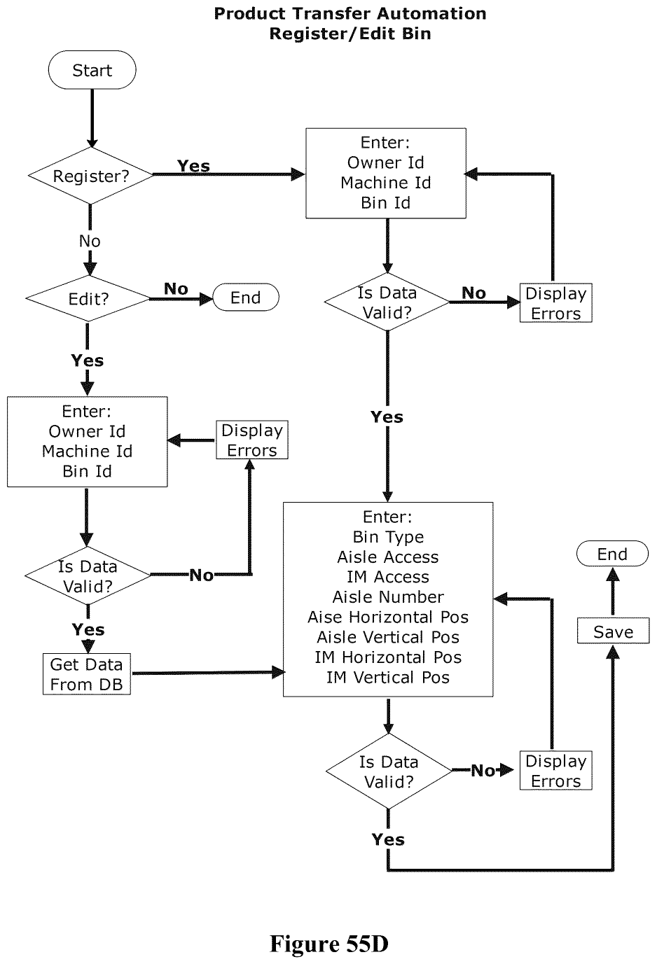

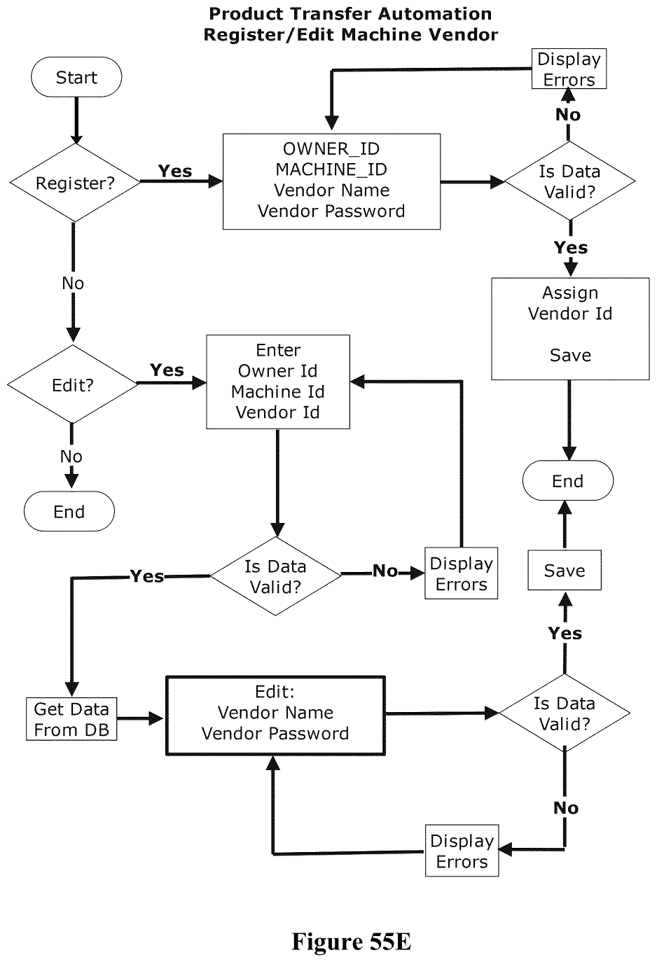

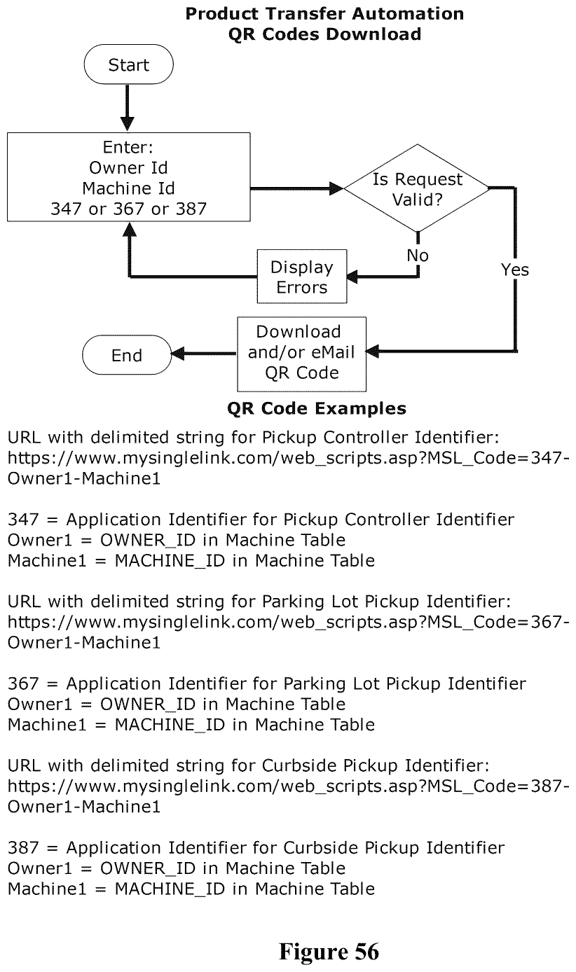

Owner clients would register as owners and edit their information as owner clients, owner clients would also add and edit employees, location, bin and vendor information with the intermediary agent as shown in flowcharts in FIGS. 55B, 55C, 55D and 55E. Machine owners would also download and display a unique QR Code for pickup controller identifier and a unique QR Code for parking lot identifier for each machine location as shown in flowchart in FIG. 56.

Owner clients can register using an owner registration web form provided by intermediary agent using ‘A’ for action. Intermediary agent would assign a unique value for owner identifier and capture values for owner name, contact name, contact email, contact phone, contact cell and password as shown in FIG. 55A. If the values are valid then the intermediary agent would insert a row into machine owner table using owner identifier for OWNER_ID, owner name for OWNER_NAME, contact name for CONTACT_NAME, contact email for CONTACT_EMAIL, contact phone for CONTACT_PHONE, contact cell for CONTACT_CELL, password for PASSWORD and ‘N’ for LOGGED_YN. Machine owners can edit their information using owner registration web form provided by intermediary agent using ‘E’ for action. When machine owners maintain their information, the intermediary agent would use a password to verify the machine owners. Intermediary agent would capture values for owner identifier, owner name, contact name, contact email, contact phone, contact cell and password as shown in FIG. 55A. If the values are valid then the intermediary agent would update a row in machine owner table as shown in a class diagram as shown in FIG. 54 using owner identifier for OWNER_ID, owner name for OWNER_NAME, contact name for CONTACT_NAME, contact email for CONTACT_EMAIL, contact phone for CONTACT_PHONE, contact cell for CONTACT_CELL, password for PASSWORD and ‘N’ for LOGGED_YN. Registered machine owners will be referred to as machine owners or product machine transfer owners.

Machine owners can add a machine or edit machine parameters using a machine registration web form as shown in FIG. 55C. Machine owners can add a machine using a machine registration web form provided by intermediary agent using ‘A’ for action. Machine owners can also edit machine parameters using a machine registration web form provided by intermediary agent using ‘E’ for action. When a machine is added, the intermediary agent would assign a unique value for the machine identifier. When machine parameters are edited, the intermediary agent would use a password to verify the machine owners. When machine parameters are edited, machine owners provide the machine identifier for which the parameters are edited. Intermediary agent would capture values for owner identifier, ADDRESS, LATITUDE, LONGITUDE, TRANSPORTER_TYPE as shown in FIG. 55C. If the machine uses rails to move the product transporter, then the value for TRANSPORTER_TYPE would be ‘R’, otherwise it will be ‘B’ to denote that it is a robot. Machine owners and/or employees can maintain the information in machine table.

Machine owners can add an employee or edit employee information using an employee registration web form as shown in FIG. 55B. Machine owners can add an employee using an employee registration web form provided by intermediary agent using ‘A’ for action. Machine owners can also edit employee information using a employee registration web form provided by intermediary agent using ‘E’ for action. When an employee is added, the intermediary agent would assign a unique value for employee identifier for each employee under each owner identifier and under each machine identifier. When employee information is added or edited, the intermediary agent would use a password to verify the user. When employee information is edited, machine owners provide the employee identifier. Intermediary agent would insert/update a row in machine employee table using owner identifier for OWNER_ID, machine identifier for MACHINE_ID, unique employee identifier for EMPLOYEE_ID and values captured from machine owners and/or employees for EMPLOYEE_NAME for PASSWORD and ‘N’ or LOGGED_YN. Machine owners can add and edit the information in machine employee table whereas employees can maintain only their own information in machine employee table.

Machine owners can add a vendor or edit vendor information using a vendor registration web form as shown in FIG. 55E. Machine owners can add a vendor using a vendor registration web form provided by intermediary agent using ‘A’ for action. Machine owners can also edit vendor information using a vendor registration web form provided by intermediary agent using ‘E’ for action. When a vendor is added, the intermediary agent would assign a unique value for vendor identifier for each vendor under each owner identifier and under each machine identifier. When vendor information is added or edited, the intermediary agent would use a password to verify the user. When vendor information is edited, machine owners provide the vendor identifier. Intermediary agent would insert/update a row in machine vendor table using owner identifier for OWNER_ID, machine identifier for MACHINE_ID, unique vendor identifier for VENDOR_ID and values captured from machine owners and/or employees for VENDOR_NAME and VENDOR_PASSWORD. Registered vendors can also maintain their own information in machine vendor table.

Machine owners can add a bin or edit bin information using a bin registration web form as shown in FIG. 55D. Machine owners can add a bin using a bin registration web form provided by intermediary agent using ‘A’ for action. Machine owners can also edit bin information using a bin registration web form provided by intermediary agent using ‘E’ for action. When a bin is added, the intermediary agent would insert a row into machine bin table. When bin information is edited, the intermediary agent would update a row into machine bin table. When bin information is added or edited, the intermediary agent would use a password to verify the user. Intermediary agent would insert/update a row in machine bin table using owner identifier for OWNER_ID, machine identifier for MACHINE_ID, values captured from owners and/or employees for BIN_ID, BIN_TYPE, AISLE_ACCESS_YN, IM_ACCESS_YN, AISLE_NUMBER, AISLE_HORIZONTAL_POSITION, AISLE_VERTICAL_POSITION, IM_HORIZONTAL_POSITION, and IM_VERTICAL_POSITION. The valid value for BIN_ID will be a valid bin identifier as shown in FIGS. 57B and 57C. The valid value for BIN TYPE would be ‘P’ for product bins, ‘I’ for intermediary bins, ‘D’ for drive-thru pickup bins and ‘C’ for curbside pickup bins. The valid value for AISLE_ACCESS_YN would be ‘Y’ or ‘N’. If AISLE_ACCESS_YN is values ‘Y’, then the for AISLE_NUMBER, AISLE_HORIZONTAL_POSITION and AISLE_VERTICAL_POSITION will greater than 0, otherwise they will be 0. The valid value for IM_ACCESS_YN would be ‘Y’ or ‘N’. If IM_ACCESS_YN is ‘Y’, then the values for IM_HORIZONTAL_POSITION and IM_VERTICAL_POSITION, will be greater than 0, otherwise they will be 0. AISLE_HORIZONTAL_POSITION and AISLE_VERTICAL_POSITION are the distances that the product transporter must move in horizontal and vertical directions respectively from the product transporter home position to receive products from product bins or in order to move products into intermediary bins. Product transporter home position is the position where the product transporter will be parked when not being used. IM_HORIZONTAL_POSITION and IM_VERTICAL_POSITION are the distances that the intermediary transporter must move in horizontal and vertical directions respectively from the intermediary transporter home position to receive products from intermediary bins or in order to move products into drive-thru pickup bins or in order to move products into curbside pickup bins. Intermediary transporter home position is the position where the intermediary transporter will be parked when not being used.

Machine owners and employees can assign products to bins using a product assignment web form. Intermediary agent would insert a row into machine bin content table. When products are assigned, the intermediary agent would use a password to verify the user. Intermediary agent would capture owner identifier, machine identifier, bin identifier and product identifier from the user. Then the intermediary agent would verify the bin identifier by retrieving a single row from machine bin table using owner identifier for OWNER_ID, machine identifier for MACHINE_ID, bin identifier for BIN_ID and ‘P’ for BIN TYPE. If the intermediary agent cannot retrieve a single row, then the intermediary agent would display an error and terminate the process. Then the intermediary agent would retrieve the latest single row from machine bin content table using owner identifier for OWNER_ID, machine identifier for MACHINE_ID, bin identifier for BIN_ID and BIN_SEQ is equal to (maximum of (BIN_SEQ) for the same OWNER_ID, MACHINE_ID and BIN_ID). If the intermediary agent can retrieve one row from machine bin content table, then the intermediary agent would save the values of BIN_SEQ plus 1 as new bin sequence, otherwise the intermediary agent would save 1 as new bin sequence. Then the intermediary agent would insert a row into machine bin content table using owner identifier for OWNER_ID, machine identifier for MACHINE_ID, bin identifier for BIN_ID, new bin sequence for BIN_SEQ and product identifier for CONTENT_IDENTIFIER.

Machine owners and employees can also set product inventory in bins using a product inventory web form. Intermediary agent would insert a row into machine bin inventory table. In some embodiments, vendors can also set product inventory. When product inventory are set up, the intermediary agent would use a password to verify the user. Intermediary agent would capture owner identifier, machine identifier, bin identifier and net count from the user. Then the intermediary agent would verify the bin identifier by retrieving a single row from machine bin table using owner identifier for OWNER_ID, machine identifier for MACHINE_ID, bin identifier for BIN_ID and ‘P’ for BIN TYPE. If the intermediary agent cannot retrieve a single row, then the intermediary agent would display an error and terminate the process. Then the intermediary agent would retrieve the latest single row from machine bin inventory table using owner identifier for OWNER_ID, machine identifier for MACHINE_ID, bin identifier for BIN_ID and BIN_SEQ is equal to (maximum of (BIN_SEQ) for the same OWNER_ID, MACHINE_ID and BIN_ID). If the intermediary agent can retrieve one row from machine bin content table, then the intermediary agent would save the values of BIN_SEQ plus 1 as new bin sequence, otherwise the intermediary agent would save 1 as new bin sequence. Then the intermediary agent would insert a row into machine bin inventory table using owner identifier for OWNER_ID, machine identifier for MACHINE_ID, bin identifier for BIN_ID, new bin sequence for BIN_SEQ, 0 for RESERVED_COUNT and net count for NET_COUNT. Before continuing, however, it is noted that machine owners, employees and vendors can set NET_COUNT only when the RESERVED_COUNT is 0 in the machine bin inventory table for the bin where the NET_COUNT is updated. Also to inactivate a bin, the NET_COUNT in the machine bin inventory table for the bin to be inactivated can be set to 0. This will ensure that the current orders will be processed without any interruption.

Machine owners can add bin locker sync or edit bin locker sync information using a bin locker sync registration web form. Machine owners can add a bin locker sync using a bin locker sync registration web form provided by intermediary agent using ‘A’ for action. Machine owners can also edit bin locker sync information using a bin locker sync registration web form provided by intermediary agent using ‘E’ for action. When a bin locker sync is added, the intermediary agent would insert a row into machine bin locker sync table. When bin locker sync information is edited, intermediary agent would update a row into machine bin locker sync table. When bin locker sync information is added or edited, the intermediary agent would use a password to verify the user. Intermediary agent would insert/update a row in using owner identifier for OWNER_ID, machine identifier for MACHINE_ID, values captured from owners and/or employees for BIN_ID, LOCKER INTERNAL IDENTIFIER and for LOCKER_EXTERNAL_IDENTIFIER. BIN_ID can only be a valid BIN_ID from machine bin table where BIN_TYPE is ‘D’ or ‘C’. Value for LOCKER_INTERNAL_IDENTIFIER will be provided by locker system operator whereas LOCKER_EXTERNAL_IDENTIFIER will be provided by the machine owners.

Machine owners and employees can provide the owner identifier and machine identifier to product machine manufacturer so that the required software would be loaded into the firmware used in product transfer machine.

Machine owners and employees can download the QR Codes as shown in FIG. 56. Machine owners and employees would attach the pickup controller identifier QR Code to pick up controller at curbside. Machine owners and employees would display the parking lot identifier QR Code at parking spaces in parking lot.

Machine owners and employees can activate the update switch in the delivery controller as needed to download the bin mapping information stored in machine table, and in machine bin table in product transfer database. Machine owners and employees would activate the update switch in the delivery controller before starting the operation and whenever the data in any one of the bin mapping information tables (machine table and machine bin table) is modified.

Product transfer machines come in two (2) types, namely product transfer machine with rails, product transfer machine with robots. All the machine types have four (4) types of controllers namely pickup controller, delivery controller, product controller and intermediary controller. All the controllers have firmware and loading of appropriate software into the firmware is required. The software loaded into the controller firmware would include a URL to communicate with the intermediary agent. At a minimum, the URL would include the intermediary agent server information namely owner identifier and machine identifier. The delivery controller would also have a database in the firmware with machine table and machine bin table like machine table and machine bin table in product transfer database in intermediary agent server as shown in a class diagram in FIG. 54. Once appropriate software is loaded into the four (4) controllers' firmware, the owner and/or employee clients can download the machine table and machine bin table information into the delivery controller database by activating a switch provided with the delivery controller. The information in machine table and machine bin table will be used by the delivery controller to move the products from a from-bin to a to-bin.

Once all the required information has been set up in the product transfer database, the product transfer machine will be ready to use.

Pickup customers and vendors would use QR Code for Product Transfer Automation system, to automate front and back of operations to handle pick up orders where vendors stock product bins with products and pick up customers can pick-up orders 24/7 from electronic lockers placed at the curbside and at the drive-thru lane or at parking spaces in parking lot.

Vendors would stock up products in product bins. Vendors can access product bins through a secured door leading to individual aisles where product bins are stacked one above the other and next to each other. Machine owners, employees and vendors can also update the inventory in the machine bin inventory table using an app or a web site.

Pickup customers can place orders remotely before arriving at the location or place orders at the location after arriving at the location. To place an order at the location, customers would scan a QR Code displayed in the pickup controller at the curbside or scan a QR Code displayed in iPoster at the drive-thru lane and/or at parking spots in the parking lot.

When the intermediary agent processes pending requests in order pickup queue, the products for a specific order will be moved from product bins to intermediary bins and from intermediary bins to a pickup bin. When all the products for an order are moved to a pickup bin, the order management system will be notified and the display monitor would display order identifier (without one-time code. if one-time is included in order identifier) and the electronic locker external number. At the location, the pickup customer would get the electronic locker external number that matches their order identifier or name from the display monitor. If an order identifier is displayed and if the order identifier also includes one-time code, then only partial order identifier without the one-time code may be displayed on the display monitor. If the order identifier or the name is not displayed in the display monitor, then the pickup customer would enter the order identifier in the keypad connected to order pickup controller or scan a QR Code displayed on the order pickup controller and enter the product identifier in a web page. If the order identifier or the name is not displayed in the display monitor, the pickup customer can activate the switch connected to the order pickup controller which would add the order identifiers into order pickup queue and trigger the delivery controller to process pending requests in order pickup queue by communicating with the intermediary agent. The delivery controller would also periodically process pending requests in order pickup queue without the activation of switch connected to the order pickup controller.

Upon finding out the electronic locker external number, the pickup customer would enter the one-tine code received from the order management system or printed on sales receipt or follow the instructions posted near the electronic locker to open the electronic locker and pick up the order. As an alternative, the pickup customer can also use a mobile wallet app to scan a QR Code displayed on the electronic locker and use a fingerprint or face id or any biometric data to authenticate, open the locker and pick up the order.

The intermediary agent would receive the requests from pickup customer through user interface, from pickup and delivery controllers through controller gateway and would use application components and application components in turn would use database server to insert, update or retrieve rows from tables in product transfer database as shown in a class diagram in FIG. 54.

Intermediary agent, user interface, controller gateway, application servers, database servers, databases are only examples and any number of agents, controller gateways, application servers, database servers and databases can be used.

First and foremost, the request handler would categorize the request received through user interface and through controller gateway into different categories namely pickup iPoster data, pickup controller data and delivery controller data. The request handler would use DATA_CATEGORIZATION_PROCESS to categorize the data and would direct the request to DRIVE_THRU_PICKUP_PROCESS or CURBSIDE_PICKUP_PROCESS or PICKUP_CONTROLLER_PROCESS or DELIVERY_CONTROLLER_INQUIRE_PROCESS, or DELIVERY_CONTROLLER_UPDATE_PROCESS or DELIVERY_CONTROLLER_DISPLAY_PROCESS based on the categorization of the received data. DRIVE_THRU_PICKUP_PROCESS, CURBSIDE_PICKUP_PROCESS, PICKUP_CONTROLLER_PROCESS, DELIVERY_CONTROLLER_INQUIRE_PROCESS, DELIVERY_CONTROLLER_UPDATE_PROCESS and DELIVERY_CONTROLLER_DISPLAY_PROCESS are only examples, and any number of processes can be used. DRIVE_THRU_PICKUP_PROCESS, CURBSIDE_PICKUP_PROCESS, PICKUP_CONTROLLER_PROCESS, DELIVERY_CONTROLLER_INQUIRE_PROCESS, DELIVERY_CONTROLLER_UPDATE_PROCESS and DELIVERY_CONTROLLER_DISPLAY_PROCESS are further described in greater detail herein.

It is beyond the scope of this invention to fully describe all the information that can be included in the data received through user interface and through controller gateway. The information provided herein is only to illustrate how products stocked in product bins are transported to pick up bins when orders are received.

It is beyond the scope of this invention to fully describe all the user interfaces that can be included in the request handler, the content of data exchanged between pickup consumers and intermediary agent and the method of exchange between pickup consumers and intermediary agent. The information provided herein is only to illustrate how user interfaces can accept pickup ready information and transport products from product bins to pick up bins.

It is beyond the scope of this invention to fully describe all the electronic devices that can be installed in product transfer machines, the content of data exchanged between electronic devices and intermediary agent and the method of exchange between electronic devices and intermediary agent. The information provided herein is only to illustrate how electronic devices can monitor incoming orders and transport products from product bins to pick up bins.

### Data_Categorization_Process:

Data categorization process is an entry point for processing incoming data. If the data categorization process terminates before fully executing the data categorization process, the intermediary agent may notify product transfer machine owner and employees and/or display a message for termination reason. If the incoming data is received through user interface or controller gateway, then the process will continue, otherwise it will be terminated. The incoming data will have a request message identified by a request message identifier such as ‘MSL_CODE’ and the request message will have segments separated by segment identifier such as ‘-’ as shown in FIG. 56. If there are at least 3 segments in the request message, then the process will continue, otherwise it will be terminated. Then the request handler would segregate the first 3 segments in the request message as input application identifier, input owner identifier and input machine identifier. If the input application identifier is 347 or 367 or 387 or 307, then the process will continue, otherwise it will be terminated.

If the input application identifier is 347, then the request message will also have a value for the fourth segment which will be saved as input order identifier. If the input application identifier is 347 and if the request message does not have a value for the fourth segment, then the process will be terminated. If the input order identifier is blank, then the process will be terminated.

If the input application identifier is 367, then the request message will also have a value for the fourth segment which will be saved as input order identifier. If the input application identifier is 367 and if the request message does not have a value for the fourth segment, then the process will be terminated. If the input order identifier is blank, then the process will be terminated.

If the input application identifier is 387, then the request message will also have a value for the fourth segment which will be saved as input order identifier. If the input application identifier is 387 and if the request message does not have a value for the fourth segment, then the process will be terminated. If the input order identifier is blank, then the process will be terminated.

If the input application identifier is 307, then the request message will also have a value for the fourth segment which will be saved as input request type. If the input application identifier is 307 and if the request message does not have a value for the fourth segment, then the process will be terminated. If the input application identifier is 307, then the request handler would save the value in the fourth segment as input request type. If the input request type is ‘DI’ or ‘DU’ or ‘DD’, then the process will continue, otherwise it will be terminated.

If the process continues, then the request handler would verify the values of input owner identifier and input machine identifier. The request handler would retrieve the value for TRANSPORTER_TYPE from machine table using input owner identifier for OWNER_ID and input machine identifier for MACHINE_ID. If the request handler retrieves one row and if the value of TRANSPORTER_TYPE in the retrieved row is ‘R’ or ‘B’, then the request handler would save the value of TRANSPORTER_TYPE from the retrieved row in variable transporter type and the process will continue, otherwise it will be terminated.

If the application identifier is 347 and the data was received through controller gateway or if the application identifier is 367 and the data was received through user interface or if the application identifier is 387 and the data was received through user interface or if the application identifier is 307 and the data was received through controller gateway, then the process will continue, otherwise it will be terminated.

If the data categorization process continues and if the application identifier is 347 which identifies that the incoming data is from pickup controller, then the request handler would direct the request to PICKUP_CONTROLLER_PROCESS.

If the data categorization process continues and if the application identifier is 367 which identifies that the incoming data is from a web site that scanned the QR Code displayed on iPosters at parking lot, then the request handler would direct the request to DRIVE_THRU_PICKUP_PROCESS.

If the data categorization process continues and if the application identifier is 387 which identifies that the incoming data is from a web site that scanned the from QR Code displayed at curbside, then the request handler would direct the request to CURBSIDE_PICKUP_PROCESS.

If the data categorization process continues and if the application identifier is 307 which identifies that the incoming data is from delivery controller and if the request type is ‘DI’, then the request handler would direct the to request DELIVERY_CONTROLLER_INQUIRE_PROCESS.

Upon successfully executing DELIVERY_CONTROLLER_INQUIRE_PROCESS, the request handler would return a response message which will be a comma delimited message in the format of move type, from-bin, to-bin or the request handler would not return any response. If the delivery controller that submitted the request with a value of 307 for application identifier and with a value of ‘DI’ for request type receives a response message, the delivery controller would segregate the comma delimited response into move type, from-bin and to-bin. If the move type is ‘P’, then the delivery controller would direct the product controller to move the product from the from-bin (product bin) to the to-bin (intermediary bin). The product controller would in turn direct the product transporter to move the product from the from-bin to the to-bin. If the move type is ‘I’, then the delivery controller would direct the intermediary controller to move the product or products of an order from the from-bin (intermediary bin) to the to-bin (pickup bin). The intermediary controller would in turn direct the intermediary transporter to move the product or products of an order from the from-bin to the to-bin. Then the delivery controller would send a request in the format of 307-owner identifier-machine-DU to the intermediary agent so that the intermediary agent would execute DELIVERY_CONTROLLER_UPDATE_PROCESS. If the delivery controller that submitted the request with a value of 307 for application identifier and with a value of ‘DI’ for request type does not receive any response, then delivery controller will not do any further processing. This will ensure that all the orders will be processed by the delivery controller.

If the data categorization process continues and if the application identifier is 307 which identifies that the incoming data is from delivery controller and if the request type is ‘DU’, then the request handler would direct the request to DELIVERY_CONTROLLER_UPDATE_PROCESS.

Upon successfully executing DELIVERY_CONTROLLER_UPDATE_PROCESS, the request handler would return a response which will ‘Y’ or ‘N’ or the request handler would not return any response.

If the delivery controller that submitted the request with a value of 307 for application identifier and with a value of ‘DU’ for request type receives a response, then the delivery controller would send a request to the intermediary agent in the format of 307-owner identifier-machine-DD so that the intermediary agent would execute DELIVERY_CONTROLLER_DISPLAY_PROCESS. When the execution of DELIVERY_CONTROLLER_DISPLAY_PROCESS is completed the delivery controller will refresh the display monitor placed at the curbside as shown in FIG. 57B and marked as T1. The delivery controller will refresh the display monitors placed at the parking lot as shown in FIG. 57B and marked as T2 and T3. If the delivery controller receives a response, then the response will be in the format of an array with the column names order identifier, status, locker location type and locker external number. If the delivery controller receives a response, then the delivery controller would display the content of all rows in the response where the value of locker location type column is ‘Curbside’ on the display monitor placed at the curbside. If the delivery controller receives a response, then the delivery controller would display the content of all rows in the response where the value of locker location type column is ‘Drive-Thru’ on the display monitors placed at the parking lot.

If the delivery controller that submitted the request with a value of 307 for application identifier and with a value of ‘DU’ for request type receives a response and if the response is ‘Y’, then the delivery controller would send a request to intermediary agent with a request message in the format 307-owner identifier-machine identifier-DI so that the intermediary agent would execute DELIVERY_CONTROLLER_INQUIRE_PROCESS again.

If the delivery controller that submitted the request with a value of 307 for application identifier and with a value of ‘DU’ for request type receives a response and if the response is ‘N’ or does not receive any response, then the delivery controller will not do any further processing.

### Pickup_Controller_Process:

Pickup controller process is an entry point for processing the data received from pickup controller through controller gateway. If the pickup controller process terminates before fully executing the pickup controller process, the intermediary agent may notify product transfer machine owner and employees and/or display a message for termination reason.

If the request handler is directed to pick up controller process by data categorization process, then the pickup controller process will continue, otherwise it will be terminated.

If the pickup controller process continues the request handler would insert a new row into machine order queue table. But, before inserting a new row, the request handler would verify that the input order identifier does not already exist in machine order queue table. The request handler would retrieve one row from machine order queue table using input owner identifier for OWNER_ID, input machine identifier for MACHINE_ID, ordering QUEUE_SEQ in descending order and input order identifier for ORDER_IDENTIFIER. If the request handler can retrieve one row, then the order identifier already exists in machine order queue table and the pickup controller process will terminate, otherwise it will continue.

The request handler would retrieve the value of QUEUE_SEQ from the latest row in machine order queue table using input owner identifier for OWNER_ID, input machine identifier for MACHINE_ID and QUEUE_SEQ in descending order. If the request handler can retrieve one row, then the request handler would save the value of QUEUE_SEQ plus 1 as new queue sequence, otherwise the request handler would save 1 as new queue sequence.

Then the request handler would insert a new row in machine order queue table using input owner identifier for OWNER_ID, input machine identifier for MACHINE_ID, new queue sequence for QUEUE_SEQ, ‘P’ for STATUS, input order identifier for ORDER_IDENTIFIER and ‘C’ for PICKUP BIN_TYPE because the order pickup will be from curbside.

If the insert is successful, then the request handler would end the process, otherwise it will be terminated.

If the process successfully ends, the pickup controller will receive a successful message and the pickup controller will request the delivery controller to start processing the orders that are in pending status. Upon receiving a request, the delivery controller would communicate with the intermediary agent to update the data in product transfer database using a request message in the format of application identifier-owner identifier-machine identifier-request type. An example of the request message would be 307-OwnerId-MachineId-DI.

### Drive_Thru_Pickup_Process:

Drive-thru pickup process is an entry point for processing the data received from a web site through user interface. If the drive-thru pickup process terminates before fully executing the drive-thru pickup process, the intermediary agent may notify product transfer machine owner and employees and/or display a message for termination reason.

If the request handler is directed to drive-thru pickup process by data categorization process, then the drive-thru pickup process will continue, otherwise it will be terminated.

If the drive-thru pickup process continues, then the request handler would insert a new row into machine order queue table. But, before inserting a new row, the request handler would verify that the input order identifier does not exist in machine order queue table. The request handler would retrieve one row from machine order queue table using input owner identifier for OWNER_ID, input machine identifier for MACHINE_ID, ordering QUEUE_SEQ in descending order and input order identifier for ORDER_IDENTIFIER. If the request handler can retrieve one row, then the input order identifier already exists in machine order queue table and drive-thru pickup process will terminate, otherwise it will continue.

If the drive-thru pickup process continues, the request handler would retrieve the value of QUEUE_SEQ from the latest row in machine order queue table using input owner identifier for OWNER_ID, input machine identifier for MACHINE_ID and QUEUE_SEQ in descending order. If the request handler can retrieve one row, then the request handler would save the value of QUEUE_SEQ plus 1 as new queue sequence, otherwise the request handler would save 1 as new queue sequence.

Then the request handler would insert a new row in machine order queue table using input owner identifier for OWNER_ID, input machine identifier for MACHINE_ID, new queue sequence for QUEUE_SEQ, ‘P’ for STATUS, input order identifier for ORDER_IDENTIFIER and ‘D’ for PICKUP BIN_TYPE because the order pickup will be from parking lot.

If the insert is successful, then the request handler would end the process, otherwise it will be terminated.

If the process successfully ends, the person who scanned the data to initiate the drive-thru pickup process will receive a successful message. The delivery controller will at periodical intervals start DELIVERY_CONTROLLER_INQUIRE_PROCESS. Also, when the pickup controller switch placed at the curbside is activated, the pickup controller will request the delivery controller to start DELIVERY_CONTROLLER_INQUIRE_PROCESS. To start the DELIVERY CONTROLLER_INQUIRE_PROCESS, the delivery controller would communicate with the intermediary agent with a request message in the format of application identifier-owner identifier-machine identifier-request type. An example of the request message would be 307-OwnerId-MachineId-DI.

### Curbside_Pickup_Process:

Curbside pickup process is an entry point for processing the data received from a web site through user interface. If the curbside pickup process terminates before fully executing the curbside pickup process, the intermediary agent may notify product transfer machine owner and employees and/or display a message for termination reason.

If the request handler is directed to curbside pickup process by data categorization process, then the curbside pickup process will continue, otherwise it will be terminated.

If the curbside pickup process continues, then the request handler would insert a new row into machine order queue table. But, before inserting a new row, the request handler would verify that the input order identifier does not exist in the machine order queue table. The request handler would retrieve one row from machine order queue table using input owner identifier for OWNER_ID, input machine identifier for MACHINE_ID, ordering QUEUE_SEQ in descending order and input order identifier for ORDER_IDENTIFIER. If the request handler can retrieve one row, then the input order identifier already exists in machine order queue table and curbside pickup process will terminate, otherwise it will continue.

If the curbside pickup process continues, the request handler would retrieve the value of QUEUE_SEQ from the latest row in machine order queue table using input owner identifier for OWNER_ID, input machine identifier for MACHINE_ID and QUEUE_SEQ in descending order. If the request handler can retrieve one row, then the request handler would save the value of QUEUE_SEQ plus 1 as new queue sequence, otherwise the request handler would save 1 as new queue sequence.

Then the request handler would insert a new row in machine order queue table using input owner identifier for OWNER_ID, input machine identifier for MACHINE_ID, new queue sequence for QUEUE_SEQ, ‘P’ for STATUS, input order identifier for ORDER_IDENTIFIER and ‘C’ for PICKUP_BIN_TYPE because the order pickup will be from curbside.

If the insert is successful, then the request handler would end the process, otherwise it will be terminated.

If the process successfully ends, the person who scanned the data to initiate the curbside pickup process will receive a successful message. When pickup controller switch placed at the curbside is activated, the pickup controller would request the delivery controller to start DELIVERY CONTROLLER INQUIRE PROCESS. The delivery controller would also at periodical intervals start DELIVERY_CONTROLLER_INQUIRE_PROCESS. To start the DELIVERY_CONTROLLER_INQUIRE_PROCESS, the delivery controller would communicate with the intermediary agent with a request message in the format of application identifier-owner identifier-machine identifier-request type. An example of the request message would be 307-OwnerId-MachineId-DI.

### Delivery_Controller_Inquire_Process:

Delivery controller inquire process is an entry point for processing the data received from delivery controller through controller gateway to inquire whether products are to be moved from one bin to another bin. If the delivery controller inquire process terminates before fully executing the delivery controller inquire process, the intermediary agent may notify product transfer machine owner and employees and/or display a message for termination reason.

If the request handler is directed to the delivery controller inquire process by data categorization process, then the delivery controller inquire process will continue, otherwise it will be terminated.

If an order in active status exists in machine bin move header table and if at least one move in pending status exists in machine bin move detail table, then the request handler would process the move that exists in pending status in machine bin move detail table, otherwise the request handler would process an order that exists in pending status in machine order queue table and then process a move from machine bin move detail table.

First and foremost, the request handler would determine whether to process a move from machine bin move detail table or to process an order from machine order queue table and then process a move from machine bin move detail table. Then the request handler would formulate a response that would include move type, from-bin and to-bin information and return the formulated response to the delivery controller. If the request handler cannot formulate a response, then the request handler will not return any response back to the delivery controller.

The request handler would retrieve one a single row from machine bin move detail table using owner identifier for OWNER_ID, machine identifier for MACHINE_ID, ORDER_SEQ is greater than 0, MOVE_SEQ is greater than 0 and ‘P’ for MOVE STATUS ORDER BY ORDER_SEQ, MOVE_SEQ. If the request handler can retrieve a single row, then the request handler would save ‘Y’ for move found, the values of ORDER_SEQ, MOVE_SEQ and MOVE_IDENTIFIER from the retrieved one row as current order sequence, current move sequence and current move identifier respectively, otherwise the request handler would save ‘N’ for move found.

If move found is ‘Y’ then the request handler would retrieve a single row from machine bin move header table using owner identifier for OWNER_ID, machine identifier for MACHINE_ID, current order sequence for ORDER_SEQ and ‘A’ for STATUS. If the request handler can retrieve a single row, then the request handler would save the values ORDER_IDENTIFIER, PICKUP_BIN and INTERMEDIARY_INCLUDED_YN from the retrieved one row as current order identifier, current pickup bin and current intermediary included respectively, otherwise the request handler would save ‘N’ for move found. If move found is ‘Y’ and if the current intermediary included is ‘Y’, then the request handler would save ‘I’ as current move type. If move found is ‘Y’ and if the current intermediary included is ‘N’, then the request handler would save ‘P’ as current move type.

If move found is ‘Y’, then the request handler would save ‘N’ for order found. If move found is ‘N’, then the request handler would verify whether any request for pickup in machine order queue table is in pending status and the request handler would process an order from machine order queue table that is in pending status. To verify whether any request for pickup in machine order queue table is in pending status, the request handler would retrieve a single row from machine order queue table using owner identifier for OWNER_ID, machine identifier for MACHINE_ID, QUEUE_SEQ is greater than 0 and ‘P’ for STATUS ORDER BY QUEUE_SEQ DESC. If the request handler can retrieve a single row, then the request handler would save ‘Y’ for order found and the values of QUEUE_SEQ, ORDER_IDENTIFIER and PICKUP_BIN_TYPE from the retrieved row as current que sequence, current order identifier and current pickup bin type respectively, otherwise the request handler would save ‘N’ for order found.

If order found is ‘Y’, the request handler will determine whether a pickup bin is available and then determine whether the current order identifier is valid. To determine whether a pickup bin is available, the request handler would search machine bin table and machine bin content table for an unoccupied pickup bin. The request handler would retrieve the values of BIN_ID of all rows in machine bin table and save them in a new bin identifier array using owner identifier for OWNER_ID, machine identifier for MACHINE_ID and current pickup bin type for BIN_TYPE. Then the request handler would save the value of BIN_ID from a single row as current pickup bin identifier from machine bin content table using owner identifier for OWNER_ID, machine identifier for MACHINE_ID, the value of each row in the bin identifier array for BIN_ID, BIN_SEQ is equal to (maximum of (BIN_SEQ) for the same OWNER_ID, MACHINE_ID and BIN_ID) and blank for CONTENT_IDENTIFIER. If the request handler can retrieve a single row from machine bin content table and save the value of BIN_ID from the single retrieved row as current pickup bin identifier, otherwise the request handler would save ‘N’ for order found.

If order found is ‘Y’, then the request handler will determine whether the current order identifier is valid and all the products related to the current order identifier are available in the product transfer machine. To determine whether the current order identifier is valid, the request handler would communicate with the order management system and get order details related to the current order identifier. The order details may be in the form of an array or in any other form that would enable the request handler to get the order details in the form of two (2) columns with one or more rows. The two (2) columns would hold the information namely product identifier and product count respectively for each row. The product identifier could be the same as the CONTENT IDENTIFIER saved in machine bin content table. If the order details are valid, then the request handler will copy product identifier and product count from order details array into a new product details array with four (4) columns where the four (4) columns will be used to store product identifier, required, available and reserved information respectively. If the product identifier from order details matches with product identifier in product details array, then the request handler would add the product count from order details to the required column in the product details array. If the product identifier is not found in the product details array, then the request handler would add a new row in the product details array using the product identifier and product count from the order details for product identifier and required columns respectively in the product details array. When adding a row in product details array, the request handler will also save 0 for available and reserved columns in product details array. When all the rows in order details are processed, the product details array will have unique row for each product identifier with required, available and reserved information where the available and reserved information for all the rows will be 0. If the request handler can populate the values in product details array successfully, then the request handler would continue processing the delivery controller inquire process, otherwise the request handler would save ‘N’ for order found and the delivery controller inquire process will be terminated.

Once all the products are loaded into product details array and if order found is ‘Y’, then the request handler would update the available column in product details array by retrieving one row from machine bin content table for each row in product details array. The request handler would save the value of each row and the value of product identifier in product details array as current product identifier row and current product identifier respectively and would retrieve one or more rows from machine bin content table using owner identifier for OWNER_ID, machine identifier for MACHINE_ID, BIN_ID is not blank, BIN_SEQ is equal to (maximum of (BIN_SEQ) for the same OWNER_ID, MACHINE_ID and BIN_ID) and current product identifier for CONTENT_IDENTIFIER. If the request handler retrieves one or more rows from machine bin content table, then the request handler would save the value of BIN_ID from each retrieved row from machine bin content table as current product bin identifier, otherwise the request handler would save ‘N’ for order found and delivery controller inquire process will be terminated. If order found is ‘Y’, then the request handler would retrieve one row from machine bin table for each retrieved row from machine bin content table using owner identifier for OWNER_ID, machine identifier for MACHINE_ID, current product bin identifier for BIN_ID and ‘P’ for BIN_TYPE. If the request handler retrieves one row from machine bin table, then the request handler would retrieve one row from machine bin inventory table using owner identifier for OWNER_ID, machine identifier for MACHINE_ID, current product bin identifier for BIN_ID, BIN_SEQ is equal to (maximum of (BIN_SEQ) for the same OWNER_ID, MACHINE_ID and BIN_ID) and NET_COUNT minus RESERVED_COUNT is greater than 0. If the request handler retrieves one row from machine bin inventory table, then the request handler would add the value of NET_COUNT minus RESERVED_COUNT from the retrieved row from machine bin inventory table to available column for current product identifier row in product detail array.

Once the request handler updates the value of available column in each row in product detail array and if the order found is ‘Y’, the request handler would confirm that value of available column is each row in product detail array is greater then 0. If the value of the available column in each row in product detail array is greater than 0, then the request handler would confirm that the value of available column is greater than or equal to required column in each row in product detail array, otherwise the request handler would save ‘N’ for order found. If the value of available column is less than required column in any row in product detail array, the request handler would save ‘N’ for order found.

If the order found is ‘Y’, then the request handler would update the value for reserved in each row in product detail array where required is greater than reserved. The request handler would save the value of the row as current product identifier row, save the value of product identifier as current product identifier, save required minus reserved as current required count in each row in product details array where required is greater than reserved and would retrieve rows from machine bin content table using owner identifier for OWNER_ID, machine identifier for MACHINE_ID, BIN_ID is not blank BIN_SEQ is equal to (maximum of (BIN_SEQ) for the same OWNER_ID, MACHINE_ID and BIN_ID) and current product identifier for CONTENT_IDENTIFIER. If a row from product details array is saved as current product identifier row, and if the request handler does not retrieve one or more rows from machine bin content table, the request handler would save ‘N’ for order found. If order found is ‘Y’, then the request handler would save the value of BIN_ID from each retrieved row from machine bin content table as current product bin identifier and would retrieve a row from machine bin inventory table using owner identifier for OWNER_ID, machine identifier for MACHINE_ID, current product bin identifier for BIN_ID, BIN_SEQ is equal to (maximum of (BIN_SEQ) for the same OWNER_ID, MACHINE_ID and BIN_ID) and NET_COUNT minus RESERVED_COUNT is greater than 0 ORDER BY NET_COUNT minus RESERVED COUNT DESC. If the request handler can retrieve a single row from machine bin inventory table, then the request handler would save the value of BIN_SEQ as database bin sequence and NET_COUNT minus RESERVED COUNT as database available count. If current required count is greater than database available count, then the request handler would save database available count as current required count. Then the request handler would update a single row in machine bin inventory table using owner identifier for OWNER_ID, machine identifier for MACHINE_ID, current product bin identifier for BIN_ID, database bin sequence for BIN_SEQ and by setting the value of RESERVED_COUNT to RESERVED_COUNT plus current required count. Then the required request handler would add current required count to required in current product row in product details array. Once the request handler updated the value of required for all rows in product details array, the request handler would insert a row in machine bin move header table and one or more rows in machine bin move detail table.

If the order found is ‘Y’, then the request handler would get the value of ORDER_SEQ from the latest single row in machine bin move header table using owner identifier for OWNER_ID, machine identifier for MACHINE_ID and ordering ORDER_SEQ in descending order. If the request handler can retrieve one single row from machine bin move header table, then the request handler would set the new order sequence as the value of ORDER_SEQ from the retrieved single row+1, otherwise the request hander would set 1 as new order sequence. Once the new order sequence is determined, the request handler would insert a new row into machine bin move header table using owner identifier for OWNER_ID, machine identifier for MACHINE_ID, new order sequence for ORDER_SEQ, ‘A’ for STATUS, current order identifier for ORDER_IDENTIFIER, current pickup bin identifier for PICKUP_BIN and ‘N’ for INTERMEDIARY_INCLUDED_YN. If the insert is not successful, then the request handler would save ‘N’ for order found.

If the order found is ‘Y’, then the request handler would insert a row for required number of times for product identifier from each row from product details array into machine bin move detail table. The request handler would set a value of 0 for new move sequence and increment the new move sequence by 1 before inserting a row into machine bin move detail table. The request handler would retrieve the values of product identifier and required columns from each row in product details array and save as current product identifier and current required respectively. Then the request handler would insert a new row into machine bin move detail table for current required times by incrementing the new move sequence each time by 1 for current product identifier using owner identifier for OWNER_ID, machine identifier for MACHINE_ID, new order sequence for ORDER_SEQ, new move sequence for MOVE_SEQUENCE, ‘P’ for MOVE_STATUS, ‘P’ for MOVE_TYPE, current product identifier for MOVE_IDENTIFIER, blank for FROM_BIN and blank for TO BIN. When product identifiers from all rows in product details array are inserted into machine bin move detail table successfully, the delivery controller inquire process will continue, otherwise request handler will save ‘N’ order found.

If order found is ‘Y’, then the request handler would update the status in machine order queue table by setting the value of STATUS to ‘I’ using owner identifier for OWNER_ID, machine identifier for MACHINE_ID, QUEUE_SEQ is greater than 0, and current order identifier for ORDER_IDENTIFIER. This will ensure that orders machine order queue table will be processed only once.

If order found is ‘Y’, thenthe request handler would retrieve one a single row from machine bin move detail table using owner identifier for OWNER_ID, machine identifier for MACHINE_ID, ORDER_SEQ is greater than 0, MOVE_SEQ is greater than 0 and ‘P’ for MOVE_STATUS ORDER BY ORDER_SEQ, MOVE_SEQ. If the request handler can retrieve a single row, then the request handler would save the values of ORDER_SEQ, MOVE_SEQ and MOVE_IDENTIFIER from the retrieved one row as current order sequence, current move sequence and current move identifier respectively, otherwise the request handler would save ‘N’ for order found.

If order found is ‘Y’ then the request handler would retrieve a single row from machine bin move header table using owner identifier for OWNER_ID, machine identifier for MACHINE_ID, current order sequence for ORDER_SEQ and ‘A’ for STATUS. If the request handler can retrieve a single row, then the request handler would save the values ORDER_IDENTIFIER, PICKUP_BIN and INTERMEDIARY_INCLUDED_YN from the retrieved one row as current order identifier, current pickup bin and current intermediary included respectively, otherwise the request handler would save ‘N’ for order found. If order found is ‘Y’ and if the current intermediary included is ‘Y’, then the request handler would save ‘I’ as current move type. If order found is ‘Y’ and if the current intermediary included is ‘N’, then the request handler would save ‘P’ as current move type.

If move found is ‘N’ and if order found is ‘Y’, then the request handler would save ‘Y’ for move found.

If the move found is ‘Y’ and if the value of current move type is ‘P’, then the current move identifier would be a product identifier and the current move will be from a product bin to an intermediary bin. The request handler would use a product bin stocked with current move identifier and reserved count is greater then 0 as from-bin and use an intermediary bin accessible from the same aisle where from-bin is located as to-bin. To locate a product bin stocked with current move identifier, the intermediary agent would use machine bin content table, machine bin table and machine bin inventory table.

If the move found is ‘Y’ and if the value of current move type is ‘P’, then the request handler would save the values of BIN_ID in a new content bin identifier array from all the rows in machine bin content table using owner identifier for OWNER_ID, machine identifier for MACHINE_ID, BIN_ID is not blank, BIN_SEQ is equal to (maximum of (BIN_SEQ) for the same OWNER_ID, MACHINE_ID and BIN_ID) and current move identifier for CONTENT_IDENTIFIER. The current move identifier will be the product identifier. Then the request handler would use one row of information from content bin identifier array at a time to retrieve data from machine bin inventory table and machine bin table. Then the request handler will save the value from each row in content bin identifier array as current content bin identifier and will verify that the bin type of current content bin identifier is same as current move type. The request handler would retrieve one row from machine bin table using owner identifier for OWNER_ID, machine identifier for MACHINE_ID, current content bin identifier for BIN_ID and current move type for BIN_TYPE. If the request handler retrieves one row from machine bin table for each row in content bin identifier array, then the delivery controller inquire process will continue, otherwise delivery controller inquire process will be terminated.

If the delivery controller inquire process continues and if the current move type is ‘P’, the request handler would save the value from each row in content bin identifier array as current content bin identifier and use the current content bin identifier to retrieve BIN_ID from a single row from machine bin inventory table using owner identifier for OWNER_ID, machine identifier for MACHINE_ID, current content bin identifier for BIN_ID, BIN_SEQ is equal to (maximum of (BIN_SEQ) for the same OWNER_ID, MACHINE_ID and BIN_ID), RESERVED_COUNT is greater than 0 and NET_COUNT is greater than 0 ORDER BY RESERVED COUNT. If the request handler can retrieve a single row, then the request handler would save current content bin identifier as from-bin, otherwise the process will be terminated. This will ensure that the product in the from-bin is the product identifier, and the product is available to be moved from from-bin.

If the delivery controller inquire process continues and if the current move type is ‘P’ then the request handler would retrieve the value of AISLE_NUMBER in a single row from machine bin table using owner identifier for OWNER_ID, machine identifier for MACHINE_ID, from-bin for BIN_ID, If the request handler can retrieve one row, then the request handler would save the value of AISLE_NUMBER from the single retrieved row as aisle number, otherwise the delivery controller inquire process will be terminated.

If the delivery controller inquire process continues and if the current move type is ‘P’, then the request handler would save the values of BIN_ID in a new bin identifier array from all the rows in machine bin table using owner identifier for OWNER_ID, machine identifier for MACHINE_ID, BIN_ID is not blank, BIN_TYPE is equal to ‘I’ and AISLE_NUMBER is equal to aisle number. If the request handler can retrieve at least one row then the process will continue, otherwise the process will be terminated.

If the delivery controller inquire process continues and if the current move type is ‘P’, the request handler would save the value from each row in bin identifier array as current bin identifier and use the current bin identifier to retrieve BIN_ID from a single row from machine bin content table using owner identifier for OWNER_ID, machine identifier for MACHINE_ID, current bin identifier for BIN_ID, BIN_SEQ is equal to (maximum of (BIN_SEQ) for the same OWNER_ID, MACHINE_ID and BIN_ID) and CONTENT_IDENTIFIER is blank or equal to current order identifier. If the request handler can retrieve a single row, then the request handler would save the current bin identifier as to-bin, otherwise the process will be terminated. This will ensure that all products from a single aisle will be moved to a single intermediary bin. In some embodiments, the request handler would have additional algorithm to search for a from-bin and a to-bin before terminating delivery controller inquire process.

If the delivery controller inquire process continues and if the current move type is ‘P’ and if values for from-bin and to-bin are determined, then the request handler would set the value of ‘A’ for MOVE STATUS, from-bin for FROM BIN, to-bin for TO BIN and current move identifier for MOVE IDENTIFIER in machine bin move detail table using owner identifier for OWNER_ID, machine identifier for MACHINE_ID, current order sequence for ORDER_SEQ, current move sequence for MOVE_SEQ, ‘P’ for MOVE_STATUS and ‘P’ for MOVE_TYPE.

If the delivery controller inquire process continues and if the current move type is ‘P’ and if values for from-bin and to-bin are determined and if values for from-bin, to-bin and current move identifier are updated in machine bin move detail table, then the request handler would return a response where the response will be move type, from-bin, to-bin and the process will end. As an example the response would be like ‘P,A3-B63,A3-15’.

If the move found is ‘Y’ and if the value of current move type is ‘I’, then the current move identifier would be an order identifier and the current move will be from an intermediary bin to a pickup bin. If move found is ‘Y’ and if the value of current move type is ‘I’, then the request handler would use an intermediary bin with a BIN_TYPE of ‘I’ and with a content of current order identifier as from-bin and current pickup bin as to-bin. If move found is ‘Y’ and if the value of current move type is ‘I’ and if the current pickup bin is ‘C’, then the request handler would use a pickup bin with a BIN_TYPE of ‘C’ as to-bin. If move found is ‘Y’ and if the value of current move type is ‘I’ and if the current pickup bin is ‘D’, then the request handler would use a pickup bin with a BIN_TYPE of ‘D’ as to-bin. To locate an intermediary with a content of current order identifier, the intermediary agent would use machine bin content table and machine bin table.

If the request handler can retrieve one row from machine bin move detail table and if the value of current move type is ‘I’, then the current move identifier should be same as current order identifier, otherwise the process will be terminated.

Then the request handler would save the values of BIN_ID in a new content bin identifier array from all the rows in machine bin content table using owner identifier for OWNER_ID, machine identifier for MACHINE_ID, BIN_ID is not blank, BIN_SEQ is equal to (maximum of (BIN_SEQ) for the same OWNER_ID, MACHINE_ID and BIN_ID) and current move identifier for CONTENT_IDENTIFIER.

If the current move type is ‘I’, then the request handler would use one row of information from content bin identifier array at a time to retrieve data from machine bin table.

Then the request handler will save the value from each row in content bin identifier array as current content bin identifier and will verify that the bin type of current content bin identifier is same as current move type. The request handler would retrieve one row from machine bin table using owner identifier for OWNER_ID, machine identifier for MACHINE_ID, current content bin identifier for BIN_ID and current move type for BIN_TYPE. If the request handler retrieves one row from machine bin table for each row in content bin identifier array, then the delivery controller inquire process will continue, otherwise it will end.

If the delivery controller inquire process continues and if the current move type is ‘I’, then the request handler would save the value in the first row of content bin identifier array as from-bin and the value of current pickup bin as to-bin.

If the delivery controller inquire process continues and if values for from-bin and to-bin are determined, then the intermediary agent would set the value of ‘A’ for MOVE STATUS in machine bin move detail table using owner identifier for OWNER_ID, machine identifier for MACHINE_ID, current order sequence for ORDER_SEQ, current move sequence for MOVE_SEQ, ‘P’ for MOVE_STATUS and current move type for MOVE_TYPE.

If the delivery controller inquire process continues and if values for from-bin and to-bin are determined, then the intermediary agent would return a response where the response will be move-type, from-bin, to-bin and the process will end. As an example the response would be ‘I,A3-I5,OC2’.

### Delivery_Controller_Update_Process:

Delivery controller update process is an entry point for processing the request received from delivery controller through controller gateway. If the delivery controller update process terminates before fully executing the delivery controller update process, the intermediary agent may notify product transfer machine owner and employees and/or display a message for termination reason.

If the request handler is directed to the delivery controller update process by data categorization process, then the delivery controller update process will continue, otherwise it will be terminated.

First and foremost, the request handler would determine whether any active move from a from-bin to a to-bin exists. If an active move exists, then the request handler would determine the from-bin, to-bin, move identifier and move type. Then the request handler would update the content of the from-bin to blank and the content of the to-bin to content identifier. Then the request handler would update the status in move detail table to ‘I’. If the move type ‘P’, then the request handler would update the reserved count and net count in the inventory table. If intermediary moves are not included in the move detail table and if there are no more product moves, then the request handler would insert intermediary moves into move detail table. If intermediary moves are included in the move detail table and if there are no more intermediary moves, then the request handler would update the status to ‘I’ in move header table. If the status is updated to ‘I’ in move header table, the request handler would notify the order management system.

To determine whether any active move from a from-bin to a to-bin exists, the request handler would retrieve a single row from machine bin move detail table using owner identifier for OWNER_ID, machine identifier for MACHINE_ID, ORDER_SEQ greater than 0, MOVE_SEQ greater than 0, ‘A’ for MOVE_STATUS, FROM_BIN is not blank and TO BIN is not blank ORDER BY ORDER_SEQ DESC, MOVE_SEQ. If the request handler retrieves one row, then the request handler would save the values of ORDER_SEQ, MOVE_SEQ, MOVE_TYPE and MOVE_IDENTIFIER, FROM_BIN, TO_BIN as current order sequence, current move sequence, current move type, current move identifier, current from bin and current to bin respectively and the delivery controller update process will continue, otherwise it will be terminated.

Then the request handler would retrieve a single row from machine bin move header table using owner identifier for OWNER_ID, machine identifier for MACHINE_ID, current order sequence for ORDER_SEQ and ‘A’ for STATUS. If the request handler retrieves one row, then the request handler would save the values of ORDER_IDENTIFIER, PICKUP_BIN and INTERMEDIARY_INCLUDED_YN as current order identifier, current pickup bin and current intermediary included yn respectively and the delivery controller update process will continue, otherwise it will be terminated.

Then the request handler would set blank as content for current from bin by inserting a row into machine bin content table. To insert a row into machine bin content table, the request handler would get the value of BIN_SEQ from the latest single row in machine bin content table using owner identifier for OWNER_ID, machine identifier for MACHINE_ID, current from bin for BIN_ID and ordering BIN_SEQ in descending order. If the request handler retrieves one single row from machine bin content table, then the request handler would set the new bin sequence as the value of BIN_SEQ from the retrieved single row+1, otherwise it will be terminated. Once the new bin sequence is determined, the request handler would insert a new row into machine bin content table using owner identifier for OWNER_ID, machine identifier for MACHINE_ID, current from bin for BIN_ID, new bin sequence for BIN_SEQ and blank for CONTENT_IDENTIFIER. If the insert is successful the delivery controller update process will continue, otherwise it will be terminated.

If the current move type is ‘P’, then the request handler would save current order identifier as current to bin content, otherwise the request handler would save current move identifier as current to bin content.

Then the request handler would set current to bin content as content for current to bin by inserting a row into machine bin content table. To insert a row into machine bin content table, the request handler would get the value of BIN_SEQ from the latest single row in machine bin content table using owner identifier for OWNER_ID, machine identifier for MACHINE_ID, current to bin for BIN_ID and ordering BIN_SEQ in descending order. If the request handler retrieves one single row from machine bin content table, then the request handler would set the new bin sequence as the value of BIN_SEQ from the retrieved single row+1, otherwise the request handler will set 1 as new bin sequence. Once the new bin sequence is determined, the request handler would insert a new row into machine bin content table using owner identifier for OWNER_ID, machine identifier for MACHINE_ID, current to bin for BIN_ID, new bin sequence for BIN SEQ and current to bin content for CONTENT IDENTIFIER. If the insert is successful the delivery controller update process will continue, otherwise it will be terminated.

Then the request handler would update a row in machine bin move detail table by setting ‘I’ for MOVE_STATUS using owner identifier for OWNER_ID, machine identifier for MACHINE_ID, current order sequence for ORDER_SEQ and current move sequence for MOVE_SEQ. If the insert is successful the delivery controller update process will continue, otherwise it will be terminated.

If the current move type is ‘P’, the request handler would insert a row into machine bin inventory table for the current from bin to reduce the reserved count and net count by 1. First the request handler would determine the new bin sequence and then insert a row in machine bin inventory table. To determine new bin sequence, the request handler would get the value of BIN_SEQ from the latest single row in machine bin inventory table using owner identifier for OWNER_ID, machine identifier for MACHINE_ID, current from bin for BIN_ID and ordering BIN_SEQ in descending order. If the request handler retrieves one single row from machine bin inventory table, then the request handler would set the new bin sequence as the value of BIN_SEQ from the retrieved single row+1 and save the value of RESERVED_COUNT and NET COUNT from the retrieved single row as database reserved count and database net count, otherwise delivery controller update process will be terminated. Once the new bin sequence is determined, the request handler would insert a new row into machine bin inventory table using owner identifier for OWNER_ID, machine identifier for MACHINE_ID, current from bin for BIN_ID, new bin sequence for BIN_SEQ, database reserved count minus 1 for RESERVED COUNT and database net count minus 1 for NET COUNT. If the insert is successful the delivery controller update process will continue, otherwise it will be terminated.

If current intermediary included yn is ‘N’, then the request handler would save ‘Y’ for insert intermediary yn, otherwise the request handler would save ‘N’ for insert intermediary yn. If insert intermediary yn is ‘Y’, then the request handler would retrieve a single row from machine bin move detail table using owner identifier for OWNER_ID, machine identifier for MACHINE_ID, current order sequence for ORDER_SEQ, MOVE_SEQ is greater than 0, ‘P’ for MOVE_TYPE, MOVE_STATUS is not equal to ‘I’ ORDER BY MOVE_SEQ DESC. If insert intermediary yn is ‘Y’ and if the request handler retrieves a row from machine bin move detail table, then the request handler would save ‘N’ for insert intermediary yn.

If insert intermediary yn is ‘Y’, the request handler would save the values of BIN_ID in a new intermediary bin identifier array from all the rows in machine bin content table using owner identifier for OWNER_ID, machine identifier for MACHINE_ID, BIN_ID is not blank, BIN_SEQ is equal to (maximum of (BIN_SEQ) for the same OWNER_ID, MACHINE_ID and BIN_ID) and current order identifier for CONTENT IDENTIFIER.

If insert intermediary yn is ‘Y’, then the request handler would retrieve the value of MOVE_SEQ from a single row in machine bin move detail table using owner identifier for OWNER_ID, machine identifier for MACHINE_ID, current order sequence for ORDER_SEQ and ordering MOVE_SEQ in descending order. If the request handler retrieves one row, then the request handler would save the value of MOVE_SEQ from the single retrieved row as insert move sequence, otherwise the request handler would save 0 as insert move sequence.

If insert intermediary yn is ‘Y’ and if insert move sequence is greater than 0, then the request handler would process one row of information from intermediary bin identifier array at a time. The request handler will save the value from each row in intermediary bin identifier array as insert bin identifier. Then the request handler will increment the value of insert move sequence by 1 and insert a row in machine move bin detail table using owner identifier for OWNER_ID, machine identifier for MACHINE_ID, current order sequence for ORDER_SEQ, insert move sequence for MOVE_SEQ, ‘P’ for MOVE_STATUS, ‘I’ for MOVE_TYPE, current order identifier for MOVE_IDENTIFIER, current bin identifier for FROM BIN and current pickup bin for TO BIN.

If current intermediary included yn is ‘Y’, then the request handler would save ‘Y’ for end order yn, otherwise the request handler would save ‘N’ for end order yn. If end order yn is ‘Y’, then the request handler would retrieve a single row from machine bin move detail table using owner identifier for OWNER_ID, machine identifier for MACHINE_ID, current order sequence for ORDER_SEQ, MOVE_SEQ is greater than 0, MOVE_STATUS is not equal to ‘I’ ORDER BY MOVE_SEQ DESC. If end order yn is ‘Y’ and if the request handler retrieves a row from machine bin move detail table, then the request handler would save ‘N’ for end order yn.

If end order yn is ‘Y’, then the request handler would update a row in machine bin move header table by setting ‘I’ to STATUS using owner identifier for OWNER_ID, machine identifier for MACHINE_ID and current order sequence for ORDER_SEQ.

If end order yn is ‘Y’, then the request handler would notify the order management system that all the products in a particular order have been moved to a pickup bin and the order management system would in turn will notify the locker management system.

Then the request handler would determine whether the delivery controller should continue processing product moves. To determine the delivery controller should continue processing product moves, the request handler would retrieve a single row from machine bin move header table using owner identifier for OWNER_ID, machine identifier for MACHINE_ID, ORDER_SEQ is greater than 0 and ‘A’ for STATUS ORDER BY ORDER_SEQ. If the request handler retrieves one row from machine bin move header table then the request handler would save ‘Y’ for response yn, otherwise the request handler would save ‘N’ for response yn.

If response yn is ‘N’, then the handler would retrieve a single row from machine order queue table using owner identifier for OWNER_ID, machine identifier for MACHINE_ID, QUEUE_SEQ is greater than 0 and ‘P’ for STATUS ORDER BY QUEUE_SEQ. If the request handler retrieves one row from machine order queue table then the request handler would save ‘Y’ for response yn.

Then the request handler would return a response with a value of response yn.

### Delivery_Controller_Display_Process:

Delivery controller display process is an entry point for processing the request received from delivery controller through controller gateway. If the delivery controller display process terminates before fully executing the delivery controller display process, the intermediary agent may notify product transfer machine owner and employees and/or display a message for termination reason.

If the request handler is directed to the delivery controller display process by data categorization process, then the delivery controller display process will continue, otherwise it will be terminated.

The request handler would create a list of orders that are already placed inside the pickup bins and ready for pick up by retrieving data from machine bin table, machine bin content table and machine bin locker sync table. Then the request handler would create a list of orders that are in the process of being moved to pick up bins by retrieving data from machine bin move header table, machine bin table and machine bin locker sync table. Then the request handler would create a list of orders that are in pending status in the queue. Then the request handler would combine the prepared lists in an array and return the array as a response to the delivery controller that initiated the delivery controller display process.

First, the request handler would create a response array with four (4) columns namely order identifier, status, locker location type and locker external number. Then the request handler would retrieve all the rows from the machine bin table using owner identifier for OWNER_ID, machine identifier for MACHINE_ID, BIN_ID is not blank and BIN_TYPE is ‘C’ or ‘D’. Then the request handler would save the values of BIN_ID and BIN_TYPE from each retrieved row from machine bin table as current pickup bin identifier and current pickup bin type respectively and retrieve a single row from machine bin content table using owner identifier for OWNER_ID, machine identifier for MACHINE_ID, current pickup bin identifier for BIN_ID, BIN_SEQ is equal to (maximum of (BIN_SEQ) for the same OWNER_ID, MACHINE_ID and BIN_ID) and CONTENT_IDENTIFIER is not blank. If the request handler retrieves a single row from machine bin content table, then the request handler would save the value of CONTENT IDENTIFIER from the retrieved row from machine bin content table as current order identifier, otherwise the request handler would save a blank for current order identifier. If the current order identifier is not blank, then the request handler would retrieve a single row from machine bin locker sync table using owner identifier for OWNER_ID, machine identifier for MACHINE_ID, current pickup bin identifier for BIN_ID. If the current order identifier is not blank and if a row from machine bin locker sync table is retrieved, then the request handler would save the value of LOCKER_EXTERNAL_IDENTIFIER as current locker external number. If the current order identifier is not blank and if a row from machine bin locker sync table is not retrieved, then the request handler would save blank for current order identifier. If the current order identifier is not blank and current pickup bin type is ‘C’ then the request handler would save ‘Curbside’ as current pickup location type. If the current order identifier is not blank and current pickup bin type is ‘D’ then the request handler would save ‘Drive-Thru’ as current pickup location type. If the current order identifier is not blank then the request handler would save current order identifier, ‘Ready’, current pickup location type and current locker external number in columns order identifier, status, locker location type and locker external number respectively in a new row in response array.

Once the request handler inserted all the orders that are ready to be picked up into the response array, the request handler would insert orders that are being processed into the response array. The request handler would retrieve all the rows from the machine bin move header table using owner identifier for OWNER_ID, machine identifier for MACHINE_ID, ORDER SEQ is not blank and ‘A’ for STATUS. Then the request handler would save the values of ORDER_IDENTIFIER and PICKUP_BIN from each retrieved row from machine bin move header table as current order identifier and current pickup bin identifier respectively and retrieve a single row from machine bin table using owner identifier for OWNER_ID, machine identifier for MACHINE_ID, current pickup bin identifier for BIN_ID and ‘C’ or ‘D’ for BIN TYPE. If the request handler retrieves a row from machine bin table then the request handler would save the value of BIN TYPE from the retrieved row as current pickup bin type, otherwise the request handler would save a blank for current pickup bin type. If current pickup bin type is not blank, then the request handler would retrieve a single row from machine bin locker sync table using owner identifier for OWNER_ID, machine identifier for MACHINE_ID, current pickup bin identifier for BIN_ID. If current pickup bin type is not blank and if a row from machine bin locker sync table is retrieved, then the request handler would save the value of LOCKER_EXTERNAL_IDENTIFIER as current locker external number. If current pickup bin type is not blank and if a row from machine bin locker sync table is not retrieved, then the request handler would save blank for current pickup bin type. If the current pickup bin type is ‘C’ then the request handler would save ‘Curbside’ as current pickup location type. If the current pickup bin type is ‘D’ then the request handler would save ‘Drive-Thru’ as current pickup location type. If the current pickup bin type is not blank then the request handler would save current order identifier, ‘In Process’, current pickup location type and current locker external number in columns order identifier, status, locker location type and locker external number respectively in a new row in response array.

Once the request handler inserted all the orders that are being processed into the response array, the request handler would insert orders that are waiting in the queue into the response array. The request handler would retrieve all the rows from the machine order queue table using owner identifier for OWNER_ID, machine identifier for MACHINE_ID, QUEUE_SEQ is not blank and ‘P’ for STATUS. Then the request handler would save the values of ORDER_IDENTIFIER and PICKUP_BIN_TYPE from each retrieved row from machine order queue table as current order identifier and current pickup bin type respectively. If the current pickup bin type is ‘C’ then the request handler would save ‘Curbside’ as current pickup location type. If the current pickup bin type is ‘D’ then the request handler would save ‘Drive-Thru’ as current pickup location type. Then the request handler would save current order identifier, ‘In Queue’, current pickup location type and a blank in columns order identifier, status, locker location type and locker external number respectively in a new row in response array. Once the request handler inserted all the orders that are ready to be picked up, all the orders that are being processed and all the orders that are in the queue into the response array, the request handler would return response array as a response.

While the foregoing description is exemplary of various embodiments of the present invention, those of ordinary skill in the relevant arts will recognize the many variations, alterations, modifications, substitutions and the like as are readily possible, especially in light of this description, the accompanying drawings and claims drawn thereto. In any case, because the scope of the present invention is much broader than any particular embodiment, the foregoing detailed description should not be construed as a limitation of the scope of the present invention, which is limited only by the claims appended hereto.

I claim:

1. A system for facilitating secure, anonymous communications in retail environments between a first party device and a second party device, comprising:
a QR code associated with the first party device configured to link to unique, time-limited communication channels;
an intermediary communication agent configured to:
receive a request from the QR code through the second party device;
authenticate first party device in part to proximity of the retail environment;
establish a secure communication pathway between the first party device and second party device without exchanging personal contact information; and
terminate the communication channel upon completion of the customer interaction.
